SEQUENCE LISTING (299 sequences)

SEQ ID NO: 1 - protein, 35 aa, Artificial Sequence
  GCN4 zipper
GRMKQLEDKVEELLSKNYHLENEVARLKKLVGERG

SEQ ID NO: 2 - DNA, 7 bp, Artificial Sequence
  SAP-1 cleavage site
gctcttc

SEQ ID NO: 3 - DNA, 24 bp, Artificial Sequence
  CALX24 Primer
gccgctgtgccatcgctcagtaac

SEQ ID NO: 4 - DNA, 40 bp, Artificial Sequence
  pCALVH-F Primer
gcccaggcggccgcagaagttcagctggttgaatctggtg

SEQ ID NO: 5 - DNA, 58 bp, Artificial Sequence
  primer E / oligonucleotide pool E
cctttggtcgacgccggagaaacggtaacaacggtacccggaccccaagcgtcgaacg

SEQ ID NO: 6 - DNA, 45 bp, Artificial Sequence
  CALX24H1S-F primer F1
gccgctgtgccatcgctcagtaacgcggccgcagaagttcagctg

SEQ ID NO: 7 - DNA, 3513 bp, Artificial Sequence
  pCAL G13 vector
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcccagccggccatggccgccggtgcctaactctggctggtttcgctaccgtaaccggtttaattaataaggaggatataattatgaaaaagacagctatcgcgattgcagtggcactggctggtttcgctaccgtagcccaggcggccgcacgcgtctggttgaatctggtggggtctggaattctgcgatcgcggccaggccggccgcaccatcaccatcaccatggcgcatacccgtacgacgttccggactacgcttctactagttaggagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 8 - DNA, 3513 bp, Artificial Sequence
  pCAL A1 vector
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcccagccggccatggccgccggtgcctaactctggctggtttcgctaccgtaaccggtttaattaataaggaggatataattatgaaaaagacagctatcgcgattgcagtggcactggctggtttcgctaccgtagcccaggcggccgcacgcgtctggttgaatctggtggggtctggaattctgcgatcgcggccaggccggccgcaccatcaccatcaccatggcgcatacccgtacgacgttccggactacgcttctactagttagaagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 9 - DNA, 3 bp, Artificial Sequence
  amber stop DNA
tag

SEQ ID NO: 10 - RNA, 3 nt, Artificial Sequence
  amber stop RNA
uag

SEQ ID NO: 11 - DNA, 4765 bp, Artificial Sequence
  2G12 pCAL G13 vector
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcccagccggccatggccgccggtgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctaattaattaataaggaggatataattatgaaaaagacagctatcgcgattgcagtggcactggctggtttcgctaccgtagcccaggcggccgcagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcgatcgcggccaggccggccgcaccatcaccatcaccatggcgcatacccgtacgacgttccggactacgcttctactagttaggagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 12 - protein, 424 aa, Artificial Sequence
  M13 gene III protein (cp3, g3p, minor coat protein, g.i. 59799327)
MKKLLFAIPLVVPFYSHSAETVESCLAKPHTENSFTNVWKDDKTLDRYANYEGCLWNATGVVVCTGDETQCYGTWVPIGLAIPENEGGGSEGGGSEGGGSEGGGTKPPEYGDTPIPGYTYINPLDGTYPPGTEQNPANPNPSLEESQPLNTFMFQNNRFRNRQGALTVYTGTVTQGTDPVKTYYQYTPVSSKAMYDAYWNGKFRDCAFHSGFNEDPFVCEYQGQSSDLPQPPVNAGGGSGGGSGGGSEGGGSEGGGSEGGGSEGGGSGGGSGSGDFDYEKMANANKGAMTENADENALQSDAKGKLDSVATDYGAAIDGFIGDVSGLANGNGATGDFAGSNSQMAQVGDGDNSPLMNNFRQYLPSLPQSVECRPFVFSAGKPYEFSIDCDKINLFRGVFAFLLYVATFMYVFSTFANILRNKES

SEQ ID NO: 13 - protein, 123 aa, Artificial Sequence
  2G12 VH domain
EVQLVESGGGLVKAGGSLILSCGVSNFRISAHTMNWVRRVPGGGLEWVASISTSSTYRDYADAVKGRFTVSRDDLEDFVYLQMHKMRVEDTAIYYCARKGSDRLSDNDPFDAWGPGTVVTVSP

SEQ ID NO: 14 - protein, 107 aa, Artificial Sequence
  2G12 VL domain (also 3-ALA VL) 1
DVVMTQSPSTLSASVGDTITITCRASQSIETWLAWYQQKPGKAPKLLIYKASTLKTGVPSRFSGSGSGTEFTLTISGLQFDDFATYHCQHYAGYSATFGQGTRVEIK

SEQ ID NO: 15 - protein, 123 aa, Artificial Sequence
  3-ALA 2G12 VH domain
EVQLVESGGGLVKAGGSLILSCGVSNFRISAHTMNWVRRVPGGGLEWVASISTSSTYRDYADAVKGRFTVSRDDLEDFVYLQMHKMRVEDTAIYYCARKGSDRAADADPFDAWGPGTVVTVSP

SEQ ID NO: 16 - DNA, 54 bp, Artificial Sequence
  Linker 1
ggtggttcgtctggatcttcctcctctggtggcggtggctcgggcggtggtggc

SEQ ID NO: 17 - protein, 18 aa, Artificial Sequence
  Linker 1
GGSSGSSSSGGGGSGGGG

SEQ ID NO: 18 - DNA, 54 bp, Artificial Sequence
  Linker 2
ggaggatccggcagcagcagcagcggcggcggcggcgggagctccggcggcgga

SEQ ID NO: 19 - protein, 18 aa, Artificial Sequence
  Linker 2
GGSGSSSSGGGGGSSGGG

SEQ ID NO: 20 - DNA, 48 bp, Artificial Sequence
  L216
ggaggatccggcagcagcagcagcggcggcgggagctccggcggcgga

SEQ ID NO: 21 - protein, 16 aa, Artificial Sequence
  L216
GGSGSSSSGGGSSGGG

SEQ ID NO: 22 - DNA, 51 bp, Artificial Sequence
  L217
ggaggatccggcagcagcagcagcggcggcggcgggagctccggcggcgga

SEQ ID NO: 23 - protein, 17 aa, Artificial Sequence
  L217
GGSGSSSSGGGGSSGGG

SEQ ID NO: 24 - DNA, 57 bp, Artificial Sequence
  L219
ggaggatccagcggcagcagcagcagcggcggcggcggcgggagctccggcggcgga

SEQ ID NO: 25 - protein, 19 aa, Artificial Sequence
  L219
GGSSGSSSSGGGGGSSGGG

SEQ ID NO: 26 - DNA, 60 bp, Artificial Sequence
  L220
ggaggatccagcggcggcagcagcagcagcggcggcggcggcgggagctccggcggcgga

SEQ ID NO: 27 - protein, 20 aa, Artificial Sequence
  L220
GGSSGGSSSSGGGGGSSGGG

SEQ ID NO: 28 - DNA, 87 bp, Artificial Sequence
  BamHISacI linker / BamHISacI(+)
gatccggtggcggcagcgaaggtggtggcagcgaaggtggcggtagcgaaggtggcggcagcgaaggcggcggtagcggtgggagct

SEQ ID NO: 29 - protein, 29 aa, Artificial Sequence
  BamHISacI linker
DPVAAAKVVAAKVAVAKVAAAKAAVAVGA

SEQ ID NO: 30 - DNA, 6819 bp, Artificial Sequence
  vector with 2G12 Fab Cys19 construct
ggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctagggccaggccggccgcggccgcataatgcttaagtcgaacagaaagtaatcgtattgtacacggccgcataatcgaaattaatacgactcactataggggaattgtgagcggataacaattccccatcttagtatattagttaagtataagaaggagatatacatatgaaatacctattgcctacggcagccgctggattgttattactcgctgcccaaccagccatggccgaagttcagctggttgaatctggtggtggtctggttaaagctggtggttctctgtgcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcggcagcagccaccatcaccatcaccatggcgcatacccgtacgacgttccggactacgcttcttagctcgagtctggtaaagaaaccgctgctgcgaaatttgaacgccagcacatggactcgtctactagcgcagcttaattaacctaggctgctgccaccgctgagcaataactagcataaccccttggggcctctaaacgggtcttgaggggttttttgctgaaaggaggaactatatccggattggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttctggcggcacgatggcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactccccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgcaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaatacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatcatgattgaagcatttatcagggttattgtctcatgagcggatacatatttgaatgtatttagaaaaataaacaaataggtcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgctagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatgtccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatcgatctcgatcccgcgaaattaatacgactcactata

SEQ ID NO: 31 - DNA, 6802 bp, Artificial Sequence
  vector with 2G12 scFab deltaC2Cys19 construct
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatctggtggtggatccggtggcggcagcgaaggtggtggcagcgaaggtggcggtagcgaaggtggcggcagcgaaggcggcggtagcggtgggagctccggtgaagttcagctggttgaatctggtggtggtctggttaaagctggtggttctctgtgcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatctggcagcagcggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 32 - DNA, 6121 bp, Artificial Sequence
  vector with 2G12 scFv Cys19 construct
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaaggtggttcgtctggatcttcctcctctggtggcggtggctcgggcggtggtggcgaagttcagctggttgaatctggtggtggtctggttaaagctggtggttctctgtgcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccgggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 33 - DNA, 4765 bp, Artificial Sequence
  3-ALA 2G12 pCAL G13 vector
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcccagccggccatggccgccggtgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctaattaattaataaggaggatataattatgaaaaagacagctatcgcgattgcagtggcactggctggtttcgctaccgtagcccaggcggccgcagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtgcggcggacgcggacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcgatcgcggccaggccggccgcaccatcaccatcaccatggcgcatacccgtacgacgttccggactacgcttctactagttaggagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 34 - DNA, 6840 bp, Artificial Sequence
  2G12 Fab hinge in petDuet
ggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctagggccaggccggccgcggccgcataatgcttaagtcgaacagaaagtaatcgtattgtacacggccgcataatcgaaattaatacgactcactataggggaattgtgagcggataacaattccccatcttagtatattagttaagtataagaaggagatatacatatgaaatacctattgcctacggcagccgctggattgttattactcgctgcccaaccagccatggccgaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaaagctgcgataaaacccatacctgcccgccgtgcccgcaccatcaccatcaccatggcgcatacccgtacgacgttccggactacgcttcttagctcgagtctggtaaagaaaccgctgctgcgaaatttgaacgccagcacatggactcgtctactagcgcagcttaattaacctaggctgctgccaccgctgagcaataactagcataaccccttggggcctctaaacgggtcttgaggggttttttgctgaaaggaggaactatatccggattggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttctggcggcacgatggcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactccccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgcaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaatacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatcatgattgaagcatttatcagggttattgtctcatgagcggatacatatttgaatgtatttagaaaaataaacaaataggtcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgctagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatgtccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatcgatctcgatcccgcgaaattaatacgactcactata

SEQ ID NO: 35 - DNA, 6121 bp, Artificial Sequence
  vector with 2G12 domain exchanged scFv
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaaggtggttcgtctggatcttcctcctctggtggcggtggctcgggcggtggtggcgaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccgggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 36 - DNA, 6916 bp, Artificial Sequence
  vector w/ 2G12 domain exchanged scFv tandem
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaaggtggttcgtctggatcttcctcctctggtggcggtggctcgggcggtggtggcgaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccgggaggatccggcagcagcagcagcggcggcggcggcgggagctccggcggcggagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccgggtggttcgtctggatcttcctcctctggtggcggtggctcgggcggtggtggcgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaaggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 37 - DNA, 6166 bp, Artificial Sequence
  vector w/ 2G12 domain exchanged scFv hinge(E)
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaaggtggttcgtctggatcttcctcctctggtggcggtggctcgggcggtggtggcgaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccggaaccgaaaagctgcgataaaacccatacctgcccgccgtgcccgggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 38 - DNA, 6163 bp, Artificial Sequence
  vector w/ 2G12 domain exchanged scFv hinge deltaE
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaaggtggttcgtctggatcttcctcctctggtggcggtggctcgggcggtggtggcgaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcacaaaatgcgtgttgaagacaccgctatctactactgcgctcgtaaaggttctgaccgtctgtctgacaacgacccgttcgacgcttggggtccgggtaccgttgttaccgtttctccgccgaaaagctgcgataaaacccatacctgcccgccgtgcccgggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 39 - protein, 6 aa, Artificial Sequence
  6-amino acid target portion of AC8 heavy chain target polypeptide
VAYMLE

SEQ ID NO: 40 - protein, 122 aa, Artificial Sequence [sequence omitted]

SEQ ID NO: 41 - DNA, 48 bp, Artificial Sequence
  AC8 heavy chain CDR3
gttgcctatatgttggaacctaccgtcactgcagggggtttggacgtc

SEQ ID NO: 42 - DNA, 18 bp, Artificial Sequence
  18-nucleotide target portion of AC8 target polynucleotide
gttgcctatatgttggaa

SEQ ID NO: 43 - DNA, 4 bp, Artificial Sequence
  overhang
agct

SEQ ID NO: 44 - DNA, 112 bp, Artificial Sequence
  AC8HCDR3org (+)
tatgaagacacggccatgtattactgtgcgagagttgcctatatgttggaacctaccgtcactgcagggggtttggacgtctggggccaagggaccacggtcaccgtgagct

SEQ ID NO: 45 - DNA, 106 bp, Artificial Sequence
  AC8HCDR3org (-)
cacggtgaccgtggtcccttggccccagacgtccaaaccccctgcagtgacggtaggttccaacatataggcaactctcgcacagtaatacatggccgtgtcttca

SEQ ID NO: 46 - DNA, 112 bp, Artificial Sequence
  AC8HCDR3 (+)
tatgaagacacggccatgtattactgtgcgagannknnknnknnknnknnkcctaccgtcactgcagggggtttggacgtctggggccaagggaccacggtcaccgtgagct

SEQ ID NO: 47 - DNA, 106 bp, Artificial Sequence
  AC8HCDR3 (-)
cacggtgaccgtggtcccttggccccagacgtccaaaccccctgcagtgacggtaggmnnmnnmnnmnnmnnmnntctcgcacagtaatacatggccgtgtcttca

SEQ ID NO: 48 - DNA, 5371 bp, Artificial Sequence
  pET28(a)+ vector
atccggatatagttcctcctttcagcaaaaaacccctcaagacccgtttagaggccccaaggggttatgctagttattgctcagcggtggcagcagccaactcagcttcctttcgggctttgttagcagccggatctcagtggtggtggtggtggtgctcgagtgcggccgcaagcttgtcgacggagctcgaattcggatccgatatcagccatggaaccgcgtggcaccagggtacccagatctgggctgtccatgtgctggcgttcgaatttagcagcagcggtttctttcatatgtatatctccttcttaaagttaaacaaaattatttctagaggggaattgttatccgctcacaattcccctatagtgagtcgtattaatttcgcgggatcgagatcgatctcgatcctctacgccggacgcatcgtggccggcatcaccggcgccacaggtgcggttgctggcgcctatatcgccgacatcaccgatggggaagatcgggctcgccacttcgggctcatgagcgcttgtttcggcgtgggtatggtggcaggccccgtggccgggggactgttgggcgccatctccttgcatgcaccattccttgcggcggcggtgctcaacggcctcaacctactactgggctgcttcctaatgcaggagtcgcataagggagagcgtcgagatcccggacaccatcgaatggcgcaaaacctttcgcggtatggcatgatagcgcccggaagagagtcaattcagggtggtgaatgtgaaaccagtaacgttatacgatgtcgcagagtatgccggtgtctcttatcagaccgtttcccgcgtggtgaaccaggccagccacgtttctgcgaaaacgcgggaaaaagtggaagcggcgatggcggagctgaattacattcccaaccgcgtggcacaacaactggcgggcaaacagtcgttgctgattggcgttgccacctccagtctggccctgcacgcgccgtcgcaaattgtcgcggcgattaaatctcgcgccgatcaactgggtgccagcgtggtggtgtcgatggtagaacgaagcggcgtcgaagcctgtaaagcggcggtgcacaatcttctcgcgcaacgcgtcagtgggctgatcattaactatccgctggatgaccaggatgccattgctgtggaagctgcctgcactaatgttccggcgttatttcttgatgtctctgaccagacacccatcaacagtattattttctcccatgaagacggtacgcgactgggcgtggagcatctggtcgcattgggtcaccagcaaatcgcgctgttagcgggcccattaagttctgtctcggcgcgtctgcgtctggctggctggcataaatatctcactcgcaatcaaattcagccgatagcggaacgggaaggcgactggagtgccatgtccggttttcaacaaaccatgcaaatgctgaatgagggcatcgttcccactgcgatgctggttgccaacgatcagatggcgctgggcgcaatgcgcgccattaccgagtccgggctgcgcgttggtgcggacatctcggtagtgggatacgacgataccgaagacagctcatgttatatcccgccgttaaccaccatcaaacaggattttcgcctgctggggcaaaccagcgtggaccgcttgctgcaactctctcagggccaggcggtgaagggcaatcagctgttgcccgtctcactggtgaaaagaaaaaccaccctggcgcccaatacgcaaaccgcctctccccgcgcgttggccgattcattaatgcagctggcacgacaggtttcccgactggaaagcgggcagtgagcgcaacgcaattaatgtaagttagctcactcattaggcaccgggatctcgaccgatgcccttgagagccttcaacccagtcagctccttccggtgggcgcggggcatgactatcgtcgccgcacttatgactgtcttctttatcatgcaactcgtaggacaggtgccggcagcgctctgggtcattttcggcgaggaccgctttcgctggagcgcgacgatgatcggcctgtcgcttgcggtattcggaatcttgcacgccctcgctcaagccttcgtcactggtcccgccaccaaacgtttcggcgagaagcaggccattatcgccggcatggcggccccacgggtgcgcatgatcgtgctcctgtcgttgaggacccggctaggctggcggggttgccttactggttagcagaatgaatcaccgatacgcgagcgaacgtgaagcgactgctgctgcaaaacgtctgcgacctgagcaacaacatgaatggtcttcggtttccgtgtttcgtaaagtctggaaacgcggaagtcagcgccctgcaccattatgttccggatctgcatcgcaggatgctgctggctaccctgtggaacacctacatctgtattaacgaagcgctggcattgaccctgagtgatttttctctggtcccgccgcatccataccgccagttgtttaccctcacaacgttccagtaaccgggcatgttcatcatcagtaacccgtatcgtgagcatcctctctcgtttcatcggtatcattacccccatgaacagaaatcccccttacacggaggcatcagtgaccaaacaggaaaaaaccgcccttaacatggcccgctttatcagaagccagacattaacgcttctggagaaactcaacgagctggacgcggatgaacaggcagacatctgtgaatcgcttcacgaccacgctgatgagctttaccgcagctgcctcgcgcgtttcggtgatgacggtgaaaacctctgacacatgcagctcccggagacggtcacagcttgtctgtaagcggatgccgggagcagacaagcccgtcagggcgcgtcagcgggtgttggcgggtgtcggggcgcagccatgacccagtcacgtagcgatagcggagtgtatactggcttaactatgcggcatcagagcagattgtactgagagtgcaccatatatgcggtgtgaaataccgcacagatgcgtaaggagaaaataccgcatcaggcgctcttccgcttcctcgctcactgactcgctgcgctcggtcgttcggctgcggcgagcggtatcagctcactcaaaggcggtaatacggttatccacagaatcaggggataacgcaggaaagaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgaacaataaaactgtctgcttacataaacagtaatacaaggggtgttatgagccatattcaacgggaaacgtcttgctctaggccgcgattaaattccaacatggatgctgatttatatgggtataaatgggctcgcgataatgtcgggcaatcaggtgcgacaatctatcgattgtatgggaagcccgatgcgccagagttgtttctgaaacatggcaaaggtagcgttgccaatgatgttacagatgagatggtcagactaaactggctgacggaatttatgcctcttccgaccatcaagcattttatccgtactcctgatgatgcatggttactcaccactgcgatccccgggaaaacagcattccaggtattagaagaatatcctgattcaggtgaaaatattgttgatgcgctggcagtgttcctgcgccggttgcattcgattcctgtttgtaattgtccttttaacagcgatcgcgtatttcgtctcgctcaggcgcaatcacgaatgaataacggtttggttgatgcgagtgattttgatgacgagcgtaatggctggcctgttgaacaagtctggaaagaaatgcataaacttttgccattctcaccggattcagtcgtcactcatggtgatttctcacttgataaccttatttttgacgaggggaaattaataggttgtattgatgttggacgagtcggaatcgcagaccgataccaggatcttgccatcctatggaactgcctcggtgagttttctccttcattacagaaacggctttttcaaaaatatggtattgataatcctgatatgaataaattgcagtttcatttgatgctcgatgagtttttctaagaattaattcatgagcggatacatatttgaatgtatttagaaaaataaacaaataggggttccgcgcacatttccccgaaaagtgccacctgaaattgtaaacgttaatattttgttaaaattcgcgttaaatttttgttaaatcagctcattttttaaccaataggccgaaatcggcaaaatcccttataaatcaaaagaatagaccgagatagggttgagtgttgttccagtttggaacaagagtccactattaaagaacgtggactccaacgtcaaagggcgaaaaaccgtctatcagggcgatggcccactacgtgaaccatcaccctaatcaagttttttggggtcgaggtgccgtaaagcactaaatcggaaccctaaagggagcccccgatttagagcttgacggggaaagccggcgaacgtggcgagaaaggaagggaagaaagcgaaaggagcgggcgctagggcgctggcaagtgtagcggtcacgctgcgcgtaaccaccacacccgccgcgcttaatgcgccgctacagggcgcgtcccattcgcca

SEQ ID NO: 49 - DNA, 6145 bp, Artificial Sequence
  pAC8 sequence
tggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgaattaattcttagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagtttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaatcgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctagagcaagacgtttcccgttgaatatggctcataacaccccttgtattactgtttatgtaagcagacagttttattgttcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggggccgccatgccggcgataatggcctgcttctcgccgaaacgtttggtggcgggaccagtgacgaaggcttgagcgagggcgtgcaagattccgaataccgcaagcgacaggccgatcatcgtcgcgctccagcgaaagcggtcctcgccgaaaatgacccagagcgctgccggcacctgtcctacgagttgcatgataaagaagacagtcataagtgcggcgacgatagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatatccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatctcgatcccgcgaaattaatacgactcactataggggaattgtgagcggataacaattcccctctagaaataattttgtttaactttaagaaggagatataccatgaaaaagacagctatcgcgattgcagtggcactggctggtttcgctaccgtggcccaggcggccgagatagtcctcacgcagtctccaggcaccctgtctttgtctccaggggaaagagccaccctctcctgcagggccagtcagagtgttagtagcgcctacttagcctggtaccagcagaaacctggccaggctcccaggctcctcatctatggtgcatccagcagggccactggcatcccagacaggttcagtggcagtgggtctgggacagacttcactctcaccatcagcagactggaacctgaagattttgcagtgtattactgtcagcagtatggtaggtcacccactttcggcggagggaccaaggtggagatcaaaggtggttcgtctagatcttcctcctctggtggcggtggctcgggcggtggtggccaggtccagctcgtccagtcaggggctgaggtgaagaagcctgggtcctcggtgaaggtctcctgcaaggcttctggaggttccttcagcagctatgctatcaactgggtgcgacaggcccctggacaagggcttgagtggatgggagggctcatgcctatctttgggacaacaaactacgcacagaagttccaggacagactcacgattaccgcggacgtatccacgagtacagcctacatgcagctgagcggcctgacatatgaagacacggccatgtattactgtgcgagagttgcctatatgttggaacctaccgtcactgcagggggtttggacgtctggggccaagggaccacggtcaccgtgagctcagcttccaccaagggcggccaggccggccagcaccatcaccatcaccatggcgcatacccgtacgacgttccggactacgcttcttaggcggccgcactcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggat

SEQ ID NO: 50 - DNA, 72 bp, Artificial Sequence
  AC8 (reference sequence) clone
tattactgtgcgagagttgcctatatgttggaacctaccgtcactgcagggggtttggacgtctggggccaa

SEQ ID NO: 51 - protein, 24 aa, Artificial Sequence
  AC8 (reference sequence) clone
YYCARVAYMLEPTVTAGGLDVWGQ

SEQ ID NO: 52 - DNA, 72 bp, Artificial Sequence
  MXD 1 clone
tattactgtgcgagaagtggggatgaggggaagcctaccgtcactgcagggggtttggacgtctggggccaa

SEQ ID NO: 53 - protein, 24 aa, Artificial Sequence
  MXD 1 clone
YYCARSGDEGKPTVTAGGLDVWGQ

SEQ ID NO: 54 - DNA, 72 bp, Artificial Sequence
  MXD 3
tattactgtgcgagatttccgccttttacgcgtcctaccgtcactgcagggggtttggacgtctggggccaa

SEQ ID NO: 55 - protein, 24 aa, Artificial Sequence
  MXD 3
YYCARFPPFTRPTVTAGGLDVWGQ

SEQ ID NO: 56 - DNA, 72 bp, Artificial Sequence
  MXD 4
tattactgtgcgagacgtcagctttttcaaccgcctaccgtcactgcagggggtttggacgtctggggccaa

SEQ ID NO: 57 - protein, 24 aa, Artificial Sequence
  MXD 4
YYCARRQLFQPPTVTAGGLDVWGQ

SEQ ID NO: 58 - DNA, 72 bp, Artificial Sequence
  MXD 5
tattactgtgcgagacatagtccgcagttttggcctaccgtcactgcagggggtttggacgtctggggccaa

SEQ ID NO: 59 - protein, 24 aa, Artificial Sequence
  MXD 5
YYCARHSPQFWPTVTAGGLDVWGQ

SEQ ID NO: 60 - DNA, 72 bp, Artificial Sequence
  MXD 6
tattactgtgcgagacctagtccgcagttttggcctaccgtcactgcagggggtttggacgtctggggccaa

SEQ ID NO: 61 - protein, 24 aa, Artificial Sequence
  MXD 6
YYCARPSPQFWPTVTAGGLDVWGQ

SEQ ID NO: 62 - DNA, 72 bp, Artificial Sequence
  MXD 8
tattactgtgcgagaattgcggctagtcttttgcctaccgtcactgcagggggtttggacgtctggggccaa

SEQ ID NO: 63 - protein, 24 aa, Artificial Sequence
  MXD 8
YYCARIAASLLPTVTAGGLDVWGQ

SEQ ID NO: 64 - DNA, 72 bp, Artificial Sequence
  MXD 9
tattactgtgcgagaacttttacttgggaggctcctaccgtcactgcagggggtttggacgtctggggccaa

SEQ ID NO: 65 - protein, 24 aa, Artificial Sequence
  MXD 9
YYCARTFTWEAPTVTAGGLDVWGQ

SEQ ID NO: 66 - DNA, 72 bp, Artificial Sequence
  MXD 13
tattactgtgcgagagcggtggtgtaggttgggcctaccgtcactgcagggggtttggacgtctggggccaa

SEQ ID NO: 67 - protein, 24 aa, Artificial Sequence
  MXD 13
YYCARAVVXVGPTVTAGGLDVWGQ

SEQ ID NO: 68 - DNA, 72 bp, Artificial Sequence
  MXD 15
tattactgtgcgagacggagtgctcttgctcatcctaccgtcactgcagggggtttggacgtctggggccaa

SEQ ID NO: 69 - protein, 24 aa, Artificial Sequence
  MXD 15
YYCARRSALAHPTVTAGGLDVWGQ

SEQ ID NO: 70 - DNA, 72 bp, Artificial Sequence
  MXD 16
tattactgtgcgagactgcggccgattccgtttcctaccgtcactgcagggggtttggacgtctggggccaa

SEQ ID NO: 71 - protein, 24 aa, Artificial Sequence
  MXD 16
YYCARLRPIPFPTVTAGGLDVWGQ

SEQ ID NO: 72 - DNA, 72 bp, Artificial Sequence
  MXD 17
tattactgtgcgagaagttgggtgagtgtgccgcctaccgtcactgcagggggtttggacgtctggggccaa

SEQ ID NO: 73 - protein, 24 aa, Artificial Sequence
  MXD 17
YYCARSWVSVPPTVTAGGLDVWGQ

SEQ ID NO: 74 - DNA, 72 bp, Artificial Sequence
  MXD 18
tattactgtgcgagatagatggagttgaatttgcctaccgtcactgcagggggtttggacgtctggggccaa

SEQ ID NO: 75 - protein, 24 aa, Artificial Sequence
  MXD 18
YYCARXMELNLPTVTAGGLDVWGQ

SEQ ID NO: 76 - DNA, 72 bp, Artificial Sequence
  MXD 19
tattactgtgcgagagatctgctttatcttaggcctaccgtcactgcagggggtttggacgtctggggccaa

SEQ ID NO: 77 - protein, 24 aa, Artificial Sequence
  MXD 19
YYCARDLLYLRPTVTAGGLDVWGQ

SEQ ID NO: 78 - DNA, 72 bp, Artificial Sequence
  MXD 20
tattactgtgcgagagatttggataatcgtaggcctaccgtcactgcagggggtttggacgtctggggccaa

SEQ ID NO: 79 - protein, 24 aa, Artificial Sequence
  MXD 20
YYCARDLDNRRPTVTAGGLDVWGQ

SEQ ID NO: 80 - DNA, 72 bp, Artificial Sequence
  MXD 22
tattactgtgcgagacggatgatgatgggggtgcctaccgtcactgcagggggtttggacgtctggggccaa

SEQ ID NO: 81 - protein, 24 aa, Artificial Sequence
  MXD 22
YYCARRMMMGVPTVTAGGLDVWGQ

SEQ ID NO: 82 - DNA, 72 bp, Artificial Sequence
  MXD 23
tattactgtgcgagagggatgggttagtcgaggcctaccgtcactgcagggggtttggacgtctggggccaa

SEQ ID NO: 83 - protein, 24 aa, Artificial Sequence
  MXD 23
YYCARGMGXSRPTVTAGGLDVWGQ

SEQ ID NO: 84 - DNA, 72 bp, Artificial Sequence
  MXD 24
tattactgtgcgagaactccgacgaatcggactcctaccgtcactgcagggggtttggacgtctggggccaa

SEQ ID NO: 85 - protein, 24 aa, Artificial Sequence
  MXD 24
YYCARTPTNRTPTVTAGGLDVWGQ

SEQ ID NO: 86 - DNA, 6 bp, Artificial Sequence
  NdeI restriction site
catatg

SEQ ID NO: 87 - DNA, 5 bp, Artificial Sequence
  Sac1 restriction site overhang
gagct

SEQ ID NO: 88 - DNA, 124 bp, Artificial Sequence
  AC8HC3 mixed template(+)
agcggcctgacatatgaagacacggccatgtattactgtgcgagannknnknnknnknnknnkcctaccgtcactgcagggggtttggacgtctggggccaagggaccacggtcaccgtgagct

SEQ ID NO: 89 - DNA, 124 bp, Artificial Sequence
  AC8HC3 native template(+)
agcggcctgacatatgaagacacggccatgtattactgtgcgagagttgcctatatgttggaacctaccgtcactgcagggggtttggacgtctggggccaagggaccacggtcaccgtgagct

SEQ ID NO: 90 - DNA, 22 bp, Artificial Sequence
  AC8H3 fill-in-R
cacggtgaccgtggtcccttgg

SEQ ID NO: 91 - DNA, 72 bp, Artificial Sequence
  MFILL_ 1
tattactgtgcgagacgtgaggcggggttttggcctaccgtcactgcagggggtttggacgtctggggccaa

SEQ ID NO: 92 - protein, 24 aa, Artificial Sequence
  MFILL_ 1
YYCARREAGFWPTVTAGGLDVWGQ

SEQ ID NO: 93 - DNA, 72 bp, Artificial Sequence
  MFILL_ 2
tattactgtgcgagaaggctgacggtggtggggcctaccgtcactgcagggggtttggacgtctggggccaa

SEQ ID NO: 94 - protein, 24 aa, Artificial Sequence
  MFILL_ 2
YYCARRLTVVGPTVTAGGLDVWGQ

SEQ ID NO: 95 - DNA, 72 bp, Artificial Sequence
  MFILL_ 3
tattactgtgcgagaattatgagtacgcatttgcctaccgtcactgcagggggtttggacgtctggggccaa

SEQ ID NO: 96 - protein, 24 aa, Artificial Sequence
  MFILL_ 3
YYCARIMSTHLPTVTAGGLDVWGQ

SEQ ID NO: 97 - DNA, 72 bp, Artificial Sequence
  MFILL_ 4
tattactgtgcgagagagactgttgcgcagtcgcctaccgtcactgcagggggtttggacgtctggggccaa

SEQ ID NO: 98 - protein, 24 aa, Artificial Sequence
  MFILL_ 4
YYCARETVAQSPTVTAGGLDVWGQ

SEQ ID NO: 99 - DNA, 72 bp, Artificial Sequence
  MFILL_ 5
tattactgtgcgagatttggttgggttgattgtcctaccgtcactgcagggggtttggacgtctggggccaa

SEQ ID NO: 100 - protein, 24 aa, Artificial Sequence
  MFILL_ 5
YYCARFGWVDCPTVTAGGLDVWGQ

SEQ ID NO: 101 - DNA, 72 bp, Artificial Sequence
  MFILL_ 6
tattactgtgcgagatttgtgcagatgtagtggcctaccgtcactgcagggggtttggacgtctggggccaa

SEQ ID NO: 102 - protein, 24 aa, Artificial Sequence
  MFILL_ 6
YYCARFVQMXWPTVTAGGLDVWGQ

SEQ ID NO: 103 - DNA, 72 bp, Artificial Sequence
  MFILL_ 8
tattactgtgcgagacgtaatcttctggttaagcctaccgtcactgcagggggtttggacgtctggggccaa

SEQ ID NO: 104 - protein, 24 aa, Artificial Sequence
  MFILL_ 8
YYCARRNLLVKPTVTAGGLDVWGQ

SEQ ID NO: 105 - DNA, 72 bp, Artificial Sequence
  MFILL_ 11
tattactgtgcgagaagttctctgtggagggttcctaccgtcactgcagggggtttggacgtctggggccaa

SEQ ID NO: 106 - protein, 24 aa, Artificial Sequence
  MFILL_ 11
YYCARSSLWRVPTVTAGGLDVWGQ

SEQ ID NO: 107 - DNA, 72 bp, Artificial Sequence
  MFILL_ 12
tattactgtgcgagactggcggatatgtttaagcctaccgtcactgcagggggtttggacgtctggggccaa

SEQ ID NO: 108 - protein, 24 aa, Artificial Sequence
  MFILL_ 12
YYCARLADMFKPTVTAGGLDVWGQ

SEQ ID NO: 109 - DNA, 72 bp, Artificial Sequence
  MFILL_ 13
tattactgtgcgagatttcgttgttatgctactcctaccgtcactgcagggggtttggacgtctggggccaa

SEQ ID NO: 110 - protein, 24 aa, Artificial Sequence
  MFILL_ 13
YYCARFRCYATPTVTAGGLDVWGQ

SEQ ID NO: 111 - DNA, 72 bp, Artificial Sequence
  MFILL_ 15
tattactgtgcgagagggacggggacgcggtcgcctaccgtcactgcagggggtttggacgtctggggccaa

SEQ ID NO: 112 - protein, 24 aa, Artificial Sequence
  MFILL_ 15
YYCARGTGTRSPTVTAGGLDVWGQ

SEQ ID NO: 113 - DNA, 72 bp, Artificial Sequence
  MFILL_ 16
tattactgtgcgagacagctgagggagagtgttcctaccgtcactgcagggggtttggacgtctggggccaa

SEQ ID NO: 114 - protein, 24 aa, Artificial Sequence
  MFILL_ 16
YYCARQLRESVPTVTAGGLDVWGQ

SEQ ID NO: 115 - DNA, 72 bp, Artificial Sequence
  MFILL_ 17
tattactgtgcgagagctaagcggggttggactcctaccgtcactgcagggggtttggacgtctggggccaa

SEQ ID NO: 116 - protein, 24 aa, Artificial Sequence
  MFILL_ 17
YYCARAKRGWTPTVTAGGLDVWGQ

SEQ ID NO: 117 - DNA, 72 bp, Artificial Sequence
  MFILL_ 20
tattactgtgcgagactgcatgggcggcctatgcctaccgtcactgcagggggtttggacgtctggggccaa

SEQ ID NO: 118 - protein, 24 aa, Artificial Sequence
  MFILL_ 20
YYCARLHGRPMPTVTAGGLDVWGQ

SEQ ID NO: 119 - DNA, 72 bp, Artificial Sequence
  MFILL_ 21
tattactgtgcgagaagggttgagagtaggctgcctaccgtcactgcagggggtttggacgtctggggccaa

SEQ ID NO: 120 - protein, 24 aa, Artificial Sequence
  MFILL_ 21
YYCARRVESRLPTVTAGGLDVWGQ

SEQ ID NO: 121 - DNA, 72 bp, Artificial Sequence
  MFILL_ 22
tattactgtgcgagaacgggtggtgagggttcgcctaccgtcactgcagggggtttggacgtctggggccaa

SEQ ID NO: 122 - protein, 24 aa, Artificial Sequence
  MFILL_ 22
YYCARTGGEGSPTVTAGGLDVWGQ

SEQ ID NO: 123 - DNA, 72 bp, Artificial Sequence
  MFILL_ 23
tattactgtgcgagactgtttaagattggggtgcctaccgtcactgcagggggtttggacgtctggggccaa

SEQ ID NO: 124 - protein, 24 aa, Artificial Sequence
  MFILL_ 23
YYCARLFKIGVPTVTAGGLDVWGQ

SEQ ID NO: 125 - DNA, 72 bp, Artificial Sequence
  MFILL_ 24
tattactgtgcgagacgggataggaagcgttatcctaccgtcactgcagggggtttggacgtctggggccaa

SEQ ID NO: 126 - protein, 24 aa, Artificial Sequence
  MFILL_ 24
YYCARRDRKRYPTVTAGGLDVWGQ

SEQ ID NO: 127 - protein, 228 aa, Artificial Sequence
  3-ALA 2G12 domain exchanged Fab heavy chain (VH-CH1)
EVQLVESGGGLVKAGGSLILSCGVSNFRISAHTMNWVRRVPGGGLEWVASISTSSTYRDYADAVKGRFTVSRDDLEDFVYLQMHKMRVEDTAIYYCARKGSDRAADADPFDAWGPGTVVTVSPASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEPKSCLR

SEQ ID NO: 128 - protein, 228 aa, Artificial Sequence
  2G12 domain exchanged Fab heavy chain (VH-CH1)
EVQLVESGGGLVKAGGSLILSCGVSNFRISAHTMNWVRRVPGGGLEWVASISTSSTYRDYADAVKGRFTVSRDDLEDFVYLQMHKMRVEDTAIYYCARKGSDRLSDNDPFDAWGPGTVVTVSPASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEPKSCLR

SEQ ID NO: 129 - protein, 215 aa, Artificial Sequence
  2G12 and 3-ALA light chain (domain exchanged Fab)
AGVVMTQSPSTLSASVGDTITITCRASQSIETWLAWYQQKPGKAPKLLIYKASTLKTGVPSRFSGSGSGTEFTLTISGLQFDDFATYHCQHYAGYSATFGQGTRVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 130 - DNA, 684 bp, Artificial Sequence
  NT encoding 3-ALA 2G12 Fab  heavy chain
gaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtgcggcggacgcggacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcga

SEQ ID NO: 131 - DNA, 645 bp, Artificial Sequence
  NT encoding 3-ALA 2G12 and 2G12 Fab light chain
gccggtgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgc

SEQ ID NO: 132 - DNA, 24 bp, Artificial Sequence
  oligonucleotide pool A / primer A
gcccaggcggccgcagaagttcag

SEQ ID NO: 133 - DNA, 48 bp, Artificial Sequence
  oligonucleotide pool  B
gaacacgacgaacccagttcatmnnannagcagagatacggaagttag

SEQ ID NO: 134 - DNA, 48 bp, Artificial Sequence
  oligonucleotide pool  C
ctaacttccgtatctctgctnntnnkatgaactgggttcgtcgtgttc

SEQ ID NO: 135 - DNA, 72 bp, Artificial Sequence
  oligonucleotide pool  D
ccggaccccaagcgtcgaacggmnnmnngtcmnnannacggtcagamnntttacgagcgcagtagtagatag

SEQ ID NO: 136 - DNA, 398 bp, Artificial Sequence
  3-ALA 2G12 OFIM reference sequence polynucleotide
gcccaggcggccgcagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtgcggcggacgcggacccgttcgacgcttggggtccgggtaccgttgttaccgtttctccggcgtcgaccaaagg

SEQ ID NO: 137 - DNA, 76 bp, Artificial Sequence
  H1
ggccgcagaagttcagctggttgaatctggtggtggtctggttaaagctggtggttctctgatcctgtcttgcggt

SEQ ID NO: 138 - DNA, 84 bp, Artificial Sequence
  H2
gaagttagaaacaccgcaagacaggatcagagaaccaccagctttaaccagaccaccaccagattcaaccagctgaacttctgc

SEQ ID NO: 139 - DNA, 40 bp, Artificial Sequence
  H3
gtttctaacttccgtatctctgctnntnnkatgaactggg

SEQ ID NO: 140 - DNA, 40 bp, Artificial Sequence
  Reference sequence used to design H3
gtttctaacttccgtatctctgctcacaccatgaactggg

SEQ ID NO: 141 - DNA, 40 bp, Artificial Sequence
  H4
gaacacgacgaacccagttcatmnnannagcagagatacg

SEQ ID NO: 142 - DNA, 40 bp, Artificial Sequence
  Reference Sequence used to design H4
gaacacgacgaacccagttcatggtgtgagcagagatacg

SEQ ID NO: 143 - DNA, 82 bp, Artificial Sequence
  H5
ttcgtcgtgttccgggtggtggtctggaatgggttgcttctatctctacctcttctacctaccgtgactacgctgacgctgt

SEQ ID NO: 144 - DNA, 82 bp, Artificial Sequence
  H6
aaacgacctttaacagcgtcagcgtagtcacggtaggtagaagaggtagagatagaagcaacccattccagaccaccacccg

SEQ ID NO: 145 - DNA, 82 bp, Artificial Sequence
  H7
taaaggtcgtttcaccgtttctcgtgacgacctggaagacttcgtttacctgcagatgcataaaatgcgtgttgaagacacc

SEQ ID NO: 146 - DNA, 82 bp, Artificial Sequence
  H8
gtagtagatagcggtgtcttcaacacgcattttatgcatctgcaggtaaacgaagtcttccaggtcgtcacgagaaacggtg

SEQ ID NO: 147 - DNA, 69 bp, Artificial Sequence
  H9
gctatctactactgcgctcgtaaannktctgaccgtnntnnkgacnnknnkccgttcgacgcttggggt

SEQ ID NO: 148 - DNA, 69 bp, Artificial Sequence
  Reference Sequence Used to Design H9
gctatctactactgcgctcgtaaaggttctgaccgtctgtctgacaacgacccgttcgacgcttggggt

SEQ ID NO: 149 - DNA, 69 bp, Artificial Sequence
  H10
aacggtacccggaccccaagcgtcgaacggmnnmnngtcmnnannacggtcagamnntttacgagcgca

SEQ ID NO: 150 - DNA, 69 bp, Artificial Sequence
  Reference Sequence Used to Design H10
aacggtacccggaccccaagcgtcgaacgggtcgttgtcagacagacggtcagaacctttacgagcgca

SEQ ID NO: 151 - DNA, 30 bp, Artificial Sequence
  H11
ccgggtaccgttgttaccgtttctccggcg

SEQ ID NO: 152 - DNA, 22 bp, Artificial Sequence
  H12
tcgacgccggagaaacggtaac

SEQ ID NO: 153 - DNA, 107 bp, Artificial Sequence
  F1b
gcccaggcggccgcagaagttcagctggttgaatctggtggtggtctggttaaagctggtggttctctgatcctgtcttgtggtgtgagcaacttccgcatcagcgc

SEQ ID NO: 154 - DNA, 24 bp, Artificial Sequence
  F2b
tgatgcggaagttgctcacaccac

SEQ ID NO: 155 - DNA, 40 bp, Artificial Sequence
  F3b
cgtatcagcgctnntnnkatgaactgggtgcgccgtgtgc

SEQ ID NO: 156 - DNA, 40 bp, Artificial Sequence
  Reference Sequence used to design F3b
cgtatcagcgctcacaccatgaactgggtgcgccgtgtgc

SEQ ID NO: 157 - DNA, 124 bp, Artificial Sequence
  F4b
ggtcgtcccgggaaacggtgaaacgacctttaacagcgtcagcgtagtcacggtaggtagaagaggtagagatagaagcaacccattccagaccaccacccggcacacggcgcacccagttcat

SEQ ID NO: 158 - DNA, 92 bp, Artificial Sequence
  F5b
ccgtttctcgtgacgacctggaagacttcgtttacctgcagatgcataaaatgcgtgttgaagacaccgctatctactactgcgcgcgcaac

SEQ ID NO: 159 - DNA, 40 bp, Artificial Sequence
  F6b
gacagacggtcagamnngttgcgcgcgcagtagtagatag

SEQ ID NO: 160 - DNA, 40 bp, Artificial Sequence
  Reference Sequence used to design F6b
gacagacggtcagaaccgttgcgcgcgcagtagtagatag

SEQ ID NO: 161 - DNA, 50 bp, Artificial Sequence
  F7b
aggtagcgatcgtnntnnkgacnnknnkccgtttgacgcgtggggtccgg

SEQ ID NO: 162 - DNA, 50 bp, Artificial Sequence
  Reference Sequence used to design F7b
aggtagcgatcgtctgtctgacaacgacccgtttgacgcgtggggtccgg

SEQ ID NO: 163 - DNA, 58 bp, Artificial Sequence
  F8b
cctttggtcgacgccggagaaacggtaacaacggtacccggaccccacgcgtcaaacg

SEQ ID NO: 164 - DNA, 58 bp, Artificial Sequence; identical to SEQ ID NO: 163
  H0m Primer

SEQ ID NO: 165 - DNA, 48 bp, Artificial Sequence
  H0 Primer
gaagttagaaacaccgcaagacaggatcagagaaccaccagctttaac

SEQ ID NO: 166 - DNA, 66 bp, Artificial Sequence
  H1m Primer
cagaccaccaccagattcaaccagctgaacttctgcggccgcgttactgagcgatggcacagcggc

SEQ ID NO: 167 - DNA, 26 bp, Artificial Sequence
  H11m Primer
gccgctgtgccatcgctcagtaacgc

SEQ ID NO: 168 - DNA, 47 bp, Artificial Sequence
  H12m / CALX24H5-R Primer
gccgctgtgccatcgctcagtaacgtcgacgccggagaaacggtaac

SEQ ID NO: 169 - DNA, 23 bp, Artificial Sequence
  H1s-R Primer
agacaggatcagagaaccaccag

SEQ ID NO: 170 - DNA, 21 bp, Artificial Sequence
  H1L-F Primer
gcggccgcagaagttcagctg

SEQ ID NO: 171 - DNA, 24 bp, Artificial Sequence
  H1L-R Primer
agcagagatacggaagttagaaac

SEQ ID NO: 172 - DNA, 30 bp, Artificial Sequence
  H2-F Primer
tgcggtgtttctaacttccgtatctctgct

SEQ ID NO: 173 - DNA, 30 bp, Artificial Sequence
  H2-R Primer
accacccggaacacgacgaacccagttcat

SEQ ID NO: 174 - DNA, 24 bp, Artificial Sequence
  H3L-F Primer
atgaactgggttcgtcgtgttccg

SEQ ID NO: 175 - DNA, 24 bp, Artificial Sequence
  H3L-R Primer
tttacgagcgcagtagtagatagc

SEQ ID NO: 176 - DNA, 24 bp, Artificial Sequence
  H3S-F Primer
ggtctggaatgggttgcttctatc

SEQ ID NO: 177 - DNA, 24 bp, Artificial Sequence
  H3S-R Primer
ttcaacacgcattttatgcatctg

SEQ ID NO: 178 - DNA, 30 bp, Artificial Sequence
  H4-F Primer
gacaccgctatctactactgcgctcgtaaa

SEQ ID NO: 179 - DNA, 30 bp, Artificial Sequence
  H4-R Primer
aacggtacccggaccccaagcgtcgaacgg

SEQ ID NO: 180 - DNA, 21 bp, Artificial Sequence
  H5-F Primer
ccgttcgacgcttggggtccg

SEQ ID NO: 181 - DNA, 47 bp, Artificial Sequence
  CALX24H5-F Primer
gttaccgtttctccggcgtcgacgttactgagcgatggcacagcggc

SEQ ID NO: 182 - DNA, 39 bp, Artificial Sequence
  R1 Primer
ggcggcgctcttcagttagaaacaccgcaagacaggatc

SEQ ID NO: 183 - DNA, 35 bp, Artificial Sequence
  F2 Primer
ggcggcgctcttctcgtgttccgggtggtggtctg

SEQ ID NO: 184 - DNA, 37 bp, Artificial Sequence
  R2 Primer
ggcggcgctcttcagtagatagcggtgtcttcaacac

SEQ ID NO: 185 - DNA, 34 bp, Artificial Sequence
  F3 Primer
ggcggcgctcttcgggtccgggtaccgttgttac

SEQ ID NO: 186 - DNA, 44 bp, Artificial Sequence
  R3 Primer
gccgctgtgccatcgctcagtaacgtcgacgccggagaaacggt

SEQ ID NO: 187 - DNA, 39 bp, Artificial Sequence
  H1F Primer
aacttccgtatctctgctnntnnkatgaactgggttcgt

SEQ ID NO: 188 - DNA, 39 bp, Artificial Sequence
  H1R Primer
acgacgaacccagttcatmnnannagcagagatacggaa

SEQ ID NO: 189 - DNA, 60 bp, Artificial Sequence
  H3F Primer
tactactgcgctcgtaaannktctgaccgtnntnnkgacnnknnkccgttcgacgcttgg

SEQ ID NO: 190 - DNA, 60 bp, Artificial Sequence
  H3R Primer
accccaagcgtcgaacggmnnmnngtcmnnannacggtcagamnntttacgagcgcagta

SEQ ID NO: 191 - DNA, 70 bp, Artificial Sequence
  pCAL_0
agcggaagagcgcccaatacgcaaaccgcctctccccgcgcgttggccgattcattaatgcagctggcac

SEQ ID NO: 192 - DNA, 85 bp, Artificial Sequence
  pCAL_1
gacaggtttcccgactggaaagcgggcagtgagcgcaacgcaattaatgtgagttagctcactcattaggcaccccaggctttac

SEQ ID NO: 193 - DNA, 85 bp, Artificial Sequence
  pCAL_2
actttatgcttccggctcgtatgttgtgtggaattgtgagcggataacaattgaattaaggaggatataattatgaaatacctgc

SEQ ID NO: 194 - DNA, 85 bp, Artificial Sequence
  pCAL_3
tgccgaccgcagccgctggtctgctgctgctcgcggcccagccggccatggccgccggtgcctaactctggctggtttcgctacc

SEQ ID NO: 195 - DNA, 85 bp, Artificial Sequence
  pCAL_4
gtaaccggtttaattaataaggaggatataattatgaaaaagacagctatcgcgattgcagtggcactggctggtttcgctaccg

SEQ ID NO: 196 - DNA, 85 bp, Artificial Sequence
  pCAL_5
tagcccaggcggccgcacgcgtctggttgaatctggtggggtctggaattctgcgatcgcggccaggccggccgcaccatcacca

SEQ ID NO: 197 - DNA, 44 bp, Artificial Sequence
  pCAL_6
tcaccatggcgcatacccgtacgacgttccggactacgcttcta

SEQ ID NO: 198 - DNA, 70 bp, Artificial Sequence
  pCAL_7
ctagtagaagcgtagtccggaacgtcgtacgggtatgcgccatggtgatggtgatggtgcggccggcctg

SEQ ID NO: 199 - DNA, 85 bp, Artificial Sequence
  pCAL_8
gccgcgatcgcagaattccagaccccaccagattcaaccagacgcgtgcggccgcctgggctacggtagcgaaaccagccagtgc

SEQ ID NO: 200 - DNA, 85 bp, Artificial Sequence
  pCAL_9
cactgcaatcgcgatagctgtctttttcataattatatcctccttattaattaaaccggttacggtagcgaaaccagccagagtt

SEQ ID NO: 201 - DNA, 85 bp, Artificial Sequence
  pCAL_10
aggcaccggcggccatggccggctgggccgcgagcagcagcagaccagcggctgcggtcggcagcaggtatttcataattatatc

SEQ ID NO: 202 - DNA, 85 bp, Artificial Sequence
  pCAL_11
ctccttaattcaattgttatccgctcacaattccacacaacatacgagccggaagcataaagtgtaaagcctggggtgcctaatg

SEQ ID NO: 203 - DNA, 85 bp, Artificial Sequence
  pCAL_12
agtgagctaactcacattaattgcgttgcgctcactgcccgctttccagtcgggaaacctgtcgtgccagctgcattaatgaatc

SEQ ID NO: 204 - DNA, 45 bp, Artificial Sequence
  pCAL_13
ggccaacgcgcggggagaggcggtttgcgtattgggcgctcttcc

SEQ ID NO: 205 - DNA, 34 bp, Artificial Sequence
  SpeIG3-F Primer
ggtggtggttctggtactagttaggagggtggtg

SEQ ID NO: 206 - DNA, 52 bp, Artificial Sequence
  PvuINheIG3-R Primer
gggaagggcgatcgttagctagcttaagactccttattacgcagtatgttag

SEQ ID NO: 207 - DNA, 34 bp, Artificial Sequence
  SpeG3A-F Primer
ggtggtggttctggtactagttagaagggtggtg

SEQ ID NO: 208 - DNA, 923 bp, Artificial Sequence
  partial pAC8 sequence in vector
atgaaaaagacagctatcgcgattgcagtggcactggctggtttcgctaccgtggcccaggcggccgagatagtcctcacgcagtctccaggcaccctgtctttgtctccaggggaaagagccaccctctcctgcagggccagtcagagtgttagtagcgcctacttagcctggtaccagcagaaacctggccaggctcccaggctcctcatctatggtgcatccagcagggccactggcatcccagacaggttcagtggcagtgggtctgggacagacttcactctcaccatcagcagactggaacctgaagattttgcagtgtattactgtcagcagtatggtaggtcacccactttcggcggagggaccaaggtggagatcaaaggtggttcgtctagatcttcctcctctggtggcggtggctcgggcggtggtggccaggtccagctcgtccagtcaggggctgaggtgaagaagcctgggtcctcggtgaaggtctcctgcaaggcttctggaggttccttcagcagctatgctatcaactgggtgcgacaggcccctggacaagggcttgagtggatgggagggctcatgcctatctttgggacaacaaactacgcacagaagttccaggacagactcacgattaccgcggacgtatccacgagtacagcctacatgcagctgagcggcctgacatatgaagacacggccatgtattactgtgcgagagttgcctatatgttggaacctaccgtcactgcagggggtttggacgtctggggccaagggaccacggtcaccgtgagctcagcttccaccaagggcggccaggccggccagcaccatcaccatcaccatggcgcatacccgtacgacgttccggactacgcttcttaggagggtggtggctctgaggg

SEQ ID NO: 209 - protein, 108 aa, Artificial Sequence
  2G12 VL domain (also 3-ALA VL) 2
AGVVMTQSPSTLSASVGDTITITCRASQSIETWLAWYQQKPGKAPKLLIYKASTLKTGVPSRFSGSGSGTEFTLTISGLQFDDFATYHCQHYAGYSATFGQGTRVEIK

SEQ ID NO: 210 - DNA, 684 bp, Artificial Sequence
  NT encoding 2G12 Fab  heavy chain
gaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcga

SEQ ID NO: 211 - DNA, 27 bp, Artificial Sequence
  nt sequence encoding HA tag
tacccgtacgacgttccggactacgct

SEQ ID NO: 212 - protein, 9 aa, Artificial Sequence
  AA sequence - HA tag
YPYDVPDYA

SEQ ID NO: 213 - DNA, 6840 bp, Artificial Sequence; identical to SEQ ID NO: 34
  2G12 heavy and light chain in pET Duet vector (Fab)

SEQ ID NO: 214 - DNA, 37 bp, Artificial Sequence
  pCALVL-F Primer
ccatggccgccggtgttgttatgacccagtctccgtc

SEQ ID NO: 215 - DNA, 38 bp, Artificial Sequence
  pCALCK-R Primer
ctccttattaattaattagcattcaccacggttgaaag

SEQ ID NO: 216 - DNA, 41 bp, Artificial Sequence
  pCALCH-R Primer
ctggccgcgatcgcaggcaagatttcggttcaactttcttg

SEQ ID NO: 217 - DNA, 4765 bp, Artificial Sequence
  2G12 pCAL A1 vector
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcccagccggccatggccgccggtgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctaattaattaataaggaggatataattatgaaaaagacagctatcgcgattgcagtggcactggctggtttcgctaccgtagcccaggcggccgcagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcgatcgcggccaggccggccgcaccatcaccatcaccatggcgcatacccgtacgacgttccggactacgcttctactagttagaagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 218 - DNA, 40 bp, Artificial Sequence
  3Ala-R Primer
tcgaacgggtccgcgtccgccgcacggtcagaacctttac

SEQ ID NO: 219 - DNA, 40 bp, Artificial Sequence
  3Ala-F Primer
gttctgaccgtgcggcggacgcggacccgttcgacgcttg

SEQ ID NO: 220 - DNA, 23 bp, Artificial Sequence
  OmpA-F Primer
gtggcactggctggtttcgctac

SEQ ID NO: 221 - DNA, 48 bp, Artificial Sequence
  VLL1-R Primer
ggaggaagatccagacgaaccacctttgatttcaacacgggtaccctg

SEQ ID NO: 222 - DNA, 46 bp, Artificial Sequence
  L1VH-F Primer
ggtggctcgggcggtggtggcgaagttcagctggttgaatctggtg

SEQ ID NO: 223 - DNA, 46 bp, Artificial Sequence
  VHL2-R Primer
ctgctgctgctgccggatcctcccggagaaacggtaacaacggtac

SEQ ID NO: 224 - DNA, 46 bp, Artificial Sequence
  L2VH-F Primer
ggcgggagctccggcggcggagaagttcagctggttgaatctggtg

SEQ ID NO: 225 - DNA, 47 bp, Artificial Sequence
  VHL1-R Primer
ggaggaagatccagacgaaccacccggagaaacggtaacaacggtac

SEQ ID NO: 226 - DNA, 44 bp, Artificial Sequence
  L1VL-F Primer
ggtggctcgggcggtggtggcgttgttatgacccagtctccgtc

SEQ ID NO: 227 - DNA, 42 bp, Artificial Sequence
  VLSfi-R Primer
gtgctggccggcctggcctttgatttcaacacgggtaccctg

SEQ ID NO: 228 - DNA, 28 bp, Artificial Sequence
  Sfi6His-R Primer
gtgatggtgctggccggcctggcctttg

SEQ ID NO: 229 - DNA, 54 bp, Artificial Sequence
  Linker 1(-) (L1 prime)
gccaccaccgcccgagccaccgccaccagaggcggcagatccagacgaaccacc

SEQ ID NO: 230 - DNA, 54 bp, Artificial Sequence
  Linker 2(-) (L2 prime)
tccgccgccggagctcccgccgccgccgccgctgctgctgctgccggatcctcc

SEQ ID NO: 231 - DNA, 6819 bp, Artificial Sequence
  2G12 Fab in pET Duet vector
ggggaattgtgagcggataacaattcccctctagaaataattttgtttaactttaagaaggagatataccatgaaaaagacagctatcgcgattgcagtggcactggctggtttcgctaccgtggcccaggcggccgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctagggccaggccggccgcggccgcataatgcttaagtcgaacagaaagtaatcgtattgtacacggccgcataatcgaaattaatacgactcactataggggaattgtgagcggataacaattccccatcttagtatattagttaagtataagaaggagatatacatatgaaatacctattgcctacggcagccgctggattgttattactcgctgcccaaccagccatggccgaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcggcagcagccaccatcaccatcaccatggcgcatacccgtacgacgttccggactacgcttcttagctcgagtctggtaaagaaaccgctgctgcgaaatttgaacgccagcacatggactcgtctactagcgcagcttaattaacctaggctgctgccaccgctgagcaataactagcataaccccttggggcctctaaacgggtcttgaggggttttttgctgaaaggaggaactatatccggattggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttctggcggcacgatggcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactccccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgcaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaatacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatcatgattgaagcatttatcagggttattgtctcatgagcggatacatatttgaatgtatttagaaaaataaacaaataggtcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgctagtcatgccccgcgcccaccggaaggagctgactgggttgaaggctctcaagggcatcggtcgagatcccggtgcctaatgagtgagctaacttacattaattgcgttgcgctcactgcccgctttccagtcgggaaacctgtcgtgccagctgcattaatgaatcggccaacgcgcggggagaggcggtttgcgtattgggcgccagggtggtttttcttttcaccagtgagacgggcaacagctgattgcccttcaccgcctggccctgagagagttgcagcaagcggtccacgctggtttgccccagcaggcgaaaatcctgtttgatggtggttaacggcgggatataacatgagctgtcttcggtatcgtcgtatcccactaccgagatgtccgcaccaacgcgcagcccggactcggtaatggcgcgcattgcgcccagcgccatctgatcgttggcaaccagcatcgcagtgggaacgatgccctcattcagcatttgcatggtttgttgaaaaccggacatggcactccagtcgccttcccgttccgctatcggctgaatttgattgcgagtgagatatttatgccagccagccagacgcagacgcgccgagacagaacttaatgggcccgctaacagcgcgatttgctggtgacccaatgcgaccagatgctccacgcccagtcgcgtaccgtcttcatgggagaaaataatactgttgatgggtgtctggtcagagacatcaagaaataacgccggaacattagtgcaggcagcttccacagcaatggcatcctggtcatccagcggatagttaatgatcagcccactgacgcgttgcgcgagaagattgtgcaccgccgctttacaggcttcgacgccgcttcgttctaccatcgacaccaccacgctggcacccagttgatcggcgcgagatttaatcgccgcgacaatttgcgacggcgcgtgcagggccagactggaggtggcaacgccaatcagcaacgactgtttgcccgccagttgttgtgccacgcggttgggaatgtaattcagctccgccatcgccgcttccactttttcccgcgttttcgcagaaacgtggctggcctggttcaccacgcgggaaacggtctgataagagacaccggcatactctgcgacatcgtataacgttactggtttcacattcaccaccctgaattgactctcttccgggcgctatcatgccataccgcgaaaggttttgcgccattcgatggtgtccgggatctcgacgctctcccttatgcgactcctgcattaggaagcagcccagtagtaggttgaggccgttgagcaccgccgccgcaaggaatggtgcatgcaaggagatggcgcccaacagtcccccggccacggggcctgccaccatacccacgccgaaacaagcgctcatgagcccgaagtggcgagcccgatcttccccatcggtgatgtcggcgatataggcgccagcaaccgcacctgtggcgccggtgatgccggccacgatgcgtccggcgtagaggatcgagatcgatctcgatcccgcgaaattaatacgactcactata

SEQ ID NO: 232 - DNA, 58 bp, Artificial Sequence
  VHSfi-R  Primer
ccatggtgatggtgatggtgctggccggcctggcccggagaaacggtaacaacggtac

SEQ ID NO: 233 - DNA, 24 bp, Artificial Sequence
  AgeI-F Primer
ccctgaaaaccggtgttccgtctc

SEQ ID NO: 234 - DNA, 30 bp, Artificial Sequence
  Cys19-R Primer
caccgcaagacaggcacagagaaccaccag

SEQ ID NO: 235 - DNA, 30 bp, Artificial Sequence
  Cys19-F Primer
ctggtggttctctgtgcctgtcttgcggtg

SEQ ID NO: 236 - DNA, 25 bp, Artificial Sequence
  NcoI25- R Primer
ggtatgcgccatggtgatggtgatg

SEQ ID NO: 237 - DNA, 42 bp, Artificial Sequence
  VHhinge- F Primer
ccgtttctccgccgaaaagctgcgataaaacccatacctgcc

SEQ ID NO: 238 - DNA, 41 bp, Artificial Sequence
  HingeTemplate- F Primer
gctgcgataaaacccatacctgcccgccgtgcccgggccag

SEQ ID NO: 239 - DNA, 44 bp, Artificial Sequence
  HingeTemplate- R Primer
gatggtgatggtgctggccggcctggcccgggcacggcgggcag

SEQ ID NO: 240 - DNA, 38 bp, Artificial Sequence
  NcoI38- R Primer
gcggcgccatggtgatggtgatggtgctggccggcctg

SEQ ID NO: 241 - DNA, 45 bp, Artificial Sequence
  HingeVH(E)- R Primer
cgcagcttttcggttccggagaaacggtaacaacggtacccggac

SEQ ID NO: 242 - DNA, 45 bp, Artificial Sequence
  VHhinge(E)- F Primer
ccgtttctccggaaccgaaaagctgcgataaaacccatacctgcc

SEQ ID NO: 243 - DNA, 32 bp, Artificial Sequence
  NdeIVH- F Primer
ggagatatacatatgaaatacctattgcctac

SEQ ID NO: 244 - DNA, 26 bp, Artificial Sequence
  XhoIHA26- R Primer
taccagactcgagctaagaagcgtag

SEQ ID NO: 245 - DNA, 44 bp, Artificial Sequence
  HingeCH1- R Primer
caggtatgggttttatcgcagcttttcggttcaactttcttgtc

SEQ ID NO: 246 - DNA, 44 bp, Artificial Sequence; identical to SEQ ID NO: 245
  HingeCH1- R Primer

SEQ ID NO: 247 - DNA, 39 bp, Artificial Sequence
  CH1Hinge- F Primer
ccgaaaagctgcgataaaacccatacctgcccgccgtgc

SEQ ID NO: 248 - DNA, 45 bp, Artificial Sequence
  HingeHisTemplate- F Primer
cccatacctgcccgccgtgcccgcaccatcaccatcaccatggcg

SEQ ID NO: 249 - DNA, 47 bp, Artificial Sequence
  HingeHisTemplate- R Primer
gtccggaacgtcgtacgggtatgcgccatggtgatggtgatggtgcg

SEQ ID NO: 250 - DNA, 47 bp, Artificial Sequence
  XhoIHA- R Primer
accagactcgagctaagaagcgtagtccggaacgtcgtacgggtatg

SEQ ID NO: 251 - DNA, 26 bp, Artificial Sequence
  XbaIVL-F Primer
ggggaattgtgagcggataacaattc

SEQ ID NO: 252 - DNA, 51 bp, Artificial Sequence
  BamHICK-R Primer
ccgccaccggatccaccaccagattcaccacggttgaaagatttggtaacc

SEQ ID NO: 253 - DNA, 42 bp, Artificial Sequence
  SacIVH-F Primer
gcggtgggagctccggtgaagttcagctggttgaatctggtg

SEQ ID NO: 254 - DNA, 51 bp, Artificial Sequence
  HingeCH1deltaC-R Primer
ctggccggcctggccgctgctgccagatttcggttcaactttcttgtcaac

SEQ ID NO: 255 - DNA, 46 bp, Artificial Sequence
  NcoIHinge-R Primer
gtatgcgccatggtgatggtgatggtgctggccggcctggccgctg

SEQ ID NO: 256 - DNA, 79 bp, Artificial Sequence
  SacIBamHI(-) Primer
cccaccgctaccgccgccttcgctgccgccaccttcgctaccgccaccttcgctgccaccaccttcgctgccgccaccg

SEQ ID NO: 257 - DNA, 33 bp, Artificial Sequence
  L216F Primer
gatccggcagcagcagcagcggcggcgggagct

SEQ ID NO: 258 - DNA, 25 bp, Artificial Sequence
  L216R Primer
cccgccgccgctgctgctgctgccg

SEQ ID NO: 259 - DNA, 36 bp, Artificial Sequence
  L217F Primer
gatccggcagcagcagcagcggcggcggcgggagct

SEQ ID NO: 260 - DNA, 28 bp, Artificial Sequence
  L217R Primer
cccgccgccgccgctgctgctgctgccg

SEQ ID NO: 261 - DNA, 42 bp, Artificial Sequence
  L219F Primer
gatccagcggcagcagcagcagcggcggcggcggcgggagct

SEQ ID NO: 262 - DNA, 34 bp, Artificial Sequence
  L219R Primer
cccgccgccgccgccgctgctgctgctgccgctg

SEQ ID NO: 263 - DNA, 45 bp, Artificial Sequence
  L220F Primer
gatccagcggcggcagcagcagcagcggcggcggcggcgggagct

SEQ ID NO: 264 - DNA, 37 bp, Artificial Sequence
  L220R Primer
cccgccgccgccgccgctgctgctgctgccgccgctg

SEQ ID NO: 265 - DNA, 39 bp, Artificial Sequence
  Reference sequence used to design H1F
aacttccgtatctctgctcacaccatgaactgggttcgt

SEQ ID NO: 266 - DNA, 39 bp, Artificial Sequence
  Reference sequence used to design H1R
acgacgaacccagttcatggtgtgagcagagatacggaa

SEQ ID NO: 267 - DNA, 60 bp, Artificial Sequence
  Reference sequence used to design H3F
tactactgcgctcgtaaaggttctgaccgtctgtctgacaacgacccgttcgacgcttgg

SEQ ID NO: 268 - DNA, 60 bp, Artificial Sequence
  Reference sequence used to design H3R
accccaagcgtcgaacgggtcgttgtcagacagacggtcagaacctttacgagcgcagta

SEQ ID NO: 269 - protein, 225 aa, Artificial Sequence
  2G12 Fab VH-CH1
EVQLVESGGGLVKAGGSLILSCGVSNFRISAHTMNWVRRVPGGGLEWVASISTSSTYRDYADAVKGRFTVSRDDLEDFVYLQMHKMRVEDTAIYYCARKGSDRLSDNDPFDAWGPGTVVTVSPASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEPKS

SEQ ID NO: 270 - protein, 212 aa, Artificial Sequence
  2G12 Fab VL
VVMTQSPSTLSASVGDTITITCRASQSIETWLAWYQQKPGKAPKLLIYKASTLKTGVPSRFSGSGSGTEFTLTISGLQFDDFATYHCQHYAGYSATFGQGTRVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGE

SEQ ID NO: 271 - DNA, 7 bp, Artificial Sequence
  reverse complement Sap-I cleavage site
gaagagc

SEQ ID NO: 272 - DNA, 72 bp, Artificial Sequence
  Pel B leader
atgaaatacctgctgccgaccgcagccgctggtctgctgctgctcgcggcccagccggccatggccgccggt

SEQ ID NO: 273 - protein, 24 aa, Artificial Sequence
  Pel B leader
MKYLLPTAAAGLLLLAAQPAMAAG

SEQ ID NO: 274 - DNA, 72 bp, Artificial Sequence
  Pel B leader amber stop
atgaaatacctgctgccgaccgcagccgctggtctgctgctgctcgcggcctagccggccatggccgccggt

SEQ ID NO: 275 - protein, 17 aa, Artificial Sequence
  Pel B leader amber stop
MKYLLPTAAAGLLLLAA

SEQ ID NO: 276 - DNA, 69 bp, Artificial Sequence
  OmpA leader
atgaaaaagacagctatcgcgattgcagtggcactggctggtttcgctaccgtagcccaggcggccgca

SEQ ID NO: 277 - protein, 23 aa, Artificial Sequence
  OmpA leader
MKKTAIAIAVALAGFATVAQAAA

SEQ ID NO: 278 - DNA, 69 bp, Artificial Sequence
  OmpA leader amber stop
atgaaaaagacagctatcgcgattgcagtggcactggctggtttcgctaccgtagcctaggcggccgca

SEQ ID NO: 279 - protein, 19 aa, Artificial Sequence
  OmpA leader amber stop
MKKTAIAIAVALAGFATVA

SEQ ID NO: 280 - DNA, 5882 bp, Artificial Sequence
  2G12 pCAL IT*
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcgacaccatcgaatggcgcaaaacctttcgcggtatggcatgatagcgcccggaagagagtcaattcagggtggtgaatgtgaaaccagtaacgttatacgatgtcgcagagtatgccggtgtctcttatcagaccgtttcccgcgtggtgaaccaggccagccacgtttctgcgaaaacgcgggaaaaagtggaagcggcgatggcggagctgaattacattcccaaccgcgtggcacaacaactggcgggcaaacagtcgttgctgattggcgttgccacctccagtctggccctgcacgcgccgtcgcaaattgtcgcggcgattaaatctcgcgccgatcaactgggtgccagcgtggtggtgtcgatggtagaacgaagcggcgtcgaagcctgtaaagcggcggtgcacaatcttctcgcgcaacgcgtcagtgggctgatcattaactatccgctggatgaccaggatgccattgctgtggaagctgcctgcactaatgttccggcgttatttcttgatgtctctgaccagacacccatcaacagtattattttctcccatgaagacggtacgcgactgggcgtggagcatctggtcgcattgggtcaccagcaaatcgcgctgttagcgggcccattaagttctgtctcggcgcgtctgcgtctggctggctggcataaatatctcactcgcaatcaaattcagccgatagcggaacgggaaggcgactggagtgccatgtccggttttcaacaaaccatgcaaatgctgaatgagggcatcgttcccactgcgatgctggttgccaacgatcagatggcgctgggcgcaatgcgcgccattaccgagtccgggctgcgcgttggtgcggatatctcggtagtgggatacgacgataccgaagacagctcatgttatatcccgccgttaaccaccatcaaacaggattttcgcctgctggggcaaaccagcgtggaccgcttgctgcaactctctcagggccaggcggtgaagggcaatcagctgttgcccgtctcactggtgaaaagaaaaaccaccctggcgcccaatacgcaaaccgcctctccccgcgcgttggccgattcattaatgcagctggcacgacaggtttcccgactggaaagcgggcagtgagcggtacccgataaaagcggcttcctgacaggaggccgttttgttttgcagcccacctcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcctagccggccatggccgccggtgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctaattaattaataaggaggatataattatgaaaaagacagctatcgcgattgcagtggcactggctggtttcgctaccgtagcctaggcggccgcagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcgatcgcggccaggccggccgcaccatcaccatcaccatggcgcatacccgtacgacgttccggactacgcttctactagttaggagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 281 - DNA, 5882 bp, Artificial Sequence
  2G12 pCAL ITPO vector
gtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcgacaccatcgaatggcgcaaaacctttcgcggtatggcatgatagcgcccggaagagagtcaattcagggtggtgaatgtgaaaccagtaacgttatacgatgtcgcagagtatgccggtgtctcttatcagaccgtttcccgcgtggtgaaccaggccagccacgtttctgcgaaaacgcgggaaaaagtggaagcggcgatggcggagctgaattacattcccaaccgcgtggcacaacaactggcgggcaaacagtcgttgctgattggcgttgccacctccagtctggccctgcacgcgccgtcgcaaattgtcgcggcgattaaatctcgcgccgatcaactgggtgccagcgtggtggtgtcgatggtagaacgaagcggcgtcgaagcctgtaaagcggcggtgcacaatcttctcgcgcaacgcgtcagtgggctgatcattaactatccgctggatgaccaggatgccattgctgtggaagctgcctgcactaatgttccggcgttatttcttgatgtctctgaccagacacccatcaacagtattattttctcccatgaagacggtacgcgactgggcgtggagcatctggtcgcattgggtcaccagcaaatcgcgctgttagcgggcccattaagttctgtctcggcgcgtctgcgtctggctggctggcataaatatctcactcgcaatcaaattcagccgatagcggaacgggaaggcgactggagtgccatgtccggttttcaacaaaccatgcaaatgctgaatgagggcatcgttcccactgcgatgctggttgccaacgatcagatggcgctgggcgcaatgcgcgccattaccgagtccgggctgcgcgttggtgcggatatctcggtagtgggatacgacgataccgaagacagctcatgttatatcccgccgttaaccaccatcaaacaggattttcgcctgctggggcaaaccagcgtggaccgcttgctgcaactctctcagggccaggcggtgaagggcaatcagctgttgcccgtctcactggtgaaaagaaaaaccaccctggcgcccaatacgcaaaccgcctctccccgcgcgttggccgattcattaatgcagctggcacgacaggtttcccgactggaaagcgggcagtgagcggtacccgataaaagcggcttcctgacaggaggccgttttgttttgcagcccacctcaacgcaattaatgtgagttagctcactcattaggcaccccaggctttacactttatgcttccggctcgtatgttgtgtggaattgtgagcggataacaattgaattaaggaggatataattatgaaatacctgctgccgaccgcagccgctggtctgctgctgctcgcggcccagccggccatggccgccggtgttgttatgacccagtctccgtctaccctgtctgcttctgttggtgacaccatcaccatcacctgccgtgcttctcagtctatcgaaacctggctggcttggtaccagcagaaaccgggtaaagctccgaaactgctgatctacaaggcttctaccctgaaaaccggtgttccgtctcgtttctctggttctggttctggtaccgagttcaccctgaccatctctggtctgcagttcgacgacttcgctacctaccactgccagcactacgctggttactctgctaccttcggtcagggtacccgtgttgaaatcaaacgtaccgttgctgctccgtctgttttcatcttcccgccgtctgacgaacagctgaaatctggtaccgcttctgttgtttgcctgctgaacaacttctacccgcgtgaagctaaagttcagtggaaagttgacaacgctctgcagtctggtaactctcaggaatctgttaccgaacaggactctaaagactctacctactctctgtcttctaccctgaccctgtctaaagctgactacgaaaagcacaaagtttacgcttgcgaagttacccaccagggtctgtcttctccggttaccaaatctttcaaccgtggtgaatgctaattaattaataaggaggatataattatgaaaaagacagctatcgcgattgcagtggcactggctggtttcgctaccgtagcccaggcggccgcagaagttcagctggttgaatctggtggtggtctggttaaagctggtggttctctgatcctgtcttgcggtgtttctaacttccgtatctctgctcacaccatgaactgggttcgtcgtgttccgggtggtggtctggaatgggttgcttctatctctacctcttctacctaccgtgactacgctgacgctgttaaaggtcgtttcaccgtttctcgtgacgacctggaagacttcgtttacctgcagatgcataaaatgcgtgttgaagacaccgctatctactactgcgctcgtaaaggttctgaccgtctgtctgacaacgacccgttcgacgcttggggtccgggtaccgttgttaccgtttctccggcgtcgaccaaaggtccgtctgttttcccgctggctccgtcttctaaatctacctctggtggtaccgctgctctgggttgcctggttaaagactacttcccggaaccggttaccgtttcttggaactctggtgctctgacctctggtgttcacaccttcccggctgttctgcagtcttctggtctgtactctctgtcttctgttgttaccgttccgtcttcttctctgggtacccagacctacatctgcaacgttaaccacaaaccgtctaacaccaaagttgacaagaaagttgaaccgaaatcttgcctgcgatcgcggccaggccggccgcaccatcaccatcaccatggcgcatacccgtacgacgttccggactacgcttctactagttaggagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaagctagctaacgatcgcccttcccaacagttgcgcagcctgaatggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgcttacaatttag

SEQ ID NO: 282 - DNA, 41 bp, Artificial Sequence
  LacITerm-F1 Primer
ggcgccgctcttcgagcgacaccatcgaatggcgcaaaacc

SEQ ID NO: 283 - DNA, 41 bp, Artificial Sequence
  LacITerm-R1 Primer
cttttatcgggtaccgctcactgcccgctttccagtcggga

SEQ ID NO: 284 - DNA, 58 bp, Artificial Sequence
  Term-R Primer
gctaggtgggctgcaaaacaaaacggcctcctgtcaggaagccgcttttatcgggtac

SEQ ID NO: 285 - DNA, 41 bp, Artificial Sequence
  LacITerm-F2 Primer
aaagcgggcagtgagcggtacccgataaaagcggcttcctg

SEQ ID NO: 286 - DNA, 41 bp, Artificial Sequence
  TermPO-R Primer
cacattaattgcgttgaggtgggctgcaaaacaaaacggcc

SEQ ID NO: 287 - DNA, 41 bp, Artificial Sequence
  TermPO-F Primer
gttttgcagcccacctcaacgcaattaatgtgagttagctc

SEQ ID NO: 288 - DNA, 30 bp, Artificial Sequence
  SgrAIPelB-R Primer
cataacaacaccggcggccatggccggctg

SEQ ID NO: 289 - DNA, 20 bp, Artificial Sequence
  SeqpCALTerm-F Primer
taaccgtattaccgcctttg

SEQ ID NO: 290 - DNA, 20 bp, Artificial Sequence
  SeqpCALTerm-R Primer
tgccagctgcattaatgaat

SEQ ID NO: 291 - DNA, 21 bp, Artificial Sequence
  SeqpCALIT-R Primer
cataactcacattaattgcgt

SEQ ID NO: 292 - DNA, 20 bp, Artificial Sequence
  SeqITPO-F2 Primer
gttgcccgtctcactggtga

SEQ ID NO: 293 - DNA, 25 bp, Artificial Sequence
  KasI-F Primer
ccaccctggcgcccaatacgcaaac

SEQ ID NO: 294 - DNA, 37 bp, Artificial Sequence
  AmbPelB-R Primer
gcggccatggccggctaggccgcgagcagcagcagac

SEQ ID NO: 295 - DNA, 37 bp, Artificial Sequence
  AmbPelB-F Primer
tgctgctcgcggcctagccggccatggccgccggtgt

SEQ ID NO: 296 - DNA, 36 bp, Artificial Sequence
  AmbOmpA-R Primer
gaacttctgcggccgcctaggctacggtagcgaaac

SEQ ID NO: 297 - DNA, 20 bp, Artificial Sequence
  SeqHCFR1-R Primer
ttagaaacaccgcaagacag

SEQ ID NO: 298 - DNA, 20 bp, Artificial Sequence
  SeqpCAL-F Primer
atataattatgaaatacctg

SEQ ID NO: 299 - DNA, 20 bp, Artificial Sequence
  SeqITPO-F4 Primer
gcgtggaccgcttgctgcaa

(19) United States
(12) Patent Application Publication
(10) Pub. No.: US 2010/0081575 A1
(43) Pub. Date: Apr. 1, 2010

(54) Methods for creating diversity in libraries and libraries, display vectors and methods, and displayed molecules

(76) Inventors: Robert Anthony Williamson, La Jolla, CA (US); Jehangir Wadia, San Diego, CA (US); Toshiaki Maruyama, La Jolla, CA (US); Zhifeng Chen, Vista, CA (US); Joshua Nelson, La Jolla, CA (US)

Correspondence Address: K&L Gates LLP, 3580 Carmel Mountain Road, Suite 200, San Diego, CA, 92130, US

(21) Appl. No.: 12/586,273

(22) Filed: Sep. 18, 2009

Related U.S. Application Data
(60) Provisional application No. 61/192,916, filed on Sep. 22, 2008.

(51) Int. Cl. C40B 10/00; C40B 40/06; C40B 40/10; C40B 50/00; C40B 50/06

(52) U.S. Cl. 506/1; 506/16; 506/18; 506/23; 506/26

(57) ABSTRACT

Provided herein are methods for generating diverse polypeptide and nucleic acid molecule libraries and collections, and the collections and libraries; methods for selecting variant polypeptides and nucleic acid molecules from the libraries; and molecules selected from the libraries. Exemplary of the polypeptides and nucleic acid molecules are antibodies and nucleic acids encoding the antibodies (including antibody fragments and domain exchanged antibodies). Also provided herein are methods of displaying polypeptides such as antibodies, for example on the surface of genetic packages, such as phage; and libraries and collections of the displayed polypeptides and vectors for producing the displayed polypeptides, libraries and collections. Exemplary of the displayed antibodies are domain exchanged antibodies.

### RELATED APPLICATIONS

Benefit of priority is claimed to U.S. Provisional Application Ser. No. 61/192,916 to Robert Anthony Williamson, Jehangir Wadia, Toshiaki Maruyama, Zhifeng Chen and Joshua Nelson, entitled “METHODS FOR CREATING DIVERSITY IN LIBRARIES AND LIBRARIES, DISPLAY VECTORS AND METHODS, AND DISPLAYED MOLECULES,” filed on Sep. 22, 2008.

This application is related to corresponding International Application No. [Attorney Docket No. 3800013-00032/1106PC] to Robert Anthony Williamson, Jehangir Wadia, Toshiaki Maruyama, Zhifeng Chen and Joshua Nelson, entitled “METHODS FOR CREATING DIVERSITY IN LIBRARIES AND LIBRARIES, DISPLAY VECTORS AND METHODS, AND DISPLAYED MOLECULES,” which also claims priority to U.S. Provisional Application Ser. No. 61/192,916.

This application also is related to U.S. Application No. [Attorney Docket No. 3800013-00033/1107] to Robert Anthony Williamson, Jehangir Wadia, Toshiaki Maruyama, Zhifeng Chen and Joshua Nelson, entitled “METHODS AND VECTORS FOR DISPLAY OF MOLECULES AND DISPLAYED MOLECULES AND COLLECTIONS,” filed on the same day herewith, and to International Patent Application. [Attorney Docket No. 3800013-000034/1107PC] to Robert Anthony Williamson, Jehangir Wadia, Toshiaki Maruyama, Zhifeng Chen and Joshua Nelson, entitled “METHODS AND VECTORS FOR DISPLAY OF MOLECULES AND DISPLAYED MOLECULES AND COLLECTIONS,” filed on the same day herewith.

The subject matter of each of the above-referenced applications is incorporated by reference in its entirety.

### INCORPORATION BY REFERENCE OF SEQUENCE LISTING PROVIDED ON COMPACT DISCS

An electronic version on compact disc (CD-R) of the Sequence Listing is filed herewith in duplicate (labeled Copy # 1 and Copy # 2), the contents of which are incorporated by reference in their entirety. The computer-readable file on each of the aforementioned compact discs, created on Sep. 18, 2009, is identical, 215 kilobytes in size, and titled 1106SEQ.001.txt.

### FIELD OF INVENTION

Provided herein are methods for generating diverse polypeptide and nucleic acid molecule libraries and collections, the libraries and collections, and methods of displaying polypeptides such as antibodies, libraries and collections of the displayed polypeptides and vectors for producing the displayed polypeptides, libraries and collections.

### BACKGROUND

### Methods for Generating Diversity

Natural evolution diversifies proteins through mutation, recombination and selection. Methods for rapidly introducing genetic diversity in vitro are needed for a variety of applications, including protein analysis, protein therapeutics and directed evolution. Protein libraries can be used to select variant proteins with desired properties in vitro. Targeted and non-targeted approaches for introducing diversity in protein libraries have been employed; all have limitations.

Non-targeted approaches, generally, introduce diversity at random positions within a coding nucleotide sequence. Among non-targeted approaches are chain shuffling and gene assembly (Marks et al., J. Mol. Biol. (1991) 222, 581-597; Barbas et al., Proc. Natl. Acad. Sci. USA (1991) 88, 7978-7982; and U.S. Pat. Nos. 6,291,161, 6,291,160, 6,291,159, 6,680,192, 6,291,158, and 6,969,586), DNA shuffling (Stemmer, Nature (1994) 340, 389-391; Stemmer, Proc. Natl. Acad. Sci. USA (1994) 10747-10751; and U.S. Pat. No. 6,576,467), error-prone PCR (Zhou et al., Nucleic Acids Research (1991) 19(21), 6052; US2004/0110294) and growth in mutator E. coli strains (Coia et al., J Immunol Methods (2001) 251(1-2) 187-193).

Targeted approaches, by contrast, introduce diversity in specific regions of a coding nucleotide sequence. Exemplary of these approaches are cassette mutagenesis (Wells et al., Gene (1985) 34, 315-323; Oliphant et al., Gene (1986) 44, 177-183; Borrego et al., Nucleic Acids Research (1995) 23, 1834-1835; Oliphant and Strul Proc. Natl. Acad. Sci. USA (1989) 86, 9094-9098), oligonucleotide directed mutagenesis (Rosok et al., The Journal of Immunology, (1998) 160, 2353-2359), codon cassette mutagenesis (Kegler-Ebo et al., Nucleic Acids Research, (1994) 22(9), 1593-1599) and degenerate primer PCR, including two-step PCR and overlap PCR (U.S. Pat. Nos. 5,545,142, 6,248,516, and 7,189,841; Higuchi et al., Nucleic Acids Research (1988); 16(15), 7351-7367; and Dubreuil et al., The Journal of Biological Chemistry (2005) 280(26), 24880-24887). Combined targeted/non-targeted approaches also have been used (Crameri and Stemmer, Biotechniques, (1995), 18(2), 194-6; and US2007/0077572). Each of these approaches has limitations.

Domain Exchanged Antibodies

Domain exchanged antibodies have non-conventional “exchanged” three-dimensional structures, in which the variable heavy chain domain “swings away” from its cognate light chain and interacts instead with the “opposite” light chain, such that the two heavy chains are interlocked. This unusual folding and pairing creates an interface between the two adjacent heavy chain variable regions (V_{H}-V_{H}′ interface). This interface can contribute to a non-conventional antigen binding site containing residues from each V_{H} domain, such that domain exchanged antibodies can contain a non-conventional binding site and two conventional binding sites. In one example, mutations in the heavy chain framework contribute to and/or stabilize the domain exchanged configuration. For example, mutation(s) in the joining region between the V_{H} and C_{H} domains can contribute to the domain exchanged configuration. In another example, mutations along the V_{H}-V_{H}′ interface can stabilize the domain-exchanged configuration (see, for example, Published U.S. Application, Publication No.: US20050003347).

The domain exchanged structure, including constrained antibody combining sites, can facilitate antigen binding within densely packed and/or repetitive epitopes, for example, sugar residues on bacterial or viral surfaces, such as, for example, epitopes within high density arrays (e.g. in pathogens and tumor cells) that can be poorly recognized by conventional antibodies.

Methods are needed for creating diversity in domain exchanged antibodies and for display of domain exchanged antibodies, and for making display libraries for production and selection of new domain exchange antibodies. Accordingly, it is among the objects herein to provide methods for creating diversity in polynucleotides and proteins and creating diverse protein and nucleic acid libraries and also to provide methods for producing display libraries for producing and selecting domain exchanged antibodies and new domain exchanged antibodies produced by the methods.

### SUMMARY

Provided herein are methods for introducing genetic diversity into polypeptides and polynucleotides, and for creating diverse libraries, including nucleic acid libraries and expression libraries, such as phage display libraries; and libraries, nucleic acids (e.g. randomized nucleic acids and vectors) and polypeptides (e.g. variant polypeptides) produced according to the methods. The polynucleotide libraries (collections of polynucleotides) contain variant and/or randomized polynucleotides, which differ in nucleic acid sequence compared to a target polynucleotide, such as an antibody-encoding polynucleotide, and to other polynucleotide members of the libraries. Likewise, the polypeptide libraries (collections) contain variant polypeptides, which vary compared to a target polypeptide, such as an antibody, and compared to other polypeptide members of the collection. Also provided are are methods and vectors for display of domain exchanged antibodies, display libraries expressing domain exchange antibodies, displayed domain exchanged antibodies, methods for selecting domain exchanged antibodies from the libraries, and domain exchanged antibodies selected from the libraries.

Provided are methods for producing collections of polynucleotides, such as collections of variant and/or. randomized polynucleotides, and the polynucleotides produced by the methods. The variant and randomized polynucleotides include polynucleotides, such as oligonucleotides, typically synthetic oligonucleotides; and assembled polynucleotides; polynucleotide duplexes, such as oligonucleotide duplexes and assembled polynucleotide duplexes (assembled duplexes); and duplex cassettes, such as assembled polynucleotide duplex cassettes (assembled duplex cassettes). The assembled duplexes and duplex cassettes include large assembled duplex cassettes, which contain, for example, greater than at or about 200, 250, 300, 350, 400, 450, 500, 550, 600, 650, 700, 750, 800, 850, 900, 950, 1000, 1500, 2000 or more nucleotides in length.

The collections of polynucleotides produced by the methods include collections of variant polynucleotides, such as variant polynucleotide duplexes (e.g. variant assembled polynucleotide duplexes). The variant duplex collections include collections of randomized polynucleotide duplexes. The variant polynucleotides contain identity to a target polynucleotide or to a region of a target polynucleotide (e.g. a functional or structural region of the target polynucleotide), and also contain variant portions compared to the target polynucleotide; in one example, the variant portions are randomized portions, which vary compared to analogous portions in a plurality of other polynucleotide members of the collection. In a collection of variant polynucleotides, not necessarily every polynucleotide is a variant polynucleotide. For example, the collection can further contain native polynucleotides with 100% identity to the target polynucleotide or region thereof. Similarly, it is not necessary that every polynucleotide in a collection of randomized polynucleotides vary compared to each other member of the collection.

The target polynucleotide includes a nucleic acid encoding a target polypeptide or a functional or structural region of the target polypeptide. The target polynucleotide optionally can contain additional 5′ and/or 3′ sequence(s) of nucleotides, such as, but not limited to, non-gene-specific nucleotide sequences, restriction endonuclease recognition site sequence(s), sequence(s) complementary to a portion of one or more primers, and/or nucleotide sequence(s) of a bacterial promoter or other bacterial sequence. The target polynucleotide can be single or double stranded. Target portions within the target polynucleotide encode the target portions of the target polypeptide.

Exemplary of the target polynucleotides are polynucleotides containing nucleic acids encoding antibodies and chains, domains and functional regions of antibodies, such as antigen binding portions of the antibodies, such as, but not limited to, polynucleotides encoding variable region domains and functional regions thereof; polynucleotides containing nucleic acids encoding antibody combining sites; polynucleotides containing nucleic acids encoding antibody constant regions or functional regions thereof; polynucleotides containing nucleic acids encoding antibody variable heavy chain (V_{H}) domains, variable light chain (V_{L}) domains, heavy chain constant region 1 (C_{H}1), 2 (C_{H}2), 3 (C_{H}3) and/or 4(C_{H}4) domains, and/or light chain constant region domains (C_{L}) and/or functional regions thereof; and polynucleotides containing nucleic acid encoding an antibody fragment, such as an scFv fragment, a Fab fragment, a F(ab′)₂ fragment, an Fv fragment, a dsFv fragment, a diabody, an Fd fragment, and an Fd′ fragment; and polynucleotides containing nucleic acids encoding domain exchanged antibodies, chains, domains and functional regions thereof, including domain exchanged antibody fragments, such as domain exchanged antibodies and antigen binding portions thereof, which can include a domain exchanged Fab fragment, a domain exchanged scFv fragment, an scFv tandem fragment, a domain exchanged single chain Fab (scFab) fragment, a domain exchanged scFv hinge fragment and a domain exchanged Fab hinge fragment.

Thus, exemplary of target polypeptides, which can be varied by the provided methods, and variant polypeptides produced by the methods, are antibodies, including antibody fragments, such as domain exchanged antibodies, including domain exchanged antibody fragments, and chains, domains and functional regions of antibodies, such as antigen binding portions of the antibodies, such as, but not limited to variable region domains and functional regions thereof; antibody combining sites; antibody constant regions and functional regions thereof; antibody variable heavy chain (V_{H}) domains, variable light chain (V_{L}) domains, heavy chain constant region 1 (C_{H}1), 2 (C_{H}2), 3 (C_{H}3) and/or 4(C_{H}4) domains, and/or light chain constant region domains (C_{L}) and/or functional regions thereof; and antibody fragments, such as an scFv fragment, a Fab fragment, a F(ab′)₂ fragment, an Fv fragment, a dsFv fragment, a diabody, an Fd fragment, and an Fd′ fragment; and domain exchanged antibodies, chains, domains and functional regions thereof, including domain exchanged antibody fragments, such as domain exchanged antibodies and antigen binding portions thereof, which can include a domain exchanged Fab fragment, a domain exchanged scFv fragment, an scFv tandem fragment, a domain exchanged single chain Fab (scFab) fragment, a domain exchanged scFv hinge fragment and a domain exchanged Fab hinge fragment.

The collections of variant polynucleotide duplexes produced by the provided methods can be used to generate variant polypeptides, such as a peptide library, e.g. a display library, for example, by inserting the polynucleotide duplexes into vectors and then transforming host cells and inducing expression.

In general, the methods for producing the collections of polynucleotides are carried out by generating a plurality of pools of oligonucleotides and/or other polynucleotides, and/or duplexes thereof, and then performing various additional steps (e.g. amplification, polymerase extension, hybridization, ligation and other assembly methods), as described below, to form assembled polynucleotides and duplexes thereof, from the pools. Typically, the oligonucleotides and polynucleotides in the pools contain identity (and/or complementarity) to regions along the length of the target polynucleotide. For example, each of the plurality of pools can contain identity to a region along the length of the target polynucleotide, where the regions of identity to the different pools overlap with one another along the length of the target polynucleotide.

The polynucleotides (e.g. oligonucleotides) in the pools need not be 100% identical or complementary to the regions of the target polynucleotide. For example, the polynucleotides and oligonucleotides can contain one or more variant (e.g. randomized) portions compared to the region of the target polynucleotide. In one example, the polynucleotides in the pool contain at least at or about 50%, 60%, 70%, 75%, 80%, 85%, 90%, 95%, 96%, 97%, 98%, 99% or 100% identity or complementarity to the target polynucleotide region.

Pools of oligonucleotides and/or polynucleotides can be designed based on a reference sequence, which contains identity to a region of the target polynucleotide, but not necessarily 100% identity to the region. In one example, the reference sequence contains at least at or about 50%, 60%, 70%, 75%, 80%, 85%, 90%, 95%, 96%, 97%, 98%, 99% or 100% identity to the target polynucleotide region. When the pool is designed based on a reference sequence, each member of the pool contains identity to the reference sequence, but not necessarily 100% identity. For example, a synthetic oligonucleotide in a pool, designed based on a reference sequence, can contain 100% identity to the reference sequence, or can contain one or more variant portions compared to analogous portions in the reference sequence, such as randomized portions, for example, can contain at or about 50%, 60%, 70%, 75%, 80%, 85%, 90%, 95%, 96%, 97%, 98%, or 99% identity to the reference sequence. When the oligonucleotide or polynucleotide contains 100% identity to the reference sequence, it is referred to as a reference sequence polynucleotide or reference sequence oligonucleotide. When it contains one or more randomized portions, it is referred to as a randomized oligonucleotide or randomized polynucleotide.

The randomized oligonucleotides can be synthetically produced, in pools according to well-known oligonucleotide synthesis methods. Typically, randomized portions of the randomized oligonucleotides (e.g. randomized template oligonucleotides, randomized primer oligonucleotides or other randomized oligonucleotides for use in the methods) are synthesized using a doping strategy. Doping strategies include non-biased (e.g. “N” or “NNN,” where N is any nucleotide) and biased (e.g. NNA, NNG, NNC, and NNT (where A=adenosine; C=cytidine (C), G=guanosine; and T=thymidine); NNN, NNK, NNB, NNS, NNR, NNM, NNH, NND and NNV; NNM; NNH; NND; and NNV) doping strategies, where N is any nucleotide; K is T or G; B is C, G or T; S is C or G; W is A or T; M is A or C; H is A, C or T; D is A, G or T; and V is A, G or C). Other known doping strategies also can be used to generate the randomized portions. The randomized portions can contain one nucleotide (randomized position), or more than one nucleotide.

The randomized, reference sequence and variant positions in the randomized oligonucleotides within the pools correspond to analogous randomized, reference sequence and variant portions in the polynucleotides produced by the methods using the oligonucleotides (e.g. assembled polynucleotides, assembled polynucleotide duplexes, assembled polynucleotide duplex cassettes). In one example, when the methods produce a collection of polynucleotides (e.g. assembled polynucleotides or assembled polynucleotide duplexes), no more than 30% of the polynucleotides of the collection contain the same nucleotide at a given randomized N position. In one example, no more than 55% of the produced polynucleotides of the collection contain the same nucleotide at a given K, S, W or M position. In one example, no more than 40% of the polynucleotides of the collection contain the same nucleotide at a given B, H, D or V position.

As noted above, the methods for producing the collections of polynucleotides (e.g. assembled polynucleotides and duplexes thereof) include additional steps, e.g. for assembly of oligonucleotides and polynucleotides of the pools. In one example, the additional steps include formation of duplexes, including assembled duplexes, such as by combining oligonucleotides, polynucleotides and/or duplexes thereof, under conditions whereby they hybridize through complementary regions, such as overlapping regions of complementarity, and/or regions of complementarity in overhangs. In some aspects, the polynucleotides (e.g. oligos, duplexes) are combined at equimolar concentrations. In one aspect, to make the duplexes, conditions are used such that nicks between polynucleotides (e.g. polynucleotides hybridizied to other polynucleotides) are sealed, such as by addition of a ligase, e.g. in a buffer compatible with ligation.

In some examples, the methods further include steps whereby complementary strands of the polynucleotides are amplified, such as by amplification or polymerase extension. In one aspect, the polynucleotides are incubated, typically with a polymerase and primers, under conditions whereby complementary strands are synthesized. Conditions whereby complementary strands are synthesized in the provided methods include polymerase reactions, e.g. amplification reactions, such as a polymerase chain reaction (PCR), for example, an amplification reaction which is carried out with at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or more cycles, and single extension reactions, such as fill-in reactions and mutually primed fill-in reactions. The amplification reactions include single-primer amplification reaction, wherein the primers are a single primer pool.

The primers for use in the methods, e.g. for complementary strand synthesis in any of the steps, can be primer pairs, or single primer pools and can be gene-specific primers, or non-gene specific primers. In one example, the primers contain identity or complementarity to a restriction endonuclease cleavage site, or contain a restriction endonuclease cleavage site. In one aspect, the primers for generating various duplexes in the methods contain a non gene-specific nucleotide sequence that has a region of identity or complementarity to a region contained in other primers, such as those used in other steps of the methods. The primers include primers purified by high-performance liquid chromatography (HPLC) or PolyAcrylamide Gel Electrophoresis (PAGE). In one example, the primers contain less than at or about 200, 150, 100, 90, 80, 70, 60, 50, 40, 30, 25, or 20 nucleotides in length. For example, the primers include short primers, containing less than at or about 100, less than at or about 50 or less than at or about 30 nucleotides in length.

The polymerases for use in the methods include, but are not limited to, high-fidelity polymerases, such as any high-fidelity polymerase known in the art. Other polymerases can be used.

In some examples, one or more of the duplexes is purified prior to combining it or using it in a step, such as a hybridization, ligation, amplification or other step of the methods. The purification can be carried out with gel extraction or a nucleic acid purification column or other purification method known in the art.

In some examples, the pools of duplexes (e.g. reference sequence duplexes, scaffold duplexes, randomized duplexes and/or reference sequence duplexes) that are produced in the course of the methods contain duplexes having less than 2000 or about 2000, less than 1000 or about 1000, less than 500 or about 500, less than 250 or about 250, less than 200 or about 200 or less than 150 or about 150, nucleotides in length.

Among the provided methods are methods for producing a collection of variant polynucleotide duplexes. In one example, the collection of variant polynucleotide duplexes is produced by generating pools of duplexes, and then generating a pool of assembled polynucleotides by combing the pools of duplexes, whereby they hybridize through complementary regions, and generating a collection of assembled polynucleotide duplexes from the assembled polynucleotides. One exemplary aspect of this example is illustrated in FIG. 4, which is described herein. Typically, the assembled polynucleotide duplexes in the collection contain reference sequence portions having identity to regions of the target polynucleotide and randomized portions, which vary to analogous portions in other members of the collection.

The pools of duplexes which are combined whereby they hybridize, can include a pool of variant duplexes, which typically are randomized duplexes, and/or a pool of reference sequence duplexes, and optionally can contain a plurality of reference sequence and/or randomized/variant duplexes. In the pools of randomized duplexes, each randomized duplex contains a randomized portion and a reference sequence portion, and optionally contains a plurality of randomized and/or reference sequence portions. Typically, the reference sequence portion contains identity to a region of the target polynucleotide. The randomized portion varies in nucleic acid sequence compared to an analogous portion in the target polynucleotide and/or compared to analogous portions in other members of the pool of randomized duplexes.

Typically, the pools of reference sequence duplexes and pools of randomized duplexes (or variant duplexes), together, contain identity along the entire length of the target polynucleotide, or the region of the target polynucleotide that is analogous to the assembled polynucleotide. Typically, these regions of identity are overlapping along the length of the target polynucleotide (see, for example, FIGS. 4A and 4B, where the regions of identity of the reference sequence duplexes overlap with the regions of identity of the randomized duplexes, along the length of the target polynucleotide). The pools of randomized and reference sequence duplexes can be produced simultaneously, or sequentially, in any order.

The pools of randomized duplexes can be generated by combining two pools of randomized oligonucleotides under conditions whereby they hybridize through complementary regions. In another aspect, the generation of the pool of randomized duplexes is effected by synthesizing a pool of randomized template oligonucleotides based on a reference sequence having identity to a region of the target polynucleotide, each randomized template oligonucleotide having a reference sequence portion and a randomized portion, and incubating the pool of randomized template oligonucleotides with a polymerase and primers, under conditions whereby complementary strands are synthesized, thereby generating the pool of randomized duplexes, or by any of the provided methods for generating duplexes.

In one example, the primers used to generate the randomized duplexes are a primer pair. Typically, each randomized template oligonucleotide contains a plurality of reference sequence portions, such as two or more, reference sequence portions. Typically, two of the plurality of reference sequence portions are at the 3′ and 5′ termini of the randomized template oligonucleotides. In one example, the entire length, or about the entire length, of each reference sequence portion contains complementarity to one of the primers. In one aspect, each reference sequence portion contains a total of at least at or about 50%, 60%, 70%, 75%, 80%, 85%, 90%, 95%, 99% or 100% complementarity to one of the primers.

In one example, the primers for generating randomized duplexes, primers for generating reference sequence duplexes, and/or primers for generating scaffold duplexes, or a combination thereof), contain a non gene-specific nucleotide sequence, having a region of identity or complementarity to a region contained in the primers used to generate the collection of assembled polynucleotide duplexes from the assembled polynucleotides.

Typically, each pool of reference sequence duplexes is generated by incubating the target polynucleotide or a region thereof (such as the target polynucleotide or region thereof contained in a vector), with a polymerase and primers, under conditions whereby complementary strands are synthesized.

In one aspect, the pools of duplexes used to assemble the assembled polynucleotide further include a pool of scaffold duplexes, the scaffold duplexes in the pools containing complementarity to other pools of duplexes, such as the randomized duplexes and/or the reference sequence duplexes. In one example, the pool of scaffold duplexes contains complementarity to members of a randomized duplex pool and complementarity to a reference sequence duplex pool. Typically, the scaffold duplexes contain complementarity to duplexes in at least two other pools, for example, a pool of reference sequence duplexes and a pool of variant duplexes, a pool of reference sequence duplexes and a pool of randomized duplexes, two pools of randomized duplexes, two pools of variant duplexes, two pools of reference sequence duplexes, or more duplexes, including combinations thereof. Typically, along the length of the scaffold duplex, the region of complementarity to one of the other pools (e.g. the randomized duplex pool) is adjacent or about adjacent to the region of complementarity to the other of the pools (e.g. the reference sequence duplex pool), such that upon hybridization to polynucleotides of the scaffold duplexes through complementary regions, the polynucleotides within the two other pools are brought into close proximity, whereby they can be joined, e.g. by sealing nicks, such as with a ligase.

Typically, the pool of scaffold duplexes is generated by incubating the target polynucleotide or a region thereof (e.g. the target polynucleotide in a vector) with a polymerase and primers, under conditions whereby complementary strands are synthesized.

Thus, typically, when the duplexes are combined under conditions whereby they hybridize through complementary regions, polynucleotides of a scaffold duplex hybridize to two different polynucleotides from two different other duplexes. Thus, typically, upon hybridization to the scaffold duplexes, polynucleotides of two or more other duplexes (e.g. randomized, reference sequence, and/or variant duplexes), are brought into close proximity (i.e. adjacent to one another). Typically, following hybridization to the scaffold duplexes, nicks between the polynucleotides from the other duplexes (e.g. from the randomized and reference sequence duplexes), nicks between the proximally close (e.g. adjacent) polynucleotides are sealed, such as by addition of a ligase and incubation under conditions whereby the nicks are sealed between the polynucleotides, thereby generating the assembled polynucleotide (see, for example, FIG. 4).

For example, formation of the assembled polynucleotides can be effected by denaturing the pools of duplexes (e.g. the randomized, reference sequence and/or variant duplexes and the scaffold duplexes); and hybridizing polynucleotides of the duplexes and sealing nicks. Typically, the sealing of nicks is effected with a ligase. In one example, the duplexes are combined, for hybridization and sealing of nicks, at equimolar concentrations. In one example, the denaturing and hybridizing steps are carried out only one time. In another example, the denaturing and hybridizing steps are repeated for a total of at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 cycles or more.

The collection of assembled duplexes, i.e. variant assembled duplexes, is generated from the assembled polynucleotide pools, for example, by incubating the assembled polynucleotides in the presence of a polymerase and primers, under conditions whereby complementary strands of the assembled polynucleotides are synthesized, such as in a polymerase reaction, e.g. an amplification reaction, such as a polymerase chain reaction (PCR), for example, an amplification reaction which is carried out with at least 10, 11, 12, 13, 14, 15, 16, 17, 18, 19, 20, 21, 22, 23, 24, 25, 26, 27, 28, 29, 30, 31, 32, 33, 34, 35 or more cycles.

In one aspect, the primers for generating the randomized duplexes, the primers for generating the reference sequence duplexes, or the primers for generating the scaffold duplexes, or a combination thereof, contain a non gene-specific nucleotide sequence, having a region of identity or complementarity to a region contained in the primers used to generate the collection of assembled polynucleotide duplexes from the assembled polynucleotides. In one example, the primers are short primers, containing less than at or about 100, less than at or about 50 or less than at or about 30 nucleotides in length. In one example, the primers contain less than at or about 200, 150, 100, 90, 80, 70, 60, 50, 40, 30, 25, or 20 nucleotides in length

In one aspect of this example, at least 2, 3, 4 or 5, ore more pools of randomized duplexes, at least 2, 3, 4 or 5, or more pools of reference sequence duplexes, and/or at least 2, 3, 4 or 5, or more pools of scaffold duplexes, or a combination thereof, are produced and combined by hybridization, to facilitate ligation of polynucleotides of each of the randomized and reference sequence pools, to form a collection of variant polynucleotides containing identity to duplexes in each of the reference sequence and randomized pools.

In one aspect, the randomized duplexes, the scaffold duplexes and/or the reference sequence duplexes are purified prior to combining them under conditions that promote hybridization.

In another example of the methods, the collection of variant assembled polynucleotide duplexes is generated by generating a plurality of pools of duplexes with overhangs (e.g. each duplex having one overhang or two overhangs), typically compatible overhangs, and generating a pool of intermediate duplexes by combining the various pools of duplexes with overhangs, under conditions whereby duplexes hybridize through complementary regions in the overhangs; and then generating a collection of assembled polynucleotide duplexes from the pool of intermediate duplexes. An exemplary aspect of this example is illustrated in FIG. 5, which is described herein. The pools of duplexes with overhangs can be generated simultaneously or sequentially, in any order.

In one aspect of this example, the pools of duplexes with overhangs includes a pool of reference sequence duplexes, each duplex in the pool containing identity to a region of the target polynucleotide, e.g. structural or functional region, and an overhang.

In one aspect, the pools of duplexes includes a pool of randomized duplexes, each randomized duplex in the pool containing a randomized portion, a reference sequence portion containing identity to a region of the target polynucleotide, e.g. structural or functional region, and an overhang. In one aspect, each randomized oligonucleotide in the pool contains at least one reference sequence portion and at least one randomized portion and each reference sequence contains a region of complementarity to a region of a duplex in another of the pools, such as a reference sequence duplex pool. The pools of duplexes typically include a pool of randomized duplexes and a pool of reference sequence duplexes, and can optionally include a plurality of reference sequence duplexes and/or pools of randomized duplexes.

In one example, the pool of reference sequence duplexes with overhangs is generated by incubating a region of the target polynucleotide with a polymerase and primers, under conditions whereby complementary strands are synthesized, and where the primers contain a restriction endonuclease cleavage site nucleotide sequence, and then adding a restriction endonuclease under conditions whereby the overhangs are generated. Typically, the overhangs (e.g. restriction site overhangs) are compatible with restriction site overhangs in other pools of duplexes, such as randomized duplexes.

In one example, the pool of randomized duplexes with overhangs is generated by synthesizing a positive and a negative strand pool of randomized oligonucleotides, each pool based on a reference sequence containing identity to a region of the target polynucleotide, and incubating the positive and negative strand pools of oligonucleotides under conditions whereby they hybridize through complementary regions. Typically, the reference sequence contains at least at or about 70%, 75%, 80%, 85%, 90%, 95%, 96%, 97%, 98%, 99% or 100% identity to the target polynucleotide. Typically, the randomized oligonucleotides for use in making the duplexes are designed such that the duplexes, once formed, contain overhangs, e.g. overhangs that are compatible with the overhangs in the other duplex pool(s). In one example, generation of the randomized duplexes with overhangs includes adding a restriction endonuclease under conditions whereby the overhangs are generated.

In one example, formation of the pool of intermediate duplexes (from the pools of duplexes with overhangs) is effected by hybridization through complementary overhangs, e.g. complementary overhangs in members of different randomized and/or reference sequence duplex pools. The formation of the intermediate duplexes can be carried out by hybridizing polynucleotides of the duplexes, and optionally, by sealing nicks, for example, with a ligase. In one example, the duplexes with overhangs are combined, to form the intermediate duplexes, at equimolar concentrations.

Typically, formation of the collection of assembled polynucleotide duplexes from the intermediate duplexes is carried out by incubating the intermediate duplexes in the presence of a polymerase and primers, under conditions whereby complementary strands of the polynucleotides of the intermediate duplexes are synthesized, as described herein. In one example, the primers contain less than at or about 200, 150, 100, 90, 80, 70, 60, 50, 40, 30, 25, or 20 nucleotides in length. In one aspect, the primers are non-gene specific primers. For example, one or more of the primers for generating the pools of duplexes can contain non-gene specific nucleic acid having identity or complementarity to a primer used to generate the assembled duplexes from the intermediate duplexes (see, e.g. FIG. 5).

In another example of the provided methods, the variant assembled polynucleotide duplexes are generated by synthesizing pools of oligonucleotides, each pool of oligonucleotides based on a reference sequence containing identity to a region of a target polynucleotide (the regions overlapping along the length of the target polynucleotide), then generating a pool of intermediate duplexes by combining the pools of oligonucleotides under conditions whereby oligonucleotides in the pools hybridize through regions of complementarity; and generating assembled duplexes from the intermediate duplexes, thereby generating a collection of variant assembled duplexes. An exemplary aspect of this example is illustrated in FIG. 3A.

In one aspect, each oligonucleotide in the pools contains at least one reference sequence portion. In one aspect, the pools of oligonucleotides contain at least two, and typically at least three, pools of oligonucleotides. In one aspect, at lease one of the pools of oligonucleotides, and typically at least two of the pools, is a pool of randomized oligonucleotides, that has reference sequence portions with identity to the target polynucleotide and randomized portions. In one aspect, each oligonucleotide within each of the pools contains a region of complementarity to a region of at least one oligonucleotide in another of the pools. In one example, the reference contains at least at or about 70%, 75%, 80%, 85%, 90%, 95%, 96%, 97%, 98%, 99% or 100% identity to the target polynucleotide.

In one aspect of this example, the intermediate duplexes are generated by incubating pools of oligonucleotides under conditions whereby positive and negative strand oligonucleotides of the pools hybridize through complementary regions and nicks are sealed, e.g. by adding a ligase. In one example, the pools are combined at equimolar concentrations to effect this step. In one aspect, combining and ligating is effected by mixing pairs of positive and negative strand pools, under conditions whereby oligonucleotides in the pools hybridize through complementary regions, thereby generating pools of duplexes, and then mixing the pools of duplexes, whereby oligonucleotides in the duplexes hybridize through complementary regions in overhangs.

The collection of assembled polynucleotide duplexes can be generated from the pool of intermediate duplexes by incubating polynucleotides of the intermediate duplexes with primers and a polymerase, under conditions whereby complementary strands are synthesized, such as the conditions described herein or other conditions for complementary strand synthesis.

In another example of the provided methods, the collection of assembled polynucleotide duplexes is produced by synthesizing pools of oligonucleotides (each pool based on a reference sequence containing identity to a region of a target polynucleotide, each oligonucleotide within each of the pools containing a region of complementarity to a region of at least one oligonucleotide in another of the pools) and then forming pools of duplexes by performing fill-in reactions with the pools of oligonucleotides. An exemplary aspect of this example is illustrated in FIG. 2.

The pools of duplexes can further contain overhangs. The overhangs typically are generated by incubating the pools of duplexes in the presence of a restriction endonuclease. The pools of duplexes with overhangs can be used to assemble the collection of assembled duplexes by combining the pools of duplexes under conditions whereby they hybridize through complementary regions in the overhangs, thereby generating a collection of variant assembled duplexes having reference sequence portions with identity to the target polynucleotide and randomized portions.

In one aspect of this example, the pools of oligonucleotides contain at least four pools of oligonucleotides, and typically contain at least one pools of randomized oligonucleotides. In one example, the pools are combined at equimolar concentrations.

In one aspect, the fill-in reactions are effected by combining pair(s) of the pools of oligonucleotides in the presence of a polymerase, whereby complementary strands are synthesized. In one example, the pools of oligonucleotides are combined at equimolar concentrations. In another example, they are combined at unequal molar concentrations.

In one aspect, the reference sequence contains at least at or about 70%, 75%, 80%, 85%, 90%, 95%, 96%, 97%, 98%, 99% or 100% identity to the target polynucleotide. In one aspect, the fill-in reactions include mutually-primed fill-in reactions, where oligonucleotides are both template and primer oligonucleotides.

In particular aspects, provided are methods for producing a collection of variant assembled polynucleotide duplexes based on a target polynucleotide. The method contains the steps of a) generating a pool of reference sequence duplexes, wherein, each reference sequence duplex in the pool includes at least a portion with sequence identity to a region of a target polynucleotide, and also includes a single stranded overhang of sufficient length to bind a complementary single stranded overhang; b) generating a pool of randomized duplexes, wherein each randomized duplex contains a randomized portion, a reference sequence portion containing identity to a region of the target polynucleotide, and an overhang comprising a sequence complementary to the overhang in the pool of duplexes of step (a) and of sufficient length to bind therewith; c) generating intermediate duplexes by combining the duplexes generated in step (a) and the randomized duplexes generated in step (b), under conditions whereby duplexes hybridize through complementary regions; and d) amplifying the intermediate duplexes to generate assembled polynucleotide duplexes from the intermediate duplexes, thereby generating a collection of variant assembled polynucleotide duplexes, the variant assembled duplexes having reference sequence portions with identity to regions of the target polynucleotide and randomized portions; wherein step (a) and step (b) are performed simultaneously or sequentially, in any order.

In other aspects, provided are methods for producing a collection of variant assembled polynucleotide duplexes, in which the following steps are performed: a) synthesizing at least four pools of oligonucleotides, wherein each pool of oligonucleotides contains a reference sequence containing identity to a region of a target polynucleotides, at least one of the pools is a pool of randomized oligonucleotides, and each oligonucleotide within each of the pools contains a region of complementarity to a region of at least one oligonucleotide in another of the pools; b) forming pools of duplexes by combining the pools of oligonucleotides under conditions whereby the oligonucleotides hybridize through complementary regions; and performing fill-in reactions, wherein the pools of duplexes contain overhangs; and c) generating assembled duplexes by combining the pools of duplexes under conditions whereby they hybridize through complementary regions in the overhangs, thereby generating a collection of variant assembled duplexes having reference sequence portions with identity to the target polynucleotide and randomized portions.

Also provided are methods for producing collections of assembled duplex cassettes, which contain overhangs for ligation into vectors. In one example, the assembled duplex cassettes are generated from the assembled duplexes, by cutting with a restriction endonuclease. In another example, the assembled duplex cassettes are produced without cutting with a restriction enzyme.

In a particular example, a collection of variant assembled duplex cassettes is generated using the following method: a) synthesizing at least three pools of oligonucleotides, wherein the pools contain at least one pool of positive strand oligonucleotides and one pool of negative strand oligonucleotides, each oligonucleotide pool contains a reference sequence containing identity to a region of a target polynucleotide, at least two of the oligonucleotide pools are pools of randomized oligonucleotides, and each oligonucleotide within each pool contains at least a region of complementarity to a region of an oligonucleotide in at least another of the pools; and b) forming variant assembled cassettes by combining the pools of oligonucleotides under conditions whereby positive and negative strand oligonucleotides hybridize through regions of complementarity and the nicks are sealed, thereby generating a collection of variant assembled duplex cassettes; wherein each of the cassettes comprises the nucleotide sequence of one oligonucleotide from each pool, and at least one randomized portion.

In one example, the collection of assembled duplex cassettes is produced by synthesizing and combining pools of positive and negative strand oligonucleotides under conditions whereby they hybridize through complementary regions and nicks are sealed, and where the oligonucleotides (e.g. the oligonucleotides to form the 3′ and 5′ termini of the assembled duplexes) are designed such that the resulting duplex contains overhangs, e.g. is an assembled duplex cassette. An exemplary aspect of this example is illustrated in FIG. 1.

In one aspect, the process is carried out by synthesizing at least three pools of oligonucleotides, each pool based on a reference sequence containing identity to a region of a target polynucleotide, where at least one, and typically at least two, of the pools are pools of variant (typically randomized) oligonucleotides, and each oligonucleotide within each pool contains at least a region of complementarity to a region of an oligonucleotide in at least another of the pools, and then combining the pools of oligonucleotides, thereby generating a collection of variant assembled duplex cassettes. Typically, each of the cassettes in the collection contains the nucleotide sequence of one oligonucleotide from each pool, and at least one randomized portion.

Nicks can be sealed with a ligase. The positive and negative strand pools of oligonucleotides can be combined at equimolar concentrations.

In one example, the reference sequence used to design the oligonucleotides in each pool contains at least at or about 70%, 75%, 80%, 85%, 90%, 95%, 96%, 97%, 98%, 99% or 100% identity to the target polynucleotide.

In one example, the methods do not include a polymerase chain reaction (PCR) step.

The assembled duplexes produced by the methods, e.g. variant assembled duplexes and duplex cassettes, contain reference sequence portions which contain identity to a target polynucleotides, and typically contain variant (typically randomized) portions, where the randomize portions vary among a plurality of members of the collection. In one example, the reference sequence portions in the assembled duplexes contain no more than 20 or about 20%, no more than 15 or about 15%, no more than 10 or about 10%, no more than 5 or about 5% or no more than 1 or about 1% insertions, deletions or substitutions, compared to the analogous portion of the target polynucleotide.

In one example, the collection of variant assembled duplexes contains a diversity of at least 10⁴ or at least about 10⁴, 10⁵ or at least about 10⁵, 10⁶ or at least about 10⁶, 10⁷ or at least about 10⁷, 10⁸ or at least about 10⁸, 10⁹ or at least about 10⁹, 10¹⁰ or at least about 10¹⁰ or 10¹¹ or at least about 10¹¹, 10¹² or at least about 10¹², 10¹³ or at least about 10¹³, 10¹⁴ or at least about 10¹⁴, or more. In one aspect, the collection contains a diversity ratio that is a high diversity ratio, such as diversity ratios approaching 1, such as, for example, at or about 0.1, 0.2, 0.3, 0.4, 0.5, 0.6, 0.7, 0.8, 0.9 0.91, 0.92, 0.93, 0.94, 0.95, 0.96, 0.97, 0.98, or 0.99.

Typically, each variant assembled duplex of the collection contains at least two non-contiguous randomized portions. In one example, at least two of the non-contiguous randomized portions are separated by at least 50 or about 50, at least 100 or about 100, at least 150 or about 150, at least 200 or about 200, at least 300 or about 300, at least 400 or about 400 or at least 500 or about 500, at least 1000 or about 1000, at least 2000 or about 2000 nucleotides, or more. In another example, each of the variant assembled duplexes in the collection contains at least 50 or about 50, at least 100 or about 100, at least 150 or about 150, at least 200 or about 200, at least 300 or about 300, at least 500 or about 500, at least 1000 or about 1000, or at least 2000 or about 2000, at least 5000 or about 5000 nucleotides in length, or more.

In one example, at least one of the randomized portions in each variant assembled duplex contains a nucleotide within nucleic acid encoding an antibody complementary determining region (CDR) or an antibody framework region. In another example, at least one of the randomized portions contains a nucleotide within nucleic acid encoding an antibody CDR1, CDR2 or CDR3. In one aspect, each of the variant assembled duplexes in the collection contains at least two randomized portions, the randomized portion containing nucleotides within nucleic acids encoding two different antibody CDRs.

The variant assembled duplex cassettes in the collections encode variant polypeptides, which can be polypeptides analogous to any target polypeptide. Exemplary target polypeptides are described herein. In one example, the target polynucleotide contains a nucleic acid encoding an antibody variable region domain or functional region thereof, nucleic acid encoding an antibody constant region domain or functional region thereof; and/or nucleic acid encoding an antibody combining site.

The target polynucleotides include target polynucleotides having nucleic acid encoding an antibody variable heavy chain (V_{H}) domain, nucleic acid encoding an antibody variable light chain (V_{L}) domain, nucleic acid encoding a heavy chain constant region 1 (C_{H}1) domain, and nucleic acid encoding a light chain constant region (CL) domain, and combinations thereof. In one aspect, the target polynucleotide encodes all or part of an antibody fragment, such as, but not limited to, an scFv fragment, a Fab fragment, a Fab′ fragment, a F(ab′)₂, an Fv fragment, a dsFv fragment, a diabody, an Fd and an Fd′.

In one example, the target polynucleotide is used in one or more steps of the methods (for example, as a template in a polymerase reaction). In one example, the target polynucleotide is contained in a vector or the target polynucleotide is a nucleic acid molecule contained in a vector, which optionally can further include a nucleic acid encoding a display protein, such as a phage coat protein, for example, cp3, cp8, or any other display protein such as those described herein.

In one example, the target polynucleotide contains nucleic acid encoding a domain exchanged antibody or antigen binding portion thereof. In one aspect, the domain exchanged antibody polypeptide is a 2G12 antibody or a modified 2G12 antibody polypeptide. The domain exchanged antibody can be 2G12, but typically is an antibody other than 2G12; or can be a domain exchanged antibody that specifically binds an antigen other than gp120, such as a modified 2G12 antibody that does not specifically bind gp120 or binds another antigen with a higher affinity than it binds to gp120. The modified 2G12 antibody can contain an amino acid residue that is modified compared to an analogous amino acid residue within a CDR of a 2G12 antibody, such as a modified 2G12 antibody contains an amino acid residue that is modified compared to an analogous amino acid residue within a CDR of a 2G12 antibody.

The domain exchanged antibody or antigen binding portion thereof can include a domain exchanged Fab fragment, a domain exchanged scFv fragment, an scFv tandem fragment, a domain exchanged single chain Fab (scFab) fragment, a domain exchanged scFv hinge fragment or a domain exchanged Fab hinge fragment.

In one example, each variant assembled duplex in the collection contains nucleic acid encoding antibodies or functional regions thereof, such as antibody fragments, domains, antibody combining sites or other functional antibody domains, e.g. an antibody variable region domain or functional region thereof, nucleic acid encoding an antibody constant region domain or functional region thereof; and/or nucleic acids encoding an antibody combining site. In one example, the assembled duplexes contain nucleic acid encoding an antibody variable heavy chain (V_{H}) domain, nucleic acid encoding an antibody variable light chain (V_{L}) domain, nucleic acid encoding a heavy chain constant region 1 (C_{H}1) domain, and nucleic acid encoding a light chain constant region (CL) domain.

In one example, the duplexes contain nucleic acids encoding domain exchanged antibodies and/or functional regions thereof. The domain exchanged antibody can be 2G12, but typically is an antibody other than 2G12; or can be a domain exchanged antibody that specifically binds an antigen other than gp120, such as a modified 2G12 antibody that does not specifically bind gp120 or binds another antigen with a higher affinity than it binds to gp120. The modified 2G12 antibody can contain an amino acid residue that is modified compared to an analogous amino acid residue within a CDR of a 2G12 antibody. For example, the duplexes can contain nucleic acid encoding a variable region domain, a constant region domain of a domain exchanged antibody, or functional region thereof.

Also provided are collections of duplexes (e.g. assembled duplexes, such as variant assembled polynucleotide duplexes and duplex cassettes) that are produced by the methods.

Also provided are methods for producing nucleic acid libraries from the duplexes, e.g. by producing a collection of variant assembled duplexes (e.g. duplex cassettes), according to the provided methods and ligating the cassettes into vectors, and optionally transforming host cells with the vectors. Also provided are the nucleic acid libraries produced by the methods.

Also provided are methods for generating collections of variant polypeptides. In one example, the methods are performed by generating a nucleic acid library according to the provided methods and transforming host cells with the nucleic acid library; and inducing polypeptide expression in the host cells. The host cells include display-compatible cells, such as genetic packages and phage-display compatible cells, including partial suppressor cells, such as amber suppressor cells.

Also provided are collections of variant polypeptides produced by the methods.

Also provided are methods for producing a collection of genetic packages displaying variant polypeptides. In one example, the methods are performed by producing a collection of assembled duplexes (e.g. duplex cassettes) according to the provided methods, incubating the cassettes with vectors and a ligase, thereby inserting each cassette into one of the vectors, wherein each vector comprises nucleic acid encoding a display protein, transforming host cells with the vectors, and inducing expression of the polypeptides, whereby the collection of variant polypeptides is displayed on the surface of the genetic packages.

Also provided are genetic packages expressing variant polypeptides produced by the methods, and methods for selecting variant polypeptides having a desired binding property or activity from the collections. In one example, the selection methods are performed by producing a collection of genetic packages displaying variant polypeptides provided herein, exposing the collection to a binding partner, whereby one or more of the variant polypeptides displayed on genetic packages binds to the binding partner, washing, thereby removing unbound genetic packages, and eluting, thereby isolating genetic packages displaying the one or more selected variant polypeptides having the desired binding property or activity, such as specific binding, high affinity binding and high avidity binding, high off-rate and high on-rate.

In one aspect, the binding partner is coupled to a solid support. The solid support can be a plate, a bead, a column or a matrix, or any other known solid support. In one example, the methods include an iterative process. In this example, more than one genetic packages are isolated and the selection steps are repeated, and more polypeptide(s) are selected, according to the provided methods.

In one example, a polynucleotide encoding a selected variant polypeptide is isolated following selection. Also provided are variant polypeptides selected by the methods.

Also provided herein are collections of randomized polynucleotides containing at least 10⁴ or at least about 10⁴, 10⁵ or at least about 10⁵, 10⁶ or at least about 10⁶, 10⁷ or at least about 10⁷, 10⁸ or at least about 10⁸, 10⁹ or at least about 10⁹, 10¹⁰ or at least about 10¹⁰, 10¹¹ or at least about 10¹¹, 10¹² or at least about 10¹², or 10¹³ or at least about 10¹³, 10¹⁴ or at least about 10¹⁴ different nucleic acid sequences among the polynucleotide members. In such collections, each member contains at least 100 or about 100, at least 200 or about 200, at least 300 or about 300, at least 500 or about 500, at least 1000 or about 1000, or at least 2000 or about 2000 nucleotides in length, and each member contains at least one randomized portion that is analogous to randomized portions in the other duplex members, and reference sequence portions, each reference sequence portion containing at least at or about 50%, 60%, 70%, 75%, 80%, 85%, 90%, 95%, 96%, 97%, 98%, 99% or 100% identity to a target polynucleotide.

In one aspect, the collection contains a diversity ratio that is a high diversity ratio, such as diversity ratios approaching 1, such as, for example, at or about 0.1, 0.2, 0.3, 0.4, 0.5, 0.6, 0.7, 0.8, 0.9 0.91, 0.92, 0.93, 0.94, 0.95, 0.96, 0.97, 0.98, or 0.99. In some examples, for each analogous randomized nucleotide position among the polynucleotide members, each member contains one or the other of two nucleotides at the analogous position, wherein each of the two nucleotides is present at the position in no more than at or about 55% of the members. Alternatively, each member contains one of four or more nucleotides at the analogous position, wherein each of the four or more nucleotides is present at the position in no more than 30% of the members. In some aspects, each member of the collection contains only one randomized portion. In other aspects, each member contains at least two non-contiguous randomized portions. In such examples, two of the non-contiguous randomized portions can be separated by at least 100 or about 100, at least 150 or about 150, at least 200 or about 200, at least 300 or about 300, at least 400 or about 400 or at least 500 or about 500 nucleotides.

Provided herein are collections containing randomized polynucleotides, wherein each randomized polynucleotide member of the collection contains at least two reference sequence portions that are common among the cassettes and at least two non-contiguous randomized portions, wherein the randomized portions are separated by at least 100 or about 100, 200 or about 200, 300 or about 300, 500 or about 500 or 1000 or about 1000 nucleotides.

Also provided herein are collections comprising randomized polynucleotides, wherein each polynucleotide member of the collection contains at least two reference sequence portions that are common among the cassettes and at least one randomized portion, wherein each cassette comprises at least 200 or about 200, 300 or about 300 or 500 or about 500, 1000 about 1000 or 2000 or about 2000 nucleotides in length.

In some aspects of the collections provided herein, the polynucleotide members are polynucleotide duplexes, polynucleotide duplex cassettes or vectors. In other aspects, the collection is a nucleic acid library. In some examples, each polynucleotide member of the collection contains nucleic acid encoding an antibody variable heavy chain (V_{H}) domain, nucleic acid encoding an antibody variable light chain (V_{L}) domain, nucleic acid encoding a heavy chain constant region 1 (C_{H}1) domain, and nucleic acid encoding a light chain constant region (CL) domain. Thus, in some of the collections provided herein, each polynucleotide member can contain nucleic acid encoding an antibody fragment, such as, for example, an scFv fragment, a Fab fragment, a Fab′ fragment, a F(ab′)₂, an Fv fragment, a dsFv fragment, a diabody, an Fd or an Fd′.

In a particular example, the polynucleotide members of the collections provided herein encode domain exchanged antibodies, including domain exchanged antibody fragments. Exemplary of such fragments are domain exchanged Fab fragments, domain exchanged scFab fragments, domain exchanged scFv fragments, scFv tandem fragments, domain exchanged single chain Fab (scFab) fragments, domain exchanged scFv hinge fragments and domain exchanged Fab hinge fragments.

In some aspects, the polynucleotides in the collections provided herein are contained in vectors. In such examples, the vectors also can contain nucleic acid encoding a display protein, such as, for example, a phage coat protein. Exemplary of phage coat proteins that can be encoded in the vectors are cp3 and cp8 proteins.

In some of the collections provided herein, at least one of the randomized portion(s) in each polynucleotide member contains a nucleotide within a sequence encoding an antibody complementary determining region (CDR), such as, for example, a CDR3. In other examples, each of the members contains at least two randomized portions containing nucleotides within nucleic acids encoding two different antibody CDRs. In one example, at least one of the randomized portion(s) contains nucleotides within nucleic acid encoding an antibody variable framework region (FR).

The collections of randomized polynucleotides provided herein can have members that encode domain exchanged antibody polypeptides or antigen-binding portions thereof. For example, the members can encode modified 2G12 domain exchanged antibody polypeptides. In some examples, these encoded modified 2G12 antibody polypeptides do not specifically bind gp120.

Also provided herein are collections of variant polypeptides. These variants polypeptides can be encoded by the polynucleotides contained in the collection of randomized polynucleotides described above and provided herein. Further, collections containing genetic packages for displaying variant proteins are provided herein. Each of these genetic package expresses a polypeptide encoded by the collection of randomized polynucleotides described above and provided herein. In some examples, the genetic packages are bacteriophage.

Provided herein are methods for selecting one or more polypeptides having a desired binding property or activity. These methods contain the steps of: (a) displaying polypeptides from the collection of genetic packages of claim 140; (b) exposing the collection to a binding partner, whereby one or more of the variant polypeptides displayed on genetic packages binds to the binding partner; (c) washing, thereby removing unbound genetic packages; and (d) eluting, thereby isolating genetic packages displaying the one or more selected variant polypeptides having the desired binding property or activity.

In some examples of the methods for selecting one or more polypeptides having a desired binding property or activity, the binding partner is coupled to a solid support. The solid support can be, for example, a plate, a bead, a column or a matrix. In other examples of these methods, the eluting is carried out with one or more elution buffers. or the washing is carried out with one or more wash buffers. In some aspects, the methods are used to select one or more polypeptides having specific binding, high affinity binding or high avidity binding. In a particular example of the methods, more than one genetic packages are isolated. This can be achieved, for example, by repeating steps (b)-(d) of the methods, wherein the collection contains the more than one isolated genetic packages, thereby selecting one or more polypeptides from among the selected polypeptides.

### BRIEF DESCRIPTION OF THE DRAWINGS

FIG. 1: Schematic illustration of random cassette mutagenesis and assembly (RCMA) method for producing assembled duplexes

FIG. 1 illustrates an example of formation of a collection of variant assembled duplex cassettes (bottom) using RCMA as provided herein. FIG. 1A: In the illustrated example, oligonucleotides from eight pools of reference sequence oligonucleotides (open boxes) and four pools of randomized oligonucleotides (open boxes with hatched portions representing randomized portions) are synthesized for assembly of the assembled duplexes. FIG. 1B: Positive strand and negative strand oligonucleotide pools are combined, hybridized through complementary regions, and ligated to seal nicks between the adjacent oligonucleotides (arrows), forming a pool of assembled duplex cassettes (FIG. 1C), each cassette containing sequences from each oligonucleotide pool. The oligonucleotides are designed such that they can hybridize through shared complementary regions.

FIG. 2: Schematic illustration of oligonucleotide fill-in mutagenesis and assembly (OFIA) method for producing assembled duplexes

FIG. 2 is illustrates an example of formation of a collection of variant assembled duplexes (and duplex cassettes) with oligonucleotide fill-in mutagenesis and assembly (OFIA), according to the methods provided herein. In this example, pools of reference sequence oligonucleotides (open boxes) and pools of randomized oligonucleotides (open boxes with hatched portions, representing randomized portions) are synthesized according to the methods. FIG. 2A: In the illustrated example, fill-in reactions, including three mutually primed fill-in reactions (three right-most pairs; illustrated with two horizontal arrows indicating the direction of polymerization), are performed to synthesize complementary strands, forming duplexes. FIG. 2B: The duplexes then are digested with restriction endonucleases, which cut at restriction sites, indicated with two offset vertical lines, to generate overhangs in the duplexes. FIG. 2C: The duplexes then are hybridized through overhangs and ligated to seal nicks (indicated with arrows), generating a collection of variant assembled duplexes (FIG. 2D), each duplex containing sequence from an oligonucleotide in each of the pools. In one example, as indicated in FIG. 2D, the assembled duplexes contain restriction sites and can be cut with restriction endonucleases to generate assembled duplex cassettes, for ligation into vectors.

FIG. 3: Schematic illustration of duplex oligonucleotide ligation/single primer amplification (DOLSPA) method for generating collections of assembled duplexes

FIGS. 3A and 3B illustrate examples of formation of collections of variant assembled duplexes (and duplex cassettes) using the duplex oligonucleotide ligation/single primer amplification (DOLSPA) approach and a variation thereof, according to the methods provided herein. 3A: In this example, ten pools of reference sequence oligonucleotides (open and grey boxes) and four pools of randomized oligonucleotides (open boxes with hatched portions representing randomized portions) are synthesized according to the provided methods (top panel). In the example illustrated in this figure, seven positive and seven negative strand pools of the oligonucleotides are combined, whereby oligonucleotides of the pools hybridize through shared complementary regions and nicks (indicated with arrows) are sealed by ligation, forming intermediate duplexes (middle panel). The intermediate duplexes then are used in an amplification reaction, (bottom panel) using primers (here, a non gene-specific single primer pool; illustrated in grey) and a polymerase, whereby complementary strands are synthesized, forming a collection of variant assembled duplexes, each containing sequence from an oligonucleotide in each of the pools. The non-gene specific primer (of the single primer pool) specifically hybridizes to non gene-specific sequences in the intermediate duplexes, generated by use of oligonucleotides with non gene-specific sequences. In the illustrated example, the resulting assembled duplexes can be cut with restriction enzymes for ligation into vectors, according to the methods herein. Throughout the figure, the non gene-specific nucleotide sequence (Region X), contained in the single primer and some oligonucleotides, is represented in black and a complementary region (Region Y) is represented in grey. 3B: In the example illustrated in this figure (variation of DOLSPA), eight pools of reference sequence oligonucleotides (open boxes) and four pools of randomized oligonucleotides (open boxes with hatched portions representing randomized portions) are synthesized according to the provided methods (top panel). Six positive and six negative strand pools are combined, whereby oligonucleotides of the pools hybridize through shared complementary regions and nicks (indicated with arrows) are sealed by ligation (middle panel), forming a pool of intermediate duplexes. The intermediate duplexes then are used in an amplification reaction, (bottom panel) using primers (here, a gene-specific primer pair; the two primer pools of the pair indicated with vertical and horizontal dashes) and a polymerase, whereby complementary strands are synthesized, forming a collection of variant assembled duplex cassettes, each containing sequence from an oligonucleotide in each of the pools. The gene specific primers specifically hybridize to gene-specific sequences in the intermediate duplexes. The amplification reaction generates a collection of assembled duplexes, which, in one example, can be cut with restriction endonucleases to form duplex cassettes, which contain overhangs and can be ligated into vectors.

FIG. 4: Schematic illustration of fragment Assembly and Ligation/Single Primer Amplification (FAL-SPA) method for generating collections of assembled duplexes

FIG. 4 illustrates one example of the provided methods for forming a collection of variant assembled duplexes using Fragment Assembly and Ligation/Single Primer Amplification (FAL-SPA). FIG. 4A: In this illustrated example, pools of randomized duplexes are generated according to the provided methods (open boxes with hatched portions representing randomized portions). Typically, these pools are generated by amplification (not shown) using randomized template oligonucleotides and primers. FIG. 4B: Pools of reference sequence duplexes and pools of scaffold duplexes are generated by amplification, using the target polynucleotide as a template, for example, in a high-fidelity (hi-fi) PCR (the primers are not shown). FIG. 4C: Duplexes from the pools are combined in a Fragment Assembly and Ligation (FAL) step whereby they are denatured and hybridize through complementary regions. As shown, randomized and reference sequence duplex polynucleotides are brought in close proximity as they hybridize to the scaffold duplexes, which contain regions complementary to regions in multiple pools of the other duplexes. Nicks (indicated by arrows) are sealed between the adjacent polynucleotides, forming a pool of assembled polynucleotides. FIG. 4D: The assembled polynucleotides are used as templates in a single primer amplification (SPA) reaction, generating a pool of variant assembled duplexes, each duplex containing sequences from polynucleotides in the randomized and the reference sequence duplex pools. In one example, the assembled duplexes can be cut with restriction enzymes to form assembled duplex cassettes, which can be ligated into vectors. Throughout this figure, two complementary non-gene specific nucleotide sequences (Region X and Region Y) are illustrated as black and grey filled boxes respectively. These non gene-specific regions are contained in the duplexes in two of the reference sequence duplex pools (FIG. 4B), and have complementarity/identity to the single primer pool used in the amplification reaction (FIG. 4D), which contains the nucleotide sequence with identity to Region X, e.g. the nucleotide sequence of Region X.

FIG. 5: Schematic illustration of modified fragment Assembly and Ligation/Single Primer Amplification (mFAL-SPA) method for generating collections of assembled duplexes

FIG. 5 one example of the provided methods for forming a collection of variant assembled duplexes using modified Fragment Assembly and Ligation/Single Primer Amplification (mFAL-SPA). FIG. 5A: In this example, pools of randomized duplexes with overhangs are generated (open boxes with hatched portions representing randomized portions). FIG. 5B: Pools of reference sequence duplexes are generated in amplification reactions using the target polynucleotide as a template and primers containing restriction site nucleotide sequences (restriction sites, which are within the portions of the primers and duplexes illustrated as boxes with vertical lines or grey or black fill). FIG. 5C: The reference sequence duplexes are digested with restriction endonucleases (which recognize the site within the vertical line boxes) to form overhangs in the duplexes. FIG. 5D: Reference sequence duplexes with overhangs and randomized duplexes with overhangs are combined in a Fragment Assembly and Ligation (FAL) step, whereby the duplexes hybridize through complementary regions in the overhangs, which are compatible overhangs, forming a pool of intermediate duplexes. A single primer amplification (SPA) reaction then is performed (not shown) using the intermediate duplex polynucleotides as templates. As in FAL-SPA (e.g. FIG. 4) a SPA reaction then is performed with a primer (not shown) having identity to a non gene-specific sequence (Region X; shown in black; contained in the intermediate duplexes, and the pools of reference sequence duplexes) and complementary to another non gene-specific sequence, Region Y, which is illustrated in grey. In one example, the assembled duplexes can be cut with restriction enzymes (recognizing the site within the sequence represented in black) for ligation into vectors.

FIG. 6: pCAL G13 vector

FIG. 6 is an illustrative map of the pCAL G13 vector, provided and described in detail herein. GIII represents the nucleotide encoding the phage coat protein cp3. “Amber” indicates the position of the amber stop codon (TAG/UAG), adjacent to the cp3 encoding nucleotide.

FIG. 7: Comparison of Conventional and Domain Exchanged Antibodies

FIG. 7 is an illustrative comparison of a full-length conventional IgG antibody (left) and an exemplary full-length domain exchanged IgG antibody. As shown, the conventional full-length antibody contains two heavy (H and H′) and two light (L and L′) chains, and two antibody combining sites, each formed by residues of one heavy and one light chain. By contrast, the heavy chains in the exemplary domain exchanged antibody are interlocked, resulting in pairing of the heavy chain variable regions (V_{H} and V_{H}′) with the opposite light chain variable regions (V_{L}′ and V_{L}, respectively), forming a pair of conventional antibody combining sites, locked in space. As described herein, the V_{H}-V_{H}′ interface can form a non-conventional antibody combining site, containing residues of the two adjacent heavy chain variable regions (V_{H} and V_{H}′). The number (35 Å (angstroms)) represents the distance between the two conventional antibody combining sites in this exemplary domain exchanged antibody. For each antibody, the two heavy chains, H and H′ are illustrated in grey and black, respectively; the two light chains, L and L′, are illustrated with open and hatched boxes, respectively. The specific domains (e.g. V_{H} C_{H}1, C_{L}) are indicated.

FIG. 8: Domain Exchanged Antibody Fragments

FIG. 8 schematically illustrates examples of a plurality of the provided domain exchanged antibody fragments (domain exchanged Fab fragment (8A); domain exchanged Fab hinge fragment (8B); domain exchanged Fab Cys19 fragment (8C); domain exchanged scFab ΔC² fragment (8D(i)); domain exchanged scFab ΔC²Cys19 fragment (8D(ii)); domain exchanged scFv tandem fragment (8E); domain exchanged scFv fragment (8F); domain exchanged scFv hinge/scFv hinge (SE) fragments (having the same general structure as described herein) (8G); and domain exchanged scFv Cys19 fragment (8H). In the example illustrated in this figure, the fragments are expressed as part of phage coat (cp3) fusion proteins, for display on bacteriophage. “S—S” indicates a disulfide bond; “G3” indicates a cp3 phage coat protein. Specific antibody domains (e.g. V_{H} C_{H}1, C_{L}) are indicated. One heavy (H) and one light (L) chain are illustrated filled in white, while the other heavy (H′) and light (L′) chains are illustrated filled in grey. These fragments are described in detail herein.

FIG. 9: Diversity Among Randomized AC8 Clones

FIG. 9 displays a phylogenetic tree, mapping the nucleotide sequence diversity among clones listed in Table 6A, which contain randomized nucleotide sequences within the nucleic acid encoding the anti-HSV (AC-8) antibody heavy chain CDR3, generated using random cassette mutagenesis.

FIG. 10: Diversity among randomized AC8 Clones

FIG. 10 displays a phylogenetic tree, mapping the nucleotide sequence diversity among clones containing randomized nucleotide sequences within the nucleic acid encoding the anti-HSV (AC-8) antibody heavy chain CDR3, which were generated using oligonucleotide fill-in mutagenesis.

FIG. 11: Use of overlap PCR to randomize a 3-ALA 2G12 fragment target polypeptide

FIG. 11 illustrates the process described in Example 3, which was used to generate diversity in a 3-ALA 2G12 domain exchanged Fab fragment target polypeptide by overlap PCR. Reference sequence polynucleotides are indicated with open boxes and randomized polynucleotides are indicated as open boxes with hatched portions, representing randomized portions. FIG. 11A: A 3-ALA 2G12 reference sequence polynucleotide from a vector was used as a template in initial PCRs (PCR1a, PCR1b). Primer pools A (reference sequence) and B (randomized) were used to perform one initial PCR (PCR1a) and primer pools C and D (randomized) were used to perform another initial PCR (PCR1b). FIG. 11B: Purified product pools (PCR1a product and PCR1b product) from the initial PCRs were combined with primer pools A and E in an overlap PCR, whereby randomized duplexes were generated. FIG. 11C: The randomized duplexes were incubated with Not I and Sal I restriction endonucleases, to generate a duplex cassette, which then was inserted into the 3Ala-1 pCAL G13 vector digested with Not I/Sal I.

FIG. 12: Randomization of 3-ALA 2G12 fragment target polypeptide using RCMA

FIG. 12 illustrates the RCMA process that was used, according to the provided methods, to randomize a 3-ALA 2G12 domain exchanged Fab fragment target polypeptide, as described in Example 4. FIG. 12A: Eight reference sequence oligonucleotide pools (H1, H2, H5, H6, H7, H8, H11 and H12; illustrated as open boxes) and four randomized oligonucleotide pools (H3, H4, H9, H10; illustrated as open boxes with hatched portions representing randomized portions) were generated. Oligonucleotides in the positive strand pools (H1, H3, H5, H7, H9, H11) contained regions of complementarity with regions in oligonucleotides in the negative strand pools (H2, H4, H6, H8, H10, H12). FIG. 12B: The 12 pools of oligonucleotides were combined under conditions whereby positive and negative strand oligonucleotides specifically hybridized through complementary regions, and nicks (indicated with arrows) were sealed by ligation, thereby assembling large duplex oligonucleotide cassettes with overhangs, that could be directly ligated into vectors (FIG. 12C).

FIG. 13: Randomization of 3-ALA 2G12 fragment target polypeptide using OFIA

FIG. 13 illustrates the OFIA process that can be used, according to the provided methods, to randomize the 3-ALA 2G12 domain exchanged Fab fragment target polypeptide, as described in Example 5 below. FIG. 13A: Five pools of reference sequence oligonucleotides (F1b, F2b, F4b, F5b and F8b; illustrated as open boxes) and three pools of randomized oligonucleotides (F3b, F6b and F7b; illustrated as open boxes with hatched portions representing randomized portions) were designed. These pools can be used in fill-in reactions, where the pools are mixed pairwise (F1b and F2b; F3b and F4b; F5b and F6b; and F7b and F8b) under conditions whereby complementary strands are synthesized, thereby forming duplexes. The F3b-F4b fill-in reaction, the F5b-F6b fill-in reaction and the F7b-F8b fill-in reaction each are mutually primed fill-in reactions, where oligonucleotides in the pools were both primers and templates. The F1b-F2b fill-in reaction was a single extension fill-in reaction, with one primer pool, whereby an overhang was generated. FIG. 13B: Three of the resulting four pools oligonucleotide duplexes (the three made by mutually primed fill-in reactions) then can be incubated with restriction endonucleases to create restriction site overhangs, through a collection of assembled duplexes is generated. The restriction enzymes and corresponding partial nucleotide sequences (restriction sites) are indicated. FIG. 13C: The digested duplexes then are combined (together with the other duplex formed by the F1b-F2b fill-in reaction), under conditions whereby they ligate through complementary regions in the overhangs, thereby assembling a collection of assembled duplexes. The assembled duplexes can be cut with restriction enzymes (Not I and Sal I) to generate a collection of assembled duplex cassettes, each containing restriction site overhangs (FIG. 13D), which can then be ligated into the pCAL 3-Ala 2G12 vector.

FIG. 14: Randomization of 3-ALA 2G12 fragment target polypeptide using DOLSPA

FIG. 14 illustrates the DOLSPA process that was used, according to the provided methods, to randomize the 3-ALA 2G12 domain exchanged Fab fragment target polypeptide, as described in Example 6 below. Ten pools of reference sequence oligonucleotides (FIG. 14A; H1m, H0, H1, H0m, H5, H6, H7, H8, H11m and H12m; illustrated as open, black and grey boxes) and four pools of randomized oligonucleotides (FIG. 14A; H3, H4, H9, H10; illustrated as open boxes with hatched portions representing randomized portions), all designed based on reference sequences having identity to regions of the 3-ALA 2G12 domain exchanged Fab fragment target polynucleotide, were synthesized according to the provided methods. The oligonucleotides were combined (FIG. 14B) under conditions whereby positive and negative strand oligonucleotides in the pools hybridized through regions of complementarity and nicks (indicated with arrows) were sealed with a ligase. The resulting pool of intermediate duplexes then was used in a single primer amplification reaction (FIG. 14C) with the CALX24 primer (single primer), thereby generating a collection of assembled duplexes (not shown). Throughout the figure, non gene-specific nucleotide sequences Region X and complementary Region Y are illustrated as black and grey boxes respectively. The nucleotide sequence of Region X is identical to the nucleotide sequence contained in the single primer (CALX24) and is also present in a portion of oligonucleotides in pool H1m and H12m. The presence of these non gene-specific sequence of nucleotides in the oligonucleotides facilitates amplification of the intermediate duplexes with the single primer pool (CALX24).

FIG. 15: Randomization of 3-ALA 2G12 fragment target polypeptide using FAL-SPA

FIG. 15 illustrates the FAL-SPA process that was used, according to the provided methods, to randomize the 3-ALA 2G12 domain exchanged Fab fragment target polypeptide, as described in Example 7 below. FIG. 15A: Pools of randomized duplexes (H2 and H4; illustrated as open boxes with hatched portions representing randomized portions) were formed using the provided methods, by performing amplification reactions (not shown) with pools of template oligonucleotides (H3, H4, H9 and H10, listed in Table 13) and primer pair pools (H2-F/H2-R; H4-F; H4-R) listed in Table 15, as described in Example 7A. FIG. 15B: Pools of reference sequence duplexes (H1S, H3S and H5S) and pools of scaffold duplexes (H1L, H3L and H5L) were generated in PCR amplification reactions using primer pair pools listed in Table 15 and the 3-ALA pCAL G13 vector containing the target polynucleotide as a template, or by hybridizing reference sequence oligonucleotides, as described in Example 7B and C. FIG. 15C: The reference sequence, randomized and scaffold duplexes were combined in a FAL step, under conditions whereby the reference sequence and randomized oligonucleotides hybridized to scaffold polynucleotides through complementary regions and nicks were sealed with a ligase, forming a collection of assembled polynucleotides containing nucleic acids from the reference sequence and randomized duplexes. FIG. 15D: The collection of assembled polynucleotide duplexes was used as a template in a single primer amplification reaction, using a CALX24 single primer pool, forming a collection of variant assembled duplexes. Two of the reference sequence duplex pools and one scaffold duplex pool contained a Region X (depicted in black), a non gene-specific sequence of nucleotides that was identical to the nucleotide sequence in the CALX24 primer single-primer pool, and a complementary Region Y (shown in grey), which facilitated the single primer amplification as described herein.

FIG. 16: Randomization of 3-ALA 2G12 fragment target polypeptide using mFAL-SPA

FIG. 16 illustrates the mFAL-SPA process that was used, according to the provided methods, to randomize the 3-ALA 2G12 domain exchanged Fab fragment target polypeptide, as described in Example 8 below. FIG. 16A: Four pools of randomized oligonucleotides (H1F, H1R, H3F, and H3R; illustrated as open boxes with hatched portions representing randomized portions) were designed and hybridized to form two pools of randomized duplexes (H1 and H3), containing overhangs. FIG. 16B: Three pools of reference sequence duplexes (1, 2, and 3) were generated using PCR with three pools of forward oligonucleotide primers (F1, F2, F3) and three pools of reverse oligonucleotide primers (R1, R2, R3). Four of the primers, R1, F2, R2 and F3, contained a recognition site for the SAP-I restriction endonuclease (indicated by a portion with vertical lines). FIG. 16C: Reference sequence duplexes were cut with the Sap-I restriction endonuclease, generating reference sequence duplexes with Sap-I overhangs compatible to those in the randomized duplexes. FIG. 16D: The reference sequence and randomized pools of duplexes with overhangs then were combined under conditions whereby they hybridized through complementary overhangs and nicks (indicated with arrows) were sealed with a ligase, forming a pool of intermediate duplexes, which then was used in an SPA reaction (not shown) with a CALX24 single primer pool to generate a collection of variant assembled duplexes. One forward primer pool (F1), and one reverse primer pool (R3) contained a non gene-specific nucleotide sequence (Region X; depicted in black), which was identical to the nucleotide sequence of the CALX24 primer, such that reference sequence duplexes 1 and 3 contained a sequence of nucleotides including Region X, and a complementary Region Y, which served as template sequences for the primers in the SPA. The assembled duplexes can be digested to form assembled duplex cassettes with restriction enzymes recognizing restriction sites within the portion illustrated in black.

FIG. 17: Binding of domain exchanged fragments, expressed in bacteria, to gp120 antigen

FIG. 17 illustrates the results of a binding assay used to evaluate the binding of the indicated exemplary 2G12 domain exchanged antibody fragments (generated as described in Example 14), expressed from BL21(DE3) host cells, to bind the antigen, gp120 (to which 2G12 antibody specifically binds). Solutions containing secreted and intracellular domain exchanged antibody fragments were obtained from overnight cultures of host cells that had been induced to express the polypeptides. An ELISA was performed as described in Example 14C, below, on 1:5 serial dilutions of the solutions. As described, binding of solutions to plate-bound gp120 was assessed using an HRP-conjugated secondary antibody and a substrate and reading absorbance at 450 nm. Absorbance values are indicated on the Y axis, while dilution factor is indicated on the X axis. Labeled arrows on the graph point to curves representing the domain exchanged Fab hinge, Fab, scFv tandem and scFv hinge fragments (the fragments having strong or moderate binding to the antigen). Error bars represent standard deviation among triplicate samples. The results illustrated in this figure are described in Example 14C and also are listed in Table 44.

FIG. 18: Exemplary phagemid vector for display of domain exchanged antibodies

FIG. 18 depicts an exemplary phagemid vector for display of domain exchanged antibodies. The vector contains a lac promotor system, including a truncated lac I gene. The lac I gene encodes the lactos repressor and the lactose promotor and operator. The lac promoter/operator is operably linked to a leader sequence, followed by a nucleic acid encoding a domain exchanged antibody light chain, another leader sequence, and a nucleic acid encoding a domain exchanged antibody heavy chain. Downstream is a tag sequence, followed by a stop codon and nucleic acid encoding a phage coat protein (here gIII encoding cp3). The vector also includes phage and bacterial origin of replications.

FIG. 19: Exemplary phagemid vector for insertion of nucleic acid encoding a protein for which reduced expression is desired

FIG. 19 depicts an exemplary phagemid vector for insertion of nucleic acid encoding a protein for which reduced expression is desired, such as to reduce toxicity of the protein to the host cell. The vector contains a lac promoter system, including the lac I gene, which encodes the lactose repressor, and the lactose promoter and operator. The lac promoter/operator is operably linked to a leader sequence into which a stop codon has been introduced. One or more restriction enzyme sites are downstream of the leader sequence, allowing for insertion of nucleic acid encoding a protein or domain or fragment thereof. In some examples, the vector contains an additional leader sequence containing a stop codon, followed by one or more restriction enzyme sites, allowing insertion of a second polynucleotide encoding another protein or fragment or domain thereof. Down stream of this is a tag sequence, followed by a stop codon and nucleic acid encoding a phage coat protein. The vector also includes phage and bacterial origin of replications.

FIG. 20: Exemplary phagemid vector for reduced expression of antibodies or antibody fragments

FIG. 20 depicts an exemplary phagemid vector for expression of antibodies or fragments thereof, including domain exchanged antibodies or fragments thereof. The vector contains a lac promoter system, including the lac I gene, which encodes the lactose repressor, and the lactose promoter and operator. The vector contains nucleic acid encoding an antibody light chain linked at its 5′ end to the 3′ end of a leader sequence into which a stop codon has been introduced, and nucleic acid encoding an antibody heavy chain linked at its 5′ end to the 3′ end of another leader sequence into which a stop codon has been introduced. Downstream of the nucleic acid encoding the heavy chain is a tag sequence, a stop codon and nucleic acid encoding a phage coat protein. The single genetic element containing these leader, antibody chain, tag and phage coat protein is operably linked to the lactose promoter and operator, such that a single mRNA transcript is produced following induction of transcription. When expressed in a partial suppressor cell, soluble (native) antibody light chains, soluble (or native) antibody heavy chains and heavy chain-phage protein fusion proteins are produced.

FIG. 21: 2G12 pCAL vector

FIG. 21 depicts the 2G12 pCAL vector, provided and described in detail herein. The vector encodes the 2G12 antibody light and heavy chains (2G12 LC and 2G12 HC, respectively) in polynucleotides that are linked to the Pel B and OmpA leader sequences, respectively. The polynucleotides encoding the 2G12 HC are linked to nucleotides encoding a histidine tag, followed by an amber stop codon (*) and a truncated gIII protein. These polynucleotides all are operably linked to the lactose promoter and operator element. Also included in the vector is a truncated lac I gene.

FIG. 22. 2G12 pCAL IT* vector

FIG. 22 depicts the 2G12 pCAL IT* vector. The 2G12 pCAL IT* vector can be used to express, with reduced toxicity, Fab fragments of the domain exchanged 2G12 antibody, which recognize the HIV gp120 antigen. Expression as both soluble 2G12 Fab fragments and 2G12-gIII coat protein fusion proteins for display on phage particles can be effected in partial amber suppressor cells by virtue of the amber stop codon between the nucleotides encoding the 2G12 heavy chain nucleotides encoding the truncated gIII coat protein. The polynucleotide encoding the 2G12 light chain is linked to the Pel B leader sequence, and the 2G12 heavy chain is linked to the OmpA leader sequence. The inclusion of an amber stop codon in each of the leader sequences results in reduced expression of the 2G12 heavy and light chains in partial amber suppressor strains following induction with, for example IPTG. The reduced expression can lead to reduced toxicity of the 2G12 Fab to the host cells.

FIG. 23: Introduction of amber stop codon in PelB and OmpA leader sequences

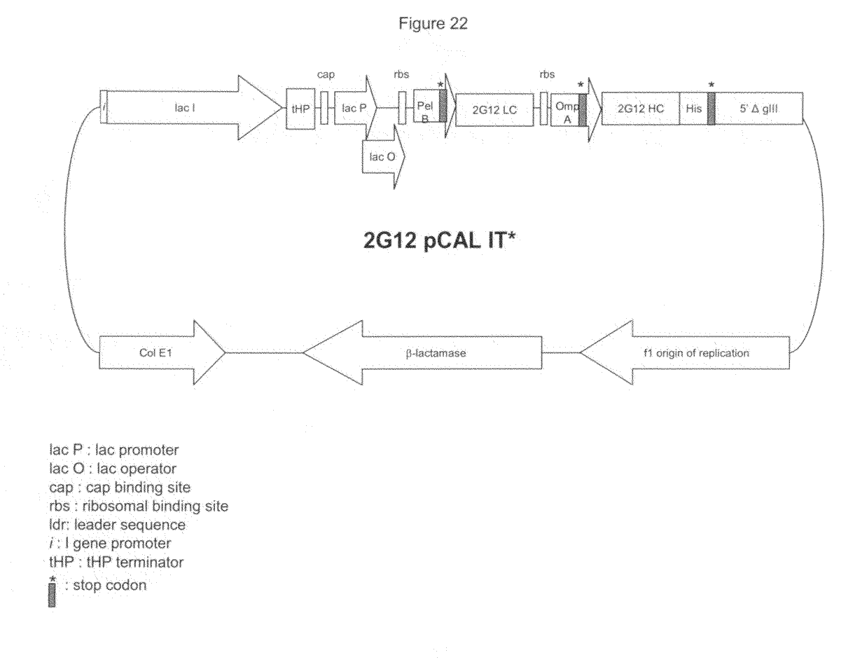

FIG. 22 depicts the modification of the Pel B and Omp A leader sequences in the 2G12 pCAL ITPO vector to introduce an amber stop codon into each sequence, producing the 2G12 pCAL IT* vector. The stop codons are incorporated by mutation of the CAG triplet encoding a glutamine (Glu, Q) in each of the leader sequences to a TAG amber stop codon. For example, the nucleotide triplet at nucleotides 52-54 of the PelB leader sequence set forth in SEQ ID NO: 272, encoding the glutamine at amino acid position 18 of the PelB leader peptide set forth in SEQ ID NO: 273 was modified to generate a TAG amber stop codon at nucleotides 52-54 (SEQ ID NO:274). Similarly, the nucleotide triplet at nucleotides 58-60 of the OmpA leader sequence set forth in SEQ ID NO: 276, encoding the glutamine at amino acid position 20 of the OmpA leader peptide set forth in SED ID NO: 277) was modified to generate a TAG amber stop codon at nucleotides 58-60 (SEQ ID NO:278).

FIG. 24. 2G12 pCAL ITPO Vector

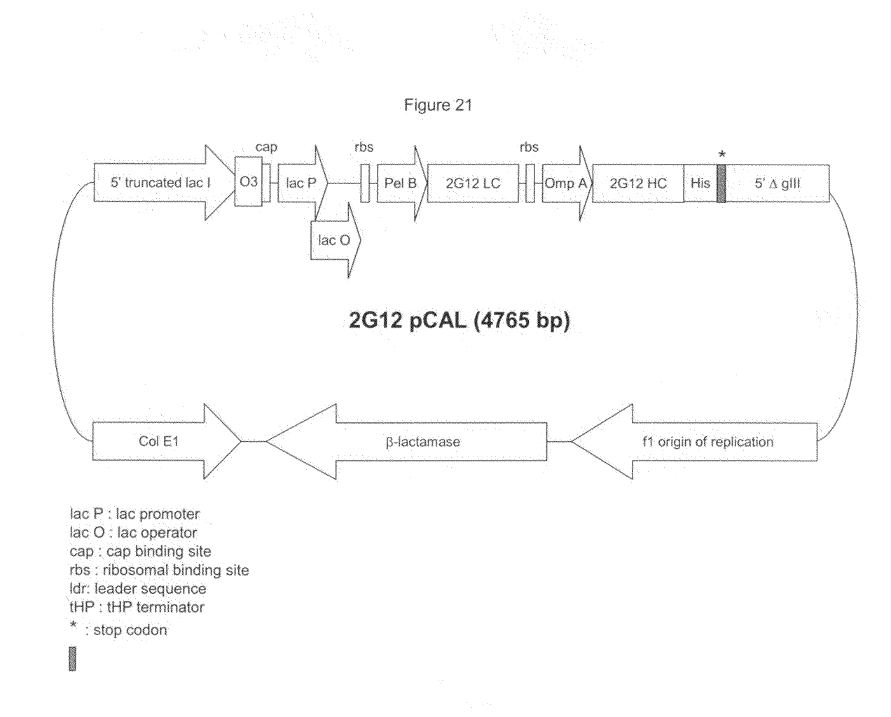

FIG. 24 depicts the 2G 12 pCAL IPTO vector, generated as described in Example 12. The vector was generated by modification of the 2G12 pCAL vector (FIG. 21), wherein the truncated lac I gene of the 2G12 pCAL vector is replaced with a full length lac I gene.

### DETAILED DESCRIPTION

### Outline

### A. DEFINITIONS

### B. OVERVIEW OF THE METHODS FOR CREATING DIVERSITY IN LIBRARIES, LIBRARIES, AND DISPLAY METHODS AND DISPLAYED MOLECULES

1. Methods for introducing diversity in libraries
2. Methods and compositions for generating diversity
   a. Selection of target polypeptides
   b. Design and synthesis of oligonucleotides
   c. Generation of assembled oligonucleotide duplexes and duplex cassettes
   d. Ligation of the assembled duplex cassettes into vectors
   e. Transformation of host cells with the vectors
   f. Display of variant polypeptides on genetic packages
   g. Selecting variant polypeptides from the collections
3. Display of domain-exchanged antibody fragments on genetic packages

### C. SELECTION OF TARGET POLYPEPTIDES

1. Exemplary target polypeptides
   a. Antibody polypeptides
      i. Antibody structural and functional domains and regions thereof
      ii. Antibodies in protein therapeutics
      iii. Recombinant techniques for producing MAbs
         a. Natural antibody libraries
         b. Synthetic and semi-synthetic antibody libraries
      iv. Antibody fragments
      v. Domain exchanged antibodies
      vi. Target domains and target portions in antibody polypeptides
   b. Other target polypeptides
2. Polypeptide target domains, target portions and target positions
3. Target polynucleotides

### D. DESIGN AND SYNTHESIS OF OLIGONUCLEOTIDES

1. Synthetic oligonucleotides
   a. Nucleotides and analogs
   b. Modifications
   c. Oligonucleotide length
2. Design and synthesis of synthetic oligonucleotides
   a. Reference sequences
   b. Methods for oligonucleotide synthesis
   c. Types of synthetic oligonucleotides
      i. Reference sequence oligonucleotides
      ii. Variant oligonucleotides
         a. Randomized oligonucleotides
         b. Oligonucleotides with pre-selected mutations
      iii. Positive and negative strand oligonucleotides
      iv. Template oligonucleotides
      v. Oligonucleotide primers
      vi. Oligonucleotides containing non gene-specific regions
   d. Purification of synthetic oligonucleotides
   e. Pools of Randomized oligonucleotides
      i. Doping strategies
         a. Non-biased randomization
         b. Biased randomization
      ii. Saturating randomization
      iii. Plurality of pools of oligonucleotides
   f. Portions/regions within oligonucleotides
      i. Reference-sequence portions
      ii. Variant portions
         a. Randomized portions
      iii. Complementary regions
      iv. Regions for compatibility with vector insertion and downstream applications

### E. GENERATION OF ASSEMBLED DUPLEXES AND DUPLEX CASSETTES

1. Direct Formation of Duplex Cassettes by hybridizing positive and negative strand oligonucleotides and sealing nicks (RCMA)
   a. Design of oligonucleotide pools with regions of complementarity
   b. Overhangs
   c. Assembly by hybridization through regions of complementarity and sealing nicks
   d. Assembled duplex cassettes
2. Formation of assembled duplexes by fill-in polymerase extension: Oligonucleotide fill-in and assembly (OFIA)
   a. Template oligonucleotides
   b. Fill-in primers
   c. Fill-in reactions
   d. Polymerases
   e. Restriction digestion and ligation
3. Formation of duplexes by duplex oligonucleotide ligation and single primer amplification (DOLSPA)
   a. Design of oligonucleotide pools
      i. Regions of shared complementarity to other oligonucleotides
      ii. Regions of complementarity/identity to primers
      iii. Restriction endonuclease recognition sites
   b. Overlapping assembly by hybridization through regions of complementarity and sealing of nicks to form intermediate duplexes
   c. Generating assembled duplexes by amplification of intermediate duplex polynucleotides
4. Producing assembled duplexes by Fragment Assembly and Ligation/Single Primer Amplification (FAL-SPA)
   a. Variant (e.g. randomized) duplexes
   b. Reference sequence duplexes and scaffold duplexes
   c. Regions of complementarity to SPA primers
   d. Producing assembled polynucleotides and intermediate duplexes by fragment assembly and ligation (FAL)
   e. Producing assembled duplexes by amplification (SPA)
5. Modified FAL-SPA
   a. Pools of variant (e.g. randomized) duplexes
   b. Pools of reference sequence duplexes
   c. Regions of complementarity to SPA primers
   d. Restriction endonuclease cleavage
   e. Producing assembled polynucleotides and intermediate duplexes by fragment assembly and ligation (FAL)
   f. Producing assembled duplexes by amplification (SPA)
6. Isolation of duplexes and duplex cassettes

### F. LIGATION OF THE ASSEMBLED DUPLEX CASSETTES INTO VECTORS

1. Expression vectors
2. Display vectors
   a. Phagemid and phage vectors
   b. Nucleic acids encoding coat proteins and portions of fusion proteins
      i. Stop codons
   c. Promoters
   d. Vector design and methods for phage-display of domain-exchange antibody fragments
      i. Exemplary provided vectors

### G. TRANSFORMATION OF HOST CELLS WITH VECTORS CONTAINING THE DUPLEX CASSETTES, AMPLIFICATION, EXPRESSION

1. Types of host cells
2. Amplification
3. Expression of polypeptides
   a. Host cells and systems for expression
      i. Prokaryotic cells
      ii. Yeast cells
      iii. Insect cells
      iv. Mammalian cells
      v. Plants
   b. Expression, isolation and analysis of polypeptides from the host cells

### H. DISPLAY OF VARIANT POLYPEPTIDES ON GENETIC PACKAGES

1. Phage display
   a. Transformation and growth of phage-display compatible cells
   b. Co-infection with helper phage, packaging and expression
   c. Isolation of polypeptides/genetic packages
2. Other display methods
   a. Cell surface display libraries
   b. Other display systems

### I. SELECTION OF VARIANT POLYPEPTIDES FROM THE COLLECTIONS

1. Confirming display of the polypeptides
2. Selection of variant polypeptides from the collections
   a. Panning
      i. Incubation of the polypeptides with a binding partner
      ii. Washing
      iii. Elution of bound polypeptides
3. Amplification and analysis of selected polypeptides
4. Analysis of selected variant polypeptides
5. Iterative screening

### J. DISPLAY OF POLYPEPTIDES ON GENETIC PACKAGES

1. Domain exchanged antibodies
2. Display vectors and methods
   a. Conventional methods for display of antibody polypeptides
   b. Domain exchanged antibody fragments
   c. Provided vectors and methods for display
      i. Stop codons and partial suppressor strains
         a. Stop codons
         b. Expression in suppressor and non-suppressor hosts
         c. Translation and expression of two distinct polypeptides from a single genetic element
         d. Exemplary fragments displayed from vectors with stop codons
      ii. Peptide linkers
      iii. Dimerization sequences
         a. Mutations promoting dimerization
         b. Hinge regions
         c. Other dimerization domains
      iv. Exemplary domain exchanged fragments
         a. Domain exchanged Fab fragment
         b. ii. Domain exchanged scFv fragment
         c. Domain exchanged Fab hinge fragment
         d. Domain exchanged scFv tandem fragment
         e. Domain exchanged single chain Fab fragments
         f. Domain exchanged Fab Cys19
         g. Domain exchanged scFv hinge
3. Exemplary provided vectors
   a. pCAL vectors
      i. 2G12 pCAL vectors and variants
      ii. 2G12 pCAL IT*
      iii. Vectors for display of other domain exchanged fragments
4. Suppressor strains and systems
   a. Suppressor tRNAs and partial suppressor cells
      i. Amber suppressor cells
5. Methods for phage display of domain exchanged antibodies, phage display libraries containing domain exchanged antibodies and methods for selecting domain exchanged antibodies from the libraries

### K. EXAMPLES

### A. DEFINITIONS

Unless defined otherwise, all technical and scientific terms used herein have the same meaning as is commonly understood by one of skill in the art to which the invention(s) belong. All patents, patent applications, published applications and publications, GENBANK sequences, websites and other published materials referred to throughout the entire disclosure herein, unless noted otherwise, are incorporated by reference in their entirety. In the event that there is a plurality of definitions for terms herein, those in this section prevail. Where reference is made to a URL or other such identifier or address, it is understood that such identifiers can change and particular information on the internet can come and go, but equivalent information is known and can be readily accessed, such as by searching the internet and/or appropriate databases. Reference thereto evidences the availability and public dissemination of such information.

As used herein, macromolecule refers to any molecule having a molecular weight from hundreds to millions of daltons. Macromolecules include peptides, proteins, polypeptides, nucleotides, nucleic acids, and other such molecules that are generally synthesized by biological organisms, but can be prepared synthetically or using recombinant molecular biology methods.

As used herein, “biomolecule” refers to any compound found in nature and any derivatives thereof. Exemplary biomolecules include but are not limited to: oligonucleotides, oligonucleosides, proteins, peptides, amino acids, peptide nucleic acid molecules (PNAs), oligosaccharides and monosaccharides.

As used herein, “polypeptide” refers to two or more amino acids covalently joined. The terms “polypeptide” and “protein” are used interchangeably herein.

As used herein, a native polypeptide or a native nucleic acid molecule is a polypeptide or nucleic acid molecule that can be found in nature. A native polypeptide or nucleic acid molecule can be the wild-type form of a polypeptide or nucleic acid molecule. A native polypeptide or nucleic acid molecule can be the predominant form of the polypeptide, or any allelic or other natural variant thereof. The variant polypeptides and nucleic acid molecules provided herein can have modifications compared to native polypeptides and nucleic acid molecules.

As used herein, the wild-type form of a polypeptide or nucleic acid molecule is a form encoded by a gene or by a coding sequence encoded by the gene. Typically, a wild-type form of a gene, or molecule encoded thereby, does not contain mutations or other modifications that alter function or structure. The term wild-type also encompasses forms with allelic variation as occurs among and between species. As used herein, a predominant form of a polypeptide or nucleic acid molecule refers to a form of the molecule that is the major form produced from a gene. A “predominant form” varies from source to source. For example, different cells or tissue types can produce different forms of polypeptides, for example, by alternative splicing and/or by alternative protein processing. In each cell or tissue type, a different polypeptide can be a “predominant form.”

As used herein, a polypeptide domain is a part of a polypeptide (a sequence of three or more, generally 5 or 7 or more amino acids) that is a structurally and/or functionally distinguishable or definable. Exemplary of a polypeptide domain is a part of the polypeptide that can form an independently folded structure within a polypeptide made up of one or more structural motifs (e.g. combinations of alpha helices and/or beta strands connected by loop regions) and/or that is recognized by a particular functional activity, such as enzymatic activity or antigen binding. A polypeptide can have one, typically more than one, distinct domains. For example, the polypeptide can have one or more structural domains and one or more functional domains. A single polypeptide domain can be distinguished based on structure and function. A domain can encompass a contiguous linear sequence of amino acids. Alternatively, a domain can encompass a plurality of non-contiguous amino acid portions, which are non-contiguous along the linear sequence of amino acids of the polypeptide. Typically, a polypeptide contains a plurality of domains. For example, each heavy chain and each light chain of an antibody molecule contains a plurality of immunoglobulin (Ig) domains, each about 110 amino acids in length.

As used herein, a structural polypeptide domain is a polypeptide domain that can be identified, defined or distinguished by homology of the amino acid sequence therein to amino acid sequences of related family members and/or by similarity of 3-dimensional structure to structure of related family members. Exemplary of related family members are members of the serine protease family. Also exemplary of related family members are members of the immunoglobulin family, for example, antibodies. For example, particular structural amino acid motifs can define an extracellular domain.

As used herein, a functional polypeptide domain is a domain that can be distinguished by a particular function, such as an ability to interact with a biomolecule, for example, through antigen binding, DNA binding, ligand binding, or dimerization, or by enzymatic activity, for example, kinase activity or proteolytic activity. A functional domain independently can exhibit a function or activity such that the domain, independently or fused to another molecule, can perform an activity, such as, for example enzymatic activity or antigen binding. Exemplary of domains are Immunoglobulin domains, variable region domains, including heavy and light chain variable region domains, constant region domains and antibody binding site domains.

As used herein, “extracellular domain” refers to the domain of a cell surface bound receptor or an antibody that is present on the outside surface of the cell and can includes ligand or antigen binding site(s).

As used herein, a transmembrane domain is a domain that spans the plasma membrane of a cell, anchoring the receptor and generally includes hydrophobic residues.

As used herein, a cytoplasmic domain of a cell surface receptor is the domain located within the intracellular space. A cytoplasmic domain can participate in signal transduction.

Those of skill in the art are familiar with these and other domains and can identify them by virtue of structural and/or functional homology with other such domains. For exemplification herein, definitions are provided, but it is understood that it is well within the skill in the art to recognize particular domains by name. If needed, appropriate software can be employed to identify domains.

As used herein, a portion of a polypeptide contains one or more contiguous amino acids within the polypeptide, for example, 1, 2, 3, 4, 5, 6, 8, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50 or more amino acids of the polypeptide, but fewer than all of the amino acids that make up the polypeptide. A portion can be a single amino acid position. A polypeptide domain can contain one, but typically more than one, portion. For example, the amino acid sequence of each CDR is a portion within the antigen binding site domain of an antibody. Each CDR is a portion of a variable region domain. Two or more non-contiguous portions can be part of the same domain.

As used herein, a region of a polypeptide is a portion of the polypeptide containing two or more contiguous amino acids of the polypeptide, for example, 2, 3, 4, 5, 6, 8, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50 or more, typically ten or more, contiguous amino acids, of the polypeptide, for example, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50 or more amino acids of the polypeptide, but not necessarily all of the amino acids that make up the polypeptide.

As used herein, a functional region of a polypeptide is a region of the polypeptide that contains at least one functional domain, which imparts a particular function, such as an ability to interact with a biomolecule, for example, through antigen binding, DNA binding, ligand binding, or dimerization, or by enzymatic activity, for example, kinase activity or proteolytic activity; exemplary of functional regions of polypeptides are antibody domains, such as V_{H}, V_{L}, C_{H}, C_{L}, and portions thereof, such as CDRs, including CDR1, CDR and CDR3, and antigen binding portions, such as antibody combining sites.

As used herein, a functional region of an antibody is a portion of the antibody that contains at least the V_{H}, V_{L}, C_{H}, C_{L} or hinge region domain of the antibody, or at least a functional region thereof.

As used herein, a functional region of a domain exchanged antibody is a portion of a domain exchanged antibody that contains at least the domain exchanged antibody's V_{H}, V_{L}, C_{H}, C_{L} or hinge region domain, or a functional region of such a domain, such that the functional region of the domain exchanged antibody (either alone or in combination with other domain exchanged antibody domain(s) or region(s) thereof), retains the domain exchanged structure of the domain exchanged antibody, including the V_{H}-V_{H} interface.

As used herein, a functional region of a V_{H} domain is at least a portion of the full V_{H} domain that retains at least a portion of the binding specificity of the full V_{H} domain (e.g. by retaining one or more CDR of the full V_{H} domain), such that the functional region of the V_{H} domain, either alone or in combination with another antibody domain (e.g. V_{L} domain) or region thereof, binds to antigen. Exemplary functional regions of V_{H} domains are regions containing the CDR1, CDR2 and/or CDR3 of the V_{H} domain.

As used herein, a functional region of a V_{L} domain is at least a portion of the full V_{L} domain that retains at least a portion of the binding specificity of the full V_{L} domain (e.g. by retaining one or more CDR of the full V_{L} domain), such that the function region of the V_{L} domain, either alone or in combination with another antibody domain (e.g. V_{H} domain) or region thereof, binds to antigen. Exemplary functional regions of V_{L} domains are regions containing the CDR1, CDR2 and/or CDR3 of the V_{L} domain.

As used herein, a functional region of a domain exchanged V_{H} domain is at least a portion of the full domain exchanged V_{H} domain that retains at least a portion of the binding specificity of the full domain exchanged V_{H} domain (e.g. by retaining one or more CDR domain and residues that promote the V_{H}-V_{H} interface), such that the functional region of a domain exchanged V_{H} domain, either alone or in conjunction with another domain (e.g. a V_{L} domain or another domain exchanged V_{H} domain), or functional region thereof, binds to antigen and retains the domain exchanged configuration, including the V_{H}-V_{H} interface. Exemplary of a functional region of a domain exchanged V_{H} domain is a portion containing the CDR1, CDR2 and/or CDR3 of the full domain exchanged V_{H} domain and any residues necessary to confer the formation of the V_{H}-V_{H} interface.

As used herein, a structural region of a polypeptide is a region of the polypeptide that contains at least one structural domain.

As used herein, a region of a polynucleotide is a portion of the polynucleotide containing two or more, typically at least six or more, typically ten or more, contiguous nucleotides, for example, 2, 2, 3, 4, 5, 6, 8, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50 or more nucleotides of the polynucleotide, but not necessarily all the nucleotides that make up the polynucleotide.

As used herein, a region of a target polynucleotide is a portion of the target polynucleotide that encodes at least a region of the target polypeptide (e.g. encodes a portion of the target polypeptide containing two or more contiguous amino acids, typically ten or more amino acids, of the target polypeptide, for example, 2, 3, 4, 5, 6, 8, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50 or more amino acids of the target polynucleotide).

As used herein, a functional region of a target polynucleotide is a region that encodes at least a functional domain of the polypeptide.

As used herein, a structural region of a target polynucleotide is a region that encodes at least a structural domain of the polypeptide.

As used herein, antibody refers to immunoglobulins and immunoglobulin fragments, whether natural or partially or wholly synthetically, such as recombinantly, produced, including any fragment thereof containing at least a portion of the variable region of the immunoglobulin molecule that retains the binding specificity ability of the full-length immunoglobulin. Antibodies include domain exchanged antibodies, including domain exchanged antibody fragments. Hence antibody includes any protein having a binding domain that is homologous or substantially homologous to an immunoglobulin antigen binding domain (antibody combining site). For purposes herein, the term antibody includes antibody fragments, such as, but not limited to, Fab, Fab′, F(ab′)₂, single-chain Fvs (scFv), Fv, dsFv, diabody, Fd and Fd′ fragments Fab fragments, Fd fragments and scFv fragments. Other known fragments include, but are not limited to, scFab fragments (Hust et al., BMC Biotechnology (2007), 7:14), and domain exchanged fragments, such as domain exchanged scFv fragments, domain exchanged scFv tandem fragments, domain exchanged scFv hinge fragments, domain exchanged Fab fragments, domain exchanged single chain Fab fragments (scFab), domain exchanged Fab hinge fragments, and other modified domain exchanged fragments. Antibodies include members of any immunoglobulin class, including IgG, IgM, IgA, IgD and IgE.

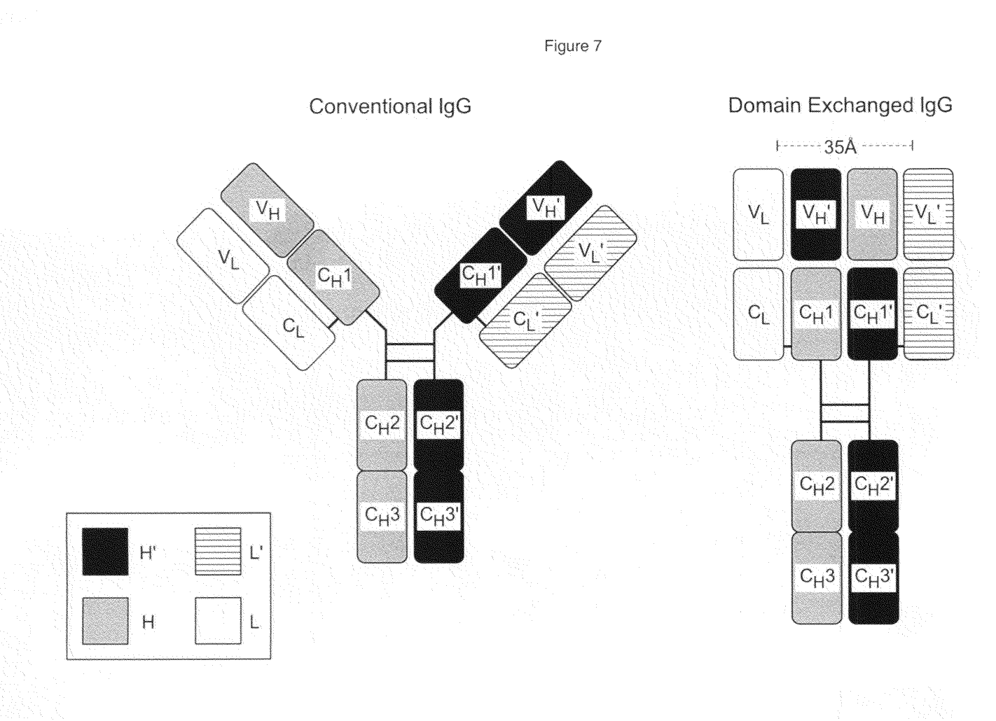

As used herein, a conventional antibody refers to an antibody that contains two heavy chains (which can be denoted H and H′) and two light chains (which can be denoted L and L′) and two antibody combining sites, where each heavy chain can be a full-length immunoglobulin heavy chain or any functional region thereof that retains antigen binding capability (e.g. heavy chains include, but are not limited to, V_{H}, chains V_{H}-C_{H}1 chains and V_{H}-C_{H}1-C_{H}2-C_{H}3 chains), and each light chain can be a full-length light chain or any functional region of (e.g. light chains include, but are not limited to, V_{L} chains and V_{L}-C_{L} chains). Each heavy chain (H and H′) pairs with one light chain (L and L′, respectively). (See e.g., FIG. 7, showing a conventional human full-length IgG antibody compared to a domain exchanged IgG antibody).

As used herein, a domain exchanged antibody refers to any antibody (including antibody fragments) having a domain exchanged three-dimensional structural configuration, which is characterized by the pairing of each heavy chain variable region with the opposite light chain variable region (and optionally the opposite light chain constant region), where the pairing is opposite as compared to heavy-light chain pairing in a conventional antibody, and by the formation of an interface (V_{H}-V_{H}′ interface) between adjacently positioned V_{H} domains (see, e.g. FIG. 7, comparing exemplary conventional and domain exchanged full-length IgG antibodies); domain exchanged antibodies further include any antibody fragment derived from such an antibody that retains the V_{H}-V_{H}′ interface and at least a portion of the antigen specificity of the antibody. This V_{H}-V_{H}′ interface can contain one or more non-conventional antibody combining sites. In one example, the opposite pairing and V_{H}-V_{H}′ interface are formed by interlocked heavy chains.

As used herein, a full-length antibody is an antibody having two full-length heavy chains (e.g. V_{H}-C_{H}1-C_{H}2-C_{H}3 or V_{H}-C_{H}1-C_{H}2-C_{H}3-C_{H}4) and two full-length light chains (V_{L}-C_{L}) and hinge regions, such as human antibodies produced naturally by antibody secreting B cells and antibodies with the same domains that are synthetically produced.

As used herein, antibody fragment refers to any portion of a full-length antibody that is less than full length but contains at least a portion of the variable region of the antibody that binds antigen (e.g. one or more CDRs and/or one or more antibody combining sites) and thus retains the binding specificity, and at least a portion of the specific binding ability of the full-length antibody; antibody fragments include antibody derivatives produced by enzymatic treatment of full-length antibodies, as well as synthetically, e.g. recombinantly produced derivatives. Examples of antibody fragments include, but are not limited to, Fab, Fab′, F(ab′)₂, single-chain Fvs (scFv), Fv, dsFv, diabody, Fd and Fd′ fragments and domain exchanged fragments, such as domain exchanged scFv fragments, domain exchanged scFv tandem fragments, domain exchanged scFv hinge fragments, domain exchanged Fab fragments, domain exchanged single chain Fab fragments (scFab), domain exchanged Fab hinge fragments, and other modified domain exchanged fragments and other fragments, including modified fragments (see, for example, Methods in Molecular Biology, Vol 207: Recombinant Antibodies for Cancer Therapy Methods and Protocols (2003); Chapter 1; p 3-25, Kipriyanov). The fragment can include multiple chains linked together, such as by disulfide bridges and/or by peptide linkers. An antibody fragment generally contains at least about 50 amino acids and typically at least 200 amino acids.

As used herein, an Fv antibody fragment is composed of one variable heavy domain (V_{H}) and one variable light (V_{L}) domain linked by noncovalent interactions.

As used herein, a dsFv refers to an Fv with an engineered intermolecular disulfide bond, which stabilizes the V_{H}-V_{L} pair.

As used herein, an Fd fragment is a fragment of an antibody containing a variable domain (V_{H}) and one constant region domain (C_{H}1) of an antibody heavy chain.

As used herein, a conventional Fab fragment (also referred to as simply “Fab fragment”) is an antibody fragment that results from digestion of a full-length immunoglobulin with papain, or a fragment having the same structure that is produced synthetically, e.g. recombinantly. A conventional Fab fragment contains a light chain (containing a V_{L} and C_{L}) and another chain containing a variable domain of a heavy chain (V_{H}) and one constant region domain of the heavy chain (C_{H}1); it can be recombinantly produced.

As used herein, 2G12 refers to the domain exchanged human monoclonal IgG1 antibody produced from the hybridoma cell line CL2 (as described in U.S. Pat. No. 5,911,989; Buchacher et al., AIDS Research and Human Retroviruses, 10(4) 359-369 (1994); and Trkola et al., Journal of Virology, 70(2) 1100-1108 (1996)), and any synthetically, e.g. recombinantly, produced antibody having the identical sequence of amino acids, including any antibody fragment thereof having at least the antigen-binding portions of the heavy and light chain variable region domains to the full-length antibody, such as the 2G12 domain exchanged Fab fragment (see, for example, Published U.S. Application, Publication No.: US20050003347 and Calarese et al., Science, 300, 2065-2071 (2003), including supplemental information). 2G12 antibodies specifically bind HIV gp120 antigen.

As used herein, “gp120” “HIV gp120” and “gp120 antigen” refer to the HIV envelope surface glycoprotein, epitopes of which are specifically recognized and bound by the 2G12 antibody. HIV gp120 (GENBANK gi:28876544) is one of two cleavage products resulting from cleavage of the gp160 precursor glycoprotein (GENBANK g.i. 9629363). Gp120 can refer to the full-length gp120 or a fragment thereof containing epitopes bound by the 2G12 antibody.

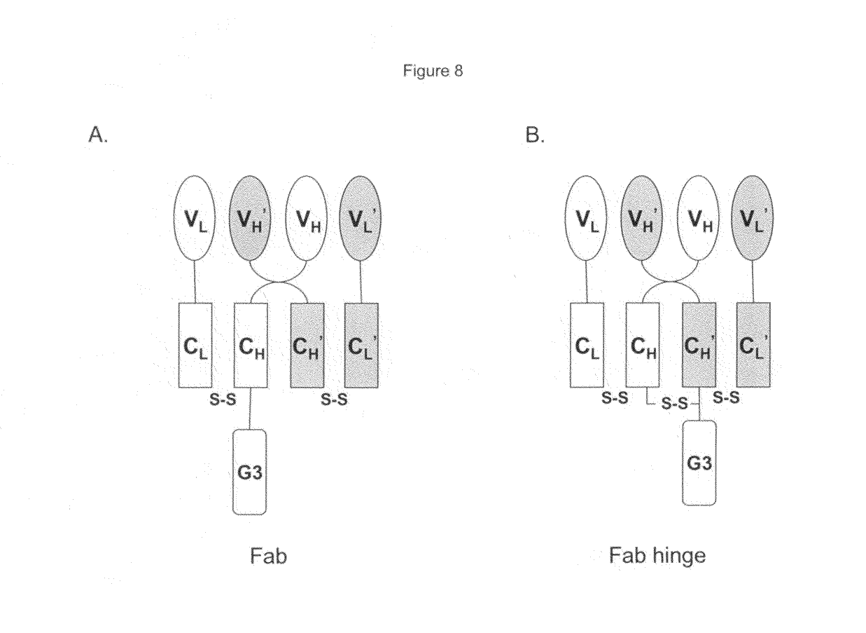

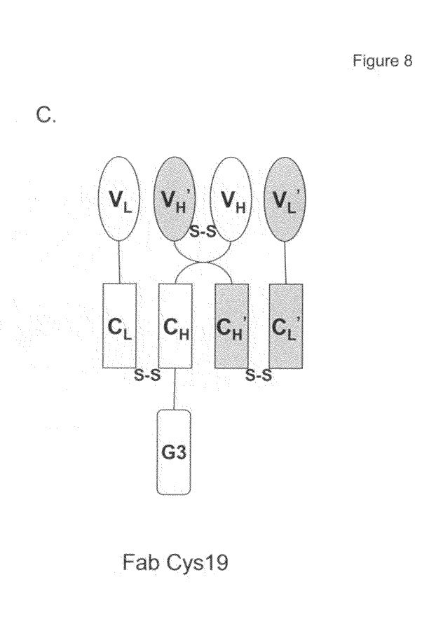

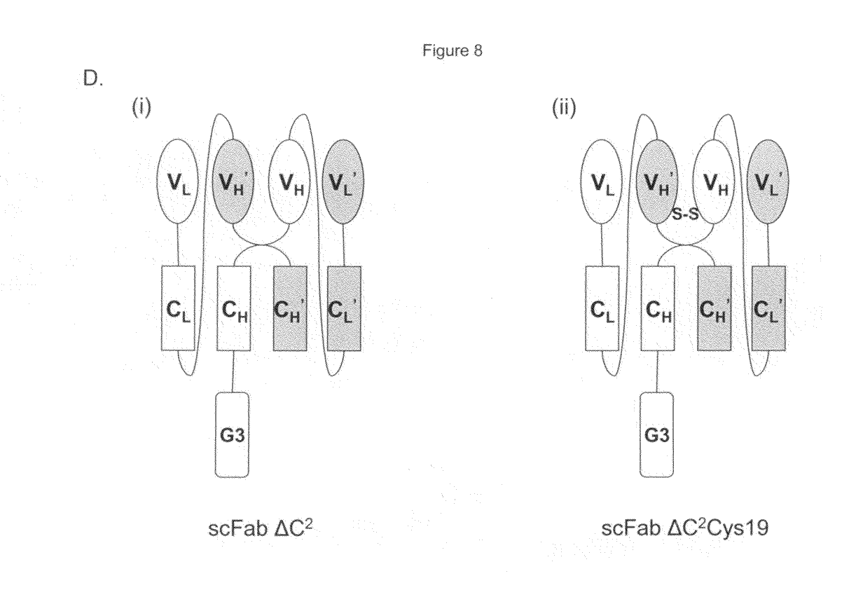

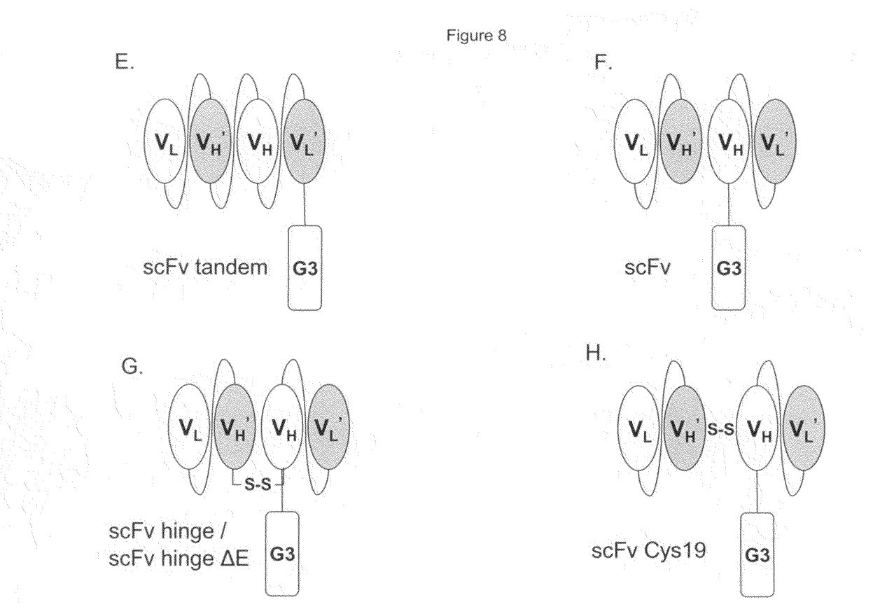

As used herein, a domain exchanged Fab fragment is a domain exchanged antibody fragment that contains two copies each of a light (V_{L}-C_{L}, V_{L}′-C_{L}′) chain and a heavy (V_{H}-C_{H}1, V_{H}′-C_{H}1′) chain, which are folded in the domain exchanged configuration, where each heavy chain variable region pairs with the opposite light chain variable region compared to a conventional antibody, and an interface (V_{H}-V_{H}′) is formed between adjacently positioned V_{H} domains. Typically, the fragment contains two conventional antibody combining sites and at least one non-conventional antibody combining site (contributed to by residues at the V_{H}-V_{H}′ interface). See, for example, FIG. 8A, showing a domain exchanged Fab fragment displayed on phage.

A domain exchanged single chain Fab fragment (scFab) is a domain exchanged Fab fragment, further including peptide linkers between each V_{H} and V_{L}. In some examples of a domain exchanged scFab fragment (e.g. domain exchanged scFabΔC2 fragment), one or more cysteines are mutated compared to the native scFab fragment, to eliminate one or more disulfide bonds between constant regions.

A domain exchanged Fab hinge fragment is a domain exchanged Fab fragment, further containing an antibody hinge region adjacent to each heavy chain constant region.

As used herein, a F(ab′)₂ fragment is an antibody fragment that results from digestion of an immunoglobulin with pepsin at pH 4.0-4.5, or a synthetically, e.g. recombinantly, produced antibody having the same structure. The F(ab′)₂ fragment essentially contains two Fab fragments where each heavy chain portion contains an additional few amino acids, including cysteine residues that form disulfide linkages joining the two fragments; it can be recombinantly produced.

A Fab′ fragment is a fragment containing one half (one heavy chain and one light chain) of the F(ab′)₂ fragment.

As used herein, an Fd′ fragment is a fragment of an antibody containing one heavy chain portion of a F(ab′)₂ fragment.

As used herein, an Fv′ fragment is a fragment containing only the V_{H} and V_{L} domains of an antibody molecule.

As used herein, a conventional scFv fragment (also referred to simply as “scFv” fragment) refers to an antibody fragment that contains a variable light chain (V_{L}) and variable heavy chain (V_{H}), covalently connected by a polypeptide linker in any order. The linker is of a length such that the two variable domains are bridged without substantial interference. Exemplary linkers are (Gly-Ser) residues with some Glu or Lys residues dispersed throughout to increase solubility.

As used herein, a domain exchanged scFv fragment is a domain exchanged antibody fragment containing two chains, each of which contains one V_{H} and one V_{L} domain, joined by a peptide linker (V_{H}-linker-V_{L}). The two chains interact through the V_{H} domains, producing the V_{H}-V_{H}′ interface characteristic of the domain exchanged configuration. Typically, the V_{H}-linker-V_{L} sequence of amino acids in each chain is identical. An example is illustrated in FIG. 8F.

In one example, as illustrated in FIG. 8F, when the domain exchanged scFv fragment is displayed on a genetic package, one of the chains is a fusion protein, containing the V_{H}-linker-V_{L} and a coat protein, such as cp3 (coat protein-V_{H}-linker-V_{L}), and the other chain is a soluble chain (V_{H}-linker-V_{L}). Alternatively, both chains can be fusion proteins.

A domain exchanged scFv hinge fragment is a domain exchanged scFv fragment further containing an antibody hinge region adjacent to each V_{H} domain. An example is illustrated in FIG. 8G.

As used herein, a domain exchanged scFv tandem fragment refers to a domain exchanged antibody fragment containing two V_{H} domains and two V_{L} domains, each in a single chain and separated by polypeptide linkers. The linear configuration of these domains is V_{L}-linker-V_{H}-linker-V_{H}-linker-V_{L}. An example is illustrated in FIG. 8E. In one example, for display on genetic packages, the fragment further includes a coat protein, e.g. a phage coat protein, at one or the other end of the molecule, adjacent or in close proximity to one of the V_{L} chains.

As used herein, hsFv refers to antibody fragments in which the constant domains normally present in a Fab fragment have been substituted with a heterodimeric coiled-coil domain (see, e.g., Arndt et al. (2001) J Mol. Biol. 7:312:221-228).

As used herein, “antibody hinge region” or “hinge region” refers to a polypeptide region that exists naturally in the heavy chain of the gamma, delta and alpha antibody isotypes, between the C_{H}1 and C_{H}2 domains that has no homology with the other antibody domains. This region is rich in proline residues and gives the IgG, IgD and IgA antibodies flexibility, allowing the two “arms” (each containing one antibody combining site) of the Fab portion to be mobile, assuming various angles with respect to one another as they bind antigen. This flexibility allows the Fab arms to move in order to align the antibody combining sites to interact with epitopes on cell surfaces or other antigens. Two interchain disulfide bonds within the hinge region stabilize the interaction between the two heavy chains. In some embodiments provided herein, the synthetically produced antibody fragments contain one or more hinge region, for example, to promote stability via interactions between two antibody chains. Hinge regions are exemplary of dimerization domains.

As used herein, “linker” refers to short sequences of amino acids that join two polypeptide sequences (or nucleic acid encoding such an amino acid sequence). “Peptide linker” refers to the short sequence of amino acids joining the two polypeptide sequences. Exemplary of polypeptide linkers are linkers joining two antibody chains in a synthetic antibody fragment such as an scFv fragment. Linkers are well-known and any known linkers can be used in the provided methods. Exemplary of polypeptide linkers are (Gly-Ser)ₙ amino acid sequences, with some Glu or Lys residues dispersed throughout to increase solubility. Other exemplary linkers are described herein; any of these and other known linkers can be used with the provided compositions and methods.

As used herein, dimerization domains are any domains that facilitate interaction between two polypeptide sequences (such as, but not limited to, antibody chains). Dimerization domains include, but are not limited to, an amino acid sequence containing a cysteine residue that facilitates formation of a disulfide bond between two polypeptide sequences, such as all or part of a full-length antibody hinge region, or one or more dimerization sequences, which are sequences of amino acids known to promote interaction between polypeptides, including, but not limited to, leucine zippers, GCN4 zippers, for example, the sequence of amino acids set forth in SEQ ID NO: 1 (GRMKQLEDKVEELLSKNYHLENEVARLKKLVGERG), and mixtures thereof. In some examples of the provided methods and compositions, one or more dimerization domains is included in a domain exchange antibody fragment, in order to promote interaction between chains, and thus stabilize the domain exchange configuration.

As used herein, diabodies are dimeric scFv; diabodies typically have shorter peptide linkers than scFvs, and they preferentially dimerize.

As used herein, humanized antibodies refer to antibodies that are modified to include “human” sequences of amino acids so that administration to a human does not provoke an immune response. Methods for preparation of such antibodies are known. For example, the hybridoma that expresses the monoclonal antibody is altered by recombinant DNA techniques to express an antibody in which the amino acid composition of the non-variable regions is based on human antibodies. Computer programs have been designed to identify such regions.

As used herein, idiotype refers to a set of one or more antigenic determinants specific to the variable region of an immunoglobulin molecule.

As used herein, anti-idiotype antibody refers to an antibody directed against the antigen-specific part of the sequence of an antibody or T cell receptor. In principle an anti-idiotype antibody inhibits a specific immune response.

As used herein, “monoclonal antibody” refers to a population of identical antibodies, meaning that each individual antibody molecule in a population of monoclonal antibodies is identical to the others. This property is in contrast to that of a polyclonal population of antibodies, which contains antibodies having a plurality of different sequences. Monoclonal antibodies can be produced by a number of well-known methods (Smith et al., J Clin Pathol (2004) 57, 912-917; and Nelson et al., J Clin Pathol (2000), 53, 111-117). For example, monoclonal antibodies can be produced by immortalization of a B cell, for example through fusion with a myeloma cell to generate a hybridoma cell line or by infection of B cells with virus such as EBV. Recombinant technology also can be used to produce monoclonal antibodies in vitro from clonal populations of host cells by transforming the host cells with plasmids carrying artificial sequences of nucleotides encoding the antibodies.

As used herein, an Ig domain is a domain, recognized as such by those in the art, that is distinguished by a structure, called the Immunoglobulin (Ig) fold, which contains two beta-pleated sheets, each containing anti-parallel beta strands of amino acids connected by loops. The two beta sheets in the Ig fold are sandwiched together by hydrophobic interactions and a conserved intra-chain disulfide bond. Individual immunoglobulin domains within an antibody chain further can be distinguished based on function. For example, a light chain contains one variable region domain (V_{L}) and one constant region domain (C_{L}), while a heavy chain contains one variable region domain (V_{H}) and three or four constant region domains (C_{H}). Each V_{L}, C_{L}, V_{H}, and C_{H} domain is an example of an immunoglobulin domain.

As used herein, a variable region domain is a specific Ig domain of an antibody heavy or light chain that contains a sequence of amino acids that varies among different antibodies. Each light chain and each heavy chain has one variable region domain (V_{L}, and, V_{H}). The variable domains provide antigen specificity, and thus are responsible for antigen recognition. Each variable region contains CDRs that are part of the antigen binding site domain and framework regions (FRs).

As used herein, “antigen binding site,” “antigen combining site” and “antibody combining site” are used synonymously to refer to a domain within an antibody that recognizes and physically interacts with cognate antigen. A native conventional full-length antibody molecule has two conventional antigen combining sites, each containing portions of a heavy chain variable region and portions of a light chain variable region. A conventional antigen binding site contains the loops that connect the anti-parallel beta strands within the variable region domains. The antigen combining sites can contain other portions of the variable region domains. Each conventional antigen binding site contains three hypervariable regions from the heavy chain and three hypervariable regions from the light chain. The hypervariable regions also are called complementarity-determining regions (CDRs).

In one example, a domain-exchanged antibody further contains one or more non-conventional antibody combining site formed by the interface between the two heavy chain variable regions. In this example, the domain exchanged antibody contains two conventional and at least one non-conventional antibody combining site. As used herein, an “antigen binding” portion or region of an antibody is a portion/region that contains at least the antibody combining site (either conventional or non-conventional) or a portion of the antibody combining site that retains the antigen specificity of the corresponding full-length antibody (e.g. a V_{H} portion of the antibody combining site).

As used herein, a non-conventional antibody combining site, antigen binding site, or antigen combining site refers to domain within an antibody that recognizes and physically interacts with cognate antigen but does not contain the conventional portions of one heavy chain variable region and one light chain variable region. Exemplary of non-conventional antibody combining sites is the non-conventional site comprised of regions of the two heavy chain variable regions in a domain exchanged antibody.

As used herein, “hypervariable region,” “HV,” “complementarity-determining region” and “CDR” and “antibody CDR” are used interchangeably to refer to one of a plurality of portions within each variable region that together form an antigen binding site of an antibody. Each variable region domain contains three CDRs, named CDR1, CDR2 and CDR3. The three CDRs are non-contiguous along the linear amino acid sequence, but are proximate in the folded polypeptide. The CDRs are located within the loops that join the parallel strands of the beta sheets of the variable domain.

As used herein, framework regions (FRs) are the domains within the antibody variable region domains that are located within the beta sheets; the FR regions are comparatively more conserved, in terms of their amino acid sequences, than the hypervariable regions.

As used herein, a constant region domain is a domain in an antibody heavy or light chain that contains a sequence of amino acids that is comparatively more conserved than that of the variable region domain. In conventional full-length antibody molecules, each light chain has a single light chain constant region (C_{L}) domain and each heavy chain contains one or more heavy chain constant region (C_{H}) domains, which include, C_{H}1, C_{H}2, C_{H}3 and C_{H}4. Full-length IgA, IgD and IgG isotypes contain C_{H}1, C_{H}2C_{H}3 and a hinge region, while IgE and IgM contain C_{H}1, C_{H}2C_{H}3 and C_{H}4. p C_{H}1 and C_{L} domains extend the Fab arm of the antibody molecule, thus contributing to the interaction with antigen and rotation of the antibody arms. Antibody constant regions can serve effector functions, such as, but not limited to, clearance of antigens, pathogens and toxins to which the antibody specifically binds, e.g. through interactions with various cells, biomolecules and tissues.

As used herein, a target polypeptide is a polypeptide selected for variation by the methods provided herein. The target polypeptide can be, for example, a native or wild-type polypeptide, or a polypeptide that contains one or more alterations compared to a native or wild-type polypeptide. In one example, the target polypeptide is a polypeptide selected from a collection of variant polypeptides made according to the methods provided herein. Typically, the sequence of the nucleic acid molecule encoding the target polypeptide is used to design synthetic oligonucleotides for use in the provided methods for creating diversity.

The target polypeptide can be a single chain polypeptide (e.g. a heavy chain of an antibody or a functional region thereof) or can include multiple chains, for example, an entire antibody or antibody fragment. Exemplary of target polypeptides are antibodies, including antibody fragments (for example, a Fab or scFv fragment), antibody chains (e.g. heavy and light chains) and antibody domains (e.g. variable region domains, such as the heavy chain variable region).

As used herein, a target domain is a specific domain within the target polypeptide that is selected for variation using the methods herein. A target polypeptide can have one or more target domains. A target domain can include one, typically more than one, for example 2, 3, 4, 5, 6, 7, 8, 9, 10, 15 or more, target portions.

As used herein, a target portion of a polypeptide is a specific portion within the amino acid sequence of a target polypeptide that is selected for variation using the methods herein. One or more target portions can be selected for variation within a single target polypeptide. The one or more target portions can be within a single target domain or within a plurality of target domains. Each target portion can have one or more target positions.

As used herein, target position of a polypeptide is an individual amino acid position within a target portion that is selected for variation by the methods herein. If the target portion contains only one amino acid in length, the target portion is synonymous with the target position.

As used herein, a target polynucleotide is a polynucleotide including the sequence of nucleotides encoding a target polypeptide or a structural or functional region of the target polypeptide (e.g. a chain of the target polypeptide), and optionally containing additional 5′ and/or 3′ sequence(s) of nucleotides (for example, non-gene-specific nucleotide sequences), for example, restriction endonuclease recognition site sequence(s), sequence(s) complementary to a portion of one or more primers, and/or nucleotide sequence(s) of a bacterial promoter or other bacterial sequence, or any other non gene-specific sequence. The target polynucleotide can be single or double stranded. Target portions within the target polynucleotide encode the target portions of the target polypeptide. Using the provided methods, variant polynucleotides, for example, randomized oligonucleotides, randomized duplex oligonucleotide fragments and randomized oligonucleotide duplex cassettes are synthesized based on the target polynucleotide sequence. Exemplary of target polynucleotides are polynucleotides encoding antibody chains, and polynucleotides encoding antibodies, such as antibody fragments, including domain exchanged antibody fragments (for example, a target polynucleotide encoding a Fab fragment, for example, contained in a vector), antibody chains (e.g. heavy and light chains) and antibody domains (e.g. variable region domains, such as the heavy chain variable region).

As used herein, a variant portion of a polypeptide is a portion that varies in amino acid sequence compared to an analogous portion in a target polypeptide and/or compared to an analogous portion within one or more polypeptides in a collection of variant polypeptides. Typically, each variant portion corresponds to an analogous target portion within the target polypeptide. The amino acid sequence in the variant portion typically is varied by amino acid substitution(s). For example, if an analogous target portion in a target polypeptide contains a valine at a particular amino acid position, a variant portion might have an arginine at the analogous position. The variations alternatively can vary due to additions, deletions or insertions.

As used herein, a variant position of a polypeptide is a single amino acid position of a variant polypeptide that varies compared to an analogous amino acid position in a target polypeptide and/or compared to an analogous position in other members of a collection of variant polypeptides.

As used herein, a variant polypeptide is a polypeptide having one or more, typically at least two, for example, 2, 3, 4, 5, 6, 7, 8, 9, 10, 15 or more, variant portions, compared to a target polypeptide or another polypeptide within a collection (e.g. a pool) of polypeptides. Two or more variant portions within one variant polypeptide typically are non-contiguous in the linear amino acid sequence of the polypeptide. Two or more variant portions can be within the same domain of the variant polypeptide. Two variant portions that are within the same domain can be non-contiguous along the linear amino acid sequence.

For example, a variant antibody variable-region domain polypeptide can contain variant portion(s) within one or more, typically two or three CDRs, where the variant portions vary compared to a native or target antibody variable region polypeptide or compared to other polypeptides in a collection of variant antibody variable domain polypeptides. In one example, the variant antibody polypeptide contains a V_{H} and/or a V_{L} domain, each domain containing three or more variant portions, each within a single CDR. In this example, all the variant portions are within the variant antibody binding site domain. In another example, fewer than each of the three CDRs in a variable region are variant, for example, one or more of CDR1, CDR2 or CDR3 can contain variant portions. In addition to the variant portions, variant polypeptides also contain non-variant portions, which are 100% identical in amino acid sequence to analogous portions of a target polypeptide, a native polypeptide or of the other variant polypeptides in a collection.

As used herein, a collection of variant polypeptides is a collection containing a plurality of analogous polypeptides, each having one or more variant portions compared to a target polypeptide or compared to other polypeptides in the collection. Exemplary of collections of polypeptides are polypeptide libraries, including, but not limited to phage display libraries. It is not necessary that each polypeptide within a variant collection be varied compared to (i.e. contain an amino acid sequence that is different than) the target polypeptide. Nor is it necessary that each polypeptide within the variant collection is varied compared to (i.e. contain an amino acid sequence that is different than) each other polypeptide of the collection. In other words, the amino acid sequence of each individual variant polypeptide is not necessarily different for each member of the collection. Typically, among the variant polypeptides in the collections are at least 10⁴ or about 10⁴, 10⁵ or about 10⁵, 10⁶ or about 10⁶, at least 10⁸ or about 10⁸, at least 10⁹ or about 10⁹, at least 10¹⁰ or about 10¹⁰, or more different polypeptide amino acid sequences. Thus, the collections typically have a diversity of at least 10⁴ or about 10⁴, 10⁵ or about 10⁵, 10⁶ or about 10⁶, at least 10⁸ or about 10⁸, at least 10⁹ or about 10⁹, at least 10¹⁰ or about 10¹⁰, or more.

The variant polypeptides are encoded by variant nucleic acid molecules, typically by variant nucleic acid molecules containing randomized oligonucleotides. The collections of variant polypeptides typically contain at least 10⁶ or about 10⁶ variant polypeptide members, typically at least 10⁷ or about 10⁷ members, typically at least 10⁸ or about 10⁸ members, typically at least 10⁹ or about 10⁹ members, typically at least 10¹⁰ or about 10¹⁰ members or more. More than one variant polypeptide in the collection can contain each individual different amino acid sequence.

As used herein, a modified polypeptide or polynucleotide is a polypeptide or polynucleotide containing one or more amino acid or nucleotide insertions, deletions, additions, substitutions or amino acid or nucleotide modifications, compared to another related molecule, such as a target or native polypeptide or polynucleotide. The modified molecule is said to be modified compared to the other molecule and the modifications typically are described with relation to the particular residues that are modified along the linear amino acid or nucleotide sequence.

As used herein, the term “nucleic acid” refers to at least two linked nucleotides or nucleotide derivatives, including a deoxyribonucleic acid (DNA) and a ribonucleic acid (RNA), joined together, typically by phosphodiester linkages. Also included in the term “nucleic acid” are analogs of nucleic acids such as peptide nucleic acid (PNA), phosphorothioate DNA, and other such analogs and derivatives or combinations thereof. Nucleic acids also include DNA and RNA derivatives containing, for example, a nucleotide analog or a “backbone” bond other than a phosphodiester bond, for example, a phosphotriester bond, a phosphoramidate bond, a phosphorothioate bond, a thioester bond, or a peptide bond (peptide nucleic acid). The term also includes, as equivalents, derivatives, variants and analogs of either RNA or DNA made from nucleotide analogs, single (sense or antisense) and double-stranded nucleic acids. Deoxyribonucleotides include deoxyadenosine, deoxycytidine, deoxyguanosine and deoxythymidine. For RNA, the uracil base is uridine. Nucleic acids can contain nucleotide analogs, including, for example, mass modified nucleotides, which allow for mass differentiation of nucleic acid molecules; nucleotides containing a detectable label such as a fluorescent, radioactive, luminescent or chemiluminescent label, which allow for detection of a nucleic acid molecule; or nucleotides containing a reactive group such as biotin or a thiol group, which facilitates immobilization of a nucleic acid molecule to a solid support. A nucleic acid also can contain one or more backbone bonds that are selectively cleavable, for example, chemically, enzymatically or photolytically cleavable. For example, a nucleic acid can include one or more deoxyribonucleotides, followed by one or more ribonucleotides, which can be followed by one or more deoxyribonucleotides, such a sequence being cleavable at the ribonucleotide sequence by base hydrolysis. A nucleic acid also can contain one or more bonds that are relatively resistant to cleavage, for example, a chimeric oligonucleotide primer, which can include nucleotides linked by peptide nucleic acid bonds and at least one nucleotide at the 3′ end, which is linked by a phosphodiester bond or other suitable bond, and is capable of being extended by a polymerase. Peptide nucleic acid sequences can be prepared using well-known methods (see, for example, Weiler et al. Nucleic acids Res. 25: 2792-2799 (1997)).

As used herein, the terms “polynucleotide” and “nucleic acid molecule” refer to an oligomer or polymer containing at least two linked nucleotides or nucleotide derivatives, including a deoxyribonucleic acid (DNA) and a ribonucleic acid (RNA), joined together, typically by phosphodiester linkages. Polynucleotides also include DNA and RNA derivatives containing, for example, a nucleotide analog or a “backbone” bond other than a phosphodiester bond, for example, a phosphotriester bond, a phosphoramidate bond, a phosphorothioate bond, a thioester bond, or a peptide bond (peptide nucleic acid). Polynucleotides (nucleic acid molecules), include single-stranded and/or double-stranded polynucleotides, such as deoxyribonucleic acid (DNA), and ribonucleic acid (RNA) as well as analogs or derivatives of either RNA or DNA. The term also includes, as equivalents, derivatives, variants and analogs of either RNA or DNA made from nucleotide analogs, single (sense or antisense) and double-stranded polynucleotides. Deoxyribonucleotides include deoxyadenosine, deoxycytidine, deoxyguanosine and deoxythymidine. For RNA, the uracil base is uridine. Polynucleotides can contain nucleotide analogs, including, for example, mass modified nucleotides, which allow for mass differentiation of polynucleotides; nucleotides containing a detectable label such as a fluorescent, radioactive, luminescent or chemiluminescent label, which allow for detection of a polynucleotide; or nucleotides containing a reactive group such as biotin or a thiol group, which facilitates immobilization of a polynucleotide to a solid support. A polynucleotide also can contain one or more backbone bonds that are selectively cleavable, for example, chemically, enzymatically or photolytically cleavable. For example, a polynucleotide can include one or more deoxyribonucleotides, followed by one or more ribonucleotides, which can be followed by one or more deoxyribonucleotides, such a sequence being cleavable at the ribonucleotide sequence by base hydrolysis. A polynucleotide also can contain one or more bonds that are relatively resistant to cleavage, for example, a chimeric oligonucleotide primer, which can include nucleotides linked by peptide nucleic acid bonds and at least one nucleotide at the 3′ end, which is linked by a phosphodiester bond or other suitable bond, and is capable of being extended by a polymerase. Peptide nucleic acid sequences can be prepared using well-known methods (see, for example, Weiler et al. Nucleic acids Res. 25: 2792-2799 (1997)). Exemplary of the nucleic acid molecules (polynucleotides) provided heran are oligonucleotides, including synthetic oligonucleotides, oligonucleotide duplexes, primers, including fill-in primers, and oligonucleotide duplex cassettes.

As used herein, a variant nucleic acid molecule (e.g. a variant polynucleotide, such as a variant polynucleotide duplex, for example, a variant assembled polynucleotide duplex) is any nucleic acid molecule (e.g. polynucleotide) having one or more, typically at least two, e.g. 1, 2, 3, 4, 5, 6, 7, 8, 9, 10, 15 or more, variant portions compared to a target nucleic acid sequence, target polynucleotide, or reference sequence, or compared to one or more other variant nucleic acid molecules within a collection of variant nucleic acid molecules. Exemplary of variant nucleic acid molecules are variant polynucleotides, including variant oligonucleotides, for example, randomized oligonucleotides, randomized duplex oligonucleotide fragments and randomized oligonucleotide duplex cassettes. Collections of variant nucleic acid molecules can be used to express a collection of variant polypeptides. A collection of variant nucleic acid molecules, for example, a nucleic acid library, can encode a collection of variant polypeptides.

As used herein, a variant position is a nucleotide position of a variant nucleic acid molecule that varies compared to an analogous nucleotide position in a target polynucleotide or other member of the collection of variant nucleic acids.

As used herein, a collection (or pool) of polypeptides or of nucleic acid molecules refers to a plurality of such molecules, for example, 2 or more, typically 5 or more, and typically 10 or more, such as, for example, at or about 10, 15, 20, 30, 40, 50, 60, 70, 80, 90, 100, 200, 300, 400, 500, 1000, 10⁴, 10⁵, 10⁶, 10⁷, 10⁸, 10⁹, 10¹⁰, 10¹¹, 10¹², 10¹³, 10¹⁴ or more of such molecules. Typically, the members of the pool are analogous to one another. For example, among the provided collections (pools) of polynucleotides are randomized oligonucleotide pools and collections of variant assembled duplexes, where the nucleotide sequences among the members of the pool are analogous.

As used herein, a collection of variant nucleic acid molecules (e.g. collection of variant polynucleotides) is a collection containing a plurality (e.g. 2 or more, and typically 5 or more and typically 10 or more, such as 10, 15, 20, 30, 40, 50, 60, 70, 80, 90, 100, 200, 300, 400, 500, 1000, 10⁴, 10⁵, 10⁶, 10⁷, 10⁸, 10⁹, 10¹⁰, 10¹¹, 10¹², 10¹³, 10¹⁴ or more) of analogous nucleic acid molecules (e.g. variant polynucleotides), each having one or more variant portions compared to a target nucleic acid molecule and/or compared to other nucleic acid molecules in the collection. Exemplary of the collection of variant nucleic acid molecules are nucleic acid libraries, e.g. libraries where the variant nucleic acid molecules are contained in vectors, or where the variant nucleic acid molecules are vectors. It is not necessary that each polynucleotide within a variant collection be varied compared to (i.e. contain a nucleic acid sequence that is different than) the target polynucleotide. Nor is it necessary that each polynucleotide within the variant collection is varied compared to (i.e. contain a nucleic acid sequence that is different than) each other polynucleotide of the collection. In other words, the nucleic acid sequence of each individual variant polynucleotide is not necessarily different for each member of the collection. Typically, among the variant polynucleotide in the collections are at least 10⁴ or about 10⁴, 10⁵ or about 10⁵, 10⁶ or about 10⁶, at least 10⁸ or about 10⁸, at least 10⁹ or about 10⁹, at least 10¹⁰ or about 10¹⁰, or more different polynucleotide nucleic acid sequences. Thus, the collections typically have a diversity of at least 10⁴ or about 10⁴, 10⁵ or about 10⁵, 10⁶ or about 10⁶, at least 10⁸ or about 10⁸, at least 10⁹ or about 10⁹, at least 10¹⁰ or about 10¹⁰, at least 10¹¹ or about 10¹¹, at least 10¹² or about 10¹², at least 10¹³ or about 10¹³, at least 10¹⁴ or about 10¹⁴, or more.

The provided collections of variant polynucleotides typically contain at least 10⁴ or about 10⁴, 10⁵ or about 10⁵, 10⁶ or about 10⁶ variant polynucleotide members, typically at least 10⁷ or about 10⁷ members, typically at least 10⁸ or about 10⁸ members, typically at least 10⁹ or about 10⁹ members, typically at least 10¹⁰ or about 10¹⁰ members or more.

As used herein, the amount of “diversity” in a collection of polypeptides or polynucleotides refers to the number of different amino acid sequences or nucleic acid sequences, respectively, among the analogous polypeptide or polynucleotide members of that collection. For example, a collection of randomized polynucleotides having a diversity of 10⁷ contains 10⁷ different nucleic acid sequences among the analogous polynucleotide members. In one example, the provided collections of polynucleotides and/or polypeptides have diversities of at least at or about 10⁴, 10⁵, 10⁶, 10⁷, 10⁸, 10⁹, 10¹⁰ or more. In another example, the collection of polynucleotides has at least 10⁴ or about 10⁴, 10⁵ or about 10⁵, 10⁶ or about 10⁶, 10⁷ or about 10⁷, 10⁸ or about 10⁸ or 10⁹ or about 10⁹ diversity, each member of the collection contains at least 50 or about 50, at least 100 or about 100, 200 or about 200, 300 or about 300, 500 or about 500, 1000 or about 1000, or 2000 or about 2000 nucleotides in length. In another example, the collection is a collection of randomized polynucleotides, in which, for each randomized position, each member of the collection contains one or the other of two nucleotides (e.g. A and T) at the randomized position and neither of the two nucleotides (e.g. A or T) is present at the position in more than 55% or about 55% of the members. In another example, the collection is a collection of randomized polynucleotides, in which, for each randomized position, each member of the collection contains one of four or more nucleotides (e.g. A, T, G and C or more) at the randomized position, and none of the four or more nucleotides is present at the analogous position in more than 30% of the members.

As used herein, “a diversity ratio” refers to a ratio of the number of different members in the library over the number of total members of the library. Thus, a library with a larger diversity ratio than another library contains more different members per total members, and thus more diversity per total members. The provided libraries include libraries having high diversity ratios, such as diversity ratios approaching 1, such as, for example, at or about 0.1, 0.2, 0.3, 0.4, 0.5, 0.6, 0.7, 0.8, 0.9 0.91, 0.92, 0.93, 0.94, 0.95, 0.96, 0.97, 0.98, or 0.99.

As used herein, a nucleic acid library is a collection of variant nucleic acid molecules. Typically, the nucleic acid library contains vectors containing variant polynucleotides, typically randomized polynucleotides, for example randomized oligonucleotide duplex cassettes. The randomized polynucleotides in the libraries can be generated using any of the methods provided herein. Typically, generation of the libraries includes generation of pools of randomized (or other variant) oligonucleotides. The polynucleotides in the nucleic acid library typically encode variant polypeptides. The libraries provided herein can be used to express collections of variant polypeptides.

As used herein, the terms “oligonucleotide” and “oligo” are used synonymously. Oligonucleotides are polynucleotides that contain a limited number of nucleotides in length. Those in the art recognize that oligonucleotides generally are less than at or about two hundred fifty, typically less than at or about two hundred, typically less than at or about one hundred, nucleotides in length. Typically, the oligonucleotides provided herein are synthetic oligonucleotides. The synthetic oligonucleotides contain fewer than at or about 250 or 200 nucleotides in length, for example, fewer than about 20, 30, 40, 50, 60, 70, 80, 90, 100, 110, 120, 130, 140, 150, 160, 170, 180, 190 or 200 nucleotides in length. Typically, the oligonucleotides are single-stranded oligonucleotides. The ending “mer” can be used to denote the length of an oligonucleotide. For example, “100-mer” can be used to refer to an oligonucleotide containing 100 nucleotides in length. Exemplary of the synthetic oligonucleotides provided herein are positive and negative strand oligonucleotides, randomized oligonucleotides, reference sequence oligonucleotides, template oligonucleotides and fill-in primers are.

As used herein, synthetic oligonucleotides are oligonucleotides produced by chemical synthesis. Chemical oligonucleotide synthesis methods are well known. Any of the known synthesis methods can be used to produce the oligonucleotides designed and used in the provided methods. For example, synthetic oligonucleotides typically are made by chemically joining single nucleotide monomers or nucleotide trimers containing protective groups. Typically, phosphoramidites, single nucleotides containing protective groups are added one at a time. Synthesis typically begins with the 3′ end of the oligonucleotide. The 3′ most phosphoramidite is attached to a solid support and synthesis proceeds by adding each phosphoramidite to the 5′ end of the last. After each addition, the protective group is removed from the 5′ phosphate group on the most recently added base, allowing addition of another phosphoramidite. Automated synthesizers generally can synthesize oligonucleotides up to about 150 to about 200 nucleotides in length. Typically, the oligonucleotides designed and used in the provided methods are synthesized using standard cyanoethyl chemistry from phosphoramidite monomers. Synthetic oligonucleotides produced by this standard method can be purchased from Integrated DNA Technologies (IDT) (Coralville, Iowa) or TriLink Biotechnologies (San Diego, Calif.).

As used herein, a portion of an oligonucleotide contains one or more contiguous nucleotides within the oligonucleotide, for example, 1, 2, 3, 4, 5, 6, 8, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 60, 70, 80, 90, 100 or more nucleotides. An oligonucleotide can contain one, but typically more than one, portion.

As used herein, a reference sequence is a contiguous sequence of nucleotides that is used as a design template for synthesizing oligonucleotides according to the methods provided herein. Each reference sequence contains nucleic acid identity to a region of a target polynucleotide, as well as optional additional, deletions, insertions and/or substitutions compared to the region of the target polynucleotide. In one example, the region of the target polynucleotide, to which the reference sequence has identity, includes the entire length of the target polynucleotide. Typically, however, the region of the target polynucleotide, to which the reference sequence contains identity, includes less than the entire length of the target polynucleotide. In some examples, the reference sequence contains only a portion with sequence identity to the target polypeptide i.e. at least 2, typically at least 10, contiguous nucleotides of the target polynucleotide. In the provided methods, oligonucleotides in a pool of oligonucleotides are designed based on a reference sequence. In the case of variant oligonucleotides, one or more positions in the oligonucleotides vary compared to the reference sequence. In the case of randomized oligonucleotides, one or more positions (randomized positions) is synthesized using a doping strategy.

In one example, the reference sequence is 100% identical to the region of the target polynucleotide. In another example, the reference sequence is less than 100% identical to the region, such as at or about, or at least at or about, 99, 98, 97, 96, 95, 94, 93, 92, 91, 90%, or less, identical to the region, for example, at least at or about 50%, 55%, 60%, 65%, 70%, 75%, 80%, 85%, 90%, 95%, 96%, 97%, 98%, 99% or any fraction thereof. In one example, the reference sequence contains a region that is identical to the region of the target polynucleotide and an additional region or portion that contains a non gene-specific sequence, or a non-encoding sequence, for example, a regulatory sequence, such as a bacterial leader sequence, promoter sequence, or enhancer sequence; a sequence of nucleotides that is a restriction endonuclease recognition site; and/or a sequence having complementarity to a primer, such as a CALX24 binding sequence. In some cases, the sequence of complementarity to a primer or other additional sequence overlaps with the region of the reference sequence having identity to the target polynucleotide. In one example, the reference sequence contains one or more target portions, each of which corresponds to all or part of a target region within the target polynucleotide to which the reference sequence is identical.

As used herein, when a polypeptide or nucleic acid molecule or region thereof contains or has “identity” or “homology” to another polypeptide or nucleic acid molecule or region, the two molecules and/or regions share greater than or equal to at or about 40% sequence identity, and typically greater than or equal to at or about 50 sequence identity, such as at least at or about 60%, 65%, 70%, 75%, 80%, 85%, 90%, 95%, 96%, 97%, 98%, 99% or 100% sequence identity; the precise percentage of identity can be specified if necessary. A nucleic acid molecule, or region thereof, that is identical or homologous to a second nucleic acid molecule or region can specifically hybridize to a nucleic acid molecule or region that is 100% complementary to the second nucleic acid molecule or region. Identity alternatively can be compared between two theoretical nucleotide or amino acid sequences or between a nucleic acid or polypeptide molecule and a theoretical sequence.

Sequence “identity,” per se, has an art-recognized meaning and the percentage of sequence identity between two nucleic acid or polypeptide molecules or regions can be calculated using published techniques. Sequence identity can be measured along the full length of a polynucleotide or polypeptide or along a region of the molecule. (See, e.g.: Computational Molecular Biology, Lesk, A. M., ed., Oxford University Press, New York, 1988; Biocomputing: Informatics and Genome Projects, Smith, D. W., ed., Academic Press, New York, 1993; Computer Analysis of Sequence Data, Part I, Griffin, A. M., and Griffin, H. G., eds., Humana Press, New Jersey, 1994; Sequence Analysis in Molecular Biology, von Heinje, G., Academic Press, 1987; and Sequence Analysis Primer, Gribskov, M. and Devereux, J., eds., M Stockton Press, New York, 1991). While there exist a number of methods to measure identity between two polynucleotide or polypeptides, the term “identity” is well known to skilled artisans (Carrillo, H. & Lipman, D., SIAM J Applied Math 48:1073 (1988)).

Sequence identity compared along the full length of two polynucleotides or polypeptides refers to the percentage of identical nucleotide or amino acid residues along the full-length of the molecule. For example, if a polypeptide A has 100 amino acids and polypeptide B has 95 amino acids, which are identical to amino acids 1-95 of polypeptide A, then polypeptide B has 95% identity when sequence identity is compared along the full length of a polypeptide A compared to full length of polypeptide B. Alternatively, sequence identity between polypeptide A and polypeptide B can be compared along a region, such as a 20 amino acid analogous region, of each polypeptide. In this case, if polypeptide A and B have 20 identical amino acids along that region, the sequence identity for the regions would be 100%. Alternatively, sequence identity can be compared along the length of a molecule, compared to a region of another molecule. As discussed below, and known to those of skill in the art, various programs and methods for assessing identity are known to those of skill in the art. High levels of identity, such as 90% or 95% identity, readily can be determined without software.

Whether any two nucleic acid molecules have nucleotide sequences that are at least 60%, 70%, 80%, 85%, 90%, 95%, 96%, 97%, 98% or 99% “identical” can be determined using known computer algorithms such as the “FASTA” program, using for example, the default parameters as in Pearson et al. (1988) Proc. Natl. Acad. Sci. USA 85:2444 (other programs include the GCG program package (Devereux, J., et al., Nucleic Acids Research 12(I):387 (1984)), BLASTP, BLASTN, FASTA (Altschul, S. F., et al., J Molec Biol 215:403 (1990); Guide to Huge Computers, Martin J. Bishop, ed., Academic Press, San Diego, 1994, and Carrillo et al. (1988) SIAM J Applied Math 48:1073). For example, the BLAST function of the National Center for Biotechnology Information database can be used to determine identity. Other commercially or publicly available programs include, DNAStar “MegAlign” program (Madison, Wis.) and the University of Wisconsin Genetics Computer Group (UWG) “Gap” program (Madison Wis.)). Percent homology or identity of proteins and/or nucleic acid molecules can be determined, for example, by comparing sequence information using a GAP computer program (e.g., Needleman et al. (1970) J. Mol. Biol. 48:443, as revised by Smith and Waterman ((1981) Adv. Appl. Math. 2:482). Briefly, the GAP program defines similarity as the number of aligned symbols (i.e., nucleotides or amino acids), which are similar, divided by the total number of symbols in the shorter of the two sequences. Default parameters for the GAP program can include: (1) a unary comparison matrix (containing a value of 1 for identities and 0 for non-identities) and the weighted comparison matrix of Gribskov et al. (1986) Nucl. Acids Res. 14:6745, as described by Schwartz and Dayhoff, eds., ATLAS OF PROTEIN SEQUENCE AND STRUCTURE, National Biomedical Research Foundation, pp. 353-358 (1979); (2) a penalty of 3.0 for each gap and an additional 0.10 penalty for each symbol in each gap; and (3) no penalty for end gaps.

In general, for determination of the percentage sequence identity, sequences are aligned so that the highest order match is obtained (see, e.g.: Computational Molecular Biology, Lesk, A. M., ed., Oxford University Press, New York, 1988; Biocomputing: Informatics and Genome Projects, Smith, D. W., ed., Academic Press, New York, 1993; Computer Analysis of Sequence Data, Part I, Griffin, A. M., and Griffin, H. G., eds., Humana Press, New Jersey, 1994; Sequence Analysis in Molecular Biology, von Heinje, G., Academic Press, 1987; and Sequence Analysis Primer, Gribskov, M. and Devereux, J., eds., M Stockton Press, New York, 1991; Carrillo et al. (1988) SIAM J Applied Math 48:1073). For sequence identity, the number of conserved amino acids is determined by standard alignment algorithms programs, and can be used with default gap penalties established by each supplier. Substantially homologous nucleic acid molecules would specifically hybridize typically at moderate stringency or at high stringency all along the length of the nucleic acid of interest. Also contemplated are nucleic acid molecules that contain degenerate codons in place of codons in the hybridizing nucleic acid molecule.

Therefore, the term “identity,” when associated with a particular number, represents a comparison between the sequences of a first and a second polypeptide or polynucleotide or regions thereof and/or between theoretical nucleotide or amino acid sequences. As used herein, the term at least “90% identical to” refers to percent identities from 90 to 99.99 relative to the first nucleic acid or amino acid sequence of the polypeptide. Identity at a level of 90% or more is indicative of the fact that, assuming for exemplification purposes, a first and second polypeptide length of 100 amino acids are compared, no more than 10% (i.e., 10 out of 100) of the amino acids in the first polypeptide differs from that of the second polypeptide. Similar comparisons can be made between first and second polynucleotides. Such differences among the first and second sequences can be represented as point mutations randomly distributed over the entire length of a polypeptide or they can be clustered in one or more locations of varying length up to the maximum allowable, e.g. 10/100 amino acid difference (approximately 90% identity). Differences are defined as nucleotide or amino acid residue substitutions, insertions, additions or deletions. At the level of homologies or identities above about 85-90%, the result should be independent of the program and gap parameters set; such high levels of identity can be assessed readily, often by manual alignment without relying on software.

As used herein, alignment of a sequence refers to the use of homology to align two or more sequences of nucleotides or amino acids. Typically, two or more sequences that are related by 50% or more identity are aligned. An aligned set of sequences refers to 2 or more sequences that are aligned at corresponding positions and can include aligning sequences derived from RNAs, such as ESTs and other cDNAs, aligned with genomic DNA sequence.

Related or variant polypeptides or nucleic acid molecules can be aligned by any method known to those of skill in the art. Such methods typically maximize matches, and include methods, such as using manual alignments and by using the numerous alignment programs available (for example, BLASTP) and others known to those of skill in the art. By aligning the sequences of polypeptides or nucleic acids, one skilled in the art can identify analogous portions or positions, using conserved and identical amino acid residues as guides. Further, one skilled in the art also can employ conserved amino acid or nucleotide residues as guides to find corresponding amino acid or nucleotide residues between and among human and non-human sequences. Corresponding positions also can be based on structural alignments, for example by using computer simulated alignments of protein structure. In other instances, corresponding regions can be identified. One skilled in the art also can employ conserved amino acid residues as guides to find corresponding amino acid residues between and among human and non-human sequences.

As used herein, “analogous” and “corresponding” portions, positions or regions are portions, positions or regions that are aligned with one another upon aligning two or more related polypeptide or nucleic acid sequences (including sequences of molecules, regions of molecules and/or theoretical sequences) so that the highest order match is obtained, using an alignment method known to those of skill in the art to maximize matches. In other words, two analogous positions (or portions or regions) align upon best-fit alignment of two or more polypeptide or nucleic acid sequences. The analogous portions/positions/regions are identified based on position along the linear nucleic acid or amino acid sequence when the two or more sequences are aligned. The analogous portions need not share any sequence similarity with one another. For example, alignment (such that maximizing matches) of the sequences of two homologous nucleic acid molecules, each 100 nucleotides in length, can reveal that 70 of the 100 nucleotides are identical. Portions of these nucleic acid molecules containing some or all of the other non-identical 30 amino acids are analogous portions that do not share sequence identity. Alternatively, the analogous portions can contain some percentage of sequence identity to one another, such as at or about 50%, 55%, 60%, 65%, 70%, 75%, 80%, 85%, 90%, 95%, 96%, 97%, 98%, 99%, or fractions thereof. In one example, the analogous portions are 100% identical.

Exemplary of analogous portions, positions and regions are portions, positions and regions that are analogous among members of a provided collection of variant polynucleotides or polypeptides. For example, collections of randomized polynucleotides (e.g. randomized oligonucleotides, assembled duplexes or duplex cassettes) contain randomized portions; the randomized portions contain randomized positions. The randomized portions and positions are analogous among the members of the collection. For example, a single randomized position is analogous among the members. When referring to a collection of randomized nucleic acids, “a randomized position” can be used to describe the randomized position that is analogous among all the members, where the position aligns when two of the members are aligned by best fit. Similarly, reference sequence portions and reference sequence positions are analogous among the members of the collection. In another example, the analogous portions are analogous between a target polypeptide and a variant polypeptide. For example, a variant portion in a variant polynucleotide is analogous to a target portion in a target polypeptide Analogous nucleic acid molecules, sequences and analogous polypeptides are those that share one or more analogous portions or similarity.

As used herein, when it is said that an oligonucleotide or pool of oligonucleotides is synthesized “based on a reference sequence,” this language indicates that that reference sequence was is used as a design template for the oligonucleotide or for each of the oligonucleotides in the pool and that the oligonucleotides in the pool contain portions identical to the reference sequence. Typically, the reference sequence is used to design oligonucleotides, which are synthesized in pools. Each oligonucleotide in a pool of oligonucleotides is designed based on the same reference sequence. In one example, a plurality of oligonucleotide pools can be synthesized to generate a plurality of oligonucleotides for assembling duplex cassettes. In this example, each of the reference sequences that are used as templates for the plurality of pools has sequence identity to a different region of the target polynucleotide. Typically, these different regions overlap along the nucleic acid sequence of the target polynucleotide. It is not necessary that a nucleic acid molecule having the sequence of nucleotides contained in the reference sequence be physically produced. For example, a virtual or theoretical reference sequence can be used as a design template for synthesizing the oligos.

As used herein, a variant portion of a polynucleotide (e.g. an oligonucleotide) is a portion of the polynucleotide having altered nucleic acid sequence compared to an analogous portion of a target polynucleotide, a reference nucleic acid sequence, or compared to an analogous portion in one or more other polynucleotides (e.g. oligonucleotides) within a collection of variant polynucleotides. Typically, each variant portion within each of the polynucleotides is analogous to a target portion within the reference sequence, which is analogous to all or part of a target portion of a target polynucleotide. Typically, the variant portions of the polynucleotides are randomized portions.

As used herein, a randomized portion of a polynucleotide (e.g. oligonucleotide) is a variant portion that varies in nucleic acid sequence compared to analogous portions in a plurality of other members in a collection (e.g. pool) of randomized polynucleotides, e.g. a collection of randomized oligonucleotides. Thus, a plurality of different nucleic acid sequences are represented at a particular randomized portion among the plurality of individual members in the collection. It is not necessary that the randomized portion vary among all the members of the collection, or that the randomized portion in a single polynucleotide vary compared to a target polynucleotide or to a native polynucleotide. Further, a randomized portion does not necessarily vary (compared to analogous portion(s)) at every nucleotide position within the randomized portion, but the nucleotide position at the 5′ end and the nucleotide position at the 3′ end of the randomized portion are randomized positions. In one example, when the randomized portions are part of a synthetic oligonucleotide, they are synthesized using one or more doping strategies during oligonucleotide synthesis. Randomized portions of polynucleotides alternatively can be synthesized by polymerase extension reaction, for example, using a randomized pool of primers and/or using one or more randomized polynucleotides (e.g. oligonucleotides) as a template.

As noted, in some examples, not every nucleotide position in the randomized portion is a randomized position. In one example, one or more positions within the randomized portion is a non-randomized position (e.g. a reference sequence position or variant position). For example, a randomized portion that is ten nucleotides in length can vary at all ten nucleotide positions compared to the reference sequence; alternatively, it can vary at only 5, 6, 7, 8, or 9 of the positions. Typically, at least 50% or at least about 50%, at least 60% or at least about 60%, at least 70% or at least about 70%, at least 80% or at least about 80%, at least 90% or at least about 90%, at least 95% or at least about 95%, at least 99% or at least about 99% or at or about 100% of the positions in the randomized portion are randomized positions. In one example, no more than 2 positions in the randomized portion are non-randomized. In another example, no more than one of the positions in the randomized portion is non-randomized. In another example, each position in the randomized portion is a randomized position. Randomized portions of polynucleotides can encode randomized portions of polypeptides, which are the amino acid portions that are encoded by the randomized portions of the polynucleotide.

The randomized portion can be a single nucleotide, or can be a plurality of contiguous nucleotides, and typically is 1, 2, 3, 4, 5, 6, 7, 8, 9, 10, 11, 12, 13, 14, 15, 20, 25, 30, 35, 40, 45, 50, 75, 80, 90, 100 or more nucleotides, such as, for example, a portion of a nucleic acid molecule that encodes a portion of a polypeptide domain, for example a target domain. Randomization of a randomized portion or position within a randomized portion can be saturating or non-saturating within a collection of randomized oligonucleotides. Along the length of a randomized portion of an oligonucleotide, some positions can be randomized by saturating randomization and others with non-saturating randomization. Similarly, if one randomized portion within an oligonucleotide is saturated, another randomized portion within the same oligonucleotide can be non-saturated.

As used herein, a doping strategy is a method used during chemical oligonucleotide synthesis of randomized portions of oligonucleotides. Doping strategies allow for incorporation of a plurality of different nucleotides at each analogous position within the randomized portion among the members of a pool of randomized oligonucleotides. Typically, positions of the randomized portions within the randomized oligonucleotides are synthesized using a doping strategy, while other portions (e.g. reference sequence portions) are synthesized using conventional synthesis methods. With the doping strategy, the incorporation of a plurality of different nucleotides at analogous positions among the randomized pool members can be carried out in a biased or non-biased fashion.

In one example, when one or more position within the randomized portion is a non-randomized position (e.g. a reference sequence or variant position), not every position within the randomized portion is synthesized using a doping strategy. For example, the randomized portion can contain 1, or more than 1, for example, 2, 3, 4, 5, or more reference sequence or variant positions among the randomized positions, which are not synthesized with a doping strategy.

As used herein, a randomized polynucleotide (e.g. a randomized oligonucleotide, a randomized polynucleotide duplex, e.g. an assembled randomized polynucleotide duplex) is a polynucleotide containing one or more randomized portion, where the randomized portion varies compared to analogous randomized portions among a collection of randomized polynucleotides. Synthetic randomized oligonucleotides are generated in pools of randomized oligonucleotides. Collections of other randomized polynucleotides can be generated from the pools of randomized oligonucleotides using the methods provided herein, for example, using techniques including, but not limited to, polymerase extension, amplification, assembly, hybridization, ligation and other methods.

As used herein, “pool of synthetic oligonucleotides” and “pool of oligonucleotides” refer to a collection of oligonucleotides, where the oligonucleotides are synthesized based on the same reference sequence. The oligonucleotides in the pool typically are synthesized together in the same one or more reaction vessels. It is not necessary that the oligonucleotides in the pool contain 100% identity in nucleotide sequence. For example, in a pool of variant oligonucleotides, the oligonucleotides contain one or more variant portions (e.g. randomized portions) that vary compared to other oligonucleotides in the pool.

As used herein, a pool of duplexes is a collection containing two or more analogous polynucleotide duplexes. Exemplary of the pool of duplexes are pools of reference sequence duplexes, pools of randomized duplexes (where the duplex members of the collection contain one or more randomized portions) and pools of assembled duplexes.

As used herein, a collection of randomized polynucleotides or a pool of randomized oligonucleotides refers to any collection of polynucleotides where each polynucleotide contains one or more randomized portions and the randomized portions are analogous to one another. Exemplary of collections of randomized polynucleotides are pools of randomized oligonucleotides and pools of randomized duplexes. The randomized polynucleotides in the collection, also contain one or more, typically two or more, reference sequence portions, which typically are identical among the members of the collection. Each randomized portion of the individual randomized polynucleotides varies, to some extent, compared to analogous portions within the reference sequence and/or with the analogous portion within the other oligonucleotides in the pool. It is not necessary that each polynucleotide in the collection has a different sequence of nucleotides in the randomized portion. For example, two or more members of the randomized collection can have an identical sequence of nucleotides over the length of the randomized portion. Pools of randomized oligonucleotides are synthesized using one or more doping strategies as described herein.

Typically, among the randomized polynucleotide in the collections are at least 10⁴ or about 10⁴, 10⁵ or about 10⁵, 10⁶ or about 10⁶, at least 10⁷ or about 10⁷, at least 10⁸ or about 10⁸, at least 10⁹ or about 10⁹, at least 10¹⁰ or about 10¹⁰, at least 10¹¹ or about 10¹¹, at least 10¹² or about 10¹², at least 10¹³ or about 10¹³, at least 10¹⁴ or about 10¹⁴, or more different analogous polynucleotide nucleic acid sequences. Thus, the collections typically have a diversity of at least 10⁴ or about 10⁴, 10⁵ or about 10⁵, 10⁶ or about 10⁶, at least 10⁷ or about 10⁷, at least 10⁸ or about 10⁸, at least 10⁹ or about 10⁹, at least 10¹⁰ or about 10¹⁰, at least 10¹¹ or about 10¹¹, at least 10¹² or about 10¹², at least 10¹³ or about 10¹³, at least 10¹⁴ or about 10¹⁴, or more.

In one example, the provided collections of randomized polynucleotides contain at least 10⁴ or about 10⁴, 10⁵ or about 10⁵, 10⁶ or about 10⁶, at least 10⁷ or about 10⁷, at least 10⁸ or about 10⁸, at least 10⁹ or about 10⁹, at least 10¹⁰ or about 10¹⁰, at least 10¹¹ or about 10¹¹, at least 10¹² or about 10¹², at least 10¹³ or about 10¹³, at least 10¹⁴ or about 10¹⁴, or more.

As used herein, a reference sequence portion of a polynucleotide refers generally to a portion of the polynucleotide that contains sequence identity to an analogous portion of a reference sequence or target polynucleotide. In one example, the reference sequence portion contains at or about 100% identity to the reference sequence or target polynucleotide or region thereof. In another example, the reference sequence oligonucleotide contains at or about or at least at or about 50%, 55%, 60 , 65%, 70%, 75%, 80%, 85%, 90%, 95%, 96%, 97%, 98%, 99% or 100% identity to the reference sequence or target polynucleotide or region thereof.

As used herein, a reference sequence portion of a synthetic oligonucleotide is a portion that theoretically contains (i.e. based on oligonucleotide design) at or about 100% identity to the analogous portion in the reference sequence. For example, a reference sequence portion of a randomized oligonucleotide is not randomized and thus is not synthesized using a doping strategy. It is understood, however, that error during synthesis can result in reference sequence portions with less than 100% sequence identity to the reference sequence.

As used herein, a reference sequence oligonucleotide is an oligonucleotide containing nucleic acid sequence identity, and theoretically 100% sequence identity, to the reference sequence used to design the oligonucleotide (e.g. used to design the pool of reference sequence oligonucleotides). In one example, the reference sequence oligonucleotide contains 100% identity to the reference sequence. Alternatively, the reference sequence oligonucleotide can contain less than 100% identity to the reference sequence, such as, for example, at or about or at least at or about 90%, 91%, 92%, 93%, 94%, 95%, 96%, 97%, 98% or 99% sequence identity to the reference sequence. For example, a pool of reference sequence oligonucleotides is designed with the goal that all of the oligonucleotides in the pool are 100% identical to the reference sequence. It is understood, however, that such a pool of oligonucleotides can contain one or more oligonucleotides that, due to error during synthesis, is not 100% identical to the reference sequence, for example, contains one or more deletions, insertions, mutations, substitutions or additions compared to the reference sequence.

As used herein, “reference sequence polynucleotide” is used generally to refer to polynucleotides with identity to one or more reference sequences and/or containing identity to a target polynucleotide or region thereof, and optionally containing one or more additions, deletions, insertions, substitutions or mutations compared to the target polynucleotide or region thereof or reference sequence. In one example, the reference sequence polynucleotide contains at or about 100% identity to the reference sequence or target polynucleotide or region thereof. In another example, the reference sequence oligonucleotide contains at or about or at least at or about 50%, 75%, 80%, 85%, 90%, 95%, 96%, 97%, 98%, 99% or 100% identity to the reference sequence or target polynucleotide or region thereof.

As used herein, saturating randomization refers to a process by, for each position or tri-nucleotide portion within the randomized portion, each of a plurality of nucleotides or tri-nucleotide combinations is incorporated at least once within a pool of randomized oligonucleotides. Exemplary of a collection of randomized oligonucleotides displaying saturating randomization is one where, within the entire collection, each of the sixty-four possible tri-nucleotide combinations that can be made by the four nucleotide monomers is incorporated at least once at a particular codon position of a particular randomized portion. In another example of a collection of randomized oligonucleotides made by saturating randomization, each of the sixty-four possible tri-nucleotide combinations is incorporated at least once at each tri-nucleotide position over the length of the randomized portion. In another example of a collection of randomized oligonucleotides made by saturating randomization, a tri-nucleotide combination encoding each of the twenty amino acids is incorporated at least once at a particular codon position or at each codon position along the randomized portion. Also exemplary of a collection of oligonucleotides displaying saturating randomization is one where each nucleotide is incorporated at least once at every nucleotide position or at a particular nucleotide position over the length of the randomized portion within the collection of oligonucleotides. Saturation is typically advantageous in that it increases the chances of obtaining a variant protein with a desired property. The desired level of saturation will vary with the type of target polypeptide, the length and number of randomized portion(s) and other factors.

As used herein, non-saturating randomization refers to a process by which fewer than all of a particular number of nucleotide or tri-nucleotide combinations are used at a particular position or tri-nucleotide portion within the randomized portion within the pool of oligonucleotides. For example, non-saturating randomization of a particular tri-nucleotide position might incorporate only 2, 3, 4, 5, 6, 7, 8, 9, 10 or more, but not all the possible, tri-nucleotide combinations at that position within the collection of randomized oligonucleotides. Substitution mutagenesis, where one nucleotide or tri-nucleotide unit is replaced with one other nucleotide or tri-nucleotide unit, is non-saturating and also can be used to create variant oligonucleotides in the methods provided herein.

As used herein, a non-biased doping strategy is a strategy used during random oligonucleotide synthesis, whereby each of a plurality of nucleotides or tri-nucleotides is present at an equal proportion during synthesis of each nucleotide or tri-nucleotide position. Exemplary of a non-biased doping strategy is one whereby each of the four nucleotide monomers (A, G, T and C) is added at an equal proportion during synthesis of each nucleotide position in a randomized portion. The strategy can lead to equal frequency of each nucleotide monomer at each randomized position within the collection synthesized using this strategy. Non-biased doping strategies using an equal ratio of each of the nucleotide monomers can be undesirable, as they lead to a relatively high frequency of stop codon incorporation compared to some biased strategies. Because there are sixty-four possible combinations of tri-nucleotide codons, which encode only twenty amino acids, redundancy exists in the nucleotide code. Different amino acids have a more redundant code than others. Thus, non-biased incorporation of nucleotides will not result in an equal frequency of each of the twenty amino acids in the encoded polypeptide. If an equal frequency of amino acids is desired, a non-biased doping strategy using equal ratios of a plurality of tri-nucleotide units, each representing one amino acid, can be employed.

As used herein, a biased doping strategy is a strategy that incorporates particular nucleotides or codons at different frequencies than others, thus biasing the sequence of the randomized portions within a collection towards a particular sequence. For example, the randomized portion, or single nucleotide positions within the randomized portion, can be biased towards a reference nucleic acid sequence or the coding sequence of a target polynucleotide. Biasing positions towards a reference nucleic acid sequence means that, within a collection of randomized oligonucleotides, the nucleotides or codons used in the reference sequence at those nucleotide positions would be more common than other nucleotides or codons. Doping strategies also can be biased to reduce the frequency of stop codons while still maintaining a possibility for saturating randomization. Alternatively, the doping strategy can be non-biased, whereby each nucleotide is inserted at an equal frequency.

Exemplary of biased doping strategies used herein are NNK, NNB and NNS, and NNW; NNM, NNH; NND; NNV doping strategies and an NNT, NNA, NNG and NNC doping strategy. In an NNK doping strategy, randomized portions of positive strands are synthesized using an NNK pattern and negative strand portions are synthesized using an MNN pattern, where N is any nucleotide (for example, A, C, G or T), K is T or G and M is A or C. Thus, using this doping strategy, each nucleotide in the randomized portion of the positive strand is a T or G. This strategy typically is used to minimize the frequency of stop codons, while still allowing the possibility of any of the twenty amino acids (listed in table 2) to be encoded by trinucleotide codons at each position of the randomized portion among the randomized oligonucleotides in the pool. Similarly, for the NNB doping strategy, an NNB pattern is used, where N is any nucleotide and B represents C, G or T. For the NNS doping strategy, an NNS pattern is used, where N is any nucleotide and S represents C or G. In an NNW doping strategy, W is A or T; in an NNM doping strategy, M is A or C; in an NNH doping strategy, H is A, C or T; in an NND doping strategy, D is A, G or T; in an NNV doping strategy, G is A, G or C. An NNK doping strategy minimizes the frequency of stop codons and ensures that each amino acid position encoded by a codon in the randomized portion could be occupied by any of the 20 amino acids. With this doping strategy, nucleotides were incorporated using an NKK pattern and a MNN pattern, during synthesis of the positive and negative strand randomized portions respectively, where N represents any nucleotide, K represents T or G and M represents A or C. An NNT strategy eliminates stop codons and the frequency of each amino acid is less biased but omits Q, E, K, M, and W. Other doping strategies include all four nucleotide monomers (A, G, C, T), but at different frequencies. For example, a doping strategy can be designed whereby at each position within the randomized portion, the sequence is biased toward the wild-type sequence or the reference sequence. Other well-known doping strategies can be used with the methods provided herein, including parsimonious mutagenesis (see, for example, Balint et al., Gene (1993) 137(1), 109-118; Chames et al., The Journal of Immunology (1998) 161, 5421-5429), partially biased doping strategies, for example, to bias the randomized portion toward a particular sequence, e.g. a wild-type sequence (see, for example, De Kruif et al., J. Mol. Biol., (1995) 248, 97-105), doping strategies based on an amino acid code with fewer than all possible amino acids, for example, based on a four-amino acid code (see, for example, Fellouse et al., PNAS (2004) 101(34) 12467-12472), and codon-based mutagenesis and modified codon-based mutagenesis (See, for example, Gaytán et al., Nucleic Acids Research, (2002), 30(16), U.S. Pat. Nos. 5,264,563 and 7,175,996).

As used herein, a polynucleotide duplex is any double stranded polynucleotide containing complementary positive and a negative strand polynucleotides. The duplex can contain any number of nucleic acids in length, typically at least at or about 10, 11, 12, 13, 14, 15, 20, 25, 30, 40, 50 nucleotides in length. In some examples, the duplexes contain at least at or about 50, 100, 150, 200, 250, 500, 1000, 1500, 2000 or more nucleotides in length. In other examples, the duplexes contain less than at or about 500 nucleotides in length, for example, less than at or about 250, 200, 150, 100 or 50 nucleotides in length. In another example, the duplex contains the number of nucleotides in length of an entire nucleotide sequence of a gene. Exemplary of a polynucleotide duplex is an oligonucleotide duplex. Duplexes can be formed in a plurality of ways in the provided methods. For example, two or more polynucleotides can be hybridized through complementary regions to form duplexes. In another example, a polymerase reaction, e.g. a single primer extension or an amplification (e.g. PCR) reaction can be used to generate duplexes from single stranded polynucleotides.

As used herein, “assembled polynucleotide duplex” and “assembled duplex” refer synonymously to a polynucleotide duplex made according to the methods herein, having a sequence of nucleotides containing sequences analogous to two or more, typically three or more, for example, 2, 3, 4, 5, 6, 7, 8, 9, 10, 15, 20 or more, synthetic oligonucleotides and/or polynucleotides. Typically, the assembled duplexes are variant duplexes, contained in pools of assembled duplexes. In one example, the assembled duplex is a randomized assembled duplex, which contains one or more randomized portions, for example, 1, 2, 3, 4, 5, 6, 7, 8, 9, 10, 15, 20 or more randomized portions.

Similarly, “Assembled polynucleotide” refers to a polynucleotide made according to the methods herein, having a sequence of nucleotides containing sequences analogous to two or more, typically three or more, for example, 2, 3, 4, 5, 6, 7, 8, 9, 10, 15, 20 or more, synthetic oligonucleotides and/or polynucleotides, such as, but not limited to one strand of an assembled duplex, formed by denaturing the duplex.

As used herein, a collection of assembled polynucleotide duplexes is a collection containing two or more analogous assembled polynucleotide duplexes. Typically, the collection is a collection of variant assembled polynucleotide duplexes, typically randomized assembled polynucleotide duplexes, where the duplexes contain one or more randomized portions that vary compare to the other members of the collection.

As used herein, a large assembled duplex is an assembled duplex containing more than about 50 nucleotides in length, for example, greater than 50, 100, 150, 200, 250, 300, 350, 400, 450, 500, 1000, 1500, 2000 or more nucleotides in length. Typically, a randomized large assembled duplex contains two or more randomized portions, for example 2, 3, 4, 5, 6, 7, 8, 9, 10, 15, 20 or more randomized portions. Typically, at least two of the two or more of the randomized portions within a randomized large assembled duplex cassette are separated by at least about 30 nucleotides, for example, at least about 30, 35, 40, 45, 50, 55, 60, 65, 70, 75, 80, 85, 90, 95, 100, 150, 200, 250 or more nucleotides, along the linear sequence of the duplex cassette.

As used herein, “duplex cassette” refers to any oligonucleotide or polynucleotide duplex (e.g. an assembled duplex) that is capable of being directly inserted into a vector. Typically, the duplex cassette contains two restriction site overhangs that function as “sticky ends” for insertion into a vector cut by restriction endonucleases that cut at those restriction sites. Similarly, “assembled duplex cassette” is used to refer to an assembled duplex that is capable of being directly inserted into a vector. Typically, the duplex cassette contains two restriction site overhangs that function as “sticky ends” for insertion into a vector cut by restriction endonucleases that cut at those restriction sites. Provided herein are collections of assembled duplex cassettes, including randomized assembled duplex cassettes.

As used herein, an intermediate duplex (e.g. intermediate duplex cassette) is any duplex generated in the provided processes for generating collections of variant polynucleotides, such as methods for generating collections of assembled duplexes and duplex cassettes. Further steps are performed using the intermediate duplexes, in order to generate the final products, such as the assembled duplexes or duplex cassettes.

As used herein, a reference sequence duplex is a polynucleotide duplex having identity to a target polynucleotide or region thereof and optionally containing one or more additions, deletions, substitutions and/or insertions. In one example, the reference sequence duplex contains at or about 100% identity to the target polynucleotide or region thereof. In another example, the reference sequence duplex further contains additional portions and/or regions, for example, regions of complementarity/identity to a non gene-specific primer, restriction endonuclease recognition sites, and/or other non gene-specific sequence, including regulatory regions. For example, the reference sequence duplex can contain at or about, or at least at or about 50%, 55%, 60%, 65%, 70%, 75%, 80%, 85%, 90%, 95%, 96%, 97%, 98%, or 99%, or fraction thereof, identity to the target polynucleotide or region thereof. In one example of the provided methods, reference sequence duplexes are combined with randomized oligonucleotide duplexes to assemble intermediate duplexes and assembled duplexes.

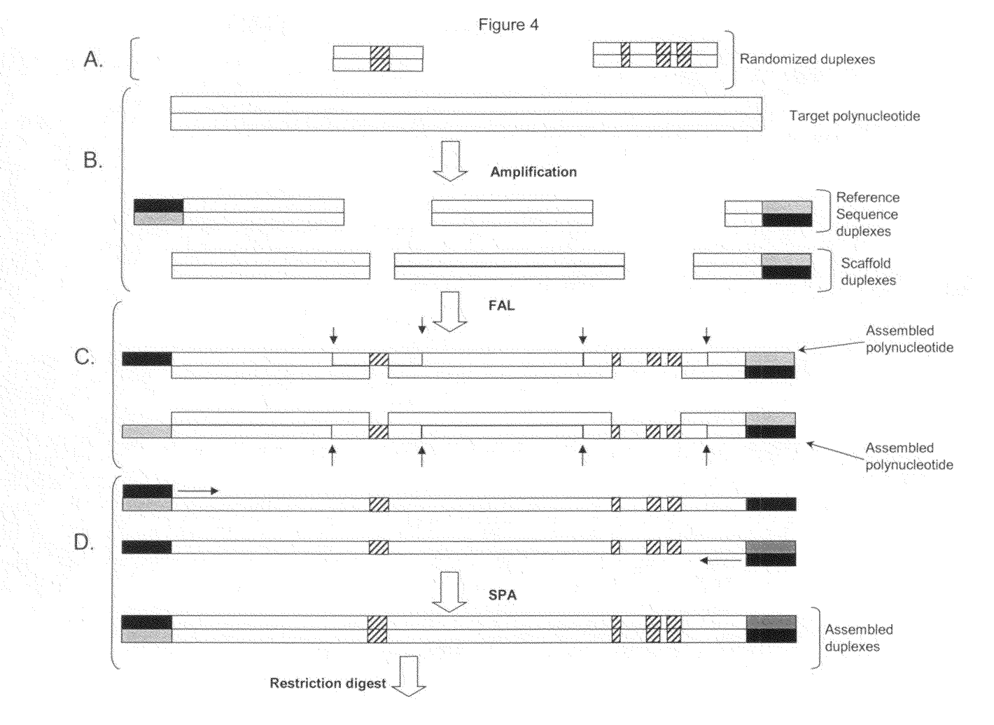

As used herein, a scaffold duplex is a polynucleotide duplex containing regions of complementarity to regions within oligonucleotides or polynucleotides within two different pools of oligonucleotides or polynucleotides or pools of duplexes. Typically, the scaffold duplex is a reference sequence duplex. Exemplary of scaffold duplexes are duplexes that contain a region of complementarity to a region in synthetic oligonucleotides in a pool of randomized oligonucleotides, and a region of complementarity to polynucleotides in another pool of reference sequence duplexes or oligonucleotide duplexes. In one example, the scaffold duplexes is used to assemble intermediate duplexes or assembled polynucleotides by combining the scaffold duplexes and the duplexes with which they share complementarity, which can facilitate ligation of oligonucleotides from the different pools. An example of scaffold duplexes is illustrated in FIG. 4, which depicts the Fragment Assembly and Ligation/Single Primer Amplification (FAL-SPA) method, where intermediate duplexes are formed by hybridizing polynucleotides and oligonucleotides from different pools to strands from scaffold duplexes.

As used herein, a genetic element refers to a gene, or any region thereof, that encodes a polypeptide or protein or region thereof.

As used herein, regulatory region of a nucleic acid molecule means a cis-acting nucleotide sequence that influences expression, positively or negatively, of an operably linked gene. Regulatory regions include sequences of nucleotides that confer inducible (i.e., require a substance or stimulus for increased transcription) expression of a gene. When an inducer is present or at increased concentration, gene expression can be increased. Regulatory regions also include sequences that confer repression of gene expression (i.e., a substance or stimulus decreases transcription). When a repressor is present or at increased concentration gene expression can be decreased. Regulatory regions are known to influence, modulate or control many in vivo biological activities including cell proliferation, cell growth and death, cell differentiation and immune modulation. Regulatory regions typically bind to one or more trans-acting proteins, which results in either increased or decreased transcription of the gene.

Particular examples of gene regulatory regions are promoters and enhancers. Promoters are sequences located around the transcription or translation start site, typically positioned 5′ of the translation start site. Promoters usually are located within 1 Kb of the translation start site, but can be located further away, for example, 2 Kb, 3 Kb, 4 Kb, 5 Kb or more, up to and including 10 Kb. Enhancers are known to influence gene expression when positioned 5′ or 3′ of the gene, or when positioned in or a part of an exon or an intron. Enhancers also can function at a significant distance from the gene, for example, at a distance from about 3 Kb, 5 Kb, 7 Kb, 10 Kb, 15 Kb or more.

Regulatory regions also include, in addition to promoter regions, sequences that facilitate translation, splicing signals for introns, maintenance of the correct reading frame of the gene to permit in-frame translation of mRNA and, stop codons, leader sequences and fusion partner sequences, internal ribosome binding site (IRES) elements for the creation of multigene, or polycistronic, messages, polyadenylation signals to provide proper polyadenylation of the transcript of a gene of interest and stop codons, and can be optionally included in an expression vector.

As used herein, “operably linked” with reference to nucleic acid sequences, regions, elements or domains means that the nucleic acid regions are functionally related to each other. For example, nucleic acid encoding a leader peptide can be operably linked to nucleic acid encoding a polypeptide, whereby the nucleic acids can be transcribed and translated to express a functional fusion protein, wherein the leader peptide effects secretion of the fusion polypeptide. In some instances, the nucleic acid encoding a first polypeptide (e.g. a leader peptide) is operably linked to nucleic acid encoding a second polypeptide and the nucleic acids are transcribed as a single mRNA transcript, but translation of the mRNA transcript can result in one of two polypeptides being expressed. For example, an amber stop codon can be located between the nucleic acid encoding the first polypeptide and the nucleic acid encoding the second polypeptide, such that, when introduced into a partial amber suppressor cell, the resulting single mRNA transcript can be translated to produce either a fusion protein containing the first and second polypeptides, or can be translated to produce only the first polypeptide. In another example, a promoter can be operably linked to nucleic acid encoding a polypeptide, whereby the promoter regulates or mediates the transcription of the nucleic acid.

As used herein, an “amino acid” is an organic compound containing an amino group and a carboxylic acid group. A polypeptide contains two or more amino acids. For purposes herein, amino acids include the twenty naturally-occurring amino acids, non-natural amino acids, and amino acid analogs (e.g., amino acids wherein the α-carbon has a side chain). As used herein, the amino acids, which occur in the various amino acid sequences of polypeptides appearing herein, are identified according to their well-known, three-letter or one-letter abbreviations (see Table 1). The nucleotides, which occur in the various nucleic acid molecules and fragments, are designated with the standard single-letter designations used routinely in the art.

As used herein, “amino acid residue” refers to an amino acid formed upon chemical digestion (hydrolysis) of a polypeptide at its peptide linkages. The amino acid residues described herein are generally in the “L” isomeric form. Residues in the “D” isomeric form can be substituted for any L-amino acid residue, as long as the desired functional property is retained by the polypeptide. NH₂ refers to the free amino group present at the amino terminus of a polypeptide. COOH refers to the free carboxy group present at the carboxyl terminus of a polypeptide. In keeping with standard polypeptide nomenclature described in J. Biol. Chem., 243:3557-59 (1968) and adopted at 37 C.F.R. §§.1.821-1.822, abbreviations for amino acid residues are shown in Table 1:

TABLE 1
Table of Correspondence

| SYMBOL | | |
|---|---|---|
| 1-Letter | 3-Letter | AMINO ACID |
| Y | Tyr | tyrosine |
| G | Gly | glycine |
| F | Phe | phenylalanine |
| M | Met | methionine |
| A | Ala | alanine |
| S | Ser | serine |
| I | Ile | isoleucine |
| L | Leu | leucine |
| T | Thr | threonine |
| V | Val | valine |
| P | Pro | proline |
| K | Lys | lysine |
| H | His | Histidine |
| Q | Gln | Glutamine |
| E | Glu | glutamic acid |
| Z | Glx | Glu and/or Gln |
| W | Trp | Tryptophan |
| R | Arg | Arginine |
| D | Asp | aspartic acid |
| N | Asn | Asparagine |
| B | Asx | Asn and/or Asp |
| C | Cys | Cysteine |
| X | Xaa | Unknown or other |

All sequences of amino acid residues represented herein by a formula have a left to right orientation in the conventional direction of amino-terminus to carboxyl-terminus. In addition, the phrase “amino acid residue” is defined to include the amino acids listed in the Table of Correspondence modified, non-natural and unusual amino acids. Furthermore, it should be noted that a dash at the beginning or end of an amino acid residue sequence indicates a peptide bond to a further sequence of one or more amino acid residues or to an amino-terminal group such as NH₂ or to a carboxyl-terminal group such as COOH.

In a peptide or protein, suitable conservative substitutions of amino acids are known to those of skill in this art and generally can be made without altering a biological activity of a resulting molecule. Those of skill in this art recognize that, in general, single amino acid substitutions in non-essential regions of a polypeptide do not substantially alter biological activity (see, e.g., Watson et al. Molecular Biology of the Gene, 4th Edition, 1987, The Benjamin/Cummings Pub. co., p. 224).

Such substitutions may be made in accordance with those set forth in TABLE 2 as follows:

TABLE 2

| Original | Conservative |
|---|---|
| residue | substitution |
| Ala (A) | Gly; Ser |
| Arg (R) | Lys |
| Asn (N) | Gln; His |
| Cys (C) | Ser |
| Gln (Q) | Asn |
| Glu (E) | Asp |
| Gly (G) | Ala; Pro |
| His (H) | Asn; Gln |
| Ile (I) | Leu; Val |
| Leu (L) | Ile; Val |
| Lys (K) | Arg; Gln; Glu |
| Met (M) | Leu; Tyr; Ile |
| Phe (F) | Met; Leu; Tyr |
| Ser (S) | Thr |
| Thr (T) | Ser |
| Trp (W) | Tyr |
| Tyr (Y) | Trp; Phe |
| Val (V) | Ile; Leu |

Other substitutions also are permissible and can be determined empirically or in accord with other known conservative or non-conservative substitutions.

As used herein, “naturally occurring amino acids” refer to the 20 L-amino acids that occur in polypeptides.

As used herein, the term “non-natural amino acid” refers to an organic compound that has a structure similar to a natural amino acid but has been modified structurally to mimic the structure and reactivity of a natural amino acid. Non-naturally occurring amino acids thus include, for example, amino acids or analogs of amino acids other than the 20 naturally occurring amino acids and include, but are not limited to, the D-isostereomers of amino acids. Exemplary non-natural amino acids are known to those of skill in the art.

As used herein, “similarity” between two proteins or nucleic acids refers to the relatedness between the sequence of amino acids of the proteins or the nucleotide sequences of the nucleic acids. Similarity can be based on the degree of identity of sequences of residues and the residues contained therein. Methods for assessing the degree of similarity between proteins or nucleic acids are known to those of skill in the art. For example, in one method of assessing sequence similarity, two amino acid or nucleotide sequences are aligned in a manner that yields a maximal level of identity between the sequences. Identity refers to the extent to which the amino acid or nucleotide sequences are invariant. Alignment of amino acid sequences, and to some extent nucleotide sequences, also can take into account conservative differences and/or frequent substitutions in amino acids (or nucleotides). Conservative differences are those that preserve the physico-chemical properties of the residues involved. Alignments can be global (alignment of the compared sequences over the entire length of the sequences and including all residues) or local (the alignment of a portion of the sequences that includes only the most similar region or regions).

As used herein, a positive strand polynucleotide refers to the “sense strand” or a polynucleotide duplex, which is complementary to the negative strand or the “antisense” strand. In the case of polynucleotides which encode genes, the sense strand is the strand that is identical to the mRNA strand that is translated into a polypeptide, while the antisense strand is complementary to that strand. Positive and negative strands of a duplex are complementary to one another.

As used herein, a pair of positive strand and negative strand pools refers to two pools of oligonucleotides, one pool containing positive strand oligonucleotides, and the other pool containing negative strand oligonucleotides, where the oligonucleotides in the positive strand pool are complementary to oligonucleotides in the negative strand pool.

As used herein, “deletion,” when referring to a nucleic acid or polypeptide sequence, refers to the deletion of one or more nucleotides or amino acids compared to a sequence, such as a target polynucleotide or polypeptide or a native or wild-type sequence.

As used herein, “insertion” when referring to a nucleic acid or amino acid sequence, describes the inclusion of one or more additional nucleotides or amino acids, within a target, native, wild-type or other related sequence. Thus, a nucleic acid molecule that contains one or more insertions compared to a wild-type sequence, contains one or more additional nucleotides within the linear length of the sequence.

As used herein, “additions,” to nucleic acid and amino acid sequences describe addition of nucleotides or amino acids onto either termini compared to another sequence.

As used herein, “substitution” refers to the replacing of one or more nucleotides or amino acids in a native, target, wild-type or other nucleic acid or polypeptide sequence with an alternative nucleotide or amino acid, without changing the length (as described in numbers of residues) of the molecule. Thus, one or more substitutions in a molecule does not change the number of amino acid residues or nucleotides of the molecule. Substitution mutations compared to a particular polypeptide can be expressed in terms of the number of the amino acid residue along the length of the polypeptide sequence. For example, a modified polypeptide having a modification in the amino acid at the 19^{th} position of the amino acid sequence that is a substitution of Isoleucine (Ile; I) for cysteine (Cys; C) can be expressed as I19C, Ile19C, or simply C19, to indicate that the amino acid at the modified 19^{th} position is a cysteine. In this example, the molecule having the substitution has a modification at Ile 19 of the unmodified polypeptide.

As used herein, “primary sequence” refers to the sequence of amino acid residues in a polypeptide or the sequence of nucleotides in a nucleic acid molecule.

As used herein, it also is understood that the terms “substantially identical” or “similar” varies with the context as understood by those skilled in the relevant art, but that those of skill can assess such.

As used herein, “primer” refers to a nucleic acid molecule (more typically, to a pool of such molecules sharing sequence identity) that can act as a point of initiation of template-directed nucleic acid synthesis under appropriate conditions (for example, in the presence of four different nucleoside triphosphates and a polymerization agent, such as DNA polymerase, RNA polymerase or reverse transcriptase) in an appropriate buffer and at a suitable temperature. It will be appreciated that certain nucleic acid molecules can serve as a “probe” and as a “primer.” A primer, however, has a 3′ hydroxyl group for extension. A primer can be used in a variety of methods, including, for example, polymerase chain reaction (PCR), reverse-transcriptase (RT)-PCR, RNA PCR, LCR, multiplex PCR, panhandle PCR, capture PCR, expression PCR, 3′ and 5′ RACE, in situ PCR, ligation-mediated PCR and other amplification protocols.

As used herein, “primer pair” refers to a set of primers (e.g. two pools of primers) that includes a 5′ (upstream) primer that specifically hybridizes with the 5′ end of a sequence to be amplified (e.g. by PCR) and a 3′ (downstream) primer that specifically hybridizes with the complement of the 3′ end of the sequence to be amplified. Because “primer” can refer to a pool of identical nucleic acid molecules, a primer pair typically is a pair of two pools of primers.

As used herein, “single primer” and “single primer pool” refer synonymously to a pool of primers, where each primer in the pool contains sequence identity with the other primer members, for example, a pool of primers where the members share at least at or about 50, 55, 60, 65, 70, 75, 80, 85, 90, 95, 96, 97, 98, 99 or 100% identity. The primers in the single primer pool (all sharing sequence identity) act both as 5′ (upstream) primers (that specifically hybridize with the 5′ end of a sequence to be amplified (e.g. by PCR)) and as 3′ (downstream) primers (that specifically hybridize with the complement of the 3′ end of the sequence to be amplified). Thus, the single primer can be used, without other primers, to prime synthesis of complementary strands and amplify a nucleic acid in a polymerase amplification reaction. In one example, the single primer is used without other primers to amplify a nucleic acid in an amplification reaction, e.g. by hybridizing to a 5′ sequence in both strands of a polynucleotide duplex. In one such example, a single primer is used to prime complementary strand synthesis (e.g. in a PCR amplification) from the termini (e.g. 5′ termini) of both strands of an oligonucleotide duplex.

As used herein, complementarity, with respect to two nucleotides, refers to the ability of the two nucleotides to base pair with one another upon hybridization of two nucleic acid molecules. Two nucleic acid molecules sharing complementarity are referred to as complementary nucleic acid molecules; exemplary of complementary nucleic acid molecules are the positive and negative strands in a polynucleotide duplex. As used herein, when a nucleic acid molecule or region thereof is complementary to another nucleic acid molecule or region thereof, the two molecules or regions specifically hybridize to each other. Two complementary nucleic acid molecules often are described in terms of percent complementarity. For example, two nucleic acid molecules, each 100 nucleotides in length, that specifically hybridize with one another but contain 5 mismatches with respect to one another, are said to be 95% complementary. For two nucleic acid molecules to hybridize with 100% complementarity, it is not necessary that complementarity exist along the entire length of both of the molecules. For example, a nucleic acid molecule containing 20 contiguous nucleotides in length can specifically hybridize to a contiguous 20 nucleotide portion of a nucleic acid molecule containing 500 contiguous nucleotide in length. If no mismatches occur along this 20 nucleotide portion, the 20 nucleotide molecule hybridizes with 100% complementarity. Typically, complementary nucleic acid molecules align with less than 25%, 20%, 15%, 10%, 5% 4%, 3%, 2% or 1% mismatches between the complementary nucleotides (in other words, at least at or about 75%, 80%, 85%, 90%, 95, 96%, 97%, 98% or 99% complementarity). In another example, the complementary nucleic acid molecules contain at or about or at least at or about 50%, 55%, 60%, 65%, 70%, 75%, 80%, 85%, 90%, 95, 96%, 97%, 98% or 99% complementarity. In one example, complementary nucleic acid molecules contain fewer than 5, 4, 3, 2 or 1 mismatched nucleotides. In one example, the complementary nucleotides are 100% complementary. If necessary, the percentage of complementarity will be specified. Typically the two molecules are selected such that they will specifically hybridize under conditions of high stringency.

As used herein, a complementary strand of a nucleic acid molecule refers to a sequence of nucleotides, e.g. a nucleic acid molecule, that specifically hybridizes to the molecule, such as the opposite strand to the nucleic acid molecule in a polynucleotide duplex. For example, in a polynucleotide duplex, the complementary strand of a positive strand oligonucleotide is a negative strand oligonucleotide that specifically hybridizes to the positive strand oligonucleotide in a duplex. In one example of the provided methods, polymerase reactions are used to synthesize complementary strands of polynucleotides to form duplexes, typically beginning by hybridizing an oligonucleotide primer to the polynucleotide.

As used herein, “region of complementarity” or “portion of complementarity” are used synonymously with “complementary region” or “complementary portion,” respectively, to refer to the region or portion, respectively, of one complementary nucleic acid molecule that specifically hybridizes to a corresponding complementary region or portion on another complementary nucleic acid molecule. For example, the synthetic oligonucleotides produced according to the methods provided herein can contain one or more regions of complementarity to one or more other oligonucleotides, for example, to a fill-in primer. Typically, for specific hybridization of a synthetic oligonucleotide to another polynucleotide, particularly to another oligonucleotide, the synthetic oligonucleotide contains a 5′ and a 3′ region complementary to the other polynucleotide. Typically, each of the 5′ and the 3′ regions of complementarity contains at least about 10 nucleotides in length, for example, at least about 10, 11, 12, 13, 14, 15, 16, 17, 18, 19, 20, 21, 22, 23, 24, 25 or more nucleotides in length.

As used herein, “region of identity” or “portion of identity” are used synonymously with “identical region” or “identical portion,” respectively, to refer to a region or portion, respectively, of one nucleic acid molecule having at least at or about 40% sequence identity, and typically at least at or about 50%, 55%, 60%, 65%, 70%, 75%, 80%, 85%, 90%, 95%, 96%, 97%, 98%, 99% or more, such as 100%, sequence identity to a region or portion in another nucleic acid molecule; specific percent identities can be specified. Typically, the region/portion of identity specifically hybridizes to a sequence of nucleotides that is complementary to the nucleic acid region to which it is identical. For example, the synthetic oligonucleotides produced according to the methods provided herein can contain one or more regions of identity to portions or regions in other polynucleotides, such as other oligonucleotides or target polynucleotides. Typically, the region of identity contains at least about 10 nucleotides in length, for example, at least about 10, 11, 12, 13, 14, 15, 16, 17, 18, 19, 20, 21, 22, 23, 24, 25 or more nucleotides in length.

As used herein, “specifically hybridizes” refers to annealing, by complementary base-pairing, of a nucleic acid molecule (e.g. an oligonucleotide or polynucleotide) to another nucleic acid molecule. Those of skill in the art are familiar with in vitro and in vivo parameters that affect specific hybridization, such as length and composition of the particular molecule. Parameters particularly relevant to in vitro hybridization further include annealing and washing temperature, buffer composition and salt concentration. It is not necessary that two nucleic acid molecules exhibit 100% complementarity in order to specifically hybridize to one another. For example, two complementary nucleic acid molecules sharing sequence complementarity, such as at or about or at least at or about 99%, 98%, 97%, 96%, 95%, 90%, 85%, 80%, 75%, 70%, 65%, 60%, 55% or 50% complementarity, can specifically hybridize to one another. Parameters, for example, buffer components, time and temperature, used in in vitro hybridization methods provided herein, can be adjusted in stringency to vary the percent complementarity required for specific hybridization of two nucleic acid molecules. The skilled person can readily adjust these parameters to achieve specific hybridization of a nucleic acid molecule to a target nucleic acid molecule appropriate for a particular application.

As used herein, “specifically bind” with respect to an antibody refers to the ability of the antibody to form one or more noncovalent bonds with a cognate antigen, by noncovalent interactions between the antibody combining site(s) of the antibody and the antigen.

As used herein, an effective amount of a therapeutic agent is the quantity of the agent necessary for preventing, curing, ameliorating, arresting or partially arresting a symptom of a disease or disorder.

As used herein, unit dose form refers to physically discrete units suitable for human and animal subjects and packaged individually as is known in the art.

As used herein, the singular forms “a,” “an” and “the” include plural referents unless the context clearly dictates otherwise. Thus, for example, reference to compound, comprising “an extracellular domain” includes compounds with one or a plurality of extracellular domains.

As used herein, ranges and amounts can be expressed as “about” a particular value or range. About also includes the exact amount. Hence “about 5 bases” means “about 5 bases” and also “5 bases.”

As used herein, “optional” or “optionally” means that the subsequently described event or circumstance does or does not occur and that the description includes instances where said event or circumstance occurs and instances where it does not. For example, an optionally variant portion means that the portion is variant or non-variant. In another example, an optional ligation step means that the process includes a ligation step or it does not include a ligation step.

As used herein, the abbreviations for any protective groups, amino acids and other compounds, are, unless indicated otherwise, in accord with their common usage, recognized abbreviations, or the IUPAC-IUB Commission on Biochemical Nomenclature (see, (1972) Biochem. 11:1726).

As used herein, a template oligonucleotide or template polynucleotide (also called oligonucleotide template or polynucleotide template) is an oligonucleotide or polynucleotide used as a template in a polymerase extension reaction, for example, in a fill-in reaction, a single-primer amplification reaction, a polymerase chain reaction (PCR) or other polymerase-driven reaction. Any of the synthetic oligonucleotides can be used as template oligonucleotides. The template oligonucleotide contains at least one region that is complementary to primers, such as primers in a primer pool, for example, fill-in primers, non gene-specific primers, primers containing a restriction site sequence, gene-specific primers, single primer pools and primer pairs.

As used herein, a fill-in primer is an oligonucleotide that specifically hybridizes to a template oligonucleotide or polynucleotide and primes a fill-in reaction, whereby a sequence of nucleotides complementary to the template strand is synthesized, thereby generating an oligonucleotide duplex. A single oligonucleotide can both be a template oligonucleotide and a fill-in primer. For example, two oligonucleotides, sharing a region of complementarity, can participate in a mutually primed fill-in reaction, whereby one oligonucleotide primes synthesis of the complementary strand of the other nucleotide, and vice versa. A fill-in reaction is a polymerase reaction carried out using a fill-in primer.

As used herein, a mutually primed fill-in reaction is a fill-in reaction whereby each of two oligonucleotides serves as a fill-in primer to prime synthesis of a strand complementary to the other oligonucleotide. Thus, the two oligonucleotides are both template oligonucleotides and fill-in primers. The two oligonucleotides share at least one region of complementarity. A mutually-primed synthesis reaction can one oligonucleotide serves as a fill-in primer for the other oligonucleotide and vice versa.

As used herein, a non gene-specific sequence is a sequence of nucleotides, for example, in a vector, that does not encode a polypeptide, such as a non-encoding sequence, for example, a regulatory sequence, such as a bacterial leader sequence, promoter sequence, or enhancer sequence; a sequence of nucleotides that is a restriction endonuclease recognition site; and/or a sequence having complementarity to a primer.

As used herein, a non gene-specific primer is a primer that binds to a non gene-specific nucleic acid sequence in a template polynucleotide or oligonucleotide and primes synthesis of the complementary strand of the polynucleotide in an amplification reaction, typically a single-primer extension reaction. Typically, the non gene-specific primer specifically hybridizes to a region of the polynucleotide that corresponds to the non gene-specific region of the polynucleotide, for example, a bacterial promoter sequence or portion thereof.

Alternatively, a gene-specific primer is a primer that binds within a sequence of nucleotides encoding a polypeptide, such as a target or variant polypeptide.

As used herein, a host cell is a cell that is used in to receive, maintain, reproduce and amplify a vector. A host cell also can be used to express the polypeptide encoded by the vector nucleotides, for example, a variant polypeptide. The nucleic acid inserted in the vector, typically a duplex cassette, is replicated when the host cell divides, thereby amplifying the cassette nucleic acids. In one example, the host cell is a genetic package, which can be induced to express the variant polypeptide on its surface. In another example, for example when the genetic package is a virus, for example, a phage, the host cell is infected with the genetic package. For example, the host cells can be phage-display compatible host cells, which can be transformed with phage or phagemid vectors and accommodate the packaging of phage expressing fusion proteins containing the variant polypeptides.

As used herein, a vector is a replicable nucleic acid into which a nucleic acid, for example, a variant polypeptide, for example, an oligonucleotide duplex cassette, can be introduced, typically by restriction digest and ligation, that can be used to introduce the nucleic acid into a host cell and/or a genetic package. The vector is used to introduce the nucleic acid into the host cell and/or genetic package for amplification of the nucleic acid or for expression/display of the polypeptide encoded by the nucleic acid. When the genetic package is a virus, for example, a phage, the genetic package can also be the vector. Alternatively, for example, in the case of phage display, a phagemid vector is used as the vector to introduce the nucleic acids into the genetic package. In this case, the phagemid vector is transformed into a host cell, typically a bacterial host cell. In one example, a helper phage is co-infected to induce packaging of the phage (genetic package), which will express the encoded polypeptide.

As used herein, a genetic package is a vehicle used to display a polypeptide, typically a variant polypeptide produced according to the provided methods. Typically, the genetic package displaying the polypeptide is used for selection of desired variant polypeptides from a collection of variant polypeptides. Genetic packages that can be used with the provided methods include, but are not limited to, bacterial cells, bacterial spores, viruses, including bacterial DNA viruses, for example, bacteriophages, typically filamentous bacteriophages, for example, Ff, M13, fd, and fl. Any of a number of well-known genetic packages can be used in association with the provided methods. A genetic package polypeptide is any polypeptide naturally expressed by the polypeptide, or variant thereof.

As used herein, display refers to the expression of one or more polypeptides on the surface of a genetic package, such as a phage. As used herein, phage display refers to the expression of polypeptides on the surface of filamentous bacteriophage.

As used herein, a phage-display compatible cell or phage-display compatible host cell is a host cell, typically a bacterial host cell, that can be infected by phage and thus can support the production of phage displaying fusion proteins containing polypeptides, e.g. variant polypeptides and can thus be used for phage display. Exemplary of phage display compatible cells include, but are not limited to, XL1-blue cells.

As used herein, panning refers to an affinity-based selection procedure for the isolation of phage displaying a molecule with a specificity for a binding partner, for example, a capture molecule (e.g. an antigen) or sequence of amino acids or nucleotides or epitope, region, portion or locus therein.

As used herein, transformation efficiency refers to the number of bacterial colonies produced per mass of plasmid DNA transformed (colony forming units (cfu) per mass of transformed plasmid DNA).

As used herein, titer with reference to phage refers to the number of colony forming units (cfu) per ml of transformed cells.

As used herein, in silico means performed or contained on a computer or via computer simulation.

As used herein, a stop codon is used to refer to a three-nucleotide sequence that signals a halt in protein synthesis during translation, or any sequence encoding that sequence (e.g. a DNA sequence encoding an RNA stop codon sequence), including the amber stop codon (UAG or TAG)), the ochre stop codon (UAA or TAA)) and the opal stop codon (UGA or TGA)). It is not necessary that the stop codon signal termination of translation in every cell or in every organism. For example, in suppressor strain host cells, such as amber suppressor strains and partial amber suppressor strains, translation proceeds through one or more stop codon (e.g. the amber stop codon for an amber suppressor strain), at least some of the time.

As used herein, “suppressor strain and suppressor cell” refer to organisms or cells (e.g. host cells), in which translation proceeds through a stop codon or termination sequence (read-through) for some percentage of the time. Stop codon suppressor strains contain mutation(s) causing the production of tRNA having altered anti-codons that can read the stop codon sequence, allowing continued protein synthesis. For example, cells of an amber suppressor strain, such as, but not limited to, XL-1 blue, contain altered tRNA (e.g. a UAG suppression tRNA gene (sup E44)) allowing them to read through the AUG codon and continue protein synthesis. In suppressor strains containing a sup E44 gene, a glutamine (Gln; Q) is produced from the AUG codon. In one example, the suppressor strains are partial suppressor strains, where translation proceeds through the stop codon less than 100% of the time (thus, effecting less than 100% suppression or read-through), typically no more than 80% suppression, typically no more than 50% suppression, such as no more than at or about 80, 75, 70, 65, 60, 55, 50, 45, 40, 35, 30, 25, 20, or 15% suppression. Efficiency of suppression can depend on several factors, such as the choice of polynucleotide, e.g. vector, containing the amber stop codon. For example, the choice of nucleotide immediately to the 3′ of an amber stop codon can affect the amount of read-through, for example, whether the vector contains a guanine residue or an adenine residue at the position just 3′ of the amber stop codon. Exemplary of partial suppressor strains are amber suppressor strains, e.g. XL-1 blue cells, which carry the E44 genotype. Other suppressor strains are well known (see, e.g. Huang et al., J. Bacteria 174(16) 5436-5441 (1992) and Bullock et al., Biotechniques 5:376-379 (1987)).

As used herein, randomized duplexes are oligonucleotide duplexes containing randomized oligonucleotides and having one or more randomized portions.

As used herein, a ligase is an enzyme capable of creating a covalent bond between a 5′ terminus of one nucleic acid molecule and a 3′ terminus of another nucleic acid molecule, when the 5′ terminus of the first nucleic acid molecule and the 3′ terminus of the second nucleic acid molecule are hybridized to portions on a third nucleic acid molecule, such as a complementary nucleic acid molecule. Thus, a ligase can be used to seal a nick between the 5′ and 3′ termini of two nucleic acid molecules each hybridized to a third nucleic acid molecule, thus forming a duplex. A ligase also can be used to join nucleic acid duplexes with overhangs, for example, restriction site overhangs, such as for insertion into a vector. When the ligase joins the nick between the 5′ and 3′ termini, the 5′ and 3′ nucleic acids of the respective molecules become adjacent nucleotides in the resulting duplex.

The ligase can be any of a number of well-known ligases, such as for example, T4 DNA ligase (from bacteriophage T4) (commercially available, for example, from New England Biolabs, Beverly, Mass.), T7 DNA ligase (from bacteriophage T7), E. coli ligase, tRNA ligase, a ligase from yeast, a ligase from an insect cell, a ligase from a mammal (e.g., murine ligase), and human DNA ligase (e.g., human DNA ligase IV/XRCC4). Exemplary of the ligases used in this step are a DNA ligase, for example, T4 DNA ligase or E. coli DNA ligase, an RNA ligase, for example, T4 RNA ligase, and a thermostable ligase, for example, Ampligase® (EPICENTRE® Biotechnologies, Madison, Wis.). An exemplary ligation reaction is carried out at room temperature, for example at 25° C., for four hours.

As used herein, “nick” describes the break between the 5′ and 3′ termini of two adjacent nucleic acid molecules (both hybridized to a third nucleic acid molecule), which can be joined by formation of a covalent phosphodiester bond by a ligase, producing a duplex. Thus, to “seal” a nick is to cause the formation of the bonds between the adjacent 5′ and 3′ terminal nucleotides in the two molecules, forming a duplex.

As used herein, a restriction enzyme or restriction endonuclease refers to an enzyme that cleaves a polynucleotide duplexes between two or more nucleotides, by recognizing short sequences of nucleotides, called restriction sites or restriction endonuclease recognition sites. Restriction endonucleases, and their recognition sites are well known and any of the known enzymes can be used with the provided methods. Often, cleavage of a duplex by a restriction endonuclease results in “restriction site overhangs,” also called “sticky ends,” which contain a single strand portion on one or both termini of the polynucleotide duplex and can be used in the provided methods to hybridize duplexes containing complementary overhangs, such as for ligation into a vector.

As used herein, “overhang” refers to a 5′ or 3′ portion of a polynucleotide duplex that is single stranded. Thus, while the duplex is a double-stranded nucleic acid molecule, with pairing through complementary nucleotides, the overhangs are single-strand portions that do not pair with complementary nucleotides and “hang over” the end of the duplex. Exemplary of overhangs are restriction site overhangs, which are generated by cutting with restriction enzymes; each restriction enzyme produces characteristic overhangs by cutting at particular sites in double stranded nucleic acid molecules. For use in the methods herein, the overhangs are of sufficient length to stably bind and hybridize to a complementary single stranded overhang. Typically, ovehangs of 5, 6, 7, 8, 9, 10 or more nucleotides are of sufficient length to stably bind and hybridize to a complementary single stranded overhang.

As used herein, a single primer extension reaction is a method whereby a complementary strand of a polynucleotide is synthesized using a single primer (e.g. a single primer pool) and a polymerase. Typically, the single primer extension is not an amplification reaction, and thus does not include multiple rounds or cycles. Thus, one complementary strand is synthesized and multiple copies are not produced.

As used herein “amplification” refers to a method for increasing the number of copies of a sequence of a polynucleotide using a polymerase and typically, a primer. An amplification reaction results in the incorporation of nucleotides to elongate a polynucleotide molecule, such as a primer, thereby forming a polynucleotide molecule, e.g. a complementary strand, which is complementary to a template polynucleotide. In one example, the formed new polynucleotide strand can then be used as a template for synthesis of an additional complementary polynucleotide in a subsequent cycle. Typically, one amplification reaction includes many rounds (“cycles”) of this process, whereby polynucleotides in the first round or cycle are denatured and used as template polynucleotides in a subsequent cycle. Each cycle includes one extension reaction, whereby a complementary strand is synthesized. Amplification reactions include, but are not limited to, polymerase chain reactions (PCR), reverse-transcriptase (RT)-PCR, RNA PCR, LCR, multiplex PCR, panhandle PCR, capture PCR, expression PCR, 3′ and 5′ RACE, in situ PCR and ligation-mediated PCR.

As used herein, “binding partner” refers to a molecule (such as a polypeptide, lipid, glyclolipid, nucleic acid molecule, carbohydrate or other molecule), with which another molecule specifically interacts, for example, through covalent or noncovalent interactions, such as the interaction of an antibody with cognate antigen. The binding partner can be naturally or synthetically produced. In one example, desired variant polypeptides are selected using one or more binding partners, for example, using in vitro or in vivo methods. Exemplary of the in vitro methods include selection using a binding partner coupled to a solid support, such as a bead, plate, column, matrix or other solid support; or a binding partner coupled to another selectable molecule, such as a biotin molecule, followed by subsequent selection by coupling the other selectable molecule to a solid support. Typically, the in vitro methods include wash steps to remove unbound polypeptides, followed by elution of the selected variant polypeptide(s). The process can be repeated one or more times in an iterative process to select variant polypeptides from among the selected polypeptides.

As used herein, binding activity refer to characteristics of a molecule, e.g. a polypeptide, relating to whether or not, and how, it binds one or more binding partners. Binding activities include ability to bind the binding partner(s), the affinity with which it binds to the binding partner (e.g. high affinity), the avidity with which it binds to the binding partner, the strength of the bond with the binding partner and specificity for binding with the binding partner.

As used herein, affinity describes the strength of the interaction between two or more molecules, such as binding partners, typically the strength of the noncovalent interactions between two binding partners. The affinity of an antibody for an antigen epitope is the measure of the strength of the total noncovalent interactions between a single antibody combining site and the epitope. Low-affinity antibody-antigen interaction is weak, and the molecules tend to dissociate rapidly, while high affinity antibody-antigen binding is strong and the molecules remain bound for a longer amount of time. Methods for calculating affinity are well known, such as methods for determining dissociation constants. Affinity can be estimated empirically or affinities can be determined comparatively, e.g. by comparing the affinity of one antibody and another antibody for a particular antigen. Affinity can be compared to another antibody, for example, “high affinity” of a variant antibody polypeptide or modified antibody polypeptide can refer to affinity that is greater than the affinity of the target or unmodified antibody.

As used herein, “off-rate” when referring to an antibody, refers to the dissociation rate constant (k_{ff}), or rate at which the antibody dissociates from bound antigen. Off-rate can be compared to another antibody, for example, “low off rate” of a variant antibody polypeptide or modified antibody polypeptide can refer to an off-rate that is lower than the off-rate of the target or unmodified antibody.

As used herein, “on-rate,” when referring to an antibody, refers to the dissociation rate constant (kₒₙ), or rate at which the antibody associates (binds) to its antigen. On-rate can be compared to another antibody, for example, “high on-rate” of a variant antibody polypeptide or modified antibody polypeptide can refer to an on-rate that is greater than the on-rate of the target or unmodified antibody.

As used herein, antibody avidity refers to the strength of multiple interactions between a multivalent antibody and its cognate antigen, such as with antibodies containing multiple binding sites associated with an antigen with repeating epitopes or an epitope array. A high avidity antibody has a higher strength of such interactions compared with a low avidity antibody. Avidity can be compared to another antibody, for example, “high avidity” of a variant antibody polypeptide or modified antibody polypeptide can refer to avidity that is greater than the avidity of the target or unmodified antibody.

As used herein, a high-fidelity polymerase is a polymerase that can be used to perform polymerase reactions with an error frequency rate that is not more than at or about 4×10⁻⁶ mutations per base pair per amplification cycle (e.g. PCR cycle), such as, for example, not more than at or about 2×10⁻⁶, and not more than at or about 1.3×10⁻⁶ mutations per base pair per cycle, or fewer. In one example, the high-fidelity polymerase is an error-free polymerase. A particular error rate can be specified. Exemplary of high fidelity polymerases is the Advantage® HF 2 polymerase (Clonetech), which produces at or about 30-fold higher fidelity than Taq polymerase.

As used herein, “coupled” means attached via a covalent or noncovalent interaction. For example, in the provided methods, one or more binding partners can be coupled to a solid support for selection of variant polypeptides.

As used herein, “bind” refers to the participation of a molecule in any attractive interaction with another molecule, resulting in a stable association in which the two molecules are in close proximity to one another. Binding includes, but is not limited to, non-covalent bonds, covalent bonds (such as reversible and irreversible covalent bonds), and includes interactions between molecules such as, but not limited to, proteins, nucleic acids, carbohydrates, lipids, and small molecules, such as chemical compounds including drugs. Exemplary of bonds are antibody-antigen interactions and receptor-ligand interactions. When an antibody “binds” a particular antigen, bind refers to the specific recognition of the antigen by the antibody, through cognate antibody-antigen interaction, at antibody combining sites. Binding can also include association of multiple chains of a polypeptide, such as antibody chains which interact through disulfide bonds.

As used herein, a disulfide bond (also called an S—S bond or a disulfide bridge) is a single covalent bond derived from the coupling of thiol groups. Disulfide bonds in proteins are formed between the thiol groups of cysteine residues, and stabilize interactions between polypeptide domains, such as antibody domains.

As used herein, “display protein” and “genetic package display protein” refer synonymously to any genetic package polypeptide for display of a polypeptide on the genetic package, such that when the display protein is fused to (e.g. included as part of a fusion protein with) a polypeptide of interest (e.g. target or variant polypeptide provided herein), the polypeptide is displayed on the outer surface of the genetic package. The display protein typically is present on or within the outer surface or outer compartment of a genetic package (e.g. membrane, cell wall, coat or other outer surface or compartment) of a genetic package, e.g. a viral genetic package, such as a phage, such that upon fusion to a polypeptide of interest, the polypeptide is displayed on the genetic package.

As used herein, a coat protein is a display protein, at least a portion of which is present on the outer surface of the genetic package, such that when it is fused to the polypeptide of interest, the polypeptide is displayed on the outer surface of the genetic package. Typically, the coat proteins are viral coat proteins, such as phage coat proteins. A viral coat protein, such as a phage coat protein associates with the virus particle during assembly in a host cell. In one example, coat proteins are used herein for display of polypeptides on genetic packages; the coat proteins are expressed as portions of fusion proteins, which contain the coat protein sequence of amino acids and a sequence of amino acids of the displayed polypeptide, such as a variant polypeptide provided herein. In the provided methods, nucleic acid encoding the coat protein is inserted in a vector adjacent or in close proximity to the nucleic acid encoding the polypeptide, e.g. the variant polypeptide. The coat protein can be a full-length coat protein or any portion thereof capable of effecting display of the polypeptide on the surface of the genetic package.

As used herein, a fusion protein is a polypeptide engineered to contain sequences of amino acids corresponding to two distinct polypeptides, which are joined together, such as by expressing the fusion protein from a vector containing two nucleic acids, encoding the two polypeptides, in close proximity, e.g. adjacent, to one another along the length of the vector. Exemplary of a fusion protein is a coat protein-polypeptide fusion, for example, a coat protein fused to a variant polypeptide, which are displayed on the surfaces of genetic packages. A non-fusion polypeptide is a polypeptide that is not part of a fusion protein containing a coat protein, such as a soluble polypeptide.

As used herein, “adjacent” nucleotides, nucleotide sequences, nucleic acids, amino acids, amino acid residues, or amino acids, are nucleotides, nucleotide sequences, nucleic acids, amino acids, amino acid residues, or amino acids that are immediately next to one another along the length of the linear nucleic acid or amino acid sequence. When it is said that a particular nucleotide, nucleotide sequence, nucleic acid, amino acid, amino acid residue, or amino acid is “between” or “located between” two other such molecules, this description refers to the location of the sequences or residues along the linear length of the amino acid or nucleic acid sequence, unless otherwise indicated.

Exemplary of coat proteins are phage coat proteins, such as, but not limited to, (i) minor coat proteins of filamentous phage, such as gene III protein (gIIIp, cp3), and (ii) major coat proteins (which are present in the viral coat at 10 copies or more, for example, tens, hundreds or thousands of copies) of filamentous phage such as gene VIII protein (gVIIIp, cp8); fusions to other phage coat proteins such as gene VI protein, gene VII protein, or gene 1× protein (see, e.g., WO 00/71694); and portions (e.g., domains or fragments) of these proteins, such as, but not limited to domains that are stably incorporated into the phage particle, e.g. such as the anchor domain of gIIIp, or gVIIIp. Additionally, mutants of gVIIIp can be used which are optimized for expression of larger peptides, such as mutants having improved surface display properties, such as mutant gVIIp (see, for example, Sidhu et al. (2000) J. Mol. Biol. 296:487-495).

As used herein, “drug-resistant” refers to the inability of an infectious agent or other microbe to be treated by drug that typically is used to treat similar types of infectious agents. It is not necessary that the drug-resistant agent be resistant to treatment with every drug.

As used herein, equimolar concentrations refers to the presence of two or more molecules at the same or about the same number of molecules within a sample, e.g. within a pool of polynucleotides.

As used herein, a “property” of a polypeptide, such as an antibody or other therapeutic polypeptide, refers to any property exhibited by a polypeptide, including, but not limited to, binding specificity, structural configuration or conformation, protein stability, resistance to proteolysis, conformational stability, thermal tolerance, and tolerance to pH conditions. Changes in properties can alter an “activity” of the polypeptide. For example, a change in the binding specificity of the antibody polypeptide can alter the ability to bind an antigen, and/or various binding activities, such as affinity or avidity, or in vivo activities of the therapeutic polypeptide.

As used herein, an “activity” or a “functional activity” of a polypeptide, such as an antibody or other therapeutic polypeptide, refers to any activity exhibited by the polypeptide. Such activities can be empirically determined. Exemplary activities include, but are not limited to, ability to interact with a biomolecule, for example, through antigen binding, DNA binding, ligand binding, or dimerization, enzymatic activity, for example, kinase activity or proteolytic activity. For an antibody (including fragments), activities include, but are not limited to, the ability to specifically bind a particular antigen, affinity of antigen binding (e.g. high or low affinity), avidity of antigen binding (e.g. high or low avidity), on-rate, off-rate, effector functions, such as the ability to promote antigen neutralization or clearance, and in vivo activities, such as the ability to prevent infection or invasion of a pathogen, or to promote clearance, or to penetrate a particular tissue or fluid or cell in the body. Activity can be assessed in vitro or in vivo using recognized assays, such as ELISA, flow cytometry, BIAcore or equivalent assays to measure on- or off-rate, immunohistochemistry and immunofluorescence histology and microscopy, cell-based assays, flow cytometry, binding assays, such as the panning assays described herein. For example, for an antibody polypeptide, activities can be assessed by measuring binding affinities, avidities, and/or binding coefficients (e.g. for on-/off-rates), and other activities in vitro or by measuring various effects in vivo, such as immune effects, e.g. antigen clearance, penetration or localization of the antibody into tissues, protection from disease, e.g. infection, serum or other fluid antibody titers, or other assays that are well know in the art. The results of such assays that indicate that a polypeptide exhibits an activity can be correlated to activity of the polypeptide in vivo, in which in vivo activity can be referred to as therapeutic activity, or biological activity. Activity of a modified polypeptide can be any level of percentage of activity of the unmodified polypeptide, including but not limited to, 1% of the activity, 2%, 3%, 4%, 5%, 10%, 20%, 30%, 40%, 50%, 60%, 70%, 80%, 90%, 91%, 92%, 93%, 94%, 95%, 96%, 97%, 98%, 99%, 100%, 200%, 300%, 400%, 500%, or more of activity compared to the unmodified polypeptide. Assays to determine functionality or activity of modified (e.g. variant) antibodies are well known in the art.

As used herein, “therapeutic activity” refers to the in vivo activity of a therapeutic polypeptide. Generally, the therapeutic activity is the activity that is used to treat a disease or condition. Therapeutic activity of a modified polypeptide can be any level of percentage of therapeutic activity of the unmodified polypeptide, including but not limited to, 1% of the activity, 2%, 3%, 4%, 5%, 10%, 20%, 30%, 40%, 50%, 60%, 70%, 80%, 90%, 91%, 92%, 93%, 94%, 95%, 96%, 97%, 98%, 99%, 100%, 200%, 300%, 400%, 500%, or more of therapeutic activity compared to the unmodified polypeptide.

As used herein, “exhibits at least one activity” or “retains at least one activity” refers to the activity exhibited by a modified polypeptide, such as a variant polypeptide produced according to the provided methods, such as a modified, e.g. variant antibody or other therapeutic polypeptide (e.g. a modified 2G12 antibody), compared to the target or unmodified polypeptide, that does not contain the modification. A modified (e.g. variant) polypeptide that retains an activity of a target polypeptide can exhibit improved activity or maintain the activity of the unmodified polypeptide. In some instances, a modified (e.g. variant) polypeptide can retain an activity that is increased compared to an target or unmodified polypeptide. In some cases, a modified (e.g. variant) polypeptide can retain an activity that is decreased compared to an unmodified or target polypeptide. Activity of a modified (e.g. variant) polypeptide can be any level of percentage of activity of the unmodified or target polypeptide, including but not limited to, 1% of the activity, 2%, 3%, 4%, 5%, 10%, 20%, 30%, 40%, 50%, 60%, 70%, 80%, 90%, 91%, 92%, 93%, 94%, 95%, 96%, 97%, 98%, 99%, 100%, 200%, 300%, 400%, 500%, or more activity compared to the unmodified or target polypeptide. In other embodiments, the change in activity is at least about 2 times, 3 times, 4 times, 5 times, 6 times, 7 times, 8 times, 9 times, 10 times, 20 times, 30 times, 40 times, 50 times, 60 times, 70 times, 80 times, 90 times, 100 times, 200 times, 300 times, 400 times, 500 times, 600 times, 700 times, 800 times, 900 times, 1000 times, or more times greater than unmodified or target polypeptide. Assays for retention of an activity depend on the activity to be retained. Such assays can be performed in vitro or in vivo. Activity can be measured, for example, using assays known in the art and described in the Examples below for activities such as but not limited to ELISA and panning assays. Activities of a modified (e.g. variant) polypeptide compared to an unmodified or target polypeptide also can be assessed in terms of an in vivo therapeutic or biological activity or result following administration of the polypeptide.

As used herein, a “polypeptide that is toxic to the cell” refers to a polypeptide whose heterologous expression in a host cell can be detrimental to the viability of the host cell. The toxicity associated with expression of the heterologous polypeptide can manifest, for example, as cell death or a reduced rate of cell growth, which can be assessed using methods well known in art, such as determining the growth curve of the host cell expressing the polypeptide by, for example, spectrophotometric methods, such as the optical density at 600 nm, and comparing it to the growth of the same host cell that does not express the polypeptide. Toxicity associated with expression of the polypeptide also can manifest as vector instability or nucleic acid instability. For example, the vector encoding the polypeptide can be lost from the host cell during replication of the host cell, or the nucleic acid encoding the polypeptide can be lost from the vector or can be otherwise modified to reduce expression of the heterologous polypeptide.

As used herein, a “leader peptide” or a “signal peptide” refers to a peptide that can mediate transport of a linked, such as a fused, polypeptide to the cell surface or exterior of intracellular membranes, such as to the periplasm of bacterial cells. Leader peptides typically are at least 10, 20, 30, 40, 50, 60, 70, 80 or more amino acids long. Typically, the leader peptide is linked to the N-terminus of the polypeptide to facilitate translocation of that polypeptide across an intracellular mebrane Leader peptides include any of eukaryotic, prokaryotic or viral origin. Exemplary of bacterial leader peptides include, but are not limited to, the leader peptide from Pectate lyase B protein from Erwinia carotovora (PelB) and the E. coli leader peptides from the outer membrane protein (OmpA; U.S. Pat. No. 4,757,013); heat-stable enterotoxin II (StII); alkaline phosphatase (PhoA), outer membrane porin (PhoE), and outer membrane lambda receptor (LamB). Non-limiting examples of viral leader peptides include the N-terminal signal peptide from the bacteriophage proteins pIII and pVIII, pVII, and pIX. Leader peptides are encoded by leader sequences.

As used herein, “expression” refers to the process by which polypeptides are produced by transcription and translation of polynucleotides. The level of expression of a polypeptide can be assessed using any method known in art, including, for example, methods of determining the amount of the polypeptide produced from the host cell. Such methods can include, but are not limited to, quantitation of the polypeptide in the cell lysate by ELISA, Coomassie blue staining following gel electrophoresis, Lowry protein assay and the Bradford protein assay.

As used herein, “located in the nucleic acid encoding” when referring to the position of a stop codon located in the nucleic acid encoding a polypeptide, means that the stop codon can be at any position in the coding sequence of the polypeptide, including in the middle of the coding sequence or at the 5′ or 3′ ends of the coding sequence.

### B. OVERVIEW OF THE METHODS FOR CREATING DIVERSITY IN LIBRARIES, LIBRARIES, AND DISPLAY METHODS AND DISPLAYED MOLECULES

Provided are methods for creating diversity, diverse libraries, and display methods and display molecules. Among the embodiments provided herein are variant polynucleotides, diverse collections of variant polynucleotides, including nucleic acid libraries, and methods for producing the polynucleotides and collections. The variant polynucleotides include oligonucleotides, such as randomized oligonucleotides, duplexes, duplex cassettes, including assembled duplex cassettes, such as large assembled duplex cassettes, and vectors.

Also among the provided embodiments are variant polypeptides and collections of variant polypeptides, including polypeptides displayed on genetic packages, such as phage-displayed fusion polypeptides and phage display libraries, and methods for producing the variant polypeptides. Among the variant polypeptides provided herein are antibody polypeptides, including domain exchanged antibody polypeptides.

Also among the provided embodiments are antibodies, including fragments thereof, displayed on genetic packages, such as phage, vectors for use in display of antibodies, and methods for display of the antibodies on the genetic packages. In one example, the antibodies are domain exchanged antibodies, such as domain exchanged antibody fragments.

This section (and its subsections below) provides a general overview of the provided methods for generating diversity and the provided polynucleotide and polypeptide collections (e.g. libraries) and other products produced by the methods, and provided display methods and displayed molecules, such as antibodies (e.g. domain exchanged antibodies) displayed on genetic packages. The methods and compositions described generally in the following sub-sections are described in more detail in sections C-J, below.

1. Methods for Introducing Diversity in Libraries

A number of approaches have been employed for creating polypeptide libraries. Each has limitations. The provided methods and compositions overcome these limitations.

Existing approaches for generating diversity in polypeptides include:

non-targeted approaches (whereby diversity is introduced at random) such as recombination approaches (e.g. chain shuffling, (Marks et al., J. Mol. Biol. (1991) 222, 581-597; Barbas et al., Proc. Natl. Acad. Sci. USA (1991) 88, 7978-7982; Lu et al., Journal of Bilogical Chemistry (2003) 278(44), 43496-43507; Clackson et al., Nature (1991) 352, 624-628; Barbas et al., Proc. Natl. Acad. Sci. USA (1992) 89, 10164; U.S. Pat. Nos. 6,291,161, 6,291,160, 6,291,159, 6,680,192, 6,291,158, and 6,969,586); and “sexual PCR” (Stemmer, Nature (1994) 340, 389-391; Stemmer, Proc. Natl. Acad. Sci. USA (1994) 10747-10751; and U.S. Pat. No. 6,576,467; Boder et al., PNAS (2000) 97(20), 10701-10705)); and error-prone PCR (Zhou et al., Nucleic Acids Research (1991) 19(21), 6052; Gram et al. Proc. Natl. Acad. Sci. USA 89, 3567-3580; Rice et al., Proc. Natl. Acad. Sci. USA (1992) 89 5467-5471; Fromant et al., Analytical Biochemistry (1995) 224(1) 347-353; Mondon et al., Biotechnol. J. (2007) 2, 76-82 U.S. Application Publication No. 2004/0110294; Low et al., J. Mol. Biol. (1996) 260(3) 359-368; Orencia et al., Nature Structural Biology (2001) 8(3) 238-242; and Coia et al., J Immunol Methods (2001) 251(1-2) 187-193);

targeted approaches (for mutating particular positions or portions), such as cassette mutagenesis (Wells et al., Gene (1985) 34, 315-323; Oliphant et al., Gene (1986) 44, 177-183; Borrego et al., Nucleic Acids Research (1995) 23, 1834-1835; Baca et al., The Journal of Bilogical Chemistry (1997) 272(16) 10678-10684; Breyer and Sauer Jounal of Biological Chemistry (1989) 264(22) 13355-13360; Oliphant and Strul Proc. Natl. Acad. Sci. USA (1989) 86, 9094-9098; U.S. Pat. No. 7,175,996; Borrego et al., Nucleic Acids Research (1995) 23, 1834-1835; and Wells et al., Gene (1985) 34, 315-323); mutual primer extension (Oliphant et al., Gene (1986) 44, 177-183; Bryer and Sauer Jounal of Biological Chemistry (1989) 264(22) 13355-13360; Oliphant and Strul Proc. Natl. Acad. Sci. USA (1989) 86, 9094-9098) template-assisted ligation and extension (Baca et al., The Journal of Bilogical Chemistry (1997) 272(16) 10678-10684); codon cassette mutagenesis (Kegler-Ebo et al., Nucleic Acids Research, (1994) 22(9), 1593-1599; Kegler-Ebo et al., Methods Mol. Biol., (1996), 57, 297-310); oligonucleotide-directed mutagenesis (Brady and Lo, Methods Mol. Biol. (2004), 248, 319-26; Rosok et al., The Journal of Immunology, (1998) 160, 2353-2359) and amplification using degenerate oligonucleotide primers (U.S. Pat. Nos. 5,545,142, 6,248,516, and 7,189,841; Barbas et al., Proc. Natl. Acad. Sci. USA (1992) 89, 4557-4461; Pini et al., The Journal of Biological Chemistry (1998) 273(34), 21769-21776; Ho et al., The Journal of Biological Chemistry (2005), 280(1), 607-617), including overlap and two-step PCR (Higuchi et al., Nucleic Acids Research (1988); 16(15), 7351-7367; Jang et al., Molecular Immunology (1998), 35, 1207-1217; Brady and Lo, Methods Mol. Biol. (2004), 248, 319-26; Burks et al., Proc. Natl. Acad. Sci. USA (1997) 94, 412-417; Dubreuil et al., The Journal of Biological Chemistry (2005) 280(26), 24880-24887); and

combined approaches, such as combinatorial multiple cassette mutagenesis (CMCM) and related techniques (Crameri and Stemmer, Biotechniques, (1995), 18(2), 194-6; and US2007/0077572; De Kruif et al., J. Mol. Biol. (1995) 248, 97-105; Knappik et al., J. Mol. Biol. (2000), 296(1), 57-86; and U.S. Pat. No. 6,096,551).

Each of the available approaches has limitations. For example, the approaches are time-consuming, cost-prohibitive and/or labor-intensive. Further, many available approaches carry the risk of introducing unwanted mutations (e.g. mutations at undesired positions) and/or biases against selection of particular mutants. Available approaches are not suitable for generating collections of variant polypeptides having multiple non-contiguous variant portions (particularly non-contiguous variant portions separated by a large number of amino acids) by targeted saturating mutagenesis. For example, available methods are not suitable for generating collections of variant polynucleotides having a large number of different sequences among the members (having a high diversity), for example, at least 10⁴ or about 10⁴, 10⁵ or about 10⁵, 10⁶ or about 10⁶, 10⁷ or about 10⁷, 10⁸ or about 10⁸, 10⁹ or about 10⁹ or more different polynucleotide sequences among the members, where each of several possible nucleobases (e.g. A, T, G, C and/or U) are represented at each variant position within the collection, at relatively equal frequencies.

Methods are needed to overcome these limitations. Particularly, there is a need for methods to quickly, efficiently and simultaneously introduce saturating diversity to multiple distant regions, creating large collections of diverse polypeptides varied at more than one portion and/or domain. Such methods are desirable, for example, in screening polypeptide collections to develop polypeptides with improved properties, for example, increased binding capabilities, for example, by varying structural and functional domains of polypeptides containing a plurality of distinct loops or regions encompassing non-contiguous amino acids along the linear sequence, for example, in producing collections of variant antibody polypeptides and selecting antibodies having improved properties, e.g. increased or altered binding activities. The methods and compositions provided herein overcome these limitations.

2. Methods and Compositions for Generating Diversity

Provided herein are methods for generating diversity, such as methods for making collections of variant polynucleotides and methods for producing collections of polypeptides encoded by the polynucleotides and methods for selecting polypeptides from the collections. Also provided are variant polynucleotides, including collections thereof (e.g. nucleic acid libraries) and variant polypeptides, including collections thereof (e.g. phage display libraries), produced by the methods. The methods and products can be used in a number of applications, such as protein therapeutics, including therapeutic antibody development, and directed evolution. In one example, the variant polypeptides are large polypeptides produced with synthetic oligonucleotides.

Thus, among the provided embodiments are variant polynucleotides, diverse collections of variant polynucleotides, including nucleic acid libraries, and methods for producing the polynucleotides and collections. The variant polynucleotides include oligonucleotides, such as randomized oligonucleotides, duplexes, duplex cassettes, including assembled duplex cassettes, such as large assembled duplex cassettes, and vectors. The collections of variant polynucleotides produced according to the provided methods, contain diversity, such as a high diversity, typically at least at or about 10⁴, 10⁵, 10⁶, 10⁷, 10⁸, 10⁹, 10¹⁰ or more.

In one example, the collections of variant polynucleotides contain a high diversity, for example, at least 10⁴ or about 10⁴, 10⁵ or about 10⁵, 10⁶ or about 10⁶, 10⁷ or about 10⁷, 10⁸ or about 10⁸, 10⁹ or about 10⁹ or more different polynucleotide sequences among the members. In one such example, the collections each of several possible nucleobases (e.g. A, T, G, C and/or U) is represented at analogous variant positions within the collection members, at relatively equal frequencies. In one such example, the collection of polynucleotides has at least 10⁴ or about 10⁴, 10⁵ or about 10⁵, 10⁶ or about 10⁶, 10⁷ or about 10⁷, 10⁸ or about 10⁸ or 10⁹ or about 10⁹ diversity and each member of the collection contains at least 100 or about 100, 200 or about 200, 300 or about 300, 500 or about 500, 1000 or about 1000, or 2000 or about 2000 nucleotides in length. In another example, the collection is a collection of randomized polynucleotides, in which, for each randomized position, each member of the collection contains one or the other of two nucleotides (e.g. A and T) at the randomized position and neither of the two nucleotides (e.g. A or T) is present at the position in more than 55% or about 55% of the members. In another example, the collection is a collection of randomized polynucleotides, in which, for each randomized position, each member of the collection contains one of four or more nucleotides (e.g. A, T, G and C or more) at the randomized position, and none of the four or more nucleotides is present at the analogous position in more than 30% of the members.

In one example, the collections are produced without cloning a target sequence or introducing restriction sites into a target sequence. In another example, the collections are generated without using a gene-specific primer or without using a primer pair, or without any amplification step, such as without performing polymerase chain reaction (PCR).

The collections of variant polypeptides provided herein can be used to select one or more variant polypeptides with one or more desired properties. In one example, the collection of variant polypeptides is a collection of antibodies, antibody domains and/or antibody fragments, for example, domain-exchanged antibodies. A collection of variant antibody polypeptides can be screened for the ability to bind a particular antigen, for example, with high affinity and/or avidity. In this example, using provided methods, for example, panning methods, one or more antibodies or antibody fragments having high affinity or avidity or other property can be selected from the collection. Typically, the collection of variant polypeptides is a collection of genetic packages displaying the polypeptides, for example, a phage display library. In this example, a variant polypeptide is expressed as part of a fusion protein, for example, a phage coat protein fusion.

Each variant polypeptide in a collection of variant polypeptides has at least one, typically at least two, for example, 2, 3, 4, 5, 6, 7, 8, 9, 10, 15, 20 or more, variant portions. The variant portions are altered in amino acid sequence compared to analogous portions in a target polypeptide and/or compared to analogous portion(s) in one or more other variant polypeptide members of the collection. Typically, two or more variant portions within one variant polypeptide are non-contiguous along the linear sequence of amino acids. Two or more variant portions, for example, two or more non-contiguous variant portions, can be part of a single variant polypeptide domain. For example, a collection of variant antibody polypeptides can vary in amino acid sequence in one, two or three non-contiguous CDR portions within a single variable region domain. In another example, a collection of variant antibody polypeptides can vary in one or more of the non-contiguous framework regions (FRs), which form the beta sheets of the variable region domain. Alternatively, two or more variant portions can be part of two or more different polypeptide domains.

Two or more non-contiguous variant portions in a variant polypeptide made according to the provided methods can be separated by at or about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 65, 70, 71, 72, 73, 74, 75, 80, 85, 90, 95, 100, 110, 120, 130, 140, 150, 160, 170, 180 or more amino acids. For example, two variant CDR portions in a single variable region domain variant polypeptide typically are separated by fewer than about 100 amino acids, typically fewer than about 65 amino acids, typically at least about 10 amino acids.

The collections of variant polypeptides produced according to the provided methods contain diversity, typically at least at or about 10⁴, 10⁵, 10⁶, 10⁷, 10⁸, 10⁹, 10¹⁰ or more. In one example, the collection of polypeptides has at least 10⁴ or about 10⁴, 10⁵ or about 10⁵, 10⁶ or about 10⁶, 10⁷ or about 10⁷, 10⁸ or about 10⁸ or 10⁹ or about 10⁹ diversity.

Also provided are methods for generating collections of variant nucleic acid molecules, such as nucleic acid libraries, which contain variant polynucleotides. Exemplary of such collections are collections of randomized polynucleotides that encode the variant polypeptides. The variant polynucleotides are generated with synthetic oligonucleotides. Typically, the libraries are generated by inserting, into vectors, polynucleotide duplex cassettes made from the synthetic oligonucleotides using the methods provided herein. Typically, the duplex cassettes are made using one or more, typically at least two, variant oligonucleotides, each of which contains one or more variant oligonucleotide portions. The variant portions have alterations in the nucleic acid sequence compared to a target portion of a reference sequence, or compared to an analogous portion in one or more other polynucleotides within the nucleic acid library. Typically, the variant oligonucleotides are randomized oligonucleotides, which contain both randomized portions and reference sequence portions.

a. Selection of Target Polypeptides

In a first step of the methods for making collections of variant polypeptides, a target polypeptide is selected for variation. In one example, the target polypeptide is a native polypeptide. In another example, the target polypeptide is a variant polypeptide, for example a variant polypeptide generated by the methods herein (e.g. a variant antibody or antibody fragment from an antibody library generated using the provided methods). Exemplary of target polypeptides are antibodies, antibody domains, antibody fragments and antibody chains, as well as regions within the antibody fragments, domains and chains. The target polypeptide is encoded by a target polynucleotide. One or more target domains, target portions and/or target positions can be specifically selected for variation within the target polypeptide.

The target domains, portions and/or positions typically are selected based on a desire to generate a collection of polypeptides that vary in a particular structural or functional property compared to the target polypeptide. For example, for alteration of a polypeptide function, a functional domain that contributes to or affects that function can be selected as the target domain. In one example, when it is desired to generate a collection of variant antibody polypeptides with varying antigen specificities or binding affinities, an antigen binding site domain is selected as a target domain within a target antibody polypeptide. One or more target portions can be selected within the target domain. For example, each target portion of an antigen binding site domain can include part or all of an amino acid sequence of a CDR. In one example, each CDR within an antibody variable region or within an entire antibody binding site is selected as a target portion. Alternatively, the target portions can be selected at random along the amino acid sequence of the target polypeptide.

Selection of target polypeptides, polynucleotides and target portions and regions is described in detail in section C, below.

b. Design and Synthesis of Oligonucleotides

Oligonucleotides are designed and synthesized for use in nucleic acid libraries that encode the variant polypeptides. Oligonucleotide design is based on a target polynucleotide encoding the target polypeptide or, typically, a region and/or domain of the target polynucleotide. A reference sequence (a sequence of nucleotides containing sequence identity to a region of the target polynucleotide) is used as a design template for synthesizing the oligonucleotides. The oligonucleotides can be variant oligonucleotides, for example, randomized oligonucleotides. Alternatively, the oligonucleotides can be reference sequence oligonucleotides, which have identity, such as at or about 100% sequence identity, to the reference sequence that is used in designing the oligonucleotides. Typically, variant (e.g. randomized) and reference sequence oligonucleotides are synthesized and then assembled by one of the provided methods, to make a collection of variant nucleic acids (e.g. collection of variant assembled duplexes or duplex cassettes).

Typically, the oligonucleotides are synthetic oligonucleotides, which are synthesized in pools of oligonucleotides. Each synthetic oligonucleotide in a pool is designed based on the same reference sequence. Each randomized oligonucleotide in a pool of randomized oligonucleotides has at least one, typically at least two, reference sequence portions and at least one, for example, 1, 2, 3, 4, 5, 6, 7, 8, 9, 10 or more, randomized portions. Randomized positions within the randomized portion(s) are synthesized using one or more of a plurality of doping strategies.

In one example, a plurality of pools of oligonucleotides, typically more than two, for example 2, 3, 4, 5, 6, 7, 8, 9, 10, 15, 20 or more pools of oligonucleotides, is synthesized. In some examples, there are at least 2, 3, 4, 5, 6, 7, 8, 9, 10, 15, 20 or more pools of oligonucleotides. In one example, oligonucleotides are designed so that oligonucleotides from each of the plurality of pools can be assembled in subsequent steps to form assembled duplex cassettes. In some such examples, assembled duplexes are generated by hybridization of positive and negative strand oligonucleotides within the plurality of pools and/or by polymerase reactions, such as amplification reactions, including, but not limited to, polymerase chain reaction (PCR), followed by formation of assembled duplex cassettes, for example, by restriction digest. In some examples, intermediate duplexes are formed before forming the assembled duplexes. Typically, in these examples, the reference sequences used to design the individual pools of oligonucleotides have sequence identity to different regions along the target polynucleotide. In one example, two or more of these different regions are overlapping along the sequence of the target polynucleotide.

Design and synthesis of oligonucleotides is described in detail in section D below.

c. Generation of Assembled Oligonucleotide Duplexes and Duplex Cassettes

Following oligonucleotide synthesis, synthetic oligonucleotides and/or duplexes generated from the oligonucleotides are used to generate duplexes, including intermediate duplexes and assembled duplexes, including assembled duplex cassettes. Synthetic oligonucleotides and/or duplexes from two or more, typically three or more, pools are assembled to form assembled duplexes. In one example, the assembled duplexes are large assembled duplexes. The large assembled duplexes can be generated by hybridization, polymerase reactions, amplification reactions, ligation, and/or combinations thereof.

Typically, the large assembled duplexes are greater than 50 or about 50 nucleotides in length, for example, greater than at or about 50, 55, 60, 65, 70, 75, 80, 85, 90, 95, 100, 150, 200, 250, 300, 350, 400, 450, 500, 600, 700, 800, 900, 1000, 1500, 2000 or more nucleotides in length. In one example, the large assembled duplexes contain the length of an entire coding region of a gene. Typically, the large assembled duplexes have one, typically more than one, for example, 2, 3, 4, 5, 6, 7, 8, 9, 10, 15, 20 or more variant portions. Typically the more than one variant portions are randomized portions. In one example, the assembled duplexes are assembled duplex cassettes, which can be directly ligated into vectors. In one example, assembled duplexes are cut with restriction endonucleases, to generate the assembled duplex cassettes, which then can be ligated into vectors. Generation of assembled duplexes and assembled duplex cassettes using the methods provided herein, is described in detail in section E, below.

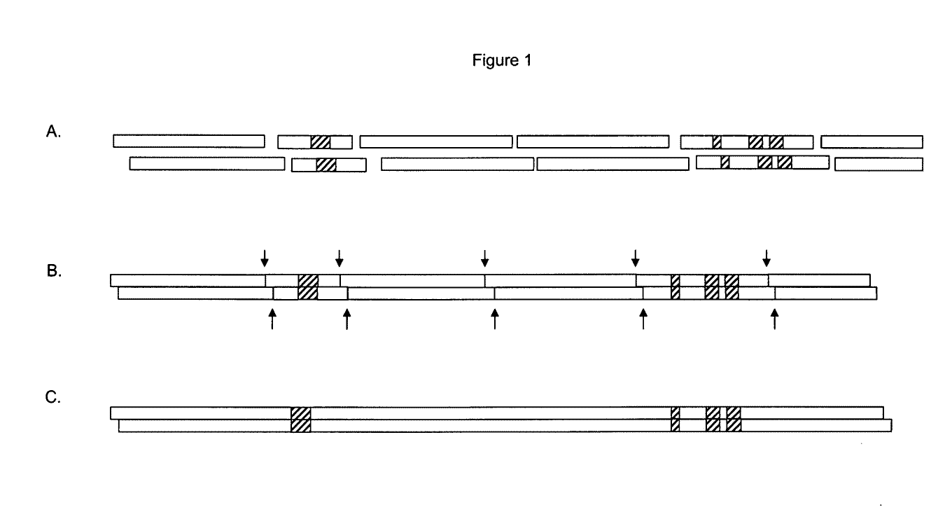

In some of the provided approaches, oligonucleotide duplex cassettes are generated directly, without using a restriction digestion step, for example, by hybridizing complementary positive and negative strand synthetic oligonucleotides. An example of such an approach is used in random cassette mutagenesis and assembly (RCMA), illustrated in FIG. 1 and described in further detail in section E(1), below. Briefly, in RCMA, assembled duplex cassettes, typically large assembled duplex cassettes, are generated by combining a plurality of oligonucleotide pools. Each assembled duplex cassette is made by hybridization and assembly of a plurality of positive and negative strand oligonucleotides with shared regions of complementarity. The approaches used in RCMA can be used to generate assembled duplex cassettes directly from synthetic oligonucleotides, without a restriction digestion step. The cassettes can be inserted directly into vectors.

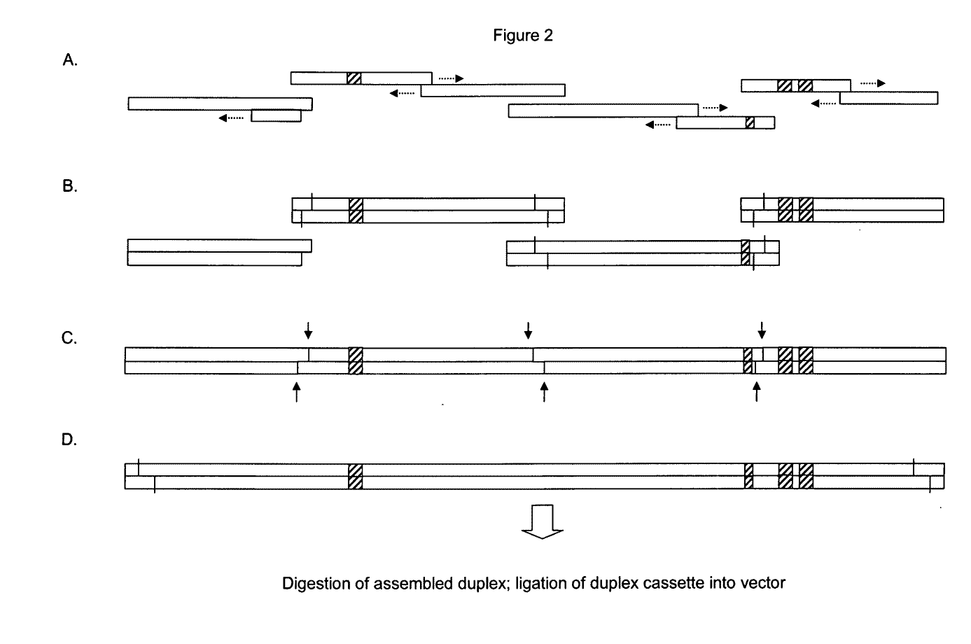

In other approaches, assembled duplexes are formed by hybridizing synthetic template oligonucleotides and synthetic oligonucleotide primers, followed by polymerase extension. In these approaches, the resulting assembled duplexes are used to generate duplex cassettes for insertion into vectors, for example, by cutting with restriction endonucleases. Exemplary of such an approach, used in oligonucleotide fill-in and assembly (OFIA), illustrated in FIG. 2 and described in detail in section E(2), below, a plurality of oligonucleotide template pools and oligonucleotide fill-in primer pools (which regions of complementarity to one another) are used in a plurality of fill-in reactions, whereby complementary strands are synthesized, thereby producing a plurality of pools of double-stranded duplexes, which then are digested with restriction endonucleases and assembled, to generate assembled duplexes. In one example, when the assembled duplexes contain restriction sites, the assembled duplexes then can be digested with one or more restriction endonucleases to create cassettes that can be inserted into vectors.

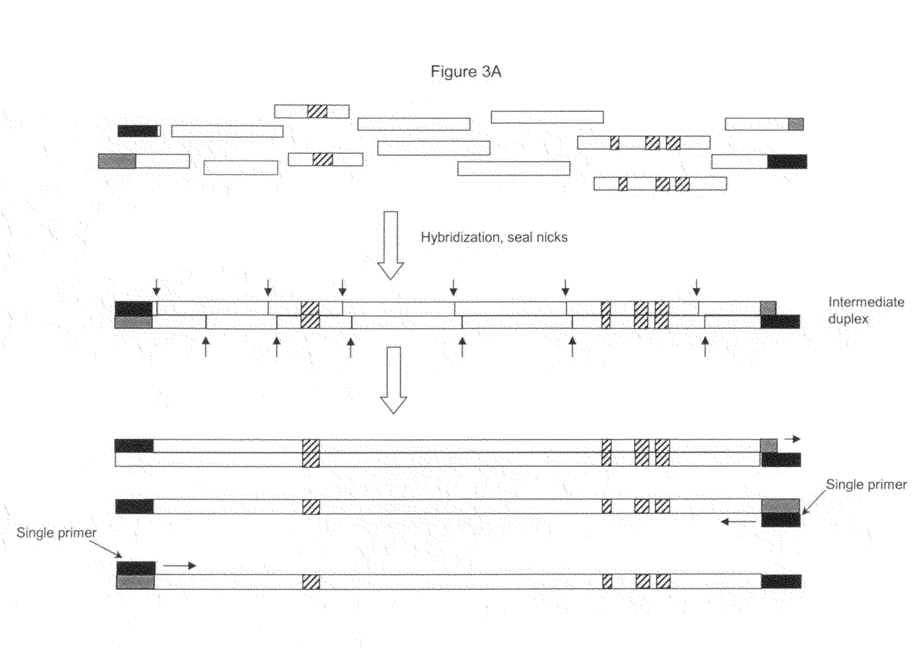

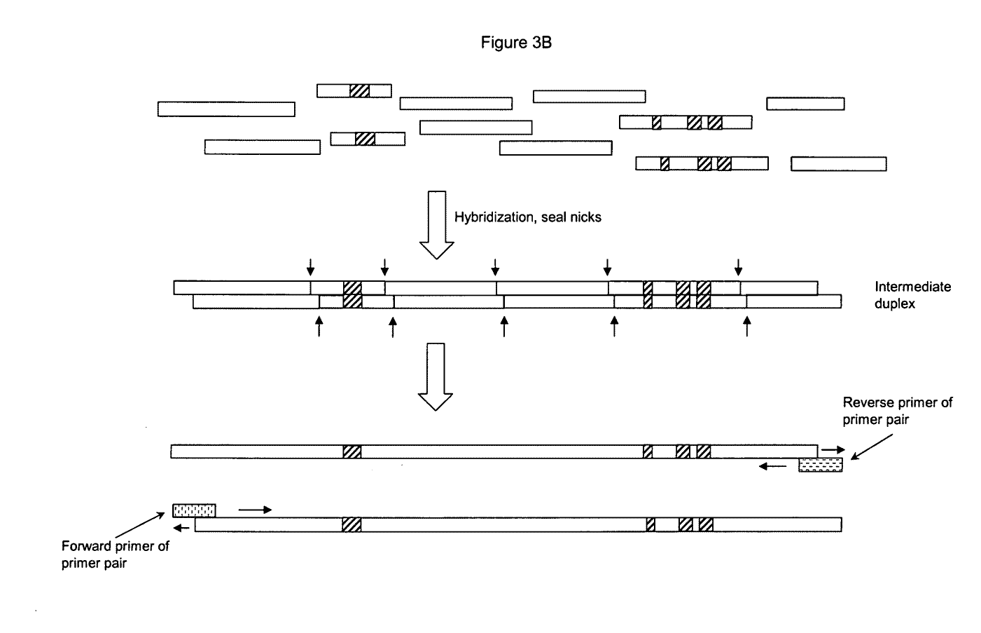

In other examples, a combination of hybridization and polymerase reactions are used to generate the assembled duplexes. Exemplary of such an approach is used in duplex oligonucleotide ligation/single primer amplification (DOLSPA), is illustrated in FIGS. 3A and 3B and described in section E(3), below. In this approach, a plurality of synthetic oligonucleotide pools (typically a combination of reference sequence oligonucleotide pools and variant oligonucleotide pools) are combined to assemble intermediate duplexes by hybridization and ligation. The intermediate duplexes then are used in an amplification reaction to form assembled duplexes. In one example of DOLSPA, illustrated in FIG. 3A, the amplification reaction is a single-primer extension reaction using a non gene-specific primer. In another example, illustrated in FIG. 3B, the amplification reaction is carried out using two primers, e.g. two gene-specific primers. As in other approaches, in one example, the assembled duplexes can be cut with restriction endonucleases to form assembled duplex cassettes, which can be ligated into vectors.

Also exemplary of the combined approaches for generating assembled duplexes, Fragment Assembly and Ligation/Single Primer Amplification (FAL-SPA), is illustrated in FIG. 4 and described in detail in section E(4), below. In this approach, pools of variant duplexes (typically randomized duplexes) (FIG. 4A), reference sequence duplexes (FIG. 4B), and scaffold duplexes (FIG. 4B) are generated simultaneously or in any order. In one example, the variant duplexes are generated by performing fill-in and/or amplification reactions, where synthetic variant template oligonucleotides (typically randomized template oligonucleotides) are incubated in the presence of oligonucleotide primers, under conditions whereby complementary strands are synthesized. Typically, the reference sequence and scaffold duplexes are generated by synthesizing complementary strands from the target polynucleotide or region thereof.

As illustrated in FIG. 4B, the scaffold duplexes contain regions of complementarity to variant (e.g. randomized) duplexes and reference sequence duplexes, and are used to facilitate ligation of polynucleotides from these two types of duplexes make pools of assembled polynucleotides, by bringing the polynucleotides in close proximity through hybridization via complementary regions. For this process, called fragment assembly and ligation (FAL) (FIG. 4C), the pools of variant duplexes, reference sequence duplexes and scaffold duplexes are incubated under conditions whereby polynucleotides from the duplexes hybridize through complementary regions, and whereby nicks are sealed, for example, by addition of a ligase, thereby forming assembled polynucleotides containing sequences of reference sequence duplexes and variant (e.g. randomized) duplexes.

Assembled duplexes then are generated by synthesizing complementary strands of the assembled polynucleotides, typically in a polymerase reaction, typically a single primer amplification (SPA) reaction (FIG. 4D), which uses a single primer pool to prime complementary strand synthesis from the 5′ ends of the assembled polynucleotides, thereby generating pools of assembled duplexes. In one example, as with the other methods described herein, the assembled duplexes then can be used to make assembled duplex cassettes, for example, for ligation into vectors.

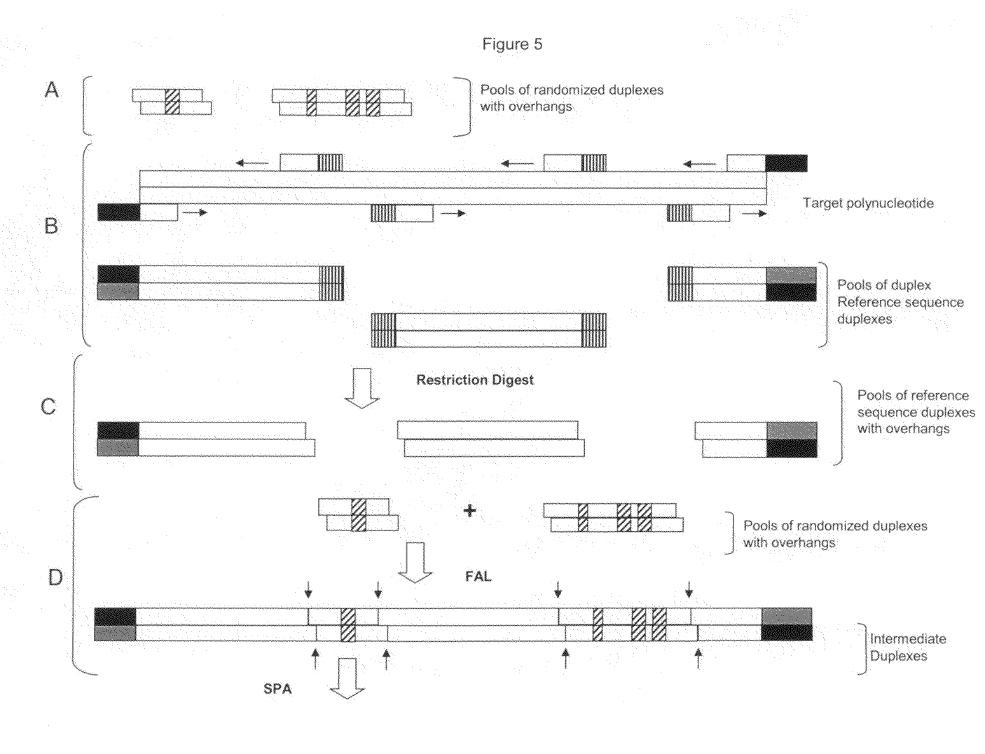

A modified variation of the FAL-SPA approach (mFAL-SPA) is illustrated in FIG. 5 and described in section E(5), below. In mFAL-SPA, the pools of variant, e.g. randomized duplexes are designed so that the resulting duplexes contain one, typically two, restriction site overhangs, which are used for assembly with reference sequence duplexes in a subsequent step. Typically, the variant (e.g. randomized) duplexes are formed by hybridizing pools of positive strand oligonucleotides and pools of negative strand oligonucleotides under conditions whereby oligonucleotides in the pools hybridize through regions of complementarity.

Reference sequence duplexes are generated, such as in FAL-SPA. Typically, the reference sequence duplexes are generated by incubating target polynucleotide or region thereof with primers, each of which contains a sequence of nucleotides corresponding to a restriction endonuclease cleavage site (nucleotide sequences within portions illustrated aw filled grey and black boxes in FIG. 5B). In this example, a restriction endonuclease cleavage step (FIG. 5C) further is carried out following the generation of the reference sequence duplexes, generating overhangs, typically being a few nucleotides in length, e.g. 2, 3, 4, 5, 6, 7, or more nucleotides in length. Typically, the restriction site overhangs designed in the variant oligonucleotides are selected based on the restriction endonuclease site used in the primers, such that cleavage of the reference sequence duplexes with the restriction endonuclease produces overhangs that are compatible with the overhangs generated in the variant oligonucleotide duplexes. Exemplary of the restriction endonuclease cleavage site is a SAP-I cleavage site (GCTCTTC SEQ ID NO:2), which allows production of 3-nucleotide overhangs of a sequence near the site.

The pools of duplexes are combined in a fragment assembly and ligation (FAL) step to form pools of intermediate duplexes (FIG. 5D). Typically the pools of intermediate duplexes are assembled through the compatible overhangs. Assembled duplexes are generated using the intermediate duplexes are synthesized, e.g. in an amplification step, typically a single primer amplification (SPA) reaction, where a “single primer” (pool of identical primers) is used to prime complementary strand synthesis from the 5′ and the 3′ ends of the single strand fragments of the denatured intermediate duplex. In one example, as with the other methods described herein, the assembled duplexes then can be used to make assembled duplex cassettes, for example, for ligation into vectors.

d. Ligation of the Assembled Duplex Cassettes into Vectors

Also provided are methods for generating collections of the variant polynucleotides, e.g. nucleic acid libraries, by ligation into vectors and transformation of host cells. After generation of duplex cassettes, the cassettes are inserted into vectors, replicable nucleic acids, for amplification of the nucleic acids and/or expression of the encoded polypeptides. The cassettes typically are inserted into the vectors using restriction digest and ligation, through restriction site overhangs generated in one or more of the previous steps. Typically, the vector into which a cassette is inserted contains all or part of the target polynucleotide.

Choice of vector can depend on the desired application. For example, after insertion of the duplex cassettes, the vectors typically are used to transform host cells, for example, to amplify the duplex cassettes and/or express, e.g. display, polypeptides encoded thereby. A number of vector-host cell combinations are known and can be used with the provided methods. Whether amplification, expression and/or display is desired can influence vector choice. In one example, the same vector can be used to amplify the nucleic acid and express the polypeptide. In one example, the vector is a display vector, for example, a phagemid vector, which is used to display the polypeptide on a genetic package, for example, in a phage display library. Provided methods for ligation of the assembled duplex cassettes into vectors, and specific vectors for use in the provided methods, are described in detail in section F, below.

e. Transformation of Host Cells with the Vectors

Also provided are methods for transforming host cells with the vectors containing the collections of variant polynucleotides. The host cells receive, maintain, reproduce, amplify and/or isolate and analyze, nucleic acids contained in the vectors, and can be used to induce protein expression from the vector and/or display on genetic packages. Host cells and their uses in the provided methods are described in detail in section G, below.

f. Display of Variant Polypeptides on Genetic Packages

Also provided are methods for displaying the variant polypeptides on genetic packages. The host cells and/or genetic packages can be used to express polypeptides encoded by the nucleic acids in the vectors, for example, in collections of variant polypeptides. Typically, the variant polypeptides are expressed on the surface of genetic packages, such as, but not limited to, bacterial cells, bacterial spores, viruses, including bacterial DNA viruses, for example, bacteriophages, typically filamentous bacteriophages, for example, Ff, M13, fd, and fl. Any of a number of well-known genetic packages can be used in association with the provided methods. Typically, the genetic package is part of a collection of genetic packages, for example a phage display library. Genetic packages and their use in the provided methods are described in detail in section H, below.

g. Selecting Variant Polypeptides from the Collections

Also provided are methods for selecting one or more variant polypeptides from the collections, e.g. collections of genetic packages displaying the polypeptides. With these methods, the collection of variant polypeptides, such as a phage display library is used to select one or more variant polypeptides having one or more desired properties. The collection can be subjected to one of a number of different selection procedures, e.g. panning on a binding partner, such as an antigen or a ligand. Selection strategies are designed based on the one or more properties desired for the selected variant polypeptides.

In one example of a selection process, variant polypeptides expressed on the surface of isolated genetic packages, are selected for their ability to bind a particular binding partner (for example, with high affinity, avidity and/or specificity), e.g. by panning. In an exemplary panning process, a binding partner is linked to a solid support or in solution; genetic packages displaying the variant polypeptides are exposed to the binding partner under binding conditions; non-binding members of the collection are washed away; and bound members are recovered (e.g. by elution). In some examples, bound and/or recovered members are assayed, for example, in an ELISA-based assay or by nucleic acid sequencing, to determine properties. In some cases, the recovered members are used in an iterative process, for example, in subsequent rounds of panning or by using the recovered members as target polynucleotides for further variation using the provided methods.

Recovered genetic packages can be used in one or more types of iterative processes, for example, by re-infection into host cells followed by subsequent rounds of selection. In another example, the recovered genetic packages can be used directly in a subsequent round of screening without re-infection. The additional rounds of selection can be used to further enrich the collection of variant polypeptides for a particular property or to select based on a different desired property. In one example, increasingly stringent selection conditions are used in the subsequent rounds of selection in order to enrich for a particular property.

In another example of an iterative process, the polypeptide expressed on one or more of the selected genetic packages is used as the target polypeptide in a subsequent round of variation for generating a collection of variant polypeptides using the methods provided herein. In this example, nucleic acids encoding the selected polypeptide(s) are purified from the selected genetic package(s) and sequenced. The nucleic acid(s) then are used as target polynucleotides to design oligonucleotides in a subsequent round of variation according to the provided methods. In one example, the nucleic acid sequence can be altered, for example by mutation, insertion, deletion, substitution or addition, before it is used as a target polynucleotide.

Selection methods, including iterative methods, are described in further detail in section I, below.

3. Display of Domain-Exchanged Antibody Fragments on Genetic Packages

In one example, the collections of variant polynucleotides are collections of polynucleotides encoding all or part of a domain exchanged antibody or antibody fragment, for example, a collection of polynucleotides generated by varying a 2G12 target polypeptide, such as a 2G12 heavy chain or a 2G12 Fab fragment. It is discovered herein that the unique three-dimensional folded configuration of domain exchanged antibodies renders their display using conventional methods problematic. Thus, also provided are methods for display of domain exchanged antibodies (e.g. antibody fragments) on genetic packages, particularly phage, and displayed domain exchanged antibodies and collections thereof. These methods are described in detail in Section J, below. Briefly, the methods include engineering vectors that contain a stop or termination sequence, e.g. an amber stop codon, and use of amber suppressor or partial suppressor host cells, whereby soluble and coat protein fusion versions of antibody chains are expressed from the host cell and displayed on phage.

Thus, when the target and/or variant polynucleotides encode domain exchanged antibodies, including fragments thereof, these provided methods (including design of vectors and choice of host cells) are used to display the encoded polynucleotides on genetic packages.

### C. SELECTION OF TARGET POLYPEPTIDES

The provided methods can be used to modify, e.g. vary the amino acid sequence of, target polypeptides. The target polypeptides are varied by generating collections of variant polypeptides, which vary in amino acid sequence compared to the target polypeptide, and optionally selecting members of the collection. Typically, in a first step of the methods, a target polypeptide is selected for variation. The sequence of a target polynucleotide encoding all or part of the target polypeptide then is used to design and generate a collection of variant polynucleotides encoding the variant polypeptides. Typically, a target polypeptide is selected based on a desire to vary one or more particular structural or functional properties of the target polypeptide, or based on the desire to generate polypeptides having a particular structural or functional property that the target polypeptide has. After generation of the collection of variant polypeptides, the collection can be screened to select individual variant polypeptides having one or more desired property.

Specific target portions and/or positions within the target polypeptide are selected for variation. The provided variant polypeptides contain variant portions, which are analogous to the target portions in the target polypeptide and vary in sequence compared to the target portions and/or variant portions in other polypeptides in the collection. In one example, target portions are selected based on their location within one or more target domains of the target polypeptide. The target domains can be structural or functional domains. For example, target portions within a functional target domain, for example an antigen binding site, can be selected for variation of the functional property associated with the domain. Alternatively, the target portions can be selected at random along the amino acid sequence of the polypeptide.

1. Exemplary Target Polypeptides

The methods provided herein can be used to vary any target polypeptide, for example, any protein encoded by a gene, for example, an antibody polypeptide, such as a full-length antibody or antibody fragment. The target polypeptide need not be a full-length protein, such as one that exists in nature or one that is encoded by an entire gene or genes. For example, the target polypeptide can be a protein fragment. Typically, a fragment target polypeptide bears one or more structural or functional properties of a corresponding native or full-length protein. Exemplary of a fragment target polypeptide is an antibody fragment that has the antigen-binding properties of a full-length antibody, for example a Fab or an ScFv or a domain exchanged fragment.

In one example, the target polypeptide is a wild-type polypeptide. In another example, the target polypeptide is a variant polypeptide, such as, but not limited to, a variant polypeptide generated by the provided methods. Thus, the target polypeptide can contain one or more modifications, for example, amino acid deletion, addition, insertion or substitution, compared to a wild-type polypeptide. In one example, the target polypeptide is encoded by a polynucleotide contained in a vector, for example, a polynucleotide member of a collection of variant polynucleotides, such as a variant nucleic acid library.

Because or more non-contiguous target portions within the target polypeptide can be selected for variation by the provided methods, target polypeptides can be selected based on a desire to vary two or more non-contiguous portions of a particular polypeptide. For example, a target polypeptide having a target domain containing multiple loops of non-contiguous amino acid sequence, such as an antigen binding. site, can be selected.

Typically, the target polypeptides are selected based on a desire to vary one or more properties of the target polypeptide or to generate a collection of variant polypeptides from which to select a polypeptide(s) having a particular property. Thus, the target polypeptides typically are polypeptides that have one or more structural or functional properties. Exemplary of target polypeptides are polypeptides that bind to particular binding partners, such as, but not limited to, antibodies, including antibody fragments and domain exchanged antibodies, antigens, enzymes, receptors, ligands and nucleic acid-binding polypeptides.

In one example, the property of the polypeptide is the ability bind to one or more binding partners (a binding activity). Typically, the binding activity is a specific binding ability. In one example, it can be desired to change, increase or decrease specificity, affinity, avidity or other aspects of the ability of the target polypeptide to bind to a binding partner, such as an antigen. For example, target antibody polypeptides can be selected for variation to create variant antibody polypeptides having increased binding affinity for a particular antigen. In another example, antigen specificity can be varied. In both examples, target portions can be selected within the antigen binding site domain.

Alternatively, target polypeptides, including antibody polypeptides, can be selected for variation of other properties, for example stability, solubility, immunogenicity, three-dimensional structure, effector function and/or ability to enter or remain in a particular tissue or cellular compartment. In this example, appropriate target portions can be selected within domains that confer or contribute to these properties. Alternatively, properties of target polypeptides are varied by selecting target portions of polypeptides at random.

a. Antibody Polypeptides

Antibody polypeptides, including antibody fragments, can be chosen as target polypeptides to generate collections of variant antibody polypeptides. Antibodies are produced naturally by B cells in membrane-bound and secreted forms. Antibodies specifically recognize and bind antigen epitopes through cognate interactions. Antibody binding to cognate antigens can initiate multiple effector functions, which cause neutralization and clearance of toxins, pathogens and other infectious agents. Diversity in antibody specificity arises naturally due to recombination events during B cell development. Through these events, various combinations of multiple antibody V, D and J gene segments, which encode variable regions of antibody molecules, are joined with constant region genes to generate a natural antibody repertoire with large numbers of diverse antibodies. A human antibody repertoire contains more than 10¹⁰ different antigen specificities and thus theoretically can specifically recognize any foreign antigen. Antibodies include such naturally produced antibodies, as well as synthetically, i.e. recombinantly, produced antibodies, such as antibody fragments, including domain exchanged antibodies.

In folded antibody polypeptides, binding specificity is conferred by antigen binding site domains, which contain portions of heavy and/or light chain variable region domains. Other domains on the antibody molecule serve effector functions by participating in events such as signal transduction and interaction with other cells, polypeptides and biomolecules. These effector functions cause neutralization and/or clearance of the infecting agent recognized by the antibody. Domains of antibody polypeptides can be varied according to the methods herein to alter specific properties.

i. Antibody Structural and Functional Domains and Regions Thereof

Full-length antibodies contain multiple chains, domains and regions, any of which can be targeted by the methods provided herein. A full length conventional antibody contains two heavy chains and two light chains, each of which contains a plurality of immunoglobulin (Ig) domains. An Ig domain is characterized by a structure called the Ig fold, which contains two beta-pleated sheets, each containing anti-parallel beta strands connected by loops. The two beta sheets in the Ig fold are sandwiched together by hydrophobic interactions and a conserved intra-chain disulfide bond. The Ig domains in the antibody chains are variable (V) and constant (C) region domains.

Each full-length conventional antibody light chain contains one variable region domain (V_{L}) and one constant region domain (C_{L}). Each full-length conventional heavy chain contains one variable region domain (V_{H}) and three or four constant region domains (C_{H}) and, in some cases, a hinge region. Owing to recombination events discussed above, nucleic acid sequences encoding the variable region domains of natural antibodies differ among antibodies and confer antigen-specificity to a particular antibody. The constant regions, on the other hand, are encoded by sequences that are more conserved among antibodies. These domains confer functional properties to antibodies, for example, the ability to interact with cells of the immune system and serum proteins in order to cause clearance of infectious agents. Different classes of antibodies, for example IgM, IgD, IgG, IgE and IgA, have different constant regions, allowing them to serve distinct effector functions.

Each conventional variable region domain contains three portions called complementarity determining regions (CDRs) or hypervariable (HV) regions, which are encoded by highly variable nucleic acid sequences. The CDRs are located within the loops connecting the beta sheets of the variable region Ig domain. Together, the three heavy chain CDRs (CDR1, CDR2 and CDR3) and three light chain CDRs (CDR1, CDR2 and CDR3) make up a conventional antigen binding site (antibody combining site) of the antibody, which physically interacts with cognate antigen and provides the specificity of the antibody. A whole antibody contains two identical antibody combining sites, each made up of CDRs from one heavy and one light chain. Because they are contained within the loops connecting the beta strands, the three CDRs are non-contiguous along the linear amino acid sequence of the variable region. Upon folding of the antibody polypeptide, the CDR loops are in close proximity, making up the antigen combining site. The beta sheets of the variable region domains form the framework regions (FRs), which contain more conserved sequences that are important for other properties of the antibody, for example, stability. As described herein, non-conventional antibody combining site(s) in domain exchanged antibodies are made up of residues from adjacent V_{H} domains.

The methods provided herein can be used to vary any domain(s) and/or portion(s) in target antibody polypeptides to generate collections of variant antibody polypeptides, including antibody fragments, and/or domains/regions thereof, having varied structural and/or functional properties.

ii. Antibodies in Protein Therapeutics

Because of their diversity, specificity and effector functions, antibodies are attractive candidates for protein-based therapeutics. Therapeutic and diagnostic monoclonal antibodies (MAbs) are used in the clinical setting to treat and diagnose human diseases, for example, cancer and autoimmune diseases. Improved antibodies are needed for therapeutics, such as antibodies with higher specificity and/or affinity compared with existing antibodies, and antibodies that are more bioavailable, or stable or soluble in particular cellular or tissue environments. Available techniques for generating improved antibody therapeutics are limited.

MAb production first was accomplished by fusion of B cells to tumor cells to make clonal hybridoma cells line secreting MAbs. MAbs since have been produced using other immortalization techniques. Immortalization of B cells to produce a MAb with desired specificity typically requires isolation of B cells from an immunized non-human animal or from blood of an immunized or infected human donor. Non-human therapeutic antibodies are problematic due to immunogenicity of non-human sequences. In attempts to overcome this difficulty, various genetic techniques have been used to engineer chimeric or humanized antibodies in which the non-antigen-binding portions of the antibodies are encoded by human sequences. Transgenic animals also can be used to produce fully human antibodies. These techniques are limited.

iii. Recombinant Techniques for Producing MAbs

Recombinant DNA technology has produced antibodies and antibody fragments by cloning of human antibody sequences and expression in host cells. Antibody coding sequences can be manipulated to vary specificity and other properties. Such techniques have generated collections of antibodies (antibody libraries), e.g. phage display libraries, with a plurality of antigen specificities for selection of antibodies.

a. Natural Antibody Libraries

Recombinant technology has been used to generate antibody repertoires, or libraries, in vitro by cloning numerous antibody variable region gene segments from human or non-human cells and randomly combining them. For this technique, antibody genes are cloned from cells from immunized or naïve donors or from hybridomas and then combined. These types of combinatorial libraries are limited by the number of naturally occurring gene segments and also by the practical size of libraries.

b. Synthetic and Semi-Synthetic Antibody Libraries

Synthetic and semi-synthetic antibody libraries are made by techniques that synthetically mutate or randomize particular portions of antibody variable region genes, for example by PCR using degenerate primers and cassette mutagenesis. Typically, these techniques are used to randomize a portion within the antigen binding site of the antibody, for example, one of the CDRs.

iv. Antibody fragments

Typically, the target antibody polypeptide selected for variation by the methods herein is an antibody fragment, such as a derivative of a full-length antibody that contain less than the full sequence of the full-length antibody but retains at least a portion of the full-length antibody's specific binding ability. Examples of antibody fragments include, but are not limited to, Fab, Fab′, F(ab′)₂, single-chain Fvs (scFv), Fv, dsFv, diabody, Fd and Fd′ fragments, and domain exchanged fragments such as domain exchanged Fab, scFv and other domain exchanged fragments, and other fragments, including modified fragments (see, for example, Methods in Molecular Biology, Vol 207: Recombinant Antibodies for Cancer Therapy Methods and Protocols (2003); Chapter 1; p 3-25, Kipriyanov). Antibody fragments can include multiple chains linked together, such as by disulfide bridges and can be produced recombinantly. Antibody fragments also can contain synthetic linkers, such as peptide linkers, to link two or more domains.

Any of these antibody fragments and others described herein or known in the art can be selected as target polypeptides for variation by the methods provided herein.

v. Domain Exchanged Antibodies

In one example, the target polypeptide is a domain exchanged antibody. Domain exchanged antibodies include antibodies such as full-length antibodies and antibody fragments, having a domain exchanged three-dimensional configuration, which is characterized by the pairing of V_{H} domains with opposite V_{L} domains (compared to pairing in conventional antibodies) and formation of an interface (V_{H}-V_{H}′ interface) between V_{H} domains (see, for example, Published U.S. Application, Publication No.: US20050003347). FIG. 7 shows a schematic comparison of an exemplary domain exchanged IgG antibody compared to an exemplary conventional full-length IgG antibody. In this exemplary full-length domain exchanged antibody, the heavy chains are interlocked (forming the V_{H}-V_{H}′ interface), causing the variable region of each heavy chain (V_{H} and V_{H}′, respectively) to pair with the variable region on the opposite light chain compared with the interactions between the constant regions (C_{H}-C_{L}). In one example, mutations in the heavy chain cause and/or stabilize the domain exchanged configuration. For example, mutations in the heavy chain joining region causes the heavy chains to interlock, forming the heavy chain interface. In another example, framework mutations along the V_{H}-V_{H}′ interface act to stabilize the domain-exchange configuration (see, for example, Published U.S. Application, Publication No.: US20050003347).

In conventionally structured IgG, IgD and IgA antibodies, the hinge regions between the C_{H}1 and C_{H}2 domains provide flexibility, resulting in mobile antibody combining sites that can move relative to one another to interact with epitopes, for example, on cell surfaces. In domain exchanged antibodies, by contrast, this flexible arrangement is not adopted; instead, the antibody combining sites are constrained. In one example, domain exchanged antibodies contain two conventional antibody combining sites and at least one non-conventional antibody combining site, which can be formed by residues of the VH-VH′ interface. In this example, the conventional and non-conventional antigen binding sites are in close proximity with one another and constrained in space, as illustrated in the exemplary IgG in FIG. 7.

In some examples, the domain exchanged antibodies specifically bind (such as, through constrained antibody combining sites) to epitopes within densely packed and/or repetitive epitope arrays, such as sugar residues on bacterial or viral surfaces. Exemplary of such epitopes are epitopes that tend to evolve, for example, in pathogens and tumor cells, as means for immune evasion, including, but not limited to, high density/repetitive epitope arrays contained within polysaccharides, carbohydrates, glycolipids, e.g. bacterial cell wall carbohydrates and carbohydrates and glycolipids displayed on the surfaces of tumor cells/tissues and/or viruses, such as epitopes on antigens not optimally recognized by conventional (non-domain exchanged) antibodies, i.e. because their high density and/or repetitiveness that makes simultaneous binding of both antibody-combining sites of a conventional antibody energetically disfavored. Thus, in some examples, domain exchanged antibodies can bind with high affinity to epitopes that are poorly recognized by conventional antibodies or to which conventional antibodies bind with low affinity. Thus, in some examples, domain exchanged antibodies are useful in targeting (e.g. therapeutically) poorly immunogenic antigens, such as antigens on bacteria, fungi, viruses and other infectious agents, such as drug-resistant agents (e.g. drug resistant microbes) and cancerous tissues, e.g. tumor cells.

Exemplary of domain exchanged antibodies is the 2G12 antibody, which includes the domain exchanged human monoclonal IgG1 antibody produced from the hybridoma cell line CL2 (as described in U.S. Pat. No. 5,911,989; Buchacher et al., AIDS Research and Human Retroviruses, 10(4) 359-369 (1994); and Trkola et al., Journal of Virology, 70(2) 1100-1108 (1996)), as well as any synthetically, e.g. recombinantly, produced antibody having the identical sequence of amino acids, and any antibody fragment thereof having identical heavy and light chain variable region domains to the full-length antibody, such as the 2G12 domain exchanged Fab fragment (see, for example, Published U.S. Application, Publication No.: US20050003347 and Calarese et al., Science, 300, 2065-2071 (2003), which contains a heavy chain (V_{H}-C_{H}1) having the sequence of amino acids set forth in SEQ ID NO: 269 (evqlvesggglvkaggsfilscgvsnfrisahtmnwvrrvpggglewvasistsstyrdyadavkgyftvsrddledfv ylqmhkmrvedtaiyycarkgsdrlsdndpfdawgpgtvvtvspastkgpsvfplapsskstsggtaalgclvkdyfp epvtvswnsgaltsgvhtfpavlqssglyslssvvtvpssslgtqtyicnvnhkpsntkvdkkvepks); and a light chain (VL) having the sequence of amino acids set forth in SEQ ID NO: 270 (vvmtqspstlsasvgdtititcrasqsietwlawyqqkpgkapklliykastlktgvpsrfsgsgsgteftltisglqfddfa tyhcqhyagysatfgqgtrveikrtvaapsvfifppsdeqlksgtasvvcllnnfypreakvqwkvdnalqsgnsqesv teqdskdstyslsstltlskadyekhkvyacevthqglsspvtksfnrge). 2G12 includes antibodies (such as fragments) having at least the antigen binding portions of the heavy chains of the monoclonal IgG1 (e.g. the sequence of amino acids set forth in SEQ ID NO: 13) and typically at least the antigen binding portion(s) of the light chain (e.g. the light chain having the sequence of amino acids set forth in SEQ ID NO: 14 or SEQ ID NO: 209) of nucleic acids set forth in 2G12 antibody specifically binds HIV gp120 antigen (the HIV envelope surface glycoprotein, gp120, GENBANK gi:28876544, which is generated by cleavage of the precursor, gp160, GENBANK g.i. 9629363). Also exemplary of the domain exchanged antibodies are 3-Ala 2G12 antibodies, including fragments thereof, which are modified 2G12 antibodies having three mutations to alanine in the amino acid sequence encoding the heavy chain antigen binding domain, rendering it non-specific for the cognate antigen (gp120) of the native 2G12 antibody. These and other domain exchanged antibody fragments are described in further detail in other sections herein.

Thus, domain exchanged antibodies, including domain exchanged antibody fragments, can be used as target polypeptides for variation using the provided methods to generate variant domain exchanged antibodies or antibody fragments. For example, a 3-ALA 2G12 or 2G12 target polypeptide can be used to generate variant antibody polypeptides that have the domain exchanged structure but have antigen specificity for other antigens, for example, antigens that may not be efficiently recognized/bound by conventional (non-domain exchanged) antibodies. In one example, the target polypeptide will have 100% identity to the amino acid sequence of the 3-ALA 2G12 or 2G12 antibody or a fragment thereof. In another example, the amino acid sequence of the target polypeptide can have one or more mutations, insertions, deletions, additions and/or substitutions compared to the amino acid sequence of the 3-ALA 2G12 antibody or fragment thereof, or a functional region, e.g. domain, thereof. In on example, a domain exchanged fragment of the 2G12 or the 3-ALA 2G12 antibody is the target polypeptide. In another example, a domain exchanged scFv fragment or other domain exchanged fragment, of the 3-ALA 2G12 or 2G12 antibody, or a functional region, e.g. domain, thereof, is the target polypeptide.

vi. Target Domains and Target Portions in Antibody Polypeptides

Any functional or structural antibody domain can be selected as a target domain. Exemplary of target antibody domains are variable region domains, constant region domains, antigen binding sites, heavy or light chain component of the antibody binding site and framework regions. Exemplary of target portions within the target antibody domains are CDRs and/or portions thereof and FRs and/or portions thereof. Other target portions can be selected. Alternatively, target portions can be selected at random along the length of the antibody polypeptide amino acid sequence.

b. Other Target Polypeptides

In addition to antibody polypeptides, other polypeptides can be targeted for variation using the methods provided herein. Generally, the methods can be used to vary the sequence of any polypeptide and are desirable in any situation where sequence diversity in a collection of polypeptides is advantageous. For example, target polypeptides that bind to particular binding partners, for example, receptors, ligands, substrates, enzymes, inhibitors or nucleic acid sequences, can be attractive targets. In one example, it can be desired to generate variant polypeptides with increased affinity for the binding partners compared to the target polypeptide. In another example, it can be desired to generate variant polypeptides with increased specificity to the binding partner compared to the target polypeptide, for example, to eliminate interactions with other molecules.

In another example, it can be desired to change the binding specificity of the target polypeptide, for example, to generate a collection of variant polypeptides from which to select novel polypeptides that can interact with a particular molecule. In this example, the target polypeptide is selected based on a general property, for example, a structural framework, and then used to generate a collection of variant polypeptides, from which polypeptides are selected based on a property that the target polypeptide itself does not possess. Exemplary of additional target polypeptides that can be targeted by the provided methods are antigens, epitopes, receptors, hormones, agonists, antagonists, mimics, zinc finger DNA binding proteins, proteases and substrates.

It is not necessary that a single target polypeptide be selected. More than one target polypeptide can be targeted using the provided methods. For example, the methods can be used to target one or more regions of an entire genome.

2. Polypeptide Target Domains, Target Portions and Target Positions

Generally, one or more target domains and/or target portions within the target polypeptide are selected for variation. A target domain is a domain within the target polypeptide, selected for variation based on one or more functional or structural characteristics. Exemplary of target domains are active sites, e.g. catalytic sites of enzymes; binding sites, such as, but not limited to, antigen binding sites; immunoglobulin domains, such as variable region domains and constant region domains; extracellular domains; transmembrane domains; DNA binding domains and inhibitory domains. The target domain can be a structural and/or functional domain. Other polypeptide domains known in the art can be selected. A target polypeptide can contain one or more target domains, and a target domain can include one, typically more than one, for example, 2, 3, 4, 5, 6, 7, 8, 9, 10, 15 or more target portions.

Target portions of the polypeptide are portions along the linear amino acid sequence of the polypeptide that are selected for variation by the methods. A target portion can contain one or more amino acids, for example, 1, 2, 3, 4, 5, 6, 8, 10, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50 or more amino acids of the target polypeptide, but fewer than all of the amino acids that make up the target polypeptide. A target portion can be a single amino acid position. Exemplary of target portions are portions within the CDRs of an antibody polypeptide variable region. A CDR target portion can encompass the entire sequence of the CDR or a portion thereof. Typically, two or more target portions are non-contiguous along the linear amino acid sequence, separated by portions that are not varied by the methods. Two or more non-contiguous target portions can be separated by about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 65, 70, 71, 72, 73, 74, 75, 80, 85, 90, 95, 100 or more amino acids. Two target CDR portions typically are separated by fewer than about 100 amino acids, typically fewer than about 65 amino acids, typically at least about 10 amino acids.

Variant portions in the collections of variant polypeptides vary in nucleic acid sequence compared to analogous portions in the other variant polypeptide members of the collection, and typically compared to the target portions in the target polypeptide.

3. Target Polynucleotides

Target polynucleotides are polynucleotides that include the sequence of nucleotides encoding a target polypeptide or a functional region of the target polypeptide (e.g. a chain of the target polypeptide), and optionally containing additional 5′ and/or 3′ sequence(s) of nucleotides (for example, non-gene-specific nucleotide sequences), for example, restriction endonuclease recognition site sequence(s), sequence(s) complementary to a portion of one or more primers, and/or nucleotide sequence(s) of a bacterial promoter or other bacterial sequence, or any other non gene-specific sequence. The target polynucleotide can be single or double stranded. Target portions within the target polynucleotide encode the target portions of the target polypeptide. With the provided methods, variant polynucleotides, for example, randomized oligonucleotides, randomized duplex oligonucleotide fragments and randomized oligonucleotide duplex cassettes are synthesized based on their identity and/or complementarity to target polynucleotide sequence. Exemplary of target polynucleotides are polynucleotides encoding antibody chains, and polynucleotides encoding antibodies, such as antibody fragments, including domain exchanged antibody fragments (for example, a target polynucleotide encoding a Fab fragment, for example, contained in a vector), antibody chains (e.g. heavy and light chains) and antibody domains (e.g. variable region domains, such as the heavy chain variable region).

In one example, the target polynucleotides are contained in vectors, for example in collections of polynucleotides, for example, collections of variant polynucleotides produced according to the provided methods. In one example, the target polynucleotide is cloned by amplifying coding nucleic acid(s) from cells expressing the target polypeptide, for example, by PCR. The target polynucleotide does not need to be produced physically in order to carry out the methods provided herein. For example, the nucleotide sequence of the target polynucleotide can be determined in silico for use in reference sequence design. In one example, the target polynucleotide is the entire coding sequence of a gene encoding the target polypeptide. In another example, it is a region of the gene coding sequence. In one example, in addition to the region encoding the target polypeptide, the target polynucleotide or the vector containing the target polynucleotide contains a portion or portions of non gene-specific nucleotide sequence or non-encoding sequence, for example, the nucleotide sequence of a bacterial promoter or portion thereof.

The nucleotide sequence of the target polynucleotide is used as a starting point in designing synthetic oligonucleotides that are used to generate collections of variant polynucleotides, for example nucleic acid libraries, that encode variant polypeptides. Generally, one, typically more than one, reference sequences are designed based on the nucleotide sequence of the target polynucleotide and the reference sequences are in turn used to design synthetic oligonucleotides. Generally, the reference sequence contains nucleotide sequence identity to a region of the target polynucleotide. Reference sequences typically are produced in silico. Target portions within the target polynucleotide are those portions of the nucleic acid that encode the target portions of the target polypeptide. Typically, these portions are targeted by using doping strategies in subsequent oligonucleotide synthesis methods.

### D. DESIGN AND SYNTHESIS OF OLIGONUCLEOTIDES

### 1. Synthetic Oligonucleotides

Synthetic oligonucleotides are used to generate the provided collections of variant polynucleotides and variant polypeptides, with the provided methods. The synthetic oligonucleotides can be chemically synthesized. Methods for chemical synthesis of oligonucleotides are well-known and involve the addition of nucleotide monomers or trimers to a growing oligonucleotide chain. Any of the known synthesis methods can be used to produce the oligonucleotides. Typically, oligonucleotides used in the provided methods are designed and ordered from a company or supplier, for example, Integrated DNA Technologies (IDT) (Coralville, Iowa) or TriLink Biotechnologies (San Diego, Calif.), which synthesize custom oligonucleotides using standard cyanoethyl chemistry (using phosphoramidite monomers and tetrazole catalysis (see, e.g. Behlke et al. “Chemical Synthesis of Oligonucleotides” Integrated DNA Technologies (2005), 1-12; and McBride and Caruthers Tetrahedron Lett. 24:245-248)). Automated synthesizers generally can synthesize oligonucleotides up to about 150 to about 200 nucleotides in length. Provided are methods for making variant polynucleotides that contain greater nucleotide length than a typical oligonucleotide, e.g. by assembling the synthetic oligonucleotides using steps, such as amplification, extension, hybridization, hybridization and/or restriction digest.

The synthetic oligonucleotides are synthesized in pools, each of which contains a plurality of oligonucleotide members. Each pool is synthesized using one reference sequence as a design template. In one example, all the oligonucleotides in the pool contain 100% identity with respect to the other oligonucleotides in the pool. In another example, the oligonucleotides in the pool are varied with respect to one another. Typically, the oligonucleotides in a pool contain at least some identity with respect to the other oligonucleotides in the pool. Typically, the oligonucleotides in a pool contain one or more, typically at least two, reference portions, which contain at least about 10 contiguous nucleotides, typically at least about 15 contiguous nucleotides, that are identical among the oligonucleotide members.

a. Nucleotides and Analogs

The nucleotide monomers used to synthesize oligonucleotides can be purine and pyrimidine deoxyribonucleotides (adenosine (A), cytidine (C), guanosine (G) and thymidine (T)) or ribonucleotides (A, G, C and U (uridine)), or they can analogs or derivatives of these nucleotides, such as peptide nucleic acid (PNA), phosphorothioate DNA, and other such analogs and derivatives or combinations thereof. Other nucleotide analogs are well known in the art and can be used in synthesizing the oligonucleotides provided herein.

b. Modifications

The oligonucleotides can be synthesized with modifications. In one example, each oligonucleotide contains a terminal phosphate group, for example, a 5′ phosphate group. For example, when it is desired to seal nicks between two adjacent oligonucleotides, e.g. following hybridization of the two oligonucleotides to a common opposite strand polynucleotide according to the methods herein, a 5′ phosphate group is added to the end of the oligonucleotide whose 5′ terminus will be joined with the 3′ terminus of another oligonucleotide to seal the nick. In one example, a 5′ phosphate (PO₄) group is added during oligonucleotide synthesis. In another example, a kinase, such as T4 polynucleotide kinase (T4 PK) is added to the oligonucleotide for addition of the 5′ phosphate group. Other oligonucleotide modifications are well-known and can be used with the provided methods.

c. Oligonucleotide Length

The synthetic oligonucleotides provided herein generally are less than 250 nucleotides in length, typically less than 150 nucleotides in length, for example 200, 190, 180, 170, 160, 150, 140, 130, 120, 110, 100, 95, 90, 85, 80, 75, 70, 65, 60, 55, 50, 45, 40, 35, 30, 25, 20, 15, 10 or fewer nucleotides in length. Typically, the oligonucleotides are at least about 10 nucleotides in length, for example, at least about 10, 15, 20, 25, 30, 35, 40, 45, 50, 55, 60, 65, 70, 75, 80, 90, 100, 110, 120 or more nucleotides in length.

These individual oligonucleotides typically are combined or assembled in subsequent steps to form assembled duplexes and/or duplex cassettes, which can be any length. In one example, the assembled duplexes or duplex cassettes are larger than any one of the individual synthetic oligonucleotides, for example, greater than about 20, 25, 30, 35, 40, 45, 50, 55, 60, 65, 70, 75, 80, 85, 90, 95, 100, 150, 200, 250, 300, 350, 400, 450, 500, 600, 700, 800, 900, 1000, 1500, 2000 or more nucleotides in length. Typically, more than one, typically more than two, for example, 3, 4, 5, 6, 7, 8, 9, 10, 15, 20 or more, oligonucleotides are assembled to form an assembled duplex cassette. Typically, the assembled duplex cassette is a large assembled duplex cassette, which contains more than about 50 nucleotides in length, for example, greater than about 50, 55, 60, 65, 70, 75, 80, 85, 90, 95, 100, 150, 200, 250, 300, 350, 400, 450, 500, 600, 700, 800, 900, 1000, 1500, 2000 or more nucleotides in length. In one example, the large assembled duplex cassettes contain the length of an entire coding region of a gene.

### 2. Design and Synthesis of Synthetic Oligonucleotides

A first step in oligonucleotide synthesis is designing the oligonucleotides. Design is related to target portions of the polypeptide that were selected for variation. Design involves determining which one or more nucleotide monomers will be included during synthesis of each individual position along the linear sequence of the oligonucleotide during synthesis. The oligonucleotides are synthesized in pools, each oligonucleotide within a single pool being designed based on one reference sequence. The pool of oligonucleotides contains a plurality of oligonucleotides. In one example, the pool of oligonucleotides contains at least at or about 10², 10³, 10⁴, 10⁵, 10⁶, 10⁷, 10⁸, 10⁹, 10¹⁰ or more oligonucleotide members.

The reference sequence is a contiguous sequence of nucleotides that shares identity with a region of the target polynucleotide and is used as a design template.

Individual oligonucleotides within a pool of oligonucleotides are not necessarily 100% identical to one another or to the reference sequence. For example, the sequences of oligonucleotides in a pool of randomized oligonucleotides vary compared to other oligonucleotides in the pool. In one example, when a plurality of oligonucleotide pools are synthesized for use in assembling duplex cassettes, the pools are designed based on reference sequences that are complementary or identical to overlapping and/or adjacent regions along the length of the sequence of the target polynucleotide, such that the resulting oligonucleotides can be assembled in an overlapping manner by hybridization through complementary regions shared among the different oligonucleotides.

Portions and regions within the oligonucleotides are designed, for example, variant portions, for example randomized portions; reference sequence portions; and complementary regions, for example, regions complementary to other oligonucleotides, for example, primers, or to assembly polynucleotides. The different portions and regions need not be mutually exclusive. For example, a region of complementarity can contain a reference sequence portion and/or a randomized portion. Typically, some of the oligonucleotides are positive strand oligonucleotides and some are negative strand oligonucleotides. Typically, oligonucleotides in a pool of positive strand oligonucleotides are complementary to oligonucleotides in one or more pools of negative strand oligonucleotides.

a. Reference Sequences

A reference sequence is a nucleic acid sequence that is used as a design template for a pool of synthetic oligonucleotides. Each reference sequence contains nucleic acid identity to a region of a target polynucleotide, as well as optional additional, deletions, insertions and/or substitutions compared to the region of the target polynucleotide. In one example, the region of the target polynucleotide, to which the reference sequence has identity, includes the entire length of the target polynucleotide. Typically, however, the region of the target polynucleotide, to which the reference sequence contains identity, includes less than the entire length of the target polynucleotide, but at least 2, typically at least 10, contiguous nucleotides of the target polynucleotide.

In one example, the reference sequence is 100% identical to the region of the target polynucleotide. In another example, the reference sequence is less than 100% identical to the region, such as at or about, or at least at or about, 99, 98, 97, 96, 95, 94, 93, 92, 91, 90%, or less, such as at or about or at least at or about 50%, 55%, 60%, 65%, 70%, 75%, 80%, or 85% identical to the region. In one example, the reference sequence contains a region that is identical to the region of the target polynucleotide and an additional region or portion that contains a non gene-specific sequence, or a non-encoding sequence, for example, a regulatory sequence, such as a bacterial leader sequence, promoter sequence, or enhancer sequence; a sequence of nucleotides that is a restriction endonuclease recognition site; and/or a sequence having complementarity to a primer, such as a CALX24 binding sequence. In some cases, the sequence of complementarity to a primer or other additional sequence overlaps with the region of the reference sequence having identity to the target polynucleotide. In one example, the reference sequence contains one or more target portions, each of which corresponds to all or part of a target region within the target polynucleotide to which the reference sequence is identical. Each reference sequence contains at least some nucleic acid identity to a region of the target polynucleotide.

Typically, positive and negative strand reference sequences are used to design positive and negative strand pools of oligonucleotides so that oligonucleotides within the pools can be specifically hybridized to generate oligonucleotide duplexes. In one example, more than one, typically more than two, for example, 3, 4, 5, 6, 7, 8, 9, 10, 15, 20 or more, reference sequences are used, each to design an individual pool of oligonucleotides that can be assembled to form an oligonucleotide duplex cassette using one of the assembly methods provided herein. Typically, the reference sequences are complementary to overlapping or adjacent regions along the linear sequence of the target polynucleotide.

The reference sequence is used as a template to determine which nucleotide monomer is added at each position during synthesis of the oligonucleotides. Thus, each oligonucleotide in a pool contains the same number of contiguous nucleotides in length as the reference sequence. The sequence of the oligonucleotides can be identical to the reference sequence (reference sequence oligonucleotides). Alternatively, they it be varied compared to the reference sequence (variant or randomized oligonucleotides).

During synthesis, at a single nucleotide position, the nucleotide monomer corresponding to the nucleotide at the analogous reference sequence position can be added. Such a position is a reference sequence position. Alternatively, a different nucleotide monomer, typically a mixture of different nucleotide monomers can be added during synthesis of the position using one of several doping strategies. In this example, the position is a variant position, typically a randomized position.

The reference sequence can contain one or more target portions, which correspond to target portions in the target polynucleotide. During oligonucleotide synthesis, each position corresponding to a position within the target portions typically is synthesized using a doping strategy, or using a nucleotide monomer that is different than the analogous position in the reference sequence. Thus, the reference sequence target portions correspond to variant, typically randomized portions created in the synthetic oligonucleotides.

In one example, the reference sequence exists only theoretically (e.g. in silico). In other words, in this example, no oligonucleotide containing the reference sequence of nucleotides is physically produced. It is not necessary that the reference sequence be physically produced to use it as a design template.

b. Methods for Oligonucleotide Synthesis

The synthetic oligonucleotides are produced by chemical synthesis. Methods for chemical synthesis of oligonucleotides are well-known and involve the addition of nucleotide monomers or trimers to a growing oligonucleotide chain. Typically, synthetic oligonucleotides are made by chemically joining single nucleotide monomers or nucleotide trimers containing protective groups. For example, phosphoramidites, single nucleotides containing protective groups, can be added one at a time. Synthesis typically begins with the 3′ end of the oligonucleotide. The 3′ most phosphoramidite is attached to a solid support and synthesis proceeds by adding each phosphoramidite to the 5′ end of the last. After each addition, the protective group is removed from the 5′ phosphate group on the most recently added base, allowing addition of another phosphoramidite.

Any of the known synthesis methods can be used to produce the oligonucleotides designed and used in the provided methods. Typically, oligonucleotides used in the methods provided herein are designed and then ordered from a company, for example, Integrated DNA Technologies (IDT) (Coralville, Iowa) or TriLink Biotechnologies (San Diego, Calif.), which synthesize custom oligonucleotides using standard cyanoethyl chemistry. Automated synthesizers generally can synthesize oligonucleotides up to about 150 to about 200 nucleotides in length.

c. Types of Synthetic Oligonucleotides

i. Reference Sequence Oligonucleotides

Exemplary of the synthetic oligonucleotides provided herein are reference sequence oligonucleotides. A reference sequence oligonucleotide contains a nucleic acid sequence that is identical to the reference sequence used as a design template for the pool of oligonucleotides, and in theory, contains 100% identity to the reference sequence. In one example, the reference sequence oligonucleotide contains 100% identity to the reference sequence. In another example, the reference sequence oligonucleotide contains less than 100% identity to the reference sequence, such as, for example, at or about or at least at or about 90%, 91%, 92%, 93%, 94%, 95%, 96%, 97%, 98% or 99% sequence identity to the reference sequence. For example, a pool of reference sequence oligonucleotides is a pool of oligonucleotides designed so that all of the oligonucleotides in the pool will be 100% identical to the reference sequence. It is understood, however, that a pool of oligonucleotides, designed as a pool of reference sequence oligonucleotides, can contain one or more oligonucleotides that, due to error during synthesis, is not 100% identical to the reference sequence.

ii. Variant Oligonucleotides

Also exemplary of the synthetic oligonucleotides provided herein are variant oligonucleotides. Variant oligonucleotides are oligonucleotides that vary in nucleic acid sequence compared to the reference sequence and/or compared to other oligonucleotides in a pool of variant oligonucleotides. The portions of the variant oligonucleotides that vary are variant portions, which are analogous to the target portions in the reference sequence. A pool of variant oligonucleotides can contain one or more reference sequence oligonucleotides. A pool of variant oligonucleotides can contain oligonucleotides that all have the same nucleic acid sequence. Typically, however, the individual oligonucleotides in a pool of variant oligonucleotides vary compared to other oligonucleotides in the pool. Variant oligonucleotides can be randomized oligonucleotides, which contain randomized portions.

a. Randomized Oligonucleotides

Exemplary of variant oligonucleotides are randomized oligonucleotides. Randomized oligonucleotides are synthesized in pools of randomized oligonucleotides by using one of several doping strategies in the synthesis of particular portions, called randomized portions, which are analogous among the oligonucleotides in the pool. Randomized oligonucleotides typically contain one or more, typically at least two, reference sequence portions, which are identical among the randomized oligonucleotides in the pool.

b. Oligonucleotides with Pre-Selected Mutations

Also exemplary of variant oligonucleotides are oligonucleotides with pre-selected mutations, where variant portions within the oligonucleotides contain one or more pre-determined nucleotide substitutions compared to the reference sequence.

iii. Positive and Negative Strand Oligonucleotides

Typically, the provided methods involve synthesis of one or more pools of positive strand oligonucleotides and one or more pools of negative strand oligonucleotides. Typically, each oligonucleotide within a pool of positive strand oligonucleotides contains a region of complementarity to a region in a negative strand oligonucleotide. In one example, the region of complementarity is over the entire length, or almost the entire length of the oligonucleotides. In another example, a plurality of positive and negative strand pools are synthesized and the oligonucleotide members contain shared regions of complementarity, e.g. one or more of the pools contains complementarity to multiple other pools. In this example, the oligonucleotides can be assembled to generate assembled duplex cassettes. In another example, one of the positive and negative strand oligonucleotides is a primer, for example, a fill-in primer, which primes synthesis of a complementary strand of a template oligonucleotide. In one example, a single oligonucleotide can be a template oligonucleotide and a primer. Positive and negative strand template and primer oligonucleotides provided herein, share regions of complementarity.

iv. Template Oligonucleotides

Exemplary of the oligonucleotides synthesized in the provided methods are template oligonucleotides. A template oligonucleotide is an oligonucleotide that is used as a template in a polymerase extension reaction that synthesizes nucleic acid sequence complementary to the template oligonucleotide sequence, for example, a fill-in reaction or single-primer extension reaction. Each template oligonucleotide contains a region that is complementary to a primer, for example, a fill-in primer or non gene-specific primer. In one example, the template oligonucleotides are at least about 80 nucleotides in length, for example, at least about 80, 85, 90, 95, 100, 110, 120, 130, 140, 150 or more nucleotides in length.

v. Oligonucleotide Primers

Also exemplary of the oligonucleotides synthesized as provided herein are oligonucleotide primers. An oligonucleotide primer is used in a polymerase reaction to prime synthesis of a sequence of nucleotides that is complementary to that of a template oligonucleotide or template polynucleotide.

Exemplary of oligonucleotide primers provided herein are fill-in primers and non gene-specific primers. A fill-in primer specifically hybridizes to a template oligonucleotide and primes a fill-in reaction, whereby a sequence of nucleotides complementary to the template strand is synthesized, thereby generating an oligonucleotide duplex. A single oligonucleotide can be a template oligonucleotide and a primer. For example, two oligonucleotides, sharing a region of complementarity, can participate in a mutually primed fill-in reaction, whereby one oligonucleotide primes synthesis of the complementary strand of the other nucleotide, and vice versa. In a mutually primed fill-in reaction, each of two oligonucleotides serves as a fill-in primer to prime synthesis of a strand complementary to the other oligonucleotide. Thus, the two oligonucleotides are template oligonucleotides and fill-in primers. The two oligonucleotides share at least one region of complementarity. A mutually-primed synthesis reaction can one oligonucleotide serves as a fill-in primer for the other oligonucleotide and vice versa.

A non gene-specific primer primes an extension reaction by binding to a portion of a variant or target polynucleotide analogous to a portion of the target polynucleotide that does not encode the target polypeptide, for example, a bacterial leader sequence. In one example, the non gene-specific primer binds to a non gene-specific portion of a polynucleotide, for example, an intermediate duplex generated by assembling a plurality of randomized oligonucleotides, and primes synthesis of the complementary strand of the polynucleotide to create a duplex, typically an assembled duplex.

vi. Oligonucleotides Containing Non Gene-Specific Regions

Also exemplary of oligonucleotides provided herein are oligonucleotides containing non gene-specific regions, e.g. non gene-specific oligonucleotides. These oligonucleotides contain nucleic acids that do not encode proteins, e.g. do not encode the target polypeptide. Exemplary of the non gene-specific oligonucleotides are oligonucleotides containing sequence identity to a region of the target polynucleotide that does not encode the target polypeptide, for example, the sequence of nucleotides of a bacterial promoter or bacterial leader sequence. In one example, the non gene-specific region is complementary or identical to a non gene-specific primer, such as a single primer pool.

d. Purification of Synthetic Oligonucleotides

The synthesized oligonucleotides can be purified by a number of well-known methods, for example, high-performance liquid chromatography (HPLC), thin layer chromatography (TLC), PolyAcrylamide Gel Electrophoresis (PAGE) and desalting. Typically, larger oligonucleotides, for example, oligonucleotides comprising greater than about 50 nucleotides in length or greater than about 40 nucleotides in length, are purified. Purification, being an added step to the synthesis process, has the potential to create a bias for or against particular sequences in a pool of oligonucleotides containing varied sequences, for example in pools of randomized oligonucleotides. Thus, randomized pools of oligonucleotides typically are not purified. Thus, the randomized oligonucleotides typically contain less than about 50 nucleotides in length, for example, less than about 50, 45, 40, 35, 30, 25, 20, 15 or fewer nucleotides in length.

e. Pools of Randomized Oligonucleotides

Randomized oligonucleotides are synthesized in pools using one or more doping strategies to introduce nucleotide monomers at random during synthesis to particular positions within randomized portions. Thus, the pools of oligonucleotides contain a number of oligonucleotides having diverse sequences. Each randomized oligonucleotide in the pool contains one or more randomized portions, where the randomized portions are analogous. The randomized oligonucleotides also contain one or more, typically two or more, reference sequence portions, which typically are identical among the oligonucleotides in the pool. Each randomized portion of the individual randomized oligonucleotides varies, to some extent, compared to analogous portions within the reference sequence and/or with the randomized portion within the other oligonucleotides in the pool. For each randomized portion, however, one or more individual randomized oligonucleotide members within a pool of randomized oligonucleotides can have a nucleic acid sequence that is identical to the analogous portion of a reference sequence.

i. Doping Strategies

Biased and non-biased doping strategies can be used during synthesis of randomized portions in pools of randomized oligonucleotides. In non-biased doping strategies, each of a plurality of nucleotides or tri-nucleotides is present at an equal proportion during synthesis of each nucleotide or tri-nucleotide position. In biased doping strategies, particular nucleotide monomers or codons are included at different frequencies than others, thus biasing the sequence of the randomized portions within a collection towards a particular sequence within the randomized portions.

a. Non-Biased Randomization

Non-biased randomization is carried out using a non-biased doping strategy where each of a plurality of nucleotide monomers or trimers are added at equal percentages during synthesis of the randomized position. Exemplary of a non-biased doping strategy is one (e.g. “N” or “NNN”) whereby each of the four nucleotide monomers (A, G, T and C) is added at an equal proportion during synthesis of each nucleotide position in a randomized portion. The strategy can lead to equal frequency of each nucleotide monomer at each randomized position within the collection synthesized using this strategy. Non-biased doping strategies using an equal ratio of each of the nucleotide monomers can be undesirable, as they lead to a relatively high frequency of stop codon incorporation compared to some biased strategies. Because there are sixty-four possible combinations of tri-nucleotide codons, which encode only twenty amino acids, redundancy exists in the nucleotide code. Different amino acids have a more redundant code than others. Thus, non-biased incorporation of nucleotides will not result in an equal frequency of each of the twenty amino acids in the encoded polypeptide. If an equal frequency of amino acids is desired, a non-biased doping strategy using equal ratios of a plurality of tri-nucleotide units, each representing one amino acid, can be employed.

b. Biased Randomization

In biased randomization, a doping strategy is used in synthesis of the randomized positions to incorporate particular nucleotides or codons at different frequencies than others, biasing the sequence of the randomized portions towards a particular sequence. For example, the randomized portion, or single nucleotide positions within the randomized portion, can be biased towards a reference nucleotide sequence or the coding sequence of a target polynucleotide. Biasing positions towards a reference nucleotide sequence means that, within a collection of randomized oligonucleotides, the nucleotides or codons used in the reference sequence at those nucleotide positions would be more common than other nucleotides or codons. Doping strategies also can be biased to reduce the frequency of stop codons while still maintaining a possibility for saturating randomization. Alternatively, the doping strategy can be non-biased, whereby each nucleotide is inserted at an equal frequency.

Exemplary of biased doping strategies used herein are NNK, NNB and NNS, and NNW; NNM, NNH; NND; NNV doping strategies and an NNT, NNA, NNG and NNC doping strategy. In an NNK doping strategy, randomized portions of positive strands are synthesized using an NNK pattern and negative strand portions are synthesized using an MNN pattern, where N is any nucleotide (for example, A, C, G or T), K is T or G and M is A or C. Thus, using this doping strategy, each nucleotide in the randomized portion of the positive strand is a T or G. This strategy typically is used to minimize the frequency of stop codons, while still allowing the possibility of any of the twenty amino acids (listed in table 2) to be encoded by trinucleotide codons at each position of the randomized portion among the randomized oligonucleotides in the pool. Similarly, for the NNB doping strategy, an NNB pattern is used, where N is any nucleotide and B represents C, G or T. For the NNS doping strategy, an NNS pattern is used, where N is any nucleotide and S represents C or G. In an NNW doping strategy, W is A or T; in an NNM doping strategy, M is A or C; in an NNH doping strategy, H is A, C or T; in an NND doping strategy, D is A, G or T; in an NNV doping strategy, G is A, G or C. An NNK doping strategy minimizes the frequency of stop codons and ensures that each amino acid position encoded by a codon in the randomized portion could be occupied by any of the 20 amino acids. With this doping strategy, nucleotides were incorporated using an NKK pattern and a MNN pattern, during synthesis of the positive and negative strand randomized portions respectively, where N represents any nucleotide, K represents T or G and M represents A or C. An NNT strategy eliminates stop codons and the frequency of each amino acid is less biased but omits Q, E, K, M, and W. Other doping strategies include all four nucleotide monomers (A, G, C, T), but at different frequencies. For example, a doping strategy can be designed whereby at each position within the randomized portion, the sequence is biased toward the wild-type sequence or the reference sequence. Other well-known doping strategies can be used with the methods provided herein, including parsimonious mutagenesis (see, for example, Balint et al., Gene (1993) 137(1), 109-118; Chames et al., The Journal of Immunology (1998) 161, 5421-5429), partially biased doping strategies, for example, to bias the randomized portion toward a particular sequence, e.g. a wild-type sequence (see, for example, De Kruif et al., J. Mol. Biol., (1995) 248, 97-105), doping strategies based on an amino acid code with fewer than all possible amino acids, for example, based on a four-amino acid code (see, for example, Fellouse et al., PNAS (2004) 101(34) 12467-12472), and codon-based mutagenesis and modified codon-based mutagenesis (See, for example, Gaytán et al., Nucleic Acids Research, (2002), 30(16), U.S. Pat. Nos. 5,264,563 and 7,175,996).

ii. Saturating Randomization

Synthesizing pools of randomized oligonucleotides can be used to achieve saturating mutagenesis or saturating randomization of portions within collections of variant polypeptides. Saturating randomization means that for each position or tri-nucleotide portion within the randomized portion, each of a plurality of nucleotides or tri-nucleotide combinations is incorporated at least once within the collection of randomized oligonucleotides. Exemplary of a collection of randomized oligonucleotides displaying saturating randomization is one where, within the entire collection, each of the sixty-four possible tri-nucleotide combinations that can be made by the four nucleotide monomers is incorporated at least once at a particular codon position of a particular randomized portion. In another example of a collection of randomized oligonucleotides made by saturating randomization, each of the sixty-four possible tri-nucleotide combinations is incorporated at least once at each tri-nucleotide position over the length of the randomized portion. In another example of a collection of randomized oligonucleotides made by saturating randomization, a tri-nucleotide combination encoding each of the twenty amino acids is incorporated at least once at a particular codon position or at each codon position along the randomized portion. Also exemplary of a collection of oligonucleotides displaying saturating randomization is one where each nucleotide is incorporated at least once at every nucleotide position or at a particular nucleotide position over the length of the randomized portion within the collection of oligonucleotides. Saturation is typically advantageous in that it increases the chances of obtaining a variant protein with a desired property. The desired level of saturation will vary with the type of target polypeptide, the length and number of randomized portion(s) and other factors.

On the other hand, non-saturating randomization means that fewer than all of a particular number of nucleotide or tri-nucleotide combinations are represented at a particular position or tri-nucleotide portion within the randomized portion within the pool of oligonucleotides. For example, non-saturating randomization of a particular tri-nucleotide position might incorporate only 2, 3, 4, 5, 6, 7, 8, 9, 10 or more, but not all the possible, tri-nucleotide combinations at that position within the collection of randomized oligonucleotides. Substitution mutagenesis, where pre-selected mutations are made by replacing one nucleotide or tri-nucleotide unit with one other pre-selected nucleotide or tri-nucleotide unit are non-saturating and also can be used to create variant portions of oligonucleotides in the methods provided herein.

iii. Plurality of Pools of Oligonucleotides

In one example of the provided methods, a plurality of pools of oligonucleotides is synthesized so that an oligonucleotide from each pool can be assembled to form an assembled duplex in a subsequent step. In this example, the regions to which reference sequences used to design the individual pools are complementary to the target polynucleotide typically are overlapping or adjacent along the sequence of the target polynucleotide. By extension, the oligonucleotides from the individual pools have shared regions of complementarity to one another, e.g. where oligonucleotides in one of the pools contain regions of complementarity to oligonucleotides in more than one of the other pools.

f. Portions/Regions within Oligonucleotides

i. Reference-Sequence Portions

The oligonucleotides synthesized in the methods herein contain at least one, typically at least two, reference sequence portions. A reference sequence portion of a synthetic oligonucleotide is a portion containing sequence identity, theoretically 100% sequence identity, to a portion of the reference sequence that was used to design the oligonucleotide. An oligonucleotide made entirely of reference sequence portion is called a reference sequence oligonucleotide. It is understood that due to error in synthesis, the reference sequence portion of an oligonucleotide in a pool can contain less than 100% identity to the reference sequence. Randomized oligonucleotides contain reference sequence portions in addition to randomized portions. The reference sequence portions are non-randomized and are not synthesized with doping strategies. Typically, each oligonucleotide contains at least one reference sequence portion at its 5′ end, at least one reference sequence portion at its 3′ terminus, or at least one reference sequence portion at the 5′ and 3′ termini. Typically, each of the 3′ and 5′ reference sequence portions contains at least about 10 nucleotides in length, for example, at least about 10, 11, 12, 13, 14, 15, 16, 17, 18, 19, 20, 21, 22, 23, 24, 25, 30, 35, 40, 45, 50 or more nucleotides in length. The oligonucleotides also can contain additional reference sequence portions within the oligonucleotide in addition to the 3′ and 5′ reference sequence portions. In one example, the reference sequence portions facilitate duplex formation through hybridization of complementary strands. In another example, the reference sequence portion contains complementarity to a primer, for example, a fill-in primer, which can be used to extend multiple oligonucleotides.

ii. Variant Portions

Variant oligonucleotides, for example, randomized oligonucleotides, contain variant portions. The variant portion is a portion of the oligonucleotide having altered nucleic acid sequence compared to an analogous portion of a reference sequence or compared to an analogous portion in one or more other oligonucleotides within a pool of variant oligonucleotides. Typically, each variant portion within the oligonucleotides corresponds to a target portion within the reference sequence, which corresponds to all or part of a target portion of the target polynucleotide. Typically, the variant portions of the oligonucleotides are randomized portions.

a. Randomized Portions

Randomized oligonucleotides have one or more randomized portion. A randomized portion of an oligonucleotide is a of variant portion that varies compared to analogous portions in a plurality of other members of a pool of randomized oligonucleotides, and typically compared to an analogous target portion in the reference sequence, and is synthesized using one of a number of doping strategies. A plurality of different nucleotide sequences are represented at a particular randomized portion among the plurality of individual oligonucleotide members in the collection. A randomized portion that varies compared to an analogous portion will not necessarily vary at every nucleotide position within the portion. For example, a randomized portion that is five nucleotides in length can vary at all five nucleotide positions compared to the reference sequence. Alternatively, it can vary at only 1, 2, 3 or 4 of the positions.

The randomized portion can contain a single nucleotide or a plurality of contiguous nucleotides, and typically is 1, 2, 3, 4, 5, 6, 7, 8, 9, 10, 11, 12, 13, 14, 15, 20, 25, 30, 35, 40, 45, 50, 75, 80, 90, 100 or more nucleotides, such as, for example, a portion of a nucleic acid molecule that encodes a portion of a polypeptide domain, for example a target domain. Randomization of a randomized portion or position within a randomized portion can be saturating or non-saturating within a collection of randomized oligonucleotides. Along the length of a randomized portion of an oligonucleotide, some positions can be randomized with saturating randomization and others with non-saturating randomization. Similarly, if one randomized portion within an oligonucleotide is saturated, another randomized portion within the same oligonucleotide can be non-saturated. Similarly, multiple randomized portions along the length of an oligonucleotide can be synthesized using different doping strategies. Randomized portions in the oligonucleotide correspond to randomized portions in the collection of variant polynucleotides produced in subsequent steps of the methods.

iii. Complementary Regions

Typically, the synthetic oligonucleotides contain regions of complementarity to regions in other oligonucleotides or polynucleotides used in the methods. For example, a positive strand oligonucleotide typically contains at least one region of complementarity to a negative strand oligonucleotide synthesized in a separate oligonucleotide pool. These regions of complementarity are used in subsequent steps to specifically hybridize the oligonucleotides and create duplexes.

In one example, the oligonucleotides in a plurality of pools contain regions of complementarity with one another. These regions of complementarity are used to assemble the oligonucleotides to form assembled duplexes and assembled duplex cassettes, for example, in RCMA, OFMA and DOLSPA. The oligonucleotides also can contain regions of complementarity to primers, for example, fill-in primers or non gene-specific primers, which can be used to prime extension reactions to synthesize complementary strands.

The regions of complementarity and various portions within the oligonucleotide are not necessarily mutually exclusive. For example, in a positive strand oligonucleotide, the region of complementarity to a negative strand oligonucleotide can contain reference sequence and randomized portions. In another example, the region of complementarity can include only reference sequence portions.

The regions of complementarity need not be 100% complementary. The complementary regions typically are greater than at or about 50%, 55%, 60% or 65% complementary, typically greater than 70% complementary, for example, greater than about 70%, 75%, 80%, 85%, 90%, 95%, 96%, 97%, 98%, 99%, or more complementary. In one example, they are 100% complementary. It is understood that degree of complementarity will affect the parameters of hybridization conditions necessary for specific hybridization of complementary nucleic acid molecules. These parameters can be determined by well-known methods. Typically, for specific hybridization of a synthetic oligonucleotide to another polynucleotide, particularly to another oligonucleotide, the synthetic oligonucleotide contains a 5′ and a 3′ region complementary to the other polynucleotide. Typically, each of the 5′ and the 3′ regions of complementarity contains at least about 10 nucleotides in length, for example, at least about 10, 11, 12, 13, 14, 15, 16, 17, 18, 19, 20, 21, 22, 23, 24, 25 or more nucleotides in length.

iv. Regions for Compatibility with Vector Insertion and Downstream Applications

The synthetic oligonucleotides can contain regions to facilitate insertion of oligonucleotide duplex cassettes into vectors in subsequent steps. For example, an oligonucleotide can contain the nucleotide sequence recognized by a restriction endonuclease. For example, a positive strand oligonucleotide with a 5′ portion that is complementary to the 3′ portion of a negative strand oligonucleotide may contain an additional sequence of nucleotides that is located in the 5′ direction of the region that is complementary to the negative strand. In this example, the region of additional sequence can form a restriction site overhang or “sticky end” when the positive and negative strand oligonucleotides are hybridized. This sticky end overhang can be used to insert the duplex into a vector that has been cut with the restriction endonuclease that cuts at that particular sequence.

Alternatively, the oligonucleotides can contain regions with restriction endonuclease recognition sequences (restriction sites), such that, upon hybridization of two complementary oligonucleotides, the resulting duplex can be cut with restriction endonucleases to generate duplex cassettes that can be inserted into vectors.

### E. GENERATION OF ASSEMBLED DUPLEXES AND DUPLEX CASSETTES

In the methods provided herein, the synthetic oligonucleotides are used to generate assembled polynucleotide duplexes and assembled duplex cassettes. The assembled duplex cassettes can be ligated into vectors and, in some examples, are generated from assembled duplexes by restriction digestion.

The provided assembled duplexes and duplex cassettes can be any length. Typically, the assembled duplexes contain a nucleotide length that is greater than a typical synthetic oligonucleotide, e.g. greater than at or about 50, 55, 60, 65, 70, 75, 80, 85, 90, 95, 100, 150, 200, 250, 300, 350, 400, 450, 500, 600, 700, 800, 900, 1000, 1500, 2000 or more nucleotides. Exemplary of assembled duplexes and duplex cassettes formed using the provided methods are large assembled duplexes and cassettes, which are greater than at or bout 50 nucleotides in length, for example, greater than at or about 50, 55, 60, 65, 70, 75, 80, 85, 90, 95, 100, 150, 200, 250, 300, 350, 400, 450, 500, 600, 700, 800, 900, 1000, 1500, 2000 or more nucleotides in length. In one example, the large assembled duplex cassettes contain the length of an entire coding region of a gene. Typically, the assembled duplexes and/or duplex cassettes have one, typically more than one, for example, 2, 3, 4, 5, 6, 7, 8, 9, 10, 15, or more variant portions, which can be randomized portions. In one example, the assembled duplexes and/or duplex cassettes contain two or more variant (e.g. randomized) portions that are separated by at least at or about 50, 60, 70, 80, 90, 100, 110, 120, 130, 140, 150, 175, 200, 250, 500, 1000, 2000 or more nucleotides. Provided herein are a plurality of approaches for generating collections os assembled duplexes and collections of assembled duplex cassettes.

Generally, the assembled duplex cassettes are formed by using the oligonuclotides and/or polynucleotides in steps, such as assembly steps, which can include hybridization, sealing of nicks, such as by ligation, complementary strand synthesis, such as in a polymerase reaction, such as by amplification, e.g. PCR. In some examples, the assembled duplex cassettes, which contain overhangs, are produced without a restriction digest step. In other examples, assembled duplex cassettes are generated by first generating assembled duplexes containing restriction sites and incubating the assembled duplexes with one or more restriction endonucleases to produce restriction site overhangs.

Generally, the assembled duplexes and assembled duplex cassettes are formed by incubating one or more pools of synthetic oligonucleotides and/or duplexes (with or without other polynucleotides, e.g. duplexes), under conditions that promote hybridization through complementary regions (e.g. shared complementary regions or complementary overhangs), performing polymerase reactions, e.g. amplification, fill-in reaction, and/or single-primer extension using the polynucleotides, and/or providing one or more enzymes, for example, ligases, restriction endonucleases or other enzymes.

In one example (e.g. RCMA), described in further detail in section E(1), below, assembled duplex cassettes are formed without restriction digest, by combining pools of positive strand oligonucleotides and pools of negative strand oligonucleotides under conditions whereby oligonucleotides in the different pools specifically hybridize through complementary regions, and typically, whereby nicks are sealed, e.g. by providing a ligase. This process generates assembled duplex cassettes that can be ligated into vectors.

In another example (e.g. OFIA), described in section E(2), below, assembled duplexes are produced by performing one or more polymerase extension reactions with the synthetic oligonucleotides, e.g. fill-in reactions, whereby complementary strands are synthesized, thereby forming oligonucleotide duplexes, which then typically are digested with restriction endonucleases that recognize sites at the termini of the duplexes. The digested duplexes then are incubated under conditions whereby they hybridize through restriction site overhangs. In one example, the fill-in reaction is a mutually-primed fill-in reaction, where individual oligonucleotides serve as primers and as template oligonucleotides and complementary strands of each oligonucleotide are produced. In another example, the fill-in reaction is a single extension fill-in reaction, where one primer is used to prime synthesis of the complementary strand of one template oligonucleotide. Mutually primed and single-extension fill-in reactions can be performed in combination to generate a collection of assembled duplexes.

In another example (DOLSPA), described in section E(3), below, duplexes are formed (as in RCMA) by combining pools of positive strand oligonucleotides and pools of negative strand oligonucleotides under conditions whereby oligonucleotides in the different pools specifically hybridize through complementary regions, and typically, whereby nicks are sealed, e.g. by providing a ligase. In DOLSPA, the duplexes are intermediate duplexes, which then are used as templates in an amplification reaction, such as a single primer amplification reaction, to form a collection of assembled duplexes. In one example, the assembled duplexes then are cut with restriction endonucleases that recognize sites within the assembled duplexes, to generate a collection of assembled duplex cassettes.

In another example (e.g. FAL-SPA), described in section E(4), below, pools of variant (e.g. randomized) duplexes are generated by performing amplification reactions using pools of variant (e.g. randomized) oligonucleotide templates; and pools of reference sequence and scaffold duplexes are generated by performing amplification reactions where the target polynucleotide is the template. After the pools of duplexes are generated, a collection of intermediate duplexes is produced by combining the variant, reference sequence and scaffold duplexes, whereby polynucleotides of the duplexes hybridize, typically through shared complementary regions. In this process, polynucleotides of different duplex pools are brought into proximity with one another by hybridization to the scaffold duplex polynucleotide. Typically, nicks between the adjacent polynucleotides are sealed, e.g. by a ligase. A 5′ phosphate group at the terminus of the polynucleotides allows sealing of the nicks by a ligase. Typically, the intermediate duplexes then are denatured and used in a polymerase, e.g. amplification, reaction, to produce a collection of assembled duplexes. The amplification typically is performed with a single primer pool. As with the other methods, in one example, the assembled duplexes can be digested to form duplex cassettes.

In another example (mFAL-SPA), described in section E(5), pools of oligonucleotide duplexes (e.g. randomized duplexes) are generating by hybridizing positive and negative strand pools of oligonucleotides. The duplexes contain overhangs, typically restriction site overhangs. Pools of reference sequence duplexes are generated by amplification of a target polynucleotide, typically using primers with restriction endonuclease cleavage sites. In one example, the restriction sites are compatible with the overhangs in the oligonucleotide (e.g. randomized) duplexes. The pools of reference sequence duplexes are digested with restriction endonucleases, to form overhangs, which are compatible with the overhangs in the oligonucleotide (e.g. randomized) duplexes. The pools of duplexes with compatible overhangs then are combined to form a collection of intermediate duplexes, under conditions whereby they hybridize through complementary regions in the overhangs. The intermediate duplexes then are used to form a collection of assembled duplexes by amplification, e.g. a single primer amplification. In one example, the assembled duplexes are digested with a restriction endonuclease to form assembled duplex cassettes.

1. Direct Formation of Duplex Cassettes by hybridizing positive and Negative Strand Oligonucleotides and Sealing Nicks (RCMA)

In one example, the oligonucleotide duplex cassettes are generated directly by hybridization of positive and negative strand oligonucleotides (without using restriction endonuclease digestion and without an amplification step, such as a low-fidelity PCR). The absence of low-fidelity amplification step, and the relatively few steps in general, can reduce the chances that unwanted mutations will be introduced during production of the duplexes and of the libraries. By assembling multiple oligonucleotides (e.g. with shared regions of complementarity), these methods can be used to introduce mutations in (e.g. randomize) multiple, non-contiguous regions, such as non-contiguous regions separated by a large number of nucleotides in length, such as at least at or about 50, 100, 150, 200, 250, 500 or more nucleotides in length. Exemplary of the provided direct approaches for generating duplex cassettes by hybridization and sealing nicks is random cassette mutagenesis and assembly (RCMA) (illustrated in FIG. 1).

In RCMA, assembled duplex cassettes, for example, large assembled cassettes, are produced by overlapping hybridization of oligonucleotides through regions of complementarity and sealing nicks. Typically, oligonucleotides from three or more, typically four or more, pools of oligonucleotides (such as combinations of reference sequence and randomized pools of oligonucleotides) are hybridized through regions of complementarity in a hybridization step, followed by sealing of nicks between the assembled oligonucleotides (e.g. with a ligase), thereby generating an assembled duplex cassette.

a. Design of Oligonucleotide Pools with Regions of Complementarity

In RCMA, pools of oligonucleotides are designed such that oligonucleotides in each of the pools contain regions of complementarity to regions in oligonucleotides in an opposite strand pool. Typically, each oligonucleotide in each pool contains at least region of complementarity to at least one oligonucleotide in at least one other pool. Some of the oligonucleotides have regions complementary to oligonucleotides in more than one other pools, which can allow overlapping assembly as shown in FIG. 1. Each oligonucleotide in at least one of the pools is complementary to oligonucleotides in two or more opposite strand oligonucleotide pools, through two or more regions of complementarity. It is not necessary that each of the pools contains oligonucleotides with regions of complementarity to more than one other pool. For example, one, typically two, of the pools contains oligonucleotides with complementarity to oligonucleotides in only one other oligonucleotide pool. Typically, oligonucleotides from these pools form the termini of the assembled duplex cassettes upon assembly.

The plurality of pools of oligonucleotides can include pools of reference sequence oligonucleotides, pools of variant oligonucleotides, such as randomized oligonucleotides, and typically includes a combination thereof. For example, FIG. 1A illustrates five positive strand and five negative strand oligonucleotide pools designed for assembly of a duplex cassette using RCMA. In this particular example, shown in FIG. 1, four of the oligonucleotide pools are randomized oligonucleotide pools (illustrated as open boxes with hatched portions representing randomized portions), while six of the pools are reference sequence oligonucleotide pools (illustrated as open boxes). In this example, oligonucleotides in one positive strand pool (left-most upper oligonucleotide in FIG. 1) and one negative strand pool (right-most lower oligonucleotide in FIG. 1) contain complementarity to oligonucleotides in only one other pool. Other pools illustrated in FIG. 1 contain oligonucleotides having multiple regions of complementarity, to regions of oligonucleotides in more than one other oligonucleotide pool.

The regions of complementarity can contain randomized portions, reference sequence portions or randomized and reference sequence portions. For hybridization, the regions of complementarity are not necessarily 100% complementarity, but typically are greater than at or about 50%, 55%, 60% or 65% complementary, typically at least at or about 70% complementary, for example, greater than about 70%, 75%, 80%, 85%, 90%, 95%, 96%, 97%, 98%, 99%, or more complementary. In one example, the regions of complementarity are 100% complementary to one another.

b. Overhangs

Typically, in addition to regions of complementarity, each oligonucleotide within at least one, typically within at least two, of the pools, has a region containing an additional sequence of nucleotides at the 3′ or 5′ terminus, in the 3′ or 5′ direction from a complementary region respectively, that are not complementary to another oligonucleotide. Upon hybridization of these oligonucleotides as described in section (c) below, these regions form overhangs or “sticky ends,” such as restriction site overhangs, in the assembled duplexes, which can facilitate insertion of the duplexes into vectors, such as vectors that have been cut with the restriction endonuclease that recognizes the restriction site and generates compatible overhangs. Alternatively, the overhangs can be formed by cutting assembled duplexes (not containing overhangs) with one or more restriction endonuclease subsequent to assembly, to generate assembled duplex cassettes.

c. Assembly by Hybridization Through Regions of Complementarity and Sealing Nicks

As shown in the example illustrated in FIG. 1B, the plurality of oligonucleotide pools, having regions of complementarity, is incubated under conditions whereby positive and negative strand oligonucleotides anneal through complementary regions. For this step of the methods, generally, pools of oligonucleotides are combined under conditions whereby they hybridize through complementary regions, for example, in the presence of a hybridization buffer, and heated to temperatures that favor specific hybridization of complementary nucleic acid molecules. In one example, such as when pools of randomized oligonucleotides are used, the positive and negative strand oligonucleotide pools are mixed at a 1:1 molar ratio. Mixing the randomized pools at molar equivalents can reduce bias toward particular randomized sequence(s). In another example, the pools are mixed at non-equivalent molar ratios, e.g. 3:1 or 2:1 molar ratio.

Hybridization techniques are well-known. It is understood that optimal hybridization conditions, including temperature, buffer components and time of incubation, vary depending on parameters such as length of oligonucleotides, degree of complementarity and nucleic acid composition of the molecules. An exemplary hybridization buffer is STE buffer, which contains 10 mM Tris PH 8.0, 50 mM NaCl, 1 mM EDTA. Multiple methods for hybridizing complementary nucleic acid molecules are well-known. Any of these methods can be used with the methods provided herein to specifically hybridize oligonucleotides.

In one example, the hybridization is carried out at between about 90° C. and about 95° C., typically for about five minutes, followed by slow cooling, such as slow cooling to 50° C. or to room temperature, for example, to 25° C. Exemplary of slow cooling is placing the sample at a temperature, for example, at room temperature (e.g. between at or about 50° C. and 25° C.) for a period of time, such as between at or about 4 hours to at or about 24 hours, for example, at or about 4, 5, 6, 7, 8, 9, 10, 11, 12, 13, 14, 15, 16, 17, 18, 19, 20, 21, 22, 23 or 24 hours, typically between at or about 4 hours and overnight. This slow cooling can be used to increase the likelihood that nucleic acid molecules with a high degree of complementarity (e.g. at or about 100% complementarity) will hybridize without (e.g. before) hybridization of mismatched sequences, reducing the likelihood of generating duplexes with mismatched sequences and bias toward particular randomized sequences.

Simultaneous with or subsequent to hybridization of the oligonucleotides, nicks (indicated with arrows in FIG. 1B) are sealed between the hybridized oligonucleotides (e.g. between the 5′ and 3′ termini of adjacent oligonucleotides). In one example, oligonucleotides are incubated under conditions whereby they hybridize and nicks are sealed; in another example, after hybridization, the hybridized oligonucleotides are incubated under conditions whereby nicks are sealed between adjacent oligonucleotides.

Typically, the nicks are sealed using a ligase, such as, but not limited to, a thermostable ligase. The ligase mediates the formation of phosphodiester bonds between adjacent 3′-OH and 5′-phosphate ends of the nick (e.g. joining 3′ and 5′ termini of adjacent oligonucleotides), thereby sealing the nicks and forming an assembled duplex cassette. Thus, in order to seal nicks using a ligase, a phosphate (PO₄) group is included at the 5′ end of any oligonucleotide that will be joined with the 3′ end of the adjacent oligonucleotide to seal the nick. In one example, the 5′ phosphate group is added during oligonucleotide synthesis; the oligonucleotides can be designed and then the designed oligonucleotides purchased with phosphate groups at their 5′ termini. In another example, a kinase, such as T4 polynucleotide kinase (T4 PK) is added to a previously synthesized oligonucleotide under conditions whereby a 5′ phosphate group is added.

In one example of ligation to seal the nicks, the ligase is added following hybridization of the oligonucleotides. Alternatively, the hybridization reaction can be carried out in the presence of a ligase, typically a thermostable ligase, and a ligation buffer, so that the ligation reaction can proceed following hybridization, without adding any further reagents, such as a ligase. Methods for ligating nucleic acid molecules are well-known. Any of a number of well known ligases and reaction conditions can be used in this ligation step. Exemplary of the ligases used in this step are a DNA ligase, for example, T4 DNA ligase or E. coli DNA ligase, an RNA ligase, for example, T4 RNA ligase, and a thermostable ligase, for example, Ampligase® (EPICENTRE® Biotechnologies, Madison, Wis.). An exemplary ligation reaction is carried out at room temperature, for example at 25° C., for four hours.

In one example, to produce the assembled duplex cassettes, the plurality of oligonucleotide pools are combined under conditions whereby they hybridize and nicks are sealed (see, for example, FIG. 1B). In another example, pairs, including one positive and one negative oligonucleotide pool, first are combined under conditions whereby the complementary oligos hybridize, thereby forming duplexes with overhangs and these duplexes with overhangs are incubated under conditions whereby they hybridize through complementary regions in the overhangs and nicks are sealed, e.g. by ligation.

As shown in FIG. 1B, incubation under conditions whereby the oligonucleotides of the pools hybridize and nicks are sealed results in generation of a collection of assembled duplex cassettes, where each cassette contains nucleic acid sequence from an oligonucleotide in each of the pools.

d. Assembled Duplex Cassettes

Incubation of the pools of oligonucleotides under conditions whereby they hybridize through shared complementary regions and nicks are sealed produces a collection of assembled duplex cassettes, each cassette typically containing two overhangs, typically restriction site overhangs, which are compatible with insertion into a vector, e.g. a vector that has been cut with one or more restriction enzymes, Each assembled duplex cassette in the collection contains nucleic acid of an oligonucleotide from each of the pools. Thus, when one or more pools of randomized oligonucleotides are used, as in the examples illustrated in FIG. 1, the assembled duplex cassettes are randomized assembled duplex cassettes. Typically, the randomized assembled duplex cassettes are generated with one or more, typically two or more, positive strand randomized oligonucleotide pools and one or more, typically two or more, negative strand randomized oligonucleotide pools, and optionally pool(s) of reference sequence oligonucleotides. In this example, the resulting randomized assembled cassettes contain two or more randomized portions, typically two or more non-contiguous randomize portions.

Alternatively, a reference sequence assembled duplex cassette can be generated using the methods with reference sequence pools of oligonucleotides; a variant (but non-randomized) assembled duplex cassette can be generated with one or more, typically two or more, pools of variant (but not randomized) oligonucleotides.

2. Formation of Assembled Duplexes by Fill-in Polymerase Extension: Oligonucleotide Fill-In and Assembly (OFIA)

In other provided approach for generating assembled duplexes, complementary strands of template oligonucleotides are synthesized in polymerase extension reactions (fill-in reactions), using one or more oligonucleotide primer, to generate one or more oligonucleotide duplexes, which then are cut (e.g. with restriction endonucleases) and assembled to form a collection of assembled duplexes. In one example, these assembled duplexes contain restriction sites and can be cut with restriction enzymes to form duplex cassettes. In general, the fill-in reactions are carried out by specific hybridization of one or more template oligonucleotide and one or more oligonucleotide primer, followed by polymerase extension. Exemplary of such approaches is oligonucleotide fill-in and assembly (OFIA). An example of OFIA is illustrated schematically in FIG. 2.

In OFIA, oligonucleotide duplexes are formed in fill-in reactions, where complementary strands of template oligonucleotides, designed and produced according to the provided methods, are synthesized. Each fill-in reaction is primed by an oligonucleotide primer (fill-in primer pool) having complementarity to a region of the oligonucleotides in a pool of template oligonucleotides.

To form assembled duplexes, a plurality of fill-in reactions can be carried out to produce multiple pools of oligonucleotide duplexes, which then are cut (to generate overhangs) and assembled. In one example, at least some of the plurality of fill-in reactions are mutually primed fill-in reactions, where each of two different oligonucleotide pools is a template pool and a fill-in primer pool and the two pools are combined such that complementary strand synthesis proceeds in both directions (see, for example, FIG. 2A). Typically, to form assembled duplexes, restriction endonucleases are added to the pools of oligonucleotide duplexes to generate compatible overhangs, followed by assembly by hybridization through complementary regions in the compatible overhangs. The OFIA process is described in further detail in subsections (a)-(e) below.

a. Template Oligonucleotides

Template oligonucleotides are oligonucleotides used as templates in the fill-in reactions; they can be designed and synthesized in pools according to the provided methods (e.g. as described in section D, above). The template oligonucleotides can be randomized template oligonucleotides and alternatively can be reference sequence oligonucleotides or variant (but non-randomized) oligonucleotides. Typically, a combination of randomized, reference sequence and/or variant (non-randomized) template oligonucleotide pools are used to generate an assembled duplex. Each template oligonucleotide in a template oligonucleotide pool contains a region that is complementary to a fill-in primer. Typically, this region is identical among the oligonucleotide members in the pool, such as at least at or about 50%, 55%, 60%, 65%, 70%, 75%, 80%, 85%, 90%, 95%, 96%, 97%, 98%, 99% or 100% identical, typically at or about 100% identical, among the members in the pool. The region of complementarity to a fill-in primer typically is a reference sequence region and typically contains at least about 10 contiguous nucleotides in length, for example, at least about 10, 11, 12, 13, 14, 15, 16, 17, 18, 19, 20 or more contiguous nucleotides in length. The template oligonucleotides can be any length, such as any length of an oligonucleotide, and typically are at least about 80 nucleotides in length, for example, at least at or about 80, 85, 90, 95, 100, 110, 120, 130, 140, 150, 200 or more nucleotides in length.

b. Fill-In Primers

A fill-in primer (a pool of fill-in primers) is used to prime synthesis of the complementary strand to the template oligonucleotides. The pool of fill-in primers can be designed and synthesized using the oligonucleotide methods provided herein, such as methods described in section D, above. The members of the fill-in primer pool contain regions of complementarity to regions in a pool of template oligonucleotides and, in one example, contain complementary to regions in all the members of the pool of template oligonucleotides. The region of complementarity can include the entire length of the fill-in primer or alternatively can contain less than the entire length of the fill-in primer. The fill-in primer specifically hybridizes to the template oligonucleotide through the region of complementarity and primes the fill-in reaction as described in section (c) below. In one example, the fill-in primer is a reference sequence oligonucleotide pool.

In another example, it is a randomized oligonucleotide and/or variant oligonucleotide pool. The fill-in primer can be any length, such as any length of an oligonucleotide, and is typically at least about 10 nucleotides in length, typically at least about 15 nucleotides in length, for example, at least at or about 10, 11, 12, 13, 14, 15, 16, 17, 18, 19, 20 or more contiguous nucleotides in length. In one example, a single oligonucleotide is a template oligonucleotide and a primer in the same fill-in reaction; in this example, the fill-in reaction is a mutually-primed fill-in reaction as described in section (c) below. For example, typically, when a fill-in primer is a randomized oligonucleotide, it is also a template oligonucleotide.

c. Fill-In Reactions

For OFIA, pools of oligonucleotide duplexes are generated in fill-in reactions (see the exemplary fill-in reactions illustrated in FIG. 2A, which produce the exemplary duplexes illustrated in FIG. 2B). For this process, a fill-in primer pool is mixed with a template oligonucleotide pool, under conditions whereby primers and templates hybridize through the complementary regions and complementary strands of the template oligonucleotides are synthesized, forming duplexes. In one example, each oligonucleotide pool used in the fill-in reaction is a template pool and a primer pool.

Various conditions for complementary strand synthesis are well known and can be used in the fill-in reaction; specific conditions can be chosen based on various considerations, including length and nucleotide composition of the oligonucleotides, and other considerations, by those skilled in the art. Exemplary of such conditions are incubation of the primer and template pools in the presence of dNTPs, buffer and polymerase, for example, DNA polymerase at appropriate temperature to allow complementary strand synthesis. In one example, a 3:1 molar excess of primer to template oligonucleotides is used. In another example, the template and primer are included at molar equivalents. Exemplary conditions are described in Example 5 below.

In the fill-in reaction, oligonucleotides within the template and fill-in primer pools specifically hybridize with one another through regions of complementarity. Typically, these regions contain reference-sequence portion(s). The regions of complementarity are not necessarily 100% complementarity, but typically are greater than at or about 50%, 55%, 60% or 65% complementary, typically at least at or about 70% complementary, for example, greater than about 70%, 75%, 80%, 85%, 90%, 95%, 96%, 97%, 98%, 99%, or more complementary. In one example, the regions of complementarity are 100% complementary to one another.

In one example, the fill-in reaction is a mutually-primed fill-in reaction, where each template oligonucleotide is also a fill-in primer, such that a complementary strand of each of the two hybridized oligonucleotides is synthesized in a bi-directional polymerase extension reaction. In one example, the reaction is a mutually-primed fill-in reaction and the template and primer pools are mixed at a 1:1 molar ratio. In another example, the reaction is not a mutually primed fill-in reaction and the primer and template pools are mixed at a 3:1 primer:template ratio. Other primer:template ratios can be used. Examples of mutually primed and non-mutually primed fill-in reactions are illustrated in FIG. 2A. For example, the three right-most illustrated fill-in reactions (two bi-directional arrows) are mutually primed, while the left-most pictured reaction (single arrow) is not mutually primed, but is single-directional.

d. Polymerases

A plurality of polymerases can be used to generate pools of oligonucleotide duplexes in fill-in reactions. Such polymerases are well-known. Exemplary of the polymerases used are DNA polymerases, for example high-fidelity DNA polymerases, and RNA polymerases. For example, the following polymerases can be used with the provided methods: the Advantage® HF 2 polymerase (Clonetech), DNA polymerase I (Klenow fragment), T4 DNA polymerase, T7 DNA polymerase, Taq DNA polymerase and derivatives, micrococcal DNA polymerase, AMV reverse transcriptase, Alpha DNA polymerase, M-MuLV reverse transcriptase and derivatives, E. coli RNA polymerase.

e. Restriction Digestion and Ligation

In OFIA, following formation of pools of oligonucleotide duplexes in fill-in reactions, the duplexes are cut, e.g. digested with one or more restriction endonucleases, to form compatible restriction site overhangs (see, for example, FIG. 2B). In some examples, the duplexes are purified, either before or after digestion, for example, using any of well-known nucleic acid purification methods, such as, but not limited to, nucleic acid purification columns, gel electrophoresis and extraction, or other methods.

Methods for restriction digestion are well known by those in the art. Exemplary of the restriction enzymes that can be used are restriction endonucleases available from New England Biolabs (Ipswich, Mass.). Typical restriction digests can be carried out following the manufactures protocol (e.g. recommended by suppliers) and using the suppliers' recommended buffers. Exemplary of a restriction digest is carried out by incubating the duplex, the endonuclease, diluted in 1× buffer, at 37° C. for 1.5 hours.

Following digestion and formation of compatible overhangs, the duplexes are assembled, via hybridization through the overhangs and nicks are sealed (e.g. using a ligase as described herein above for RCMA), to form an assembled duplex (see, for example, FIG. 2C) As noted herein above, hybridization and ligation techniques are well known, and any known techniques or other known techniques can be used to assemble the duplexes through compatible overhangs.

In one example, after forming the assembled duplexes by OFIA, the assembled duplexes contain restriction sites; in this example, they can be cut with restriction endonucleases as described herein to form assembled duplex cassettes for insertion into vectors (see, for example, FIG. 2D).

3. Formation of Duplexes by Duplex Oligonucleotide Ligation and Single Primer Amplification (DOLSPA)

In another approach (duplex oligonucleotide ligation and single primer amplification (DOLSPA)), multiple pools of oligonucleotides produced using the provided methods (e.g. as described in section D, above) are assembled, as in RCMA, to form a pool of intermediate duplexes, members of which are used as templates in an amplification reaction to form the collection of assembled duplexes. The amplification step can reduce the risk of generating duplexes with mismatched sequences and bias toward particular randomized sequences. Further, the amplification step amplifies the intermediate duplexes, which can result in a greater quantity of assembled duplexes, for use in making the libraries.

In DOLSPA, as shown in FIG. 3A, the amplification reaction is a single primer amplification reaction, where a single primer (a single primer pool—a single pool of primers sharing sequence identity) is used as a forward and reverse primer, thus priming complementary synthesis from positive strand and negative strands of the intermediate duplexes. Typically, the single primer is a non gene-specific primer. In variations of DOLSPA, such as the example illustrated in FIG. 3B, the amplification reaction is a gene-specific amplification; in some variations, such as illustrated in FIG. 3B, the amplification is performed with a primer pair (two pools of primers, primers in each pool sharing sequence identity). The primer pair can contain gene-specific primers, which hybridize to regions encoding polypeptide regions.

a. Design of Oligonucleotide Pools

As in RCMA, a plurality of pools of positive and negative strand oligonucleotide pools (see, for example, FIG. 3A, top panel) are designed according to the provided methods (e.g. as described in section D, above), for use in subsequent assembly steps. As in RCMA, the oligonucleotide pools can include reference sequence, randomized and/or variant (non-randomized) pools, typically a combination of reference sequence and randomized/variant pools. In DOLSPA and related methods, the pools of oligonucleotides typically are designed with regions of shared complementarity, restriction endonuclease recognition sites and/or overhangs, and/or regions of complementarity/identity to primers that will be used in the amplification reaction.

i. Regions of Shared Complementarity to Other Oligonucleotides

In DOLSPA and related methods, pools of oligonucleotides are designed such that oligonucleotides in each of the pools contain regions of complementarity to regions in oligonucleotides in an opposite strand pool. Typically, each oligonucleotide in each pool contains at least region of complementarity to at least one oligonucleotide in at least one other pool. The regions of complementarity can facilitate hybridization of the oligonucleotides during assembly. Some of the oligonucleotides have regions complementary to oligonucleotides in more than one other pools, as shown in FIGS. 3A and 3B. Each oligonucleotide in at least one of the pools is complementary to oligonucleotides in two or more opposite strand oligonucleotide pools, through two or more regions of complementarity. It is not necessary that each of the pools contains oligonucleotides with regions of complementarity to more than one other pool. For example, one, typically two, of the pools contains oligonucleotides with complementarity to oligonucleotides in only one other oligonucleotide pool. Typically, oligonucleotides from these pools form the termini of the assembled duplex cassettes upon assembly.

The plurality of pools of oligonucleotides can include pools of reference sequence oligonucleotides, pools of variant oligonucleotides, such as randomized oligonucleotides, and typically includes a combination thereof. For example, FIG. 3A illustrates seven positive strand and seven negative strand oligonucleotide pools designed for assembly of a duplex cassette using DOLSPA. In this particular example, shown in FIG. 3A, four of the oligonucleotide pools are randomized oligonucleotide pools (illustrated as open boxes with hatched portions representing randomized portions), while ten of the pools are reference sequence oligonucleotide pools (illustrated as open boxes or boxes partially filled with black or grey). In this example, oligonucleotides in one positive strand pool (left-most upper oligonucleotide in FIG. 3A) and one negative strand pool (right-most lower oligonucleotide in FIG. 3A) contain complementarity to oligonucleotides in only one other pool. Other pools illustrated in FIG. 3A contain oligonucleotides having multiple regions of complementarity, to regions of oligonucleotides in more than one other oligonucleotide pool.

The regions of complementarity (e.g. regions of shared complementarity) can contain randomized portions, reference sequence portions or randomized and reference sequence portions. For hybridization, the regions of complementarity are not necessarily 100% complementarity, but typically are greater than at or about 50%, 55%, 60% or 65% complementary, typically at least at or about 70% complementary, for example, greater than about 70%, 75%, 80%, 85%, 90%, 95%, 96%, 97%, 98%, 99%, or more complementary. In one example, the regions of complementarity are 100% complementary to one another.

ii. Regions of Complementarity/Identity to Primers

In DOLSPA and variations on this approach, some oligonucleotide pools, such as the oligonucleotide pools containing oligonucleotides that will form the 3′ and 5′ termini of the intermediate duplexes (typically four pools of oligonucleotides), contain regions of complementarity or identity to primers that will be used in the subsequent amplification reaction. In one example, the pools containing oligonucleotides that will form the positive and negative strand 5′ termini of the intermediate duplexes contain a region X, which contains sequence identity to a primer (see, for example, FIG. 3A, where region X, contained in one positive and one negative strand oligonucleotide pool, is depicted in black). In this example, the pools containing oligonucleotides that will form the positive and negative strand 3′ termini of the intermediate duplexes contain a region, Y, which contains complementarity to region X and to the primer (see, for example, FIG. 3A, where region Y, contained in one positive and one negative strand oligonucleotide pool, is depicted in grey).

In one example, as shown in FIG. 3A, when one positive and one negative strand pool contain regions X, the regions X are identical, for example at or about 100% identical. Similarly, when one positive and one negative strand pool contain regions Y, the regions Y are identical, for example, at or about 100% identical. In one aspect of these examples, a single primer pool, e.g. a non gene-specific single primer pool having identity to region X, can be used in the amplification reaction. In this example, the primers in the single-primer pool contain all or part of the sequence of nucleotides contained in region X, allowing it to hybridize with complementary region Y. In another example, where one positive and one negative strand pool contains regions X, the two pools contain different regions X, and similarly where one positive and one negative strand pools contain regions Y, the regions Y are different. In one aspect of this example, a primer pair is used in the amplification reaction, such as a gene-specific primer pair, where one pool of each pair contains identity to one of the regions X.

In one example, region X is a non gene-specific region (having identity to a non gene-specific primer), containing a sequence of nucleotides not encoding a target polypeptide or variant polypeptide, for example, the nucleotide sequence of a bacterial promoter, bacterial leader sequence, or portion thereof. Exemplary of a non gene specific primer is the CALX24 primer, having the sequence set forth in SEQ ID NO.: 3 (GCCGCTGTGCCATCGCTCAGTAAC). In another example, region X contains identity to a region of a gene-specific primer. Exemplary of gene-specific primers provided herein are the primer pCALVH-F, having the sequence set forth in SEQ ID NO.: 4 (GCCCAGGCGGCCGCAGAAGTTCAGCTGGTTGAATCTGGTG) and the primer E, having the sequence set forth in SEQ ID NO.: 5 (CCTTTGGTCGACGCCGGAGAAACGGTAACAACGGTACCCGGACCCCAAG CGTCGAACG), which can be used to generate assembled duplexes for making variant antibody polypeptides.

iii. Restriction Endonuclease Recognition Sites

Typically, the oligonucleotides that will form the termini of the intermediate duplexes further contain restriction endonuclease recognition sites (restriction sites). These sits can facilitate digestion of the assembled duplexes to form assembled duplex cassettes, which can be inserted into vectors. In one example, the restriction endonuclease recognition sites overlap with or are adjacent to region Y and/or region X.

b. Overlapping Assembly by Hybridization Through Regions of Complementarity and Sealing of Nicks to Form Intermediate Duplexes

As illustrated in FIG. 3A (middle panel), the plurality of oligonucleotide pools, having regions of complementarity, is incubated under conditions whereby positive and negative strand oligonucleotides hybridize through complementary regions, such as shared complementary regions. For this step, generally, pools of pools of oligonucleotides are combined under conditions whereby they specifically hybridize through complementary regions, for example, in the presence of a hybridization buffer and heated to temperatures that favor specific hybridization of complementary nucleic acid molecules. In one example, such as when pools of randomized oligonucleotides are used, the positive and negative strand oligonucleotide pools are mixed at a 1:1 molar ratio. Mixing the randomized pools at molar equivalents can reduce risk of bias toward particular randomized sequence(s). In another example, the pools are mixed at non-molar equivalents, such as 3:1 or 2:1 molar ratios.

Hybridization techniques are well-known. It is understood that optimal hybridization conditions, including temperature, buffer components and time of incubation, vary depending on parameters such as length of oligonucleotides, degree of complementarity and nucleic acid composition of the molecules. An exemplary hybridization buffer is STE buffer, as described above. A plurality of hybridization methods are well known; any of these well-known methods and variations thereof can be used with the methods provided herein to specifically hybridize oligonucleotides.

In one example, the hybridization is carried out at between 70° C. or about 70° C. and 95° C. or about 95° C., typically between 90° C. or about 90° C. and 95° C. or about 95° C., typically for about five minutes, followed by slow cooling, for example, to 50° C. or 25° C. Exemplary of slow cooling is placing the sample at a cooler temperature, e.g. at room temperature, such as between at or about 50° C. and 25° C., for a period of time, such as between at or about 4 hours and at or about 24 hours, such as at or about 4, 5, 6, 7, 8, 9, 10, 11, 12, 13, 14, 15, 16, 17, 18, 19, 20, 21, 22, 23 or 24 hours, typically between at or about 4 hours and overnight. Slow cooling can be used to increase the likelihood that nucleic acid molecules having a high percentage of complementarity (such as at or about 100% complementarity) will hybridize without hybridization of mismatched sequences, reducing the risk of generating duplexes with mismatched sequences and bias toward particular randomized sequences. In one example, the hybridization is carried out in the presence of ligase, typically a thermostable ligase, and/or a ligation reaction buffer, for example, Ampligase® reaction buffer, in the presence of Ampligase® ligase.

Simultaneous with or subsequent to hybridization of the oligonucleotides, nicks (indicated with arrows in FIG. 3A, middle panel) are sealed between the hybridized oligonucleotides (e.g. between the 5′ and 3′ termini of adjacent oligonucleotides). In one example, oligonucleotides are incubated under conditions whereby they hybridize and nicks are sealed; in another example, after hybridization, the hybridized oligonucleotides are incubated under conditions whereby nicks are sealed between adjacent oligonucleotides.

Typically, the nicks are sealed using a ligase, such as, but not limited to, a thermostable ligase. The ligase mediates the formation of phosphodiester bonds between adjacent 3′-OH and 5′-phosphate ends of the nick (e.g. joining 3′ and 5′ termini of adjacent oligonucleotides), thereby sealing the nicks and forming an assembled duplex cassette. Thus, in order to seal nicks using a ligase, a phosphate (PO₄) group is included at the 5′ end of any oligonucleotide that will be joined with the 3′ end of the adjacent oligonucleotide to seal the nick. In one example, the 5′ phosphate group is added during oligonucleotide synthesis; the oligonucleotides can be designed and then the designed oligonucleotides purchased with phosphate groups at their 5′ termini. In another example, a kinase, such as T4 polynucleotide kinase (T4 PK) is added to a previously synthesized oligonucleotide under conditions whereby a 5′ phosphate group is added.

In one example of ligation to seal the nicks, the ligase is added following hybridization of the oligonucleotides. Alternatively, the hybridization reaction can be carried out in the presence of a ligase, typically a thermostable ligase, and a ligation buffer, so that the ligation reaction can proceed following hybridization, without adding any further reagents, such as a ligase. Methods for ligating nucleic acid molecules are well-known. Any of a number of well known ligases and reaction conditions can be used in this ligation step. Exemplary of the ligases used in this step are a DNA ligase, for example, T4 DNA ligase or E. coli DNA ligase, an RNA ligase, for example, T4 RNA ligase, and a thermostable ligase, for example, Ampligase® (EPICENTRE® Biotechnologies, Madison, Wis.). An exemplary ligation reaction is carried out at room temperature, for example at 25° C., for four hours.

In one example, to produce the intermediate duplexes, the plurality of oligonucleotide pools are combined under conditions whereby they hybridize and nicks are sealed (see, for example, FIG. 3A., middle panel). In another example, pairs, including one positive and one negative oligonucleotide pool, first are combined under conditions whereby the complementary oligos hybridize, thereby forming oligonucleotide duplexes with overhangs and these duplexes with overhangs are incubated under conditions whereby they hybridize through complementary regions in the overhangs and nicks are sealed, e.g. by ligation.

As shown in FIG. 3A, middle panel, incubation under conditions whereby the oligonucleotides of the pools hybridize and nicks are sealed results in generation of a collection of intermediate duplexes, where each duplex contains nucleic acid sequence from an oligonucleotide in each of the pools. The intermediate duplexes are amplified as described below to generate assembled duplexes.

When one or more, typically two or more, pools of randomized oligonucleotides are used, the intermediate duplexes are randomized assembled intermediate duplexes, which contain one or more, typically two or more, randomized portions. In an alternative example, when each of the plurality of pools is a reference sequence pool, a pool of reference sequence intermediate duplexes is generated.

c. Generating Assembled Duplexes by Amplification of Intermediate Duplex Polynucleotides

Following hybridization and sealing of nicks, polynucleotides of the resulting pool of intermediate duplexes are used as templates in a polymerase reaction, typically an amplification reaction, to generate a collection of assembled duplexes. For the reaction, the collection of intermediate duplexes is incubated under conditions whereby complementary strands are synthesized (e.g. where the duplexes are denatured and primers hybridize to the polynucleotides and mediate synthesis of the complementary strands).

Typically, the collection of intermediate duplexes is incubated in the presence of a suitable buffer (such as any polymerase extension buffer, for example, a 1× Advantage HF reaction buffer) dNTPs (for example, a 1×dNTP mix), and one or more primers. In one example (DOLSPA, as shown in FIG. 3A), the primer is a single primer pool; the single primer pool typically is a non gene-specific single primer pool. Exemplary of a non gene-specific single primer pool is the CALX24 primer pool. In another example, as illustrated in FIG. 3B, the primers are a primer pair (two pools of identical primers), for example, a pair of two gene-specific primers. As shown in FIG. 3A, typically, the primer(s) are complementary to regions (Regions Y) at the 3′ end of the positive and negative strands of the intermediate duplexes and contain identity to regions (regions X) at the 5′ ends of the intermediate duplexes.

Typically, the mixture (e.g. primers, intermediate duplexes, buffer, dNTP, polymerase) is incubated under conditions whereby complementary strands are synthesized, for example, conditions whereby the polynucleotides of the intermediate duplexes are denatured, primers and the polynucleotides hybridize through complementary regions, and complementary strands are synthesized (e.g. by polymerase extension). In one example, the conditions include a series of denaturing, annealing and extension cycles using suitable temperatures, cycle times and number of cycles, which are well known in the art. Exemplary suitable conditions for the extension reaction are: denaturation at 95° C. for 1 minute, followed by 30 cycles of denaturation at 95° C. for 5 seconds and annealing/extension at 68° C. for 1 minute, followed by 3 minute incubation at 68° C. For amplification, denaturing, hybridizing and polymerase extension are carried out in multiple cycles, for example, by repeating denaturation, hybridization and polymerase extension for a total of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35 or more cycles.

In some examples, the intermediate duplexes are purified, for example, by methods known in the art, such as gel electrophoresis purification, and using nucleic acid purification columns. In one example, the resulting assembled duplexes contain restriction sites and can be cut with one or more restriction endonucleases to form assembled duplex cassettes, which can be ligated into vectors.

4. Producing Assembled Duplexes by Fragment Assembly and Ligation/Single Primer Amplification (FAL-SPA)

Another approach, Fragment Assembly and Ligation/Single Primer Amplification (FAL-SPA), combines aspects of other approaches described herein for making assembled duplexes, typically variant (e.g. randomized) assembled duplexes. In this approach, pools of variant (e.g. randomized) duplexes, reference sequence duplexes and scaffold duplexes are generated, simultaneously or sequentially, in any order. The duplexes typically are generated in amplification reactions. Polynucleotides in the pools of scaffold duplexes contain regions of complementarity to polynucleotides in other pools of duplexes, typically more than one other pool of duplexes, for example, a pool of randomized duplexes and a pool of reference sequence duplexes. Thus, after generating the duplexes, polynucleotides of the reference sequence duplexes and the variant (e.g. randomized) duplexes are assembled through regions of complementarity to the scaffold polynucleotides, forming assembled polynucleotides, which then are denatured and amplified to generate a collection of assembled duplexes. Typically, each assembled duplex contains a region of identity to a polynucleotide in each reference sequence duplex pool and each variant (e.g. randomized) duplex pool. In one example, the assembled duplexes then can be cut with restriction endonucleases to form assembled duplex cassettes. An example of the FAL-SPA approach is illustrated schematically in FIG. 4. The approach is described in further detail in the sub-sections below.

a. Variant (e.g. Randomized) Duplexes

Typically, pools of synthetic template oligonucleotides (typically randomized oligonucleotides), such as those designed and produced according to the provided methods (e.g. as described in section D, herein), are used to form variant (typically randomized) duplexes (see, for example, FIG. 4A) in a polymerase reaction, typically an amplification reaction. In this reaction, primers, typically a primer pair, are used to prime complementary strand synthesis from the template oligonucleotides, typically in an amplification reaction, such as a PCR. Alternatively, the variant (e.g. randomized) duplexes can be generated by other methods, such as by hybridization of complementary randomized oligonucleotides.

The primers used in the polymerase reaction are oligonucleotide primers, such as oligonucleotides designed and synthesized according to the methods herein (see, e.g. section D). In one example, the primers are short oligonucleotide primers, such as oligonucleotides containing less than at or about 100, 90, 80, 70, 60, 50, 40 or 30 nucleotides in length. In one example, using short oligonucleotide primers can reduce the risk of unwanted mutations, deletions and/or insertions. Typically, the oligonucleotide primers are purified prior to use, for example, by desalting, but typically by HPLC and/or PAGE purification. In one example, oligonucleotide primers contain 5′ phosphate groups, for ligation in subsequent steps. In one example, the primers are treated with T4 polynucleotide kinase (e.g. T4 Polynucleotide Kinase available from New England Biolabs) or other enzyme, to add 5′ phosphate groups, for example, so the duplexes can be ligated.

Amplification methods and conditions are well known; examples are described in other sections herein. Any of the methods/conditions can be used to amplify the template oligonucleotides to form the pools of variant (e.g. randomized) duplexes.

Typically, the template oligonucleotides are randomized oligonucleotides. In one example, the entire length of the reference sequence portion(s) of the randomized template oligonucleotides, or about the entire length of the reference sequence portion(s), such as all but 1, 2, 3, 4 or 5 nucleotides, is complementary to a primer used to prime the amplification. In another example, the reference sequence portion(s) in the randomized template oligonucleotides contain a total of at least at or about 50%, 55%, 60%, 65%, typically at least at or about 70%, 75%, 80%, 85%, 90%, 95%, 99%, or 100%, complementarity to primers. In one example, the only portion (or about the only portion) of the randomized duplex that is not complementary to a primer is the randomized portion(s). In another example, where one or more reference sequence portions is located between two or more randomized portions within a single randomized oligonucleotide, these one or more reference sequence portions are not complementary to primers. Designing the template oligonucleotides/primers so that most/all of the reference sequence positions are complementary to primers used in the polymerase reaction can reduce unwanted mutation, and/or bias toward particular randomized mutations.

The reference sequences used to design the template oligonucleotides contain sequence identity to the target polynucleotide, typically to a region thereof. In one example, reference sequence contains at least at or about 50%, 60%, 70%, 75%, 80%, 85%, 90%, 95%, 96%, 97%, 98%, 99% or 100% identity to the target polynucleotide region.

The variant (e.g. randomized) duplexes can be any length, such as, for example, any oligonucleotide length, such as, but not limited to, 30, 40, 50, 60, 70, 80, 90, 100, 110, 120, 130, 140, 150, 175, 200, 250 or more nucleotides in length. In one example, the variant (e.g. randomized) duplexes contain less than 250 or about 250, less than 200 or about 200 or less than 150 or about 150, less than 100 or about 100, less than 50 or about 50, or fewer, nucleotides in length. In one example, these lengths can reduce risk of error in nucleotide sequence of the duplexes.

b. Reference Sequence Duplexes and Scaffold Duplexes

Simultaneously, or sequentially in any order, reference sequence duplexes and scaffold duplexes also are generated, typically by amplification from the target polynucleotide, as illustrated in FIG. 4B. The scaffold duplexes are polynucleotide duplexes containing regions of complementarity to regions within other pools of duplexes. Typically, each scaffold duplex contains complementarity to polynucleotides in at least two other duplexes, such as two, three or four of the duplexes, for example, complementarity to pool(s) of reference sequence duplexes and pool(s) of randomized duplexes. Typically, the members of at least one of the pools of scaffold duplexes contain complementarity to reference sequence and variant (e.g. randomized) duplexes. The fact that scaffold duplexes are complementary to multiple pools can facilitate ligation and assembly of polynucleotides of the other duplexes (e.g. randomized and reference sequence duplexes) in subsequent assembly step, by bringing polynucleotides from the various duplexes into close proximity as they specifically hybridize to regions of complementarity on the scaffold polynucleotides. When more than one pool of scaffold duplexes is used, it is not necessary that each of the scaffold duplex pools contains complementarity to a plurality of other pools. In one example, one of the plurality of scaffold duplexes contains complementarity to only one other pool.

Generally, as illustrated in FIG. 4B, the reference sequence duplexes and scaffold duplexes are formed in amplification reactions, using primers to prime synthesis of complementary strands of a target polynucleotide, using the target polynucleotide, or region thereof, as a template. Thus, the reference sequence duplex members and the scaffold duplex members contain regions of identity to the target polynucleotide. The amplification reactions typically are carried out using high-fidelity polymerases, which can reduce the risk of unwanted mutations. Alternatively, variant, e.g. randomized duplexes, can be used in place of the reference sequence duplexes, e.g. by amplification using a variant or randomized polynucleotide.

The primers for the polymerase reactions are oligonucleotides, such as oligonucleotides made according to the methods herein. Typically, the primers are primer pairs. Typically, the primers are short oligonucleotide primers, for example, oligonucleotides containing less than at or about 100, 90, 80, 70, 60, 50, 40 or 30 nucleotides in length. In one example, the short oligonucleotide primers can reduce the risk of unwanted mutations, deletions and/or insertions. Typically, the oligonucleotide primers are purified prior to use, for example, using desalting, but typically HPLC and/or PAGE purification. In one example, oligonucleotide primers contain 5′ phosphate groups, for ligation of the duplexes in subsequent steps. In one example, the primers are treated with T4 polynucleotide kinase (e.g. T4 Polynucleotide Kinase available from New England Biolabs) or other enzyme to add 5′ phosphate groups.

The reference sequence duplexes and the scaffold duplexes can be any length, such as, for example, at or about 30, 40, 50, 60, 70, 80, 90, 100, 110, 120, 130, 140, 150, 175, 200, 250, 300, 350, 400, 450, 500, 550, 600, 700, 800, 900, 1000, 1500, 2000 or more nucleotides in length. In one example, the reference sequence duplexes or the scaffold duplexes contain less than 500 or about 500, less than 250 or about 250, less than 200 or about 200 or less than 150 or about 150, less than 100 or about 100, less than 50 or about 50, or fewer, nucleotides in length, which can reduce risk of error in nucleotide sequence of the duplexes.

c. Regions of Complementarity to SPA Primers

Typically, primers used to generate the randomized, reference sequence, and/or scaffold duplexes contain a region X, which has a nucleotide sequence having identity to a sequence in a primer that will be used in the subsequent amplification step. Typically, this primer is a single primer pool. In one example, the primer contains a non gene-specific sequence. Thus, pools of duplexes generated in the amplification reactions (such as randomized, reference sequence and/or scaffold duplexes) contain a Region X (represented as black filled boxes in FIG. 4B) and a complementary Region, region Y (represented by grey boxes in FIG. 4B). Typically, at least two, such as 2, 3 or 4, pools of the pools of duplexes contain region X and region Y; typically, the region X and region Y are identical, such as at or about 90%, 95%, 96%, 97%, 98%, 99% or 100% identical among the two pools. In this example, a single primer pool (containing a sequence having identity to region X) can be used in an SPA step to amplify the assembled polynucleotide (FIG. 4D) to make assembled polynucleotide duplexes.

Typically, among the duplexes that contain region X and Y are the duplexes that will form the 5′ and 3′ termini of the assembled duplex produced by the methods, such that the assembled duplexes will contain region Y and region X at their 5′ and 3′ termini.

In one example, Region X and Y are non gene-specific regions (having identity to a non gene-specific primer), containing a sequence of nucleotides not encoding a target polypeptide or variant polypeptide, for example, the nucleotide sequence of a bacterial promoter, bacterial leader sequence, or portion thereof. In this example, Region X can contain identity to a non gene-specific primer, such as the primers: CALX24, having the sequence set forth in SEQ ID NO.: 3 (GCCGCTGTGCCATCGCTCAGTAAC) and CALX24H1S-F, having the sequence of nucleotides set forth in SEQ ID NO: 6 (GCCGCTGTGCCATCGCTCAGTAACGCGGCCGCAGAAGTTCAGCTG). In another example, region X contains identity to a region of a gene-specific primer. Exemplary of such gene-specific primers are the primer pCALVH-F, having the sequence set forth in SEQ ID NO.: 4 (GCCCAGGCGGCCGCAGAAGTTCAGCTGGTTGAATCTGGTG) and the primer E, having the sequence set forth in SEQ ID NO.: 5 (CCTTTGGTCGACGCCGGAGAAACGGTAACAACGGTACCCGGACCCCAAG CGTCGAACG), which can be used to generate assembled duplexes for making variant antibody polypeptides.

In one example, one or more of the primers used to generate the duplexes contains a restriction endonuclease recognition site. Typically, the primers (and thus the duplexes) containing region X also contain the restriction endonuclease recognition sites. In one example, the restriction endonuclease site overlaps with region X/Y. In another example, the restriction endonuclease recognition site is adjacent to region X/Y. The restriction sites can be the same, but typically are different, restriction sites, e.g. recognized by different restriction enzymes.

d. Producing Assembled Polynucleotides and Intermediate Duplexes by Fragment Assembly and Ligation (FAL)

As shown in FIG. 4C, following formation of the pools of variant (e.g. randomized) duplexes, the pools of reference sequence duplexes and the pools of scaffold duplexes, the duplexes are combined under conditions whereby they hybridize through complementary regions and nicks are sealed, thereby forming pools of assembled polynucleotides. This step is referred to as the fragment assembly and ligation (FAL) step, whereby the variant (e.g. randomized) duplexes and the reference sequence duplexes are denatured and the resulting single strand polynucleotides hybridized, through shared complementary regions, to scaffold polynucleotides from denatured scaffold duplexes, which contain regions of complementarity to a plurality of the pools. Thus, polynucleotides of the variant and reference sequence duplexes are hybridized and brought into close proximity through regions of complementarity to polynucleotides of the scaffold duplexes. Typically, this process generates a pool of positive strand assembled polynucleotides and a pool of negative strand assembled polynucleotides.

Typically, for generation of the assembled polynucleotides in the FAL step, the pools of duplexes are denatured and incubated under conditions whereby they hybridize through complementary regions. Nicks (indicated with arrows in FIG. 4C) between adjacent polynucleotides are sealed, typically using a ligase, e.g. T4 DNA ligase. Polynucleotide strands of the scaffold duplexes hybridize to regions of polynucleotides of the reference sequence duplexes and/or variant (e.g. randomized) duplexes; this process facilitates ligation of the reference sequence and/or variant duplexes, by bringing them in close proximity to one another. Hybridization and ligation forms a pool of assembled duplexes, each of which typically contains the sequence of nucleotides from a polynucleotide within each of the reference sequence and randomized duplex pools, as illustrated in FIG. 4C. Typically, the FAL includes repeating the denaturing and annealing (hybridization) steps, for example, for 20-40 cycles, for example, 30 cycles, in order to generate assembled polynucleotides in duplexes. Exemplary of such a process is one whereby the duplexes are mixed in the presence of a ligase, denatured, for example, for 30 seconds at 95° C., then incubated under conditions, for example, at 65° C. for 1 minute, whereby the polynucleotides specifically hybridize through complementary regions, and these steps are repeated, for example, in 30 cycles, allowing formation of assembled polynucleotides in intermediate duplexes.

Typically, as illustrated in FIG. 4C, one or more region X and/or Region Y form 5′ and 3′ ends of the assembled polynucleotides, respectively. These 5′ and 3′ terminal ends typically further contain restriction endonuclease recognition sites, which can be contained within the sequences X and Y.

e. Producing Assembled Duplexes by Amplification (SPA)

Following formation of assembled polynucleotides, as shown in FIG. 4D, the assembled polynucleotides are used as templates in an amplification reaction, typically a single primer amplification (SPA), to form a collection of assembled duplexes, typically a collection of randomized duplexes.

In this step, primers, typically a single-primer pool, typically a non gene-specific single primer pool, is used in the amplification reaction to synthesize complementary strands of the assembled polynucleotides to form the assembled duplexes. In the example shown in FIG. 4D, the primers in the single-primer pool contain all or part of the sequence of nucleotides contained in region X (which is identical among the polynucleotides in the positive strand pool and the negative strand pool), allowing it to hybridize with complementary region Y, as shown in FIG. 4D.

Alternatively, a primer pair can be used in the amplification step. In this alternative, the positive strand pool of assembled polynucleotides and the negative strand pool of assembled polynucleotides have Region X and Region Y that differ from one another. In this example, one pool of primers in the pair is complementary to the first Region Y and the other is complementary to the second Region Y.

In one example, after formation of the assembled duplexes, the duplexes can be digested with one or more restriction endonucleases, typically recognizing sites within the 3′ and 5′ regions of the duplexes, to form a pool of assembled duplex cassettes that can be introduced into vectors.

5. Modified FAL-SPA

Modified FAL-SPA (mFAL-SPA) is a modified variation of the FAL-SPA approach to forming assembled duplexes. An example of this approach is illustrated in FIG. 5. As with FAL-SPA, a plurality of pools of duplexes are generated, simultaneously or sequentially, in any order. In mFAL-SPA, the plurality of pools of duplexes includes variant (e.g. randomized) and reference sequence duplexes.

a. Pools of Variant (e.g. Randomized) Duplexes

The pools of variant oligonucleotide duplexes (e.g. randomized duplexes) typically are formed by hybridizing pools of positive strand oligonucleotides and pools of negative strand oligonucleotides under conditions whereby oligonucleotides in the pools hybridize through regions of complementarity. Typically, the oligonucleotides are synthetic oligonucleotides, such as those designed and synthesized according to the provided methods (e.g. as described in section D, herein above). Typically, the oligonucleotides are synthesized with 5′ phosphate groups, to facilitate their ligation to other duplexes in subsequent steps.

The variant (e.g. randomized) oligonucleotides are designed such that the resulting duplexes contain one, typically two, overhangs, such as restriction site overhangs, so that the duplexes can be assembled with reference sequence duplexes having compatible overhangs, in a subsequent step. The synthetic oligonucleotide duplexes typically are randomized duplexes, as illustrated in FIG. 5A.

The reference sequences used to design the variant (e.g. randomized) oligonucleotides contain sequence identity to the target polynucleotide, typically to a region thereof. In one example, reference sequence contains at least at or about 50%, 60%, 70%, 75%, 80%, 85%, 90%, 95%, 96%, 97%, 98%, 99% or 100% identity to the target polynucleotide region.

The variant (e.g. randomized) duplexes can be any length, such as, for example, any oligonucleotide length, such as, but not limited to, 30, 40, 50, 60, 70, 80, 90, 100, 110, 120, 130, 140, 150, 175, 200, 250 or more nucleotides in length. In one example, the variant (e.g. randomized) duplexes contain less than 250 or about 250, less than 200 or about 200 or less than 150 or about 150, less than 100 or about 100, less than 50 or about 50, or fewer, nucleotides in length. In one example, these lengths can reduce risk of error in nucleotide sequence of the duplexes.

b. Pools of Reference Sequence Duplexes

The pools of reference sequence duplexes are generated (see, e.g. FIG. 5B), as in FAL-SPA, by amplification, using a target polynucleotide or region thereof as a template, with primers (typically primer pairs) that are complementary to regions along of the target polynucleotide. Alternatively, variant, e.g. randomized duplexes, can be used in place of the reference sequence duplexes, e.g. by amplification using a variant or randomized polynucleotide.

Generally, as illustrated in FIG. 5B, the reference sequence duplexes are formed in amplification reactions, using primers to prime synthesis of complementary strands of a target polynucleotide, using the target polynucleotide, or region thereof, as a template. Thus, the reference sequence duplex members contain regions of identity to the target polynucleotide. The amplification reactions typically are carried out using high-fidelity polymerases, which can reduce the risk of unwanted mutations.

The primers for the polymerase reactions are oligonucleotides, such as oligonucleotides made according to the methods herein. Typically, the primers are primer pairs. Typically, the primers are short oligonucleotide primers, for example, oligonucleotides containing less than at or about 100, 90, 80, 70, 60, 50, 40 or 30 nucleotides in length. In one example, the short oligonucleotide primers can reduce the risk of unwanted mutations, deletions and/or insertions. Typically, the oligonucleotide primers are purified prior to use, for example, using desalting, but typically HPLC and/or PAGE purification. In one example, oligonucleotide primers contain 5′ phosphate groups, for ligation of the duplexes in subsequent steps. In one example, the primers are treated with T4 polynucleotide kinase (e.g. T4 Polynucleotide Kinase available from New England Biolabs) or other enzyme to add 5′ phosphate groups.

The reference sequence duplexes and the scaffold duplexes can be any length, such as, for example, at or about 30, 40, 50, 60, 70, 80, 90, 100, 110, 120, 130, 140, 150, 175, 200, 250, 300, 350, 400, 450, 500, 550, 600, 700, 800, 900, 1000, 1500, 2000 or more nucleotides in length. In one example, the reference sequence duplexes or the scaffold duplexes contain less than 500 or about 500, less than 250 or about 250, less than 200 or about 200 or less than 150 or about 150, less than 100 or about 100, less than 50 or about 50, or fewer, nucleotides in length, which can reduce risk of error in nucleotide sequence of the duplexes.

The method for generating the pools of reference sequence duplexes is similar to that used in FAL-SPA, described in section E(4)(b) above, with the exception that in mFAL-SPA, the primers for generating the reference sequence duplexes further contain sequences of nucleotides corresponding to restriction endonuclease cleavage sites. For example, in the example illustrated in FIG. 5B, portions of the primers illustrated as filled black boxes and those illustrated as vertical lines contain restriction site sequences. Exemplary of the restriction endonuclease cleavage site is a Sap-I cleavage site (GCTCTTC SEQ ID NO: 2). Typically, among the restriction sites are restriction sites recognized by endonucleases that generate overhangs compatible with the restriction site overhangs in the variant (e.g. randomized) duplexes. The primers also can contain other restriction sites, such as restriction sites to facilitate ligation of the assembled duplexes into vectors (e.g. the restriction sites within the portions illustrated in black in FIG. 5).

c. Regions of Complementarity to SPA Primers

As in FAL-SPA, the primers for generating the reference sequence duplexes contain a region X, which has a nucleotide sequence having identity to a sequence in a primer that will be used in the subsequent amplification step. Typically, this primer is a single primer pool. In one example, the primer contains a non gene-specific sequence. Thus, pools of duplexes generated in the amplification reactions (such as randomized, reference sequence and/or scaffold duplexes) contain a Region X (represented as black filled boxes in FIG. 5B) and a complementary Region, region Y (represented by grey boxes in FIG. 5B). Typically, at least two, such as 2, 3 or 4, pools of the pools of duplexes contain region X and region Y; typically, the region X and region Y are identical, such as at or about 90%, 95%, 96%, 97%, 98%, 99% or 100% identical among the two pools. In this example, a single primer pool (containing a sequence having identity to region X) can be used in an SPA step to amplify the assembled polynucleotide to make assembled polynucleotide duplexes.

Typically, among the duplexes that contain region X and Y are the duplexes that will form the 5′ and 3′ termini of the assembled duplex produced by the methods, such that the assembled duplexes will contain region Y and region X at their 5′ and 3′ termini.

In one example, Region X and Y are non gene-specific regions (having identity to a non gene-specific primer), containing a sequence of nucleotides not encoding a target polypeptide or variant polypeptide, for example, the nucleotide sequence of a bacterial promoter, bacterial leader sequence, or portion thereof. In this example, Region X can contain identity to a non gene-specific primer, such as the primers: CALX24, having the sequence set forth in SEQ ID NO.: 3 (GCCGCTGTGCCATCGCTCAGTAAC) and CALX24H1S-F, having the sequence of nucleotides set forth in SEQ ID NO: 6 (GCCGCTGTGCCATCGCTCAGTAACGCGGCCGCAGAAGTTCAGCTG). In another example, region X contains identity to a region of a gene-specific primer. Exemplary of such gene-specific primers are the primer pCALVH-F, having the sequence set forth in SEQ ID NO.: 4 (GCCCAGGCGGCCGCAGAAGTTCAGCTGGTTGAATCTGGTG) and the primer E, having the sequence set forth in SEQ ID NO.: 5 (CCTTTGGTCGACGCCGGAGAAACGGTAACAACGGTACCCGGACCCCAAG CGTCGAACG), which can be used to generate assembled duplexes for making variant antibody polypeptides.

Typically, the primers (and thus the duplexes) containing region X also contain restriction endonuclease recognition sites, as described in section (b) above, for example, the restriction sites within the black portions in FIG. 5B. In one example, the restriction endonuclease site overlaps with region X/Y. In another example, the restriction endonuclease recognition site is adjacent to region X/Y. The restriction sites can be the same, but typically are different, restriction sites, e.g. recognized by different restriction enzymes.

d. Restriction Endonuclease Cleavage

In mFAL-SPA, a restriction endonuclease cleavage step (see, for example, FIG. 5C) further is carried out following the generation of the reference sequence duplexes, generating overhangs, typically being a few nucleotides in length, e.g. 2, 3, 4, 5, 6, 7, or more nucleotides in length. The restriction endonuclease cleavage in the example illustrated in FIG. 5C cuts the duplexes at the restriction sites within the portions represented in vertical lines.

Typically, as illustrated in FIG. 5, the overhangs in the variant oligonucleotide duplexes (e.g. randomized duplexes) are compatible with the overhangs generated in this restriction endonuclease cleavage of the reference sequence duplexes.

e. Producing Assembled Polynucleotides and Intermediate Duplexes by Fragment Assembly and Ligation (FAL)

In mFAL-SPA, a fragment assembly and ligation (FAL) step is carried out (FIG. 5D) to produce a collection of intermediate duplexes. In the FAL step, the variant (e.g. randomized) duplexes and reference sequence duplexes are assembled through the compatible overhangs, typically without denaturing the duplexes. Thus, the pools of variant and reference sequence duplexes are combined under conditions whereby they hybridize through complementary regions and nicks (indicated with arrows in FIG. 5D) are sealed, e.g. by adding a ligase, thereby generating a collection of intermediate duplexes. Conditions whereby the duplexes hybridize and nicks are sealed include combining the pools of duplexes (e.g. in the presence of a ligase buffer, e.g. T4 DNA ligase buffer), typically at equimolar concentration, and adding T4 DNA ligase for ligation at room temperature (e.g. 25° C. or about 25° C.) overnight.

f. Producing Assembled Duplexes by Amplification (SPA)

The intermediate duplexes formed by the FAL step are used as templates in an amplification reaction, typically a single primer amplification (SPA), to form a collection of assembled duplexes, e.g. a collection of randomized duplexes. The intermediate duplexes are incubated with primers and a polymerase, under conditions whereby they are denatured and complementary strands are synthesized. Amplification reactions are well-known; any known amplification methods, such as those described herein, can be used to generate the assembled duplexes.

In this step, primers, typically a single-primer pool, typically a non gene-specific single primer pool, is used in the amplification reaction to synthesize complementary strands of the assembled polynucleotides to form the assembled duplexes. In one example, the primers in the single-primer pool contain all or part of the sequence of nucleotides contained in region X (which is identical among the polynucleotides in the positive strand pool and the negative strand pool), allowing it to hybridize with complementary region Y.

Alternatively, a primer pair can be used in the amplification step. In this alternative, the positive strand pool of assembled polynucleotides and the negative strand pool of assembled polynucleotides have Region X and Region Y that differ from one another. In this example, one pool of primers in the pair is complementary to the first Region Y and the other is complementary to the second Region Y.

In one example, after formation of the assembled duplexes, the duplexes can be digested with one or more restriction endonucleases, typically recognizing sites within the 3′ and 5′ regions of the duplexes, to form a pool of assembled duplex cassettes that can be introduced into vectors.

6. Isolation of Duplexes and Duplex Cassettes

After formation, the duplexes and duplex cassettes can be isolated for use in subsequent steps. Methods for isolating duplexed DNA are well-known. Any of a number of well-known techniques can be used to isolate the duplexes and duplex cassettes, for example, PCR cleanup kits, or by gel electrophoresis and extraction.

### F. LIGATION OF THE ASSEMBLED DUPLEX CASSETTES INTO VECTORS

Assembled duplex cassettes, made by the provided methods, can be inserted into vectors cut with restriction endonucleases, for example, in order to transform host cells for amplification and/or isolation of the polynucleotides and/or expression of polypeptides encoded by the polynucleotides (for example, in a phage display library). Thus, also provided are vectors that contain the target and/or variant polynucleotides, e.g. in nucleic acid libraries containing variant polynucleotides.

For example, the variant polynucleotide duplexes generated by the methods herein can be inserted into an appropriate cloning vector. Typically, the choice of vector is affected by whether it is desired to amplify, isolate and/or express polypeptides from the nucleic acids in the vector. A number of vector-host systems, which are known in the art, can be used. Possible vectors include, but are not limited to, plasmids and modified viruses. The vector system must be compatible with the host cell used, such as, for example, bacteriophages such as lambda derivatives, or plasmids such as pCMV4, pBR322 or pUC plasmid derivatives or the Bluescript vector (Stratagene, La Jolla, Calif.).

The insertion into a cloning vector can, for example, be accomplished by ligating the DNA fragment into a cloning vector which has complementary cohesive termini. Insertion can be effected using TOPO cloning vectors (1NVITROGEN, Carlsbad, Calif.). If the complementary restriction sites used to fragment the DNA are not present in the cloning vector, the ends of the DNA molecules can be enzymatically modified. Alternatively, any site desired can be produced by ligating nucleotide sequences (linkers) onto the DNA termini; these ligated linkers can contain specific chemically synthesized oligonucleotides encoding restriction endonuclease recognition sequences. In an alternative method, the cleaved vector and nucleic acid for insertion can be modified by homopolymeric tailing. Recombinant molecules can be introduced into host cells via, for example, transformation, transfection, infection, electroporation and sonoporation, so that many copies of the gene sequence are generated.

Typically, the vectors into which the duplex cassettes are inserted contain the target polynucleotide or a region of the target polynucleotide. The duplex cassettes typically are inserted into the vector in a suitable location to form part of a polynucleotide analogous to the target polynucleotide. In one example, when the inserted duplex cassettes are variant polynucleotides, this analogous nucleic acid sequence varies compared to the target polynucleotide sequence. For example, typically, the vectors containing inserts contain one or more nucleotide substitutions compared to the target polynucleotide. These nucleotide substitutions are located in variant portions, typically randomized portions, in the oligonucleotide(s) used to assemble the cassettes. In addition to regions with identity to the target polynucleotide, the vectors contain other regions. For example, the vectors typically contain regions of nucleic acid sequence that facilitate insertion of polynucleotides, nucleic acid replication and expression, for example, inducible expression, of the encoded polypeptides.

Various combinations of host cells and vectors can be used to receive, maintain, reproduce and amplify nucleic acids (e.g. nucleic acid libraries encoding antibodies such as domain exchanged antibodies), and to express polypeptides encoded by the nucleic acids, such as the displayed polypeptides (e.g. domain exchanged antibodies) provided herein. In general, the choice of host cell and vector depends on whether amplification, polypeptide expression, and/or display on a genetic package, is desired. In one example, the same host cell and/or vector is used to amplify the nucleic acids, express the polypeptide and for display on a genetic package. In another example, different host cells and/or vectors are used. Methods for transforming host cells are well known. Any known transformation method, for example, electroporation, can be used to transform the host cell with nucleic acids.

In one example, vectors, such as the provided display vectors and other vectors, are used to transform host cells for amplification of nucleic acids encoding the provided polypeptides. When the vectors are used to transform host cells, the nucleic acids are replicated as the host cell divides, amplifying the nucleic acids.

Nucliec acids are amplified, for example, to isolate the nucleic acids encoding polypeptides such as displayed polypeptides, e.g. to determine the nucleic acid sequence or for use in transformation of other host cells. In one example, after transforming the host cells with the vectors, the host cells are incubated in medium, for example, SOC (Super Optimal Catabolite) medium (Invitrogen™; for 1 liter: 20 grams (g) Bacto Tryptone; 5 g Yeast Extract; 0.58 g Sodium Chloride (NaCl); 0.186 g Potassium Chloride (KCl) in distilled water); SB (Super Broth) medium (for 1 liter: 30 g tryptone, 20 g yeast extract, 10 g MOPS in distilled water); or LB (Luria broth) medium (for 1 L: 10 g Bacto Tryptone; 5 g yeast extract; 10 g NaCl, in distilled water) in the presence of one or more antibiotics, for selection of cells successfully transformed with vector nucleic acids containing insert, typically at 37° C. In one example, the incubated host cells are grown overnight at 37° C. on agar plates supplemented with one or more antibiotics and/or glucose, for generation of clonal colonies, each containing host cells transformed with a single vector nucleic acid.

One or more colonies can be picked for isolation of nucleic acids for use in subsequent steps, for example, in nucleic acid sequencing. Alternatively, picked colonies can be pooled and used to re-transform additional host cells, for example, phage-compatible host cells. In another example, the colonies can be picked and grown, and then the cultures used to induce protein expression from the host cells, for example, to assay expression of the variant polypeptides in the host cells, prior to phage display.

The colonies can be used to determine transformation efficiency, for example, by calculating the number of transformants generated from a library, by multiplying the number of colonies by the culture volume and dividing by the plating volume (same units), using the following equation: [# colonies/plating volume×[culture volume)/microgram DNA]×dilution factor.

In one example, the vector is selected based on the ability to confer display of the polypeptide on the surface of a genetic package. When the genetic package is a virus, for example, a bacteriophage, the vector can be the genetic package. Alternatively, the vector can be separate from the genetic package, but encode a polypeptide displayed by the genetic package. Exemplary of such a vector is a phagemid vector, which encodes a polypeptide to be expressed on a bacteriophage, for example, a filamentous bacteriophage.

1. Expression Vectors

Any methods known to those of skill in the art for the insertion of DNA fragments into a vector can be used to construct expression vectors containing a chimeric gene containing appropriate transcriptional/translational control signals and protein coding sequences, e.g. variant polynucleotide sequences encoding variant polypeptides. These methods can include in vitro recombinant DNA and synthetic techniques and in vivo recombinants (genetic recombination).

Expression of nucleic acid sequences encoding polypeptides, or domains, derivatives, fragments or homologs thereof, can be regulated by a second nucleic acid sequence so that the genes or fragments thereof are expressed in a host transformed with the recombinant DNA molecule(s). For example, expression of the proteins can be controlled by any promoter/enhancer known in the art. In a specific embodiment, the promoter is not native to the genes for a desired protein. Promoters that can be used include, but are not limited to, the SV40 early promoter (Bernoist and Chambon, Nature 290:304-310 (1981)), the promoter contained in the 3′ long terminal repeat of Rous sarcoma virus (Yamamoto et al. Cell 22:787-797 (1980)), the herpes thymidine kinase promoter (Wagner et al., Proc. Natl. Acad. Sci. USA 78:1441-1445 (1981)), the regulatory sequences of the metallothionein gene (Brinster et al., Nature 296:39-42 (1982)); prokaryotic expression vectors such as the β-lactamase promoter (Jay et al., (1981) Proc. Natl. Acad. Sci. USA 78:5543) or the tac promoter (DeBoer et al., Proc. Natl. Acad. Sci. USA 80:21-25 (1983)); see also “Useful Proteins from Recombinant Bacteria”: in Scientific American 242:79-94 (1980)); plant expression vectors containing the nopaline synthetase promoter (Herrar-Estrella et al., Nature 303:209-213 (1984)) or the cauliflower mosaic virus 35S RNA promoter (Garder et al., Nucleic Acids Res. 9:2871 (1981)), and the promoter of the photosynthetic enzyme ribulose bisphosphate carboxylase (Herrera-Estrella et al., Nature 310:115-120 (1984)); promoter elements from yeast and other fungi such as the Gal4 promoter, the alcohol dehydrogenase promoter, the phosphoglyceroyl kinase promoter, the alkaline phosphatase promoter, and the following animal transcriptional control regions that exhibit tissue specificity and have been used in transgenic animals: elastase I gene control region which is active in pancreatic acinar cells (Swift et al., Cell 38:639-646 (1984); Ornitz et al., Cold Spring Harbor Symp. Quant. Biol. 50:399-409 (1986); MacDonald, Hepatology 7:425-515 (1987)); insulin gene control region which is active in pancreatic beta cells (Hanahan et al., Nature 315:115-122 (1985)), immunoglobulin gene control region which is active in lymphoid cells (Grosschedl et al., Cell 38:647-658 (1984); Adams et al., Nature 318:533-538 (1985); Alexander et al., Mol. Cell. Biol. 7:1436-1444 (1987)), mouse mammary tumor virus control region which is active in testicular, breast, lymphoid and mast cells (Leder et al., Cell 45:485-495 (1986)), albumin gene control region which is active in liver (Pinckert et al., Genes and Devel. 1:268-276 (1987)), alpha-fetoprotein gene control region which is active in liver (Krumlauf et al., Mol. Cell. Biol. 5:1639-1648 (1985); Hammer et al., Science 235:53-58 1987)), alpha-1 antitrypsin gene control region which is active in liver (Kelsey et al., Genes and Devel. 1:161-171 (1987)), beta globin gene control region which is active in myeloid cells (Mogram et al., Nature 315:338-340 (1985); Kollias et al., Cell 46:89-94 (1986)), myelin basic protein gene control region which is active in oligodendrocyte cells of the brain (Readhead et al., Cell 48:703-712 (1987)), myosin light chain-2 gene control region which is active in skeletal muscle (Sani, Nature 314:283-286 (1985)), and gonadotrophic releasing hormone gene control region which is active in gonadotrophs of the hypothalamus (Mason et al., Science 234:1372-1378 (1986)).

In a specific embodiment, a vector is used that contains a promoter operably linked to nucleic acids encoding a desired protein, or a domain, fragment, derivative or homolog, thereof, one or more origins of replication, and optionally, one or more selectable markers (e.g., an antibiotic resistance gene). Exemplary plasmid vectors for transformation of E. coli cells, include, for example, the pET expression vectors (see, U.S. Pat. No. 4,952,496; available from NOVAGEN®, Madison, Wis., through EMD Biosciences; see, also literature published by Novagen describing the system), with which target genes are expressed under control of strong bacteriophage T7 transcription and translation signals, induced by providing a source of T7 RNA polymerase in the host cell. Such vectors include the pET-28a-c vectors, which carry an N-terminal His•Tag®/thrombin/T7•Tag® configuration plus an optional C-terminal His•Tag sequence, vectors and the pET 11a, which contains the T71ac promoter, T7 terminator, the inducible E. coli lac operator, and the lac repressor gene; pET 12a-c, which contains the T7 promoter, T7 terminator, and the E. coli ompT secretion signal; and pET 15b and pET19b (NOVAGEN, Madison, Wis.), which contain a His-Tag™ leader sequence for use in purification with a His column and a thrombin cleavage site that permits cleavage following purification over the column, the T7-lac promoter region and the T7 terminator; as well as the pETDuet coexpression vectors, which are T7 promotor expression vectors designed to coexpress two target proteins in E. coli, for example, the pETDuet™ vector, which carries the ColE1 replicon and bla gene (ampicillin resistance) (Novagen®), for example, pETDuet-1, which is designed for the coexpression of two target genes and encodes two multiple cloning sites (MCS), each of which is preceded by a T7 promoter, lac operator and ribosome binding site (rbs) and carries the pBR322-derived ColE1 replicon, lad gene and ampicillin resistance gene.

Other exemplary plasmid vectors for transformation of E. coli cells, include, for example, pQE expression vectors (available from Qiagen, Valencia, Calif.; see also literature published by Qiagen describing the system). pQE vectors have a phage T5 promoter (recognized by E. coli RNA polymerase) and a double lac operator repression module to provide tightly regulated, high-level expression of recombinant proteins in E. coli, a synthetic ribosomal binding site (RBS II) for efficient translation, a 6×His tag coding sequence, t₀ and T1 transcriptional terminators, ColE1 origin of replication, and a beta-lactamase gene for conferring ampicillin resistance. The pQE vectors enable placement of a 6×His tag at either the N- or C-terminus of the recombinant protein. Such plasmids include pQE 32, pQE 30, and pQE 31 which provide multiple cloning sites for all three reading frames and provide for the expression of N-terminally 6×His-tagged proteins.

2. Display Vectors

Typically, when the polypeptides will be displayed on the surface of genetic packages, display vectors are used. Any display vector, for example, bacterial, viral, fungal or yeast display vector can be used. Typically, the polypeptides will be displayed in a phage display library and the duplex cassettes are ligated into phage display vectors, typically phagemid vectors. Typically, the phagemid vectors containing the duplex cassettes are used to express the variant polypeptides as part of a fusion protein with a phage coat protein.

a. Phagemid and Phage Vectors

For generating collections of variant polypeptides, for example, phage display libraries, phagemid vectors typically are used. Phagemid vectors typically contain less than 6000 nucleotides and do not contain a sufficient set of phage genes for production of stable phage particles after transformation of host cells. The necessary phage genes typically are provided by co-infection of the host cell with helper phage, for example M13K01 or M13VCS. Typically, the helper phage provides an intact copy of the gene III coat protein and other phage genes required for phage replication and assembly. Because the helper phage has a defective origin of replication, the helper phage genome is not efficiently incorporated into phage particles relative to the plasmid that has a wild type origin. Thus, the phagemid vector includes a phage origin of replication, for incorporation of the vector can be packaged into bacteriophage particles when host cells, for example, bacterial cells, transformed with the phagemid, are infected with helper phage, e.g. M13K01 or M13VCS. See, e.g., U.S. Pat. No. 5,821,047. The phagemid genome typically contains a selectable marker gene, e.g. Amp.sup.R or Kan.sup.R (for ampicillin or kanamycin resistance, respectively) for the selection of cells that are infected by a member of the library.

Alternatively, the duplex cassettes can be transformed into the bacteriophage genome, using phage vectors. In this example, the vector is the genetic package and is used to infect host cells for expression of the variant polypeptides.

Nucleic acids suitable for phage display, e.g., phage vectors and phagemid vectors, are known in the art (see, e.g., Andris-Widhopf et al. (2000) J Immunol Methods, 28: 159-81; Armstrong et al. (1996) Academic Press, Kay et al., Ed. pp. 35-53; Corey et al. (1993) Gene 128(1):129-34; Cwirla et al. (1990) Proc Natl Acad Sci USA 87(16):6378-82; Fowlkes et al. (1992) Biotechniques 13(3):422-8; Hoogenboom et al. (1991) Nuc Acid Res 19(15):4133-7; McCafferty et al. (1990) Nature 348(6301):552-4; McConnell et al. (1994) Gene 151(1-2):115-8; Scott and Smith (1990) Science 249(4967):386-90). Typically, the phagemid vector or phage vector contains nucleic acids encoding all or part of a phage coat protein, for the generation of fusion proteins containing the variant polypeptides.

The vectors can be constructed by standard cloning techniques to contain nucleic acid encoding a polypeptide that includes a variant or target polypeptide and a portion of a phage coat protein, and which is operably linked to a regulatable promoter. In some examples, a phage display vector includes two nucleic acids that encode the same region of a phage coat protein. For example, the vector includes one sequence that encodes such a region in a position operably linked to the sequence encoding the display protein, and another sequence which encodes such a region in the context of the functional phage gene (e.g., a wild-type phage gene) that encodes the coat protein. Expression of the wild-type and fusion coat proteins can aid in the production of mature phage by lowering the amount of fusion protein made per phage particle. Such methods are particularly useful in situations where the fusion protein is less tolerated by the phage.

b. Nucleic Acids Encoding Coat Proteins and Portions of Fusion Proteins

Phage display systems typically utilize filamentous phage, such as M13, fd, and fl. In some examples using filamentous phage, the display protein is fused to a phage coat protein anchor domain. In order to generate phage display libraries containing fusion proteins with the variant and/or target polypeptides, the duplex cassettes are ligated into the vectors in such a way that the variant polynucleotides encoding the variant polypeptides are near, typically adjacent or nearly adjacent to (along the linear nucleic acid sequence), the nucleic acid encoding a phage coat protein, such as 5′ of the nucleic acid encoding the coat protein. For example, the variant polynucleotide encoding the variant polypeptide can be fused to nucleic acids encoding the C-terminal domain of filamentous phase M13 Gene III (gIIIp; g3p; cp3, gene 3 protein)

Phage coat proteins that can be used for display of the variant polypeptides include (i) minor coat proteins of filamentous phage, such as gene III protein (gIIIp), and (ii) major coat proteins of filamentous phage such as gene VIII protein (gVIIIp). Fusions to other phage coat proteins such as gene VI protein, gene VII protein, or gene IX protein also can be used (see, e.g., WO 00/71694). Alternatively, nucleic acids encoding portions (e.g., domains or fragments) of these proteins can be used. Useful portions include domains that are stably incorporated into the phage particle, e.g., so that the fusion protein remains in the particle throughout a selection procedure, for example, a selection procedure as described below. In one example, the anchor domain of gIIIp is used (see, e.g., U.S. Pat. No. 5,658,727). In another example, gVIIIp is used (see, e.g., U.S. Pat. No. 5,223,409), which can be a mature, full-length gVIIIp fused to the display protein. The filamentous phage display systems typically use protein fusions to attach the heterologous amino acid sequence to a phage coat protein or anchor domain. For example, the phage can include a gene that encodes a signal sequence, the heterologous amino acid sequence, and the anchor domain, e.g., a gIIIp anchor domain.

Valency of the fusion protein displayed on the genetic package can be controlled by choice of phage coat protein and the nucleic acids encoding the coat protein. For example, gIIIp proteins typically are incorporated into the phage coat at three to five copies per virion. Fusion of gIIIp to variant proteases thus produces a low-valency. In comparison, gVIII proteins typically are incorporated into the phage coat at 2700 copies per virion (Marvin (1998) Curr. Opin. Struct. Biol. 8:150-158). Due to the high-valency of gVIIIp, peptides greater than ten residues are generally not well tolerated by the phage. Phagemid systems can be used to increase the tolerance of the phage to larger peptides, by providing wild-type copies of the coat proteins to decrease the valency of the fusion protein. Additionally, mutants of gVIIIp can be used which are optimized for expression of larger peptides. In one such example, a mutant gVIIp was obtained in a mutagenesis screen for gVIIIp with improved surface display properties (Sidhu et al. (2000) J. Mol. Biol. 296:487-495).

In one example, the vector is designed so that the fusion protein encoded by the vector further includes a flexible peptide linker or spacer, a tag or detectable polypeptide, a protease site, or additional amino acid modifications to improve the expression and/or utility of the fusion protein. For example, addition of a nucleic acid encoding a protease site can allow for efficient recovery of desired bacteriophages following a selection procedure. Exemplary tags and detectable proteins are known in the art and include for example, but not limited to, a histidine tag, a hemagglutinin tag, a myc tag or a fluorescent protein. In another example, the nucleic acid encoding the protease-coat protein fusion can be fused to a leader sequence in order to improve the expression of the polypeptide. Exemplary of leader sequences include, but are not limited to, STII or OmpA. Phage display is described, for example, in Barbas, C. F., 3rd et al., 2001. Phage Display: A Laboratory Manual. Cold Spring Harbor Laboratory Press, Cold Spring Harbor, N.Y.; Ladner et al., U.S. Pat. No. 5,223,409; Rodi et al. (2002) Curr. Opin. Chem. Biol. 6:92-96; Smith (1985) Science 228:1315-1317; WO 92/18619; WO 91/17271; WO 92/20791; WO 92/15679; WO 93/01288; WO 92/01047; WO 92/09690; WO 90/02809; de Haard et al. (1999) J. Biol. Chem. 274:18218-30; Hoogenboom et al. (1998) Immunotechnology 4:1-20; Hoogenboom et al. (2000) Immunol Today 2:371-8; Fuchs et al. (1991) Bio/Technology 9:1370-1372; Hay et al. (1992) Hum Antibody Hybridomas 3:81-85; Huse et al. (1989) Science 246:1275-1281; Griffiths et al. (1993) EMBO J. 12:725-734; Hawkins et al. (1992) J Mol Biol 226:889-896; Clackson et al. (1991) Nature 352:624-628; Gram et al. (1992) PNAS 89:3576-3580; Garrard et al. (1991) Bio/Technology 9:1373-1377; Rebar et al. (1996) Methods Enzymol. 267:129-49; Hoogenboom et al. (1991) Nuc Acid Res 19:4133-4137; and Barbas et al. (1991) PNAS 88:7978-7982.

i. Stop Codons

Additionally, a nucleic acid encoding a termination or stop codon can be included in the vector sequence between the nucleic acid encoding the variant/target polypeptide and the nucleic acid encoding the coat protein. Such termination or stop codons include, for example, the amber stop codon (UAG (encoded by TAG)), the ochre stop codon (UAA) and the opal stop codon (UGA). The presence of such a termination or stop codon in a non-suppressor host cell results in synthesis of a non-fusion protein, which contains the target or variant polypeptide, without the coat protein. In a suppressor strain (e.g. an amber suppressor strain), typically a partial suppressor strain, which contain mutations resulting in altered tRNA allowing reading of the stop codon or “read-through,” translation continues without being halted by the stop codon, thereby generating detectable quantities of fusion protein, which contains the target/variant polypeptide and the coat protein. In the case of a partial suppressor strain, the fusion and non-fusion protein are produced. Such suppressor host strains are well known and described (see, for example, Bullock et al., Biotechniques 5:376-379); exemplary suppressor strains are described herein below.

Thus, in one example, the presence of a stop codon, typically an amber stop codon, between the sequence encoding the polypeptide of interest and the coat protein, is used in order to regulate expression of the fusion protein versus the variant polypeptide alone, by using an amber-suppressor strain of host cell. In one such example of the provided methods, the amber stop codon is included between the 3′ end of a variant polynucleotide encoding an antibody heavy chain and a nucleic acid encoding a phage coat protein, for example, gene III coat protein. In one example, when an amber stop codon is included, an amber suppressor strain, for example, XL-1 blue cells and ER2738 cells are used to express the polypeptides. In this example, the suppressor strains allow “read-through,” translation that continues without being halted by the amber stop codon.

Typically, depending on the suppressor strain, this “read-through” occurs only a certain percentage of the time. This partial read-through of the amber-stop results in a mixed collection of polypeptides. The mixed population contains some fusion proteins and some variant polypeptides that are not part of fusion proteins with phage coat proteins, and thus, are soluble. In one example, the mixed population contains between 50% or about 50% and 75% or about 75% soluble variant polypeptide, for example, soluble heavy chain polypeptide, and between 25% or about 25% and 50% or about 50% variant polypeptide-coat protein fusion protein. In one example, the soluble variant polypeptide interacts with the fusion protein, for example, through hydrophobic interactions and/or disulfide bonds, so that both polypeptides are expressed on the surface of the phage.

c. Promoters

Regulatable promoters also can be used to control the valency of the display protein. Regulated expression can be used to produce phage that have a low valency of the display protein. Many regulatable (e.g., inducible and/or repressible) promoter sequences are known. Such sequences include regulatable promoters whose activity can be altered or regulated by the intervention of the user, e.g., by manipulation of an environmental parameter, such as, for example, temperature or by addition of stimulatory molecule or removal of a repressor molecule. For example, an exogenous chemical compound can be added to regulate transcription of some promoters. Regulatable promoters can contain binding sites for one or more transcriptional activator or repressor protein. Synthetic promoters that include transcription factor binding sites can be constructed and also can be used as regulatable promoters. Exemplary regulatable promoters include promoters responsive to an environmental parameter, e.g., thermal changes, hormones, metals, metabolites, antibiotics, or chemical agents. Regulatable promoters appropriate for use in E. coli include promoters which contain transcription factor binding sites from the lac, tac, trp, trc, and tet operator sequences, or operons, the alkaline phosphatase promoter (pho), an arabinose promoter such as an araBAD promoter, the rhamnose promoter, the promoters themselves, or functional fragments thereof (see, e.g., Elvin et al. (1990) Gene 37: 123-126; Tabor and Richardson, (1998) Proc. Natl. Acad. Sci. U.S.A. 1074-1078; Chang et al. (1986) Gene 44: 121-125; Lutz and Bujard, (1997) Nucl. Acids. Res. 25: 1203-1210; D. V Goeddel et al. (1979) Proc. Nat. Acad. Sci. U.S.A., 76:106-110; J. D. Windass et al. (1982) Nucl. Acids. Res., 10:6639-57; R. Crowl et al. (1985) Gene, 38:31-38; Brosius (1984) Gene 27: 161-172; Amanna and Brosius, (1985) Gene 40: 183-190; Guzman et al. (1992) J. Bacteriol., 174: 7716-7728; Haldimann et al. (1998) J. Bacteriol., 180: 1277-1286).

The lac promoter, for example, can be induced by lactose or structurally related molecules such as isopropyl-beta-D-thiogalactoside (IPTG) and is repressed by glucose. Some inducible promoters are induced by a process of derepression, e.g., inactivation of a repressor molecule.

A regulatable promoter sequence also can be indirectly regulated. Examples of promoters that can be engineered for indirect regulation include: the phage lambda PR, PL, phage T7, SP6, and T5 promoters. For example, the regulatory sequence is repressed or activated by a factor whose expression is regulated, e.g., by an environmental parameter. One example of such a promoter is a T7 promoter. The expression of the T7 RNA polymerase can be regulated by an environmentally-responsive promoter such as the lac promoter. For example, the cell can include a heterologous nucleic acid that includes a sequence encoding the T7 RNA polymerase and a regulatory sequence (e.g., the lac promoter) that is regulated by an environmental parameter. The activity of the T7 RNA polymerase also can be regulated by the presence of a natural inhibitor of RNA polymerase, such as T7 lysozyme.

In another configuration, the lambda PL can be engineered to be regulated by an environmental parameter. For example, the cell can include a nucleic acid that encodes a temperature sensitive variant of the lambda repressor. Raising cells to the non-permissive temperature releases the PL promoter from repression. The regulatory properties of a promoter or transcriptional regulatory sequence can be easily tested by operably linking the promoter or sequence to a sequence encoding a reporter protein (or any detectable protein). This promoter-report fusion sequence is introduced into a bacterial cell, typically in a plasmid or vector, and the abundance of the reporter protein is evaluated under a variety of environmental conditions. A useful promoter or sequence is one that is selectively activated or repressed in certain conditions.

In some embodiments, non-regulatable promoters are used. For example, a promoter can be selected that produces an appropriate amount of transcription under the relevant conditions. An example of a non-regulatable promoter is the gIII promoter.

Phage display vectors can further include a site into which a foreign nucleic acid can be inserted, such as a multiple cloning site containing restriction enzyme digestion sites. Foreign nucleic acid sequences, e.g., nucleic acids that encode display proteins in phage vectors, can be linked to a ribosomal binding site, a signal sequence (e.g., a M13 signal sequence), and a transcriptional terminator sequence.

d. Vector Design and Methods for Phage-Display of Domain-Exchange Antibody Fragments

It is discovered herein that display of domain exchanged antibodies and fragments thereof on phage, using conventional display methods, is not straightforward. For example, as noted hereinabove, a conventional Fab fragment contains one light chain (V_{L} and CO and a heavy chain fragment, containing a variable domain of a heavy chain (V_{H}) and one constant region domain of the heavy chain (C_{H}1). Conventional phage display methods thus can be used to generate phage displayed Fab fragments, for example, by generating a vector for expression of a heavy chain-coat protein fusion polypeptide and a native light chain polypeptide, which interact to form the Fab fragment.

In contrast, the variable heavy chain domain of a domain-exchange antibody “swings away” from its cognate light chain, and instead interacts with the “opposite” light chain (the light chain other than the light chain with which the variable constant region interacts). Mutations in the heavy chain (e.g. mutations in the joining region between the V_{H} and C_{H} regions in domain exchanged antibodies) and/or additional framework mutations along the V_{H}-V_{H}′ interface, can promote and/or stabilize this domain-exchanged configuration. Because of this altered configuration, a domain-exchange Fab fragment contains not the typical heavy chain/light chain pair, but a pair of interlocked Fabs where each V_{H} domain interacts with the V_{L} domain that is “opposite” to the interaction that occurs through the constant regions. Due to this unusual configuration, conventional means of expressing a heavy chain-coat protein fusion and a native light chain cannot be used to display domain exchanged antibody Fab fragments. Display of other domain exchanged fragments, for example, scFv domain exchanged fragments, presents similar limitations.

Accordingly, provided herein are methods and vectors for display of domain exchanged antibodies and fragments on phage. These methods and vectors are described herein below. In one example provided herein, it is determined that expression of two distinct heavy chains—one (V_{H}) expressed as part of a fusion protein with a genetic package coat protein, and the other (V_{H}′) expressed as a native heavy chain, can be used along with light chain polypeptides to display domain exchanged Fab fragments on phage. In one example, the two distinct heavy chains are encoded by and expressed from a single genetic element, e.g. a single nucleic acid (sequence of nucleotides) in a vector. Thus, in this example, because they are encoded by a single genetic element, the amino acid sequences of the two heavy chains (V_{H} and V_{H}′) within the two polypeptides are 100% identical.

i. Exemplary Provided Vectors

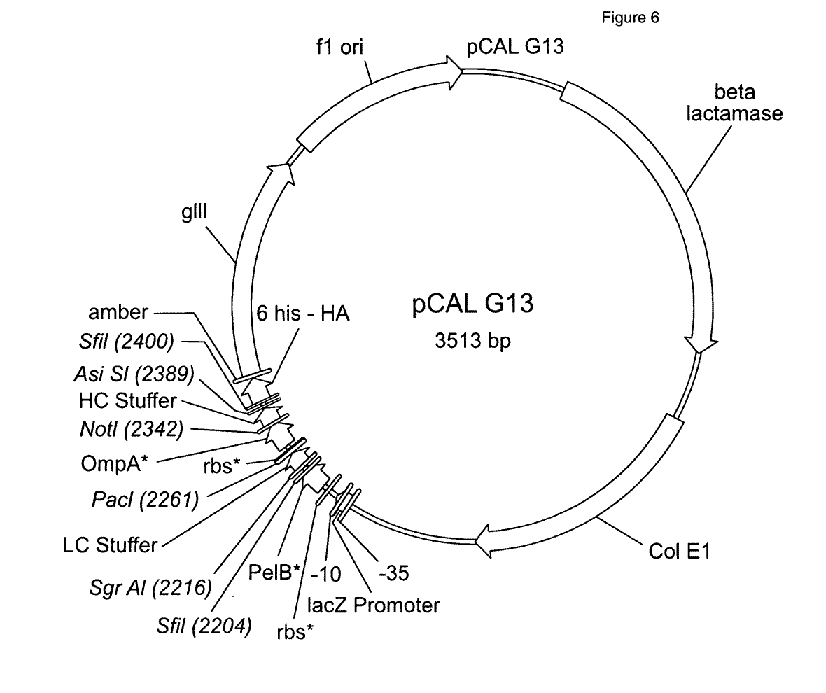

Provided herein are display vectors, e.g. phage display vectors, for expression and display of the variant polypeptides, including variant antibody polypeptides, and methods for making the vectors. Exemplary provided phage display vectors, which can be used in the provided methods, are pCAL vectors containing a sequence of nucleotides encoding the C-terminal domain of filamentous phase M13 Gene III coat protein. Exemplary of the pCAL vectors are, pCAL G13 and pCAL A1, having the sequences of nucleotides set forth in SEQ ID NOs.: 7 and 8, respectively. These vectors were constructed using the methods described in Example 9, below. A map of pCAL G13 is shown in FIG. 6. pCAL G13 and pCAL A1 contain the gill gene encoding the M13 gene III coat protein, preceded by a multiple cloning site, into which a polynucleotide, for example, a polynucleotide containing a target polynucleotide, can be inserted. Exemplary provided vectors are described in detail in Section J(3), below. Any of the vectors described in that section can be used with the provided methods for generating diverse protein libraries.

Each of these vectors further contains an amber stop codon DNA sequence (TAG, SEQ ID NO: 9) encoding the RNA amber stop codon (UAG; SEQ ID NO: 10), just upstream of the geneIII coding sequence. Thus, the vectors are designed such that polynucleotides, e.g. target/variant polynucleotides, can be inserted just upstream of the amber stop codon. This amber stop codon is included so that expression of target/variant polypeptide-gene III fusion protein vs. native target/variant polypeptide expression can be regulated by using different host cells. For example, amber-suppressor or partial amber-suppressor strains, which allow read-through (translation of protein through the amber stop codon), when it is desired to express full-length fusion proteins containing the target/variant polypeptides. On the other hand, a non-amber suppressor strain can be used when no read-through is desired, to produce native target/variant polypeptides from the vectors.

These two different pCAL vectors provided herein result in different amounts of readthrough through the amber-stop codon. The pCAL G 13 vector contains a guanine residue at the position just 5′ of the amber stop codon, while the pCAL A1 vector contains an adenine at this position. Thus, the choice of vector will determine how much read-through occurs through the amber stop codon when using a partial suppressor strain, thus controlling the relative amount of fusion versus non-fusion target/variant polypeptide translated from the vector.

Exemplary of vectors into which assembled duplexes are inserted are pCAL G13 and pCAL A1 vectors that contain inserted polynucleotide sequences containing the target polynucleotide. In one example, a pCAL G13 vector containing nucleic acids encoding the heavy and light chain variable regions of an antibody polypeptide is used. In one example, the vector contains heavy and light chain domains of a domain exchanged antibody, such as, but not limited to, the 2G12 antibody, which recognizes the HIV gp120 antigen, and the 3-Ala 2G12 antibody, which contains 3 mutations in the antibody combining site compared to the 2G12 antibody, rendering the antibody incapable of binding to the natural cognate antigen of the 2G12 antibody, HIV gp120 (the HIV envelope surface glycoprotein, gp120, GENBANK gi:28876544, which is generated by cleavage of the precursor, gp160, GENBANK g.i. 9629363). In one example, the vector is a 2G12 pCAL G13, SEQ ID NO: 11, which contains a nucleic acid encoding heavy and light chain domains of the 2G12 antibody. Exemplary vectors for expression of domain exchanged antibody fragments are described in Example 10 below.

### G. TRANSFORMATION OF HOST CELLS WITH VECTORS CONTAINING THE DUPLEX CASSETTES, AMPLIFICATION, EXPRESSION

After insertion of the duplex cassettes into vectors, the vectors are used to transform host cells. In some examples, transformation of host cells with recombinant DNA molecules that incorporate the polynucleotide, e.g. an isolated gene, cDNA, or synthesized DNA sequence, enables generation of multiple copies of the polynucleotide, e.g. the target polynucleotide (amplification). Thus, the polynucleotides, such as the provided variant polynucleotides, can be obtained in large quantities by growing transformants, isolating the recombinant DNA molecules from the transformants and, when necessary, retrieving the inserted gene from the isolated recombinant DNA.

Thus, host cells containing the vectors with the target and variant polynucleotides also are provided. The cells include eukaryotic and prokaryotic cells and the vectors include any suitable vectors for use therein. Exemplary of the provided cells are bacterial cells, yeast cells, fungal cells, Archea, plant cells, insect cells and animal cells.

Various host cells are used in to receive, maintain, reproduce and amplify the vector, and for expression of the polypeptides encoded by the vectors, for example, in phage display libraries. For example, the duplex cassette contained in the vector is replicated when the host cell divides, thereby amplifying the cassette nucleic acids. Amplification of the nucleic acids is useful, for example, for isolation of the nucleic acids encoding the cassettes, for example, in order to determine the nucleic acid sequence of the cassettes, or for use in transformation of other host cells. Expression of polynucleotides encoded by the vectors also can be induced in the host cells, for example, by adding IPTG to cell cultures. Polypeptide expression can be useful, for example, in order to isolate and analyze variant polypeptides encoded by collections of variant duplex cassettes. In one example, the host cells are phage-display compatible host cells, and are used to display the variant polypeptides on the surface of a genetic package (e.g. a bacteriophage), for example, in a phage display library. This method can be used to screen, analyze and select variant polypeptides based on various properties, according to the provided methods.

1. Types of Host Cells

A variety of host cells can be transformed with the vectors containing the duplex cassette inserts. These include but are not limited to mammalian cell systems infected with virus (e.g. vaccinia virus, adenovirus and other viruses); insect cell systems infected with virus (e.g. baculovirus); microorganisms such as yeast containing yeast vectors; or bacteria transformed with bacteriophage, DNA, plasmid DNA, or cosmid DNA. The expression elements of vectors vary in their strengths and specificities. Depending on the host-vector system used, any one of a number of suitable transcription and translation elements can be used.

Choice of host cell can depend on whether amplification, polypeptide expression, and/or display on a genetic package, is desired. In one example, the same host cell is used to amplify the nucleic acids, express the polypeptide and for display on a genetic package. In another example, the vectors are transformed into different host cells for these different processes. Methods for transforming host cells are well known. Any known transformation method, for example, electroporation, can be used to transform the host cell with the vector DNA.

Typically, it is desired to express the variant polypeptides on the surface of genetic packages, for example, in a phage display library. In this example, a host cell is selected that is compatible with display of the polypeptide on genetic package. Typically, the genetic package is a virus, for example, a bacteriophage, and a host cell is chosen that can be infected with bacteriophage, and accommodate the packaging of phage particles, for example XL-1 blue cells. In another example, the host cell is the genetic package, for example, a bacterial cell genetic package, that expresses the variant polypeptide on the surface of the host cell.

In one example, as noted above, the host cells are partial amber-suppressor cells, which allow some percentage of “read-though,” translation through an amber stop codon in the nucleic acid sequence encoding the variant polypeptide. Exemplary suppressor (e.g. partial suppressor) host cells and systems are described in detail in Section J(4) below, and can be used as host cells with the provided methods and libraries. Typically, when an amber stop codon is located in the vector, within the region encoding a fusion protein (e.g. between the nucleic acid encoding the variant polypeptide and the nucleic acid encoding the phage coat protein) an amber suppressor or partial amber suppressor host cell strain is used in order to express display fusion proteins containing the polypeptides.

2. Amplification

In one example, vectors, such as the provided display vectors and other vectors, are used to transform host cells for amplification of nucleic acids encoding the provided polypeptides. When the vectors are used to transform host cells, the nucleic acids are replicated as the host cell divides, amplifying the nucleic acids.

Nucliec acids are amplified, for example, to isolate the nucleic acids encoding polypeptides such as displayed polypeptides, e.g. to determine the nucleic acid sequence or for use in transformation of other host cells. In one example, after transforming the host cells with the vectors, the host cells are incubated in medium, for example, SOC (Super Optimal Catabolite) medium (Invitrogen™; for 1 liter: 20 grams (g) Bacto Tryptone; 5 g Yeast Extract; 0.58 g Sodium Chloride (NaCl); 0.186 g Potassium Chloride (KCl) in distilled water); SB (Super Broth) medium (for 1 liter: 30 g tryptone, 20 g yeast extract, 10 g MOPS in distilled water); or LB (Luria broth) medium (for 1 L: 10 g Bacto Tryptone; 5 g yeast extract; 10 g NaCl, in distilled water) in the presence of one or more antibiotics, for selection of cells successfully transformed with vector nucleic acids containing insert, typically at 37° C. In one example, the incubated host cells are grown overnight at 37° C. on agar plates supplemented with one or more antibiotics and/or glucose, for generation of clonal colonies, each containing host cells transformed with a single vector nucleic acid.

One or more colonies can be picked for isolation of nucleic acids for use in subsequent steps, for example, in nucleic acid sequencing. Alternatively, picked colonies can be pooled and used to re-transform additional host cells, for example, phage-compatible host cells. In another example, the colonies can be picked and grown, and then the cultures used to induce protein expression from the host cells, for example, to assay expression of the variant polypeptides in the host cells, prior to phage display.

The colonies can be used to determine transformation efficiency, for example, by calculating the number of transformants generated from a library, by multiplying the number of colonies by the culture volume and dividing by the plating volume (same units), using the following equation: [# colonies/plating volume×[culture volume)/microgram DNA]×dilution factor.

3. Expression of Polypeptides

In another example, expression of polynucleotides encoded by the vectors is induced in host cells. Induction of polypeptide expression can be used to isolate and analyze polypeptides encoded by nucleic acids, such as nucleic acid libraries, encoding the polypeptides. Host cells for expression include display-compatible host cells (e.g. phage display compatible), which can be used to display the polypeptides on the surface of a genetic package (e.g. a bacteriophage), for example, in a phage display library.

In one example, polypeptide expression is induced from the host cells for isolation and analysis of the polypeptides, for example, to determine if polypeptides in a collection bind a particular binding partner, e.g. an antigen. Methods for inducing polypeptide expression from host cells are well known and vary depending on choice of vector and host cell. In one example, one or more colonies is picked and grown in medium supplemented with antibiotic and grown until a desired Optical Density (O.D.) is reached. Protein expression then can be induced by well-known methods, for example, by addition of isopropyl-beta-D-thiogalactopyranoside (IPTG) and continued growth.

Methods for purification of polypeptides, including domain exchanged antibodies, from host cells will depend on the chosen host cells and expression systems. For secreted molecules, proteins generally are purified from the culture media after removing the cells. For intracellular expression, cells can be lysed and the proteins purified from the extract. In one example, polypeptides are isolated from the host cells by centrifugation and cell lysis (e.g. by repeated freeze-thaw in a dry ice/ethanol bath), followed by centrifugation and retention of the supernatant containing the polypeptides. When transgenic organisms such as transgenic plants and animals are used for expression, tissues or organs can be used as starting material to make a lysed cell extract. Additionally, transgenic animal production can include the production of polypeptides in milk or eggs, which can be collected, and if necessary further the proteins can be extracted and further purified using standard methods in the art.

Proteins, such as the provided domain exchanged antibodies, can be purified, for example, from lysed cell extracts, using standard protein purification techniques known in the art including but not limited to, SDS-PAGE, size fraction and size exclusion chromatography, ammonium sulfate precipitation and ionic exchange chromatography, such as anion exchange. Affinity purification techniques also can be utilized to improve the efficiency and purity of the preparations. For example, antibodies, receptors and other molecules that bind proteases can be used in affinity purification. Expression constructs also can be engineered to add an affinity tag to a protein such as a myc epitope, GST fusion or His₆ and affinity purified with myc antibody, glutathione resin and Ni-resin, respectively. Purity can be assessed by any method known in the art including gel electrophoresis and staining and spectrophotometric techniques.

The isolated polypeptides then can be analyzed, for example, by separation on a gel (e.g. SDS-Page gel), size fractionation (e.g. separation on a Sephacryl™ S-200 HiPrep™ 16×60 size exclusion column (Amersham from GE Healthcare Life Sciences, Piscataway, N.J.). Isolated polypeptides can also be analyzed in binding assays, typically binding assays using a binding partner bound to a solid support, for example, to a plate (e.g. ELISA-based binding assays) or a bead, to determine their ability to bind desired binding partners. The binding assays described in the sections below, which are used to assess binding of precipitated phage displaying the polypeptides, also can be used to assess polypeptides isolated directly from host cell lysates. For example, binding assays can be carried out to determine whether antibody polypeptides bind to one or more antigens, for example, by coating the antigen on a solid support, such as a well of an assay plate and incubating the isolated polypeptides on the solid support, followed by washing and detection with secondary reagents, e.g. enzyme-labeled antibodies and substrates.

Polypeptides, such as any set forth herein, including antibodies or fragments thereof, can be produced by any method known to those of skill in the art including in vivo and in vitro methods. Desired polypeptides can be expressed in any organism suitable to produce the required amounts and forms of the proteins, such as for example, needed for analysis, administration and treatment. Expression hosts include prokaryotic and eukaryotic organisms such as E. coli, yeast, plants, insect cells, mammalian cells, including human cell lines and transgenic animals. Expression hosts can differ in their protein production levels as well as the types of post-translational modifications that are present on the expressed proteins. The choice of expression host can be made based on these and other factors, such as regulatory and safety considerations, production costs and the need and methods for purification.

Many expression vectors are available and known to those of skill in the art and can be used for expression of polypeptides. The choice of expression vector will be influenced by the choice of host expression system. In general, expression vectors can include transcriptional promoters and optionally enhancers, translational signals, and transcriptional and translational termination signals. Expression vectors that are used for stable transformation typically have a selectable marker which allows selection and maintenance of the transformed cells. In some cases, an origin of replication can be used to amplify the copy number of the vector.

a. Host Cells and Systems for Expression

A variety of host cells can be used. These include but are not limited to mammalian cell systems infected with virus (e.g. vaccinia virus, adenovirus and other viruses); insect cell systems infected with virus (e.g. baculovirus); microorganisms such as yeast containing yeast vectors; or bacteria transformed with bacteriophage, DNA, plasmid DNA, or cosmid DNA. The expression elements of vectors vary in their strengths and specificities. Depending on the host-vector system used, any one of a number of suitable transcription and translation elements can be used.

For display of the polypeptides on genetic packages, a host cell is selected that is compatible with such display. Typically, the genetic package is a virus, for example, a bacteriophage, and a host cell is chosen that can be infected with bacteriophage, and accommodate the packaging of phage particles, for example XL1-Blue cells. In another example, the host cell is the genetic package, for example, a bacterial cell genetic package, that expresses the variant polypeptide on the surface of the host cell.

i. Prokaryotic Cells

Prokaryotes, especially E. coli, provide a system for producing large amounts of proteins. Typically, E. coli host cells are used for amplification and expression of the provided variant polypeptides. Transformation of E. coli is simple and rapid technique well known to those of skill in the art. Expression vectors for E. coli can contain inducible promoters, such promoters are useful for inducing high levels of protein expression and for expressing proteins that exhibit some toxicity to the host cells. Examples of inducible promoters include the lac promoter, the trp promoter, the hybrid tac promoter, the T7 and SP6 RNA promoters and the temperature regulated λPL promoter.

Proteins, such as any provided herein, can be expressed in the cytoplasmic environment of E. coli. For some polypeptides, the cytoplasmic environment, can result in the formation of insoluble inclusion bodies containing aggregates of the proteins. Reducing agents such as dithiothreotol and β-mercaptoethanol and denaturants, such as guanidine-HCl and urea can be used to resolubilize the proteins, followed by subsequent refolding of the soluble proteins. An alternative approach is the expression of proteins in the periplasmic space of bacteria which provides an oxidizing environment and chaperonin-like and disulfide isomerases and can lead to the production of soluble protein. For example, for phage display of the proteins, the proteins are exported to the periplasm so that they can be assembled into the phage. Typically, a leader sequence is fused to the protein to be expressed which directs the protein to the periplasm. The leader is then removed by signal peptidases inside the periplasm. Examples of periplasmic-targeting leader sequences include the pelB leader from the pectate lyase gene and the leader derived from the alkaline phosphatase gene. In some cases, periplasmic expression allows leakage of the expressed protein into the culture medium. The secretion of proteins allows quick and simple purification from the culture supernatant. Proteins that are not secreted can be obtained from the periplasm by osmotic lysis. Similar to cytoplasmic expression, in some cases proteins can become insoluble and denaturants and reducing agents can be used to facilitate solubilization and refolding. Temperature of induction and growth also can influence expression levels and solubility, typically temperatures between 25° C. and 37° C. are used. Typically, bacteria produce aglycosylated proteins. Thus, if proteins require glycosylation for function, glycosylation can be added in vitro after purification from host cells.

ii. Yeast Cells

Yeasts such as Saccharomyces cerevisae, Schizosaccharomyces pombe, Yarrowia lipolytica, Kluyveromyces lactis and Pichia pastoris are well known yeast expression hosts that can be used for expression and production of polypeptides, such as any described herein. Yeast can be transformed with episomal replicating vectors or by stable chromosomal integration by homologous recombination. Typically, inducible promoters are used to regulate gene expression. Examples of such promoters include GAL1, GAL7 and GAL5 and metallothionein promoters, such as CUP1, AOX1 or other Pichia or other yeast promoter. Expression vectors often include a selectable marker such as LEU2, TRP1, HIS3 and URA3 for selection and maintenance of the transformed DNA. Proteins expressed in yeast are often soluble. Co-expression with chaperonins such as Bip and protein disulfide isomerase can improve expression levels and solubility. Additionally, proteins expressed in yeast can be directed for secretion using secretion signal peptide fusions such as the yeast mating type alpha-factor secretion signal from Saccharomyces cerevisae and fusions with yeast cell surface proteins such as the Aga2p mating adhesion receptor or the Arxula adeninivorans glucoamylase. A protease cleavage site such as for the Kex-2 protease, can be engineered to remove the fused sequences from the expressed polypeptides as they exit the secretion pathway. Yeast also is capable of glycosylation at Asn-X-Ser/Thr motifs.

iii. Insect Cells

Insect cells, particularly using baculovirus expression, are useful for expressing polypeptides such as variant polypeptides provided herein. Insect cells express high levels of protein and are capable of most of the post-translational modifications used by higher eukaryotes. Baculovirus have a restrictive host range which improves the safety and reduces regulatory concerns of eukaryotic expression. Typical expression vectors use a promoter for high level expression such as the polyhedrin promoter of baculovirus. Commonly used baculovirus systems include the baculoviruses such as Autographa califormica nuclear polyhedrosis virus (AcNPV), and the Bombyx mori nuclear polyhedrosis virus (BmNPV) and an insect cell line such as Sf9 derived from Spodoptera frugiperda, Pseudaletia unipuncta (A7S) and Danaus plexippus (DpN 1). For high-level expression, the nucleotide sequence of the molecule to be expressed is fused immediately downstream of the polyhedrin initiation codon of the virus. Mammalian secretion signals are accurately processed in insect cells and can be used to secrete the expressed protein into the culture medium. In addition, the cell lines Pseudaletia unipuncta (A7S) and Danaus plexippus (DpN1) produce proteins with glycosylation patterns similar to mammalian cell systems.

An alternative expression system in insect cells is the use of stably transformed cells. Cell lines such as the Schnieder 2 (S2) and Kc cells (Drosophila melanogaster) and C7 cells (Aedes albopictus) can be used for expression. The Drosophila metallothionein promoter can be used to induce high levels of expression in the presence of heavy metal induction with cadmium or copper. Expression vectors are typically maintained by the use of selectable markers such as neomycin and hygromycin.

iv. Mammalian Cells

Mammalian expression systems can be used to express proteins including the variant polypeptides provided herein. Expression constructs can be transferred to mammalian cells by viral infection such as adenovirus or by direct DNA transfer such as liposomes, calcium phosphate, DEAE-dextran and by physical means such as electroporation and microinjection. Expression vectors for mammalian cells typically include an mRNA cap site, a TATA box, a translational initiation sequence (Kozak consensus sequence) and polyadenylation elements. Such vectors often include transcriptional promoter-enhancers for high-level expression, for example the SV40 promoter-enhancer, the human cytomegalovirus (CMV) promoter and the long terminal repeat of Rous sarcoma virus (RSV). These promoter-enhancers are active in many cell types. Tissue and cell-type promoters and enhancer regions also can be used for expression. Exemplary promoter/enhancer regions include, but are not limited to, those from genes such as elastase I, insulin, immunoglobulin, mouse mammary tumor virus, albumin, alpha fetoprotein, alpha 1 antitrypsin, beta globin, myelin basic protein, myosin light chain 2, and gonadotropic releasing hormone gene control. Selectable markers can be used to select for and maintain cells with the expression construct. Examples of selectable marker genes include, but are not limited to, hygromycin B phosphotransferase, adenosine deaminase, xanthine-guanine phosphoribosyl transferase, aminoglycoside phosphotransferase, dihydrofolate reductase and thymidine kinase. Fusion with cell surface signaling molecules such as TCR-ζ and Fc_{ε}RI-γ can direct expression of the proteins in an active state on the cell surface.

Many cell lines are available for mammalian expression including mouse, rat human, monkey, chicken and hamster cells. Exemplary cell lines include but are not limited to CHO, Balb/3T3, HeLa, MT2, mouse NSO (nonsecreting) and other myeloma cell lines, hybridoma and heterohybridoma cell lines, lymphocytes, fibroblasts, Sp2/0, COS, NIH3T3, HEK293, 293S, 2B8, and HKB cells. Cell lines also are available adapted to serum-free media which facilitates purification of secreted proteins from the cell culture media. One such example is the serum free EBNA-1 cell line (Pham et al., (2003) Biotechnol. Bioeng. 84:332-42.)

v. Plants

Transgenic plant cells and plants can be to express polypeptides such as any described herein. Expression constructs are typically transferred to plants using direct DNA transfer such as microprojectile bombardment and PEG-mediated transfer into protoplasts, and with agrobacterium-mediated transformation. Expression vectors can include promoter and enhancer sequences, transcriptional termination elements and translational control elements. Expression vectors and transformation techniques are usually divided between dicot hosts, such as Arabidopsis and tobacco, and monocot hosts, such as corn and rice. Examples of plant promoters used for expression include the cauliflower mosaic virus promoter, the nopaline synthase promoter, the ribose bisphosphate carboxylase promoter and the ubiquitin and UBQ3 promoters. Selectable markers such as hygromycin, phosphomannose isomerase and neomycin phosphotransferase are often used to facilitate selection and maintenance of transformed cells. Transformed plant cells can be maintained in culture as cells, aggregates (callus tissue) or regenerated into whole plants. Transgenic plant cells also can include algae engineered to produce proteases or modified proteases (see for example, Mayfield et al. (2003) PNAS 100:438-442). Because plants have different glycosylation patterns than mammalian cells, this can influence the choice of protein produced in these hosts.

b. Expression, Isolation and Analysis of Polypeptides from the Host Cells

In one example, polypeptide expression is induced from the host cells for isolation and analysis of the target or variant polypeptides, for example, to determine if polypeptides encoded by a target polypeptide or collection of variant polypeptides bind a particular binding partner, e.g. an antigen.

Methods for inducing polypeptide expression from host cells are well known and vary depending on choice of vector and host cell. In one example, one or more colonies is picked and grown in medium supplemented with antibiotic and grown until a desired Optical Density (O.D.) is reached. Protein expression then can be induced by well-known methods, for example, by addition of isopropyl-beta-D-thiogalactopyranoside (IPTG) and continued growth.

Method for purification of polypeptides, including variant polypeptides or other proteins, from host cells will depend on the chosen host cells and expression systems. For secreted molecules, proteins are generally purified from the culture media after removing the cells. For intracellular expression, cells can be lysed and the proteins purified from the extract. In one example, polypeptides are isolated from the host cells by centrifugation and cell lysis (e.g. by repeated freeze-thaw in a dry ice/ethanol bath), followed by centrifugation and retention of the supernatant containing the polypeptides. When transgenic organisms such as transgenic plants and animals are used for expression, tissues or organs can be used as starting material to make a lysed cell extract. Additionally, transgenic animal production can include the production of polypeptides in milk or eggs, which can be collected, and if necessary further the proteins can be extracted and further purified using standard methods in the art.

Proteins, such as the provided variant polypeptides, can be purified, for example, from lysed cell extracts, using standard protein purification techniques known in the art including but not limited to, SDS-PAGE, size fraction and size exclusion chromatography, ammonium sulfate precipitation and ionic exchange chromatography, such as anion exchange. Affinity purification techniques also can be utilized to improve the efficiency and purity of the preparations. For example, antibodies, receptors and other molecules that bind proteases can be used in affinity purification. Expression constructs also can be engineered to add an affinity tag to a protein such as a myc epitope, GST fusion or His₆ and affinity purified with myc antibody, glutathione resin and Ni-resin, respectively. Purity can be assessed by any method known in the art including gel electrophoresis and staining and spectrophotometric techniques.

The isolated polypeptides then can be analyzed, for example, by separation on a gel (e.g. SDS-Page gel), size fractionation (e.g. separation on a Sephacryl™ S-200 HiPrep™ 16×60 size exclusion column (Amersham from GE Healthcare Life Sciences, Piscataway, N.J.). Isolated polypeptides can also be analyzed in binding assays, typically binding assays using a binding partner bound to a solid support, for example, to a plate (e.g. ELISA-based binding assays) or a bead, to determine their ability to bind desired binding partners. The binding assays described in the sections below, which are used to assess binding of precipitated phage displaying the polypeptides, also can be used to assess polypeptides isolated directly from host cell lysates. For example, binding assays can be carried out to determine whether antibody polypeptides bind to one or more antigens, for example, by coating the antigen on a solid support, such as a well of an assay plate and incubating the isolated polypeptides on the solid support, followed by washing and detection with secondary reagents, e.g. enzyme-labeled antibodies and substrates.

### H. DISPLAY OF VARIANT POLYPEPTIDES ON GENETIC PACKAGES

Methods for expressing and analyzing the provided variant polypeptides include methods for expressing the polypeptide on the surface of a genetic package, for example, in a phage display library (see, e.g., Barbas, C. F., 3rd et al., 2001. Phage Display: A Laboratory Manual. Cold Spring Harbor Laboratory Press, Cold Spring Harbor, N.Y.; Clackson et 25 al. (1991) Making Antibody Fragments Using Phage Display Libraries, Nature, 352:624-628). Also provided are methods for display of the provided variant polypeptides on genetic packages, particularly on bacteriophage, and for screening and selection of variant polypeptides using the genetic packages. Also provided are collections of genetic packages (e.g. phage display libraries) containing the variant polypeptides.

In the provided methods, host cells transformed with the vectors containing the variant polynucleotides are used to express polypeptides encoded by the nucleic acids in the vectors, on the surface of genetic packages. Exemplary genetic packages include, but are not limited to, bacterial cells, bacterial spores, viruses, including bacterial DNA viruses, for example, bacteriophages, typically filamentous bacteriophages, for example, Ff, M13, fd, and fl (see, e.g., Barbas, C. F., 3rd et al., 2001. Phage Display: A Laboratory Manual. Cold Spring Harbor Laboratory Press, Cold Spring Harbor, N.Y.; Clackson et 25 al. (1991) Making Antibody Fragments Using Phage Display Libraries, Nature, 352:624-628; Glaser et al. (1992) Antibody Engineering by Condon-Based Mutagenesis in a Filamentous Phage Vector System, J. Immunol., 149:3903 3913; Hoogenboom et al. (1991) Multi-Subunit Proteins on the Surface of Filamentous Phage: Methodologies for Displaying Antibody (Fate) Heavy and 30 Light Chains, Nucleic Acids Res., 19:4133-41370; Clackson and Lowman, Phage Display: A Practical Approach; (2004) Oxford University Press (Chapter 1, Russel et al., An introduction to Phage Biology and Phage Display, p. 1-26; Chapter 2, Sidhu and Weiss Constructing Phage display libraries by oligonucleotide-directed mutagenesis, p 27-41)), baculoviruses (see, e.g., Boublik et al., (1995) Eukaryotic Virus Display: Engineering the Major Surface Glycoproteins of the Autographa California Nuclear Polyhedrosis Virus (ACNPV) for the Presentation of Foreign Proteins on the Virus Surface, Bio/Technology, 13:1079-1084). Typically, the variant polypeptides are displayed on the genetic packages in collections of genetic packages, such as phage display libraries, which can be used to select particular polypeptides from the collections using the provided methods. Display of the polypeptides on genetic packages allows selection of polypeptides having desired properties, for example, the ability to bind with a particular binding partner.

1. Phage Display

Typically, the genetic packages are phage, and the variant polypeptides are expressed by phage display. Methods for generating phage display libraries are well known (see Barbas, C. F., 3rd et al., 2001. Phage Display: A Laboratory Manual. Cold Spring Harbor Laboratory Press, Cold Spring Harbor, N.Y.; Clackson and Lowman, Phage Display: A Practical Approach; (2004) Oxford University Press (Clackson and Lowman, Phage Display: A Practical Approach; (2004) Oxford University Press (Chapter 1, Russel et al., An introduction to Phage Biology and Phage Display, p. 1-26; Chapter 2, Sidhu and Weiss Constructing Phage display libraries by oligonucleotide-directed mutagenesis, p 27-41)); any of the known methods can be used with the provided methods to display the provided variant polypeptides on phage.

Libraries of variant polypeptides, including libraries of variant antibodies and antibody fragments (e.g. domain exchanged antibody fragments) can be expressed on the surfaces of bacteriophages, such as, but not limited to, M13, fd, fl, T7, and λ phages (see, e.g., Santini (1998) J. Mol. Biol. 282:125-135; Rosenberg et al. (1996) Innovations 6:1-6; Houshmand et al. (1999) Anal Biochem 268:363-370, Zanghi et al. (2005) Nuc. Acid Res. 33(18)e160:1-8). Phage display is described, for example, in Ladner et al., U.S. Pat. No. 5,223,409; Rodi et al. (2002) Curr. Opin. Chem. Biol. 6:92-96; Smith (1985) Science 228:1315-1317; WO 92/18619; WO 91/17271; WO 92/20791; WO 92/15679; WO 93/01288; WO 92/01047; WO 92/09690; WO 90/02809; de Haard et al. (1999) J. Biol. Chem. 274:18218-30; Hoogenboom et al. (1998) Immunotechnology 4:1-20; Hoogenboom et al. (2000) Immunol Today 2:371-8; Fuchs et al. (1991) Bio/Technology 9:1370-1372; Hay et al. (1992) Hum Antibod Hybridomas 3:81-85; Huse et al. (1989) Science 246:1275-1281; Griffiths et al. (1993) EMBO J. 12:725-734; Hawkins et al. (1992) J Mol Biol 226:889-896; Clackson et al. (1991) Nature 352:624-628; Gram et al. (1992) PNAS 89:3576-3580; Garrard et al. (1991) Bio/Technology 9:1373-1377; Rebar et al. (1996) Methods Enzymol. 267:129-49; Hoogenboom et al. (1991) Nuc Acid Res 19:4133-4137; and Barbas et al. (1991) PNAS 88:7978-7982.

In general, host cells capable of phage infection and packaging are transformed with phage vectors, typically phagemid vectors, containing the duplex cassette inserts. Following amplification, phage packaging and protein expression and is induced, typically by co-infection with a helper phage. Generally, the variant polypeptides are exported to the periplasm (e.g. as part of a fusion protein) for assembly into phage during phage packaging. Following phage packaging, the variant polypeptides are expressed on the surface of phage, typically as part of fusion proteins, each containing a variant polypeptide and a portion of a phage coat protein. The phage displaying the fusion proteins can be isolated and analyzed, and used to select desired polynucleotides, using the provided screening and selection methods.

Typically, to produce the fusion protein, the variant polypeptides are fused to bacteriophage coat proteins with covalent, non-covalent, or non-peptide bonds. (See, e.g., U.S. Pat. No. 5,223,409, Crameri et al. (1993) Gene 137:69 and WO 01/05950). For example, nucleic acids encoding the variant polypeptides can be fused to nucleic acids encoding the coat proteins (e.g. by introduction into a vector encoding the coat protein) to produce a variant polypeptide-coat protein fusion protein, where the variant polypeptide is displayed on the surface of the bacteriophage. Additionally, the fusion protein can include a flexible peptide linker or spacer, a tag or detectable polypeptide, a protease site, or additional amino acid modifications to improve the expression and/or utility of the fusion protein. For example, addition of a protease site can allow for efficient recovery of desired bacteriophages following a selection procedure. Exemplary tags and detectable proteins are known in the art and include for example, but not limited to, a histidine tag, a hemagglutinin tag, a myc tag or a fluorescent protein.

Nucleic acids suitable for phage display, e.g., phage vectors, are known in the art (see, e.g., Andris-Widhopf et al. (2000) J Immunol Methods, 28: 159-81, Armstrong et al. (1996) Academic Press, Kay et al., Ed. pp. 35-53; Corey et al. (1993) Gene 128(1):129-34; Cwirla et al. (1990) Proc Natl Acad Sci USA 87(16):6378-82; Fowlkes et al. (1992) Biotechniques 13(3):422-8; Hoogenboom et al. (1991) Nuc Acid Res 19(15):4133-7; McCafferty et al. (1990) Nature 348(6301):552-4; McConnell et al. (1994) Gene 151(1-2):115-8; Scott and Smith (1990) Science 249(4967):386-90). Phage display vectors, including exemplary phage display vectors, are described herein, for example, in section F above.

A library of nucleic acids encoding the variant polypeptide-coat protein fusion proteins can be incorporated into the genome of the bacteriophage, or alternatively inserted into in a phagemid vector. In a phagemid system, the nucleic acid encoding the display protein is provided on a phagemid vector, typically of length less than 6000 nucleotides. The phagemid vector includes a phage origin of replication so that the plasmid is incorporated into bacteriophage particles when bacterial cells bearing the plasmid are infected with helper phage, e.g. M13K01 or M13VCS. Phagemids, however, lack a sufficient set of phage genes in order to produce stable phage particles after infection. These phage genes can be provided by a helper phage. Typically, the helper phage provides an intact copy of the gene III coat protein and other phage genes required for phage replication and assembly. Because the helper phage has a defective origin of replication, the helper phage genome is not efficiently incorporated into phage particles relative to the plasmid that has a wild type origin. See, e.g., U.S. Pat. No. 5,821,047. The phagemid genome contains a selectable marker gene, e.g. Amp.sup.R or Kan.sup.R (for ampicillin or kanamycin resistance, respectively) for the selection of cells that are infected by a member of the library.

In another example of phage display, vectors can be used that carry nucleic acids encoding a set of phage genes sufficient to produce an infectious phage particle when expressed, a phage packaging signal, and an autonomous replication sequence. For example, the vector can be a phage genome that has been modified to include a sequence encoding the display protein. Phage display vectors can further include a site into which a foreign nucleic acid sequence can be inserted, such as a multiple cloning site containing restriction enzyme digestion sites. Foreign nucleic acid sequences, e.g., that encode display proteins in phage vectors, can be linked to a ribosomal binding site, a signal sequence (e.g., a M13 signal sequence), and a transcriptional terminator sequence.

Vectors may be constructed by standard cloning techniques to contain sequence encoding a polypeptide that includes a variant polypeptide and a portion of a phage coat protein, and which is operably linked to a regulatable promoter. In some examples, a phage display vector includes two nucleic acids that encode the same region of a phage coat protein. For example, the vector includes one sequence that encodes such a region in a position operably linked to the sequence encoding the display protein, and another sequence which encodes such a region in the context of the functional phage gene (e.g., a wild-type phage gene) that encodes the coat protein. Expression of the wild-type and fusion coat proteins can aid in the production of mature phage by lowering the amount of fusion protein made per phage particle. Such methods are particularly useful in situations where the fusion protein is less tolerated by the phage.

Phage display systems typically utilize filamentous phage, such as M13, fd, and fl. In some examples using filamentous phage, the display protein is fused to a phage coat protein anchor domain. The fusion protein can be co-expressed with another polypeptide having the same anchor domain, e.g., a wild-type or endogenous copy of the coat protein. Phage coat proteins that can be used for protein display include (i) minor coat proteins of filamentous phage, such as the bacteriophage M13 gene III protein (also called gIIIp, cp3, g3p; GENBANK g.i. 59799327, having the amino acid sequence set forth in SEQ ID NO: 12: MKKLLFAIPLVVPFYSHSAETVESCLAKPHTENSFTNVWKDDKTLDRYANYE GCLWNATGVVVCTGDETQCYGTWVPIGLAIPENEGGGSEGGGSEGGGSEGG GTKPPEYGDTPIPGYTYINPLDGTYPPGTEQNPANPNPSLEESQPLNTFMFQNN RFRNRQGALTVYTGTVTQGTDPVKTYYQYTPVSSKAMYDAYWNGKFRDCA FHSGFNEDPFVCEYQGQSSDLPQPPVNAGGGSGGGSGGGSEGGGSEGGGSEG GGSEGGGSGGGSGSGDFDYEKMANANKGAMTENADENALQSDAKGKLDSV ATDYGAAIDGFIGDVSGLANGNGATGDFAGSNSQMAQVGDGDNSPLMNNFR QYLPSLPQSVECRPFVFSAGKPYEFSIDCDKINLFRGVFAFLLYVATFMYVFST FANILRNKES), and (ii) major coat proteins of filamentous phage such as gene VIII protein (gVIIIp, cp8). Fusions to other phage coat proteins such as gene VI protein, gene VII protein, or gene IX protein can also be used (see, e.g., WO 00/71694).

Portions (e.g., domains or fragments) of these phage proteins may also be used. Useful portions include domains that are stably incorporated into the phage particle, e.g., so that the fusion protein remains in the particle throughout a selection procedure. In one example, the anchor domain of gIIIp is used (see, e.g., U.S. Pat. No. 5,658,727). In another example, gVIIIp is used (see, e.g., U.S. Pat. No. 5,223,409), which can be a mature, full-length gVIIIp fused to the display protein. The filamentous phage display systems typically use protein fusions to attach the heterologous amino acid sequence to a phage coat protein or anchor domain. For example, the phage can include a gene that encodes a signal sequence, the heterologous amino acid sequence, and the anchor domain, e.g., a gIIIp anchor domain.

Valency of the expressed fusion protein can be controlled by choice of phage coat protein. For example, gIIIp proteins typically are incorporated into the phage coat at three to five copies per virion. Fusion of gIIIp to variant proteases thus produces a low-valency. In comparison, gVIII proteins typically are incorporated into the phage coat at 2700 copies per virion (Marvin (1998) Curr. Opin. Struct. Biol. 8:150-158). Due to the high-valency of gVIIIp, peptides greater than ten residues are generally not well tolerated by the phage. Phagemid systems can be used to increase the tolerance of the phage to larger peptides, by providing wild-type copies of the coat proteins to decrease the valency of the fusion protein. Additionally, mutants of gVIIIp can be used which are optimized for expression of larger peptides. In one such example, a mutant gVIIp was obtained in a mutagenesis screen for gVIIIp with improved surface display properties (Sidhu et al. (2000) J. Mol. Biol. 296:487-495).

Regulatable promoters can also be used to control the valency of the display protein. Regulated expression can be used to produce phage that have a low valency of the display protein. Many regulatable (e.g., inducible and/or repressible) promoter sequences are known. Such sequences include regulatable promoters whose activity can be altered or regulated by the intervention of user, e.g., by manipulation of an environmental parameter, such as, for example, temperature or by addition of stimulatory molecule or removal of a repressor molecule. For example, an exogenous chemical compound can be added to regulate transcription of some promoters. Regulatable promoters can contain binding sites for one or more transcriptional activator or repressor protein. Synthetic promoters that include transcription factor binding sites can be constructed and can also be used as regulatable promoters. Exemplary regulatable promoters include promoters responsive to an environmental parameter, e.g., thermal changes, hormones, metals, metabolites, antibiotics, or chemical agents. Regulatable promoters appropriate for use in E. coli include promoters which contain transcription factor binding sites from the lac, tac, trp, trc, and tet operator sequences, or operons, the alkaline phosphatase promoter (pho), an arabinose promoter such as an araBAD promoter, the rhamnose promoter, the promoters themselves, or functional fragments thereof (see, e.g., Elvin et al. (1990) Gene 37: 123-126; Tabor and Richardson, (1998) Proc. Natl. Acad. Sci. U.S.A. 1074-1078; Chang et al. (1986) Gene 44: 121-125; Lutz and Bujard, (1997) Nucl. Acids. Res. 25: 1203-1210; D. V Goeddel et al. (1979) Proc. Nat. Acad. Sci. U.S.A., 76:106-110; J. D. Windass et al. (1982) Nucl. Acids. Res., 10:6639-57; R. Crowl et al. (1985) Gene, 38:31-38; Brosius (1984) Gene 27: 161-172; Amanna and Brosius, (1985) Gene 40: 183-190; Guzman et al. (1992) J. Bacteriol., 174: 7716-7728; Haldimann et al. (1998) J. Bacteriol., 180: 1277-1286).

The lac promoter, for example, can be induced by lactose or structurally related molecules such as isopropyl-beta-D-thiogalactoside (IPTG) and is repressed by glucose. Some inducible promoters are induced by a process of derepression, e.g., inactivation of a repressor molecule.

A regulatable promoter sequence can also be indirectly regulated. Examples of promoters that can be engineered for indirect regulation include: the phage lambda P_{R}, P_{L}, phage T7, SP6, and T5 promoters. For example, the regulatory sequence is repressed or activated by a factor whose expression is regulated, e.g., by an environmental parameter. One example of such a promoter is a T7 promoter. The expression of the T7 RNA polymerase can be regulated by an environmentally-responsive promoter such as the lac promoter. For example, the cell can include a heterologous nucleic acid that includes a sequence encoding the T7 RNA polymerase and a regulatory sequence (e.g., the lac promoter) that is regulated by an environmental parameter. The activity of the T7 RNA polymerase can also be regulated by the presence of a natural inhibitor of RNA polymerase, such as T7 lysozyme.

In another configuration, the lambda P_{L} can be engineered to be regulated by an environmental parameter. For example, the cell can include a nucleic acid that encodes a temperature sensitive variant of the lambda repressor. Raising cells to the non-permissive temperature releases the P_{L} promoter from repression.

The regulatory properties of a promoter or transcriptional regulatory sequence can be easily tested by operably linking the promoter or sequence to a sequence encoding a reporter protein (or any detectable protein). This promoter-report fusion sequence is introduced into a bacterial cell, typically in a plasmid or vector, and the abundance of the reporter protein is evaluated under a variety of environmental conditions. A useful promoter or sequence is one that is selectively activated or repressed in certain conditions.

In some embodiments, non-regulatable promoters are used. For example, a promoter can be selected that produces an appropriate amount of transcription under the relevant conditions. An example of a non-regulatable promoter is the gIII promoter.

Following induction, the phage, displaying the variant polypeptides, are produced from, typically secreted by, the host cells. The phage can be isolated, for example, by precipitation, and then assayed and/or used for selection of desired variant polypeptides. The selected polypeptides and/or phage displaying the polypeptides can be used in an iterative process, by repeating one or more aspects of the provided methods.

a. Transformation and Growth of Phage-Display Compatible Cells

For phage display using a phagemid vector, host cells compatible with phage display, for example, XL-1 blue cells, are transformed, typically by electroporation, with the polynucleotides in the vectors. The transformed cells can be grown for amplification of the vector nucleic acids, for example, for subsequent sequence analysis or pooling for re-transformation. In one example, transformed cells are grown in suitable medium, for example, SB medium supplemented with antibiotics, and incubated for use in phage display to express the variant polypeptides.

b. Co-Infection with Helper Phage, Packaging and Expression

When a phagemid vector is used, phage packaging and expression of the variant polypeptides is induced by co-infection with helper phage, for example, with VCS M13 helper phage. Methods for transformation, growth and phage packaging and propagation are well-known (see Clackson and Lowman, Phage Display: A Practical Approach; (2004) Oxford University Press (Chapter 2, Constructing Phage display libraries by oligonucleotide-directed mutagenesis, Sidhu and Weiss, p. 27-41). Any phage display method can be used. In general, host cells transformed with the vector nucleic acids are incubated in medium. Helper phage is added and the cells are incubated. Typically, variant polypeptide expression is induced, for example, by IPTG. An exemplary protocol is detailed in Example 9, herein below. Generally, the expressed variant polypeptide (e.g. the variant polypeptide contained as part of a phage coat protein fusion) is directed to the periplasm of the bacterial host cell (e.g. using methods described above) so it can be assembled into phage.

c. Isolation of Polypeptides/Genetic Packages

Following phage propagation, the phage (genetic packages) displaying the variant polypeptides can be isolated from the host cells or from the media containing the host cells. For example, phage secreted in the culture medium can be precipitated using well-known methods. Typically, phage is precipitated and the precipitate collected by centrifugation. The precipitate typically is resuspended in a buffer and the solution centrifuged to remove debris (clearing).

In an exemplary protocol, cultures containing propagated phage are centrifuged, for example, at 8000 rpm for 10 minutes with the break on, and the supernatant retained. In this example, the pelleted cells optionally can be retained for assays, for example, sequencing of the nucleic acids in the vectors, or for iterative processes, and the supernatant can be transferred, and the phage precipitated from the supernatant. In one example, polyethylene glycol (for example, 20% PEG-8000 in 2.5 M NaCl) is added to the supernatant and incubated on ice for approximately 30 minutes, to precipitate the phage. In this example, the phage then is centrifuged at 13,000 rpm, for 20 minutes ate 4° C. The supernatant then is discarded (e.g. poured off) and the precipitated phage is dried, for example by inverting the tube, for 5-10 minutes. The precipitated phage then can be resuspended, for example in 1 mL 1% BSA and 1% PBS, and transferred to a microcentrifuge tube, which then is centrifuged (to clear the precipitate), for example, at 13,500 rpm, at 25° C., for 5 minutes. The supernatant then contains the phage, which can be used, for example, in screening and/or selection steps, for example, to isolate one or more desired variant polypeptides.

2. Other Display Methods

a. Cell Surface Display Libraries

Alternatively, the provided collections of variant polypeptides can be expressed on the surfaces of cells, for example, prokaryotic or eukaryotic cells. Exemplary cells for cell surface expression include, but are not limited to, bacteria, yeast, insect cells, avian cells, plant cells, and mammalian cells (Chen and Georgiou (2002) Biotechnol Bioeng 79: 496-503). In one example, the bacterial cells for expression are Escherichia coli.

Variant polypeptides can be expressed as a fusion protein with a protein that is expressed on the surface of the cell, such as a membrane protein or cell surface-associated protein. For example, a variant polypeptide can be expressed in E. coli as a fusion protein with an E. coli outer membrane protein (e.g. OmpA), a genetically engineered hybrid molecule of the major E. coli lipoprotein (Lpp) and the outer membrane protein OmpA or a cell surface-associated protein (e.g. pili and flagellar subunits). Generally, when bacterial outer membrane proteins are used for display of heterologous peptides or proteins, expression is achieved through genetic insertion into permissive sites of the carrier proteins. Expression of a heterologous peptide or protein is dependent on the structural properties of the inserted protein domain, since the peptide or protein is more constrained when inserted into a permissive site as compared to fusion at the N- or C-terminus of a protein. Modifications to the fusion protein can be done to improve the expression of the fusion protein, such as the insertion of flexible peptide linker or spacer sequences or modification of the bacterial protein (e.g. by mutation, insertion, or deletion, in the amino acid sequence). Enzymes, such as β-lacatamase and the Cex exoglucanase of Cellulomonas fimi, have been successfully expressed as Lpp-OmpA fusion proteins on the surface of E. coli (Francisco J. A. and Georgiou G. Ann N Y Acad. Sci. 745:372-382 (1994) and Georgiou G. et al. Protein Eng. 9:239-247 (1996)). Other peptides of 15-514 amino acids have been displayed in the second, third, and fourth outer loops on the surface of OmpA (Samuelson et al. J. Biotechnol. 96: 129-154 (2002)). Thus, outer membrane proteins can carry and display heterologous gene products on the outer surface of bacteria.

In another example, variant polypeptides generated herein can be fused to autotransporter domains of proteins such as the N. gonorrhoeae IgA1 protease, Serratia marcescens serine protease, the Shigella flexneri VirG protein, and the E. coli adhesin AIDA-I (Klauser et al. EMBO J. 1991-1999 (1990); Shikata S, et al. J. Biochem. 114:723-731 (1993); Suzuki T et al. J Biol. Chem. 270:30874-30880 (1995); and Maurer J et al. J Bacteriol. 179:794-804 (1997)). Other autotransporter proteins include those present in gram-negative species (e.g. E. coli, Salmonella serovar Typhimurium, and S. flexneri). Enzymes, such as β-lactamase, have been successful expressed on the surface of E. coli using this system (Lattemann C T et al. J Bacteriol. 182(13): 3726-3733 (2000)).

Bacteria can be recombinantly engineered to express a fusion protein, such a membrane fusion protein. Variant polynucleotides encoding the variant polypeptides can be fused to nucleic acids encoding a cell surface protein, such as, but not limited to, a bacterial OmpA protein. The nucleic acids encoding the variant polypeptides can be inserted into a permissible site in the membrane protein, such as an extracellular loop of the membrane protein. Additionally, a nucleic acid encoding the fusion protein can be fused to a nucleic acid encoding a tag or detectable protein. Such tags and detectable proteins are known in the art and include for example, but not limited to, a histidine tag, a hemagglutinin tag, a myc tag or a fluorescent protein. The nucleic acids encoding the fusion proteins can be operably linked to a promoter for expression in the bacteria, For example nucleic acid can be inserted in a vectors or plasmid, which can carry a promoter for expression of the fusion protein and optionally, additional genes for selection, such as for antibiotic resistance. The bacteria can be transformed with such plasmids, such as by electroporation or chemical transformation. Such techniques are known to one of ordinary skill in the art.

Proteins in the outer membrane or periplasmic space are usually synthesized in the cytoplasm as premature proteins, which are cleaved at a signal sequence to produce the mature protein that is exported outside the cytoplasm. Exemplary signal sequences used for secretory production of recombinant proteins for E. coli are known. The N-terminal amino acid sequence, without the Met extension, can be obtained after cleavage by the signal peptidase when a gene of interest is correctly fused to a signal sequence. Thus, a mature protein can be produced without changing the amino acid sequence of the protein of interest (Choi and Lee. Appl. Microbiol. Biotechnol. 64: 625-635 (2004)).

Other cell surface display systems are known in the art and include, but are not limited to ice nucleation protein (Inp)-based bacterial surface display system (Lebeault J M (1998) Nat. Biotechnol. 16: 576 80), yeast display (e.g. fusions with the yeast Aga2p cell wall protein; see U.S. Pat. No. 6,423,538), insect cell display (e.g. baculovirus display; see Ernst et al. (1998) Nucleic Acids Research, Vol 26, Issue 7 1718-1723), mammalian cell display, and other eukaryotic display systems (see e.g. U.S. Pat. No. 5,789,208 and WO 03/029456).

b. Other Display Systems

It is also possible to use other display formats to screen collections of variant polypeptides provided herein. Exemplary other display formats include nucleic acid-protein fusions, ribozyme display (see e.g. Hanes and Pluckthun (1997) Proc. Natl. Acad. Sci. U.S.A. 13:4937-4942), bead display (Lam, K. S. et al. Nature (1991) 354, 82-84; K. S. et al. (1991) Nature, 354, 82-84; Houghten, R. A. et al. (1991) Nature, 354, 84-86; Furka, A. et al. (1991) Int. J. Peptide Protein Res. 37, 487-493; Lam, K. S., et al. (1997) Chem. Rev., 97, 411-448; U.S. Published Patent Application 2004-0235054) and protein arrays (see e.g. Cahill (2001) J. Immunol. Meth. 250:81-91, WO 01/40803, WO 99/51773, and US2002-0192673-A1).

In specific other cases, it can be advantageous to instead attach the variant polypeptides, or phage libraries or cells expressing variant polypeptides, to a solid support. For example, in some examples, cells expressing variant polypeptides can be naturally adsorbed to a bead, such that a population of beads contains a single cell per bead (Freeman et al. Biotechnol. Bioeng. (2004) 86:196-200). Following immobilization to a glass support, microcolonies can be grown and screened with a chromogenic or fluorogenic substrate. In another example, variant polypeptides or phage libraries or cells expressing variant polypeptides can be arrayed into titer plates and immobilized.

### I. SELECTION OF VARIANT POLYPEPTIDES FROM THE COLLECTIONS

Various well-known methods can be used in the provided methods to select desired variant polypeptides from the collections generated using the provided methods. For example, methods for selecting desired polypeptides from phage display libraries are well known and include panning methods, where phage displaying the polypeptides are selected for binding to a desired binding partner (see, for example, Clackson and Lowman, Phage Display: A Practical Approach; (2004) Oxford University Press (Chapter 1, Russel et al., An introduction to Phage Biology and Phage Display, pp. 1-26; Chapter 4, Dennis and Lowman, Phage selection strategies for improved affinity and specificity of proteins and peptided pp. 61-83)). Polypeptides selected from the collections can be optionally amplified, and analyzed, for example, by sequencing nucleic acids or in a screening assay (see, for example, Phage Display: A Practical Approach; (2004) Oxford University Press (Chapter 5, De Lano and Cunningham, Rapid screening of phage displayed protein binding affinities by phage ELISA pp 85-94)) to determine whether the selected polypeptide(s) has a desired property. In one example, iterative selection steps are performed in order to enrich for a particular property of the variant polypeptide.

1. Confirming Display of the Polypeptides

Typically, prior to selection of polypeptides from a collection, e.g. a phage display library, one or more methods is used to determine successful expression and/or display of the variant polypeptides. Such methods are well-known and include phage enzyme-linked immunosorbent assays (ELISAs), as described hereinbelow, for detection of binding to a binding partner, and/or detection of an epitope tag on the expressed polypeptides, such as a His6 tag, which can be detected by binding to metal-chelating matrices or anti-His antibodies bound to solid supports.

2. Selection of Variant Polypeptides from the Collections

Also provided herein are methods for selecting variant polypeptides from the provided collections. Typically, or more selection steps is carried out to select one or more variant polypeptides from the provided collections, e.g. phage display libraries ((see, for example, Clackson and Lowman, Phage Display: A Practical Approach; (2004) Oxford University Press (Chapter 1, Russel et al., An introduction to Phage Biology and Phage Display, pp. 1-26; Chapter 4, Dennis and Lowman, Phage selection strategies for improved affinity and specificity of proteins and peptided pp. 61-83)). Typically, the selection step is a panning step, whereby phage displaying the polypeptide are selected for their ability to bind to a desired binding partner (e.g. an antigen).

a. Panning

Panning methods for selection of phage-displayed polypeptides are well-known, and can be used with the provided methods and collections of variant polypeptides. Generally, a binding partner (an antigen or epitope in the case of a variant antibody polypeptide collection) is presented to the collection of phage and the collection enriched for members that bind, for example, with high affinity, to the binding partner.

In an exemplary panning process for selecting variant polypeptides from the libraries, the binding partner (e.g. antigen) is be coated on to microtiter wells and incubated with the collections of variant polypeptides expressed on the surface of phage. After washing non-specific binders from the wells using buffers known to those skilled in the art (e.g. 1× phosphate buffered saline pH 7.4 with 0.01% Tween 20), the remaining variants are eluted with an elution buffer (e.g. 0.1 M HCl pH 2.2 with Glycine and Bovine Serum Albumin 1 mg/mL) and bacteria are infected with the eluted phage for the expansion of specific variants. This procedure can be repeated (e.g. 2-6 times) in an iterative screening process as described below, for the enrichment of specific variants with higher affinity.

i. Incubation of the Polypeptides with a Binding Partner

As a first step in the panning process, the binding partner is presented to the collection of phage displaying the variant polypeptides. A number of means for presenting the binding partner to the phage are well-known and all can be used with the provided methods. In one example, the binding partner is immobilized on a solid support (e.g. a bead, column or well). Alternatively, the phage and a soluble binding partner can be incubated in solution, followed by capture of the binding partner. Alternatively, whole cells expressing the binding partner can be used to select phage. In vivo methods for selection also are known and can be used with the provided methods.

For immobilization of the binding partner, a number of solid supports can be used. Exemplary supports include resins and beads (e.g. sepharose, controlled-pore glass), plates (e.g. microtiter (96 and 384 well) plates, and chips (e.g. dextran-coated chips (BIAcore, Inc.)). In one example, the binding partner is immobilized by coupling to an affinity tag (e.g. biotin, His6) and immobilization on a solid support coated with a molecule having affinity for the tag (e.g. avidin, Ni²⁺). For binding of the phage to binding partners in solution, the phage are selected by a second capture step using an appropriate matrix.

Prior to incubation of the phage with the binding partner, a blocking step is carried out to prevent non-specific selection of phage. Binding reagents are well known and include bovine serum albumin (BSA), ovalbumin, casein and nonfat milk. An exemplary blocking step includes incubation of the blocking buffer (e.g. 4% nonfat dry milk in PBS) for one hour at 37° C. The blocking buffer is discarded prior to incubation of the phage collection with the binding partner.

Typically, for incubation of the phage with the binding partner, a number of dilutions of the precipitated phage (e.g. prepared using a two- four- six- or ten-fold dilution curve) are prepared and incubated with the binding partner. In one example, where the binding partner is immobilized in wells of a microtiter plate, the phage dilutions are incubated in buffer (e.g. blocking buffer, optionally containing polysorbate 20), for example, for one to two hours, at room temperature or at 37° C., with optional rocking. Choice of buffer for the binding of the phage to the binding partner is based on several parameters, including the affinity of the target polypeptide or desired polypeptide for the binding partner and for the nature of the binding. For example, more or less protein can be included depending on the affinity. In some cases, it is necessary to include cations or cofactors to facilitate binding.

In one example, a competing decoy binding partner is included during the incubation step, for example, to reduce the possibility of selecting non-specific binders and/or to select polypeptides having high affinity for the binding partner. In another example, a non-specific polypeptide, having none or low affinity for the binding partner, is included in the panning step.

Typically, a first panning step, for example, using phage displaying only the target polypeptide, is conducted to verify the accuracy of the panning procedure.

ii. Washing

Following incubation with the binding partner, non-binding phage and/or polypeptides are washed away using one or more wash buffers. Typical wash buffers include PBS, and PBS supplemented with polysorbate 20 (Tween 20), for example, at 0.05%. Depending on the desired stringency, the wash buffer and/or length/number of washes can be varied, according to methods well known to the skilled artisan. Conditions of the binding and washing steps can be varied to adjust stringency, according to various parameters, for example, affinity of the target or desired polypeptide for the binding partner.

In one example, after washing, some of the samples can be used to analyze the polypeptides, for example, by performing an ELISA-based assay as described hereinbelow, to determine whether any of the polypeptides have bound to the binding partner. For example, when the panning is carried out in a well of a microtiter plate, duplicate wells for each dilution can be used. In this example, one of the wells from each sample is used to elute bound phage, while the phage bound to the other duplicate well is retained for analysis, e.g. by ELISA-based assay. Alternatively, the panning procedure can be continued, by eluting bound phage, which potentially display polypeptides having desired properties.

iii. Elution of Bound Polypeptides

Following washing to remove non-bound phage, the phage expressing polypeptides that have bound to the binding partner are eluted using one of several well known elution methods, typically by reduction of the pH of the solution, recovery of phage, and neutralization, or addition of a competing polypeptide which can compete for binding to the binding partner. Exemplary of the elution step is reduction of the pH to approximately 2 (e.g. 2.2) by incubation of the bound phage with 10-100 mM hydrochloric acid (HCL), pH 2.2, or with 0.2 M glycine, (e.g. for 10 minutes at room temperature (e.g. 25° C.)), followed by removal of the eluate and addition of 1-2 M Tris-base (pH 8.0-9.0) to neutralize the pH. In some examples, multiple elution steps are carried out and the eluates pooled for subsequent steps.

Efficient elution can be assessed by analysis of the eluate, or alternatively, by performing an analysis on the solid support from which the phage have been eluted, e.g. by performing an ELISA-based assay as described hereinbelow.

3. Amplification and Analysis of Selected Polypeptides

In one example, variant polypeptides (e.g. polypeptides displayed on genetic packages, e.g. phage) selected in the panning step are amplified for analysis and/or use in subsequent panning steps. The amplification step amplifies the genome of the genetic package, e.g. phage. This amplification can be useful for expressing the variant polypeptide encoded by the selected phage, for example, for use in analysis steps or subsequent panning steps in iterative selection processes as described hereinbelow, and for identification of the variant polypeptide and polynucleotide encoding the polypeptide, such as by subsequent nucleic acid sequencing.

In this example, following elution, the phage nucleic acids are amplified in an appropriate host cell. In one example, the selected phage is incubated with an appropriate host cell (e.g. XL-1 blue cells) to allow phage adsorption (for example, by incubation of eluted phage with cells having an O.D. between 0.3 and 0.6 for 20 minutes at room temperature). After this incubation to allow phage adsorption, a small volume of nutrient broth is added and the culture agitated to facilitate phage DNA replication in the multiplying host cell. After this incubation, the culture typically is supplemented with an antibiotic and/or inducer and the cells grown until a desired optical density is reached. The phage genome can contain a gene encoding resistance to an antibiotic to allow for selective growth of the cells that maintain the phage vector DNA. The amplification of the display source, such as in a bacterial host cell, can be optimized in a variety of ways. For example, the host cells can be added in vast excess to the genetic packages recovered by elution, thereby ensuring quantitative transduction of the genetic package genome. The efficiency of transduction optionally can be measured when phage are selected.

4. Analysis of Selected Variant Polypeptides

Following selection of one or more variant polypeptides, for example, by panning using a phage display library as described above, the variant polypeptide(s) can be purified and analyzed using a number of different methods. Such methods include general recombinant DNA techniques and are routine to those of skill in the art. The vector containing the polynucleotide encoding the selected variant polypeptide (e.g. the phagemid vector), can be isolated to enable purification of the selected protein. For example, following infection of E. coli host cells with selected phage as set forth above, the individual clones can be picked and grown up for plasmid purification using any method known to one of skill in the art, and if necessary can be prepared in large quantities, such as for example, using the Midi Plasmid Purification Kit (Qiagen). The purified plasmid can used for nucleic acid sequencing to identify the sequence of the variant polynucleotide and, by extrapolation, the sequence of the variant polypeptide, or can be used to transfect into any cell for expression, such as by not limited to, a mammalian expression system. If necessary, one or two-step PCR can be performed to amplify the selected sequence, which can be subcloned into an expression vector of choice. The PCR primers can be designed to facilitate subcloning, such as by including the addition of restriction enzyme sites. Following transfection into the appropriate cells for expression, such as is described in detail hereinabove, the selected polypeptides can be tested in a number of assays.

In one example, the polypeptides are analyzed for the ability to bind one or more binding partners. For example, if the polypeptide is an antibody, the polypeptide can be analyzed for ability to interact with a particular antigen, and for affinity for the antigen. In this example the binding partner is attached to a support, such as a solid support, and the polypeptides (e.g. precipitated phage) incubated with the support, followed by a wash to remove unbound polypeptides, and detection, for example, using a labeled antibody. Exemplary of supports to which the binding partner can be attached are wells, for example, microtiter wells, beads, e.g. sepharose beads, and/or beads for use in flow cytometry.

In one example, an ELISA-based assay is used, whereby the desired binding partner is coated onto wells of a microtiter plate, the plate is blocked with protein (e.g. bovine serum albumin) and the polypeptides, e.g. precipitated phage, are incubated with the coated wells. Following incubation, the unbound polypeptides are washed away in one or more wash steps and the bound polypeptides are detected, for example, using a detection antibody, for example, an antibody labeled with a fluorescent or enzyme marker. In the case of an enzyme marker, detection is carried out by incubation with a substrate, followed by reading of absorbance at an appropriate wavelength. Such binding assays can be used to evaluate polypeptides expressed from host cells, including polypeptides expressed on precipitated phage, including polypeptides selected using the panning methods provided herein, in order to verify their desired properties.

5. Iterative Screening

In one example, the screening of collections of variant polypeptides is performed using an iterative process, for example, to optimize variation of the polypeptides, to enrich the selected polypeptides for one or more desired characteristics, and to increase one or more desired properties. Thus, in methods of iterative screening, a variant polypeptide can be evolved by performing the panning steps, described hereinabove, a plurality of times. In one example, the same parameters are used in each successive round. Typically, the successive rounds are performed using varying parameters, such as for example, by using different binding partners and/or decoys, or by increasing stringency of washes and/or binding steps.

In one example of iterative screening, selected polypeptides (optionally first amplified and analyzed) are used in multiple additional rounds of screening, by pooling the selected polypeptides (e.g. eluted phage), propagation of nucleic acids encoding the polypeptides in host cells, expression (e.g. phage display) of the selected polypeptides, and a subsequent round of panning. Multiple rounds, e.g. 2, 3, 4, 5, 6, 7, 8, or more rounds, of screening can be performed. In this example of iterative screening, the variant polypeptide collection used in the successive round of screening includes the polypeptides selected in the previous round. Alternatively, the multiple rounds of screening can be performed using the initial collection of variant polypeptides.

In an alternative example of iterative screening, a new variant polypeptide collection can be generated, that has been further varied. In one such example, one or more selected variant polypeptides is/are used as target polypeptides for variation using the methods provided herein.

In one example, a first round panning of the collection of variant polypeptides library can identify variant polypeptides containing one or more particular mutations (e.g. mutations in the CDR region(s) compared to an antibody target polypeptide), which alter one or more properties (e.g. antigen specificity) of the target polypeptide. In this example, a second round of variation and selection then can be performed, where the selected polypeptide(s) are used as target polypeptides for further variation, but the sequences of one or more of the particular mutations (e.g. the CDR sequences), are held constant, and new variant and/or randomized positions are selected for variation outside of these regions. After an additional round of screening, the selected polypeptides further can be subjected to additional rounds of variation and screening. For example, 2, 3, 4, 5, or more rounds of polypeptide variation and screening can be performed. In some examples, a property of the polypeptides (for example, the affinity of an antibody polypeptide for a specific antigen) is further optimized with each round of selection.

### J. DISPLAY OF POLYPEPTIDES ON GENETIC PACKAGES

Also provided are methods, compositions and tools for display of polypeptides (e.g. variant polypeptides), such as antibodies, including domain exchanged antibodies (including domain exchanged antibody fragments), on genetic packages, such as phage; genetic packages displaying the domain exchanged antibodies, including collections of the genetic packages (e.g. phage display libraries); methods for using the genetic packages to select domain exchanged antibodies; and domain exchanged antibodies selected from the collections. Exemplary of the tools for display of domain exchanged antibodies are vectors for displaying domain exchanged antibodies, such as phage display vectors containing nucleic acids encoding domain exchanged antibodies, antibody domains, and/or functional portions thereof, and coat protein(s), for example, phage coat proteins, such as cp3 (encoded by gene III) and cp8 (encoded by gene VIII).

It is discovered herein that because of the unusual configuration of domain exchanged antibodies, their display on genetic packages is not straightforward. Accordingly, provided herein are methods for adapting conventional display technologies to display domain exchanged antibodies. The methods can be used to produce domain exchanged antibody fragments displayed on genetic packages. Exemplary domain exchanged antibody fragments are illustrated in FIG. 8. These fragments and methods for their generation are described in further detail below. FIG. 8 depicts the antibody fragments as part of bacteriophage coat protein 3 (cp3) fusion proteins, for display on filamentous bacteriophage. Alternatively, any of the fragments depicted in the figure and described herein can be adapted for display on other genetic packages, for example, using different genetic package vectors and coat proteins. Alternatively, the fragments can be produced as non-fusion protein fragments for purposes other than display on genetic packages. The fragments described below are exemplary and the methods for vector design can be used in various combinations to generate other related domain exchanged fragments for display on genetic packages.

The provided methods for producing vectors and for display, and the vectors, also can be used to display antibody fragments other than domain exchanged fragments, in bivalent form, e.g. having two heavy and two light chain portions.

1. Domain Exchanged Antibodies

Domain exchanged antibodies are antibodies, including antibody fragments, having the domain exchanged structure, which in general is characterized by an interlocked configuration whereby V_{H} domains interact with opposite V_{L} domains and an interface is formed between V_{H} domains (see, for example, Published U.S. Application, Publication No.: US20050003347). FIG. 7 shows a schematic comparison of exemplary conventional and domain exchanged IgG antibody structures. In this example, due to a mutation within the joining region between the V_{H} and C_{H} regions in a domain exchanged antibody, the full-length folded antibody adopts an unusual structure, in which the two heavy chain variable regions swing away from their cognate light chains and pair instead with the “opposite” light chain variable regions. In other words, in this exemplary full-length domain exchanged antibody, the variable region of each heavy chain (V_{H} and V_{H}′, respectively) interacts with the variable region on the opposite light chain compared with the interactions between the constant regions (C_{H}-C_{L}). Additional framework mutations along the V_{H}-V_{H}′ interface act to stabilize this domain-exchange configuration (see, for example, Published U.S. Application, Publication No.: US20050003347).

In conventionally structured IgG, IgD and IgA antibodies, the hinge regions between the C_{H}1 and C_{H}2 domains provide flexibility, resulting in mobile antibody combining sites that can move relative to one another to interact with epitopes, for example, on cell surfaces. In domain exchanged antibodies, by contrast, because of the “exchange” of the two heavy chain variable domains (V_{H} and V_{H}′), this flexible arrangement is not adopted. In one example, domain exchanged antibodies can contain two conventional antibody combining sites and a non-conventional antibody combining site, which is formed by the interface between the two adjacently positioned heavy chain variable regions, all of which are in close proximity with one another and constrained in space, as illustrated in the exemplary IgG in FIG. 7.

Provided herein are methods for display of domain exchanged antibodies on genetic packages, collections of domain-exchanged antibody-displaying genetic packages, vectors for use in the methods, methods for selecting new domain exchanged antibodies from collections of genetic packages and domain exchanged antibodies selected by the methods. In one example, due to their domain exchanged configuration, the domain exchanged antibodies specifically bind epitopes within densely packed and/or repetitive epitope arrays, such as sugar residues on bacterial or viral surfaces. In some examples, domain exchanged antibodies can recognize and bind epitopes within high density arrays, which evolve, for example, in pathogens and tumor cells as means for immune evasion. Examples of such high density/repetitive epitope arrays include, but are not limited to, epitopes contained within bacterial cell wall carbohydrates and carbohydrates and glycolipids displayed on the surfaces of tumor cells or viruses. Such epitopes are not optimally recognized by conventional (non-domain exchanged) antibodies because their high density and/or repetitiveness makes simultaneous binding of both antibody-combining sites of a conventional antibody energetically disfavored. Thus, in one example, domain exchanged antibodies can be used to target (e.g. therapeutically; e.g. by high affinity binding) epitopes that conventional antibodies typically cannot bind or can bind only with low affinity, for example, poorly immunogenic polysaccharide antigens of bacteria, fungi, viruses and other infectious agents, such as drug-resistant agents (e.g. drug resistant microbes) and tumor cells.

Exemplary of a domain exchanged antibody that can be used in the provided methods, vectors and collections is the 2G12 antibody, which binds epitopes on the HIV gp120 antigen. 2G12 antibody includes the domain exchanged human monoclonal IgG1 antibody produced from the hybridoma cell line CL2 (as described in U.S. Pat. No. 5,911,989; Buchacher et al., AIDS Research and Human Retroviruses, 10(4) 359-369 (1994); and Trkola et al., Journal of Virology, 70(2) 1100-1108 (1996)), as well as any synthetically, e.g. recombinantly, produced antibody having an identical or substantially identical sequence of amino acids to the antibody produced by the hybridoma, and any antibody fragment thereof having identical heavy and light chain variable region domains to the full-length antibodies, such as the 2G12 domain exchanged Fab fragment (see, for example, Published U.S. Application, Publication No.: US20050003347 and Calarese et al., Science, 300, 2065-2071 (2003), including antibody fragments having at least antigen-binding portions of the 2G12 V_{H} domain (SEQ ID NO: 13; EVQLVESGGGLVKAGGSLILSCGVSNFRISAHTMNWVRRVPGGGLEWVASIS TSSTYRDYADAVKGRFTVSRDDLEDFVYLQMHKMRVEDTAIYYCARKGSDR LSDNDPFDAWGPGTVVTVSP), and typically of the 2G12 V_{L} domain (SEQ ID NO: 14: (DVVMTQSPSTLSASVGDTITITCRASQSIETWLAWYQQKPGKAPKWYKAST LKTGVPSRFSGSGSGTEFTLTISGLQFDDFATYHCQHYAGYSATFGQGTRVEIK) or SEQ ID NO: 209 (AGVVMTQSPSTLSASVGDTITITCRASQSIETWLAWYQQKPGKAPKLLIYKA STLKTGVPSRFSGSGSGTEFTLTISGLQFDDFATYHCQHYAGYSATFGQGTRV EIK)) of the full-length human antibody and retaining specific binding to the epitope(s) of the HIV gp120 antigen (e.g. as described in U.S. Pat. No. 5,911,989 and in Published U.S. Application, Publication No.: US20050003347). Amino acid residues in the V_{H} domains of 2G12 (e.g. amino acids at positions 19 (Ile), 57 (Arg), 77 (Phe), 84 (Val) and 113 (Pro), based on Kabat numbering), which vary compared to analogous residues in conventional antibodies, promote and/or stabilize the domain exchanged structure and stabilize the interface between the two V_{H} domains (Published U.S. Application, Publication No.: US20050003347). With its domain exchanged structure 2G12 binds with high affinity to oligomannose residues on the surface of HIV. Also exemplary of the domain exchanged antibodies are modified 2G12 antibodies, containing one or more modifications compared to a 2G12 antibody, such as modifications in CDR(s).

Exemplary of a modified 2G12 domain exchanged antibody that can be used in the provided methods, vectors and collections is the 3-Ala 2G12 antibody, and fragments thereof, which is a modified 2G12 antibody having three mutations to alanine in the amino acid sequence of the heavy chain antigen binding domain, rendering it non-specific for the cognate antigen (gp120) of the native 2G12 antibody. The 3-Ala 2G12 V_{H} domain contains the sequence of amino acids set forth in SEQ ID NO: 15 (EVQLVESGGGLVKAGGSLILSCGVSNFRISAHTMNWVRRVPGGGLEWVASIS TS STYRDYADAVKGRFTVSRDDLEDFVYLQMHKMRVEDTAIYYCARKGSDR AADADPFDAWGPGTVVTVSP). Thus, the 3-ALA 2G12 antibody does not specifically bind gp120. Also exemplary of the domain exchanged antibodies are modified 3-ALA 2G12 antibodies, having modification(s) compared to a 3-ALA 2G12 antibody, such as modifications in CDR(s).

2. Display Vectors and Methods

Provided herein are methods and tools, e.g. vectors, for display of domain exchanged antibodies and other antibodies on genetic packages, for example, phage, and domain exchanged antibody fragments displayed using the methods. The provided methods can be used, for example, to generate domain exchanged Fab fragments, domain exchanged single chain Fab fragments, domain exchanged scFv fragments and variations of these fragments.

Thus, the provided domain exchanged fragments can be displayed on genetic packages in the appropriate domain exchanged configuration. The provided methods and genetic packages can be used to select new domain exchanged antibodies, for example, domain exchanged antibodies having particular antigen-specificity, for example, by using one or more of the provided methods for introducing diversity in proteins.

a. Conventional Methods for Display of Antibody Polypeptides

It is discovered herein that display of domain exchanged antibodies on genetic packages (such as, for phage display) using conventional methods and vectors is not straightforward. Thus, provided are methods and vectors to display domain exchanged antibodies on phage and other genetic packages. The provided methods and vectors can be used in combination with known methods for library generation, polypeptide expression and phage display, e.g. as described herein below, to generate displayed antibodies, such as domain exchanged antibodies, and collections thereof.

With conventional phage display methods, antibodies typically are displayed as conventional Fab fragments or conventional scFv fragments. For Fab fragments, each fragment contains one heavy chain (containing one heavy chain variable region (V_{H}) and first constant region domain (C_{H}1)) and one light chain (containing one light chain variable region (V_{L}) and constant region (C_{L})). These two chains are expressed as separate polypeptides that pair through heavy-light chain interactions to form the conventional antibody fragment molecule. For phage display of the conventional Fab fragment, the heavy chain portion typically is fused to a phage coat protein as described herein below, such as gene III protein, to form a fusion protein. For scFv fragments, each fragment contains one heavy chain variable region (V_{H}) and one light chain variable region (V_{L}), which are connected by a peptide linker and expressed as a single chain. For phage display of the conventional scFv fragment, the single V_{H}-linker-V_{L} chain is fused to a phage coat protein to form a fusion protein.

Thus, with the conventional phage display methods, the displayed antibody fragment typically contains a single antibody combining site. By contrast, domain exchanged antibodies contain an interface between the two interlocked V_{H} domains (V_{H}-V_{H}′ interface), which can be promoted, for example, by mutations in the V_{H} domains that cause them to interact with one another and to pair with opposite V_{L} chains compared with conventional antibodies, as illustrated in FIG. 7. Methods and vectors are needed for displaying domain exchanged fragments with two interlocked heavy chain variable regions (V_{H}), each paired with a light chain variable region (V_{L}).

Generally, bivalent antibody molecules (having two antibody combining sites), such as F(ab′)2 fragments are not easily expressed in bacterial cells. One report describes phage display constructs for expression of F(ab′)2-like molecules containing two heavy chains (V_{H}-C_{H}1 each part of a coat fusion protein) and light chains (V_{L}-C_{L}); each construct contained all or part of a dimerization domain having a leucine zipper and an antibody hinge region. (Lee et al., Journal of Immunological Methods, 284 (2004) 119-132; see also U.S. publication No. US 2005/0119455). In this report, when an amber stop codon sequence was included between the V_{H}-C_{H}1—and phage coat protein-coding sequences, hinge region cysteines and at least part of the leucine zipper domain were required for the bivalent display.

Provided herein are vectors and methods for display of domain exchanged antibodies, including domain exchanged antibody fragments, and other bivalent antibodies.

b. Domain Exchanged Antibody Fragments

Provided are various domain exchanged antibody fragments, including displayed domain exchanged antibody fragments, vectors for display of the fragments and/or expression of the fragments, and methods for displaying the fragments. Exemplary provided domain exchanged antibody fragments are illustrated in FIG. 8, which illustrates the fragments displayed on phage. These fragments alternatively can be expressed as soluble proteins and can be displayed using other display systems. The fragments and methods for their generation are described in further detail below. FIG. 8 depicts the displayed antibody fragments as part of bacteriophage coat protein 3 (cp3) fusion proteins, for display on filamentous bacteriophage. Alternatively, any of the fragments depicted in the figure and described herein can be adapted for display on other genetic packages, for example, using different genetic package vectors and coat proteins. Alternatively, the fragments can be produced as non-fusion protein fragments for purposes other than display on genetic packages. The fragments described below are exemplary and the methods for vector design can be used in various combinations to generate other related domain exchanged fragments for display on genetic packages.

Exemplary of the provided domain exchanged fragments are fragments in which two chains (e.g. two V_{H}-C_{H}1 heavy chains or two V_{H}-linker-V_{L} single chains), encoded by the same genetic element (e.g. nucleotide sequence), are expressed on one phage as part of the domain exchanged antibody fragment. Typically, in this example, one of the chains is expressed as a soluble, non-fusion protein (e.g. V_{H}-C_{H}1 or V_{H}-V_{L}) and the other is expressed as a phage coat protein fusion protein (e.g. V_{H}-C_{H}1-cp3 or V_{L}-V_{H}-cp3); in this example, however, the antibody chain portion of the two polypeptides is identical as they are encoded by the same genetic element. Exemplary of such domain exchanged fragments are domain exchanged Fab fragments and domain exchanged scFv fragments. Also exemplary of the provided fragments are those (e.g. scFv tandem), containing multiple domains (e.g. V_{H}, V_{L}, C_{H}1, C_{L}) that are connected with peptide linkers to form the two heavy chain and two light chain domains of the domain exchanged configuration. Exemplary of such fragments are domain exchanged single chain Fab fragments and domain exchanged scFv tandem fragments.

Also exemplary of the domain exchanged fragments are fragments containing domains that promote interaction between chains, such as fragments containing antibody hinge regions and fragments containing cysteine mutations that promote formation of disulfide bridges. Such fragments are described in further detail below.

c. Provided Vectors and Methods for Display

Provided are vectors and methods for display of polypeptides, typically antibodies, such as domain exchanged antibodies (e.g. fragments of domain exchanged antibodies). The vectors include nucleic acids that promote expression of bivalent antibodies (such as domain exchanged antibody fragments); these nucleic acids can include, but are not limited to, stop codons, dimerization sequence nucleic acids, and peptide linkers. Thus, provided are vectors for expression of domain exchanged antibody fragments or other bivalent antibodies. In one example, the vector includes a stop codon or termination nucleic acid (e.g. TAG; UAG) between the nucleotide sequence encoding a chain of the antibody (e.g. the heavy chain) and the nucleotide sequence encoding a phage coat protein (e.g. between the sequence encoding V_{H}-C_{H}1 and the sequence encoding cp3 or between the sequence encoding V_{H} and the sequence encoding cp3). In some examples, the vectors include additional stop codons, such as a stop codon in the leader sequence operably linked to a nucleic acid encoding the polypeptide, e.g. for reduced expression of the polypeptide compared to the absence of the stop codon when expressed in a partial suppressor cell that allows partial read-through of protein translation through the stop codon. The provided vectors further include vectors containing peptide linker(s) between antibody domains, vectors containing amino acids or amino acid mutations hat promote covalent intra-chain interactions, for example, by promoting formation of disulfide bonds, and vectors containing other domains, such as dimerization domains and/or hinge regions and combinations thereof.

The vectors provided herein contain all of the necessary transcription, translation and regulatory elements for expression of one or more proteins of interest, such as a domain exchanged antibody. Optionally, nucleic acid encoding other recombinant proteins or fragments thereof also are included in the vectors, such as selectable markers, repressors, inducers, tags and phage proteins, such as phage coat proteins. Any suitable vector that can be modified by introduction of one or more stop codons, peptide linkers and/or dimerization sequences, can be used to generate the vectors provided herein. Such vectors include those for eukaryotic, such as mammalian, expression or prokaryotic expression, such as bacterial expression. Included amongst the vectors provided herein are plasmids, cosmids and phagemid vectors.

In one example, the vector exhibits the ability to confer display of the polypeptide on the surface of a genetic package. When the genetic package is a virus, for example, a bacteriophage, the vector can be the genetic package. Alternatively, the vector can be separate from the genetic package, but encode a polypeptide displayed by the genetic package. Exemplary of such a vector is a phagemid vector, which encodes a polypeptide to be expressed on a bacteriophage, for example, a filamentous bacteriophage. Thus, in a particular example, the vectors are phagemid vectors that can be used to display proteins as fusion proteins with the phage coat protein on the surface of phage. Other cell surface display systems are known in the art and include, but are not limited to ice nucleation protein (Inp)-based bacterial surface display system (Lebeault J M (1998) Nat. Biotechnol. 16: 576 80), yeast display (e.g. fusions with the yeast Aga2p cell wall protein; see U.S. Pat. No. 6,423,538), insect cell display (e.g. baculovirus display; see Ernst et al. (1998) Nucleic Acids Research, Vol 26, Issue 7 1718-1723), mammalian cell display, and other eukaryotic display systems (see e.g. U.S. Pat. No. 5,789,208 and WO 03/029456). The vectors provided herein can be used in any of these systems to display polypeptides, such as domain exchanged antibodies.

The vectors provided herein contain an origin of replication and, typically, one or more selectable markers. Selectable markers include, but are not limited to, antibiotic resistance gene(s), where the corresponding antibiotic(s) is added to the cell culture medium to select for cells containing the vector, or any other type of selectable marker gene known in the art, such as a prototrophy-restoring gene wherein the vector is introduced into a host cell that is auxotrophic for the corresponding trait, e.g., a biocatalytic trait such as an amino acid biosynthesis or a nucleotide biosynthesis trait, or a carbon source utilization trait. Other regulatory elements can be included in the vector to enhance protein expression and regulation. Such elements include, but are not limited to, transcriptional enhancer sequences, translational enhancer sequences, promoters, activators, translational start and stop signals, transcription terminators, cistronic regulators, polycistronic regulators, tag sequences, such as nucleotide sequence “tags” and “tag” polypeptide coding sequences, which can facilitate identification, separation, purification, and/or isolation of an expressed polypeptide. For example, the vectors provided herein can contain a tag sequence, such as adjacent to the coding sequence of the protein. In one embodiment, the tag sequence allows for purification of the protein, such as a domain exchanged antibody. For example, the tag sequence can be an affinity tag, such as a hexa-histidine affinity tag or a glutathione-S-transferase tag. The tag can also be a fluorescent molecule, such as yellow green fluorescent protein (GFP), or analogs of such fluorescent proteins. The tag can also be a portion of an antibody molecule, or a known antigen or ligand for a known binding partner useful for purification.

The nucleic acid encoding the protein(s) of interest typically is operably linked to, or contains, one or more of the following regulatory elements: a promoter, a ribosome binding site (RBS), a transcription terminator and translational start and stop signals. Many specific and consensus RBSs are known and can be used in the vectors provided herein (see e.g., Frishman et al., (1999) Gene 234(2):257-65; Suzek et al., (2001) Bioinformatics 17(12): 1123-30, and Shultzaberger et al., (2001) J. Mol. Biol. 313:215-228). In some examples, the vector contains a series of regulatory regions from a particular source. For example, the vectors provided herein can contain the repressor, promoter, operator, cap binding site, and RBS from the lactose operon from E. coli. In some examples, to promote secretion of the expressed proteins from the cytoplasm of the host cell into the periplasm or cell culture medium, the nucleic acid encoding the proteins of interest also is operably linked to nucleic acid encoding a leader peptide (i.e. a leader sequence). For example, the vector can contain a genetic element encoding a leader sequence and the coding sequence of a protein for which reduced expression is desired. This genetic element can be transcribed and translated as a single mRNA transcript and polypeptide, respectively. The translated leader peptide-protein fusion protein is translocated, for example, through the cytoplasmic membrane at which point the leader peptide is cleaved to release the soluble protein.

The vectors provided herein can contain nucleic acid encoding one or more proteins or fragments or domains thereof, such as domain exchanged antibodies, including domain exchanged antibody fragments. For example, the vectors can contain nucleic acid encoding 1, 2, 3, 4, 5, 6 or more proteins or fragments thereof. For example, the vector can contain nucleic acid encoding for a heavy chain and nucleic acid encoding for a light chain. In instances where two or more proteins or fragments thereof are expressed from the vector, the proteins can be produced from one mRNA transcript. For example, the nucleic acid encoding the two or more proteins can be under the control of a single set of transcriptional regulatory elements. Further, the mRNA can contain one or more RBSs, resulting in the translation of a single polypeptide or two or more polypeptides. In another example, the nucleic acid encoding the two or more proteins or fragments thereof can be under the control of two or more sets of transcriptional elements, thereby producing two or more mRNA transcripts.

In one embodiment, the vectors are phagemid vectors and can be used to display the protein of interest as a fusion protein on the surface of phage particles. Phagemid vectors typically contain less than 6000 nucleotides and do not contain a sufficient set of phage genes for production of stable phage particles after transformation of host cells. The necessary phage genes typically are provided by co-infection of the host cell with helper phage, for example M13K01 or M13VCS. Typically, the helper phage provides an intact copy of the gene III coat protein and other phage genes required for phage replication and assembly. Because the helper phage has a defective origin of replication, the helper phage genome is not efficiently incorporated into phage particles relative to the plasmid that has a wild type origin. Thus, the phagemid vector includes a phage origin of replication for incorporation of the vector can be packaged into bacteriophage particles when host cells transformed with the phagemid are infected with helper phage, e.g. M13K01 or M13VCS. See, e.g., U.S. Pat. No. 5,821,047. The phagemid genome typically contains a selectable marker gene, e.g. Amp^{R} or Kan^{R} (for ampicillin or kanamycin resistance, respectively) for the selection of cells that are infected by the phage.

The vectors provided herein can be generated by standard cloning and recombinant techniques well know in the art. To produce the vectors provided herein, for example, one or more features of an existing expression vector can be modified, removed or replaced, and one or more additional features can be incorporated. Exemplary vectors that can be modified, such as by recombinant techniques, to produce the vectors provided herein include, but are not limited to, the pET expression vectors (see, U.S. Pat. No. 4,952,496; available from NOVAGEN®, Madison, Wis., through EMD Biosciences; see, also literature published by Novagen describing the system), with which target genes are expressed under control of strong bacteriophage T7 transcription and translation signals, induced by providing a source of T7 RNA polymerase in the host cell. pET expression vectors include the pET-28 a-c vectors, pET 15b, pET19b and the pETDuet coexpression vectors. Other exemplary vectors that can be modified to produce the vectors provided herein include, for example, pQE expression vectors (available from Qiagen, Valencia, Calif.; see also literature published by Qiagen describing the system). pQE vectors have a phage T5 promoter (recognized by E. coli RNA polymerase) and a double lac operator repression module to provide tightly regulated, high-level expression of recombinant proteins in E. coli, a synthetic ribosomal binding site (RBS II) for efficient translation, a 6×His tag coding sequence, tₒ and T1 transcriptional terminators, ColE1 origin of replication, and a beta-lactamase gene for conferring ampicillin resistance.

In some instances, the vectors provided herein are phagemid vectors. Phagemid vectors are well known in the art (see, e.g., Andris-Widhopf et al. (2000) J Immunol Methods, 28: 159-81; Armstrong et al. (1996) Academic Press, Kay et al., Ed. pp. 35-53; Corey et al. (1993) Gene 128(1):129-34; Cwirla et al. (1990) Proc Natl Acad Sci USA 87(16):6378-82; Fowlkes et al. (1992) Biotechniques 13(3):422-8; Hoogenboom et al. (1991) Nuc Acid Res 19(15):4133-7; McCafferty et al. (1990) Nature 348(6301):552-4; McConnell et al. (1994) Gene 151(1-2):115-8; Scott and Smith (1990) Science 249(4967):386-90). Phagemid vectors contain a bacterial origin of replication and a phage origin of replication so that the plasmid is incorporated into bacteriophage particles when bacterial cells bearing the plasmid are infected with helper phage. In some examples, existing phagemid vectors are modified as described herein to produce phagemid vectors that facilitate reduced expression of one or more encoded proteins. Exemplary phagemid vectors that can be modified as described herein include, but are not limited to, pBluescript, pBK-CMV® (Stratagene) and pCAL vectors, which contain a sequence of nucleotides encoding the C-terminal domain of filamentous phage M13 Gene III coat protein.

In one example, the vectors provided herein are pCAL phagemid vectors and modified pCAL phagemid vectors. Exemplary of provided pCAL vectors for modification as described herein are pCAL G13 and pCAL A1, having the sequences of nucleotides set forth in SEQ ID NOS.: 7 and 8, respectively. pCAL G13 and pCAL A1 contain the gIII gene encoding the M13 gene III (gIII) coat protein, preceded by a multiple cloning site, into which a polynucleotide can be inserted. The pCAL vectors and modified pCAL vectors are described in detail hereinbelow.

The vectors provided herein can be generated using standard recombinant techniques well known to those of skill in the art. It is understood that any one or more elements of the vector described herein can be substituted or replaced with a comparable element that retains essentially the same function. In other instances, any one or more elements can be removed or added, provided the vector retains the ability to introduce the nucleic acid encoding the protein of interest into a partial suppressor host cell and replicate the nucleic acid, and that, when expressed from the vector, the protein of interest is expressed at reduced levels.

i. Stop Codons and Partial Suppressor Strains

The provided vectors can be used to display domain exchanged antibodies (which are bivalent antibodies with two interlocked heavy chains), and other bivalent antibodies, on the surface of genetic packages. In one example, the bivalent display, e.g. display of two associated heavy chains, is effected by introduction of stop codons into the provided vector. Thus, provided are methods for modifying vectors to introduce stop codons for display of domain exchanged and other bivalent antibodies. Thus, provided are vectors containing nucleic acids encoding termination or stop codon sequences, for example, a stop codon (such as an amber stop codon (UAG or TAG)), an ochre stop codon (UAA or TAA) or an opal stop codon (UGA or TGA)), between the nucleic acid encoding all or part of the antibody fragment and the nucleic acid encoding the genetic package coat protein. The vectors containing stop codons can be used for display of domain exchanged antibodies, e.g. domain exchanged Fab fragments, domain exchanged scFv fragments, and related fragments by transforming the vectors into suppressor host strains (e.g. partial suppressors) to display the domain exchanged antibodies.

a. Stop Codons

Three exemplary types of stop codons, each containing a different trinucleotide, are: amber (UAG; encoded by TAG), ochre (UAA; encoded by TAA) and opal (UGA; encoded by TGA). These stop codons can be recognized by specific suppressor tRNAs that incorporate a specific amino acid into the elongating polypeptide. Thus, instead translation terminating at the stop codon translation continues and the full length protein is produced. For example, some amber suppressor tRNAs can recognize the amber stop codon and insert a glutamine residue. In other examples, the amber suppressor tRNA inserts a serine, tyrosine, lysine or leucine. In other examples, an ochre suppressor tRNA can recognize the ochre stop codon and insert a glutamine, while other ochre suppressor tRNAs insert a lysine, and still others insert a tyrosine. Similarly, there exists opal suppressor tRNAs that recognize the opal stop codon and insert, for example, a glycine residue, or a tryptophan residue. When a stop codon is introduced into the vector, upon translation in a partial suppressor cell, both a full length polypeptide (if there is read through of the stop codon) and a truncated polypeptide (if there is no read through and translation terminates at the stop codon) is produced.

b. Expression in Suppressor and Non-Suppressor Hosts

In general, when a vector containing such a stop codon nucleic acid is transformed into a non-suppressor host cell, only soluble (non-fusion) proteins are produced from the vectors (e.g. only proteins that do not contain the phage coat protein). Expression in a partial suppressor strain (e.g. a partial amber suppressor strain), however, results in “read-through,” translation that continues without being halted by the stop codon. Typically, depending on the suppressor strain, this “read-through” occurs only a certain percentage of the time. This partial read-through of the amber-stop results in a mixed collection of polypeptides. The mixed collection contains some polypeptide fusion proteins and some soluble polypeptides, which are not part of coat protein fusions.

In one example, the mixed population contains between 50% or about 50% and 75% or about 75% soluble polypeptide and between 25% or about 25% and 50% or about 50% polypeptide-coat protein fusion protein.

The vectors and host cells provided herein can be designed such that the amino acid incorporated into the growing polypeptide at the site of the introduced stop codon is that which normally would be found at that position in the polypeptide. This can be achieved by replacing a codon that encodes an amino acid that is carried by a suppressor tRNA with the stop codon that is recognized by that suppressor tRNA. For example, if the seventh amino acid of a polypeptide is glutamine then the seventh codon can be replaced by an amber stop codon, and the vector can be introduced into a partial amber suppressor cell that contains an amber suppressor tRNA (i.e. a suppressor tRNA that recognizes the amber stop codon) that carries a glutamine residue at its aminoacyl site (i.e. an amber suppressor tRNA^{Gln} molecule). Thus, when read through occurs, a glutamine residue is incorporated at the seventh amino acid position of the polypeptide, thus preserving the wild-type amino acid sequence of the protein.

In another example, if the partial suppressor cell that is used as the host cell contains an amber suppressor tRNA that introduces a tyrosine residue into the growing polypeptide (i.e. an amber suppressor tRNA^{Tyr} molecule), then the amber stop codon can be incorporated into the vector, in place of a codon encoding a tyrosine residue. Thus, when read through occurs in a partial amber suppressor cell, the polypeptide is produced with a tyrosine at the position encoded by the amber stop codon, thus preserving the wild type amino acid sequence of the polypeptide. In other instances, the amino acid that is incorporated at the site of the introduced stop codon is different to the amino acid that is normally present at that position in the polypeptide. Typically, the amino acid that is introduced, however, is one that does not alter the conformation and/or function of the translated protein. As noted above and below in section (f), a range of natural and synthetic suppressor tRNAs exist that incorporate various amino acid residues at the different stop codons. Further, additional suppressor tRNA molecules can be generated by mutation of the tRNA anticodon using recombinant techniques well known in the art. Thus, a variety of wild type codons can be selected as the site for introduction of the stop codon, resulting in incorporation of the wild-type amino acid residue by a suitable suppressor tRNA when the vector is introduced into an appropriate partial suppressor strain.

The efficiency of suppression can be affected by the amino acids adjacent to the introduced stop codon (see e.g. Urban et al., (1996) Nucl. Acids. Res. 24(17): 3424-3430). In some examples, single nucleotide changes can be made 3′ or 5′ of the stop codon to increase or decrease suppression efficiency. In other examples, multiple nucleotide changes can be made immediately 3′ or 5′ of the stop codon to increase or decrease suppression efficiency. One of skill in the art can modify the sequence adjacent to the introduced stop codon to increase or decrease the suppression efficiency observed when the vector is introduced into an appropriate partial suppressor cell. For example, the choice of nucleotide immediately to the 3′ of an amber stop codon can affect the amount of read-through. In one example, different vectors can be used to produce differing amounts of read-through. For example, two different pCAL vectors provided herein result in different amounts of read-through through the amber-stop codon. The pCAL G13 vector (SEQ ID NO: 7) contains a guanine residue at the position just 3′ of the amber stop codon, while the pCAL A1 vector (SEQ ID NO: 8) contains an adenine at this position. Thus, the choice of vector will determine how much read-through occurs through the amber stop codon when using a partial suppressor strain, thus controlling the relative amount of fusion versus non-fusion target/variant polypeptide translated from the vector.

c. Translation and Expression of Two Distinct Polypeptides from a Single Genetic Element

Typically, the vector contains a stop codon between the nucleic acid encoding the polypeptide of interest (e.g. antibody chain) and the nucleic acid encoding the display coat protein (e.g. cp3). In this case, a single genetic element encodes both the polypeptide of interest and the coat protein, thus resulting in a single mRNA transcript that encodes both these polypeptides. Translation of the resulting transcript in a partial suppressor strain, therefore, produces a full length peptide-coat protein fusion protein when there is read through of the stop codon, and also a truncated (soluble) peptide, without the coat protein, is produced if there is no read through and translation terminates at the stop codon in the leader sequence. Thus, two copies of the polypeptide, e.g. two copies of an antibody fragment chain (e.g., two copies of the V_{H}-C_{H}1 chain or the V_{H}-linker-V_{L} chain), are expressed, one of which is part of a fusion protein and the other of which is a soluble protein. In the case of domain exchanged antibodies, the soluble and fusion-protein chains interact on the surface of the genetic package, through conventional and/or artificial interactions (e.g. hydrophobic interactions, disulfide bonds and/or dimerization domains), to display domain exchanged antibodies with two conventional antigen combining sites. Such suppressor host strains are well known and described (see, for example, Bullock et al., Biotechniques 5:376-379 (1987)).

d. Exemplary Fragments Displayed from Vectors with Stop Codons

Exemplary of provided domain exchanged fragments that can be displayed from provided vectors containing stop codons are: the domain exchanged Fab fragment (illustrated in FIG. 8A), the domain exchanged scFv fragment (illustrated in FIG. 8F), the domain exchanged Fab hinge fragment (example illustrated in FIG. 8B), the domain exchanged Fab Cys19 fragment (example illustrated in FIG. 8C), the domain exchanged scFab ΔC2 and scFab ΔC2 Cys19 fragments (example illustrated in FIG. 8D), scFv hinge fragment (example illustrated in FIG. 8G) and scFv Cys19 fragments (example illustrated in FIG. 8H), which are described in further detail in the sections below, and variations thereof.

ii. Peptide Linkers

The provided vectors also include vectors containing nucleic acids encoding peptide linkers, for example, between nucleic acids encoding domains of the antibody fragment. In the provided methods and vectors, nucleic acid encoding peptide linkers can be used in combination with or in lieu of the stop codon, to promote and/or stabilize the domain exchanged configuration. In some examples, the peptide linkers bring two antibody variable domains (encoded by separate genetic elements within the vector) into proximity, allowing formation of the domain exchanged three-dimensional structure with two heavy chain and two light chain variable regions. In another example, the domain exchanged structure, promoted by use of a stop codon or other technique, is stabilized by the use of peptide linkers between two or more chains.

Exemplary of the provided domain exchanged fragments containing peptide linkers to promote domain exchanged configuration is the domain exchanged scFv tandem fragment. In other examples, peptide linkers can be used in combination with the stop/termination sequences and/or other methods, for example, to provide additional stability to the domain exchanged configuration, for example, in the domain exchanged scFv fragment, an example of which is illustrated in FIG. 8F and described below and contains two chains, each containing one V_{H} and one V_{L} domain, joined by a peptide linker, and in the domain exchanged scFabΔC² fragment, which contains modifications compared to the domain exchanged Fab fragment, including peptide linkers, as described below.

Linkers for use in antibody fragments are well known in the art. Exemplary linkers that can be inserted between chains in the provided methods are listed in Table 3. Methods for preparation of these linkers and their insertion into vectors for expression of domain exchanged antibody fragments is described in Example 14, below. Any known linkers can be used with the provided methods.

TABLE 3
Linkers for generating domain exchanged anti-
body fragments for phage display

| | | SEQ | | Amino |
|---|---|---|---|---|
| | | ID | SEQ ID | acid |
| | | NO | NO | length |
| Linker | Nucleotide sequence | (nucleo- | (amino | of |
| Name | encoding linker | tide) | acid) | linker |
| Linker 1 | GGTGGTTCGTCTGGATCTT | 16 | 17 | 18 |
| | CCTCCTCTGGTGGCGGTGG | | | |
| | CTCGGGCGGTGGTGGC | | | |
| Linker 2 | GGAGGATCCGGCAGCAGCA | 18 | 19 | 18 |
| | GCAGCGGCGGCGGCGGCGG | | | |
| | GAGCTCCGGCGGCGGA | | | |
| L216 | GGAGGATCCGGCAGCAGCA | 20 | 21 | 16 |
| | GCAGCGGCGGCGGGAGCTC | | | |
| | CGGCGGCGGA | | | |
| L217 | GGAGGATCCGGCAGCAGCA | 22 | 23 | 17 |
| | GCAGCGGCGGCGGCGGGAG | | | |
| | CTCCGGCGGCGGA | | | |
| L219 | GGAGGATCCAGCGGCAGCA | 24 | 25 | 19 |
| | GCAGCAGCGGCGGCGGCGG | | | |
| | CGGGAGCTCCGGCGGCGGA | | | |
| L220 | GGAGGATCCAGCGGCGGCA | 26 | 27 | 20 |
| | GCAGCAGCAGCGGCGGCGG | | | |
| | CGGCGGGAGCTCCGGCGGC | | | |
| | GGA | | | |
| BamHISacI | GATCCGGTGGCGGCAGCGA | 28 | 29 | 29 |
| | AGGTGGTGGCAGCGAAGGT | | | |
| | GGCGGTAGCGAAGGTGGCG | | | |
| | GCAGCGAAGGCGGCGGTAG | | | |
| | CGGTGGGAGCT | | | |

iii. Dimerization Sequences

The provided vectors also include vectors containing nucleic acids encoding one or more dimerization domains which can promote interaction between polypeptide chains and can stabilize the domain exchange configuration. Dimerization domains are any domains that facilitate interaction between two polypeptide sequences (e.g. antibody chains). Dimerization domains include, for example, an amino acid sequence containing a cysteine residue that facilitates formation of a disulfide bond between two polypeptide sequences. In one example, the dimerization domain includes all or part of a full-length antibody hinge region. Dimerization domains can include one or more dimerization sequences, which are sequences of amino acids known to promote interaction between polypeptides. Such dimerization domains are well known, and include, for example, leucine zippers, GCN4 zippers, for example, the sequence of amino acids set forth in SEQ ID NO: 1 (GRMKQLEDKVEELLSKNYHLENEVARLKKLVGERG), and mixtures thereof.

In one example, the dimerization domains are generated by mutation of the antibody chains, for example, the heavy chain variable regions, to promote their interaction. In another example, the dimerization domains are generated by insertion of additional nucleotide sequence encoding a dimerization sequence or sequence encoding one or more cysteine residues, for example, at the C- or N-terminal end of one or more antibody chain. Exemplary of such sequences are sequences encoding leucine zippers, CCN4 zippers or antibody hinge regions. Such additional sequences can be inserted so that the dimerization domains occur between the antibody chains or at the C-terminal end of an antibody chain, for example, between the heavy chain and the phage coat protein. In one example, the dimerization domain is located at the C-terminal end of the heavy chain variable or constant domain sequence and/or between the heavy chain variable or constant domain sequence and any viral coat protein component sequence.

a. Mutations Promoting Dimerization

In one example, one or more mutations is made to the nucleotide sequence encoding the domain exchange antibody fragment in order to facilitate and/or stabilize display of the fragment with the appropriate configuration. Exemplary of such mutations are mutations that result in amino acid substitution(s) that introduce one or more additional cysteine residues into the antibody, to promote formation of disulfide bridges, e.g. between different heavy and/or light chain domains, in order to stabilize the domain exchanged structure.

Exemplary of such mutations is one made by mutating the nucleotide sequence encoding the 19^{th} amino acid in the 2G12 antibody heavy chain, such that this amino acid is changed from an isoleucine (Ile) to a cysteine (Cys) residue. In one example, this mutation or other similar mutation is made to other domain exchanged antibodies. This substitution promotes formation of a disulfide bridge between the two heavy chain variable regions, stabilizing the domain exchanged configuration. Exemplary of the antibody fragments having this mutation are the domain exchanged Fab Cys19 (illustrated in FIG. 8C and described below).

Other mutations that stabilize intra-chain interactions are known in the art. Any known method for stabilizing interactions can be used with the provided methods to generate constructs for phage display of domain exchanged antibody fragments.

b. Hinge Regions

In some examples, the hinge region of the antibody molecule is included in the domain exchanged antibody fragment for display on genetic packages. As described above, the hinge region of IgG, IgD and IgA antibody molecules, located between the C_{H}1 and C_{H}2 regions, contains cysteine residues that promote formation of disulfide bonds between heavy chains. Nucleotide sequences encoding the hinge region of a domain exchanged antibody can be included in the nucleic acid encoding the domain exchanged antibodies for expression of domain exchanged antibody fragments (e.g. Fab, scFv) from the vectors provided herein. The hinge region can promote interaction between the two heavy chains, thus stabilizing the domain exchanged configuration.

Exemplary of displayed domain exchanged antibody fragments that contain hinge regions are illustrated in FIGS. 8B (domain exchanged Fab hinge) and 2G (domain exchanged scFv hinge). Thus, included amongst the vectors provided herein are phagemid vectors that contain a nucleic acid encoding a hinge region between the nucleic acid encoding the C_{H}1 domain (Fab hinge) or variable region (scFv) of a domain exchanged antibody fragment and the nucleic acid encoding the coat protein (for example, gene III as illustrated in FIG. 8B). The domain exchanged Fab hinge fragment is identical to the domain exchanged Fab fragment, except that each heavy chain further includes a hinge region in each heavy chain following the C_{H}1 region, which promotes interaction between the two heavy chains. Similarly, a phagemid vector encoding a domain exchanged scFv hinge fragment can contain nucleic acid encoding a hinge region between the nucleic acids encoding the V_{H} domain and the coat protein. Thus, the domain exchanged scFv hinge fragment is identical to the domain exchanged scFv fragment, with the exception that a hinge region is included in each chain, promoting formation of a disulfide bridge, which can stabilize the configuration of the domain exchanged fragment.

c. Other Dimerization Domains

Other domains that can be used to promote interaction between molecules (e.g. antibody chains) are well known (see, for example, U.S. Published Application No.: US20050119455, describing use of a leucine zipper dimerization domain to promote interaction between antibody chains to increase avidity in a phage displayed divalent Fab fragment). Dimerization domains can include, for example, an amino acid sequence comprising a cysteine residue that facilitates formation of a disulfide bond between two polypeptide sequences. Dimerization domains can include one or more dimerization sequences, which are sequences of amino acids known to promote interaction between polypeptides. Such dimerization domains are well known, and include, for example, leucine zippers, GCN4 zippers, for example, the sequence of amino acids set forth in SEQ ID NO: 1 (GRMKQLEDKVEELLSKNYHLENEVARLKKLVGERG), and mixtures thereof.

iv. Exemplary Domain Exchanged Fragments

FIG. 8 illustrates exemplary displayed domain exchanged fragments that can be made using the provided methods and vectors. The examples illustrated in FIG. 8 are displayed on bacteriophage, as fusion proteins containing part of the cp3 coat protein. These fragments, and variations thereof, can also be displayed using other coat proteins and/or in other display systems.

a. Domain Exchanged Fab Fragment

As illustrated in FIG. 8A, the domain exchanged Fab fragment contains two heavy chains (one soluble and one fusion protein) and two light chains. The displayed domain exchanged Fab fragment can be generated using a vector containing a nucleic acid encoding the V_{H}-C_{H}I chain, followed by a nucleic acid encoding a stop codon (e.g. the amber stop codon (TAG)), followed by a nucleic acid encoding a coat protein (such as a phage coat protein, e.g. cp3, encoded by gene III, as depicted in the example in FIG. 8A). In one example, the vector also includes the nucleic acid encoding a light chain (V_{L}-C_{L}). Alternatively, the light chain can be expressed from another vector, which is used to transform the same host cell. The vectors for display of the domain exchanged Fab antibody are designed such that, when expressed in a partial suppressor host cell (e.g. XL1-Blue or ER2738 cells), two separate heavy chain elements (V_{H}-C_{H}1 and V_{H}-C_{H}1-coat protein fusion) are produced from a single copy of the encoding nucleic acid. These two copies of the heavy chain assemble, along with two soluble light chains produced by the same vector or a different vector, to form the domain exchanged “Fab” antibody on the surface of the genetic package, having two conventional antibody combining sites.

b. ii. Domain Exchanged scFv Fragment

As illustrated in FIG. 8F, the displayed domain exchanged scFv fragment contains two chains, each of which contains one V_{H} and one V_{L} domain, joined by a peptide linker (V_{H}-linker-V_{L}). One of these chains is a fusion protein and further contains the sequence of a coat protein (the example in FIG. 8F illustrates a fusion with phage coat protein cp3). Thus, one of the chains is a fusion protein, containing the V_{H}-linker-V_{L} and a coat protein, such as cp3 (coat protein-V_{H}-linker-V_{L}). The other chain is a soluble chain (V_{H}-linker-V_{L}). In the folded domain exchanged scFv fragment, the two chains interact through the V_{H} domains, providing the interlocked domain exchanged configuration.

The domain exchanged scFv fragment can be generated with a vector containing a nucleic acid encoding the V_{H}-linker-V_{L} single chain, followed by a sequence encoding a stop codon (e.g. the amber stop codon (TAG)), followed by a sequence encoding a coat protein (e.g. a phage coat protein such as gene III, as depicted in FIG. 8F). Such a vector is designed so that, when expressed in a partial suppressor host cell (e.g. XL1-Blue or ER2738 cells), a soluble single chain (V_{H}-linker-V_{L}) and a fusion protein single chain (coat protein-V_{H}-linker-V_{L}) are produced, and assemble on the phage surface to form the domain exchanged “scFv” antibody on the surface of phage, having two chains (one soluble, one fusion protein) and two conventional antibody combining sites. The two chains are encoded by a single copy of the genetic element in the vector.

For display of the domain exchanged scFv fragment, one of the chains contains a coat protein, in proximity to a coat protein (cp3/GeneIII, as shown in FIG. 8F). In this example, the polynucleotide encoding the domain exchanged scFv fragment contains one nucleic acid encoding the V_{H} domain, one nucleic acid encoding the V_{L} domain and one nucleic acid encoding the coat protein. The polynucleotide further contains a nucleic acid encoding a polypeptide linker between the V_{H} and V_{L} domains and a nucleic acid encoding a stop codon between the V_{H} and coat protein encoding sequences. Thus, when the construct is expressed in partial suppressor strains, the two chains (one soluble, one fusion protein) are expressed and displayed on the genetic package surface as a domain exchanged antibody complex.

c. Domain Exchanged Fab Hinge Fragment

Also exemplary of displayed (e.g. phage-displayed) domain exchanged antibody fragments that are generated using the provided stop codon methods are domain exchanged Fab hinge fragments.

As illustrated in FIG. 8B, the display vector encoding the domain exchanged Fab hinge fragment is generated by inserting a nucleic acid encoding a hinge region into the domain exchanged Fab fragment vector, between the nucleic acid encoding the C_{H}1 domain and the nucleic acid encoding the coat protein (for example, gene III as illustrated in FIG. 8B). Thus, the domain exchanged Fab hinge fragment is identical to the domain exchanged Fab fragment, except that each heavy chain further includes a hinge region in each heavy chain following the C_{H}1 region, which promotes interaction between the two heavy chains.

d. Domain Exchanged scFv Tandem Fragment

An example of this fragment displayed on phage, as part of a cp3 fusion protein, is illustrated in FIG. 8E. In the nucleic acid molecule encoding this fragment, three nucleic acids encoding peptide linkers are inserted between the nucleic acids encoding a first V_{L} and first V_{H} chain, between the nucleic acids encoding the first V_{H} and a second V_{H} chain, and between nucleic acids encoding the second V_{H} and a second V_{L} chain. Thus, while for display of a domain exchanged Fab fragment, two heavy chains (soluble and fusion protein) are encoded by a single genetic element, the scFv tandem vector, by contrast, carries two copies each of identical nucleic acid molecules encoding the light chain and heavy chain variable region domains, all four of which are joined by nucleic acids encoding peptide linkers. Thus, in the fragment, two heavy and two light chain variable region domains are joined by peptide linkers. In the case of a displayed domain exchanged scFv tandem fragment (as illustrated in FIG. 8E), the four chains are and expressed as a single chain coat protein fusion molecule, on the genetic package surface, to form the domain exchanged structure. Thus, in this fragment, the peptide linkers are used instead of the stop codon to provide multiple heavy and light chains in the same domain exchanged fragment.

e. Domain Exchanged Single Chain Fab Fragments

In another example, illustrated in FIG. 8D(i), the displayed domain exchanged Fab fragment is modified by inserting sequences encoding peptide linkers between the V_{L}-C_{L} sequence and the V_{H}-C_{H}1-coat protein (e.g. geneIII) sequence, thereby generating (upon expression in a partial suppressor strain) one V_{L}-C_{L}-linker-V_{H}-C_{H}1-coat protein fusion chain and one soluble V_{L}-C_{L}-linker-V_{H}-C_{H}1 chain, which pair on the genetic package surface to form a single chain Fab (scFab) fragment, such as the scFab ΔC², having the domain exchanged configuration. As illustrated in FIG. 8D(i), in the scFab ΔC² fragment, two cysteines are mutated to ablate formation of the disulfide bonds between the constant regions, as the presence of the linkers makes these disulfide bonds unnecessary for stabilizing the folded antibody fragment. A modified scFab ΔC² fragment, the scFab ΔC²Cys19 fragment, is described below.

f. Domain Exchanged Fab Cys19

The domain exchanged Fab Cys 19 fragment is illustrated in FIG. 8C. It is identical to the domain exchanged Fab fragment, but carries this Ile-Cys mutation; the domain exchanged scFab ΔC²Cys19 (illustrated in FIG. 2D(ii)), which is identical to the domain exchanged scFab ΔC² fragment but further carries this mutation; and the scFv Cys19 (illustrated in FIG. 8H), which is identical to the domain exchanged ScFv fragment, but carries this additional mutation. Nucleic acid sequences of exemplary vectors encoding domain exchanged 2G12 Fab Cys19, scFab ΔC²Cys19, and scFv Cys19 fragments are set forth in SEQ ID NOs: 30, 31 and 32, respectively.

g. Domain Exchanged scFv Hinge

Similarly, the display vector encoding the domain exchanged scFv hinge fragment (illustrated in FIG. 8G) is generated by inserting into the vector encoding the domain exchanged scFv fragment a nucleic acid encoding a hinge region between the nucleic acids encoding the V_{H} and the coat protein. Thus, the domain exchanged scFv hinge fragment is identical to the domain exchanged Fab fragment, with the exception that a hinge region is included in each chain, promoting formation of a disulfide bridge, which can stabilize the configuration of the domain exchanged fragment.

3. Exemplary Provided Vectors

Provided are vectors for display of polypeptides, such as provided variant polypeptides, including bivalent display of antibodies, particularly domain exchanged antibodies.

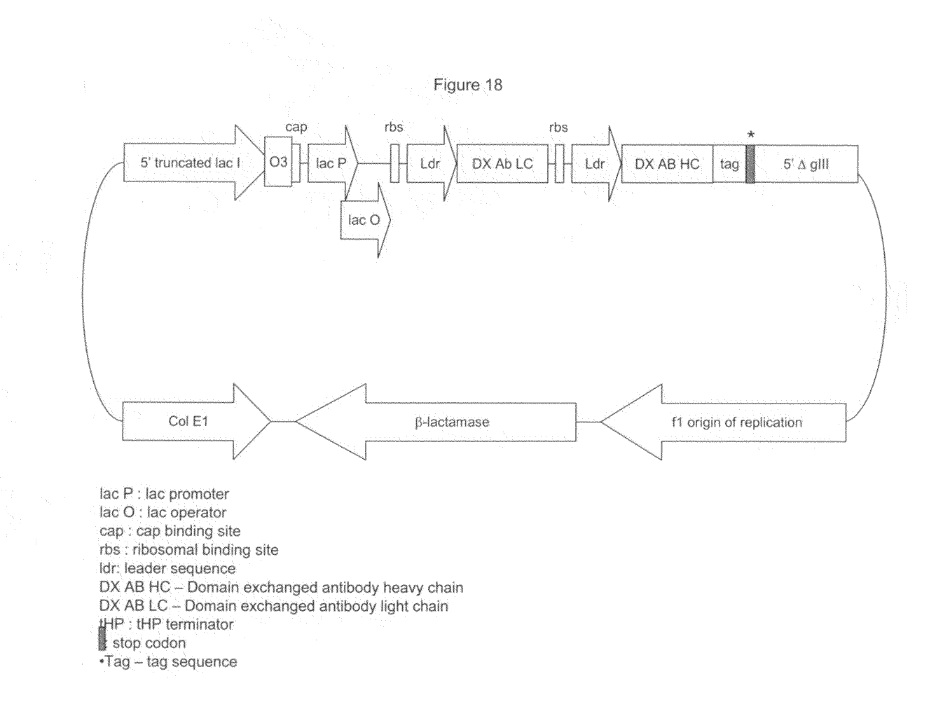

FIG. 18 illustrates an exemplary phagemid vector for display of a domain exchanged antibody, in which a stop codon is inserted between nucleic acid encoding a domain exchanged antibody heavy chain and nucleic acid encoding a coat protein, in this case phage coat protein gene III. The example illustrated in FIG. 18 further contains a nucleic acid encoding a light chain. In the example illustrated in FIG. 18, the single genetic element containing these antibody chain sequences is operably linked to a truncated lactose promoter and operator, such that their expression is regulated by lactose or an appropriate lactose substitute, such as IPTG. The vector contains nucleic acid encoding a tag and a phage coat protein downstream of the nucleic acid encoding the heavy chain. The nucleic acid encoding the tag is followed by a stop codon. Thus, when introduced into an appropriate partial suppressor cell, the heavy chain is expressed as a soluble protein (with a tag) and as a fusion protein with the phage coat protein, and the light chain is expressed as a soluble protein. Inclusion of the stop codon in the leader sequences linked to the nucleic acid encoding the heavy and light chains facilitates reduced expression of the these proteins in corresponding partial suppressor cells (i.e. amber partial suppressor cells if amber stop codons is introduced), thus reducing the toxicity of these proteins to the host cell.

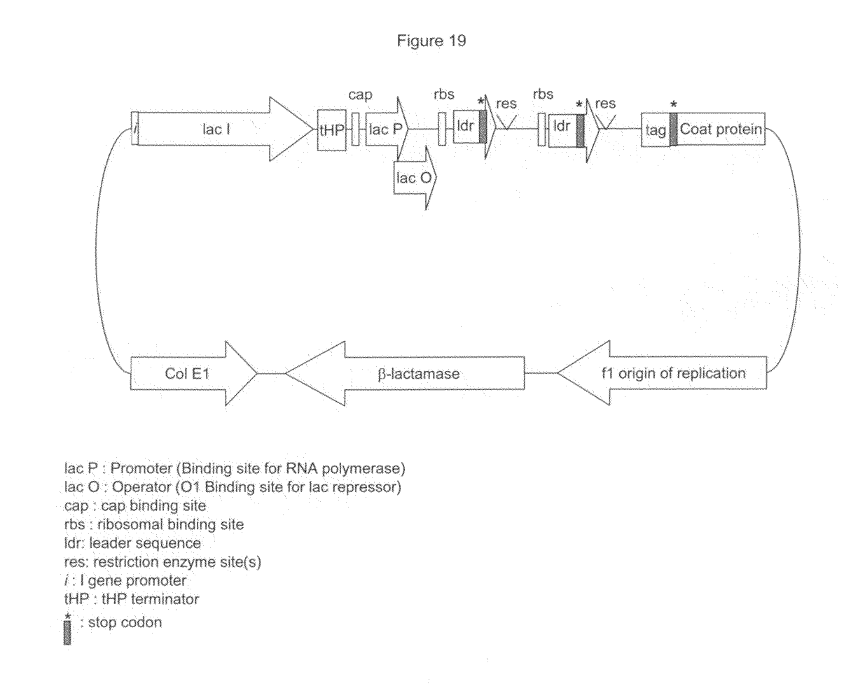

The provided vectors further include vectors for reduced expression of proteins (e.g. for reduced toxicity to host cells), such as domain exchanged antibodies, including displayed polypeptides. FIG. 19 illustrates an exemplary phagemid vector that can be used to insert nucleic acid encoding a protein for which reduced expression is desired. Such a vector includes a lac promoter system operably linked to a leader sequence into which a stop codon has been introduced. One or more restriction enzyme recognition sequences (e.g. a multiple cloning site) are downstream of the leader sequence, allowing for insertion of nucleic acid encoding a protein or domain or fragment thereof. Down stream of this is a tag sequence, followed by a stop codon and nucleic acid encoding a phage coat protein. In a further example, the vector contains an additional leader sequence containing a stop codon, followed by one or more restriction enzyme recognition sequences, allowing insertion of a second polynucleotide encoding another protein or fragment or domain thereof. As will be appreciated by one of skill in the art, additional elements and features can be included in the vector or substituted for those illustrated, while still maintaining the function of the vector, i.e. the ability to express a protein at reduced levels by the incorporation of one or more stop codons, such as the incorporation of one or more stop codon in a leader sequence. For example, different promoters can be used to replace the lac promoter system. In other instances, various elements can be excluded, such as the tag sequence.

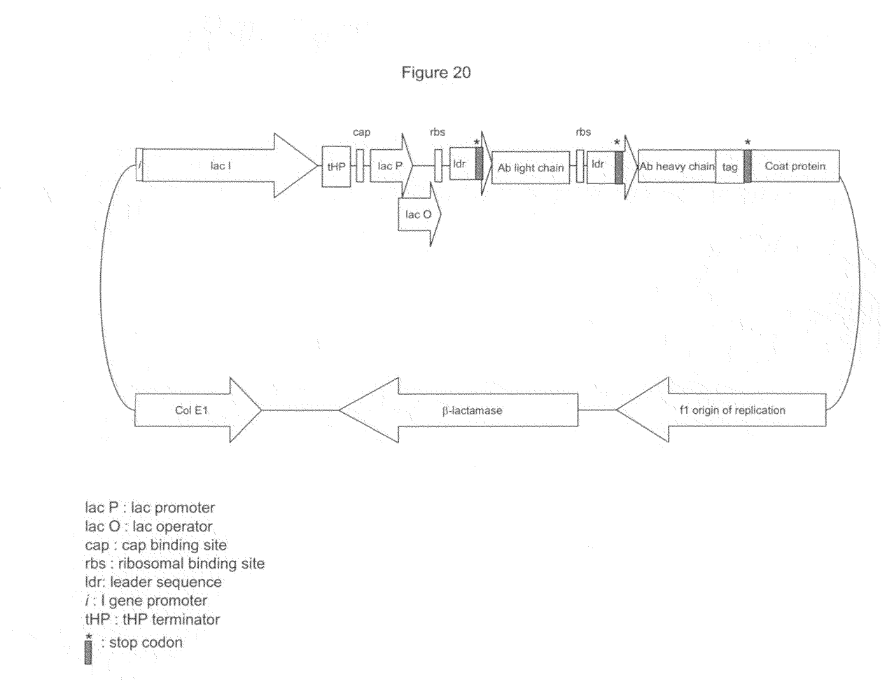

In another example, the vectors can be used to express an antibody, such as domain exchanged antibody, or fragments or domains thereof, at reduced levels to reduce toxicity. For example, the vector can be used to express a Fab fragment at reduced levels. Thus, a phagemid vector provided herein can contain nucleic acid encoding an antibody light chain operably linked at its 5′ end to the 3′ end of a leader sequence into which a stop codon has been introduced, and nucleic acid encoding an antibody heavy chain operably linked at its 5′ end to the 3′ end of a leader sequence into which a stop codon has been introduced (FIG. 20). The single genetic element containing these leader and antibody chain sequences is operably linked to the lactose promoter and operator, such that their expression is regulated by lactose or an appropriate lactose substitute, such as IPTG. Further, the vector contains nucleic acid encoding a tag and a phage coat protein downstream of the nucleic acid encoding the heavy chain. The nucleic acid encoding the tag is followed by a stop codon. Thus, when introduced into an appropriate partial suppressor cell, the heavy chain is expressed as a soluble protein (with a tag) and as a fusion protein with the phage coat protein, and the light chain is expressed as a soluble protein. Inclusion of the stop codon in the leader sequences linked to the nucleic acid encoding the heavy and light chains facilitates reduced expression of the these proteins in corresponding partial suppressor cells (i.e. amber partial suppressor cells if amber stop codons is introduced), thus reducing the toxicity of these proteins to the host cell.

a. pCAL Vectors

The provided vectors for display of polypeptides, such as domain exchanged antibodies include vectors for display of bivalent antibodies, and vectors for display with reduced toxicity compared to vectors not containing stop codons, e.g. by providing reduced expression. Exemplary of the provided vectors include, but are not limited to, pCAL vectors, such as vectors having the sequence of nucleic acids set forth in any of SEQ ID NOs: 7 (pCAL G13), 8 (pCAL A1), 11 (2G12 pCAL G13), 33 (3-ALA 2G12 pCAL G13), 217 (2G12 pCAL A1), 280 (2G12 pCAL IT*) and 281 (2G12 pCAL ITPO), which are described herein. The pCAL vectors contain nucleic acids encoding part (e.g. C-terminus) of the filamentous phase M13 Gene III coat proteins.

Exemplary of the pCAL vectors are, pCAL G13 and pCAL A1, having the sequences of nucleotides set forth in SEQ ID NOs.: 7 and 8, respectively. pCAL G13 and pCAL A1 contain a truncated gIII gene, encoding a truncated M13 gene III coat protein, preceded by a multiple cloning site, into which a polynucleotide, for example, a polynucleotide containing a target polynucleotide, can be inserted. Example 9, below describes methods for generating the pCAL G13 and pCAL A 1 vectors. A map of pCAL G13 is shown in FIG. 6.

The pCAL vectors further contain amber stop codon DNA sequences (TAG, SEQ ID NO: 9), which encode the RNA amber stop codon (UAG; SEQ ID NO: 10), just upstream of the nucleic acid encoding the portion of geneIII. Thus, the vectors are designed such that polynucleotides, e.g. domain exchanged antibody-encoding polynucleotides, can be inserted just upstream of the amber stop codon. The presence of the amber stop codon allows regulation of polypeptide expression, for example, by expression in a partial amber suppressor host cell as described in section (f), below. For example, expression in a partial amber suppressor host cell can be carried out to regulate the frequency at which fusion protein and soluble polypeptides, respectively, are produced.

Different pCAL vectors provided herein can result in different amounts of readthrough through the amber-stop codon. For example, the pCAL G13 vector contains a guanine residue at the position just 3′ of the amber stop codon, while the pCAL A1 vector contains an adenine at this position. Choice of vector can determine how the relative amount of read-through that occurs through the stop codon, e.g. when using a partial suppressor strain, and thus can regulate the relative amount of fusion versus non-fusion target/variant polypeptide translated from the vector.

The provided vectors include vectors, e.g. pCAL vectors, containing nucleic acids encoding domain exchanged Fab fragments, such as, but not limited to, domain exchanged Fab fragment of the 2G12 antibody and domain exchanged Fab fragment of the 3-Ala 2G12 antibody, which contains 3 mutations in the antibody combining site compared to the 2G12 antibody as described herein.

i. 2G12 pCAL Vectors and Variants

The provided vectors include pCAL vectors for expression and display of the domain exchanged antibody, 2G12, and a 2G12 variant 3-ALA 2G12, for example, domain exchanged Fab fragments of 2G12 and 3-ALA 2G12 and other fragments, and fragments of variant domain exchanged antibodies that contain modifications compared to 2G12.

An exemplary vector, the 2G12 pCAL G13 vector (also called the 2G12 pCAL vector) contains the nucleotide sequence set forth in SEQ ID NO: 11, is produced as described in Example 10B. This vector, which is set forth schematically in FIG. 21, contains a nucleic acid encoding heavy and light chain domains of the 2G12 antibody. Expression as both soluble 2G12 Fab fragments and 2G12-gIII coat protein fusion proteins for display on phage particles can be effected from this vector in partial amber suppressor cells by virtue of the amber stop codon between the nucleotides encoding the 2G12 heavy chain nucleotides encoding the truncated gIII coat protein, using the provided methods. In this vector, the polynucleotide encoding the 2G12 light chain is operably linked to the Pel B leader sequence (the nucleic acid sequences encoding the leader peptides from the pectate lyase B protein from Erwinia carotovora), while the 2G12 heavy chain is operably linked to the OmpA leader sequence (the nucleic acid sequence encoding the leader peptide from the E. coli outer membrane protein. The 2G12 pCAL vector further contains a truncated lac I gene; the lac I gene encodes the lactose repressor molecule. Ribosome binding sites upstream of both the PelB and OmpA leader sequences facilitate translation. The 2G12 pCAL G13 vector (SEQ ID NO: 11) can be used to display a 2G12 domain exchanged Fab antibody fragment on phage.

Another exemplary vector, the 3-Ala pCAL G13 vector, contains the nucleotide sequence set forth in SEQ ID NO: 33 and is produced as described in Example 10B, below. This vector contains nucleic acid encoding heavy and light chain domains of 3-ALA 2G12 and is otherwise identical to the 2G12 pCAL G13 vector. The 3-Ala pCAL G13 vector can be used to display the 3-Ala 2G12 Fab fragment on phage. Example 11, below, describes display of 2G12 domain exchanged Fab fragment on phage using this vector. Example 13 describes studies demonstrating antigen-specific selection by panning using the displayed 2G12 domain exchanged Fab fragment, expressed from this vector.

ii. 2G12 pCAL IT*

Also exemplary of phagemid vectors provided herein is the 2G12 pCAL IT* vector. This vector, which is schematically depicted in FIG. 22 and has a sequence of nucleotides set forth in SEQ ID NO: 280, was generated as described in Example 12, below. The 2G12 pCAL IT* vector can be used to express, with reduced toxicity (compared to the absence of stop codons in leader sequences), Fab fragments of the domain exchanged 2G12 antibody, which recognize the HIV gp120 antigen. Expression as both soluble 2G12 Fab fragments and 2G12-gIII coat protein fusion proteins for display on phage particles can be effected in partial amber suppressor cells by virtue of the amber stop codon between the nucleotides encoding the 2G12 heavy chain nucleotides encoding the truncated gill coat protein.

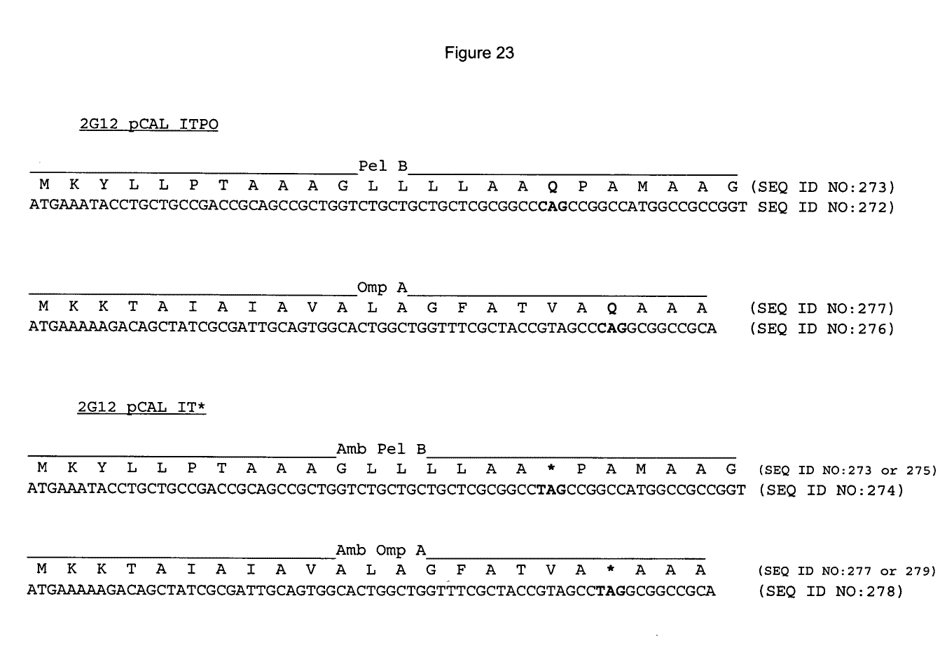

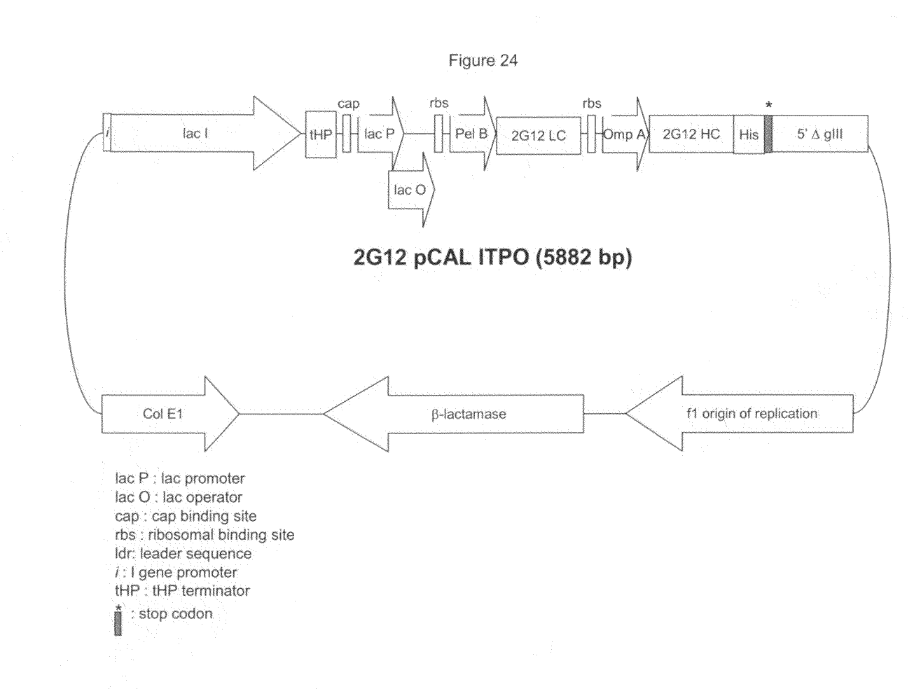

The polynucleotide encoding the 2G12 light chain is operably linked to the Pel B leader sequence (the nucleic acid sequences encoding the leader peptides from the pectate lyase B protein from Erwinia carotovora), while the 2G12 heavy chain is operably linked to the OmpA leader sequence (the nucleic acid sequence encoding the leader peptide from the E. coli outer membrane protein. The inclusion of an amber stop codon in each of the leader sequences results in reduced expression of the 2G12 heavy and light chains in partial amber suppressor strains, and, therefore, reduced toxicity. The stop codons are incorporated by mutation of the CAG triplet encoding a glutamine (Glu, Q) in each of the leader sequences to a TAG amber stop codon (see, FIG. 23). For example, the nucleotide triplet at nucleotides 52-54 of the PelB leader sequence set forth in SEQ ID NO:272, encoding the glutamine at amino acid position 18 of the PelB leader peptide set forth in SED ID NO:273, was modified to generate a TAG amber stop codon at nucleotides 52-54 (SEQ ID NO:274). Thus, upon expression in a partial amber suppressor cell, in some instances read though occurs to produce a polypeptide encoding the PelB leader peptide linked to the 2G12 light chain, while in other instances, translation is terminated at the stop codon and a truncated 17 amino acid PelB leader peptide is produced, with no expression of the 2G12 light chain. Similarly, the nucleotide triplet at nucleotides 58-60 of the OmpA leader sequence set forth in SEQ ID NO: 276, encoding the glutamine at amino acid position 20 of the OmpA leader peptide set forth in SED ID NO: 277) was modified to generate a TAG amber stop codon at nucleotides 58-60 (SEQ ID NO: 278). Thus, upon expression in a partial amber suppressor cell, in some instances read though occurs to produce a polypeptide encoding the OmpA leader peptide linked to the 2G12 heavy chain, while in other instances, translation is terminated at the stop codon and a truncated 19 amino acid OmpA leader peptide is produced, with no expression of the 2G12 heavy chain.

To further regulate expression of the 2G 12 heavy and light chains, the transcription of both is under the control of the lac promoter/operator system. The 2G12 pCAL IT* vector contains the full length lac I gene, which encodes the lactose repressor molecule. In the absence of lactose or another suitable inducer, such as IPTG, the repressor binds to the operator and interferes with binding of the RNA polymerase to the promoter, inhibiting transcription of the operably linked heavy and light chain genes. In the presence of lactose or a suitable equivalent, such as IPTG, the lactose metabolite allolactose binds to the repressor, causing a conformational change that renders the repressor unable to bind to the operator, thereby allowing binding of the RNA polymerase and transcription of a single transcript encoding the 2G12 light and heavy chains. Ribosome binding sites upstream of both the PelB and OmpA leader sequences facilitate translation.

iii. Vectors for Display of Other Domain Exchanged Fragments

The provided vectors further include vectors for display of other domain exchanged antibody fragments (e.g. other 2G12 fragments), such as fragments containing dimerization domains, such as hinge regions, cysteins forming disulfide bridges, and single chain fragments, such as domain exchanged single chain Fab fragments and domain exchanged scFv fragments, and combinations thereof (see, for example, FIG. 8). Example 14 describes the generation of constructs for the display of various other 2G12 fragments, in addition to the 2G12 domain exchanged Fab fragment on phage. Such additional fragments include the domain exchanged Fab hinge fragment (expressed from the vector containing the nucleotide sequence set forth in SEQ ID NO: 34, which contains an additional sequence in the Fab-encoding sequence, that encodes a hinge region between the heavy chain constant region and the gene III coat protein encoding sequence); the 2G12 domain exchanged Fab Cys19 fragment (expressed from the vector containing the nucleotide sequence set forth in SEQ ID NO: 30, which contains a mutation in the heavy chain of the Fab fragment, resulting in an Ile-Cys mutation to promote interaction of the two heavy chain variable regions of the Fab fragment); the 2G12 domain exchanged scFab ΔC²Cys19 (expressed from the vector containing the nucleotide sequence set forth in SEQ ID NO: 31, which contains the same mutation in the heavy chain of the Fab fragment, resulting in an Ile-Cys mutation, and contains a sequence encoding a linker between the heavy and light chains); the 2G12 domain exchanged scFv fragment (expressed from the vector containing the nucleotide sequence set forth in SEQ ID NO: 35, which contains one V_{H} encoding sequence and one V_{L} encoding sequence, followed by an amber stop codon, promoting formation of a domain exchanged scFv fragment with two conventional antibody combining sites); the 2G12 domain exchanged scFv tandem fragment (expressed from the vector containing the nucleotide sequence set forth in SEQ ID NO: 36, which includes the sequence for an additional V_{H} and an additional V_{L} region, separated by a linker sequence, for expression of two heavy chain variable domains and two light chain variable region domains from the single vector); the 2G12 domain exchanged scFv hinge and scFv hinge (ΔE) fragments (expressed from the vector containing the nucleotide sequence set forth in SEQ ID NO:37, and SEQ ID NO: 38, respectively, each of which contains the sequence of the scFv encoding vector, with an additional hinge-region encoding sequence, to promote interaction between the two single chains in the fragment); and the 2G12 domain exchanged scFv Cys 19 fragment (expressed from the vector containing the nucleotide sequence set forth in SEQ ID NO: 32, which contains the sequence of the scFv fragment with the mutation in the heavy chain variable region, resulting in an Ile-Cys mutation to promote interaction of the two heavy chain variable regions of the scFv fragment). Example 14, below, describes a study demonstrating expression and display of some of these fragments.

4. Suppressor Strains and Systems

To express the protein(s) from the provided vectors that contain stop codon nucleic acids, the vectors are transformed into an appropriate partial suppressor host cell strain. Thus, provided herein are cells for the expression and display of proteins, including domain exchanged antibodies. In some instances, the suppression efficiency (i.e. the efficiency with which the suppressor tRNA effects read through) of the partial suppressor cell into which the vector has been transformed is less than or about 90%, such as no more than or about 85%, 80%, 75%, 70%, 65%, 60%, 55%, 50%, 45%, 40%, 35%, 30%, 25%, 20%, or 15%. Thus, by introducing the vectors provided herein into partial suppressor cells, the expression of proteins encoded by the vectors can be reduced by or about 10%, 15%, 20%, 25%, 30%, 35%, 40%, 45%, 50%, 55%, 60%, 65%, 70%, 75%, 80% 85% or more compared to expression of the proteins from a comparable vector that does not contain the introduced stop codons.

The type of host cell used to express the protein of interest from the vectors provided herein will depend upon the type of stop codon incorporated into the vector, such as between the polypeptide (e.g. antibody chain) and the coat protein, or into the leader sequence that is linked to nucleic acid encoding the protein of interest. For example, if one or more amber stop codons are introduced into the vector, then the vector is transformed into a partial amber suppressor strain that harbors an amber suppressor tRNA molecule. If one or more ochre stop codons are introduced into vector, the vector is transformed into a partial ochre suppressor strain that harbors an ochre suppressor tRNA molecule. Further, a host cell typically is chosen in which the suppressor tRNA molecule will incorporate the desired amino acid residue when read through of the stop codon occurs (such as the wild-type amino acid or another desired amino acid). For example, if the vector contains an amber stop codon that was introduced in place of a glutamine codon (or where a glutamine is desired), then the vector can be introduced into a partial amber suppressor strain that expresses an amber suppressor tRNA that incorporates a glutamine residue at the TAG codon.

The vector can be introduced into the partial amber suppressor cell using any method known in the art, including, but not limited to, electroporation and chemical transformation. Following transformation into an appropriate partial suppressor strain, in some instances, expression of the polypeptides can be induced in the host cells. For example, if transcription is under control of a regulatable promoter, then the appropriate conditions can be generated to induce transcription. Further, in some examples, the host cells are phage-display compatible host cells, and are used to display the protein(s) of interest on the surface of a bacteriophage, for example, in a phage display library. By generating phage display libraries, the proteins displayed on the phage can be screened, analyzed and selected for based on various properties, such as binding activities. such as described in more detail below.

a. Suppressor tRNAs and Partial Suppressor Cells

The vectors provided herein can be transformed into a suitable partial suppressor cell. When the vectors are harbored in such cells, two possible events can occur when a ribosome encounters the stop codon that was introduced into the vector, in a host cell containing an appropriate suppressor tRNA: (1) termination of polypeptide elongation can occur if the appropriate release factors associate with the ribosome, or (2) an amino acid can be inserted into the growing polypeptide chain if a suppressor tRNA associates with the ribosome. The efficiency of suppression (read-through) depends upon how well the suppressor tRNA is charged with the appropriate amino acid, the concentration of the suppressor tRNA in the cell, and the “context” of the stop codon in the mRNA. For example, as noted above, the nucleotide on the 3′ side of the codon can affect how much read through translation occurs. In some instances, the suppression efficiency (i.e. the efficiency with which the suppressor tRNA effects read through) is less than or about 90%, such as no more than or about 85%, 80%, 75%, 70%, 65%, 60%, 55%, 50%, 45%, 40%, 35%, 30%, 25%, 20%, or 15%.

The selection of the appropriate partial suppressor host cell strain for transformation with the vectors provided herein is based upon the type of suppressor tRNA molecule that is contained in the host cell. In addition to selection based on whether the cells suppressor tRNA molecule is an amber, ochre or opal suppressor tRNA, selection also can be based on what amino acid residue is incorporated by the suppressor tRNA when read through of the introduced stop codon occurs. For example, if an opal stop codon has been introduced into the vector, and this opal stop codon is introduced such that it replaces a wild type tyrosine codon, then the vector can be introduced into a partial opal suppressor cell that has an opal suppressor tyrosine tRNA molecule (tRNA^{Tyr}) that introduces a tyrosine residue at the opal stop codon.

In one example, the 2G12 pCAL IT* vector, in which amber stop codons have been introduced into the PelB and Omp leader sequences (by replacement of the glutamine codon (GAG) with the amber stop codon (TAG)) that are linked to the nucleic acid encoding the 2G12 light and heavy chains, respectively, and also introduced between the polynucleotides encoding the heavy chain and the phage coat protein, can be transformed into a phage display compatible partial amber suppressor strain that harbors an amber suppressor glutamine tRNA (tRNA^{Gln}) and that introduces a glutamine residue at the amber stop during translation. Thus, the translated leader-antibody chain fusion polypeptides maintain the wild-type amino acid sequence. Following cleavage of the leader peptides, the 2G12 light chains, 2G12 heavy chains, and 2G12 heavy chain-gIIIp fusion proteins are secreted and can associate with one another to form 2G12 domain exchanged Fab fragments on the surface of phage.

The suppressor tRNAs in the partial suppressor cells can be natural or synthetic. In some instances, the suppressor tRNA is encoded in the genome of the suppressor cell. In other examples, the suppressor tRNA is encoded in a plasmid or bacteriophage or other vector carried by the suppressor cell. Thus, partial suppressor cells can be produced by introducing a modified gene encoding a suppressor tRNA molecule, such as one contained on a plasmid, into a non suppressor cell. Many suppressor tRNA molecules are known in the art and can be utilized in the methods herein to express proteins at reduced levels from the vectors provided herein (see e.g., Miller et al., (1989) Genome 21:905-908, Kleina et al., (1990) J. Mol. Biol. 212:295-318, Huang et al., (1992) J. Bacteriol. 174:5436-5441, Taira et al (2006) Nuc. Acids Symp. Series 50:233-234, Kleina et al., (1990) J. Mol. Biol. 213:705-717, Normanly et al., (1990) J. Mol. Biol. 213:719-726; Kohrer et al., (2004) Nucl. Acids Res. 32:6200-6211, Normanly et al., (1986) Proc. Nat. Acad. Sci. USA 83:6548-6552. The suppressor tRNAs can be naturally found in the partial suppressor cell strains, or can be introduced into a non suppressor cell to generate a partial suppressor cell. For example, a plasmid or bacrteriophage encoding the suppressor tRNA can be introduced into a non suppressor strain to generate the desired partial suppressor strain. Table 3B provides non-limiting examples of E. coli suppressor tRNAs that recognize the amber, ochre or opal stop codon. The table sets forth the suppressor name, the type of suppressor (amber, opal or ochre), the amino acid that is inserted during read through, and the reported observed suppression efficiency.

TABLE 3B
E. coli suppressor tRNAs

| | | | |
|---|---|---|---|
| | | Amino acid | Supression |
| Suppressor | Type | inserted | efficiency |

Natural suppressors

| | | | |
|---|---|---|---|
| supE | Amber | Gln | 1-61% |
| supP | Amber | Leu | 30-100% |
| supD | Amber | Ser | 6-54% |
| supU | Amber | Trp | |
| supF | Amber | Tyr | 11-100% |
| supZ | Amber | Tyr | |
| supB | Ochre | Gln | |
| supL (supG) | Ochre | Lys | |
| supN | Ochre | Lys | |
| supC | Ochre | Tyr | |
| supM | Ochre | Tyr | |
| glyT | Opal | Gly | |
| trpT | Opal | Trp | 0.1-30% |

Synthetic suppressors

| | | | |
|---|---|---|---|
| pGIFB:Ala | Amber | Ala | 8-83% |
| pGIFB:Cys | Amber | Cys | 17-51% |
| pGIFB:Glu | Amber | Glu (85%) | 8-100% |
| | | Gln (15%) | |
| pGIFB:Gly | Amber | Gly | 39-67% |
| pGIFB:His | Amber | His | 16-100% |
| pGIFB:Phe | Amber | Phe | 48-100% |
| pGIFB:Pro | Amber | Pro | 9-60% |
| tRNA(CUAAla2) | Amber | Ala | |
| tRNA(CUAGly1) | Amber | Gly | |
| tRNA(CUAHisA) | Amber | His | |
| tRNA(CUALys) | Amber | Lys | |
| tRNA(CUAProH) | Amber | Pro | |
| tRNAPheCUA | Amber | Phe | 54-100% |
| tRNACysCUA | Amber | Cys | 17-50% |

i. Amber Suppressor Cells

In one example, the vectors provided herein contain one or more introduced amber stop codons, such as between a nucleic acid encoding an antibody chain and nucleic acid encoding a coat protein, or in the nucleic acid encoding a leader peptide that is linked to the nucleic acid encoding the protein for which reduced expression is desired. Thus, to express the proteins (such as two proteins, one fusion protein and one soluble protein, from a single genetic element), the vectors are introduced into a partial amber suppressor cell. These cells contain amber suppressor tRNA molecules that recognize the UAG codon on the mRNA transcript and insert an amino acid into the polypeptide. As noted above, the efficiency with which the amber stop codon is suppressed (i.e. the efficiency with which read through occurs) depends on several factors. For the purposes herein, however, the vectors provided herein are introduced into partial amber suppressor cells in which suppression efficiency is less than or about 90%, such as no more than at or about 85%, 80%, 75%, 70%, 65%, 60%, 55%, 50%, 45%, 40%, 35%, 30%, 25%, 20%, or 15%.

Exemplary of partial amber suppressor cells are those that carry the supE amber suppressor tRNA. The supE tRNA molecule is a mutant form of a wild-type tRNA^{Gln} molecule, which recognizes a 5′ CAG 3′ codon in the mRNA and inserts glutamine (Gln, Q) into the growing polypeptide chain. In contrast, the supE tRNA contains a mutation in the anticodon (relative to the wild-type tRNA) such that it recognizes the amber stop codon (5′ UAG 3′) in the mRNA inserts a glutamine residue (Gln, Q). E. coli cells that contain the supE tRNA suppressor (sometimes denoted as being positive for the supE44 genotype), and are thus amber suppressor cells (including partial amber suppressor cells) include, but are not limited to, XL1-Blue, DB3.1, DH5α, DH5αF′, DH5aF′IQ, DH5α-MCR, DH21, EB5α, HB101, RR1, JM101, JM103, JM106, JM107, JM108, JM109, JM110, LE392, Y1088, C600, C600hfl, MM294, NM522, Stb13 and K802 cells. Typically, amber suppressor cells containing the supE suppressor tRNA are partial suppressor cells with a suppression efficiency of approximately 1-60% (see, e.g. Kleina et al., (1990) J. Mol. Biol. 212:295-318). In some examples, the partial amber suppressor strains also are phage display compatible. Thus, when phagemid vectors are introduced into these cells, the protein can be displayed on the surface of a phage, as described below.

5. Methods for Phage Display of Domain Exchanged Antibodies, Phage Display Libraries Containing Domain Exchanged Antibodies and Methods for Selecting Domain Exchanged Antibodies from the Libraries

Also provided herein are collections, including display libraries (e.g. phage display libraries) containing the polypeptides, such as domain exchanged antibodies, methods for making the libraries, and methods for selecting polypeptides, e.g. domain exchanged antibodies, from the libraries. Any known methods for generating libraries containing variant polynucleotides and/or polypeptides (e.g. methods described herein) can be used with the provided methods and vectors to generate display libraries, e.g. phage display libraries, of domain exchanged antibodies, and to select variant domain exchanged antibodies from the libraries.

Typically, the display libraries contain members having mutations compared to a target polypeptide, such as a domain exchanged antibody. Such libraries can be used to select new domain exchanged antibodies, for example, based on their ability to bind particular antigens with a desired affinity. In one example of such a display library, the target polypeptide contains an antigen-binding fragment of the 2G12 or 3-Ala 2G12 antibody, and each of the polypeptide members contains one or more variant positions. Typically, the variant positions are within the antibody combining sites, e.g. within one or more CDR region in the heavy and/or light chain of the domain exchanged molecule. The provided methods and vectors can be used to generate display libraries, which can be used to vary polypeptides, including domain exchanged antibodies.

Various well-known methods can be used in combination with the provided display methods to select desired polypeptides from the collections of displayed polypeptides (e.g. domain exchanged antibodies). For example, methods for selecting desired polypeptides from phage display libraries include panning methods, where phage displaying the polypeptides are selected for binding to a desired binding partner (see, for example, Clackson and Lowman, Phage Display: A Practical Approach; (2004) Oxford University Press (Chapter 1, Russel et al., An introduction to Phage Biology and Phage Display, pp. 1-26; Chapter 4, Dennis and Lowman, Phage selection strategies for improved affinity and specificity of proteins and peptided pp. 61-83)). Polypeptides selected from the collections optionally can be amplified, and analyzed, for example, by sequencing nucleic acids or in a screening assay (see, for example, Phage Display: A Practical Approach; (2004) Oxford University Press (Chapter 5, De Lano and Cunningham, Rapid screening of phage displayed protein binding affinities by phage ELISA pp 85-94)) to determine whether the selected polypeptide(s) has a desired property. In one example, iterative selection steps are performed in order to enrich for a particular property of the variant polypeptide. Exemplary of the display libraries are libraries where the target polypeptide contains an antigen-binding fragment of the 2G12 or 3-Ala 2G12 antibody, and each of the polypeptide members contains one or more variant positions. Typically, the variant positions are within the antibody combining sites, e.g. within one or more CDR region in the heavy and/or light chain of the domain exchanged molecule. Examples 4-8 describe generation of collections of variant polynucleotides for generation of phage display libraries using a 3-Ala 2G12 Fab fragment as a target polypeptide, using various provided methods for introducing diversity. The methods provided herein can be used to vary any domain exchanged antibody through generation of a phage display library.

### K. EXAMPLES

The following examples are included for illustrative purposes only and are not intended to limit the scope of the invention.

### Example 1

### Randomization of HSV-8 CDR3 by Random Cassette Mutagenesis

### Example 1A

### Synthesis of Randomized HSV-8 CDR3 Oligonucleotide Pools for Random Cassette Mutagenesis

To demonstrate that randomized synthetic oligonucleotides can be used to generate collections of variant polynucleotides, random cassette mutagenesis (RCM) (without assembly) was used introduce diversity to a single six amino acid target portion (SEQ ID NO: 39), within the CDR3 of a human anti-HSV-8 antibody (AC8) heavy chain target polypeptide (SEQ ID NO: 40). Table 4 sets forth two reference sequences, AC8HCDR3org (+) and AC8HCDR3org (−), which were used to design pools of positive and negative strand HSV-8 CDR3 oligonucleotides, respectively. As shown in Table 4, the positive and negative strand reference sequences are complementary to one another over a region of 106 contiguous nucleotides (shown in normal text or bold). This 106 nucleotide region includes a sequence of 48 nucleotides, encoding the heavy-chain CDR3 of the anti-HSV-8 heavy chain target polypeptide (for the positive strand reference sequence: GTTGCCTATATGTTGGAACCTACCGTCACTGCAGGGGGTTTGGACGTC; SEQ ID NO.: 41). A target portion (SEQ ID NO: 42) within this CDR3, eighteen contiguous nucleotides in length, is shown in bold in Table 4. Additionally, the positive strand reference sequence contains a 5′ TA overhang and a 3′ AGCT overhang (SEQ ID NO: 43), shown in italics, which were included so that duplex cassettes, formed using the oligonucleotides, could be ligated directly into vectors cut with NdeI and Sad.

Positive and negative strand reference sequence oligonucleotides (having 100% sequence identity to the positive and negative strand reference sequences respectively) were designed. Pools of randomized oligonucleotides also were designed using the reference sequence as a design template. The oligonucleotides were ordered from Integrated DNA Technologies (IDT®) (Coralville, Iowa), synthesized using standard cyanoethyl chemistry with phosphoramidite monomers. Nucleic acid sequences representing the randomized oligonucleotides are set forth in Table 4 (AC8HCDR3 (+) and AC8HCDR3 (−)). Each randomized oligonucleotide contained 5′ and 3′ reference sequence portions (shown in normal text or italics) and a central randomized portion (shown in bold), 18 nucleotides in length, corresponding to the target portion of the reference sequence. The randomized portion was synthesized using an NNK doping strategy to minimize the frequency of stop codons and ensure that each amino acid position encoded by a codon in the randomized portion could be occupied by any of the 20 amino acids. With this doping strategy, nucleotides were incorporated using an NKK pattern and a MNN pattern, during synthesis of the positive and negative strand randomized portions respectively, where N represents any nucleotide, K represents T or G and M represents A or C (table 4). Each synthesized oligonucleotide contained a phosphate group at the 5′ terminus.

TABLE 4
HSV-8 CDR3 randomized and reference sequence
oligonucleotides

| | | SEQ |
|---|---|---|
| Oligonucleotide | | ID |
| Pool | Sequence | NO.: |
| AC8YCDR3org (+) | 5′-TAT GAA GAC ACG GCC ATG TAT | 44 |
| | TAC TGT GCG AGA GTT GCC TAT ATG | |
| | TTG GAA CCT ACC GTC ACT GCA GGG | |
| | GGT TTG GAC GTC TGG GGC CAA GGG | |
| | ACC ACG GTC ACC GTG AGC T-3′ | |
| AC8HCDR3org (−) | 5′-CAC GGT GAC CGT GGT CCC TTG | 45 |
| | GCC CCA GAC GTC CAA ACC CCC TGC | |
| | AGT GAC GGT AGG TTC CAA CAT ATA | |
| | GGC AAC TGT CGC ACA GTA ATA CAT | |
| | GGC CGT GTC TTC A-3′ | |
| AC8HCDR3 (+) | 5′-TAT GAA GAC ACG GCC ATG TAT | 46 |
| | TAC TGT GCG AGA NNK NNK NNK NNK | |
| | NNK NNK CCT ACC GTC ACT GCA GGG | |
| | GGT TTG GAC GTC TGG GGC CAA GGG | |
| | ACC ACG GTC ACC GTG AGC T-3′ | |
| AC8HCDR3 (−) | 5′-CAC GGT GAC CGT GGT CCC TTG | 47 |
| | GCC CCA GAC GTC CAA ACC CCC TGC | |
| | AGT GAC GGT AGG MNN MNN MNN MNN | |
| | MNN MNN TCT CGC ACA GTA ATA CAT | |
| | GGC CGT GTC TTC A-3′ | |

### Example 1B

### Formation of Randomized HSV-8 CDR3 Oligonucleotide Duplex Cassettes, Ligation into scFv Vectors and Transformation of Bacterial Cells

To form randomized oligonucleotide duplex cassettes, equimolar amounts of the AC8HCDR3 (+) and AC8HCDR3 (−) randomized pools described in Example 1A were mixed in STE buffer (10 mM Tris pH 8.0, 50 mM NaCl, 1 mM EDTA). The mixture was heated to 90-95° C. for five minutes and slowly cooled to room temperature (25° C.), whereby positive and negative strand oligonucleotides were annealed through complementary regions. This step generated duplex cassettes, each containing restriction site overhangs that would enable subsequent insertion into vectors. Positive and negative strand reference sequence oligonucleotides were hybridized by the same method. Free oligonucleotides then were removed using a PCR cleanup column from the QIAquick® PCR Purification Kit (Qiagen), following the supplier's protocol, with the exception that the column was washed two times with Buffer PE at the appropriate step.

The resulting randomized and reference sequence duplex oligonucleotide cassettes were ligated (using T4 DNA ligase (NEB) in its reaction buffer (under conditions provided by the supplier)) into a pET28(a) vector (SEQ ID NO.: 48) (Novagen®, EMD Biosciences) containing DNA encoding a pAC8-scFv fragment, having the nucleic acid sequence set forth in SEQ ID NO.: 49 that had been cut with NdeI and SacI restriction endonucleases. Samples then were transformed into high-efficiency electrocompetent XL-1 Blue cells (Stratagene, La Jolla, Calif.), which then were plated on agar plates supplemented with (100 μg/mL) kanamycin and incubated overnight at 37° C. Vector without inserted cassette (pET28 AC8-scFv), which was digested with NdeI and SacI and treated with Antarctic Phosphatase (New England Biolabs® Inc., Ipswich, Mass.) also was transformed for use as a control.

Following overnight incubation, kanamycin-resistant colonies were counted to determine transformation efficiency. Table 5 sets forth the respective number of colonies (cfu) recovered per starting amount (μg) of vector containing reference sequence duplex cassettes (AC8HCDR3org duplex), randomized duplex cassettes (AC8HCDR3 duplex) and no insert (pET28 AC8-scFv).

TABLE 5
Recovery of colonies following transformation of randomized sequences

| Oligonucleotides | | | % of cfu/μg |
|---|---|---|---|
| ligated into | | | reference |
| AC8-scFv | | | sequence |
| vector | Description | cfu/μg vector | vector |
| AC8HCDR3org | reference | 3.25-3.89 × 10⁶ | 100 |
| duplex | sequence duplex | | |
| AC8HCDR3 | Randomized | 3.89-7.25 × 10⁶ | 120-186 |
| duplex | duplex (random | (120-186%) | |
| | cassette | | |
| | mutagenesis | | |
| pET28 AC8-scFv | Vector-only | 1.56-6.12 × 10⁵ | 4-18 |
| | control | (4-18.8%) | |
| AC8HC3 mixed | Randomized | 3.81-7.11 × 10⁶ | 97.9-219 |
| template(+) duplex | duplex (fill-in | (97.9-219%) | |
| | mutagenesis) | | |

As shown in Table 5, empty vector yielded only 4-18% of the colonies recovered after transformation with reference sequence duplex cassette-containing vectors. Yield from randomized duplex cassette vectors, however, was between 120% and 186% of the reference sequence yield, indicating that oligonucleotide randomization did not negatively affect transformation efficiency.

### Example 1C

### Amino Acid Sequencing of Randomized Clones

To assess randomization, vector DNA from each of twenty-four (24) representative colonies from the randomized vector transformants was sequenced. For this process, cassette nucleic acid was submitted for sequencing to Eton Biosciences (San Diego, Calif.). A portion of the nucleic acid sequence was used to infer the amino acid sequence encoded by the duplex cassette DNA. Sequencing revealed that seventeen (17) of the twenty-four (24) clones (70.8%) were productive (having no deletion of nucleotides in the coding region). Partial nucleic acid and encoded amino acid sequences for these productive clones are set forth in Table 6A. Table 6A also sets forth the sequence of the analogous portion of the reference sequence and corresponding amino acid sequence (AC8). The portions of the sequences set forth in bold represent the randomized portions of the polynucleotide within the randomized clones and the corresponding variant portions of the encoded polypeptide. The analogous target portions of the reference sequence and target polypeptide (AC8 heavy chain) also are shown in bold. The nucleic acid and amino acid sequences of the CDR3 are shown in italics. An asterisk in the amino acid sequence indicates the presence of an amber stop codon in the coding sequence, which produces a Q in the amino acid sequence in a sup E44 genotype amber suppressor strain (e.g. XL1-blue).

TABLE 6A

Variant anti-HSV-8 CDR3 Sequences Generated by Random
Cassette Mutagenesis

| | | SEQ | | SEQ |
|---|---|---|---|---|
| Clone | | ID | Amino Acid | ID |
| Name | Nucleic Acid Sequence | NO. | Sequence | NO. |
| AC8 | TATTACTGTGCGAGA [symbol] | 50 | YYCAR [symbol] PTV | 51 |
| | [symbol] CCTACCGTCACTGCAGGGG | | TAGGLDVWGQ | |
| | GTTTGGACGTCTGGGGCCAA | | | |
| MXD_1 | TATTACTGTGCGAGA [symbol] | 52 | YYCAR [symbol] PTV | 53 |
| | [symbol] CCTACCGTCACTGCAGGG | | TAGGLDVWGQ | |
| | GGTTTGGACGTCTGGGGCCAA | | | |
| MXD_3 | TATTACTGTGCGAGA [symbol] | 54 | YYCAR [symbol] PTVT | 55 |
| | [symbol] CCTACCGTCACTGCAGGGG | | AGGLDVWGQ | |
| | GTTTGGACGTCTGGGGCCAA | | | |
| MXD_4 | TATTACTGTGCGAGA [symbol] | 56 | YYCAR [symbol] PPTV | 57 |
| | [symbol] CCTACCGTCACTGCAGGGG | | TAGGLDVWGQ | |
| | GTTTGGACGTCTGGGGCCAA | | | |
| MXD_5 | TATTACTGTGCGAGA [symbol] | 58 | YYCAR [symbol] TV | 59 |
| | [symbol] CCTACCGTCACTGCAGGGG | | TAGGLDVWGQ | |
| | GTTTGGACGTCTGGGGCCAA | | | |
| MXD_6 | TATTACTGTGCGAGA [symbol] | 60 | YYCAR [symbol] PTV | 61 |
| | [symbol] CCTACCGTCACTGCAGGGG | | TAGGLDVWGQ | |
| | GTTTGGACGTCTGGGGCCAA | | | |
| MXD_8 | TATTACTGTGCGAGA [symbol] | 62 | YYCAR [symbol] PTVT | 63 |
| | [symbol] CCTACCGTCACTGCAGGG | | AGGLDVWGQ | |
| | GGTTTGGACGTCTGGGGCCAA | | | |
| MXD_9 | TATTACTGTGCGAGA [symbol] | 64 | YYCAR [symbol] PTV | 65 |
| | [symbol] CCTACCGTCACTGCAGGGG | | TAGGLDVWGQ | |
| | GTTTGGACGTCTGGGGCCAA | | | |
| MXD_{—} | TATTACTGTGCGAGA [symbol] | 66 | YYCAR [symbol] PTV | 67 |
| 13 | [symbol] CCTACCGTCACTGCAGGG | | TAGGLDVWGQ | |
| | GGTTTGGACGTCTGGGGCCAA | | | |
| MXD_{—} | TATTACTGTGCGAGA [symbol] | 68 | YYCAR [symbol] PTV | 69 |
| 15 | [symbol] CCTACCGTCACTGCAGGG | | TAGGLDVWGQ | |
| | GGTTTGGACGTCTGGGGCCAA | | | |
| MXD_{—} | TATTACTGTGCGAGA [symbol] | 70 | YYCAR [symbol] FPTVT | 71 |
| 16 | [symbol] CCTACCGTCACTGCAGGG | | AGGLDVWGQ | |
| | GGTTTGGACGTCTGGGGCCAA | | | |
| MXD_{—} | TATTACTGTGCGAGA [symbol] | 72 | YYCAR [symbol] VPPTV | 73 |
| 17 | [symbol] CCTACCGTCACTGCAGGG | | TAGGLDVWGQ | |
| | GGTTTGGACGTCTGGGGCCAA | | | |
| MXD_{—} | TATTACTGTGCGAGA [symbol] | 74 | YYCAR* [symbol] PTV | 75 |
| 18 | [symbol] CCTACCGTCACTGCAGGGG | | TAGGLDVWGQ | |
| | GTTTGGACGTCTGGGGCCAA | | | |
| MXD_{—} | TATTACTGTGCGAGA [symbol] | 76 | YYCAR [symbol] PTVT | 77 |
| 19 | [symbol] CCTACCGTCACTGCAGGGG | | AGGLDVWGQ | |
| | GTTTGGACGTCTGGGGCCAA | | | |
| MXD_{—} | TATTACTGTGCGAGA [symbol] | 78 | YYCAR [symbol] PTV | 79 |
| 20 | [symbol] CCTACCGTCACTGCAGGGG | | TAGGLDVWGQ | |
| | GTTTGGACGTCTGGGGCCAA | | | |
| MXD_{—} | TATTACTGTGCGAGA [symbol] | 80 | YYCAR [symbol] PT | 81 |
| 22 | [symbol] CCTACCGTCACTGCAGGG | | VTAGGLDVWGQ | |
| | GGTTTGGACGTCTGGGGCCAA | | | |
| MXD_{—} | TATTACTGTGCGAG [symbol] | 82 | YYCAR [symbol] PTV | 83 |
| 23 | [symbol] CCTACCGTCACTGCAGGG | | TAGGLDVWGQ | |
| | GGTTTGGACGTCTGGGGCCAA | | | |
| MXD_{—} | TATTACTGTGCGAGA [symbol] | 84 | YYCAR [symbol] PTVT | 85 |
| 24 | [symbol] CCTACCGTCACTGCAGGG | | AGGLDVWGQ | |
| | GGTTTGGACGTCTGGGGCCAA | | | |

* = amber stop codon; encoding glutanune (Q; Gln) in a sup E44 amber suppressor host cell strain

As shown in Table 6A, each productive clone contained a different and unique sequence of nucleotides in the eighteen nucleotide randomized portion. Similarly, each deduced amino acid sequence contained a unique sequence of six amino acids representing the variant portion of the encoded variant polypeptide. In some of the amino acid sequences, one or more amino acid position in the randomized portion contained an amino acid identical to or in the same class as the analogous position in the reference sequence. Others contained no conservation of amino acid or amino acid class across the entire randomized portion. Three of the seventeen clones (17.3%) contained an amber stop codon. Table 5B lists the observed and the predicted frequency (percent usage) of each amino acid in these variant portions of the encoded sequence. The asterisk (*) represents a stop codon.

TABLE 6B
Observed versus Predicted Amino Acid Frequency in Randomized
CDR3 Portion of CDR3

| Amino | Observed | Predicted |
|---|---|---|
| Acid | Frequency | Frequency |
| A | 6.3 | 6.3 |
| C | 0 | 3.1 |
| D | 4.2 | 3.1 |
| E | 3.1 | 3.1 |
| F | 5.2 | 3.1 |
| G | 6.3 | 6.3 |
| H | 2.1 | 3.1 |
| I | 2.1 | 4.7 |
| K | 1.0 | 3.1 |
| L | 11.5 | 9.4 |
| M | 5.2 | 1.6 |
| N | 3.1 | 3.1 |
| P | 8.3 | 6.3 |
| Q | 4.2 | 3.1 |
| R | 9.4 | 9.4 |
| S | 8.3 | 9.4 |
| T | 5.2 | 6.3 |
| V | 6.3 | 6.3 |
| W | 4.2 | 1.6 |
| Y | 1.0 | 3.1 |
| * | 3.1 | 4.7 |

* = amber stop codon; encoding glutamine (Q; Gln) in a sup E44 amber suppressor host cell strain

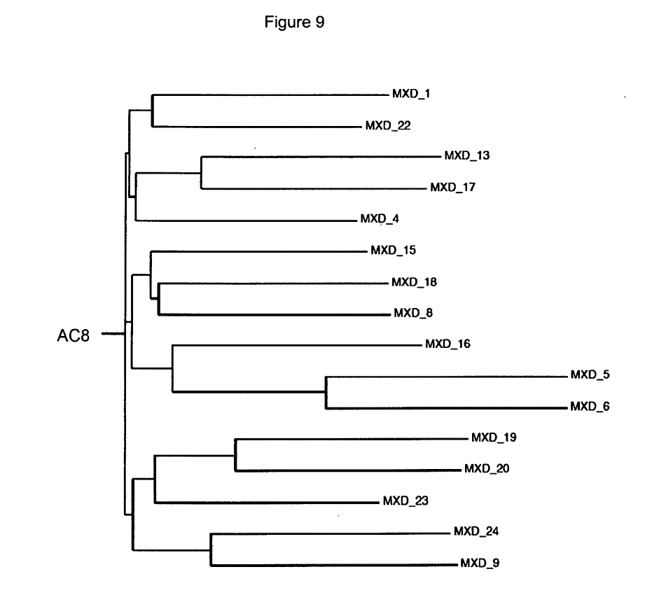

As shown in Table 6A, actual amino acid usage was comparable to expected frequency, suggesting that this method will be useful for generating full amino acid diversity in collections of variant polypeptides. FIG. 9 displays a phylogenetic tree, mapping the sequence diversity among clones listed in Table 6A. The large amount of diversity observed within this small selected collection of representative clones indicates that this method can be used to achieve saturation mutagenesis, whereby all or most of the possible amino acid combinations in a target portion or portions are generated in a collection of variant polynucleotides.

### Example 1D

### Duplex Oligonucleotide Cassettes Produced by Pairing Randomized and Reference Sequence Oligonucleotides

Mismatched oligonucleotide duplex cassettes were generated to determine whether pairing of mismatched oligonucleotides during random cassette mutagenesis would result in preferential selection of the positive or negative strand. Mismatched oligonucleotide duplex cassettes were formed by annealing positive strand AC8-CDR3 reference sequence oligonucleotides to analogous negative strand randomized oligonucleotides and negative strand reference sequence oligonucleotides to analogous positive strand randomized oligonucleotides using the same hybridization procedure as described in Example 1B, above. The resulting mismatched duplexes were isolated and ligated into vectors as described in Example 1B and sequenced as described in Example 1C. Sequencing revealed that when positive strand randomized oligonucleotides were annealed to negative strand reference sequence oligonucleotides, five out of eleven clones (45.5%) contained reference sequence DNA. When positive strand reference sequence oligonucleotides were annealed to negative strand randomized oligonucleotides, ten of 18 clones (55.6%) contained reference sequence DNA. These results indicate that positive and negative strands are selected equally using this method.

### Example 2

### Randomization of HSV-8 CDR3 by Oligonucleotide Fill-In Mutagenesis

### Example 2A

### Design of Randomized HSV-8 CDR3Oligonucleotide Template Pools for Oligonucleotide Fill-In Mutagenesis

To demonstrate that fill-in reactions with synthetic oligonucleotides can be used to generate collections of variant polynucleotides, oligonucleotide fill-in mutagenesis (OFIM) (without assembly) was used to introduce diversity to the six amino acid target portion (SEQ ID NO: 39), within the CDR3 of the anti-HSV-8 (AC-8) heavy chain antibody target polypeptide (SEQ ID NO: 40), which was varied by random cassette mutagenesis in Example 1 above. Table 7 sets forth a reference sequence (AC8HC3 native template(+)), which was used to design CDR3 template oligonucleotides. As shown in Table 7, this reference sequence contained 124 contiguous nucleotides, a 48 nucleotide portion (GTT GCC TAT ATG TTG GAA CCT ACC GTC ACT GCA GGG GGT TTG GAC GTC SEQ ID NO.: 41) of which encoded the native HSV-8 heavy chain CDR3. The target portion of the reference sequence (SEQ ID NO: 42), which was selected for variation, is shown in bold. The reference sequence also contained an NdeI restriction endonuclease site (SEQ ID NO: 86) and a SacI site overhang (SEQ ID NO: 87), both shown in italics, which were included to facilitate the ligation of resulting oligonucleotide duplex cassettes produced into vectors cut with NdeI and SacI.

A reference sequence template oligonucleotide (having 100% identity to the reference sequence) was ordered from Integrated DNA Technologies (IDT®) (Coralville, Iowa), synthesized using standard cyanoethyl chemistry with phosphoramidite monomers. A pool of randomized template oligonucleotides also was designed based on the reference sequence and ordered from IDT. A nucleic acid sequence representing the randomized template oligonucleotides (AC8HC3 mixed template(+)) is set forth in Table 7. Each randomized template oligonucleotide contained 5′ and 3′ reference sequence portions (shown in normal text or italics) and a central eighteen nucleotide randomized portion (shown in bold). The central portion was synthesized using an NNK doping strategy, in which N represents any nucleotide and K represents T or G.

This strategy was used to minimize the frequency of stop codons and ensure that each amino acid position encoded by a codon in the randomized portion could be occupied by any of the 20 amino acids.

TABLE 7
Reference sequence and randomized HSV-8 CDR3
template oligonucleotides

| Oligo- | | SEQ |
|---|---|---|
| nucleotide | | ID |
| pool | Sequence | NO. |
| AC8HC3 mixed | 5′-AGC GGC CTG ACA TAT GAA GAC | 88 |
| template (+) | ACG GCC ATG TAT TAC TGT GCG AGA | |
| | NNK NNK NNK NNK NNK NNK CCT | |
| | ACG GTC ACT GCA GGG GGT TTG GAC | |
| | GTC TGG GGC CAA GGG ACC ACG GTC | |
| | ACC GTG AGC T-3′ | |
| AC8HC3 native | 5′-AGC GGC CTG ACA TAT GAA GAC | 89 |
| template (+) | ACG GCC ATG TAT TAC TGT GCG AGA | |
| | GTT GCC TAT ATG TTG GAA CCT | |
| | ACC GTC ACT GCA GGG GGT TTG GAC | |
| | GTC TGG GGC CAA GGG ACC ACG GTC | |
| | ACC GTG AGC T-3′ | |
| AC8H3 fill-in-R | 5′-CAC GGT GAC CGT GGT CCC TTG | 90 |
| | G-3′ | |

### Example 2B

### Formation of Randomized HSV-8 CDR3 Oligonucleotide Duplexes, Ligation into scFv Vectors and Transformation of Bacterial Cells

Randomized and reference sequence (non-randomized) oligonucleotide duplexes were generated using fill-in reactions, which synthesized the complementary negative strand of each template oligonucleotide. For these reactions, a fill-in primer having the sequence of nucleotides set forth in Table 7 (AC8H3 fill-in-R), and having complementarity to a region of each template oligonucleotide, and was incubated with the randomized pool of template oligonucleotides or the reference sequence template oligonucleotide at a 3:1 molar ratio in the presence of dNTPs, buffer and Advantage HF 2 DNA polymerase (Clontech). The mixture was incubated at 95° C. for 1 min, followed by incubation at 68° C. for 3 min for hybridization of the fill-in primer to the template and extension of the fill-in primer. The AC8H3 fill-in-R primer contained a 5′ phosphate group.

After fill-in, duplex oligonucleotides were separated on an agarose gel and isolated using a QIAquick® gel extraction kit (Qiagen), following the supplier's protocol. Isolated duplex were digested with NdeI restriction endonuclease to generate duplex cassettes in the presence of NEB4 buffer (New England Biolabs) at 37° C. for 1.5 hrs. Digested oligonucleotide duplex cassettes were ligated under the same conditions into the pET28 vector containing pAC8-scFv DNA (SEQ ID NO: 49), used in Example 1 above, which had been cut with NdeI and SacI. Ligation mixtures were used to transform high-efficiency electrocompetent XL-1 Blue cells (Stratagene), which then were plated on agar plates supplemented with 100 μg/mL kanamycin and incubated overnight at 37° C.

Following overnight incubation, kanamycin-resistant colonies were counted to determine transformation efficiency. Number of colonies (cfu) recovered per amount (μg) of vector containing randomized fill-in duplexes (AC8HC3 mixed template(+) duplex) is set forth in Table 5. As with random cassette mutagenesis, the recovery after oligonucleotide fill-in mutagenesis was comparable to that obtained with native oligonucleotides, indicating that randomization did not negatively affect transformation efficiency.

### Example 2C

### Amino Acid Sequencing of Randomized Clones

To asses the extent and nature of randomization, vector DNA from each of twenty-three (23) representative colonies from the randomized vector transformants was sequenced. For this process, cassette nucleic acid was submitted for sequencing to Eton Biosciences (San Diego, Calif.). A portion of the nucleic acid sequence was used to infer the amino acid sequence encoded by the duplex cassette DNA. Sequencing revealed that eighteen (18) of the twenty-three (23) colonies (78.3%) were productive. Partial nucleic acid and amino acid sequences for these productive clones are indicated in Table 8A. Table 8A also sets forth the sequence of the analogous portion of the reference sequence and corresponding amino acid sequence (AC8). The portions of the sequences set forth in bold represent the randomized portions of the polynucleotide within the randomized clones and the corresponding variant portions of the encoded polypeptide. The analogous target portions of the reference sequence and target polypeptide (AC8) also are shown in bold. An asterisk in the amino acid sequence indicates the presence of an amber stop codon in the coding sequence, which produces a Q in the amino acid sequence in a sup E44 genotype amber suppressor strain (e.g. XL1-blue).

TABLE 8A
Variant anti-HSV-8 CDR3 Sequences Generated by
Oligonucleotide Fill-in Mutagenesis

| | | SEQ | Amino | SEQ |
|---|---|---|---|---|
| Clone | | ID | Acid | ID |
| Name | Nucleic Acid Sequence | NO. | Sequence | NO. |
| AC8 | TATTACTGTGCGAGAGTTGCCTATA | 50 | YYCARVAYM | 51 |
| | TGTTGGAACCTACCGTCACTGCAGG | | LEPTVTAGG | |
| | GGGTTTGGACGTCTGGGGCCAA | | LDVWGQ | |
| MFILL_1 | TATTACTGTGCGAGACGTGAGGCG | 91 | YYCARREAG | 92 |
| | GGGTTTTGGCCTACCGTCACTGCAG | | FWPTVTAGG | |
| | GGGGTTTGGACGTCTGGGGCCAA | | LDVWGQ | |
| MFILL_2 | TATTACTGTGCGAGAAGGCTGACG | 93 | YYCARRLTV | 94 |
| | GTGGTGGGGCCTACCGTCACTGCA | | VGPTVTAGG | |
| | GGGGGTTTGGACGTCTGGGGCCAA | | LDVWGQ | |
| MFILL_3 | TATTACTGTGCGAGAATTATGAGTA | 95 | YYCARIMST | 96 |
| | CGCATTTGCCTACCGTCACTGCAGG | | HLPTVTAGG | |
| | GGGTTTGGACGTCTGGGGCCAA | | LDVWGQ | |
| MFILL_4 | TATTACTGTGCGAGAGAGACTGTTG | 97 | YYCARETVA | 98 |
| | CGCAGTCGCCTACCGTCACTGCAGG | | QSPTVTAGG | |
| | GGGTTTGGACGTCTGGGGCCAA | | LDVWGQ | |
| MFILL_5 | TATTACTGTGCGAGATTTGGTTGGG | 99 | YYCARFGWV | 100 |
| | TTGATTGTCCTACCGTCACTGCAGG | | DCPTVTAGG | |
| | GGGTTTGGACGTCTGGGGCCAA | | LDVWGQ | |
| MFILL_6 | TATTACTGTGCGAGATTTGTGCAGA | 101 | YYCARFVQM | 102 |
| | TGTAGTGGCCTACCGTCACTGCAGG | | *WPTVTAGG | |
| | GGGTTTGGACGTCTGGGGCCAA | | LDVWGQ | |
| MFILL_8 | TATTACTGTGCGAGACGTAATCTTC | 103 | YYCARRNLL | 104 |
| | TGGTTAAGCCTACCGTCACTGCAGG | | VKPTVTAGG | |
| | GGGTTTGGACGTCTGGGGCCAA | | LDVWGQ | |
| MFILL_11 | TATTACTGTGCGAGAAGTTCTCTGT | 105 | YYCARSSLW | 106 |
| | GGAGGGTTCCTACCGTCACTGCAGG | | RVPTVTAGG | |
| | GGGTTTGGACGTCTGGGGCCAA | | LDVWGQ | |
| MFILL_12 | TATTACTGTGCGAGACTGGCGGATA | 107 | YYCARLADM | 108 |
| | TGTTTAAGCCTACCGTCACTGCAGG | | FKPTVTAGG | |
| | GGGTTTGGACGTCTGGGGCCAA | | LDVWGQ | |
| MFILL_13 | TATTACTGTGCGAGATTTCGTTGTT | 109 | YYCARFRCY | 110 |
| | ATGCTACTCCTACCGTCACTGCAGG | | ATPTVTAGG | |
| | GGGTTTGGACGTCTGGGGCCAA | | LDVWGQ | |
| MFILL_15 | TATTACTGTGCGAGAGGGACGGGG | 111 | YYCARGTGT | 112 |
| | ACGCGGTCGCCTACCGTCACTGCAG | | RSPTVTAGG | |
| | GGGGTTTGGACGTCTGGGGCCAA | | LDVWGQ | |
| MFILL_16 | TATTACTGTGCGAGA | 113 | YYCARQLRE | 114 |
| | CAGCTGAGGGAGAGTGTTCCTACC | | SVPTVTAGG | |
| | GTCACTGCAGGGGGTTTGGACGTCT | | LDVWGQ | |
| | GGGGCCAA | | | |
| MFILL_17 | TATTACTGTGCGAGAGCTAAGCGG | 115 | YYCARAKRG | 116 |
| | GGTTGGACTCCTACCGTCACTGCAG | | WTPTVTAGG | |
| | GGGGTTTGGACGTCTGGGGCCAA | | LDVWGQ | |
| MFILL_20 | TATTACTGTGCGAGACTGCATGGGC | 117 | YYCARLHGR | 118 |
| | GGCCTATGCCTACCGTCACTGCAGG | | PMPTVTAGG | |
| | GGGTTTGGACGTCTGGGGCCAA | | LDVWGQ | |
| MFILL_21 | TATTACTGTGCGAGAAGGGTTGAG | 119 | YYCARRVES | 120 |
| | AGTAGGCTGCCTACCGTCACTGCAG | | RLPTVTAGG | |
| | GGGGTTTGGACGTCTGGGGCCAA | | LDVWGQ | |
| MFILL_22 | TATTACTGTGCGAGAACGGGTGGT | 121 | YYCARTGGE | 122 |
| | GAGGGTTCGCCTACCGTCACTGCAG | | GSPTVTAGG | |
| | GGGGTTTGGACGTCTGGGGCCAA | | LDVWGQ | |
| MFILL_23 | TATTACTGTGCGAGACTGTTTAAGA | 123 | YYCARLFKI | 124 |
| | TTGGGGTGCCTACCGTCACTGCAGG | | GVPTVTAGG | |
| | GGGTTTGGACGTCTGGGGCCAA | | LDVWGQ | |
| MFILL_24 | TATTACTGTGCGAGACGGGATAGG | 125 | YYCARRDRK | 126 |
| | AAGCGTTATCCTACCGTCACTGCAG | | RYPTVTAGG | |
| | GGGGTTTGGACGTCTGGGGCCAA | | LDVWGQ | |

* = amber stop codon; encoding glutamine (Q; Gln) in a sup E44 amber suppressor host cell strain

As show in Table 8A, each productive clone contained a unique sequence of nucleotides in the eighteen nucleotide randomized portion. Similarly, each deduced amino acid sequence contained a unique sequence of six amino acids representing the randomized portion of the variant polypeptide. Table 8B lists the observed and the actual frequency (percent usage) of each amino acid in the randomized portions of the encoded sequence. The asterisk (*) represents a stop codon.

TABLE 8B
Observed versus Predicted Amino Acid Frequency in Randomized
CDR3 Portion of CDR3

| Amino | Observed | Predicted |
|---|---|---|
| Acid | Frequency | Frequency |
| A | 5.5 | 6.3 |
| C | 1.8 | 3.1 |
| D | 2.8 | 3.1 |
| E | 4.6 | 3.1 |
| F | 5.5 | 3.1 |
| G | 10.1 | 6.3 |
| H | 1.8 | 3.1 |
| I | 1.8 | 4.7 |
| K | 4.6 | 3.1 |
| L | 9.2 | 9.4 |
| M | 3.7 | 1.6 |
| N | 0.9 | 3.1 |
| P | 0.9 | 6.3 |
| Q | 2.8 | 3.1 |
| R | 12.8 | 9.4 |
| S | 7.3 | 9.4 |
| T | 7.3 | 6.3 |
| V | 9.2 | 6.3 |
| W | 4.6 | 1.6 |
| Y | 1.8 | 3.1 |
| * | 0.9 | 4.7 |

* = amber stop codon; encoding glutamine (Q; Gln) in a sup E44 amber suppressor host cell strain

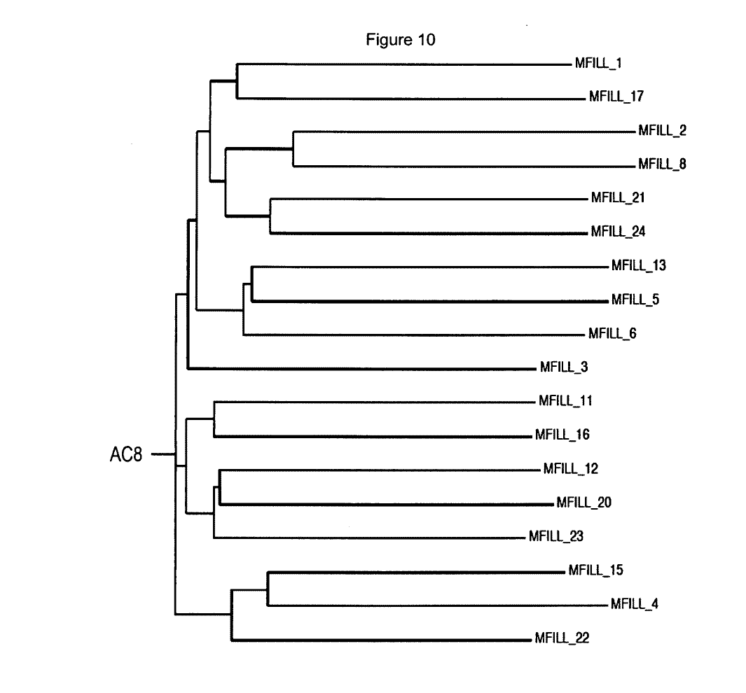

As shown in Table 8B, actual amino acid usage was comparable to expected frequency, indicating that this method will be useful for generating full amino acid diversity in collections of variant polypeptides. FIG. 10 displays a phylogenetic tree, mapping the sequence diversity among clones listed in Table 8A. The large amount of diversity observed within this small selected collection of representative clones suggests that this method can be used to achieve saturation mutagenesis, whereby all or most of the possible amino acid combinations in a target portion or portions are generated in a collection of variant polynucleotides.

### Example 3

### Randomization of 3Ala 2G12 Heavy Chain CDR1 and CDR3Using Conventional Overlap PCR

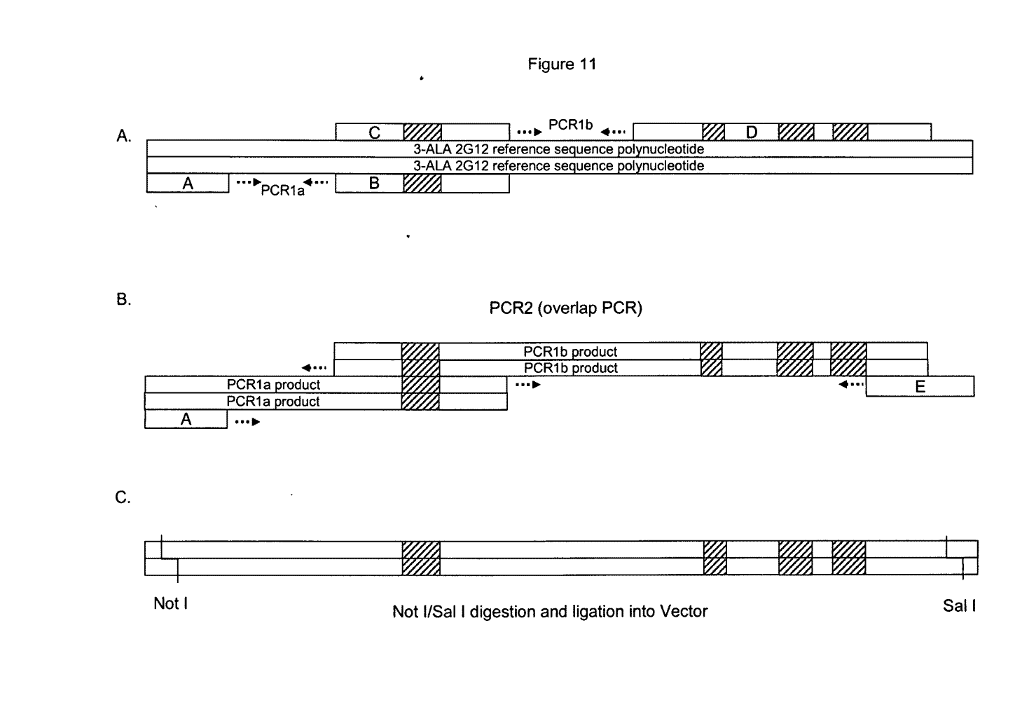

Conventional Overlap PCR was used to introduce diversity to target portions within the CDR1 and CDR3 of the heavy chain variable region of a target polypeptide. The target polypeptide was a 3-Ala 2G12 antibody domain exchanged Fab fragment, containing V_{H}-C_{H} chains and V_{L}-C_{L} chains. This process is illustrated in FIG. 11. The heavy chain of this 3-Ala 2G12 domain exchanged Fab target polypeptide contains the sequence of amino acids set forth in SEQ ID NO.: 127 (EVQLVESGGGLVKAGGSLILSCGVSNFRISAHTMNWVRRVPGGGLEWVASIS TSSTYRDYADAVKGRFTVSRDDLEDFVYLQMHKMRVEDTAIYYCARKGSDR AADADPFDAWGPGTVVTVSPASTKGPSVFPLAPSSKSTSGGTAALGCLVKDY FPEPVTVSWNSGALTSGVHTFPAVLQSSGLYSLSSVVTVPSSSLGTQTYICNVN HKPSNTKVDKKVEPKSCLR). This heavy chain contains three mutations (shown in bold in the sequence above) compared to the analogous positions in the 2G12 antibody fragment.

The analogous heavy chain of the analogous 2G12 antibody fragment contains the sequence of amino acids set forth in SEQ ID NO: 128 (EVQLVESGGGLVKAGGSLILSCGVSNFRISAHTMNWVRRVPGGGLEWVASIS TSSTYRDYADAVKGRFTVSRDDLEDFVYLQMHKMRVEDTAIYYCARKGSDR LSDNDPFDAWGPGTVVTVSPASTKGPSVFPLAPSSKSTSGGTAALGCLVKDY FPEPVTVSWNSGALTSGVHTFPAVLQSSGLYSLSSVVTVPSSSLGTQTYICNVN HKPSNTKVDKKVEPKSCLR). The positions in the 2G12 heavy chain that are mutated in the 3-Ala heavy chain are in bold. Due to these three mutations, neither the 3-Ala 2G12 antibody, nor the Fab fragment of the antibody, specifically binds the antigen recognized by the 2G12 antibody (the HIV envelope surface glycoprotein, gp120, GENBANK gi:28876544, which is generated by cleavage of the precursor, gp160, GENBANK g.i. 9629363). The light chain of 3-Ala 2G12 domain exchanged Fab target polypeptide contains the sequence of amino acids set forth in SEQ ID NO.: 129

(AGVVMTQSPSTLSASVGDTITITCRASQSIETWLAWYQQKPGKAPKLLI
YKASTLKTGVPSRFSGSGSGTEFTLTISGLQFDDFATYHCQHYAGYSATF
GQGTRVEIKRTVAAPSVFIFPPSDEQLKSGTASVVCLLNNFYPREAKVQW
KVDNALQSGNSQESVTEQDSKDSTYSLSSTLTLSKADYEKHKVYACEVTH
QGLSSPVTKSFNRGEC.

The target polynucleotide encoding the 3-Ala 2G12 Fab fragment was contained in a 3 Ala-1 pCAL G13 vector, which contained nucleic acids encoding the heavy chain (SEQ ID NO: 130) and light chain (SEQ ID NO: 131) domains of the 3-Ala 2G12 Fab fragment. This 3-Ala-1 pCAL G13 vector had the sequence of nucleotides set forth in SEQ ID NO.: 33

(GTGGCACTTTTCGGGGAAATGTGCGCGGAACCCCTATTTGTTTATTTTT
CTAAATACATTCAAATATGTATCCGCTCATGAGACAATAACCCTGATAAA
TGCTTCAATAATATTGAAAAAGGAAGAGTATGAGTATTCAACATTTCCGT
GTCGCCCTTATTCCCTTTTTTGCGGCATTTTGCCTTCCTGTTTTTGCTCA
CCCAGAAACGCTGGTGAAAGTAAAAGATGCTGAAGATCAGTTGGGTGCAC
GAGTGGGTTACATCGAACTGGATCTCAACAGCGGTAAGATCCTTGAGAGT
TTTCGCCCCGAAGAACGTTTTCCAATGATGAGCACTTTTAAAGTTCTGCT
ATGTGGCGCGGTATTATCCCGTATTGACGCCGGGCAAGAGCAACTCGGTC
GCCGCATACACTATTCTCAGAATGACTTGGTTGAGTACTCACCAGTCACA
GAAAAGCATCTTACGGATGGCATGACAGTAAGAGAATTATGCAGTGCTGC
CATAACCATGAGTGATAACACTGCGGCCAACTTACTTCTGACAACGATCG
GAGGACCGAAGGAGCTAACCGCTTTTTTGCACAACATGGGGGATCATGTA
ACTCGCCTTGATCGTTGGGAACCGGAGCTGAATGAAGCCATACCAAACGA
CGAGCGTGACACCACGATGCCTGTAGCAATGGCAACAACGTTGCGCAAAC
TATTAACTGGCGAACTACTTACTCTAGCTTCCCGGCAACAATTAATAGAC
TGGATGGAGGCGGATAAAGTTGCAGGACCACTTCTGCGCTCGGCCCTTCC
GGCTGGCTGGTTTATTGCTGATAAATCTGGAGCCGGTGAGCGTGGGTCTC
GCGGTATCATTGCAGCACTGGGGCCAGATGGTAAGCCCTCCCGTATCGTA
GTTATCTACACGACGGGGAGTCAGGCAACTATGGATGAACGAAATAGACA
GATCGCTGAGATAGGTGCCTCACTGATTAAGCATTGGTAACTGTCAGACC
AAGTTTACTCATATATACTTTAGATTGATTTAAAACTTCATTTTTAATTT
AAAAGGATCTAGGTGAAGATCCTTTTTGATAATCTCATGACCAAAATCCC
TTAACGTGAGTTTTCGTTTCCACTGAGCGTCAGACCCCGTAGAAAAGATC
AAAGGTATCTTCTTGAGATCCTTTTTTTCTGCGCGTAATCTGCTGCTTGC
AAACAAAAAAACCACCGCTACCAGCGGTGGTTTGTTTGCCGGATCAAGAG
CTACCAACTCTTTTTCCGAAGGTAACTGGCTTCAGCAGAGCGCAGATACC
AAATACTGTCCTTCTAGTGTAGCCGTAGTTAGGCCACCACTTCAAGAACT
CTGTAGCACCGCCTACATACCTCGCTCTGCTAATCCTGTTACCAGTGGCT
GCTGCCAGTGGCGATAAGTCGTGTCTTACCGGGTTGGACTCAAGACGATA
GTTACCGGATAAGGCGCAGCGGTCGGGCTGAACGGGGGGTTCGTGCACAC
AGCCCAGCTTGGAGCGAACGACCTACACCGAACTGAGATACCTACAGCGT
GAGCTATGAGAAAGCGCCACGCTTCCCGAAGGGAGAAAGGCGGACAGGTA
TCCGGTAAGCGGCAGGGTCGGAACAGGAGAGCGCACGAGGGAGCTTCCAG
GGGGAAACGCCTGGTATCTTTATAGTCCTGTCGGGTTTCGCCACCTCTGA
CTTGAGCGTCGATTTTTGTGATGCTCGTCAGGGGGGCGGAGCCTATGGAA
AAACGCCAGCAACGCGGCCTTTTTACGGTTCCTGGCCTTTTGCTGGCCTT
TTGCTCACATGTTCTTTCCTGCGTTATCCCCTGATTCTGTGGATAACCGT
ATTACCGCCTTTGAGTGAGCTGATACCGCTCGCCGCAGCCGAACGACCGA
GCGCAGCGAGTCAGTGAGCGAGGAAGCGGAAGAGCGCCCAATACGCAAAC
CGCCTCTCCCCGCGCGTTGGCCGATTCATTAATGCAGCTGGCACGACAGG
TTTCCCGACTGGAAAGCGGGCAGTGAGCGCAACGCAATTAATGTGAGTTA
GCTCACTCATTAGGCACCCCAGGCTTTACACTTTATGCTTCCGGCTCGTA
TGTTGTGTGGAATTGTGAGCGGATAACAATTGAATTAAGGAGGATATAAT
TATGAAATACCTGCTGCCGACCGCAGCCGCTGGTCTGCTGCTGCTCGCGG
CCCAGCCGGCCATGGCCGCCGGTGTTGTTATGACCCAGTCTCCGTCTACC
CTGTCTGCTTCTGTTGGTGACACCATCACCATCACCTGCCGTGCTTCTCA
GTCTATCGAAACCTGGCTGGCTTGGTACCAGCAGAAACCGGGTAAAGCTC
CGAAACTGCTGATCTACAAGGCTTCTACCCTGAAAACCGGTGTTCCGTCT
CGTTTCTCTGGTTCTGGTTCTGGTACCGAGTTCACCCTGACCATCTCTGG
TCTGCAGTTCGACGACTTCGCTACCTACCACTGCCAGCACTACGCTGGTT
ACTCTGCTACCTTCGGTCAGGGTACCCGTGTTGAAATCAAACGTACCGTT
GCTGCTCCGTCTGTTTTCATCTTCCCGCCGTCTGACGAACAGCTGAAATC
TGGTACCGCTTCTGTTGTGTTTGCCTGCTGAACAACTTCTACCCGCGTGA
AGCTAAAGTTCAGTGGAAAGTTGACAACGCTCTGCAGTCTGGTAACTCTC
AGGAATCTGTTACCGAACAGGACTCTAAAGACTCTACCTACTCTCTGTCT
TCTACCCTGACCCTGTCTAAAGCTGACTACGAAAAGCACAAAGTTTACGC
TTGCGAAGTTACCCACCAGGGTCTGTCTTCTCCGGTTACCAAATCTTTCA
ACCGTGGTGAATGCTAATTAATTAATAAGGAGGATATAATTATGAAAAAG
ACAGCTATCGCGATTGCAGTGGCACTGGCTGGTTTCGCTACCGTAGCCCA
GGCGGCCGCA

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

TCCGTCT
GTTTTCCCGCTGGCTCCGTCTTCTAAATCTACCTCTGGTGGTACCGCTGC
TCTGGGTTGCCTGGTTAAAGACTACTTCCCGGAACCGGTTACCGTTTCTT
GGAACTCTGGTGCTCTGACCTCTGGTGTTCACACCTTCCCGGCTGTTCTG
CAGTCTTCTGGTCTGTACTCTCTGTCTTCTGTTGTTACCGTTCCGTCTTC
TTCTCTGGGTACCCAGACCTACATCTGCAACGTTAACCACAAACCGTCTA
ACACCAAAGTTGACAAGAAAGTTGAACCGAAATCTTGCCTGCGATCGCGG
CCAGGCCGGCCGCACCATCACCATCACCATGGCGCATACCCGTACGACGT
TCCGGACTACGCTTCTACTAGTTAGGAGGGTGGTGGCTCTGAGGGTGGCG
GTTCTGAGGGTGGCGGCTCTGAGGGAGGCGGTTCCGGTGGTGGCTCTGGT
TCCGGTGATTTTGATTATGAAAAGATGGCAAACGCTAATAAGGGGGCTAT
GACCGAAAATGCCGATGAAAACGCGCTACAGTCTGACGCTAAAGGCAAAC
TTGATTCTGTCGCTACTGATTACGGTGCTGCTATCGATGGTTTCATTGGT
GACGTTTCCGGCCTTGCTAATGGTAATGGTGCTACTGGTGATTTTGCTGG
CTCTAATTCCCAAATGGCTCAAGTCGGTGACGGTGATAATTCACCTTTAA
TGAATAATTTCCGTCAATATTTACCTTCCCTCCCTCAATCGGTTGAATGT
CGCCCTTTTGTCTTTGGCGCTGGTAAACCATATGAATTTTCTATTGATTG
TGACAAAATAAACTTATTCCGTGGTGTCTTTGCGTTTCTTTTATATGTTG
CCACCTTTATGTATGTATTTTCTACGTTTGCTAACATACTGCGTAATAAG
GAGTCTTAAGCTAGCTAACGATCGCCCTTCCCAACAGTTGCGCAGCCTGA
ATGGCGAATGGGACGCGCCCTGTAGCGGCGCATTAAGCGCGCCGGGTGTG
GTGGTTACGCGCAGCGTGACCGCTACACTTGCCAGCGCCCTAGCGCCCGC
TCCTTTCGCTTTCTTCCCTTCCTTTCTCGCCACGTTCGCCGGCTTTCCCC
GTCAAGCTCTAAATCGGGGGCTCCCTTTAGGGTTCCGATTTAGTGCTTTA
CGGCACCTCGACCCCAAAAAACTTGATTAGGGTGATGGTTCACGTAGTGG
GCCATCGCCCTGATAGACGGTTTTTCGCCCTTTGACGTTGGAGTCCACGT
TCTTTAATAGTGGACTCTTGTTCCAAACTGGAACAACACTCAACCCTATC
TCGGTCTATTCTTTTGATTTATAAGGGATTTTGCCGATTTCGGCCTATTG
GTTAAAAAATGAGCTGATTTAACAAAAATTTAACGCGAATTTTAACAAAA
TATTAACGCTTACAATTTAG).

The sequence of a reference sequence polynucleotide (SEQ ID NO: 136), which was isolated from this vector, is displayed in bold text above. The nucleic acid sequence encoding the 3-ALA 2G12 heavy chain polypeptide, having the sequence of nucleotides set forth in SEQ ID NO: 130, is displayed in italics in the above sequence. The nucleic acid sequence encoding the light chain (V_{L}-C_{L}) region of the 3-Ala 2G12 target polynucleotide (and the 2G12 light chain) is set forth in SEQ ID NO.: 131.

For variation of the heavy chain CDRs of the 3-Ala 2G12 Fab target polypeptide, five pools of oligonucleotide primers (A-E) were designed. The oligonucleotides were ordered from Integrated DNA Technologies (IDT®) (Coralville, Iowa), synthesized using standard cyanoethyl chemistry with phosphoramidite monomers. The nucleic acid sequences representing oligonucleotide primers in these pools are set forth in Table 9. Oligonucleotide primer pools B, C and D contained randomized oligonucleotides, which contained randomized portions, set forth in bold in Table 9. As indicated in Table 9, the randomized portions were synthesized using either an NNN or an NNK doping strategy, as described in Example 1A, above. Primer pools A and E contained reference sequence oligonucleotides, containing 100% sequence identity to regions of the target polynucleotide encoding the target polypeptide. Reference sequence portions are indicated in plain text.

TABLE 9
3Ala 2G12 Overlap PCR Primers

| Oligo- | | | | |
|---|---|---|---|---|
| nucleo- | Purifi- | | | SEQ |
| tide | cation | | | ID |
| Pool | Method | Length | Sequence | NO. |
| A | standard | 24 | GCCCAGGCGGCCGCAGAAGTTCAG | 132 |
| B | standard | 48 | GAACACGACGAACCCAGTTCATMN | 133 |
| | | | NANNAGCAGAGATACGGAAGTTAG | |
| C | standard | 48 | CTAACTTCCGTATCTCTGCTNNTN | 134 |
| | | | NKATGAACTGGGTTCGTCGTGTTC | |
| D | standard | 72 | CCGGACCCCAAGCGTCGAACGGMN | 135 |
| | | | NMNNGTCMNNANNACGGTCAGAMN | |
| | | | NTTTACGAGCGCAGTAGTAGATAG | |
| E | PAGE | 58 | CCTTTGGTCGACGCCGGAGAAACG | 5 |
| | | | GTAACAACGGTACCCGGACCCCAA | |
| | | | GCGTCGAACG | |

The reference sequence polynucleotide (indicated in bold in the vector sequence above) containing a region of the 3-Ala 2G12 target polynucleotide, having the sequence set forth in SEQ ID NO.: 136 was isolated from the 3 Ala-pCAL G13 (SEQ ID NO: 33), which contained this reference sequence polynucleotide between the Not I and Sal I sites.

To isolate the reference sequence polynucleotide, the vector was isolated from XL1-blue cells and cut by restriction digest with Not I and Sal I. As shown in FIG. 11A, this isolated reference sequence polynucleotide was used as a template in initial PCRs. Primer pools A and B were used to perform one initial PCR (PCR1a) and primer pools C and D were used to perform another initial PCR (PCR1b). Product pools from these initial PCRs (PCR1a product and PCR1b product) were gel-purified using the QIAquick® Gel Extraction Kit (Qiagen). Purified product pools then were combined with primer pools A and E in an overlap PCR, whereby randomized duplexes were generated. The randomized duplexes were incubated with Not I and Sal I restriction endonucleases, to generate a duplex cassette, which then was inserted into the 3Ala-1 pCAL G13 vector digested with Not I/Sal I. This process is illustrated in FIG. 11, where reference sequence portions are illustrated as open boxes and randomized portions are illustrated as hatched boxes.

### Example 3B

### Ligation into Vectors and Transforming Host Cells

The resulting pools of randomized duplexes were ligated into the 3-Ala-1 pCAL G13 vector, by digesting the duplexes and the vector with Not I/Sal I. The resulting collection of vectors was used to transform XLI blue cells. For this process, the vectors were used to transform high-efficiency electrocompetent XL-1 Blue cells (Stratagene), which then were plated on agar plates supplemented with 100 μg/mL ampicillin and incubated overnight at 37° C.

Following overnight incubation, 46 ampicillin-resistant colonies were picked, and vector DNA from each colony sequenced to determine relative nucleotide usage.

### Example 3C

### Amino Acid Sequencing of Randomized Clones

To asses the extent and nature of randomization, vector DNA from each of forty-six (46) representative colonies from the randomized vector transformants was sequenced. For this process, cassette nucleic acid was submitted for sequencing to Eton Biosciences (San Diego, Calif.). Sequencing revealed that 36 of the 46 clones contained no insertions or deletions. Six (6) of the sequences contained an amber stop codon (TAG). The sequences of these 36 clones without deletions/insertions were further evaluated to determine the codon usage among the positions in the randomized portions of the polynucleotides. For each of the 36 clones, it was determined which nucleotide was used at each of fourteen “N” positions and five “K” randomized positions, within the randomized portions. Total and percent usage of each nucleotide (A, C, G and T), at the “N” and “K” positions among all the clones, is listed in Table 10, according to the doping strategy (N or K) used at the particular position.

TABLE 10
Nucleotide Usage in Clones Generated Using Overlap PCR

| | Doping | | | | |
|---|---|---|---|---|---|
| | Strategy | A | C | G | T |
| Total usage at | N | 114 | 132 | 85 | 172 |
| randomized | K | 0 | 2 | 62 | 119 |
| positions: | | | | | |
| Percent usage | N | 22.7% | 26.2% | 16.9% | 34.2% |
| at randomized | K | 0.0% | 0.0% | 34.3% | 65.7% |
| positions: | | | | | |

As shown in Table 10, sequencing revealed that A, C, G and T were used at 22.7%, 26.2%, 16.9% and 34.2%, respectively, where an “N” doping strategy was used, and 0%, 0%, 34.3% and 65.7%, respectively, where a “K” doping strategy was used. These results indicate a bias toward T using this strategy for generating collections of variant polynucleotides.

### Example 4

### Randomization of 3Ala 2G12 Heavy Chain CDR1 and CDR3Using Random Cassette Mutagenesis and Assembly

Random Cassette Mutagenesis and Assembly (RCMA) was used to introduce diversity to target portions within the heavy chain CDR1 and CDR3 of the target polynucleotide encoding the 3-Ala 2G12 Fab target polypeptide that was randomized in Example 3 above. Twelve pools of synthetic oligonucleotides (H1-H12) were designed and synthesized for this process. The oligonucleotide pools were ordered from Integrated DNA Technologies (IDT®) (Coralville, Iowa), synthesized using standard cyanoethyl chemistry with phosphoramidite monomers. Nucleic acid sequences representing each pool of oligonucleotides are set forth in Table 11 below.

Oligonucleotides within pools H1, H2, H5, H6, H7, H8, H11 and H12 were reference sequence oligonucleotides, each having 100% sequence identity to a reference sequence. Each reference sequence contained sequence identity to a region of the target polynucleotide.

Oligonucleotides within pools H3, H4, H9 and H10 were randomized oligonucleotides. Each oligonucleotide in each randomized pool was synthesized based on a reference sequence, but contained randomized portions, which are represented in bold type in Table 11. These randomized portions were synthesized using the NNN or NNK doping strategy described in Example 1A above. Some of the randomized portions further contained variant positions, also shown in bold type, where the nucleotide at that position was mutated (using specific, non-random mutation) compared to the reference sequence. The reference sequence used to design each randomized oligonucleotide is listed in Table 11, in the row below the randomized oligonucleotide, with the targeted positions in bold. Pools H1, H3, H5, H7, H9 and H11 contained positive strand oligonucleotides and pools H2, H4, H6, H8, H10 and H12 contained negative strand oligonucleotides. Oligonucleotides in pools H1 were designed to contain a 5′ Not I recognition site overhang and oligonucleotides in pool H12 were designed to contain a 5′ Sal I recognition site overhang. All oligonucleotides contained a 5′ phosphate group.

TABLE 11
3Ala 2G12 Oligonucleotides

| Oligo- | | | | |
|---|---|---|---|---|
| nucleo- | | Purifi- | | SEQ |
| tide | | cation | ID | |
| Pool | Type | Method | Sequence | NO.: |
| H1 | Reference | PAGE | GGCCGCAGAAGTTCAG | 137 |
| | sequence | | CTGGTTGAATCTGGTGG | |
| | | | TGGTCTGGTTAAAGCTG | |
| | | | GTGGTTCTCTGATCCTG | |
| | | | TCTTGCGGT | |
| H2 | Reference | PAGE | GAAGTTAGAAACACCG | 138 |
| | sequence | | CAAGACAGGATCAGAG | |
| | | | AACCACCAGCTTAACC | |
| | | | AGACCACCACCAGATTC | |
| | | | AACCAGCTGAACTTCTG | |
| | | | C | |
| H3 | Randomized | HPLC | GTTTCTAACTTCCGTAT | 139 |
| | | | CTCTGCTNNTNNKATGA | |
| | | | ACTGGG | |
| Reference | | | GTTTCTAACTTCCGTAT | 140 |
| sequence | | | CTCTGCTCACACCATGA | |
| used to | | | ACTGGG | |
| design H3 | | | | |
| H4 | Randomized | HPLC | GAACACGACGAACCCA | 141 |
| | | | GTTCATMNNANNAGCA | |
| | | | GAGATACG | |
| Reference | | | GAACACGACGAACCCA | 142 |
| Sequence | | | GTTCATGGTGTGAGCA | |
| used to | | | GAGATACG | |
| design H4 | | | | |
| H5 | Reference | PAGE | TTCGTCGTGTTCCGGGT | 143 |
| | sequence | | GGTGGTCTGGAATGGGT | |
| | | | TGCTTCTATCTCTACCT | |
| | | | CTTCTACCTACCGTGAC | |
| | | | TACGCTGACGCTGT | |
| H6 | Reference | PAGE | AAACGACCTTTAACAGC | 144 |
| | sequence | | GTCAGCGTAGTCACGGT | |
| | | | AGGTAGAAGAGGTAGA | |
| | | | GATAGAAGCAACCCATT | |
| | | | CCAGACCACCACCCG | |
| H7 | Reference | PAGE | TAAAGGTCGTTTCACCG | 145 |
| | sequence | | TTTCTCGTGACGACCTG | |
| | | | GAAGACTTCGTTTACCT | |
| | | | GCAGATGCATAAAATG | |
| | | | CGTGTTGAAGACACC | |
| H8 | Reference | PAGE | GTAGTAGATAGCGGTGT | 146 |
| | sequence | | CTTCAACACGCATTTTA | |
| | | | TGCATCTGCAGGTAAAC | |
| | | | GAAGTCTTCCAGGTCGT | |
| | | | CACGAGAAACGGTG | |
| H9 | Randomized | desalt | GCTATCTACTACTGCGC | 147 |
| | | | TCGTAAANNKTCTGACC | |
| | | | GTNNTNNKGACNNKNN | |
| | | | KCCGTTCGACGCTTGGG | |
| | | | GT | |
| Reference | | | GCTATCTACTACTGCGC | 148 |
| Sequence | | | TCGTAAAGGTTCTGACC | |
| Used to | | | GTCTGTCTGACAACGA | |
| Design H9 | | | CCCGTTCGACGCTTGGG | |
| | | | GT | |
| H10 | Randomized | desalt | AACGGTACCCGGACCCC | 149 |
| | | | AAGCGTCGAACGGMNN | |
| | | | MNNGTCMNNANNACG | |
| | | | GTCAGAMNNTTTACGA | |
| | | | GCGCA | |
| Reference | | | AACGGTACCCGGACCCC | 150 |
| Sequence | | | AAGCGTCGAACGGGTC | |
| Used to | | | GTTGTCAGACAGACGG | |
| Design H10 | | | TCAGAACCTTTACGAGC | |
| | | | GCA | |
| H11 | Reference | PAGE | CCGGGTACCGTTGTTAC | 151 |
| | sequence | | CGTTTCTCCGGCG | |
| H12 | Reference | PAGE | TCGACGCCGGAGAAACG | 152 |
| | sequence | | GTAAC | |

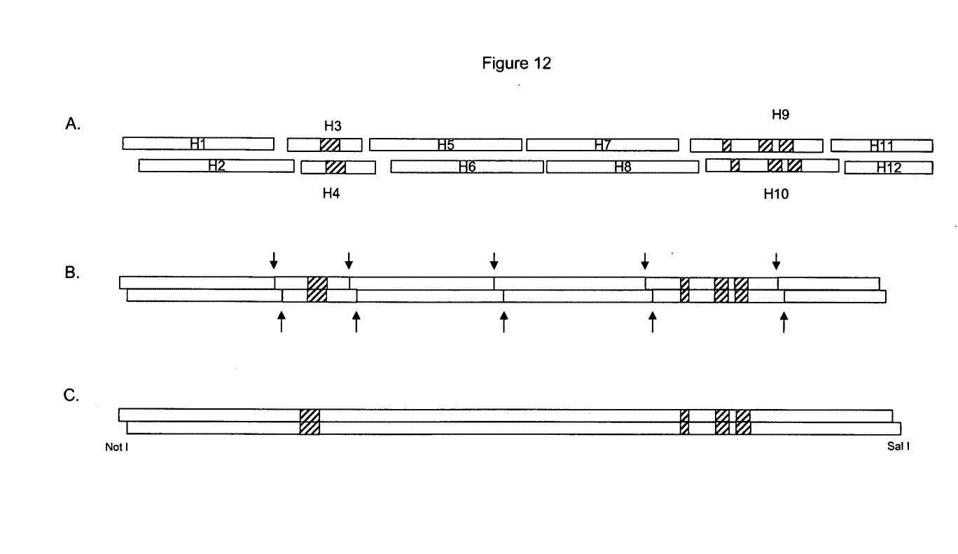

The oligonucleotides used in the RCMA and the assembly process are illustrated schematically in FIG. 12A. As shown in FIG. 12A, the positive and negative strand oligonucleotides within the randomized and reference sequence pools contained regions of complementarity to oligonucleotides within one or more of the other oligonucleotide pools. As illustrated in FIG. 12, the regions of complementarity were shared.

The pools of oligonucleotides were incubated together at 90° C. for 5 min in the presence of 10 mM Tris pH 8.0, 50 mM NaCl, 1 mM EDTA (STE buffer) and then slowly cooled to room temperature (25° C.), whereby positive and negative strand oligonucleotides were annealed through complementary regions. Nicks in the annealed oligonucleotides (FIG. 12B, indicated with arrows) were sealed using DNA ligase, thereby assembling a collection of large duplex oligonucleotide cassettes (FIG. 12C) that could be directly ligated into vectors. The duplex cassettes of the collection then were ligated into a 3Ala-1 pCAL G13 vector (SEQ ID NO: 33) that had been cut with Not I and Sal I.

### Example 5

### Design of Oligonucleotides for Randomization of 3Ala 2G12 Heavy Chain CDR1 and CDR3 using Oligonucleotide Fill-In and Assembly

Oligonucleotides were designed for use in oligonucleotide fill-in and assembly (OFIA) for introduction of diversity to the target portions within the heavy chain CDR1 and CDR3 of the target polynucleotide encoding the 3-Ala 2G12 Fab target polypeptide, described in Examples 3 and 4 above. Four positive strand oligonucleotide pools (F1b, F3b, F5b, and F7b) and four negative strand oligonucleotide pools (F2b, F4b, F6b and F8b) were designed. Nucleic acid sequences representing each pool of oligonucleotides are set forth in Table 12 below.

Oligonucleotides within pools F1b, F2b, F4b, F5b and F8b were designed as reference sequence oligonucleotides, each having 100% sequence identity to a reference sequence containing a sequence identity to a region of the target polynucleotide. Oligonucleotides within pools F3b, F6b and F7b were designed as randomized oligonucleotides. Each oligonucleotide in each of these pools was designed based on a reference sequence, but was designed to contain randomized portions, which are represented in bold type in Table 12. The randomized portions were designed to be synthesized using the NNK or NNN doping strategy. As in Example 4, above, the sequences of the designed randomized portions also contained variant positions, where the nucleotide at the variant position was varied compared to the reference sequence portion. These positions also are indicated in bold. The reference sequence used to design each randomized oligonucleotide is listed in Table 12, under the sequence of the randomized oligonucleotide.

The pools were designed so that each oligonucleotide within one pool would contain a region of complementarity with a region in each oligonucleotide within one other pool. These complementary regions are indicated in italics in Table 12. Oligonucleotides in the F1b pool would contain regions complementary to regions in the F2b pool. Oligonucleotides in the F3b pool would contain regions complementary to regions in the F4b pool. Oligonucleotides in the F5b pool would contain regions complementary to regions in the F6b pool. Oligonucleotides in the F7b pool would contain regions complementary to regions in the F8b pool. Each oligonucleotide in the Fib pool would contain a 5′ phosphate group.

TABLE 12
3Ala 2G12 Fill-In Oligonucleotides

| Oligo- | | | |
|---|---|---|---|
| nucleo- | | | SEQ |
| tide | Purifi- | | ID |
| Pool | cation | Sequence | NO. |
| F1b | PAGE | GCCCAGGCGGCCGCAGAAGTTCAGCT | 153 |
| | | GGTTGAATCTGGTGGTGGTCTGGTTA | |
| | | AAGCTGGTGGTTCTCTGATCCTGTCT | |
| | | TGTGGTGTGAGCAACTTCCGCATCAG | |
| | | CGC | |
| F2b | PAGE | TGATGCGGAAGTTGCTCACACCAC | 154 |
| F3b | HPLC | CGTATCAGCGCTNNTNNKATGAACTG | 155 |
| | | GGTGCGCCGTGTGC | |
| Reference | | CGTATCAGCGCTCACACCATGAACTG | 156 |
| Sequence | | GGTGCGCCGTGTGC | |
| used to | | | |
| design F3b | | | |
| F4b | PAGE | GGTCGTCCCGGGAAACGGTGAAACGA | 157 |
| | | CCTTTAACAGCGTCAGCGTAGTCACG | |
| | | GTAGGTAGAAGAGGTAGAGATAGAA | |
| | | GCAACCCATTCCAGACCACCACCCGG | |
| | | CACACGGCGCACCCAGTTCAT | |
| F5b | PAGE | CCGTTTCTCGTGACGACCTGGAAGAC | 158 |
| | | TTCGTTTACCTGCAGATGCATAAAAT | |
| | | GCGTGTTGAAGACACCGCTATCTACT | |
| | | ACTGCGCGCGCAAC | |
| F6b | HPLC | GACAGACGGTCAGAMNNGTTGCGCG | 159 |
| | | CGCAGTAGTAGATAG | |
| Reference | | GACAGACGGTCAGAACCGTTGCGCGC | 160 |
| Sequence | | GCAGTAGTAGATAG | |
| used to | | | |
| design F6b | | | |
| F7b | desalt | AGGTAGCGATCGTNNTNNKGACNNK | 161 |
| | | NNKCCGTTTGACGCGTGGGGTCCGG | |
| Reference | | AGGTAGCGATCGTCTGTCTGACAAC | 162 |
| Sequence | | GACCCGTTTGACGCGTGGGGTCCGG | |
| used to | | | |
| design F7b | | | |
| F8b | PAGE | CCTTTGGTCGACGCCGGAGAAACGGT | 163 |
| | | AACAACGGTACCCGGACCCCACGCGT | |
| | | CAAACG | |

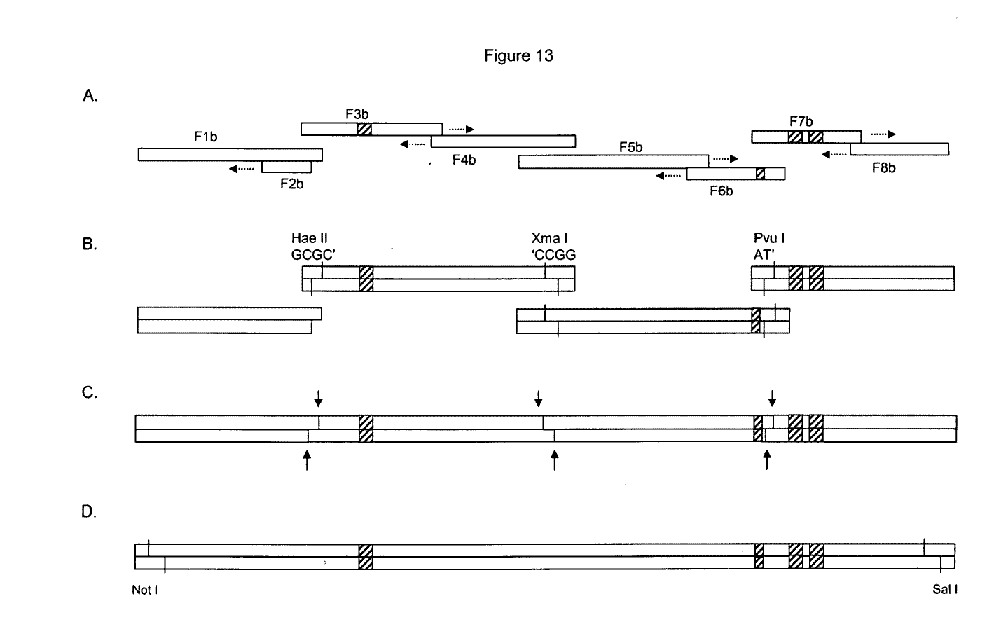

As illustrated in FIG. 13A, the oligonucleotides listed in Table 12 can be used in fill-in reactions to create oligonucleotide duplexes. Oligonucleotide pools can be mixed pairwise (F1b and F2b; F3b and F4b; F5b and F6b; and F7b and F8b) in the presence of dNTPs, buffer and Advantage HF 2 DNA polymerase (Clontech). Each mixture can then be incubated at 95° C. for 1 min, followed by incubation at 68° C. for 3 min for hybridization of the fill-in primer to the template and extension of the fill-in primer. These fill-in reactions would then result in four pools of oligonucleotide duplexes. As shown in FIG. 13A, three of the fill-in reactions would be mutually primed fill-in reactions, where oligonucleotides from both pools serve as primers for template oligonucleotides from the other pool. Thus, the oligonucleotides in these reactions would serve as both template oligonucleotides and fill-in primers. The fill-in reaction involving F1b and F2b oligonucleotides would not be a mutually primed reaction. In this reaction, F1b oligonucleotides would act as template oligonucleotides and F2b oligonucleotides as fill-in primers.

As illustrated in FIG. 13B, the resulting four pools oligonucleotide duplexes could then be incubated with restriction endonucleases to create restriction site overhangs, through which large duplexes could be assembled. The F1b/F2b duplexes would be cut with Hae II. The F3b/F4b duplexes would be cut with Hae III and Xma I. The F5b/F6b duplexes would be cut with Xma I and Pvu I. The F7b/F8b duplexes would be cut with Pvu I.

As shown in FIG. 13C, the digested duplexes then could be ligated together, thereby assembling large oligonucleotide duplexes. As shown in FIG. 13D, the assembled duplexes then could be incubated with Not I and Sal I to generate restriction site overhangs. The duplex cassettes then could be ligated into 3Ala-1 in pCAL G13 vectors that had been cut with Not I and Sal I.

### Example 6

### Randomization of 3Ala 2G12 Heavy Chain CDR1 and CDR3 Using Duplex Oligonucleotide Single Primer Amplification (DOLSPA)

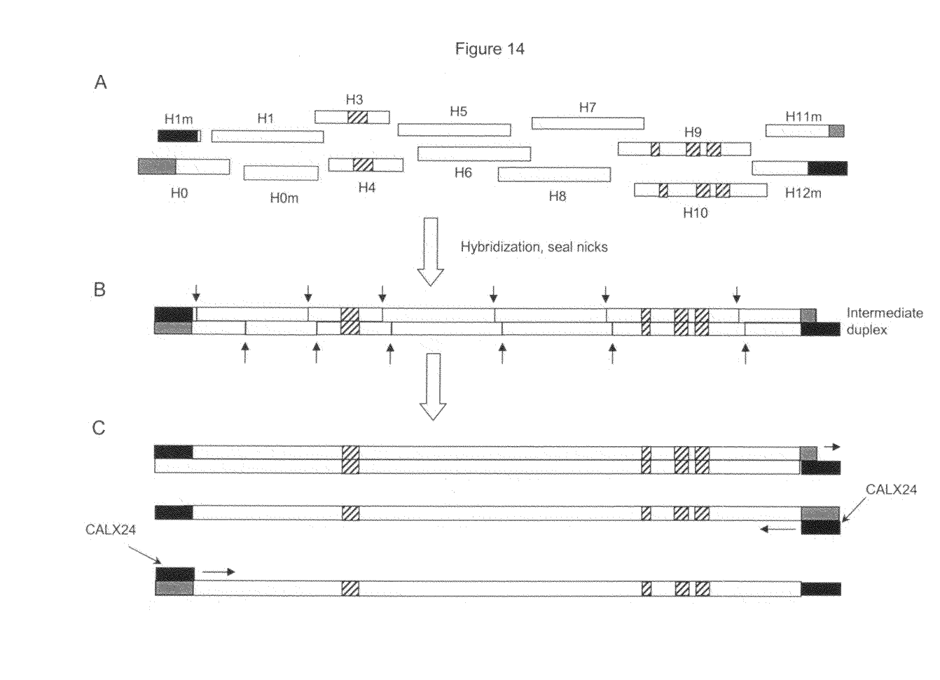

Duplex oligonucleotide single primer amplification (DOLSPA) was used to introduce diversity to the target portions within the heavy chain CDR1 and CDR3 of the 3-Ala 2G12 Fab target polypeptide described in Examples 3, 4 and 5 above. The process is illustrated schematically in FIG. 14.

Seven positive strand oligonucleotide pools (H1m, H1, H3, H5, H7, H9 and H11m) and seven negative strand oligonucleotide pools (H0, H0m, H4, H6, H8, H10 and H12m) were designed and ordered (FIG. 14A). Oligonucleotide pools H1m, H0m, H9, H10, H11m and H12m were ordered from Integrated DNA Technologies (IDT®) (Coralville, Iowa). Oligonucleotide pools H0, H1, H3, H4, H5, H6, H7 and H8 were ordered from TriLink Biotechnologies (San Diego, Calif.). Each pool was synthesized using phosphoramidite monomers and tetrazole catalysis (see, e.g. Behlke et al. “Chemical Synthesis of Oligonucleotides” Integrated DNA Technologies (2005), 1-12; and McBride and Caruthers Tetrahedron Lett. 24:245-248). Nucleic acid sequences representing each pool of oligonucleotides are set forth in Table 13 below. Each oligonucleotide pool, except H1m and H12m, was synthesized with 5′ phosphate groups.

Oligonucleotides within pools H1m, H1, H5, H7, H11m, H0, H0m, H6, H8 and H12m were reference sequence oligonucleotides, each having 100% sequence identity to a reference sequence containing sequence identity to a region of the target polynucleotide. Oligonucleotides within pools H3, H4, H9 and H10 were randomized oligonucleotides. Each oligonucleotide in each of these randomized pools was synthesized based on a reference sequence, but contained randomized portions, represented in bold type in Table 13. These randomized portions were synthesized using the NNK or NNN doping strategy. As in Example 4, above, the randomized portions further contained variant positions, where the nucleotide at the variant position was mutated compared to the reference sequence portion. These positions also are indicated in bold and are part of the randomized portions. The reference sequence used to design each pool of randomized oligonucleotides is listed in Table 13, below the sequence of the randomized oligonucleotide.

The pools were designed so that each oligonucleotide within one pool contained a region of complementarity with a region in each oligonucleotide within at least one other, typically two other, pool(s).

For example, as illustrated in FIG. 14A, oligonucleotides in the H1m pool contained regions complementary to regions in the HO pool. Oligonucleotides in the H1 pool contained regions complementary to regions in the HO and H0m pool. Oligonucleotides in the H3 pool contained regions complementary to regions in the H0m and the H4 pool. Oligonucleotides in the H5 pool contained regions complementary to regions in the H4 and the H6 pool. Oligonucleotides in the H7 pool contained regions complementary to regions in the H6 pool and the H8 pool. Oligonucleotides in the H9 pool contained regions complementary to regions in the H8 pool and the H10 pool. Oligonucleotides in the H11 m pool contained regions complementary to regions in the H10 pool and the H12m pool. Thus, the regions of complementarity were shared.

Each of the oligonucleotides in pools H1m and H12m contained identical 5′ regions X (illustrated in grey), containing the sequence of nucleotides set forth in SEQ ID NO: 3 (GCCGCTGTGCCATCGCTCAGTAAC), which was 100% identical to the CALX24 single primer sequence, used in the single primer amplification described below. Similarly, each of the oligonucleotides in pool HO contained a region Y, which contained a sequence of nucleotides complementary to region X. As illustrated in FIG. 14, these regions facilitated single primer amplification of the intermediate duplexes formed in this Example.

TABLE 13

| | | | SEQ |
|---|---|---|---|
| Oligonucleo- | | | ID |
| tide Pool | Purification | Sequence | NO. |
| H0m | PAGE | GAAGTTAGAAACACCGCA | 164 |
| | | AGACAGGATCAGAGAACC | |
| | | ACCAGCTTTAAC | |
| H0 | PAGE | CAGACCACCACCAGATTC | 165 |
| | | AACCAGCTGAACTTCTGCg | |
| | | gccgcGTTACTGAGCGATGG | |
| | | CACAGCGGC | |
| H1 | PAGE | GGCCGCAGAAGTTCAGCT | 137 |
| | | GGTTGAATCTGGTGGTGG | |
| | | TCTGGTTAAAGCTGGTGGT | |
| | | TCTCTGATCCTGTCTTGCG | |
| | | GT | |
| H1m | PAGE | GCCGCTGTGCCATCGCTCA | 166 |
| | | GTAACgc | |
| H3 | HPLC | GTTTCTAACTTCCGTATCT | 139 |
| | | CTGCTNNTNNKATGAACT | |
| | | GGG | |
| Reference | | GTTTCTAACTTCCGTATCT | 140 |
| Sequence Used | | CTGCTCACACCATGAACT | |
| to Design H3 | | GGG | |
| H4 | HPLC | GAACACGACGAACCCAGT | 141 |
| | | TCATMNNANNAGCAGAG | |
| | | ATACG | |
| Reference | | GAACACGACGAACCCAGT | 142 |
| Sequence Used | | TCATGGTGTGAGCAGAGA | |
| to design H4 | | TACG | |
| H5 | PAGE | TTCGTCGTGTTCCGGGTGG | 143 |
| | | TGGTCTGGAATGGGTTGCT | |
| | | TCTATCTCTACCTCTTCTA | |
| | | CCTACCGTGACTACGCTG | |
| | | ACGCTGT | |
| H6 | PAGE | AAACGACCTTTAACAGCG | 144 |
| | | TCAGCGTAGTCACGGTAG | |
| | | GTAGAAGAGGTAGAGATA | |
| | | GAAGCAACCCATTCCAGA | |
| | | CCACCACCCG | |
| H7 | PAGE | TAAAGGTCGTTTCACCGTT | 145 |
| | | TCTCGTGACGACCTGGAA | |
| | | GACTTCGTTTACCTGCAGA | |
| | | TGCATAAAATGCGTGTTG | |
| | | AAGACACC | |
| H8 | PAGE | GTAGTAGATAGCGGTGTC | 146 |
| | | TTCAACACGCATTTTATGC | |
| | | ATCTGCAGGTAAACGAAG | |
| | | TCTTCCAGGTCGTCACGAG | |
| | | AAACGGTG | |
| H9 | desalt | GCTATCTACTACTGCGCTC | 147 |
| | | GTAAANNKTCTGACCGTN | |
| | | NTNNKGACNNKNNKCCGT | |
| | | TCGACGCTTGGGGT | |
| Reference | | GCTATCTACTACTGCGCTC | 148 |
| Sequence Used | | GTAAAGGTTCTGACCGTC | |
| to Design H9 | | TGTCTGACAACGACCCGT | |
| | | TCGACGCTTGGGGT | |
| H10 | desalt | AACGGTACCCGGACCCCA | 149 |
| | | AGCGTCGAACGGMNNMN | |
| | | NGTCMNNANNACGGTCAG | |
| | | AMNNTTTACGAGCGCA | |
| Reference | | AACGGTACCCGGACCCCA | 150 |
| Sequence Used | | AGCGTCGAACGGGTCGTT | |
| to Design H10 | | GTCAGACAGACGGTCAGA | |
| | | ACCTTTACGAGCGCA | |
| H11m | PAGE | CCGGGTACCGTTGTTACCG | 167 |
| | | TTTCTCCGGCGTCGAC | |
| H12m | PAGE | GCCGCTGTGCCATCGCTCA | 168 |
| | | GTAACGTCGACGCCGGAG | |
| | | AAACGGTAAC | |

As shown in FIG. 14, oligonucleotides from the seven positive strand and seven negative strand oligonucleotide pools were assembled, for generation of randomized assembled duplexes using the DOLSPA method, by forming intermediate duplexes (FIG. 14B) and then amplifying the intermediate duplexes (FIG. 14C) using a non-gene-specific single primer pool.

### Example 6A

### Duplex Oligonucleotide Assembly—Forming intermediate duplexes

First, as shown in FIG. 14A, the positive and negative strand oligonucleotides were incubated under conditions whereby they were annealed through regions of complementarity and whereby nicks were sealed, generating intermediate duplexes. For this process, 1 μL of each of the 12 pools of oligonucleotides (at 100 μM each) were incubated together in the presence of 10 μL of 10× Ampligase® reaction buffer (EPICENTRE® Biotechnologies, Madison, Wis.) and 10 μL (50 units) Ampligase® ligase, in 100 μL reaction volume.

The mixture was heated to 94° C. for 5 minutes. The mixture then was slowly cooled down to 50° C. by incubating on a dry heat block. At various time-points following the transfer to the heat block (1 hour, 2 hours, 4 hours and 6 hours), 40 μL of the mixture was removed and stored at 4° C. until further use. The remainder of the reaction was incubated at 50° C. overnight. 1 μL of each 40 μL aliquot, as well as 1 μL from the remainder following overnight incubation, was run on a 1% agarose gel. Imaging of the gel revealed, in each sample, a number of bands ranging from approximately 100 to 600 base pairs. These bands likely represented both (non-amplified) intermediate duplexes, the non-annealed oligonucleotides, and incomplete intermediate duplexes that formed by annealing of fewer than all the oligonucleotides.

### Example 6B

### Single Primer Amplification

The 2 μL, 1 μL and 0.5 μL aliquots were taken from the mixtures from the aliquots taken at various time-points after cooling in the previous step, including the overnight reaction, and mixed with 1.2 μL of a single primer pool (CALX24 primer, having the nucleic acid sequence set forth in SEQ ID NO: 3; GCCGCTGTGCCATCGCTCAGTAAC), 2 μL of Advantage HF2 Polymerase mix in the presence of its reaction buffer and dNTP in a 100 μL reaction volume.

Single primer amplification then was performed, amplifying the intermediate duplexes, using the following reaction conditions: 1 minute denaturation at 95 C, followed by 30 cycles of denaturation at 95° C. for 5 seconds and annealing/extension at 68° C. for 1 minute, followed by a 3 minute incubation at 68° C. The reaction then was cooled down to 4° C. The resulting products were run on a 1% agarose gel.

Imaging of the gel revealed a band running at the appropriate size to indicate that it represented a pool of assembled duplexes, illustrated in FIG. 14B, containing 434 nucleotides in length. The intensity of the band increased with increasing time of the duplex oligonucleotide ligation step (1 hour, 2 hours, 4 hours, 6 hours, overnight), and with increasing amount of the intermediate duplex mixture (0.5, 1, and 2 microliters) added to the amplification reaction. Each sample produced an intense band at the correct size.

Based on these results, 6 microliters of the cooled intermediate duplex sample that was taken at the 2 hour time-point was used in an additional single primer assembly reaction. For this process, the 6 μL of the intermediate duplexes were mixed with 14.4 μL of the CALX24 single primer and 24 μL of Advantage HF2-polymerase mix in the presence of its reaction buffer and dNTP, in a 1200 μL reaction volume. Separately, two control reactions also were set up. In one control reaction, no intermediate duplex mixture was added to the reaction and in the other control reaction, no primer was added. The single primer amplification was carried out using the conditions described in this section above. 10 μL of each sample then was run on a 1% agarose gel.

Imaging of the gel revealed a band running at the appropriate size (indicating an assembled duplex of 434 nucleotides in length) in the sample containing the product from the reaction where primer and duplexes were added. While the control sample where no primer was added produced a very slight band at the same size, no amplification of the duplexes appeared to have occurred in either of the control samples, indicating that the single primer amplification reaction had specifically amplified the intermediate duplexes, to form a pool of assembled duplexes.

The duplexes then were digested with Not I and Sal I restriction endonucleases to form a pool assembled duplex cassettes. The assembled duplex cassettes then were inserted, by ligation (using a T4 DNA ligase), into the 3-Ala 2G12 pCAL G13 vector, described in Example 4, above, which had been digested with the same endonucleases.

The resulting collection of vectors containing the assembled duplex cassettes were used to transform NEB 10-beta high efficiency electroporation competent cells from New England Biolabs, which then were plated on agar plates supplemented with 100 μg/mL ampicillin and incubated overnight at 37° C.

### Example 6C

### Amino Acid Sequencing of Randomized Clones

Following overnight incubation, 48 representative ampicillin-resistant colonies were picked, and vector DNA from each colony sequenced to determine relative nucleotide usage in the randomized positions. For this process, cassette nucleic acids were submitted for sequencing to Eton Biosciences (San Diego, Calif.).

The sequencing results revealed that 47 of the 48 clones contained readable sequences. Of those, 29 did not contain any deletions or insertions. Six (6) of these sequences (19.1%) contained an amber stop codon (TAG). The nucleotide usage, for the 29 sequences with no deletions/insertions, at positions within randomized portions in the CDR1 and CDR3 regions are listed in Table 14 below.

As shown in Table 14, sequencing revealed that A, C, G and T were used at 25.9%, 24.9%, 23.4% and 26.4%, respectively, where an “N” doping strategy was used, and 0.7%, 0%, 53.1%, and 46.2%, respectively, where a “K” doping strategy was used. These results indicate that the bias toward T, that was observed with overlap PCR, as described in Example 4, above, was not observed with the DOLSPA method, and that the usage of the various nucleotides in the randomized positions was non-biased.

TABLE 14
Relative Nucleotide Usage in Randomized
Portions generated by DOLSPA

| | | | | | |
|---|---|---|---|---|---|
| Nucleotide in | | | | | |
| reference | Nucleotide/Doping | | | | |
| sequence | Strategy | A | C | G | T |

CDR1

| | | | | | |
|---|---|---|---|---|---|
| C | N | 6 | 9 | 6 | 8 |
| A | N | 5 | 8 | 9 | 7 |
| C | T | 0 | 0 | 0 | 29 |
| A | N | 6 | 5 | 8 | 10 |
| C | N | 8 | 5 | 5 | 11 |
| C | K | 1 | 0 | 17 | 11 |

CDR3

| | | | | | |
|---|---|---|---|---|---|
| G | N | 5 | 8 | 10 | 6 |
| G | N | 9 | 8 | 7 | 5 |
| T | K | 0 | 0 | 14 | 15 |
| G | N | 7 | 10 | 8 | 4 |
| C | N | 10 | 4 | 7 | 8 |
| G | T | 0 | 0 | 0 | 29 |
| G | N | 11 | 3 | 11 | 4 |
| C | N | 6 | 10 | 5 | 8 |
| G | K | 0 | 0 | 16 | 13 |
| G | N | 6 | 12 | 3 | 8 |
| C | N | 7 | 5 | 5 | 12 |
| G | K | 0 | 0 | 16 | 13 |
| G | N | 7 | 5 | 6 | 11 |
| A | N | 12 | 7 | 5 | 5 |
| C | K | 0 | 0 | 14 | 15 |
| Totals/Percent | Total at position N | 105 | 99 | 95 | 107 |
| Usage in 29 | Total at position K | 1 | 0 | 77 | 67 |
| clones | Percent usage at | 25.9 | 24.4 | 23.4 | 26.4 |
| | position N | | | | |
| | Percent Usage at | 0.7 | 0 | 53.1 | 46.2 |
| | position K | | | | |

### Example 7

### Randomization of 3Ala 2G12 Heavy Chain CDR1 and CDR3Using Fragment Assembly Ligation/Single Primer Amplification (FAL-SPA)

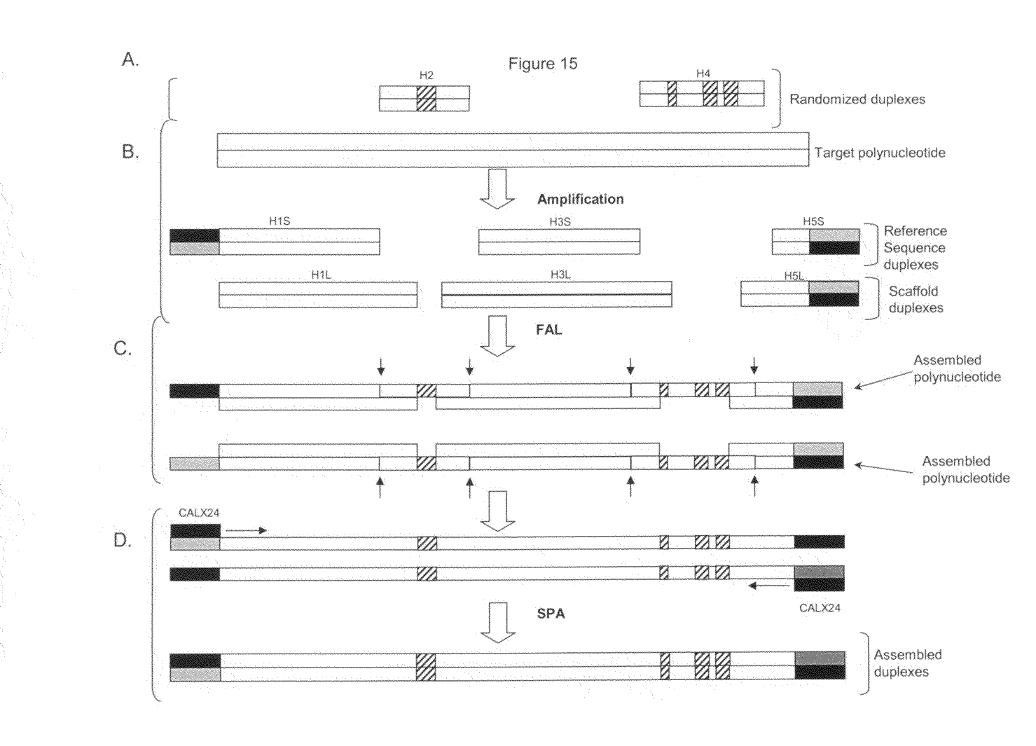

Fragment Assembly Ligation/Single Primer Amplification (FAL-SPA) was used to introduce diversity to the target portions within the heavy chain CDR1 and CDR3 of the target polynucleotide encoding the 3-Ala 2G12 Fab target polypeptide, described in Examples 3, 4, 5 and 6 above. The process is schematically illustrated in FIG. 15.

### Example 7A

### Producing Randomized Duplexes with Synthetic Oligonucleotides

First, pools of randomized duplexes (H2 and H4, depicted in FIG. 15) were produced according to the provided methods, by performing amplification reactions on pools of template oligonucleotides. For this process, oligonucleotides from pools of randomized oligonucleotides that are described in Example 6, above (H3, H4, H9 and H10, listed in Table 13 above) were used as template oligonucleotides for amplification reactions. These reactions were primed by oligonucleotide primer pairs listed in Table 15, below. The H2-F and H2-R primer pair was used to amplify the H3 and H4 template oligonucleotide pools, yielding the H2 randomized duplex pool; and the H4-F and H4-R primer pair was used to amplify H3 and H4 template oligonucleotide pools, yielding the H4 randomized duplex pool.

The primers and oligonucleotides were designed such that the entire length of the reference sequence portions in the H3, H4, H9 and H10 randomized template oligonucleotides were complementary to a region within one of the primers. In Table 15, the regions within the primers that are complementary to the reference sequence portions in the H3, H4, H9, and/or H10 oligonucleotide pools are indicated in italics. The primers were purified by desalting.

The primers used to amplify the template oligonucleotides were short oligonucleotides, containing 30 or less than 30 nucleotides in length. The randomized duplexes were formed in a PCR amplification, by denaturing and incubating the oligonucleotides (H3 and H4 or H9 and H10) with the appropriate primers (H2-F/H2R and H4-F/H4-R, respectively) in the presence of 1× HF Buffer and Advantage HF 2 polymerase mix and dNTPs. The amplification was performed using the following reaction conditions: denaturation at 95° C. for 1 minute, followed by 30 cycles of denaturation at 95° C. for 5 seconds, annealing at 50° C. for 15 seconds and extension at 68° C. for 1 minute; followed by a 3 minute incubation at 68° C. The randomized duplexes then were gel purified and treated with T4 polynucleotide kinase (New England Biolabs®, Inc.), so that they could be ligated in subsequent steps.

### Example 7B

### Producing Reference Sequence Duplexes Using Synthetic Oligonucleotide Primers and Target Polynucleotide Template

PCR amplification also was carried out to form a plurality of pools of reference sequence duplexes (HIS and H3S, which are depicted in FIG. 15B). These reference sequence duplexes were produced by amplification with primer pairs, listed in Table 15 below, as follows: Reference sequence duplex H1S was produced using the CALX24H1S-F and the H1S-R primers, listed in Table 15. Reference sequence duplex H3S was produced using the H3S-F and the H3S-R primers, listed in Table 15. Like the primers used to amplify the randomized duplexes, the primers used to amplify these reference sequence duplexes were short oligonucleotides, containing between 23 and 45 nucleotides in length.

These reference sequence duplexes were formed in a PCR amplification, using the 3-ALA pCAL G13 vector containing the 3-ALA 2G12 target polynucleotide (SEQ ID NO: 33), described in Example 3, as a template. The primers amplified regions of the vector, within the 3-Ala 2G12 heavy chain variable region that was targeted in previous Examples hereinabove (e.g. Examples 3, 4, 5). The reactions were carried out using the appropriate primers in the presence of 1×HF 2 Buffer and Advantage HF 2 polymerase mix and dNTPs. The amplification was performed using the following reaction conditions: denaturation at 95° C. for 1 minute, followed by 30 cycles of denaturation at 95° C. for 5 seconds, annealing at 50° C. for 15 seconds and extension at 68° C. for 1 minute; followed by a 3 minute incubation at 68° C. The pools of reference sequence duplexes then were gel purified and treated with T4 polynucleotide kinase (New England Biolabs®, Inc.), so that they could be ligated in subsequent steps.

An additional reference sequence duplex pool, H5S, was generated, without amplification, by hybridizing two fully complementary reference sequence oligonucleotides (CALX24H5-F and CALX24H5-R), which also are listed in Table 15, below. The oligonucleotides were treated with T4 polynucleotide kinase prior to forming the duplexes.

The reference sequence duplexes, generated as in this example, and the randomized duplexes, generated in Example 7A, were short duplexes, containing between 66 and 198 nucleotides in length. This feature reduced the chances that mutations/deletions/insertions would occur during the steps of the methods.

One primer pool (CALX24H1S-F), and one of the oligonucleotide pools used in the hybridization to form the additional duplex (CALX24H5-R), contained a Region X (identical in sequence within both primers), a non gene-specific sequence of nucleotides that is identical to the CALX24 primer (SEQ ID NO: 3). Thus, the reference sequence duplexes H1S and H5S, made with these primers/oligonucleotides, contained a sequence of nucleotides including Region X (depicted in black in FIG. 15), and also a complementary Region Y (depicted in grey in FIG. 15). These regions served as templates for the primer CALX24, which was used in the subsequent SPA step, described in Example 7D below.

### Example 7C

### Producing Scaffold Duplexes Using Synthetic Oligonucleotide Primers and Target Polynucleotide Template

PCR amplification also was carried out to form a plurality of pools of scaffold duplexes (H1L, H3L, and H5L, which are depicted in FIG. 15). The scaffold duplexes were produced with primer pairs, listed in Table 15 below. Scaffold duplex H1L was produced using the H1L-F and the H1L-R primers, listed in Table 15. Reference sequence duplex H3L was produced using the H3L-F and the H3L-R primers, listed in Table 15. Reference sequence duplex H5L was produced using the H5-F and the CALX24H5-R primers, listed in Table 15.

Like the primers used to amplify the randomized duplexes, the primers used to amplify these scaffold duplexes were short oligonucleotides, containing between 21 and 47 nucleotides in length. The reference sequence duplexes were formed in a PCR amplification, using the 3-ALA pCAL G13 vector containing the 3-ALA 2G12 target polynucleotide (SEQ ID NO: 33), described in Example 3, as a template. The primers amplified regions of the vector sequence, within the 3-Ala 2G12 heavy chain variable region, that was targeted in previous Examples herein.

The amplification reaction was carried out with the appropriate primers in the presence of 1× HF Buffer and Advantage HF 2 polymerase mix. The amplification was performed using the following reaction conditions: denaturation at 95° C. for 1 minute, followed by 30 cycles of denaturation at 95° C. for 5 seconds, annealing at 50° C. for 15 seconds and extension at 68° C. for 1 minute; followed by a 3 minute incubation at 68° C. The pools of reference sequence duplexes then were gel purified and treated with T4 polynucleotide kinase, so that they could be ligated in subsequent steps.

The reference sequence duplexes and the randomized duplexes (generated in Example 7A), were short duplexes, containing between 66 and 198 nucleotides in length. This aspect reduced the chances that mutations/deletions/insertions would occur during the steps of the methods.

One of the primers (CALX24H5-R) contained Region X, the non gene-specific sequence of amino acids that is identical to the CALX24 primer (SEQ ID NO: 3) and to the Region X used in the reference sequence duplexes described in Example 7B, above. Thus, the scaffold sequence duplex H5L contained a sequence of nucleotides including Region X (depicted in black in FIG. 15), and also a complementary Region Y (depicted in grey in FIG. 15). This region facilitated the hybridization of the strands of this duplex to fragments of the H5-S reference sequence duplex in the subsequent fragment assembly and ligation (FAL) step, described in Example 7D, below.

TABLE 15

Pools of Primers and Template Oligonucleotides

| Primer/Template | | SEQ ID |
|---|---|---|
| Oligonucleotide Pool | Sequence | NO: |
| CALX24H1S-F (45) | GCCGCTGTGCCATCGCTCAGTAACGCGGCCGCAGAAG | 6 |
| | TTCAGCTG | |
| H1S-R (23) | AGACAGGATCAGAGAACCACCAG | 169 |
| H1L-F (21) | GCGGCCGCAGAAGTTCAGCTG | 170 |
| H1L-R (24) | AGCAGAGATACGGAAGTTAGAAAC | 171 |
| H2-F (30) | TGCGGTGTTTCTAACTTCCGTATCTCTGCT | 172 |
| H2-R (30) | ACCACCCGGAACACGACGAACCCAGTTCAT | 173 |
| H3L-F (24) | ATGAACTGGGTTCGTCGTGTTCCG | 174 |
| H3L-R (24) | TTTACGAGCGCAGTAGTAGATAGC | 175 |
| H3S-F (24) | GGTCTGGAATGGGTTGCTTCTATC | 176 |
| H3S-R (24) | TTCAACACGCATTTTATGCATCTG | 177 |
| H4-F (30) | GACACCGCTATCTACTACTGCGCTCGTAAA | 178 |
| H4-R (30) | AACGGTACCCGGACCCCAAGCGTCGAACGG | 179 |
| H5-F (24) | CCGTTCGACGCTTGGGGTCCG | 180 |
| CALX24H5-F (47) | GTTACCGTTTCTCCGGCGTCGACGTTACTGAGCGATGGCA | 181 |
| | CAGCGGC | |
| CALX24H5-R (47) | GCCGCTGTGCCATCGCTCAGTAACGTCGACGCCGGAG | 168 |
| | AAACGGTAAC | |

### Example 7D

### Producing Assembled Duplexes by Fragment Assembly Ligation (FAL), Followed by Single Primer Amplification (SPA)

The reference sequence duplexes and the randomized duplexes then were denatured and ligated in a fragment assembly and ligation (FAL) step using the scaffold duplexes to bring the polynucleotides from the reference sequence and randomized duplexes in close proximity, as illustrated in FIG. 15C.

For this process, the pools of reference sequence duplexes, the pools of randomized duplexes and the pools of scaffold duplexes were incubated at equimolar amounts in the presence of 1× Ampligase® Reaction Buffer and 10 μL Ampligase® (ligase), in a 200 μL reaction volume and denatured at 95° C. for 30 seconds, and then incubated at 65° C. for 1 minute, whereby the polynucleotides annealed through complementary regions (e.g. the shared complementary regions illustrated in FIG. 15). These steps were repeated for 30 cycles to generate the assembled polynucleotides.

The assembled polynucleotides then were denatured and used in a single primer amplification (SPA) reaction. For the reaction, 10, 2, and 0.5 μL of the FAL mixture was incubated with the CALX24 primer (SEQ ID NO: 3), in the presence of 1× HF Buffer and Advantage HF 2 Polymerase Mix, in a 100 μL reaction volume. 10 μL of the reaction was run on a 1.3% agarose gel, which revealed a band at the appropriate size that was brighter at higher concentrations. No band was visible in a control sample, where no CALX24 primer was used.

### Example 7E

### Analysis of Nucleotide Usage in Randomized Portions Generated Using FAL-SPA

To asses the extent and nature of randomization, vector DNA from each of ninety (90) representative colonies from the randomized vector transformants was sequenced. For this process, cassette nucleic acids were submitted for sequencing to Eton Biosciences (San Diego, Calif.). Sequencing revealed that 77 of the 90 clones (85.6%) contained no insertions or deletions. The sequences of these 77 clones were further evaluated to determine the codon usage among the positions in the randomized portions of the polynucleotides. 65 (72.2%) of those 77 clones contained no mutations, while 12 contained mutations other than silent mutations. The nucleotide usage within randomized portions in the heavy chain CDR1 and CDR3 regions are listed in Table 16 below. There were 7 amber stop codon sequences (TAG) (in a total of 6 clones; 9.1%).

TABLE 16
Nucleotide Usage in Clones Generated Using FAL-SPA

| | | | | | |
|---|---|---|---|---|---|
| Nucleotide in | | | | | |
| reference | Nucleotide/Doping | | | | |
| sequence | Strategy | A | C | G | T |

CDR1

| | | | | | |
|---|---|---|---|---|---|
| C | N | 18 | 20 | 17 | 22 |
| A | N | 25 | 17 | 17 | 18 |
| C | T | 0 | 0 | 0 | 77 |
| A | N | 22 | 23 | 22 | 10 |
| C | N | 19 | 15 | 26 | 17 |
| C | K | 0 | 0 | 36 | 41 |

CDR3

| | | | | | |
|---|---|---|---|---|---|
| G | N | 35 | 11 | 16 | 15 |
| G | N | 19 | 15 | 15 | 28 |
| T | K | 0 | 0 | 42 | 35 |
| G | N | 20 | 13 | 21 | 23 |
| C | N | 15 | 20 | 22 | 20 |
| G | T | 0 | 0 | 0 | 77 |
| G | N | 33 | 19 | 7 | 18 |
| C | N | 26 | 14 | 17 | 20 |
| G | K | 0 | 0 | 41 | 36 |
| G | N | 16 | 24 | 21 | 16 |
| C | N | 19 | 18 | 24 | 16 |
| G | K | 0 | 0 | 35 | 42 |
| G | N | 23 | 18 | 16 | 20 |
| A | N | 22 | 17 | 19 | 19 |
| C | K | 1 | 0 | 33 | 43 |
| Totals/Percent | Total at position N | 312 | 244 | 260 | 262 |
| Usage in 77 | Total at position K | 1 | 0 | 187 | 197 |
| clones | Percent usage at | 29 | 23 | 24.1 | 24.3 |
| | position N | | | | |
| | Percent Usage at | 0.3 | 0 | 48.6 | 51.2 |
| | position K | | | | |

As shown in Table 16, sequencing revealed that A, C, G and T were used at 29%, 23%, 24.1% and 24.3%, respectively, where an “N” doping strategy was used, and 0.3%, 0%, 48.6% and 51.2%, respectively, where a “K” doping strategy was used. As noted, 85.6% of the sequences did not contain any deletions/insertions. These results indicate non-biased usage of the various nucleotides at the randomized positions, and that this method can be used to generate diversity in multiple portions in a target polynucleotide in a non-biased manner, in order to generate large collections of variant polynucleotides and polypeptides having saturated diversity at the randomized positions, and with a low error rate at non-randomized/variant positions, minimizing unwanted mutations. In fact, the 85.6% deletion/insertion rate was achieved in this study using desalted primers/oligonucleotides. It is expected that the deletion/insertion rate will improve with purified primers, for example, primers/oligonucleotides that are purified by HPLC.

### Example 8

### Randomization of 3Ala 2G12 Heavy Chain CDR1 and CDR3 Using Modified Fragment Assembly Ligation/Single Primer Amplification (mFAL-SPA)

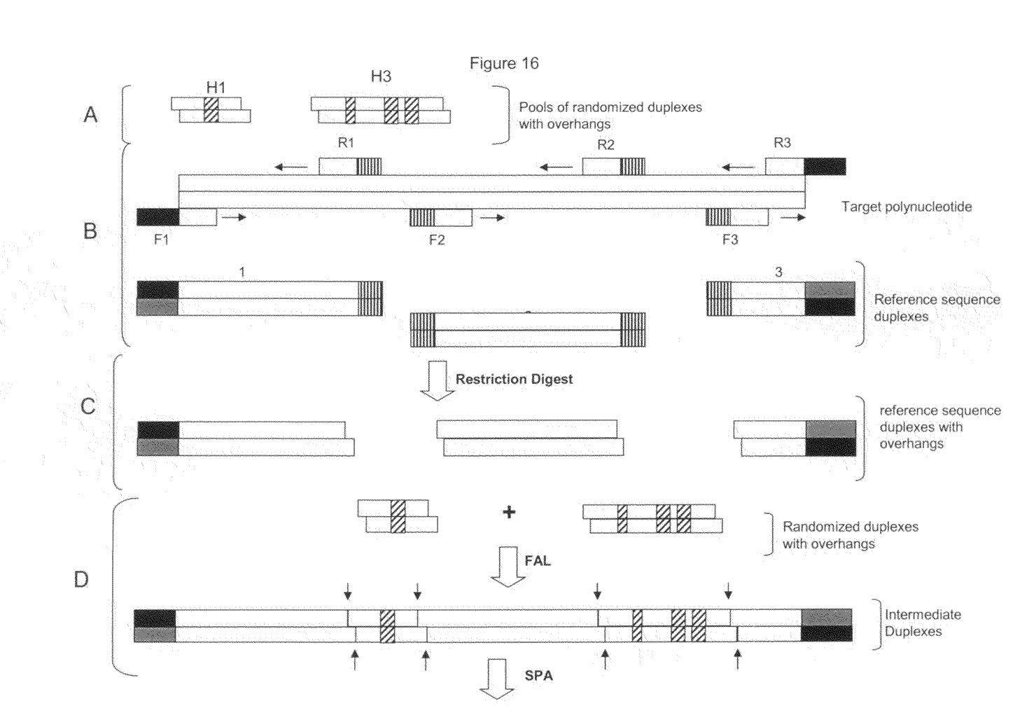

Modified Fragment Assembly Ligation/Single Primer Amplification (mFAL-SPA) was used to introduce diversity to the target portions within the heavy chain CDR1 and CDR3 of the target polynucleotide encoding the 3-Ala 2G12 Fab target polypeptide described in Examples 3, 4, 5 and 6 above. The process is schematically illustrated in FIG. 16.

### Example 8A

### Generating Pools of Randomized Duplexes

Four pools of randomized oligonucleotides (H1F, H1R, H3F, and H3R) were designed and generated using the design and synthesis methods described in the above Examples, for use in forming two pools of randomized duplexes (H1 and H3; illustrated in FIG. 16A). The sequences of these randomized oligonucleotides are set forth in Table 17, below. Each oligonucleotide in each of these randomized pools was synthesized based on a reference sequence, but contained randomized portions, represented in bold type in Table 17 and as hatched boxes in FIG. 16. These randomized portions were synthesized using the NNK or NNN doping strategy described in Example 1A above. The reference sequence used to design each pool of randomized oligonucleotides is listed in Table 17, below the sequence of the randomized oligonucleotide. As in Example 4, above, the randomized portions also contained variant positions, where the nucleotide at the variant position was mutated compared to the reference sequence portion. These positions also are indicated in bold and are part of the randomized portions.

The randomized oligonucleotides were designed such that each oligonucleotide in each of the pools contained a region complementary to an oligonucleotide in another pool. Oligonucleotides in pool H1F were complementary to oligonucleotides in pool H1R, and oligonucleotides in pool H3F were complementary to oligonucleotides in pool H3R. The oligonucleotides in each pool further were designed, whereby, following hybridization of the pairs of oligonucleotides through these complementary regions, three nucleotide overhangs would be generated, to facilitate ligation in subsequent steps (for example, see FIG. 16A. The nucleotides that would become the overhangs are indicated in italics in Table 17. The nucleotides in the randomized pools were labeled with 5′ phosphate groups.

In order to form the H1 duplex, 50 μL H1F (at 100 μM), 50 μL H1R (100 μM) and 1 μL NaCl were mixed, denatured at 95 C for 5 minutes, followed by slow cooling to 25° C. on a heat block covered with a Styrofoam® box. Similarly, to form the H3 duplex, 50 μL H3F (at 100 μM), 50 μL H1R (100 μM) and 1 μL NaCl were mixed, denatured at 95° C. for 5 minutes, followed by slow cooling to 25° C. on a heat block covered with a Styrofoam® box.

### Example 8B

### Generation of Reference Sequence Duplexes

PCR amplification was carried out to generate three reference sequence duplexes (1, 2, and 3, as illustrated in FIG. 16B). Duplexes in pool 1 were 125 nucleotides in length, duplexes in pool 2 were 196 nucleotides in length and duplexes in pool 3 were 76 nucleotides in length. For this process, three pools of forward oligonucleotide primers (F1, F2, F3) and three pools of reverse oligonucleotide primers (R1, R2, R3) were synthesized using the methods provided herein. The sequences of the primers in each pool are set forth in Table 17 below.

TABLE 17

| | | SEQ |
|---|---|---|
| | | ID |
| Name | Sequence | NO: |
| F1 | GCCGCTGTGCCATCGCTCAGTAACGCGGCCGCAGAAGTTCAGCT | 6 |
| | G | |
| R1 | GGCGGCGCTCTTCAGTTAGAAACACCGCAAGACAGGATC | 182 |
| F2 | GGCGGCGCTCTTCTCGTGTTCCGGGTGGTGGTCTG | 183 |
| R2 | GGCGGCGCTCTTCAGTAGATAGCGGTGTCTTCAACAC | 184 |
| F3 | GGCGGCGCTCTTCGGGTCCGGGTACCGTTGTTAC | 185 |
| R3 | GCCGCTGTGCCATCGCTCAGTAACGTCGACGCCGGAGAAACGG | 186 |
| | T | |
| H1F | AACTTCCGTATCTCTGCTNNTNNKATGAACTGGGTTCGT | 187 |
| H1F Ref. seq. | AACTTCCGTATCTCTGCTCACACCATGAACTGGGTTCGT | 265 |
| H1R | ACGACGAACCCAGTTCATMNNANNAGCAGAGATACGGAA | 188 |
| H1R Ref. seq. | ACGACGAACCCAGTTCATGGTGTGAGCAGAGATACGGAA | 266 |
| H3F | TACTACTGCGCTCGTAAANNKTCTGACCGTNNTNNKGACNNKN | 189 |
| | NKCCGTTCGACGCTTGG | |
| H3F Ref. seq. | TACTACTGCGCTCGTAAAGGTTCTGACCGTCTGTCTGACAACG | 267 |
| | ACCCGTTCGACGCTTGG | |
| H3R | ACCCCAAGCGTCGAACGGMNNMNNGTCMNNANNACGGTCAGA | 190 |
| | MNNTTTACGAGCGCAGTA | |
| H3R Ref. seq. | ACCCCAAGCGTCGAACGGGTCGTTGTCAGACAGACGGTCAGAA | 268 |
| | CCTTTACGAGCGCAGTA | |

Each of the primers used to generate the reference sequence duplexes contained a 5′ sequence of nucleotides corresponding to a restriction endonuclease cleavage site. Four of the primers, R1, F2, R2 and F3, contained the sequence of nucleotides set forth in SEQ ID NO:2 (GCTCTTC), which is the recognition site for the SAP-I restriction endonuclease (within the grey portions in FIG. 16B). This enzyme cuts duplex polynucleotides to leave a 3-nucleotide overhang of any sequence, beginning at one nucleotide in the 3′ direction from this recognition sequence. The restriction endonuclease recognition site is indicated in italics in Table 17 above, while the three-nucleotide overhang in each primer pool is indicated in bold. The oligonucleotides were designed such that the potential three nucleotide overhang of each primer pool was complementary to one of the three nucleotide overhangs generated in the randomized duplexes in Example 8A. The oligonucleotides were designed in this manner to facilitate ligation in a subsequent step.

Primers in the F1 pool contained a sequence of nucleotides corresponding to a Not I restriction endonuclease recognition site. Primers in the R3 pool contained a sequence of nucleotides corresponding to a Sal I restriction endonuclease site (the SalI and NotI restriction sites are within the black portions in FIG. 16). These restriction endonuclease recognition sites facilitated ligation of the assembled duplexes into vectors in subsequent steps.

Further, one forward primer pool (F1), and one reverse primer pool (R3), contained a Region X (depicted in black in FIG. 16: identical in sequence within both primers), a non gene-specific sequence of nucleotides that is identical to the CALX24 primer (SEQ ID NO: 3) at the 5′ ends of the primers. Thus, the reference sequence duplexes 1 and 3, made with these primers/oligonucleotides, contained a sequence of nucleotides including Region X, and also a complementary Region Y. These regions served as templates for the primer CALX24, which was used in the subsequent SPA step, described in Example 8D below.

To form duplexes using these primers, the 3-Ala pCAL G13 vector containing the 3-ALA 2G12 target polynucleotide (SEQ ID NO: 33) described in the previous Examples was used as a template in three separate PCR amplifications. For these reactions, primer pair pools, F1/R1, F2/R2, and F3/R3, were used to amplify duplex pool 1, duplex pool 2, and duplex pool 3. For each reaction, 40 picomoles (pmol) of each primer of each primer, 20 nanograms (ng) of the vector template were incubated in the presence of 2 μL Advantage HF2 Polymerase Mix (Clonetech) and the corresponding 1× reaction buffer, and 1×dNTP in a 100 μL reaction volume. The PCR was carried out using the following reaction conditions: 1 minute denaturation at 95° C. followed by 30 cycles of 5 seconds of denaturation at 95° C., 10 seconds of annealing at 60° C., and 20 seconds of extension at 68° C., then 1 minute incubation at 68° C. The amplified fragments were gel-purified using a Gel Extraction Kit (Qiagen) according to the manufacturer's protocol.

### Example 8B(i)

### Digestion of Reference Sequence Duplexes

As illustrated in FIG. 16C, following the PCR amplification, 1.6-2 μg of each pool of reference sequence duplexes (1, 2 and 3) was digested with Sap I (New England Biolabs, R0569M 250 Units/mL). The digested duplexes then were purified using a PCR purification column (Qiagen). The resulting digested duplexes were 108, 165 and 62 nucleobase pairs in length, respectively.

### Example 8C

### Ligation of Digested Reference Sequence Duplexes and Randomized Duplexes

As illustrated in FIG. 16D, the digested reference sequence duplexes and the randomized duplexes were hybridized and ligated to form intermediate duplexes. This process was carried out as follows. First, H1 and H3 pools were mixed at equimolar ((108 ng of 108 by duplexes, 39 ng of H1, 165 ng of 165 by duplexes, 60 ng of H3, and 62 ng of 62 by duplexes) in T4 DNA ligase buffer and ligated with 10 units of T4 DNA ligase, at room temperature (˜25° C.) overnight.

### Example 8D

Following the formation of the intermediate duplexes, a single primer amplification (SPA) reaction, like the reaction carried out in Example 7 above, was used to generate amplified randomized assembled duplexes. First, for a test scale study, 0.5, 1, 2, and 5 μL of the intermediate duplexes, separately, were mixed with 1.2 μM CALX24 primer used in the previous examples, in the presence of 1 μL Advantage HF2 polymerase mix and the corresponding 1× reaction buffer and 1×dNTP, in a 50 μL reaction volume. Two control reactions, one where no primer was added and one where no intermediate duplexes were added, also were carried out. The PCR amplification conditions were as follows:

1 minute denaturation at 95° C., followed by 30 cycles of 5 seconds of denaturation at 95° C. and 1 minute of annealing and extension at 68° C., then 3 min incubation at 68° C.

The amplified products were analyzed by agarose gel electrophoresis. Imaging of the gel indicated that all SPA reactions had yielded amplified assembled duplexes of the appropriate size. The control samples gave no visible products.

Following the test-scale study, a large-scale amplification was carried out using 50 μL of the intermediate duplexes and 1.2 μM CALX24 primer, in the presence of 50 μL Advantage HF2 Polymerase Mix and the corresponding 1× reaction buffer and 1×dNTP in a 2.5 mL reaction volume, using the same heating/cooling reaction conditions. The resulting collection of amplified assembled duplexes was column purified and gel purified. The assembled duplexes were 434 nucleotides in length. The scaled up process produced 60.8 μg of the assembled duplexes.

The assembled duplexes could have been cut with Sal I and Not I, to form assembled duplex cassettes, which could be inserted into vectors cut with those restriction endonucleases, for example the 3-Ala pCAL G13 vector.

### Example 8E

### Analysis of Nucleotide Usage in Randomized Portions Generated Using mFAL-SPA

To asses the extent and nature of randomization, vector DNA from each of ninety-two (92) representative colonies from the randomized vector transformants was sequenced. For this process, cassette nucleic acida were submitted for sequencing to Eton Biosciences (San Diego, Calif.). Sequencing revealed that 77 of the 92 clones (83.7%) contained no insertions or deletions. The sequences of these 77 clones were further evaluated to determine the codon usage among the positions in the randomized portions of the polynucleotides. 68 (73.9%) of those 77 clones contained no mutations, while 9 contained mutations other than silent mutations. The nucleotide usage within randomized portions in the heavy chain CDR1 and CDR3 regions are listed in Table 18 below. There were 9 amber stop codon sequences (TAG) (in a total of 9 clones; 11.7%).

TABLE 18
Nucleotide Usage in Clones Generated Using mFAL-SPA

| | | | | | |
|---|---|---|---|---|---|
| Nucleotide in | | | | | |
| reference | Nucleotide/Doping | | | | |
| sequence | Strategy | A | C | G | T |

CDR1

| | | | | | |
|---|---|---|---|---|---|
| C | N | 29 | 12 | 19 | 17 |
| A | N | 24 | 16 | 19 | 18 |
| C | T | 0 | 0 | 0 | 77 |
| A | N | 20 | 25 | 14 | 18 |
| C | N | 19 | 23 | 20 | 15 |
| C | K | 0 | 0 | 29 | 48 |

CDR3

| | | | | | |
|---|---|---|---|---|---|
| G | N | 24 | 16 | 13 | 24 |
| G | N | 19 | 17 | 17 | 24 |
| T | K | 0 | 0 | 34 | 43 |
| G | N | 17 | 17 | 17 | 26 |
| C | N | 17 | 16 | 21 | 23 |
| G | T | 0 | 0 | 0 | 77 |
| G | N | 13 | 25 | 16 | 23 |
| C | N | 19 | 25 | 12 | 21 |
| G | K | 0 | 0 | 37 | 40 |
| G | N | 21 | 22 | 16 | 18 |
| C | N | 17 | 25 | 17 | 18 |
| G | K | 0 | 1 | 35 | 41 |
| G | N | 23 | 13 | 15 | 26 |
| A | N | 22 | 16 | 14 | 25 |
| C | K | 0 | 0 | 31 | 46 |
| Totals/Percent | Total at position N | 284 | 268 | 230 | 296 |
| Usage in 77 | Total at position K | 0 | 1 | 166 | 218 |
| clones | Percent usage at | 26 | 25 | 21.3 | 27.5 |
| | position N | | | | |
| | Percent Usage at | 0 | 0.3 | 43.1 | 56.6 |
| | position K | | | | |

As shown in Table 18, sequencing revealed that A, C, G and T were used at 26%, 25%, 21.3% and 27.5%, respectively, where an “N” doping strategy was used, and 0%, 0.3%, 43.1% and 56.6%, respectively, where a “K” doping strategy was used. As noted, 83.7% of the sequences did not contain any deletions/insertions. These results indicate non-biased usage of the various nucleotides at the randomized positions, and that this method can be used to generate diversity in multiple portions in a target polynucleotide in a non-biased manner, in order to generate large collections of variant polynucleotides and polypeptides having saturated diversity at the randomized positions, and with a low error rate at non-randomized/variant positions, minimizing unwanted mutations. In fact, the 83.7% deletion/insertion rate was achieved in this study using desalted primers/oligonucleotides. It is expected that the deletion/insertion rate will improve with purified primers, for example, primers/oligonucleotides that are purified by HPLC.

### Example 9

### Construction of pCAL G13 and pCAL A1 Vectors

This example describes the generation of provided phagemid vectors, pCAL G13 (SEQ ID NO: 7) and pCAL A1 (SEQ ID NO:8), which can be used to produce the provided nucleic acid libraries, and for display of polypeptides, such as domain exchanged antibodies. Both vectors contained a truncated (C-terminal) M13 phage gene III sequence, and thus were suitable for use in production of fusion proteins containing target or variant polypeptide sequence and gene III sequence, in order to express the proteins on the surface of phage in the phage expression library.

As described in further detail in Example 10, below, each of these vectors contained an amber stop codon (TAG), upstream of the gene III sequence, and thus were designed so that the target and/or variant polynucleotide, for example, an antibody-encoding polynucleotide, could be inserted directly upstream of the amber stop codon, so that non-fusion target and/or variant polypeptides and target/variant polypeptides as part of gene III fusion proteins, could be expressed from a single vector, using a partial amber suppressor strain as a host cell.

The pCAL G13 and pCAL G13 A1 vectors contain identical sequences, with the exception that the pCAL A1 vector contains a G-A substitution in the first nucleotide encoding the truncated gene III, compared to the pCAL G13 vector. The pCAL G13 vector is represented schematically in FIG. 6.

### Example 9A

### Assembly of 539 Base-Pair Fragment with lacZ Promoter and Cloning Sites

In order to assemble a 539 base-pair (bp) fragment containing the lacZ promoter and cloning sites of each vector, the oligonucleotides listed in Table 19, below, were designed and ordered from Integrated DNA Technologies (IDT) (Coralville, Iowa). Each oligonucleotide contained a 5′ phosphate group. The oligonucleotides were reconstituted to 100 μM in TE pH 8.0 and further diluted to 20 in TE pH 8.0. 10 μL of each oligonucleotide was mixed with 1.4 μL 5M NaCl in a 141.4 μL volume. The mixture was incubated at 90° C. for 5 min on a dry heat block and slowly cool down to room temperature. The resulting assembled 539 by fragment contained the sequences of the oligonucleotides, and contained Sap I/Spe I restriction endonuclease site overhangs on 5′ and 3′ ends, respectively.

TABLE 19

Oligonucleotides used for the composition of lacZ pro-
moter and cloning sites for light chain and heavy chain.

| | | SEQ ID |
|---|---|---|
| Name | Sequence | NO |
| pCAL_0 | AGCGGAAGAGCGCCCAATACGCAAACCGCCTCTCCCCGC | 191 |
| | GCGTTGGCCGATTCATTAATGCAGCTGGCAC | |
| pCAL_1 | GACAGGTTTCCCGACTGGAAAGCGGGCAGTGAGCGCAAC | 192 |
| | GCAATTAATGTGAGTTAGCTCACTCATTAGGCACCCCAG | |
| | GCTTTAC | |
| pCAL_2 | ACTTTATGCTTCCGGCTCGTATGTTGTGTGGAATTGTGAG | 193 |
| | CGGATAACAATTGAATTAAGGAGGATATAATTATGAAAT | |
| | ACCTGC | |
| pCAL_3 | TGCCGACCGCAGCCGCTGGTCTGCTGCTGCTCGCGGCCC | 194 |
| | AGCCGGCCATGGCCGCCGGTGCCTAACTCTGGCTGGTTTC | |
| | GCTACC | |
| pCAL_4 | GTAACCGGTTTAATTAATAAGGAGGATATAATTATGAAA | 195 |
| | AAGACAGCTATCGCGATTGCAGTGGCACTGGCTGGTTTC | |
| | GCTACCG | |
| pCAL_5 | TAGCCCAGGCGGCCGCACGCGTCTGGTTGAATCTGGTGG | 196 |
| | GGTCTGGAATTCTGCGATCGCGGCCAGGCCGGCCGCACC | |
| | ATCACCA | |
| pCAL_6 | TCACCATGGCGCATACCCGTACGACGTTCCGGACTACGC | 197 |
| | TTCTA | |
| pCAL_7 | CTAGTAGAAGCGTAGTCCGGAACGTCGTACGGGTATGCG | 198 |
| | CCATGGTGATGGTGATGGTGCGGCCGGCCTG | |
| pCAL_8 | GCCGCGATCGCAGAATTCCAGACCCCACCAGATTCAACC | 199 |
| | AGACGCGTGCGGCCGCCTGGGCTACGGTAGCGAAACCAG | |
| | CCAGTGC | |
| pCAL_9 | CACTGCAATCGCGATAGCTGTCTTTTTCATAATTATATCC | 200 |
| | TCCTTATTAATTAAACCGGTTACGGTAGCGAAACCAGCC | |
| | AGAGTT | |
| pCAL_10 | AGGCACCGGCGGCCATGGCCGGCTGGGCCGCGAGCAGC | 201 |
| | AGCAGACCAGCGGCTGCGGTCGGCAGGAGGTATTTCATA | |
| | ATTATATC | |
| pCAL_11 | CTCCTTAATTCAATTGTTATCCGCTCACAATTCCACACAA | 202 |
| | CATACGAGCCGGAAGCATAAAGTGTAAAGCCTGGGGTGC | |
| | CTAATG | |
| pCAL_12 | AGTGAGCTAACTCACATTAATTGCGTTGCGCTCACTGCCC | 203 |
| | GCTTTCCAGTCGGGAAACCTGTCGTGCCAGCTGCATTAAT | |
| | GAATC | |
| pCAL_13 | GGCCAACGCGCGGGGAGAGGCGGTTTGCGTATTGGGCGC | 204 |
| | TCTTCC | |

### Example 9B

### PCR Amplification of Gene III from M13mp18 with SpeIG3-F and PvuINheIG3-R Primers

For the amplification of gene III (G3) (G) (for making the pCAL G13 vector) from M13 phage, a 5′ primer SpeIG3-F (having the sequence set forth in SEQ ID NO: 205 (GGTGGTGGTTCTGGTACTAGTTAGGAGGGTGGTG)) and a 3′ primer, PvuINheIG3-R (having the nucleic acid sequence set forth in SEQ ID NO: 206 (GGGAAGGGCGATCGTTAGCTAGCTTAAGACTCCTTATTACGCAGTATGTT AG), were ordered from IDT, and M13mp18 RF1 DNA was ordered from New England Biolabs (NEB). The M13 mp 18 DNA (100 nanograms (ng)/μL) was diluted in water to a concentration of 10 ng/μL and G3(G) was amplified with the above primers using Advantage HF2 DNA polymerase (Clontech) in the presence of its reaction buffer and dNTP mix in a 100 μL reaction volume. The PCR consisted of a denaturation step at 95° C. for 1 min, 5 cycles of denaturation at 95° C. for 5 seconds and annealing and extension at 72° C. for 1 min, and 30 cycles of denaturation at 95° C. for 5 seconds and annealing and extension at 68° C. for 1 min, followed by the incubation at 68° C. for 3 minutes. The PCR product was run on a 1% agarose gel and purified using Gel Extraction Kit (Qiagen).

To generate G3 (A) (for making the pCAL G13 A1 vector) by introducing the G to A mutation in the first nucleotide encoding truncated gene III, a primer, SpeG3A-F (having the nucleic acid sequence set forth in SEQ ID NO: 207 (GGTGGTGG′TTCTGGTACTAGTTAGAAGGGTGGTG)) was ordered from IDT. Two ng of the G3(G) product that was amplified above was used as a template for amplification of a mutant G3(A) fragment, by amplification with primers SpeG3A-F and PvuINheIG3-R. The amplification was carried out in a PCR, using Advantage HF2 DNA polymerase in the presence of its reaction buffer and dNTP in a 100 μL reaction volume. PCR was performed as above for the amplification of G3(G). The PCR product was run on a 1% agarose gel and purified using a Gel Extraction Kit (Qiagen).

The purified G3 (G) and G3 (A) products then were digested with Spe I and Pvu I restriction endonucleases, using the buffers and conditions recommended by the supplier. The digested products then were purified using PCR purification columns (Qiagen).

pBlueScript II KS(+) vector (Stratagene) then was digested with Sap I and Pvu I and run on a 0.7% agarose gel. Visualization of the gel revealed a 2419 fragment, which was purified using the Gel Extraction Kit.

### Example 9C

### Ligation into Vector and Transformation of Host Cells

Fifty nanograms (ng) of the 2419 by vector fragment, 50 ng of the 539 by lacZ promoter/coning site fragment and 30-40 ng of either G3(G) or G3(A) product (isolated after digestion with Spe I/Pvu I) then were ligated using T4 DNA ligase (NEB) with its reaction buffer at room temperature (20-25° C.) for at least 2 hrs.

For transformation of host cells, 1 μL of each ligation reaction (that for G3 (G) and G3 (A)) was electroporated into 80 μL of TOP10F′ cells (Invitrogen™ Corporation, Carlsbad, Calif.) at 2.5 kV in 0.2 cm gap cuvettes. The cells then were resuspended in 1 mL SOC medium. The cells were incubated at 37° C. for 1 hr; serial dilutions of the transformed bacteria then were made and the samples spread onto LB agar plates supplemented with 100 μg/mL ampicillin. The plates were incubated at 37° C. overnight.

To check insertion of the fragments into the vectors, colonies were picked from the plates and grown in culture plates with 1.2 mL of Super Broth (SB) medium containing 20 mM glucose and 50 μg/mL of ampicillin at 37° C. overnight shaking at 300 rpm. The culture plates then were centrifuged at 3000 rpm for 10 minutes. DNA was purified from the cell pellets using QIAprep 8 Turbo Miniprep Kit (Qiagen, Valencia, Calif.) according to the manufacturer's protocol. Because the vector, as constructed, contained Age I and Nhe I sites, the vector DNA was digested with these restriction endonucleases and run on an agarose gel. Visualization of the gel revealed an appropriately sized 753 by fragment in DNA from some clones, indicating that these clones contained vectors with the G3 insert. These 753 by fragments were isolated from the gel using a gel extraction kit (Qiagen) and sent for sequencing analysis to Eton Bioscience (San Diego, Calif.). Sequencing revealed that these clones contained pCAL G13 G3 and pCAL A1 vectors, containing the 753 by G3 (G) and G3 (A) inserts, respectively.

### Example 10

### Design and Evaluation of Vectors for Phage Display of Domain Exchanged Antibodies and Fragments Thereof

This Example describes provided methods and vectors for display of domain exchanged antibodies. In general, display of domain exchanged antibody fragments was carried out using vectors capable of expressing two distinct heavy chain polypeptides (a heavy chain-gene III fusion polypeptide and a soluble heavy chain polypeptide), where the heavy chain portion of each polypeptide is encoded by a single genetic element, and thus has identical antigen binding specificity. This result was achieved by designing the vector such that an amber stop codon (TAG) was placed between the nucleic acid encoding the heavy chain and the nucleic acid of GeneIII, within a phagemid vector containing a domain-exchange target antibody heavy chain. As described in the sub-sections below, these vectors were transformed into a partial amber-suppressor bacterial host cell strain (supE), thereby allowing expression of transcripts containing mRNA encoding the full heavy chain-GeneIII fusion, and others containing mRNA encoding the heavy chain alone. As described in detail in the subsections below, results from this study revealed that host cells containing these vectors produced phage displaying polypeptides with specificity to the antigen recognized by the target phage display antibody.

### Example 10A

### Design of Vector for Producing GeneIII Fused and Non-Gene III Fused AC8 Antibody Chains

First, to demonstrate that introduction of an amber stop codon between a nucleic acid encoding a antibody target polynucleotide and a nucleic acid encoding a coat protein can yield expression of non-fusion (soluble) and fusion protein heavy chain polypeptides in host cells, the nucleic acid encoding an AC-8 antibody (scFv fragment) and an HA tag (SEQ ID NO: 49), described in Example 1, above and a gIII-encoding gene, that had been introduced into a plasmid, separated by an amber stop codon (TAG), was assessed. Two separate vectors containing a sequence encoding the AC8 antibody were used; one vector, containing an A residue immediately 3′ of the amber stop codon, was generated from the first vector, which contained a G residue immediately 3′ of the stop codon, by PCR mutagenesis, as follows.

An aliquot of a vector containing the Ac8-encoding sequence was obtained from The Scripps Research Institute (La Jolla, Calif.); the plasmid was sequenced through the antibody framework and into the start of gene III. The region of the plasmid encoding the antibody framework through the start of gene III has the nucleic acid sequence set forth in SEQ ID NO: 208.

In order to generate the second vector containing an A residue immediately following the amber stop codon, the QuikChange Site-Directed Mutagenesis Kit (Stratagene, La Jolla Calif.) was used in PCR mutagenesis to replace the G immediately following the amber stop codon with an A, using conditions suggested by the supplier.

Approximately 250 ng of each vector then were used to transform non-amber suppressor, Top10 (Invitrogen™ Corporation, Carlsbad, Calif.) cells, and partial amber-suppressor, XL-1 Blue cells. Individual transformed colonies were grown overnight at 37° C. in 3 mL of LB medium supplemented with 50 μg/mL ampicillin. The cultures were then diluted 10-fold into 3 mL of fresh media and grown at 37° C. to an optical density (OD) of 0.6.

1 mM IPTG then was added to half of the cultures. Duplicate cultures were grown in the absence of IPTG. The cultures then were grown at 30° C. for an additional 4 hours. The cells were collected by centrifugation at 3,000 rpm, for 15 minutes, and resuspended in 25 μL PBS.

The samples then were boiled in SDS loading buffer for 10 min and loaded on a 10% SDS-PAGE gel. Following gel electrophoresis, proteins were transferred to a 0.2 μm nitrocellulose membrane for 1 hr at 10V. The membrane was blocked with 5% non-fat dry milk in PBS containing 0.05% Tween for 1 hr at room temperature. Next, the membrane was incubated overnight at 4° C. with 1:2000 anti-HA-HRP (Roche Applied Science, Indiannapolis, Ind.) in 5% non-fat dry milk in PBS containing 0.05% Tween. After washing the membrane 3 times, for 5 minutes each, with PBS containing 0.05% Tween, an enhanced chemiluminescent substrate (SuperSignal, Thermo Fisher Scientific, Rockford, Ill.) was added and the membrane was imaged. Density analysis was carried out on the images of the membranes, to determine relative intensities of bands corresponding to non-gene III-fused AC8 antibody versus gene III-fused AC8 antibody.

The results indicated that in the non-amber suppressor (Top10) cells, only non-gene III-fused AC8 heavy chain polypeptide was produced. In the partial amber-suppressor (XL-1 Blue) cells, however, bands corresponding to the sizes of the AC8 and the AC8-gene III polypeptides were present. In the cultures that were grown in the presence of 1 mM IPTG, the expression of the AC8-gIII fusion relative to non-fusion AC8 was approximately 1:1, while in the cells that were not treated with IPTG, the ratio was approximately 1:2. These results indicated that the provided methods can be used to express, from a single vector, a non-fusion protein antibody chain and a fusion-protein containing the antibody chain, each antibody chain encoded by a single genetic element.

### Example 10B

### Generation of Vector for Phage Display of 2G12 Domain Exchanged Antibody Fragment

Following verification of the ability to express fusion and non-fusion antibody chains, vectors were produced, using the pCAL G13 and pCAL A1 vectors described in Example 9, above, were designed for use in phage display of Domain Exchanged Fab fragments containing regions of the domain exchanged antibodies, 2G12 and 3-ALA 2G 12, which were randomized using various methods as described in the above Examples. The generation steps described in the following sub-sections resulted in vectors containing nucleic acids encoding a 2G12 light chain fragment (V_{L} and CL), and a 2G12 (or 3-Ala 2G12 mutant) heavy chain fragment (V_{H} and C_{H}1). These antibody-encoding polynucleotides were inserted into the vectors such that they were directly upstream of an amber stop codon (TAG). This design enabled expression of 2G12 (or 3-ALA) heavy chain-gene III fusion polypeptide, and non-fusion 2G12 or 3-ALA heavy chain (V_{H}/C_{H}1) polypeptide, by expression in an amber-suppressor bacterial strain, thus allowing for phage display of domain exchanged Fab fragments.

### Example 10B(i)

### 2G12 pCAL G13 and 3-Ala 2G12 pCAL G13 Vectors

The 2G12 pCAL G13 vector was made by inserting a nucleic acid encoding a light chain domain of the 2G12 antibody (SEQ ID NO: 131) and heavy chain domain of the same antibody (SEQ ID NO: 210) into the pCAL G13 vector (SEQ ID NO: 7), described in Example 9, above. The 2G12 antibody sequence in the vector further contained a sequence of nucleotides (SEQ ID NO: 211: TACCCGTACGACGTTCCGGACTACGCT) encoding an HA tag (SEQ ID NO: 212: YPYDVPDYA). The resulting 2G12 pCAL G13 vector contained the nucleic acid sequence set forth in SEQ ID NO: 11.

The 2G12 heavy and light chains encoded by these nucleic acids contained the sequences of amino acids set forth in SEQ ID NOS: 128 and 129, respectively.

The 3-Ala 2G12 pCAL G13 (3-Ala pCAL G13) vector (SEQ ID NO: 33), which is described in Examples 3-7 above, was identical to the 2G12 pCAL G13 vector, with the exception that the heavy chain domain in the vector contained three Alanine substitutions, which are indicated in bold in the sequence set forth in Example 4, above. The 3-Ala light chain domain was identical to the 2G12 light chain domain set forth in this example.

### Example 10B(ii)

### Construction of the 2G12 pCAL G13, 2G12 pCAL A1, 3-Ala 2G12 pCAL G13 (3-Ala pCAL G13) and 3-Ala pCAL A1 Vectors for Phage Display of Domain Exchanged Antibody Fragments

The 2G12 pCAL G13 vector first was made by the following process. Polynucleotides encoding 2G12 heavy and light chains were amplified from a pET Duet vector, having the nucleic acid sequence set forth in SEQ ID NO: 213 and cloned into the pCAL G13 vector, which is described in Example 9, above. Two primers (pCALVL-F: CCATGGCCGCCGGTGTTGTTATGACCCAGTCTCCGTC (SEQ ID NO: 214); and pCALCK-R: CTCCTTATTAATTAATTAGCATTCACCACGGTTGAAAG (SEQ ID NO: 215)) were used to amplify the light chain fragment and two heavy chain primers (pCALVH-F (SEQ ID NO: 4): GCCCAGGCGGCCGCAGAAGTTCAGCTGGTTGAATCTGGTG; and pCALCH-R: (SEQ ID NO: 216) CTGGCCGCGATCGCAGGCAAGATTTCGGTTCAACTTTCTTG) were used to amplify the heavy chain fragment, using conventional PCR. The products then were digested with SgrA I/Pac I and Not I/AsiS I and cloned into the pCAL G13 vector, described in Example 9, above. An identical process was used to introduce the 2G12 sequence into the pCAL A1 vector (SEQ ID NO: 8), also described in Example 9, above, producing the 2G12 pCAL A1 vector (SEQ ID NO: 217).

To produce the vector (3-Ala pCAL G13) containing the sequence encoding the 3-Ala 2G12 mutant polypeptide, two sets of PCR amplifications were carried out, using the 2G12 pCAL G13 vector as a template. For the first reaction, pCALVH-F primer was used with another reverse primer (3Ala-R: TCGAACGGGTCCGCGTCCGCCGCACGGTCAGAACCTTTAC; SEQ ID NO: 218), and for the second reaction, the pCALCH-R primer was used with another forward primer (3Ala-F: GTTCTGACCGTGCGGCGGACGCGGACCCGTTCGACGCTTG; SEQ ID NO: 219). The products from these two reactions were gel-purified and an overlap PCR was performed with primer A (GCCCAGGCGGCCGCAGAAGTTCAG; SEQ ID NO: 132) and primer E (CCTTTGGTCGACGCCGGAGAAACGGTAACAACGGTACCCGGACCCCAAG CGTCGAACG; SEQ ID NO: 5). The product from the overlap PCR then was gel-purified and digested with Not I/Sal I and cloned back into 2G12 pCAL in the same restriction sites.

### Example 10C

### Amplification of 2G12 Vector Nucleic Acids in Host Cells and Expression of Domain Exchanged Fab Fragment-Gene III Fusion Proteins

In order to express 2G12 Domain Exchanged Fab fragments from the vectors in Example 10B, the vectors were used to transform phage display-compatible, partial amber suppressors, bacterial host cell line (XL1-Blue). 1 μg (2 μL) of vector (e.g. 2G12 pCAL G13; 2G12 pCAL A1; 3-Ala pCAL G13; 3-Ala pCAL A1) DNA was electroporated into 100 μL of electrocompetent XL1-Blue cells (Stratagene) at 1700 kV/0.1 cm (BioRad). The cells were resuspend in 3 mL SOC medium (Invitrogen™ Corporation). The mixture was incubated at 37° C. for 1 hour, with shaking at 250 rpm. 7 mL SB medium (30 g tryptone, 20 g yeast extract, 10 g MOPS in a 1 L volume in distilled water) was added to the culture, along with carbenicillin (at 20 μg/mL) and tetracycline (at 12.5 μg/mL).

To generate colonies, 0.01 μL and 0.001 μL aliquots of the mixture then were spread on LB agar plates, supplemented with 100 μg/mL of carbenicillin and 20 mM of glucose. The vectors generated in Example 9, above (pCAL A1 and pCAL G13), without inserts, also were transformed into the cells, for use as negative controls in subsequent assays. The plates were incubated overnight at 37° C. Number of colonies was determined to evaluate transformation efficiency by multiplying the number of colonies by the culture volume and dividing by the plating volume (same units), using the following equation: [# colonies/plating volume×[culture volume)/microgram DNA]×dilution factor. For cells transformed with 2G12 pCAL A1 vector DNA, the efficiency was 9×10′ (cfu/microgram), for cells transformed with 2G12 pCAL G13, the efficiency was 1.6×10⁸ cfu/microgram, and for cells transformed with pCAL G13 empty vector, the efficiency was 7.1×10⁸ cfu/μg.

### Example 11

### Phage Display of Domain Exchanged Antibody

### Example 11A

### Inducing Production of Phage Expressing 2G12 Fab Fragments

After removal of the aliquots for spreading on agar plates, the remainder of the XL1-Blue cultures were incubated for 1 hour at 37° C., with shaking at 250 rpm, and added to 40 mL SB medium. Prior to the incubation, the concentration of carbenicillin was adjusted to 50 μg/mL and the concentration of tetracycline was adjusted to 12.5 μg/mL.

To induce phage production, 5×10¹¹ pfu of VCS M13 helper phage (Stratagene) then was added to the culture, which then was incubated for 2 hours at 37° C., with shaking at 250 rpm. Kanamycin was added, to a concentration of 70 μg/mL, and isopropyl-beta-D-thiogalactopyranoside (IPTG) (Acros Chemicals) was added, to a concentration of 1 mM, and the culture was incubated overnight at 30° C., with shaking at 250 rpm.

### Example 11B

### Phage Precipitation

The culture then was centrifuged at 4000 rpm for 15 min (4° C.). 32 mL of supernatant then was added to 8 mL of 20% polyethylene glycol 8000 (PEG8000; Sigma Catalog No. P P5413) in 2.5 M NaCl solution, for a final concentration of 4% PEG, 1.5 M NaCl, while inverting, to mix thoroughly. This mixture was incubated on ice for 30 min to precipitate the phage.

To clear the phage, the mixture then was centrifuged at 12000×g for 30 minutes at 4° C. The supernatant was aspirated and the pellet was briefly dried (5 minutes). The precipitated phage then were resuspended in 2 mL phosphate buffered saline (PBS) containing 1% bovine serum albumin (BSA), and transferred to microcentrifuge tubes. The tubes were centrifuged at 14000 rpm for 5 min at 4° C. The resulting cleared phage suspensions were transferred to new microcentrifuge tubes.

### Example 11C

### Antigen Binding of Precipitated Phage

A binding assay was carried out on the cleared phage (phage transformed with 2G12 pCAL G13; 2G12 pCAL A1; empty pCAL G13; and empty pCAL A1), in order to demonstrate that the methods yielded expression of functional 2G12 Fab fragments on the surface of the phage. For this process, 50 microliters of gp120 antigen (Strain JR-FL, Immune Technologies) diluted in PBS pH 7.4, was added to coat individual wells of a 96-well microtiter plate (Corning Costar, Catalog No. 3690, using a 50 microliter volume per well. Some wells were coated with ovalbumin (2 microgram per mL, 100 ng per well), as a control.

In each case, the antigen was coated onto the plate overnight, at 4° C. The coated plate then was washed 5 times with PBS/0.05% Tween20. The plate then was blocked, using 135 microliters per well of 4% nonfat dry milk diluted in PBS, for one hour at 37° C. The block was discarded and the plate dried by tapping on paper towels.

A two-fold serial dilution was carried out by diluting the cleared phage from the previous step (dilutions carried out in 1% BSA in PBS), in order to generate the following dilutions of the phage: non-diluted; 1:2, 1:4, 1:8, 1:16, 1:32, 1:64, 1:128, 50 microliters of each dilution was added to each well of the coated and washed microtiter plate, and incubated at 37° C. for 2 hours, with rocking.

The plate then was washed 5 times with PBS/0.5% Tween-20 (polysorbate 20). To detect phage displaying domain exchanged fragments that had specifically bound to the antigen coated on the plate, two separate enzyme linked immunosorbent assay (ELISA) reaction was carried out, detecting bound phage with either anti-HA antibody or anti-M13 (phage) antibody. For this process, the wells were incubated with 50 μL of HRP-conjugated anti-HA (3F10) (1:1000)(Roche) or rabbit anti-M13 antibody (1:1000) in 1% BSA/PBS at 37° C. for 1 hr. The plates were washed 5 times, with PBS/0.05% Tween 20. The wells that contained anti-HA antibody were developed with 50 μL of TMB substrate kit (Pierce) and stopped with 50 μL of H₂SO₄. The plates were read at 450 nm. The wells that contained rabbit anti-M13 antibody were incubated with 50 μL of HRP-conjugated goat anti-rabbit IgG (H+L) (minimum cross-reactivity with human serum proteins)(Pierce) at 37° C. for 1 hr. The plates were washed 5 times, with PBS/0.05% Tween 20. The wells were developed with 50 μL of TMB substrate kit (Pierce) and stopped with 50 μL of H₂SO₄. The plates were read at 450 nm.

The results indicated that phage precipitated from the cells transformed with the 2G12 pCAL G13 and the 2G12 pCAL A1 vectors specifically bound, in a concentration-dependent manner, to the wells coated with gp120, but not the control wells, coated with ovalbumin. No specific binding was observed with empty vectors (pCAL G13 and pCAL A1), with either antigen. These data confirmed that the provided methods can be used to display a functional fragment of a domain-exchange antibody (2G12) fragment on the surface of phage, and that the provided methods will be useful in phage display of domain-exchange antibody fragments, for example, in phage display libraries.

### Example 12

### Generation of Vector for Increased Stability/Reduced Toxicity: 2G12 pCAL IT* Vector

To reduce the toxicity of the domain exchanged Fab fragments expressed from the vectors, and thereby increase stability of the phagemids displaying the Fab fragments, the 2G12 pCAL IT* vector was generated, in which an additional amber stop codon (TAG) was introduced into each of the leader sequences upstream of the polynucleotides encoding the heavy and light chain fragments (see FIG. 22). This phagemid vector was made by modifying a 2G12 pCAL ITPO vector, which was derived from the 2G12 pCAL vector (as described below).

This vector can be used for repressed expression of the 2G12 Fab fragments in non-supE44 amber suppresser strains (such as, for example, NEB 10-beta cells and TOP10F′ cells), and modest expression in supE44 cells (e.g. XL1-Blue cells), for reduced expression and thus reduced toxicity of domain exchanged Fab fragments in amber-suppressor strains such as XL1-Blue.

### Example 12A

### Generation of the 2G12 pCAL ITPO Vector

The 2G12 pCAL G13 vector (FIG. 21), having a nucleic acid sequence set forth in SEQ ID NO: 11, first was modified by replacement of the 5′-truncated lac I gene with the lac I gene promoter (i) and the entire lac I gene, tHP terminator, and lac promoter/operon gene to create the 2G12 pCAL ITPO vector (FIG. 24), having a nucleic acid sequence set forth in SEQ ID NO: 281.

Briefly, the lac I gene promoter and lac I gene were amplified using 10 ng of pET28a(+) AC8 scFv (SEQ ID NO: 49) as template DNA with 0.4 μM each of a LacITerm-F1 primer (SEQ ID NO: 282) and a LacITerm-R1 primer (SEQ ID NO: 283), 1 μL of Advantage® HF2 Polymerase Mix (Clontech) in 1× reaction buffer and dNTP mix in a 50 μL reaction volume. This amplification reaction was labeled PCR 1a.

The tHP terminator gene was amplified using 0.2 μmol of Term-R oligonucleotide (SEQ ID NO: 284) as a template with 0.4 μM of the LaclTemr-F2 primer (SEQ ID NO: 285) and the TermPO-R primer (SEQ ID NO: 286) in the presence of 1 μL of Advantage® HF2 Polymerase Mix and its reaction buffer and dNTP mix in a 50 μL reaction volume. The amplification reaction was labeled PCR 1b.

The Lac promoter and operon gene was amplified using 10 ng of the 3Ala mutant of 2G12 in the pCAL G13 vector (SEQ ID NO: 33) as a template with 0.4 μM of the TermPO-F primer (SEQ ID NO: 287) and the SgrAIPelB-R primer (SEQ ID NO: 288) in the presence of 1 μL of Advantage® HF2 Polymerase Mix and its reaction buffer and dNTP mix in a 50 μL reaction volume (PCR 1c).

Each of the PCR amplifications (PCR 1a-c) included a denaturation step at 95° C. for 1 min followed by 30 cycles of denaturation at 95° C. for 5 seconds and annealing/extension at 68° C. for 1 min, and finished with incubation at 68° C. for 3 min.

The amplified products from the PCR 1a amplification (1195 base pairs (bp)) and the PCR 1c amplification (219 bp) were run on a 1% agarose gel and purified with a Gel Extraction Kit (Qiagen). The amplified product from the PCR 1b amplification was purified on a PCR purification column.

Two overlap PCR amplifications were then performed to join each of the products from the PCR 1a, b and c reactions. The first overlap amplification was performed by mixing 5 μL of PCR 1a and PCR 1b with 0.4 μM of LacITerm-F1 primer in the presence of 2 μL of Advantage® HF2 Polymerase Mix and its reaction buffer and dNTP mix in a 100 μL reaction volume. The second overlap amplification was performed by mixing 5 μL of PCR 1b and PCR 1c with 0.4 μM of SgrAIPelB-R primer in the presence of 2 μL of Advantage® HF2 Polymerase Mix and its reaction buffer and dNTP mix in a 100 μL reaction volume. Each of these reactions were performed using an initial denaturation step at 95° C. for 1 min, followed by 5 cycles of denaturation at 95° C. for 5 seconds and annealing/extension at 68° C. for 1 min. The two overlap reactions were then mixed in a third reaction with an initial denaturation step at 95° C. for 20 seconds, then 30 cycles of 95° C. for 5 seconds and annealing/extension at 68° C. for 1 min and 20 seconds, followed by a final extension step for 3 min incubation at 68° C.

The resulting amplified product (1443 bp) was run on a 1% agarose gel and purified with Gel Extraction Kit (Qiagen). The purified product was digested with Sap I/SgrA I and purified using PCR purification column. The 2G 12 pCAL vector similarly was digested with Sap I/SgrA Ito release the 5′-truncated lac I gene, and the vector DNA was gel purified using Gel Extraction Kit (Qiagen). The digested amplification product then was ligated into the vector DNA using T4 DNA ligase (Invitrogen) to produce the 2G12 pCAL ITPO vector (FIG. 24 and SEQ ID NO: 281) and transformed in XL1-Blue cells. Plasmid DNA was prepared by first inoculating colonies from the titration plates into 1.2 mL SuperBroth medium containing 50 μg/mL carbenicillin and 20 mM glucose. The culture plate was incubated overnight at 37° C. (shaken at 300 rpm). The DNA sequence of the resulting 2G12 pCAL ITPO vector (SEQ ID NO:281) was confirmed using the following primers: SeqCALTerm-F (SEQ ID NO:289), SeqpCALTerm-R (SEQ ID NO: 290), SeqpCALIT-R (SEQ ID NO: 291) and SeqITP0-F2 (SEQ ID NO: 292).

### Example 12B

### Generation of the 2G12 pCAL IT* Vector

To generate the 2G12 pCAL IT* vector, the 2G12 pCAL ITPO vector was modified by introducing amber stop codons (TAG) at the 3′ end of the Pel B and Omp A bacterial leader sequences. The TAG amber stop codons were introduced to replace the wild-type CAG codon for glutamine.

Two PCR amplifications were performed using 10 ng 2G12 pCAL IPTO (SEQ ID NO: 281) as a template DNA, with either 400 nM of Kas I-F and AmbPe1B-R primers (SEQ ID NOS: 292 and 293, respectively) or 400 nM of AmbPelB-F and AmbOmpA-R primers (SEQ ID NOS: 295 and 296, respectively), in the presence of 1 μL of Advantage® HF2 Polymerase Mix and its reaction buffer and dNTP mix in a 50 μL reaction volume. The PCR reactions were performed with an initial denaturation step at 95° C. for 1 min, followed by 30 cycles of denaturation at 95° C. for 5 seconds, annealing at 64° C. for 10 seconds, and extension at 68° C. for 1 min, followed by a final incubation at 68° C. for 3 min. The resulting amplified products (360 by and 777 bp, respectively) were run on a 1% agarose gel and purified with Gel Extraction Kit (Qiagen).

An overlap PCR amplification was performed using 4 μL of the gel-purified PCR fragments as template, with 400 nM of Kas I-F and AmbOmpA-R primers, in the presence of 4 μL of Advantage® HF2 Polymerase Mix, Advantage® HF2 reaction buffer, and dNTP mix, in a 200 μL reaction volume. The PCR reaction was performed with an initial denaturation step at 95° C. for 1 min, followed by 30 cycles of denaturation at 95° C. for 5 seconds and annealing/extension at 68° C. for 1 min, followed by a final incubation at 68° C. for 3 min. The resulting 1106 by amplified product was run on a 1% agarose gel and purified with Gel Extraction Kit (Qiagen).

Both the 2G12 pCAL ITPO vector and the purified PCR product were digested with Kas I/Not I. The vector DNA was run on a 0.7% agarose gel and the 4809 by fragment was purified with Gel Extraction Kit (Qiagen). The digested 1084 by PCR fragment was purified on a PCR purification column. The vector DNA and PCR product were ligated using 100 ng of vector DNA and 56 ng of PCR fragment with 1 μL of T4 DNA ligase (Invitrogen) and its reaction buffer in a 20 μL reaction volume at room temperature (˜25° C.) for 2 hrs or more. The ligated DNA was transformed into XL1-Blue cells (Stratagene) and spread onto LB agar plates with 100 μg/mL of carbenicillin and 20 mM glucose. 16 colonies from the plates were used to inoculate cultures of 1.2 mL SuperBroth medium containing 50 μg/mL carbenicillin and 20 mM glucose. The cultures were then incubated overnight at 37° C. (shaken at 300 rpm).

Plasmid DNA was purified using miniprep DNA columns (Qiagen) and DNA sequence of the resulting 2G12 pCAL IT* vector (FIG. 22) was confirmed using the following primers: SeqHCFR1-R (SEQ ID NO: 297), SeqpCAL-F (SEQ ID NO: 298), SeITPO-F2 (SEQ ID NO:292), and SeqITPO-F4 (SEQ ID NO: 299).

### Example 13

### Antigen-Specific Selection of Phage Displaying Domain Exchanged Antibody

Panning studies were carried out to demonstrate that the provided methods for phage display of domain exchanged antibodies can be used to select antigen-specific domain exchanged antibody fragments. In these studies, the gp120 antigen was used to select from among mixtures of phage-displayed domain exchanged antibodies described in the examples above. Two such studies were performed. In the first study, described in Example 13A, varying concentrations of a vector encoding the domain exchanged Fab fragment specific for the gp120 antigen (2G12 pCAL G13 (SEQ ID NO: 11), described above) were spiked into a quantity of vector encoding a non-antigen specific domain exchanged Fab fragment (3-ALA pCAL G13 (SEQ ID NO: 33), described above), and the mixtures used to transform cells for phage display and selection by multiple rounds of panning, to assess enrichment for the antigen-specific domain exchanged antibody fragment. In the second study, a nucleic acid library containing variant 2G12-encoding nucleic acids (using the mFAL-SPA method described and provided herein) was generated; then amounts of vector encoding native 2G12 antibody was spiked in to the library to generate a nucleic acid library mixture, which was subject to similar panning assays. The studies and results are described below.

### Example 13A

### Spiking Study with 2G12 and 3-ALA Vectors

### Example 13A(i)

### Transformation of Partial Amber Suppressor Host Cells with Vectors Encoding Domain Exchanged Fab Antibody Fragments

First, 1 microgram each of various phage display vector samples was used to transform host cells. One of the samples contained the 2G12 pCAL G13 vector alone (2G12 alone). Another contained the 3-ALA 2G12 pCAL G12 vector alone (3-ALA alone). Other samples contained mixtures of vectors, which were generated by adding (spiking in) 2G12 pCAL G13 vector to a sample containing 3-ALA pCAL G13 vector at four different dilutions, as follows: 10⁻³, 10⁴, 10⁻⁵ and 10⁻⁶ micrograms of the 2G12 pCAL G13 were spiked, separately, into 1 microgram of 3-ALA pCAL G13 vector. 1 microgram of each diluted vector sample (2G12 alone, 3-ALA alone and each “spiked in” mixture) then was used to transform XL1-Blue MRF E. coli cells (Stratagene, La Jolla, Calif.) by electroporation. Cells then were incubated for one hour at 37° C., with shaking at 250 rpm, and the cultures supplemented with 50 μg/mL carbenicillin and 10 μg/mL tetracycline. The cells in culture then were infected with 10¹² VCSM13 helper phage (Stratagene) for an additional 4 hours, at 30° C.

### Example 13A(ii)

### Phage Precipitation

To precipitate phage particles, cells from each of the cultures described in Example 13A(i) were centrifuged at 4000 rpm for 30 minutes, and 32 mL of the supernatant mixed with 8 mL of a 2.5 M sodium chloride (NaCl) solution containing 20% polyethylyne glycol (Sigma #P5413-500 g), for a final concentration of 4% PEG and 1.5 M NaCl. Each sample then was inverted ten times and incubated on ice for thirty minutes. The resulting samples, which contained precipitated phage, then were centrifuged at 13,000 rpm for twenty minutes at 4° C. The pellet containing the precipitated phage then was resuspended in 1 mL PBS containing 1% bovine serum albumin (BSA) and centrifuged at 13,500 rpm at 25° C., for 5 minutes. The supernatant of the 2G12 alone and 3-ALA alone samples were used in studies to assess display as described in Example 13A(iii); the mixtures were used in panning (repeated selection and enrichment based on binding to antigen) as described in Example 13D.

### Example 13A(iii)

### Assessing Display and Specificity of Antibodies Following Transformation with 2G12 and 3-Ala Vectors

Prior to panning (see Example 13A(iv), below), an ELISA-based assay was used to analyze and verify expression and display of domain exchanged antibody produced by cells transformed with the 2G12 vector alone and the 3-ALA vector alone. For this assay, precipitated phage recovered after each vector transformation was captured onto wells of a microtiter plate that previously had been coated overnight at 4° C., with 100 ng/well (in PBS) of either gp120 JR-FL (Immune Technology Corp, New York, N.Y.) (gp120 capture) or anti-human F(ab′)₂ MinX antibody (Goat Anti-Human IgG, F(ab′)₂ fragment specific (min X Bov, Hrs, Ms Sr Prot) catalog number: 109 006 097) (anti-human capture) or chicken albumin (Sigma-Aldrich) (control). For this process, eleven two-fold dilutions (1/2; 1/4; 1/8; 1/16; 1/32; 1/64; 1/128; 1/256; 1/512; 1/1024; 1/2048) of the precipitated phage were made. Each dilution was added to a coated and blocked well on the plates. The capture (binding of phage to antibody) was carried out for 2 hours at 37° C., with gentle rocking.

To remove unbound phage, the supernatant from each well was discarded and plates were washed with 150 microliters of PBS containing 0.05% Tween 20 (polysorbate 20). After washing, the presence of bound phage was detected using either 1:5000 anti-M13-p8 HRP (GE) (which bound the phage coat protein p8) or 1:1000 anti-HA (GE) (which bound the HA tag on the displayed antibody). The wells were developed with 50 μL of TMB substrate kit (Pierce) and stopped with 50 μL of H₂SO₄, according to conditions suggested by the supplier. Absorbance was read at 450 nm (A450). The results for the gp120 capture and anti-human capture are set forth in Table 19a (gp120 capture) and Table 19b (anti-human antibody capture), below. The column labeled “Input phage [cfu per well]” lists the corresponding cfu for each dilution of the respective precipitated phage.

TABLE 19a
ELISA data - plates coated with gp120; anti-M13 secondary

| Dilution of | 2G12 | | 3-ALA 1 | |
|---|---|---|---|---|
| precipitated | Input phage | | Input phage | |
| phage | [cfu per well] | A450 | [cfu per well] | A450 |
| ½ | 1.43E+11 | 1.576 | 1E+11 | 0.1555 |
| ¼ | 7.13E+10 | 1.1465 | 5.00E+10 | 0.102 |
| ⅛ | 3.56E+10 | 0.85 | 2.50E+10 | 0.0715 |
| 1/16 | 1.78E+10 | 0.405 | 1.25E+10 | −0.0065 |
| 1/32 | 8.91E+09 | 0.199 | 6.25E+09 | −0.016 |
| 1/64 | 4.45E+09 | 0.0435 | 3.13E+09 | −0.037 |
| 1/128 | 2.23E+09 | 0.016 | 1.56E+09 | −0.03 |
| 1/256 | 1.11E+09 | −0.0095 | 7.81E+08 | −0.0235 |
| 1/512 | 5.57E+08 | −0.023 | 3.91E+08 | −0.0385 |
| 1/1024 | 2.78E+08 | −0.034 | 1.95E+08 | −0.038 |
| 1/2048 | 1.39E+08 | −0.039 | 9.77E+07 | −0.0415 |

TABLE 19b
ELISA data - plates coated with gp120; anti-M13 secondary

| Dilution of | 2G12 | | 3-ALA 1 | |
|---|---|---|---|---|
| precipitated | Input phage | | Input phage | |
| phage | [cfu per well] | A450 | [cfu per well] | A450 |
| ½ | 1.43E+11 | 1.3985 | 1E+11 | 1.441 |
| ¼ | 7.13E+10 | 1.387 | 5.00E+10 | 1.4 |
| ⅛ | 3.56E+10 | 1.311 | 2.50E+10 | 1.3765 |
| 1/16 | 1.78E+10 | 1.1885 | 1.25E+10 | 1.211 |
| 1/32 | 8.91E+09 | 1.08 | 6.25E+09 | 1.0895 |
| 1/64 | 4.45E+09 | 0.869 | 3.13E+09 | 0.8285 |
| 1/128 | 2.23E+09 | 0.65 | 1.56E+09 | 0.591 |
| 1/256 | 1.11E+09 | 0.3995 | 7.81E+08 | 0.369 |
| 1/512 | 5.57E+08 | 0.24 | 3.91E+08 | 0.227 |
| 1/1024 | 2.78E+08 | 0.1265 | 1.95E+08 | 0.1385 |
| 1/2048 | 1.39E+08 | 0.0665 | 9.77E+07 | 0.0745 |

As evidenced by absorbance values listed in Tables 19a and 19b, the phage generated by transformation with the 2G12 vector and the phage generated by transformation with the 3-ALA vector exhibited a phage concentration-dependent binding in the anti-human capture study (where phage were incubated on wells coated with the anti-human antibody and detected with the anti-M13-HRP secondary). In contrast, however, only the phage generated by 2G12 vector transformation (and not that generated by the 3-ALA vector transformation) displayed specific binding to gp120 antigen in the gp120 capture study. Neither sample displayed any specific binding to the wells coated with albumin alone (not shown). These results indicated that the provided methods can be used for phage display and antigen-specific selection of domain exchanged antibodies.

### Example 13A(iv)

### Panning, Elution and Amplification

For panning (selection and enrichment based on ability to bind gp120 antigen), 50 microliters of phage solutions from samples generated in Example 13A(ii) were added to individual wells of a microtiter plate that had previously been coated with 1 microgram (per well) of gp120 antigen (Immune Technology Corp, New York, N.Y.) overnight at 4° C. The phage was incubated on the plate by incubation at 37° C. for 2 hours with gentle rocking. To remove unbound phage, the supernatant from each well was discarded and plates were washed with 150 microliters of PBS containing 0.05% Tween 20 (polysorbate 20). To elute phage that had bound to the antigen, 100 microliters of 0.1 M HCL (pH 2.2) was added to each well for 10 minutes. The solution (eluate) was removed from the wells by vigorous pipetting and transferred to a 1 mL Eppendorf tube containing 10 uL of 2M Tris-base (pH 9.0). This elution step was repeated and the resulting eluates containing the selected phage were pooled.

For amplification of the selected phage, 220 microliters of the pooled eluate was incubated with 10 mL XL-1 Blue cells (having an O.D. between 0.3 and 0.6) for 20 minutes at room temperature (approximately 25° C.). The bacteria then were transferred to a 100 mL bottle containing 45 mL YT medium (5 g Bacto-yeast extract, 8 g Bacto-tryptone, 2.5 g NaCl, in dH₂O, total volume of 1 L), 20 mM glucose, 10 microgram/mL tetracycline and 20 microgram/mL carbenicillin, and incubated at 37° C., with shaking at 250 rpm. After 1 hour of incubation, the medium was supplemented with additional carbenicillin (for a final concentration of 50 micrograms/mL) and the cells incubated at 37° C. until the O.D. of the culture reached 0.3-0.6.

Following amplification, an iterative process was performed, whereby amplified phage from the cultures was isolated by precipitation, as described in the previous section, above, and used for a subsequent round of panning as described in this section above. With the samples generated from the mixtures containing spiked-in vectors, the iterative process was repeated for a total of three rounds of panning, to select for phage displaying antibody fragments that specifically bind to the gp120 antigen. Enrichment was analyzed as described in Example 13A(v), below.

### Example 13A(v)

### Assessing Enrichment for Antigen-Specificity Following Transformation with Mixed (2G12/3-Ala) Vector Samples and Multiple Rounds of Panning

Enrichment of phage for those displaying antigen specific domain exchanged Fab was assessed following the third round of panning (Example 13A(iii), above) for the samples where the 2G12 vector had been spiked into the 3-Ala vector samples at dilutions of 10⁻³, 10⁻⁴, and 10⁻⁵. For this process, XL1-Blue MRF cells were infected with the output (eluate) phage from the third panning round, and plated on agar plates supplemented with 100 μg/mL carbenicillin and 20 mM glucose. Individual colonies then were picked and used to inoculate 1 mL of SB medium containing 20 mM glucose, 50 μg/mL carbenicillin and 10 μg/mL tetracycline, in a 96 well plate.

The cultures then were incubated for sixteen hours at 37° C., with shaking at 300 rpm. 200 microliters from each well then were used to inoculate 1 mL fresh medium containing 1 mM IPTG and 50 μg/mL carbenicillin. After incubation for 4 hours at 30° C. with shaking at 300 rpm the cells were lysed by freeze-thawing the plates two times in a dry ice/ethanol bath and then centrifuged at 4000 rpm for 30 minutes, at 4° C., to produce a cleared lysate.

The ELISA-based assay described in Example 13A(iv), above, then was used to detect the presence of total antibody (Goat anti Human Fab MinX capture) and gp120-specific antibody (gp120 JR-FL capture). For this process, specific antibody that remained bound to the microtiter plates was detected using Goat Anti Human FabMin labeled with horse radish peroxidase (HRP) (Pierce, #31414) and a substrate, followed by reading of absorbance as described above.

Results indicated that the cumulative enrichment rates over three rounds for the 10⁻³, 10⁻⁴, and 10⁻⁵ dilutions were 583×, 1,875× and 2,083×, respectively. The “spiked” 2G12 antibody was not detected in the sample from the 1 to 10⁻⁶ dilution. These results indicated that the provided methods can be used to display domain exchanged antibodies on phage and to produce, select, and enrich for domain exchanged antibodies and fragments thereof in an antigen-specific manner. The vectors for phage display of domain exchanged antibodies can be used with the provided methods (e.g. as target polynucleotides) to generate collections of variant, for example, randomized, domain exchanged antibody polypeptides and to select variant antibodies from the collections, for example, based on ability to bind a particular antigen.

### Example 13B

### Generation of Nucleic Acid Libraries, and Panning from Library Mixtures Containing Spiked-In Antigen-Specific Antibody-Encoding Nucleic Acids

This Example describes generation of a phage display library for panning by spiking in vector encoding 2G12 (antigen specific) to a nucleic acid library containing vectors with randomized 2G12 sequences, produced according to the provided methods for generating diversity.

### Example 13B(i)

### Generation of a Nucleic Acid Library for Display of a Collection of Domain Exchanged Fab Fragments

To generate phage display libraries for selection of phage displayed domain exchanged antibodies, a nucleic acid library was generated by randomizing nucleotides encoding seven amino acids in the CDR 1 and CDR 3 regions of the 2G12 heavy chain. For this process, modified Fragment Assembly and Ligation/Single Primer Amplification (mFAL-SPA), was used to generate a collection of duplex cassettes containing randomized nucleic acids, with randomized positions within the 2G12 heavy chain-encoding nucleic acid. As described in subsections of this example, below, for vectors described in Example 9 (2G12 pCAL; SEQ ID NO: 11) and Example 12 (2G12 pCAL IT*; SEQ ID NO: 280), nucleic acids encoding the wild-type 2G12 heavy chains were replaced with this collection of randomized cassettes, generating a nucleic acid library based on each vector. These libraries were used in “spike-in” experiments described in Examples below.

### Example 13B(i)(a)

### Randomization of CDRs 1 and 3 by Modified Fragment Assembly and Ligation/Single Primer Amplification (mFAL-SPA)

Modified Fragment Assembly and Ligation (mFAL-SPA), as described herein, was used to generate nucleic acid libraries that could be used to make display libraries containing variant polypeptides with diversity in portions of the CDR1 and CDR3 of the heavy chain variable region of a 2G12 domain exchanged Fab target polypeptide. The 2G12 domain exchanged fab target polypeptide, which was randomized to create this diversity, contained a heavy chain having the amino acid sequence set forth in SEQ ID NO: 128 and a light chain having the amino acid sequence set forth in SEQ ID NO.: 129.

As illustrated schematically in FIG. 16, the mFAL-SPA process was used to diversify 7 amino acid positions in the 2G12 Fab by randomization of the 2G12 Heavy Chain CDR1 and CDR3, as follows.

Generating Pools of Randomized Duplexes

Four pools of randomized oligonucleotides (H₁F, H1R, H₃F, and H3R) were designed and generated for use in forming two pools of randomized duplexes (H1 and H3; illustrated in FIG. 13A). The sequences of these randomized oligonucleotides are set forth in Table 19C, below. Each oligonucleotide in each of these randomized pools was synthesized based on a reference sequence (which contained part of the native 2G12 heavy chain nucleotide sequence), but contained randomized portions, represented in bold type in Table 19C and as hatched boxes in FIG. 16. These randomized portions were synthesized using the NNK or NNT doping strategy. An NNK doping strategy minimizes the frequency of stop codons and ensures that each amino acid position encoded by a codon in the randomized portion could be occupied by any of the 20 amino acids. With this doping strategy, nucleotides were incorporated using an NKK pattern and a MNN pattern, during synthesis of the positive and negative strand randomized portions respectively, where N represents any nucleotide, K represents T or G and M represents A or C. An NNT strategy eliminates stop codons and the frequency of each amino acid is less biased but omits Q, E, K, M, and W.

The reference sequence used to design each pool of randomized oligonucleotides is listed in Table 19C, below the sequence of the randomized oligonucleotide. The randomized portions also contained variant positions, where the nucleotide at the variant position was mutated compared to the reference sequence portion. These positions also are indicated in bold and are part of the randomized portions.

The randomized oligonucleotides were designed such that each oligonucleotide in each of the pools contained a region complementary to an oligonucleotide in another pool. Oligonucleotides in pool H₁F were complementary to oligonucleotides in pool H1R, and oligonucleotides in pool H3F were complementary to oligonucleotides in pool H3R. The oligonucleotides in each pool further were designed, whereby, following hybridization of the pairs of oligonucleotides through these complementary regions, three nucleotide 5′-end overhangs would be generated, to facilitate ligation in subsequent steps (for example, see FIG. 16A). The nucleotides that would become the overhangs are indicated in italics in Table 19C. The nucleotides in the randomized pools were labeled with 5′ phosphate groups.

In order to form the H1 duplex, 50 μL H1F (at 100 μM), 50 μL H1R (100 μM) and 1 μL NaCl were mixed, denatured at 95 C for 5 minutes, followed by slow cooling to 25° C. on a heat block covered with a Styrofoam® box. Similarly, to form the H3 duplex, 50 μL H3F (at 100 μM), 50 μL H1R (100 μM) and 1 μL NaCl were mixed, denatured at 95° C. for 5 minutes, followed by slow cooling to 25° C. on a heat block covered with a Styrofoam® box.

TABLE 19 C

| | | SEQ ID |
|---|---|---|
| Name | Sequence | NO: |
| F1 | GCCGCTGTGCCATCGCTCAGTAACgcggccgcagaa | 6 |
| | gttcagctg | |
| R1 | GGCGGCGCTGTTCagttagaaacaccgcaagacaggatc | 182 |
| F2 | GGCGGCGCTCTTCtcgtgttccgggtggtggtctg | 183 |
| R2 | GGCGGCGCTCTTCagtagatagcggtgtcttcaacac | 184 |
| F3 | GGCGGCGCTCTTCgggtccgggtaccgttgttac | 185 |
| R3 | GCCGCTGTGCCATCGCTCAGTAACgtcgacgccgga | 186 |
| | gaaacggt | |
| H1F | AACTTCCGTATCTCTGCTNNTNNKATGAACTG | 187 |
| | GGTTCGT | |
| Reference | AACTTCCGTATCTCTGCTCACACCATGAACTG | 265 |
| sequence | GGTTCGT | |
| used to | | |
| design H1F | | |
| H1R | ACGACGAACCCAGTTCATMNNANNAGCAGAG | 188 |
| | ATACGGAA | |
| Reference | ACGACGAACCCAGTTCATGGTGTGAGCAGAG | 266 |
| sequence | ATACGGAA | |
| used to | | |
| design H1R | | |
| H3F | TACTACTGCGCTCGTAAANNKTCTGACCGTNN | 189 |
| | TNNKGACNNKNNKCCGTTCGACGCTTGG | |
| Reference | TACTACTGCGCTCGTAAAGGTTCTGACCGTCT | 267 |
| sequence | GTCTGACAACGACCCGTTCGACGCTTGG | |
| used to | | |
| design H3F | | |
| H3R | ACCCCAAGCGTCGAACGGMNNMNNGTCMNN | 190 |
| | ANNACGGTCAGAMNNTTTACGAGCGCAGTA | |
| Reference | ACCCCAAGCGTCGAACGGGTCGTTGTCAGAC | 268 |
| sequence | AGACGGTCAGAACCTTTACGAGCGCAGTA | |
| used to | | |
| design H3R | | |

Generation of Reference Sequence Duplexes

PCR amplification was carried out to generate three reference sequence duplexes (1, 2, and 3, as illustrated in FIG. 16B). Duplexes in pool I were 125 nucleotides in length, duplexes in pool 2 were 196 nucleotides in length and duplexes in pool 3 were 76 nucleotides in length. For this process, three pools of forward oligonucleotide primers (F1, F2, F3) and three pools of reverse oligonucleotide primers (R1, R2, R3) were synthesized using the methods provided herein. The sequences of the primers in each pool are set forth in Table 19C, above.

Each of the primers used to generate the reference sequence duplexes contained a 5′ sequence of nucleotides corresponding to a restriction endonuclease cleavage site. Four of the primers, R1, F2, R2 and F3, contained the sequence of nucleotides set forth in SEQ ID NO: 2 (GCTCTTC), which is the recognition site for the Sap I restriction endonuclease (within the grey portions in FIG. 16B). This enzyme cuts duplex polynucleotides to leave a 3-nucleotide overhang of any sequence at its 5′ end, beginning at one nucleotide in the 3′ direction from this recognition sequence. The restriction endonuclease recognition site is indicated in italics in Table 19C, above, while the three-nucleotide overhang in each primer pool is indicated in bold. The oligonucleotides were designed such that the potential three nucleotide overhang of each primer pool was complementary to one of the three nucleotide overhangs generated in the randomized duplexes. The oligonucleotides were designed in this manner to facilitate ligation in a subsequent step.

Primers in the F1 pool contained a sequence of nucleotides corresponding to a Not I restriction endonuclease recognition site. Primers in the R3 pool contained a sequence of nucleotides corresponding to a Sal I restriction endonuclease site (the Sal I and Not I restriction sites are within the black portions in FIG. 16). These restriction endonuclease recognition sites facilitated ligation of the assembled duplexes into vectors in subsequent steps.

Further, one forward primer pool (F1), and one reverse primer pool (R3), contained a Region X (depicted in black in FIG. 16: identical in sequence within both primers), a non gene-specific sequence of nucleotides that is identical to the CALX24 primer (SEQ ID NO: 3) at the 5′ ends of the primers. Thus, the reference sequence duplexes 1 and 3, made with these primers/oligonucleotides, contained a sequence of nucleotides including Region X, and also a complementary Region Y. These regions served as templates for the primer CALX24, which was used in the subsequent single primer amplification (SPA) step, described below.

To form duplexes using these primers, the 2G12 pCAL vector containing the 2G12 target polynucleotide (SEQ ID NO: 33) was used as a template in three separate PCR amplifications. For these reactions, primer pair pools, F1/R1, F2/R2, and F3/R3, were used to amplify duplex pool 1, duplex pool 2, and duplex pool 3. For each reaction, 40 picomoles (pmol) of each primer of each primer, 20 nanograms (ng) of the vector template were incubated in the presence of 2 μL Advantage HF2 Polymerase Mix (Clonetech) and the corresponding 1× reaction buffer, and 1×dNTP in a 100 μL reaction volume. The PCR was carried out using the following reaction conditions: 1 minute denaturation at 95° C. followed by 30 cycles of 5 seconds of denaturation at 95° C., 10 seconds of annealing at 60° C., and 20 seconds of extension at 68° C., then 1 minute incubation at 68° C. The amplified fragments were gel-purified using a Gel Extraction Kit (Qiagen).

After amplification by PCR, 1.6-2 μg of each pool of reference sequence duplexes (1, 2 and 3) was digested, as illustrated in FIG. 13C, with 250 Units/mL Sap I (New England Biolabs, R0569M 10,000 Units/mL). The digested duplexes then were purified using a PCR purification column (Qiagen). The resulting digested duplexes were 108, 165 and 62 nucleobase pairs in length, respectively.

Ligation of Digested Reference Sequence Duplexes and Randomized Duplexes to Form Intermediate Duplexes

As illustrated in FIG. 16D, the digested reference sequence duplexes and the randomized duplexes were hybridized and ligated to form intermediate duplexes. This process was carried out as follows. First, H1 and H3 pools were mixed at equimolar ((108 ng of 108 by duplexes, 39 ng of H1, 165 ng of 165 by duplexes, 60 ng of H3, and 62 ng of 62 by duplexes) in T4 DNA ligase buffer and ligated with 10 units of T4 DNA ligase, at room temperature (˜25° C.) overnight.

Formation of Duplex Cassettes

Following the formation of the intermediate duplexes, a single primer amplification (SPA) reaction was used to generate amplified randomized assembled duplexes. Amplification was carried out using 50 μL of the intermediate duplexes and 1.2 μM CALX24 primer, in the presence of 50 μL Advantage HF2 Polymerase Mix and the corresponding 1× reaction buffer and 1×dNTP in a 2.5 mL reaction volume, using the same heating/cooling reaction conditions. The resulting collection of amplified assembled duplexes was column purified and gel purified. The assembled duplexes were 434 nucleotides in length. This process produced 60.8 μg of the assembled duplexes. The assembled duplexes were then digested with Sal I and Not I, to form assembled duplex cassettes, which could be ligated into vectors to form nucleic acid libraries.

### Example 13B(i)(b)

### Formation of 2G12 Nucleic Acid Libraries

Both the 2G12 pCAL IT* vector (SEQ ID NO: 280) and the 2G12 pCAL vector (SEQ ID NO: 11) were digested with Sal I and Not I. The DNA was run on a 0.7% agarose gel. The linearized pCAL IT* and pCAL vectors (without the original wild-type 2G12 insertions) were then purified using the Gel Extraction Kit (Qiagen). Each vector was ligated with the assembled duplex cassettes described above, to generate two libraries, each containing randomized 2G12 Fab encoding nucleic acid members. The two libraries contained the nucleic acids in the pCAL IT* vector and the pCAL vector, respectively.

### Example 13B(ii)

### Generation of Domain Exchanged Phage Display Libraries and Selection of Antigen-Specific Domain Exchanged Antibodies from the Libraries

The two nucleic acid libraries generated as described in Example 13B(i), above (the randomized 2G12 domain exchanged Fab-encoding nucleic acids in the pCAL IT* vectors (“the pCAL IT* library”) and the randomized 2G12 domain exchanged Fab-encoding nucleic acids in the pCAL vectors (“the pCAL library”) were used in spike-in experiments to demonstrate that phage display libraries generated using the provided vectors and methods could be used to select antigen-specific domain exchanged antibodies.

### Example 13B(ii)(a)

### Generation of Vector Mixture Libraries

Four distinct vector library mixtures were generated by adding (“spiking in”), separately, to 1 μg of “the pCAL library,” 10⁻³, 10⁻⁴, 10⁻⁶ and 10⁻⁸ μg of non-randomized 2G12 pCAL vector DNA. The resulting mixtures were labeled 2G12 pCAL 10⁻³; 2G12 pCAL 10⁻⁴; 2G12 pCAL 10⁻⁶; and 2G12 pCAL 10⁻⁸, respectively. Similarly, four distinct vector mixtures were generated by adding (“spiking in”), separately, to 1 μg of “the pCAL IT* library,” 10⁻³, 10⁻⁴, 10⁻⁶ and 10⁻⁸ μg of non-randomized 2G12 pCAL IT* vector DNA. The resulting mixtures were labeled 2G12 pCAL IT* 10⁻³; 2G12 pCAL IT* 10⁻⁴; 2G12 pCAL IT* 10⁻⁶; and 2G12 pCAL IT* 10⁻⁸, respectively.

Additionally, a control mixture was generated, by adding (“spiking in”), separately, to 1 μg of “the pCAL library,” 10⁻³, 10⁻⁴, 10⁻⁶ and 10⁻⁸ μg of anti-HSV antibody (AC8)-encoding vector DNA (described in Example 10A, herein; vector containing the nucleic acid having the nucleotide sequence set forth in SEQ ID NO: 208). The resulting mixtures were labeled AC-8 pCAL 10⁻³; AC-8 pCAL 10⁻⁴; AC-8 pCAL 10⁻⁶; and AC-8 pCAL 10⁻⁸, respectively.

### Example 13B(ii)(b)

### Phage Display and Selection

As follows, each of the mixtures (libraries) were used to transform partial amber-suppressor XL1-Blue MRF′ cells for the first round of selection. Phage display was then induced and the phage were precipitated and selected by capturing with biotinylated antigen (gp120 for the 2G12 pCAL IT* and the 2G12 pCAL libraries, or HSV-1 gD for the AC-8 libraries) and incubation with streptavidin-coated magnetic beads. After washing of the beads, the bound phage were eluted. These phage were used to infect XL1-Blue MRF′ cells and the phagemid vector DNA was isolated for use in transforming XL1-Blue MRF′ cells to begin the next round of selection. This iterative process was continued for a total of 5 rounds to enrich for phage reactive with gp120 or HSV-1 gD. Following each round of selection, the phage were analyzed, such as by ELISA and determination of phage titers, to assess the stability and enrichment of reactive phage generated from either the pCAL IT* or pCAL vectors.

### Example 13(B)(ii)(b)(1)

### Transformation of E. coli

Each of the twelve nucleic acid libraries (2G12 pCAL IT* 10⁻³, 10⁻⁴, 10⁻⁶ or 10⁻⁸; 2G12 pCAL 10⁻³, 10⁻⁴, 10⁻⁶ or 10⁻⁸; AC8 pCAL 10⁻³, 10⁻⁴, 10⁻⁶ or 10⁻⁸) were individually transformed into XL1-Blue MRF′ cells (Stratagene). The following selection protocol was then used for each library. Briefly, frozen electrocompetent XL1-Blue MRF′ cells were thawed on ice before 1 μg of the pre-chilled DNA library was added to 100 μL cells in a pre-chilled electroporation cuvette. Following electroporation, 1000 μL of prewarmed 37° C. SOC media was added to resuspend and quench the cells. The cells were then transferred to a sterile 50 mL conical polypropylene tube. The SOC flush process was repeated two more times, resulting in a final volume of approximately 3 mL. A 10 μL aliquot was removed to calculate the electroporation efficiency, described in Example 13(B)(ii)(c)(i) below. To the remaining cell suspension, 2YT medium was added to a final volume of 10 mL, and sterile glucose was added to a final concentration of 20 mM. The tubes were incubated for 1 hour at 37° C. on a shaker at 250 rpm. Following incubation, the cells were transferred to a 100 mL bottle and 2YT media was added to a final volume of 50 mL. Tetracycline [10 μg/mL final concentration], carbenicillin [50 μg/mL final concentration] and glucose (20 mM final concentration) also were added. The cells were then incubated for 2 hours at 37° C. on a shaker at 250 rpm, before being centrifuged at room temperature for 25 minutes at 4000 rpm to obtain a cell pellet.

### Example 13(B)(ii)(b)(2)

### Phagemid Expression

To induce phagemid expression, the cell pellet was resuspended in 2YT medium (containing 10 μg/mL tetracycline and 50 μg/mL carbenicillin) to a final volume of 30 mL per μg DNA electroporated). For cells containing the pCAL IT* vector, IPTG also was added to the medium to a final concentration of 1 mM. The cells were incubated at 30° C. for 1 hour, shaking at 250 rpm before VCSM13 helper phage was added at a multiplicity of infection (MOI) of 60:1. The cells were incubated at 30° C. for 8 hours, shaking at 300 rpm, before the temperature was lowered to 4° C. for incubation at 200 rpm until use.

### Example 13(B)(ii)(b)(3)

### Phage Precipitation

The cell culture was centrifuged for 30 minutes at 4000 rpm and 32 mL of the supernatant was transferred to a 50 mL centrifuge tube (Nalgene), to which 8 mL of 20% PEG, in 2.5 M NaCl, was added. The tube was then inverted 10 times and incubated on ice for 30 minutes., before the cells were centrifuged at 13,000 rpm for 30 minutes at 4° C. The supernatant was removed and the tube was inverted on a paper towel for 5-10 minutes to remove any excess media. The phage pellet was then resuspended in 2 mL PBS and aliquoted and transferred to sterile microcentrifuge tubes (Eppendorf). The tubes were centrifuged at 13,500 rpm for 5 minutes at 25° C. and the supernatant was transferred to a sterile microcentrifuge tube.

### Example 13(B)(ii)(b)(1)(4)

### Phage Capture

To 1.5 mL phage in a microfuge tube, Tween 20 was added to a final concentration of 0.05%. The appropriate biotinylated antigen also was added to a final concentration of 41.6 nM. For the 2G12 pCAL and 2G12 pCAL IT* libraries, biotinylated gp120 (Strain JR-FL, Immune Technology Corp) was used as the capture antigen. Biotinylated HSV-1 gD (Vybion) was used as the capture Ag for the AC-8 pCAL libraries. The phage were then incubated for 2 hours at 37° C., rocking.

To prepare the magnetic beads for capture of the antigen-bound phage, 200 μL Dynabeads® M-280 Stretavidin (Invitrogen) in an microcentrifuge tube were washed 3 times by first applying the tube to the DynaMag2 magnet particle concentrator for 2 minutes to collect the beads at the bottom of the tube, removing the supernatant then washing the beads with 1 mL PBS by repeatedly pipetting. This process was repeated two more times for a total of 3 washes. The beads were then blocked by the addition of 2 ml blocking solution (3% bovine serum albumin (BSA) diluted in PBS) and incubating for 2 hours at 37° C. The beads were again concentrated using a DynaMag™-2 magnet and washed with 200 μL it PBS.

To capture the antigen-bound phage, 200 μL of the washed beads were added to 1 mL of the phage/biotinylated antigen mix and the resulting mixture was incubated for 30 minutes at 37° C., rocking. To remove any unbound phage, the beads were washed with PBS/0.05% Tween 20 by concentrating the beads using the DynaMag2 magnet particle concentrator for 2 minutes and removing the supernatant, then washing the beads with 1 mL PBS/0.05% Tween 20. This process was repeated twice for a total of 3 washes. The supernatant was then removed.

### Example 13(B)(ii)(b)(5)

### Phage Elution

To elute the phage from the bead pellet, 150 μL 0.1 M HCl (pH 2.2) was added to the beads and the beads were incubated for 10 minutes at room temperature. The tube was vortexed repeatedly and pipetted to ensure maximal elution of the phage. The beads were removed using the magnet and the supernatant containing the eluted phage was transferred to a sterile microcentrifuge tube. The phage were then neutralized by the addition of 15 μL 2 M Tris base (pH 9) per 150 μL phage eluate. To the microcentrifuge tube containing the phage, 150 μL 0.1 M HCl (pH 2.2) was added and the tube was incubated for 5 minutes at room temperature before the phage were neutralized by the addition of 15 μL 2 M Tris base (pH 9) per 150 μL phage eluate.

### Example 13(B)(ii)(b)(6)

### Infection of E. coli XL1-Blue MRF′ Cells

Chemically competent XL1-Blue MRF′ cells were streaked onto a Luria Broth (LB) agar plate containing 10 μg/mL tetracycline and incubated overnight at 37° C. Colonies were scraped off the plate and inoculated into 5 mL SB medium (30 g/L Bacto tryptone (Fisher), 20 g/L yeast extract (Fisher), 10 g/L MOPS (Fisher), pH: 7.0) containing 10 μg/mL tetracycline, and the culture was incubated at 37° C., 250 rpm until the OD 600 reached 1.0-2.0. The OD 600 was then adjusted to between 0.6 and 1.0 and 2.5 mL XL1-Blue MRF′ cells were infected with eluted phage (approximately 330 μL phage. The cells were incubated at room temperature for 30 minutes.

The infected XL1-Blue cells (2.5 mL) were then transferred to a bioassay tray (Corning) containing LB agar, 100 μg/mL carbenicillin and 100 mM glucose. The cells were spread evenly using a steril spreader and the tray was incubated at room temperature for 30 minutes. The tray was then inverted and placed in a 37° C. incubator for 12 hours.

### Example 13(B)(ii)(b)(7)

### DNA Purification

The cells were scraped from the plate and DNA was purified from the cells using a Qiafilter Midiprep Kit (Qiagen). Briefly, 25 mL 2YT media was spread onto the tray and the cells were gently scraped off and removed by pipetting. The cells were then centrifuged for 15 minutes at 5000-8000 rpm and the pellet was resuspended in 4 mL Buffer P1 of the Qiafilter Midiprep Kit (Qiagen). Buffer P2 (4 mL) was added and the solution was mixed by inversion before the lysis reaction was incubated for 5 minutes at room temperature. Precipitation was facilitated by adding 4 mL chilled Buffer P3. The lysate was then transferred to the barrel of the Qiafilter cartridge and incubated for 10 minutes at room temperature.

A Qiagen-tip 100 was equilibrated by applying 4 mL of Buffer QBT and allowing the column to empty by gravity flow. The cap from the Qiafilter Midi Cartridge outlet nozzle was removed and the plunger was inserted into the Qiafilter Midi Cartridge and the cell lysate was filtered into the previously equilibrated Qiagen-tip. The Qiagen-tip 100 was washed by applying 2×10 mL of Buffer QC before the DNA was eluted with 5 mL Buffer QF. The DNA was then precipitated by adding 3.5 mL (equivalent to 0.7 volumes) of room temperature isopropanol to the eluted DNA. The solution was mixed and centrifuged immediately at >15,000×g for 30 minutes at 4° C. The supernatant was decanted and the DNA pellet was washed with 2 mL room temperature 70% ethanol and again centrifuged at >15,000×g for 10 minutes at 4° C. The DNA pellet was air dried for 5-10 minutes and dissolved in TE buffer, pH 8.0, or mM Tris-Cl, pH 8.5 to achieve a concentration of ≧125 ng/μL.

### Example 13(B)(ii)(b)(8)

### Repetition of the Process for Rounds 2-5

The nucleic acid library DNA isolated in Example 13(B)(ii)(b)(7), above, was then used to transform XL1-Blue MRF′ cells and the process described in 13(B)(ii)(b)(1) through 13(B)(ii)(b)(7), was repeated for a second round of screening. Following isolation of DNA, the process was again repeated until a total of 5 rounds of screening were performed. During each screening, the washing conditions for washing the phage-bound beads (13(B)(ii)(b)(4)) were adjusted to increase stringency. Table 19D sets forth the wash conditions used in each round.

TABLE 19D
Phage-bound bead wash conditions

| | No. of | |
|---|---|---|
| Round | washes | Description |
| 1 | 3 | Gentle washing steps: |
| | | Washing procedure is completed quickly and without |
| | | pipetting up and down vigorously. |
| 2 | 5 | Gentle washing steps: |
| | | Washing procedure is completed quickly and without |
| | | pipetting up and down vigorously. |
| 3 | 10 | Stringent washing steps: |
| | | Washing procedure is completed slowly and |
| | | pipetting is performed vigorously |
| 4-5 | 10 | Stringent washing steps: |
| | | Washing procedure is completed slowly and |
| | | pipetting is performed vigorously. Incubate |
| | | phage and biotinylated antigen in PBS/Tween wash for |
| | | 5 minute intervals, rocking at room temperature in |
| | | between each wash step. |

### Example 13(B)(ii)(c)

### Analysis of Enrichment Using the Phage Libraries

The stability of the vectors and the enrichment of phage displaying antigen-specific 2G12 Fabs was assessed throughout the 5 round selection process described above. The various parameters analyzed included electroporation efficiencies (of the electroporations described in 13(B)(ii)(b)(1), input and output phagemid titers (i.e. before and after the phage capture described in 13(B)(ii)(b)(4)), and antigen-reactivity.

### Example 13(B)(ii)(c)(1)

### Transformation Efficiencies

To determine the transformation efficiencies, a 10 μL it aliquot of cells taken following electroporation (described in Example 13(B)(ii)(b)(1), above), was used to prepare serial 10-fold dilutions. Into a 96-well plate, 90 μL SOC was added to the wells and the 10 μL cell aliquot was added to the first well. Serial 10-fold dilution were then prepared, resulting in 10⁻¹, 10⁻², 10⁻³, 10⁻⁴, 10⁻⁵ and 10⁻⁶ dilutions. Seventy-five μL of the 10⁻³, 10⁻⁴, 10⁻⁵ and 10⁻⁶ dilutions were plated onto LB agar plates containing 100 μg/mL carbenicillin. The liquid was spread and the plate was allowed to dry before being inverted and placed in a 37° C. incubator overnight.

The number of transformants from the electroporation of cells with the nucleic acid libraries was calculated by multiplying the number of colonies on the plate by the culture volume and dividing by the plating volume, as set forth in the following equation:

[number of colonies/plating volume (μL)]×[culture volume (μL)/μg DNA]×dilution factor.

As demonstrated in Table 19E, each electroporation resulted in over 10⁸ colonies per μg electroporated DNA.

TABLE 19E
Transformation efficiency using each nucleic acid library

| | Titer (cfu/μg) | | | | |
|---|---|---|---|---|---|
| Library | Round 1 | Round 2 | Round 3 | Round 4 | Round 5 |
| AC8 pCAL [10⁻³] | 2.64 × 10⁸ | 1.20 × 10⁹ | 1.92 × 10⁸ | ND | ND |
| AC8 pCAL [10⁻⁴] | 5.12 × 10⁸ | 2.50 × 10⁹ | 3.80 × 10⁸ | 1.00 × 10⁸ | ND |
| AC8 pCAL [10⁻⁶] | 8.96 × 10⁸ | 1.40 × 10⁹ | 2.20 × 10⁸ | 2.52 × 10⁸ | 3.70 × 10⁸ |
| AC8 pCAL [10⁻⁸] | 4.04 × 10⁸ | 3.00 × 10⁹ | 3.08 × 10⁸ | 2.44 × 10⁸ | 3.04 × 10⁸ |
| 2G12 pCAL [10⁻³] | 2.76 × 10⁸ | 1.60 × 10⁹ | 3.92 × 10⁸ | 1.32 × 10⁸ | ND |
| 2G12 pCAL [10⁻⁴] | 4.96 × 10⁸ | 1.40 × 10⁹ | 2.72 × 10⁸ | 1.28 × 10⁸ | ND |
| 2G12 pCAL [10⁻⁶] | 6.12 × 10⁸ | 1.30 × 10⁹ | 2.92 × 10⁸ | 6.80E+07 | 3.60 × 10⁸ |
| 2G12 pCAL [10⁻⁸] | 9.28 × 10⁸ | 2.40 × 10⁹ | 3.84 × 10⁸ | 1.00 × 10⁸ | 4.50 × 10⁸ |
| 2G12 pCAL IT* [10⁻³] | 1.12 × 10⁸ | 1.30 × 10⁹ | 2.24 × 10⁸ | ND | ND |
| 2G12 pCAL IT* [10⁻⁴] | 1.92 × 10⁸ | 9.60 × 10⁸ | 3.00 × 10⁸ | 6.40 × 10⁷ | ND |
| 2G12 pCAL IT* [10⁻⁶] | 3.32 × 10⁸ | 1.20 × 10⁹ | 1.60 × 10⁸ | 4.44 × 10⁸ | 3.06 × 10⁸ |
| 2G12 pCAL IT* [10⁻⁸] | 3.64 × 10⁸ | 1.10 × 10⁹ | 7.40 × 10⁸ | 1.60 × 10⁸ | 3.68 × 10⁸ |

In addition to calculating the transformation efficiency, the input phagemid DNA (i.e. the phagemid DNA used for electroporation) at each round was digested with Pac I enzyme (New England Biolabs) to linearize the vector, and the vector was run on an agarose gel to visualize the abundance and quality of the DNA. Non-digested supercoiled DNA also was run on a gel. All of the phagemid vector DNA samples were observed to have the expected size with no degradation products.

### Example 13(B)(ii)(c)(2)

### Phagemid Titers

The titers of the phagemids before (input phage) and after (output phage) capture also were determined by titration and the percentage enrichment calculated. To determine the titer of input phage, 10 μL of input phage (obtained following precipitation and resuspension in PBS, see Example 13B(ii)(b))(3), was added to 90 μL SOC and then diluted in series of 10-fold dilutions in SOC. One μL of each dilution was then added to 99 μL of XL1-Blue MRF′ cells and the phage was allowed to infect the cells for 15 minutes at room temperature, before 20 μL of the infected cells was plated onto LB agar plates containing 100 μg/mL carbenicillin. The plates were incubated overnight at 37° C. to obtain single colonies, which were then calculated to the phage titer (cfu/mL).

To determine the titer of the output phage, 10 μL of the XL1-Blue cells that had been infected with the eluted phage (see Example Example 13B(ii)(b)(6) was added to 90 μL SOC and then diluted in series of 10-fold dilutions in SOC. Seventy-five μL of the diluted cells were then plated onto LB agar plates containing 100 μg/mL carbenicillin. The plates were allowed to dry for 15 minutes before being incubated overnight at 37° C. to obtain single colonies, which were then calculated to the phage titer (cfu/mL).

Table 19F sets forth the input and output phage titers and the % enrichment.

TABLE 19F
Phagemid titers before and after capture

| | Phagemid titer (cfu/mL) | | |
|---|---|---|---|
| Library | Input | Output | Enrichment (%) |

Round 1

| | | | |
|---|---|---|---|
| AC8 pCAL [10⁻³] | 1.60E+12 | 3.16E+06 | 0.000198 |
| AC8 pCAL [10⁻⁴] | 2.00E+12 | 1.74E+06 | 0.000087 |
| AC8 pCAL [10⁻⁶] | 7.60E+11 | 1.80E+06 | 0.000237 |
| AC8 pCAL [10⁻⁸] | 4.16E+11 | 2.40E+06 | 0.000577 |
| 2G12 pCAL [10⁻³] | 4.96E+11 | 5.70E+06 | 0.001149 |
| 2G12 pCAL [10⁻⁴] | 3.20E+12 | 1.00E+07 | 0.000313 |
| 2G12 pCAL [10⁻⁶] | 4.00E+11 | 8.10E+06 | 0.002025 |
| 2G12 pCAL [10⁻⁸] | 2.80E+12 | 3.60E+06 | 0.000129 |
| 2G12 pCAL IT* [10⁻³] | 6.80E+11 | 3.09E+06 | 0.00045 |
| 2G12 pCAL IT* [10⁻⁴] | 1.28E+12 | 3.00E+06 | 0.00023 |
| 2G12 pCAL IT* [10⁻⁶] | 3.24E+12 | 8.25E+06 | 0.00026 |
| 2G12 pCAL IT* [10⁻⁸] | 1.20E+12 | 4.80E+06 | 0.0004 |

Round 2

| | | | |
|---|---|---|---|
| AC8 pCAL [10⁻³] | 2.80E+13 | 5.40E+07 | 0.000193 |
| AC8 pCAL [10⁻⁴] | 2.00E+13 | 2.30E+07 | 0.000115 |
| AC8 pCAL [10⁻⁶] | 2.80E+13 | 3.50E+06 | 0.000013 |
| AC8 pCAL [10⁻⁸] | 2.00E+13 | 6.20E+06 | 0.000031 |
| 2G12 pCAL [10⁻³] | 8.80E+12 | 5.20E+06 | 0.000059 |
| 2G12 pCAL [10⁻⁴] | 1.40E+13 | 2.40E+07 | 0.000171 |
| 2G12 pCAL [10⁻⁶] | 1.70E+13 | 1.04E+07 | 0.000061 |
| 2G12 pCAL [10⁻⁸] | 9.20E+12 | 2.14E+07 | 0.000233 |
| 2G12 pCAL IT* [10⁻³] | 2.10E+13 | 8.80E+06 | 0.000042 |
| 2G12 pCAL IT* [10⁻⁴] | 1.10E+13 | 5.64E+07 | 0.000513 |
| 2G12 pCAL IT* [10⁻⁶] | 2.90E+13 | 1.65E+07 | 0.000057 |
| 2G12 pCAL IT* [10⁻⁸] | 1.50E+13 | 3.22E+07 | 0.000215 |

Round 3

| | | | |
|---|---|---|---|
| AC8 pCAL [10⁻³] | 6.80E+13 | ND | ND |
| AC8 pCAL [10⁻⁴] | 2.80E+13 | 1.00E+06 | 0.000004 |
| AC8 pCAL [10⁻⁶] | 3.60E+13 | 2.30E+06 | 0.000006 |
| AC8 pCAL [10⁻⁸] | 6.40E+13 | 3.20E+06 | 0.000005 |
| 2G12 pCAL [10⁻³] | 2.80E+13 | 2.80E+06 | 0.00001 |
| 2G12 pCAL [10⁻⁴] | 6.40E+11 | 5.40E+06 | 0.000844 |
| 2G12 pCAL [10⁻⁶] | 5.60E+12 | 7.00E+06 | 0.000125 |
| 2G12 pCAL [10⁻⁸] | 3.20E+13 | 7.73E+06 | 0.000024 |
| 2G12 pCAL IT* [10⁻³] | 6.40E+13 | ND | ND |
| 2G12 pCAL IT* [10⁻⁴] | 4.00E+13 | 9.00E+06 | 0.000023 |
| 2G12 pCAL IT* [10⁻⁶] | 6.80E+13 | 2.60E+06 | 0.000004 |
| 2G12 pCAL IT* [10⁻⁸] | 2.40E+13 | 6.20E+06 | 0.000026 |

Round 4

| | | | |
|---|---|---|---|
| AC8 pCAL [10⁻³] | ND | ND | ND |
| AC8 pCAL [10⁻⁴] | 4.00E+12 | 1.45E+07 | 0.000363 |
| AC8 pCAL [10⁻⁶] | 3.60E+12 | 5.20E+06 | 0.000144 |
| AC8 pCAL [10⁻⁸] | 5.20E+12 | 2.70E+06 | 0.000052 |
| 2G12 pCAL [10⁻³] | ND | 3.60E+06 | ND |
| 2G12 pCAL [10⁻⁴] | 6.00E+12 | 2.60E+06 | 0.000043 |
| 2G12 pCAL [10⁻⁶] | 3.60E+12 | 2.69E+06 | 0.000075 |
| 2G12 pCAL [10⁻⁸] | 5.60E+12 | 3.70E+06 | 0.000066 |
| 2G12 pCAL IT* [10⁻³] | ND | ND | ND |
| 2G12 pCAL IT* [10⁻⁴] | 3.20E+12 | 7.40E+06 | 0.000231 |
| 2G12 pCAL IT* [10⁻⁶] | 4.40E+12 | 4.60E+06 | 0.000105 |
| 2G12 pCAL IT* [10⁻⁸] | 2.80E+12 | 3.70E+06 | 0.000132 |

Round 5

| | | | |
|---|---|---|---|
| AC8 pCAL [10⁻³] | ND | ND | ND |
| AC8 pCAL [10⁻⁴] | ND | ND | ND |
| AC8 pCAL [10⁻⁶] | 1.08E+13 | 9.20E+06 | 0.000085 |
| AC8 pCAL [10⁻⁸] | 4.40E+12 | 2.30E+07 | 0.000523 |
| 2G12 pCAL [10⁻³] | ND | ND | ND |
| 2G12 pCAL [10⁻⁴] | ND | ND | ND |
| 2G12 pCAL [10⁻⁶] | 1.24E+13 | 8.30E+05 | 0.000007 |
| 2G12 pCAL [10⁻⁸] | 8.00E+12 | 1.70E+06 | 0.000021 |
| 2G12 pCAL IT* [10⁻³] | ND | ND | ND |
| 2G12 pCAL IT* [10⁻⁴] | ND | ND | ND |
| 2G12 pCAL IT* [10⁻⁶] | 1.08E+13 | ND | ND |
| 2G12 pCAL IT* [10⁻⁸] | 4.80+12 | 1.80E+06 | 0.000038 |

ND = not done

### Example 13(B)(ii)(c)(3)

### ELISA Analysis of Fabs Displayed by Selected Phage

The stability and enrichment of gp120-specific Fabs displayed on phage from the various libraries was assessed by ELISA. Two ELISAs were performed, one to assess the reactivity of the phage on a polyclonal level, and the other to assess the reactivity of the phage on a monoclonal level. In the first assay (polyclonal), ELISAs were performed using an aliquot of the precipitated input phage obtained in Example 7B(iii). In the second assay (monoclonal), ELISAs were performed using cells lysates from individual colonies of XL1-Blue MRF′ cells that had been infected with the eluted phage. Reactivity of the displayed Fabs was tested against two different antigens to assess specificity: gp120 (Strain JR-FL, Immune Technologies), and HSV-1 gD (Vybion, Inc.). Goat anti-human IgG F(ab′)₂ fragment-specific antibodies (Jackson ImmunoResearch Laboratories, Inc) were used as a capture “antigen” to assess stability of the selected Fabs.

Polyclonal ELISA Analysis

To determine the reactivity of the phage on a polyclonal level, eluted phage from each round of selection were assayed by ELISA for reactivity with gp120 (Strain JR-FL, Immune Technologies), HSV-1 gD (Vybion, Inc.) and goat anti-human IgG F(ab′)₂ fragment specific antibodies (Jackson ImmunoResearch Laboratories, Inc). Ninety-six well ELISA plates were coated with antigen (gp120, HSV-1 gD or anti-human Fab) at 100 ng/50 μL (diluted in PBS)/well at 4° C. overnight. Following coating, the plates were washed twice with PBS/0.05% Tween 20 and then blocked with 4% non-fat dry milk in PBS at 37° C. for 2 hours. The plates were again washed twice with PBS/0.05% Tween 20. To each well, 50 μL of 1×10⁶, 1×10⁷, 1×10⁸, 1×10⁹, 1×10¹⁰, 1×10″, 1×10¹², or 1×10¹³ cfu/well phage was added. The ELISA assay plate was incubated for a further 2 hours at 37° C. and the plates were washed 5 times with PBS/0.05% Tween 20 before 50 μL of ImmunoPure Goat Anti-Human IgG [F(ab′)2], Peroxidase Conjugated (Pierce:diluted 1:1000) was added to each well of the plates originally coated with HSV-gD or gp120, and anti-M13 HRP Conjugated (GE:diluted 1:5000) was added to each well of the plates originally coated with goat anti-human Fab. Following incubation for 1 hour at room temperature, the plate was washed 5 times with PBS/0.05% Tween 20 and 50 μL of TMB substrate (Pierce; prepared according to manufacturer's instructions) was added to each well and the plate was then incubated until a blue color developed. The reaction was stopped with the addition of 50 μL 1M H₂SO₄ and the optical density (O.D. 450 nm) of each well was determined.

It was observed that phage selected from the 2G12 pCAL IT* libraries had slightly increased reactivity with anti-human Fab antibodies compared to the phage selected from 2G12 pCAL libraries, indicating the expression from the pCAL IT* vectors increased stability of the Fabs. In addition, enrichment of gp120 reactive phage also was increased using the 2G12 pCAL IT* libraries compared to the 2G12 pCAL libraries, as indicated by higher OD values in ELISAs for these phage using gp120 as the capture antigen.

Monoclonal ELISA Analysis

To determine the reactivity of the phage on a monoclonal level, an aliquot of the XL1-Blue MRF′ cells that were infected with the eluted phage after each round of selection (see Example 13B(ii)(b)(6)) were first diluted and plated onto LB agar plates containing 100 μg/mL carbenicillin and incubated overnight at 37° C. to obtain single colonies. Individual colonies were then inoculated into a 96 deep well (1 mL volume) plate containing SB media containing 20 mM Glucose, 50 μg/mL carbenicillin and 10 μg/mL tetracycline. This parental plate was incubated for 16 hours at 37° C., shaking at 300 rpm. From each well of the parental plate, 200 μL of cell culture was inoculated into corresponding wells of a daughter plate that contained 1 mL/well SB media containing 20 mM glucose, 50 μg/mL carbenicillin and 10 μg/mL tetracycline. The parental plate was centrifuged at 3500 rpm for 30 minutes to pellet the cells and the pellets were stored at −20° C.

IPTG was added to each well of the daughter plate to a final volume of 1 mM. The daughter plate was incubated for 8 hours at 37° C., shaking at 300 rpm. The daughter plate was then frozen in a dry ice/ethanol bath and thawed to lyse the cells, before the lysate was cleared by centrifugation at 3500 rpm for 15 minutes. The supernatant was then extracted for analysis by ELISA.

Ninety-six well ELISA plates were coated with antigen at 100 ng/50 μL (diluted in PBS)/well at 4° C. overnight. Reactivity of the phage isolated from each colony was tested against two different antigens: gp120 (Strain JR-FL, Immune Technologies), HSV-1 gD (Vybion, Inc.). Goat anti-human IgG F(ab′)₂ fragment specific antibodies (Jackson ImmunoResearch Laboratories, Inc) also were used as a capture “antigen.” Following coating, the plates were washed twice with PBS/0.05% Tween 20 and then blocked with 135 μL/well 4% % non-fat dry milk in PBS at 37° C. for 2 hours. The plates were again washed twice with PBS/0.05% Tween 20. To each well, 50 μL of the bacterial cell lysate supernatant containing the phage was added, at a 1:2 dilution in PBS/0.05% Tween 20, to the ELISA assay plate and the plate was incubated for a further 2 hours at 37° C. The plate was washed 5 times with PBS/0.05% Tween 20 before 50 μL of ImmunoPure Goat Anti-Human IgG [F(ab′)2], Peroxidase Conjugated (Pierce:diluted 1:1000) was added to each well. Following incubation for 1 hour at room temperature, the plate was washed 5 times with PBS/0.05% Tween 20 and 50 μL of TMB substrate (Pierce; prepared according to manufacturers instructions) was added to each well and the plate was then incubated until a blue color developed. The reaction was stopped with the addition of 50 μL 1M H₂SO₄ and the optical density (O.D. 450 nm) of each well was determined. An OD 450 nm of greater than 0.5 indicated that the phage in that well (which were derived from a single colony) displayed Fabs that exhibited a positive reactivity for gp120. Tables 19G-19I set forth the percentage of phage that displayed Fabs that bound gp120, anti-human Fab and HSV-1 gD, respectively after each round of selection.

It was observed that there was increased stability and enrichment of phage displaying 2G12 Fabs from phage display libraries generated using the 2G12 pCAL IT* phagemid vector libraries compared to those generated using the 2G12 pCAL phagemid vector libraries. For example, after the 4^{th} round of selection, 31% of phage generated from the 2G12 pCAL IT* [10⁻⁴] phagemid vector library reacted with gp120, compared to only 9% from the 2G12 pCAL [10⁻³] phagemid vector library (see Table 19G). Further, the Fabs displayed on the phage from the 2G12 pCAL IT*libraries were recognized by the anti-human IgG [F(ab′)2] capture antibody at higher frequencies than the Fabs displayed on the phage from the 2G12 pCAL libraries. In particular, reactivity of Fabs displayed by phage from the 2G12 pCAL libraries with the anti-human IgG [F(ab′)2] capture antibody decreased as the selection rounds proceeded, indicating that the phagemids and/or Fabs were less stable than those from the 2G12 pCAL IT*libraries, which maintained high reactivity throughout the selection process (Table 19H).

TABLE 19G
Evaluation of gp120 antigen specific Fabs displayed by phage that
were selected after each round of capture

| | Number and percentage of gp120-specific phage | | | | | | | | | |
|---|---|---|---|---|---|---|---|---|---|---|
| | following each round of selection | | | | | | | | | |
| | Round 1 | | Round 2 | | Round 3 | | Round 4 | | Round 5 | |
| AC8 pCAL | ND | ND | 0/22 | 0% | ND | ND | ND | ND | ND | ND |
| [10⁻³] | | | | | | | | | | |
| AC8 pCAL | ND | ND | 0/22 | 0% | 0/22 | 0% | 0/44 | 0% | ND | ND |
| [10⁻⁴] | | | | | | | | | | |
| AC8 pCAL | ND | ND | 0/22 | 0% | 0/33 | 0% | 0/44 | 0% | 0/44 | 0% |
| [10⁻⁶] | | | | | | | | | | |
| AC8 pCAL | ND | ND | 0/22 | 0% | 0/33 | 0% | 0/88 | 0% | 0/44 | 0% |
| [10⁻⁸] | | | | | | | | | | |
| 2G12 pCAL | ND | ND | 0/22 | 0% | 0/22 | 0% | 2/22 | 9% | ND | ND |
| [10⁻³] | | | | | | | | | | |
| 2G12 pCAL | ND | ND | 0/22 | 0% | 0/22 | 0% | 0/22 | 0% | ND | ND |
| [10⁻⁴] | | | | | | | | | | |
| 2G12 pCAL | ND | ND | 0/22 | 0% | 0/22 | 0% | 0/22 | 0% | ND | ND |
| [10⁻⁶] | | | | | | | | | | |
| 2G12 pCAL | ND | ND | 0/22 | 0% | 0/22 | 0% | 0/22 | 0% | ND | ND |
| [10⁻⁸] | | | | | | | | | | |
| 2G12 pCAL | ND | ND | ND | ND | ND | ND | ND | ND | ND | ND |
| IT* [10⁻³] | | | | | | | | | | |
| 2G12 pCAL | ND | ND | 0/44 | 0% | 10/176 | 6% | 41/132 | 31% | ND | ND |
| IT* [10⁻⁴] | | | | | | | | | | |
| 2G12 pCAL | ND | ND | 0/44 | 0% | 0/44 | 0% | 0/44 | 0% | ND | ND |
| IT* [10⁻⁶] | | | | | | | | | | |
| 2G12 pCAL | ND | ND | 0/44 | 0% | 0/44 | 0% | 0/44 | 0% | 14/176 | 8% |
| IT* [10⁻⁸] | | | | | | | | | | |

TABLE 19H
Evaluation of reactivity of Fabs displayed by phage that were
selected after each round of capture with anti-human Fab.

| | Number and percentage of phage that reacted with anti-human Fab | | | | | | | | | |
|---|---|---|---|---|---|---|---|---|---|---|
| | antibody following each round of selection | | | | | | | | | |
| | Round 1 | | Round 2 | | Round 3 | | Round 4 | | Round 5 | |
| AC8 pCAL | ND | ND | 21/22 | 95% | ND | ND | ND | ND | ND | ND |
| [10⁻³] | | | | | | | | | | |
| AC8 pCAL | ND | ND | 21/22 | 95% | 21/22 | 95% | 37/44 | 84% | ND | ND |
| [10⁻⁴] | | | | | | | | | | |
| AC8 pCAL | ND | ND | 21/22 | 95% | 27/33 | 81% | 40/44 | 91% | 30/44 | 68% |
| [10⁻⁶] | | | | | | | | | | |
| AC8 pCAL | ND | ND | 21/22 | 95% | 32/33 | 97% | 68/88 | 77% | 32/44 | 72% |
| [10⁻⁸] | | | | | | | | | | |
| 2G12 pCAL | ND | ND | 21/22 | 95% | 71/22 | 77% | 15/22 | 68% | ND | ND |
| [10⁻³] | | | | | | | | | | |
| 2G12 pCAL | ND | ND | 22/22 | 100% | 21/22 | 95% | 18/22 | 82% | ND | ND |
| [10⁻⁴] | | | | | | | | | | |
| 2G12 pCAL | ND | ND | 20/22 | 90% | 21/22 | 95% | 17/22 | 77% | ND | ND |
| [10⁻⁶] | | | | | | | | | | |
| 2G12 pCAL | ND | ND | 20/22 | 100% | 20/22 | 90% | 13/22 | 60% | ND | ND |
| [10⁻⁸] | | | | | | | | | | |
| 2G12 pCAL | ND | ND | ND | ND | ND | ND | ND | ND | ND | ND |
| IT* [10⁻³] | | | | | | | | | | |
| 2G12 pCAL | ND | ND | 44/44 | 100% | 172/176 | 97% | 132/132 | 100% | ND | ND |
| IT* [10⁻⁴] | | | | | | | | | | |
| 2G12 pCAL | ND | ND | 41/44 | 93% | 44/44 | 100% | 43/44 | 97% | ND | ND |
| IT* [10⁻⁶] | | | | | | | | | | |
| 2G12 pCAL | ND | ND | 44/44 | 100% | 42/44 | 95% | 41/44 | 93% | 170/176 | 97% |
| IT* [10⁻⁸] | | | | | | | | | | |

TABLE 19I
Evaluation of HSV-1 gD antigen specific Fabs displayed by phage
that were selected after each round of capture.

| | Number and percentage of HSV-1 gD-specific | | | | | | | | | |
|---|---|---|---|---|---|---|---|---|---|---|
| | phage following each round of selection | | | | | | | | | |
| | Round 1 | | Round 2 | | Round 3 | | Round 4 | | Round 5 | |
| AC8 pCAL | ND | ND | 14/22 | 63% | ND | ND | ND | ND | ND | ND |
| [10⁻³] | | | | | | | | | | |
| AC8 pCAL | ND | ND | 0/22 | 0% | 1/22 | 5% | 28/44 | 64% | ND | ND |
| [10⁻⁴] | | | | | | | | | | |
| AC8 pCAL | ND | ND | 0/22 | 0% | 1/33 | 3% | 24/44 | 54% | 20/44 | 45% |
| [10⁻⁶] | | | | | | | | | | |
| AC8 pCAL | ND | ND | 0/22 | 0% | 0/33 | 0% | 18/88 | 20% | 23/44 | 52% |
| [10⁻⁸] | | | | | | | | | | |
| 2G12 pCAL | ND | ND | 0/22 | 0% | 0/22 | 0% | 0/22 | 0% | ND | ND |
| [10⁻³] | | | | | | | | | | |
| 2G12 pCAL | ND | ND | 0/22 | 0% | 0/22 | 0% | 0/22 | 0% | ND | ND |
| [10⁻⁴] | | | | | | | | | | |
| 2G12 pCAL | ND | ND | 0/22 | 0% | 0/22 | 0% | 0/22 | 0% | ND | ND |
| [10⁻⁶] | | | | | | | | | | |
| 2G12 pCAL | ND | ND | 0/22 | 0% | 0/22 | 0% | 0/22 | 0% | ND | ND |
| [10⁻⁸] | | | | | | | | | | |
| 2G12 pCAL | ND | ND | ND | ND | ND | ND | ND | ND | ND | ND |
| IT* [10⁻³] | | | | | | | | | | |
| 2G12 pCAL | ND | ND | 0/44 | 0% | 0/176 | 0% | 0/132 | 0% | ND | ND |
| IT* [10⁻⁴] | | | | | | | | | | |
| 2G12 pCAL | ND | ND | 0/44 | 0% | 0/44 | 0% | 0/44 | 0% | ND | ND |
| IT* [10⁻⁶] | | | | | | | | | | |
| 2G12 pCAL | ND | ND | 0/44 | 0% | 0/44 | 0% | 0/44 | 0% | 0/176 | 0% |
| IT* [10⁻⁸] | | | | | | | | | | |

### Example 14

### Design of Vectors for Generating Domain-Exchange Antibody Fragment Variants

To generate various types of domain exchanged antibody fragments and assess their ability to assemble in periplasm for display on phage, multiple polynucleotide constructs were designed and generated. The constructs were designed to express various combinations of heavy and light chain regions of domain exchanged antibody, to form a plurality of domain exchanged antibody fragments (in addition to the domain exchanged Fab fragment), in the form of gene III fusion proteins, for phage display. The additional 2G12 antibody fragment fusion proteins encoded by the constructs are illustrated schematically in FIG. 8.

FIG. 8A schematically illustrates a phage displayed domain exchanged Fab fragment (illustrated as a cp3 fusion polypeptide) described in the examples above, as well as additional exemplary displayed domain exchanged fragments, all shown in the figure as parts of phage coat protein (cp3) fusions. These additional fragments, illustrated in FIGS. 8B-H, further contain covalent linkage of two heavy chains via a disulphide bond and/or via a peptide linker, and/or contain only variable heavy and light chains joined by peptide linkers, forming single chain fragments.

In addition to the 2G12 domain exchanged Fab fragment, a construct for expressing a 2G12 domain exchanged fragment-cp3 fusion polypeptide was carried out for each of the fragment types illustrated in FIG. 8.

### Example 14A

### 2G12 Fragments with Varying Configuration

Changes were made to the 2G12 domain exchanged Fab fragment to evaluate effects on stability of the domain exchanged configuration of the domain exchanged Fab molecule. For example, as shown in FIG. 8B, the domain exchanged Fab hinge fragment (encoded by the polynucleotide construct having the nucleic acid sequence set forth in SEQ ID NO: 34) was designed to include the amino acids making up the hinge region, providing cysteine residues that form a disulfide bridge between the two heavy chain domains, which could potentially further stabilize the domain exchanged configuration. As shown in FIG. 8C, the domain exchanged Fab Cys19 fragment (encoded by the polynucleotide construct having the nucleic acid sequence set forth in SEQ ID NO: 30) was identical to the domain exchanged Fab fragment, but contained an Isoleucine to cysteine mutation at position 19 of the heavy chain. This mutation was expected to induce formation of a disulfide bridge between the heavy chain variable regions, which was expected to stabilize the domain exchanged configuration at the heavy chain interface.

As shown in FIG. 8D, the 2G12 domain exchanged scFab ΔC2Cys19 fragment (encoded by the polynucleotide construct having the nucleic acid sequence set forth in SEQ ID NO: 31) contained the same isoleucine to cysteine mutation, but lacked the two cysteines responsible for formation of disulfide bridges between the C_{H} and C_{L} domains, and included two peptide linkers, covalently joining the heavy and light chains.

In addition to variation of the 2G12 Fab fragment, 2G12 domain exchanged single chain fragments were designed to assess expression, folding and/or domain exchanged configuration of antibodies other than the domain exchanged Fab fragment. As shown in FIG. 8E, the domain exchanged scFv tandem fragment (encoded by the polynucleotide construct having the nucleic acid sequence set forth in SEQ ID NO: 36) was a single-chain fragment containing two V_{H} and two V_{L} domains and no constant region domains. These four variable region domains were linked via peptide linkers, which was expected to ensure formation of a domain exchanged type configuration, which could potentially be used to display domain exchanged antibody on the surface of phage, even in the absence of an amber stop codon between the nucleic acid encoding the antibody and that encoding the gene III. By contrast, as shown in FIG. 8F, the scFv fragment (encoded by the polynucleotide construct having the nucleic acid sequence set forth in SEQ ID NO: 35) contained two single-chain molecules, each containing one V_{H} and one V_{L} domain, linked by a peptide linker, but no linker between the two V_{H} domains. As illustrated in FIG. 8G, the scFv hinge fragment (encoded by the polynucleotide construct having the nucleic acid sequence set forth in SEQ ID NO: 37) was identical to the scFv fragment, but further contained the amino acids of the hinge region, providing for disulfide bridge formation between the V_{H} domains. A variation of this fragment (scFv hinge ΔE, encoded by the polynucleotide construct having the nucleic acid sequence set forth in SEQ ID NO: 38) also was generated, which lacked the first amino acid (glutamate) in the hinge region. Finally, as illustrated in FIG. 8H, the scFv Cys19 fragment (encoded by the polynucleotide construct having the nucleic acid sequence set forth in SEQ ID NO: 32) was identical to the scFv fragment, but further contained the isoleucine to cysteine mutation at position 19 of the variable heavy chain. As noted above, this mutation was expected to induce formation of a disulfide bridge between the heavy chain variable regions, which was expected to stabilize the domain exchanged configuration at the heavy chain interface.

### Example 14B

### Generation of the Constructs Encoding the Fragments

### Example 14B(i)

### 2G12 scFv tandem (VL-VH-VH-VL-6His-HA) Construct

The 2G12 scFv tandem construct (illustrated in FIG. 8E) was generated in a pET 28 vector (Novagen). As illustrated in FIG. 8E, the scFv tandem polynucleotide construct was designed with the following configuration: V_{L}-V_{H}-V_{H}-V_{L}-6His-HA, where V_{L} represents a nucleic acid encoding the light chain variable region of 2G12, V_{H} represents a nucleic acid encoding the heavy chain variable region of 2G12 antibody, 6H is represents a nucleic acid encoding six histidine residues, and HA represents a nucleic acid encoding a hemagglutinin (HA) tag. The scFv tandem polynucleotide further contained a first linker (Linker 1) between the first V_{L} and V_{H} and the second V_{H} and V_{L}, and a second linker (Linker 2), between the two V_{H} domains. The nucleotide sequence of the pET 28 vector containing the nucleic acid encoding the 2G12 scFv tandem is set forth in SEQ ID NO: 36.

To generate the construct, the oligonucleotides listed in Table 20 were ordered from IDT.

TABLE 20
Oligonucleotides for Generation of the 2G12
Domain Exchanged scFv tandem (VL-VH-VH-VL-
6His-HA) construct

| Oligonu- | | SEQ |
|---|---|---|
| cleotide | | ID |
| Name | Sequence | NO: |
| OmpA-F: | GTGGCACTGGCTGGTTTCGCTAC | 220 |
| VLL1 -R: | GGAGGAAGATCCAGACGAACCACCTTTGATTTCAA | 221 |
| | CACGGGTACCCTG | |
| L1VH-F: | GGTGGCTCGGGCGGTGGTGGCGAAGTTCAGCTGGT | 222 |
| | TGAATCTGGTG | |
| VHL2-R: | CTGCTGCTGCTGCCGGATCCTCCCGGAGAAACGGT | 223 |
| | AACAACGGTAC | |
| L2VH-F: | GGCGGGAGCTCCGGCGGCGGAGAAGTTCAGCTGG | 224 |
| | TTGAATCTGGTG | |
| VHL1-R: | GGAGGAAGATCCAGACGAACCACCCGGAGAAACG | 225 |
| | GTAACAACGGTAC | |
| L1VL-F: | GGTGGCTCGGGCGGTGGTGGCGTTGTTATGACCCA | 226 |
| | GTCTCCGTC | |
| VLSfi-R: | GTGCTGGCCGGCCTGGCCTTTGATTTCAACACGGG | 227 |
| | TACCCTG | |
| Sfi6His-R: | GTGATGGTGCTGGCCGGCCTGGCCTTTTG | 228 |
| Linker | GGTGGTTCGTCTGGATCTTCCTCCTCTGGTGGCGGT | 16 |
| 1(+): (L1) | GGCTCGGGCGGTGGTGGC | |
| Linker | GCCACCACCGCCCGAGCCACCGCCACCAGAGGCG | 229 |
| 1(−): (L1′) | GCAGATCCAGACGAACCACC | |
| Linker | GGAGGATCCGGCAGCAGCAGCAGCGGCGGCGGCG | 18 |
| 2(+): (L2) | GCGGGAGCTCCGGCGGCGGA | |
| Linker | TCCGCCGCCGGAGCTCCCGCCGCCGCCGCCGCTGC | 230 |
| 2(−): (L2′) | TGCTGCTGCCGGATCCTCC | |

Four first PCR amplifications (PRC1a-d) were carried out using the template and primers indicated in Table 21 below. For each reaction, the pET Duet vector containing the nucleotide encoding the 2G12 domain exchanged Fab fragment (SEQ ID NO: 231, was used as a template.

For each first PCR, 1 μL of template DNA and 1 μL of each primer were mixed with 1 μL of Advantage HF2 polymerase mix (Clontech) and 1× Advantage HF2 reaction buffer and dNTPs in 50 μL reaction volume. Each amplification was performed with 1 min denaturation at 95° C. and 30 cycles of denaturation at 95° C. for 5 seconds and annealing and extension at 68° C. for 1 min followed by an incubation at 68° C. for 3 minutes. The reaction then was cooled down to 4° C. Each PCR product then was run on a 1% agarose gel and purified using Gel Extraction Kit (Qiagen). The size of each product is indicated in Table 21 below.

TABLE 21
Template and Primers for First PCR Amplifications

| | PCR (product name) | | | |
|---|---|---|---|---|
| | PCR1a | PCR1b | PCR1c | PCR1d |
| template | pETDuet 2G12 | pETDuet 2G12 | pETDuet 2G12 | pETDuet 2G12 |
| | Fab (SEQ ID NO: | Fab (SEQ ID NO: | Fab (SEQ ID NO: | Fab (SEQ ID NO: |
| | 231) | 231) | 231) | 231) |
| 5′ primer(s) (20 μM) | OmpA-F (SEQ | L1 (SEQ ID NO: | L2 (SEQ ID NO: | L1 (SEQ ID NO: |
| | ID NO: 220) | 16):L1VH-F | 18):L2VH-F | 16):L1VL-F |
| | | (SEQ ID NO: | (SEQ ID NO: | (SEQ ID NO: |
| | | 222) | 224) | 226) |
| | | (10:1) | (10:1) | (10:1) |
| 3′ primer(s) (20 μM) | VLL1-R (SEQ ID | VHL2-R (SEQ ID | VHL1-R (SEQ | VLSfi-R (SEQ ID |
| | NO: 221):L1′ | NO: 223):L2′ | ID NO: 225):L1′ | NO: 227) |
| | (SEQ ID NO: | (SEQ ID NO: | (SEQ ID NO: | |
| | 229) (1:10) | 230) (1:10) | 229) (1:10) | |
| Product size | 411 | 446 | 444 | 390 |
| (base pairs (bp)) | | | | |

Four second PCR (overlap PCR) amplifications then were carried out using the purified products from the first PCR amplifications as templates. The template and primers used in each of the reactions are indicated in Table 22 below. For the reactions, 16 μL total template mixture and 4 μL of each primer were mixed with 4 μl, of Advantage HF2 polymerase mix and 1× Advantage HF2 reaction buffer and dNTPs in a 200 μL reaction volume. The amplification was performed with 1 min denaturation at 95° C. and 30 cycles of denaturation at 95° C. for 5 seconds and annealing and extension at 68° C. for 1 min followed by an incubation at 68° C. for 3 minutes. The reaction then was cooled down to 4° C. Each PCR product then was run on a 1 agarose gel and purified using Gel Extraction Kit (Qiagen). The size of each product is indicated in Table 22 below.

TABLE 22
Template and Primers for Second PCR Amplifications

| | PCR (product name) | | | |
|---|---|---|---|---|
| | PCR2a | PCR2b | PCR2c | PCR2d |
| template | PCR1a:PCR1b (1:1) | PCR1a:PGR1b | PCR1c:PCR1d | PCR1c:PCR1d |
| | | (1:1) | (1:1) | (1:1) |
| 5′ primer (20 μM) | OmpA-F | OmpA-F | L2 | L2 |
| | (SEQ ID NO: 220) | (SEQ ID NO: | (SEQ ID NO: 18) | (SEQ ID NO: 18) |
| | | 220) | | |
| 3′ primer (20 μM) | VHL2-R | L2′ | VLSfi-R | Sfi6His-R |
| | (SEQ ID NO: 223) | (SEQ ID NO: | (SEQ ID NO: | (SEQ ID NO: |
| | | 230) | 227) | 228) |
| Product size | 803 | 834 | 813 | 819 |
| (base pairs (bp)) | | | | |

The purified products from the second amplification reaction then were digested and ligated. The product from PCR2a was ligated to the product from PCR2c and the product from PCR2b was ligated to the product from PCR2d. For this process, the products were digested with Barn HI restriction endonuclease and purified using a PCR purification column (Qiagen). The digested, purified products then were ligated with T4 DNA ligase (New England Biolabs). The resulting ligated polynucleotides (PCR2a/PCR2c and PCR2b/PCR2d) then were gel-purified and combined.

The combined polynucleotides then were digested with Sfi I (New England Biolabs) and purified using a PCR purification column. A pET28 vector (Novagen) containing AC8 scFv (SEQ ID NO: 49) was digested with Sfi I and gel purified (Qiagen). The Sfi I-digested polynucleotide described above then was inserted into the digested vector by ligation with T4 DNA ligase.

The resulting vector with the inserted polynucleotide then was used to transformed TOP 10F′ cells (Invitrogen™ Corporation, Carlsbad, Calif.). The cells were titrated for colony formation on LB agar plates supplemented with 50 μg/mL kanamycin and 20 mM glucose. Following overnight growth at 37° C., individual colonies were picked and grown in 1.2 mL LB medium containing 50 μg/mL kanamycin at 37° C., overnight. DNA from the cultures then was prepared from the cultures using Qiagen miniprep DNA kit. Insertion of the polynucleotide was verified by digesting the DNA with Bam HI/Xho I (New England Biolabs) and visualization on a 1% agarose gel. The nucleotide sequence of the 2G12 scFv tandem (VL-VH-VH-VL-6His-HA) insert was verified by DNA sequencing.

### Example 14B(ii)

### 2G12 Domain Exchanged scFv (V_{L}-V_{H}) Construct

The 2G12 domain exchanged scFv construct (illustrated in FIG. 8F) was generated in a pET 28 vector (Novagen) by performing a PCR amplification using a PCR product from the procedure used to make the scFv tandem construct, described in Example 14B(i), as a template. As illustrated in FIG. 8F, the scFv polynucleotide construct was designed with the following configuration: V_{L}-V_{H}, where V_{L} represents a nucleic acid encoding the light chain variable region of 2G12, V_{H} represents a nucleic acid encoding the heavy chain variable region of 2G12 antibody. The scFv polynucleotide further contained a linker (Linker 1) between the V_{L} and V_{H}. The nucleotide sequence of the pET 28 vector containing the nucleic acid encoding the 2G12 scFv fragment is set forth in SEQ ID NO: 35.

To generate the scFv polynucleotide, a PCR amplification was carried out using 4 μL of PCR2a from the scFv tandem generation (described in Example 14B(i) above) as a template and 4 μL of primers (20 μM) OmpA-F (SEQ ID NO: 220; GTGGCACTGGCTGGTTTCGCTAC) and VHSfi-R (SEQ ID NO: 232, CCATGGTGATGGTGATGGTGCTGGCCGGCCTGGCCCGGAGAAACGGTAAC AACGGTAC). The PCR was carried out in the presence of 4 μL of Advantage HF2 polymerase mix and 1× Advantage HF2 reaction buffer and dNTP mix (Clontech) in a 200 μL reaction volume. The amplification was performed with 1 min denaturation at 95° C. and 30 cycles of denaturation at 95° C. for 5 seconds and annealing and extension at 68° C. for 1 min followed by an incubation at 68° C. for 3 minutes. The reaction then was cooled down to 4° C. The resulting 815 by polynucleotide was run on a 1% agarose gel and gel-purified using a Gel Extraction Kit (Qiagen).

The resulting scFv product then was ligated into the pET28 vector. For this process, the purified product was digested with Sfi I restriction endonuclease and purified over a PCR purification column (Qiagen). The purified digested product then was ligated into the pET28 vector that had been digested with Sfi I (described in Example 14B(i) above) using T4 DNA ligase (New England Biolabs® Inc.). The product from this ligation reaction was transformed into XL1-Blue cells (Statagene) and the cells titrated for colony formation on LB agar plates supplemented with 50 μg/mL kanamycin and 20 mM glucose. Following overnight growth at 37° C., individual colonies were picked and grown in 1.2 mL LB medium containing 50 μg/mL kanamycin, at 37° C. overnight, DNA from the cultures then was prepared from the cultures using Qiagen miniprep DNA kit. Correct insertion of the polynucleotide was verified by digesting the DNA with Xba I/Xho I (New England Biolabs) and visualization on a 1 agarose gel. The nucleotide sequence of the 2G12 scFv (V_{L}-V_{H}-) insert was verified by DNA sequencing.

### Example 14B(iii)

### scFv Cys19 Construct

The 2G 12 scFv Cys 19 construct (illustrated in FIG. 8H) was generated in a pET 28 vector (Novagen) by performing a PCR amplification using the scFv construct, described in Example 14B(i), as a template. As illustrated in FIG. 8H, the scFv Cys19 polynucleotide construct was identical to the scFv polynucleotide, with the exception that the encoded amino acid sequence contained a mutation at the 19^{th} residue of the V_{H} domain from isoleucine to cysteine. Thus, the scFv Cys19 polynucleotide had the following configuration: V_{L}-V_{H}, where V_{L} represents a nucleic acid encoding the light chain variable region of 2G12 and V_{H} represents a nucleic acid encoding the heavy chain variable region of 2G12 antibody, with a cysteine at position 19. The scFv polynucleotide further contained a linker (Linker 1; SEQ ID NO: 16) between the V_{L} and V_{H}. The nucleotide sequence of the pET 28 vector containing the nucleic acid encoding the 2G12 scFv Cys19 fragment is set forth in SEQ ID NO: 32.

Oligonucleotide primers used to construct the pET28 scFv Cys 19 were ordered from IDT. Their sequences are listed in Table 23 below.

TABLE 23
Oligonucleotide Primers for Construction of
the 2G12 Domain Exchanged pET28 scFv Cys 19
Fragment

| | | SEQ |
|---|---|---|
| Oligonucleotide | | ID |
| name | Sequence | NO: |
| AgeI-F | CCCTGAAAACCGGTGTTCCGTCTC | 233 |
| Cys19- R | CACCGCAAGACAGGCACAGAGAACCACCAG | 234 |
| Cys19- F | CTGGTGGTTCTCTGTGCCTGTCTTGCGGTG | 235 |
| NcoI25- R | GGTATGCGCCATGGTGATGGTGATG | 236 |

Two first PCR amplifications (Cys a; Cys b) were carried out using the template and primers indicated in Table 24 below. As indicated in the table, for each reaction, the template was the pET28 2G12 domain exchanged scFv vector (SEQ ID NO: 35), generated as described in Example 14B(ii) above.

For each first PCR, 1 μL of template DNA (approximately 4 ng) and 1 μL of each primer were mixed with 1 μL of Advantage HF2 polymerase mix (Clontech) and 1× Advantage HF2 reaction buffer and dNTP mix in 50 μL reaction volume. Each amplification was performed with 1 min denaturation at 95° C. and 26 cycles of denaturation at 95° C. for 5 seconds and annealing and extension at 68° C. for 30 seconds followed by an incubation at 68° C. for 3 minutes. Then the reaction was cooled down to 4° C.

Each PCR product then was run on a 1% agarose gel and purified using Gel Extraction Kit (Qiagen). The size of each product is indicated in Table 24 below.

TABLE 24
Template and Primers for First PCR Amplifications

| | PCR (product name) | |
|---|---|---|
| | Cys a | Cys b |
| template | pET28 2G12 scFv [VL-VH] | pET28 2G12 scFv |
| | (SEQ ID NO: 35) | [VL-VH] |
| | | (SEQ ID NO: 35) |
| 5′ primer | AgeI-F (SEQ ID NO: 233) | Cys19-F |
| | | (SEQ ID NO: 235) |
| 3′ primer | Cys19-R (SEQ ID NO: 234) | NcoI25-R |
| | | (SEQ ID NO: 236) |
| Product size (bp) | 288 | 372 |

A second PCR amplification (Cys c; overlap PCR) was performed using the purified products from the first PCRs described above as templates and primers used in the first reactions. The templates and primers used in the second PCR amplification are indicated in Table 25 below. For this reaction, 4 μL of each template mix and 2 μL of each primer was mixed with 2 μL Advantage HF2 polymerase mix and 1× Advantage H₂F reaction buffer and dNTP mix in a 100 μL reaction volume. The amplification was performed with 1 min denaturation at 95° C. and 30 cycles of denaturation at 95° C. for 5 seconds and annealing and extension at 68° C. for 1 min followed by an incubation at 68° C. for 3 minutes. Then the reaction was cooled down to 4° C. The product then was run on a 1% agarose gel, and purified using Gel Extraction Kit (Qiagen). The size of the product also is indicated in Table 25 below.

TABLE 25
Primers and Template for Second PCR Amplification

| | PCR |
|---|---|
| | (product name) |
| | Cys c |
| template | Cys a:Cys b (1:1) |
| 5′ | AgeI-F (SEQ ID NO: |
| | 233) |
| 3′ | NcoI25-R (SEQ ID NO: |
| | 236) |
| Product size | 630 |
| (base pairs) | |

The purified product then was digested and ligated into a pET28 vector. For this process, the product first was digested with Age I and Nco I (New England Biolabs) and purified using a PCR purification column. The digested fragment then was ligated into the pET28 vector containing the scFv polynucleotide (SEQ ID NO: 35, described in Example 14B(ii) above) digested with Age I/Nco I using T4 DNA ligase. The product from the ligation reaction was transformed into TOP10F′ cells (Invitrogen™ Corporation, Carlsbad, Calif.) and the cells titrated for colony formation on LB agar plates supplemented with 50 μg/mL kanamycin and 20 mM glucose. After overnight growth at 37° C., colonies were picked and grown in 1.2 mL LB medium containing 50 μg/mL kanamycin 37° C., overnight. DNA from the cultures was prepared using Qiagen miniprep DNA kit. Verification of correct insertion of the polynucleotide and the presence of cysteine in the 19th amino acid of heavy chain were confirmed by DNA sequence analysis.

### Example 14B(iv)

### scFv hingeΔE Construct

The scFv hinge ΔE polynucleotide (illustrated in FIG. 8G) was generated in the pET28 vector by carrying out PCR reactions using the pET28 vector containing the nucleotide encoding the 2G12 domain exchanged scFv fragment (SEQ ID NO: 35, described in Example 14B(ii) above) as a template. As shown in FIG. 8G and as described above, the 2G12 scFv hinge ΔE construct was designed to be identical to the scFv fragment, but further contained the nucleic acid encoding the hinge region (without the first glutamate residue), to promote disulfide bond formation between the two heavy chains. The nucleotide sequence of the pET 28 vector containing the nucleic acid encoding the 2G12 scFv hinge ΔE fragment is set forth in SEQ ID NO: 38.

The oligonucleotides listed in Table 26, below were ordered from IDT for the construction of the scFv hinge ΔE construct.

TABLE 26
Oligonucleotides for Construction of the 2G12
Domain Exchanged scFv hinge ΔE construct

| Primer/ | | SEQ |
|---|---|---|
| oligo | | ID |
| name | Sequence | NO: |
| AgeI- F | CCCTGAAAACCGGTGTTCCGTCTC | 233 |
| HingeVH- | CGCAGCTTTTCGGCGGAGAAACGGTAACAACGGTAC | 237 |
| R | | |
| VHhinge- | CCGTTTCTCCGCCGAAAAGCTGCGATAAAACCCATACCT | 238 |
| F | GCC | |
| Hinge | GCTGCGATAAAACCCATACCTGCCCGCCGTGCCCGGGCC | 239 |
| Tem- | AG | |
| plate- F | | |
| Hinge | GATGGTGATGGTGCTGGCCGGCCTGGCCCGGGCACGGCG | 240 |
| Tem- | GGCAG | |
| plate- R | | |
| NcoI38- | GCGGCGCCATGGTGATGGTGATGGTGCTGGCCGGCCTG | 241 |
| R | | |

Two first PCR amplifications (Hinge a; Hinge b) were carried out using the template and primers indicated in Table 27 below. As indicated in the table, for each reaction, the template was the pET28 2G12 domain exchanged scFv vector (SEQ ID NO: 35), generated as described in Example 14B(ii) above, or one of the template oligonucleotides listed in Table 26 above.

For each first PCR, 1 μL of template DNA (approximately 4 ng) and 1 μL of each primer were mixed with 1 μL of Advantage HF2 polymerase mix (Clontech) and 1× Advantage HF2 reaction buffer and dNTP mix in 50 μL reaction volume. Each amplification was performed with 1 min denaturation at 95° C. and 26 cycles of denaturation at 95° C. for 5 seconds and annealing and extension at 68° C. for 30 seconds followed by an incubation at 68° C. for 3 minutes. Then the reaction was cooled down to 4° C.

Each PCR product then was run on a 1 agarose gel and purified using Gel Extraction Kit (Qiagen). The size of each product is indicated in Table 27 below.

TABLE 27
Template and Primers for First PCR Amplifications

| | PCR (product name) | |
|---|---|---|
| | Hinge a | Hinge b |
| template | pET28 2G12 scFv | HingeTemplate-F |
| | [VL-VH] | (SEQ ID NO: 238) and |
| | (SEQ ID NO: 35) | HingeTemplate-R |
| | (approximately 4 ng) | |
| | | (SEQ ID NO: 240) |
| | | (1 μM each) |
| 5′ primer | AgeI-F (SEQ ID NO: 233) | VHhinge-F |
| | | (SEQ ID NO: 238) |
| 3′ primer | HingeVH-R | NcoI38-R |
| | (SEQ ID NO: 237) | (SEQ ID NO: 241) |
| Product size (bp) | 600 | 94 |

A second PCR amplification (Hinge c; overlap PCR) was performed using the purified products from the first PCRs described above as templates and primers used in the first reactions. The templates and primers used in the second PCR amplification are indicated in Table 28 below. For this reaction, 4 μL of each template mix and 2 μL of each primer was mixed with 2 μL Advantage HF2 polymerase mix and 1× Advantage H₂F reaction buffer and dNTP mix in a 100 μL reaction volume. The amplification was performed with 1 min denaturation at 95° C. and 30 cycles of denaturation at 95° C. for 5 seconds and annealing and extension at 68° C. for 1 min followed by an incubation at 68° C. for 3 minutes. The reaction then was cooled down to 4° C. The product then was run on a 1% agarose gel and purified using Gel Extraction Kit (Qiagen). The size of the product also is indicated in Table 28 below.

TABLE 28
Template and Primers for Second PCR Amplification

| | PCR (product name) |
|---|---|
| | Hinge c |
| template | Hinge a:Hinge b (1:1) |
| 5′ primer | AgeI-F (SEQ ID NO: 233) |
| 3′ primer | NcoI38-R (SEQ ID NO: 241) |
| Product size (bp) | 670 |

The purified product from the Hinge c PCR then was digested and inserted via ligation into the pET28 vector. For this process, the purified product was digested with Age I and Nco I enzymes (New England Biolabs) and purified using a PCR purification column. The digested fragment was ligated into the pET28 vector containing the domain exchanged scFv-encoding polynucleotide (SEQ ID NO: 35), described in Example 14B(ii) above, that had been digested with Age I/Nco I, using T4 DNA ligase (New England Biolabs® Inc.). The product from the ligation reaction then was used to transform TOP 10F′ cells (Invitrogen™ Corporation, Carlsbad, Calif.) and the cells titrated for colony formation on LB agar plates containing 50 μg/mL kanamycin and 20 mM glucose. Following growth on the plates overnight at 37° C., colonies were picked and grown in 1.2 mL LB medium containing 50 μg/mL kanamycin at 37° C., overnight, and miniprep DNA was prepared using Qiagen miniprep DNA kit. Verification of correct insertion and presence of the hinge region was confirmed by sequencing the isolated DNA.

### Example 14B(v)

### scFv Hinge Construct

The scFv hinge polynucleotide (illustrated in FIG. 8G) was generated in the pET28 vector by carrying out PCR reactions using the pET28 vector containing the nucleotide encoding the 2G12 domain exchanged scFv fragment (SEQ ID NO: 35, described in Example 14B(ii) above) as a template. As shown in FIG. 8G and as described above, the 2G12 scFv hinge construct was designed to be identical to the scFv fragment, but further contained the nucleic acid encoding the hinge region (including the first glutamate residue), to promote disulfide bond formation between the two heavy chains. The nucleotide sequence of the pET 28 vector containing the nucleic acid encoding the 2G12 domain exchanged scFv hinge fragment is set forth in SEQ ID NO: 37.

The oligonucleotides listed in Table 29, below were ordered from IDT for the construction of the scFv hinge construct.

TABLE 29
Oligonucleotides for Construction of the Domain
Exchanged 2G12 scFv Hinge Construct

| Primer/ | | SEQ |
|---|---|---|
| oligo | | ID |
| name | Sequence | NO: |
| AgeI- F | CCCTGAAAACCGGTGTTCCGTCTC | 233 |
| Hinge | CGCAGCTTTTCGGTTCCGGAGAAACGGTAACAACGGTAC | 242 |
| VH(E)- R | CCGGAC | |
| VH | CCGTTTCTCCGGAACCGAAAAGCTGCGATAAAACCCATA | 243 |
| hinge | CCTGCC | |
| (E)- F | | |
| Hinge | GCTGCGATAAAACCCATACCTGCCCGCCGTGCCGGGGCC | 239 |
| Template | AG | |
| F - | | |
| Hinge | GATGGTGATGGTGCTGGCCGGCCTGGCCCGGGCACGGCG | 240 |
| Tem- | GGCAG | |
| plate- R | | |
| NcoI25- | GGTATGCGCCATGGTGATGGTGATG | 236 |
| R | | |

Two first PCR amplifications (Hinge(E) a; Hinge(E) b) were carried out using the template and primers indicated in Table 30 below. As indicated in the table, for each reaction, the template was the pET28 2G12 domain exchanged scFv vector (SEQ ID NO: 35), generated as described in Example 14B(ii) above, or one of the Hinge template oligonucleotides listed in Table 29 above.

For each first PCR, 1 μL of template DNA (approximately 4 ng) and 1 μL of each primer were mixed with 1 μL of Advantage HF2 polymerase mix (Clontech) and 1× Advantage HF2 reaction buffer and dNTP mix in 504 reaction volume. Each amplification was performed with 1 min denaturation at 95° C. and 26 cycles of denaturation at 95° C. for 5 seconds and annealing and extension at 68° C. for 30 seconds followed by an incubation at 68° C. for 3 minutes. The reaction then was cooled down to 4° C.

Each PCR product then was run on a 1% agarose gel and purified using Gel Extraction Kit (Qiagen). The size of each product is indicated in Table 30 below.

TABLE 30
First PCR Amplifications

| | PCR (product name) | |
|---|---|---|
| | Hinge (E) a | Hinge (E) b |
| template | pET28 2G12 scFv [VL-VH] | HingeTemplate-F |
| | (SEQ ID NO: 35) | (SEQ ID NO: 239) and |
| | (approximately 4 ng) | HingeTemplate-R |
| | | (SEQ ID NO: 240) |
| | | (1 μM each) |
| 5′ primer | AgeI-F | VHhinge(E)-F |
| | (SEQ ID NO: 233) | (SEQ ID NO: 243) |
| 3′ primer | HingeVH(E)-R | NcoI38-R |
| | (SEQ ID NO: 242) | (SEQ ID NO: 241) |
| product size (bp) | 603 | 97 |

A second PCR amplification (Hinge(E) c; overlap PCR) was performed using the purified products from the first PCRs described above as templates and primers used in the first reactions. The templates and primers used in the second PCR amplification are indicated in Table 31 below. For this reaction, 4 μL of each template mix and 2 μL of each primer was mixed with 24 Advantage HF2 polymerase mix and 1× Advantage H₂F reaction buffer and dNTP mix in a 100 μL reaction volume. The amplification was performed with 1 min denaturation at 95° C. and 30 cycles of denaturation at 95° C. for 5 seconds and annealing and extension at 68° C. for 1 min followed by an incubation at 68° C. for 3 minutes. The reaction then was cooled down to 4° C. The product then was run on a 1 agarose gel and purified using Gel Extraction Kit (Qiagen). The size of the product also is indicated in Table 31 below.

TABLE 31
Second PCR Amplifications

| PCR (product name) | Hinge(E) c |
|---|---|
| template | Hinge(E) a:Hinge(E) b (1:1) |
| 5′ primer | AgeI-F (SEQ ID NO: 233) |
| 3′ primer | NcoI25-R (SEQ ID NO: 236) |
| Product size (bp) | 673 |

The purified product from the Hinge(E) c PCR then was digested and inserted via ligation into the pET28 vector. For this process, the purified product was digested with Age I and Nco I enzymes (New England Biolabs) and purified using a PCR purification column. The digested fragment was ligated into the pET28 vector containing the domain exchanged scFv-encoding polynucleotide (SEQ ID NO: 35), described in Example 14B(ii) above, that had been digested with Age I/Nco I, using T4 DNA ligase. The product from the ligation reaction then was used to transform TOP10F′ cells (Invitrogen™ Corporation, Carlsbad, Calif.) and the cells titrated for colony formation on LB agar plates containing 50 μg/mL kanamycin and 20 mM glucose. Following growth on the plates overnight at 37° C., colonies were picked and grown in 1.2 mL LB medium containing 50 μg/mL kanamycin at 37° C. overnight, and miniprep DNA was prepared using Qiagen miniprep DNA kit. Verification of correct insertion and presence of the hinge region was confirmed by sequencing the isolated DNA.

### Example 14B(vi)

### 2G12 Fab Cys19 Construct

The 2G12 Fab Cys19 construct (illustrated in FIG. 8C) was generated in a pET Duet vector (Novagen). As illustrated in FIG. 8C, the 2G12 Fab Cys19 polynucleotide construct was identical to the 2G12 Fab fragment, with the exception that the polynucleotide was mutated such that an isoleucine to cysteine substitution occurred at position 19 of the heavy chain amino acid sequence encoded by the construct; this mutation was made to promote formation of a disulfide bridge between the two heavy chain variable regions in the folded domain exchanged fragment. The 2G12 Fab Cys19 polynucleotide contained a linker (Linker 1; SEQ ID NO: 16) between the V_{L} and V_{H} encoding sequences. The nucleotide sequence of the pET Duet vector containing the nucleic acid encoding the 2G12 Fab Cys19 is set forth in SEQ ID NO: 30.

In addition to oligonucleotides listed elsewhere in this Example, the oligonucleotides listed in Table 32 below were ordered from IDT, for generation of the 2G12 Fab Cys19 construct.

TABLE 32
Oligonucleotides for Generating 2G12 Domain
Exchanged Fab Cys19

| Primer Name | Sequence | SEQ ID NO: |
|---|---|---|
| NdeIVH- F | GGAGATATACATATGAA | 244 |
| | ATACCTATTGCCTAC | |
| XhoIHA26- R | TACCAGACTCGAGCTAA | 245 |
| | GAAGCGTAG | |

Two first PCR amplifications (Fab Cys19 a and Fab Cys19 b) were carried out using the template and primers indicated in Table 33 below. For each reaction, the pET Duet vector containing the nucleotide encoding the 2G12 domain exchanged Fab fragment (SEQ ID NO: 231) was used as a template.

For each first PCR, 1 μL of template DNA (approximately 10 ng) and 1 μL of each primer were mixed with 1 μL of Advantage HF2 polymerase mix (Clontech) and 1× Advantage HF2 reaction buffer and dNTPs in 50 μL reaction volume. Each amplification was performed with 1 min denaturation at 95° C. and 26 cycles of denaturation at 95° C. for 5 seconds and annealing and extension at 68° C. for 30 seconds followed by an incubation at 68° C. for 3 minutes. The reaction then was cooled down to 4° C. Each PCR product then was run on a 1% agarose gel and purified using Gel Extraction Kit (Qiagen). The size of each product is indicated in Table 33 below.

TABLE 33
First PCR Amplifications

| | PCR (product name) | |
|---|---|---|
| | Fab Cys19 a | Fab Cys19 b |
| template | 2G12 Fab in pETDuet vector | 2G12 Fab in pETDuet |
| | (SEQ ID NO: 231) | vector |
| | | (SEQ ID NO: 231) |
| 5′ primer (20 μM) | NdeIVH-F (SEQ ID NO: 244) | Cys19-F |
| | | (SEQ ID NO: 235) |
| 3′ primer (20 μM) | Cys19-R | XhoIHA26-R |
| | (SEQ ID NO: 234) | (SEQ ID NO: 245) |
| Product size (bp) | 148 | 717 |

A second PCR amplification (Fab Cys 19 c, an Overlap PCR) was performed using the purified products from the first PCR as templates. The primers/templates used in this second PCR are indicated in Table 34 below. For the reaction, 4 μL of template mix and 2 μL of each primer were mixed with 2 μL of Advantage HF2 polymerase mix in 1× Advantage H2F reaction buffer and dNTP in 100 μL reaction volume. The amplification was performed with 1 min denaturation at 95° C. and 30 cycles of denaturation at 95° C. for 5 seconds and annealing and extension at 68° C. for 1 min followed by an incubation at 68° C. for 3 minutes. The reaction then was cooled down to 4° C. The size of the product is indicated in Table 34 below. The product was run on a 1% agarose gel and purified by gel extraction.

TABLE 34
Second PCR Amplification

| | PCR (product name) |
|---|---|
| | Fab Cys19 c |
| template | Fab Cys a:Fab Cys b |
| | (1:1) |
| 5′ primer (20 μM) | NdeIVH-F |
| | (SEQ ID NO: 244) |
| 3′ primer (20 μM) | XhoIHA26-R |
| | (SEQ ID NO: 245) |
| Product size (bp) | 835 |

The purified product then was digested and inserted via ligation into the pETDuet 2G12 Fab vector. For this process, the product was digested with Nde I and Xho I enzymes (New England Biolabs) and purified using a PCR purification column. The digested product then was ligated into the pETDuet 2G12 Fab vector (SEQ ID NO: 231), that had been digested with Nde I/Xho I, using T4 DNA ligase. The product of this ligation reaction was used to transform TOP10F′ cells (Invitrogen™ Corporation, Carlsbad, Calif.) and the cells titrated for colony formation on LB agar plates supplemented with 100 μg/mL ampicillin and 20 mM glucose. Following overnight growth at 37° C., colonies were picked and grown in 1.2 mL LB medium containing 50 μg/mL ampicillin, overnight at 37° C., and DNA from the culture prepared using Qiagen miniprep DNA kit. The correct insertion of the 2G12 Fab Cys19 polynucleotide and the presence of the cysteine codon in the sequence at the position encoding the 19^{th} amino acid of the heavy chain were confirmed by DNA sequence analysis.

### Example 14B(vii)

### 2G12 Fab Hinge Construct

The 2G12 Fab hinge construct (illustrated in FIG. 8B) was generated in a pET Duet vector (Novagen). As illustrated in FIG. 8B, the 2G12 Fab hinge polynucleotide construct was identical to the 2G12 Fab fragment, with the exception that the construct further included the nucleic acid encoding the hinge region of the 2G12 antibody, thereby facilitating the formation of a disulfide bridge in the encoded fragment between the two heavy chains. The 2G12 Fab hinge polynucleotide contained a linker (Linker 1 SEQ ID NO: 16) between the V_{L} and V_{H} encoding sequences. The nucleotide sequence of the pET Duet vector containing the nucleic acid encoding the 2G12 Fab hinge fragment is set forth in SEQ ID NO: 34.

The oligonucleotides listed in Table 35 below were ordered from IDT, for generation of the 2G12 Fab hinge construct.

TABLE 35
Oligonucleotides for Generation of the Domain
Exchanged 2G12 Fab Hinge Construct

| | | SEQ |
|---|---|---|
| Oligonucleotide | | ID |
| name | sequence | NO: |
| HingeCH1- R | CAGGTATGGGTTTTATCGCAGCTTTTCGGT | 246 |
| | TCAACTTTCTTGTC | |
| CH1Hinge- F | CCGAAAAGCTGCGATAAAACCCATACCTG | 247 |
| | CCCGCCGTGC | |
| HingeHis | CCCATACCTGCCCGCCGTGCCCGCACCAT | 248 |
| Template- F | CACCATCACCATGGCG | |
| HingeHis | GTCCGGAACGTCGTACGGGTATGCGCCAT | 249 |
| Template- R | GGTGATGGTGATGGTGCG | |
| XhoIHA- R | ACCAGACTCGAGCTAAGAAGCGTAGTCCG | 250 |
| | GAACGTCGTACGGGTATG | |

Two first PCR amplifications (Fab hinge a and Fab hinge b) were carried out using the templates and primers indicated in Table 36 below. As indicated, for the Fab hinge a reaction, the pET Duet vector containing the nucleotide encoding the 2G12 domain exchanged Fab fragment (SEQ ID NO: 231) was used as a template.

For each first PCR, 1 μL of template DNA (approximately 10 ng) and 1 L of each primer were mixed with 1 μL of Advantage HF2 polymerase mix (Clontech) in 1× Advantage HF2 reaction buffer and dNTPs in 50 μL reaction volume. The amplification of “Fab hinge a” was performed with 1 min denaturation at 95° C. and 30 cycles of denaturation at 95° C. for 5 seconds, annealing at 60° C. for 10 seconds, and extension at 68° C. for 30 seconds followed by an incubation at 68° C. for 3. The reaction then was cooled down to 4° C. The amplification of “Fab hinge b” was performed with 1 min denaturation at 95° C. and 26 cycles of denaturation at 95° C. for 5 seconds and annealing and extension at 68° C. for 30 seconds followed by an incubation at 68° C. for 3 minutes. The reaction then was cooled down to 4° C. Each PCR product then was run on a 1% agarose gel and purified using Gel Extraction Kit (Qiagen). The size of each product is indicated in Table 36 below.

TABLE 36
First PCR Amplifications

PCR (product name)

| | Fab hinge a | Fab hinge b |
|---|---|---|
| template | pETDuet 2G12 Fab | HingeHisTemplate-F |
| | (SEQ ID NO: 231) | (SEQ ID NO: 248) and |
| | | HingeHisTemplate-R |
| | | (SEQ ID NO: 249) |
| | | (0.2 μM each) |
| 5′ primer (20 μM) | NdeIVH-F | CH1hinge-F |
| | (SEQ ID NO: 244) | (SEQ ID NO: 247) |
| 3′ primer (20 μM) | HingeCH1-R | XhoIHA-R |
| | (SEQ ID NO: 246) | (SEQ ID NO: 250) |
| Product size (bp) | 774 | 111 |

A second PCR amplification (Fab hinge, an Overlap PCR) was performed using the purified products from the first PCR as templates. The primers/templates used in this second PCR are indicated in Table 37 below. For the reaction, 4 μL of template mix and 2 μL of each primer were mixed with 2 μL of Advantage HF2 polymerase mix in 1× Advantage H₂F reaction buffer and dNTP in 100 μL reaction volume. The amplification was performed with 1 min denaturation at 95° C. and 30 cycles of denaturation at 95° C. for 5 seconds, annealing at 60° C. for 10 seconds, and extension at 68° C. for 30 seconds followed by an incubation at 68° C. for 3 minutes. The reaction then was cooled down to 4° C. The size of the product is indicated in Table 37 below. The product was run on a 1% agarose gel and purified by gel extraction.

TABLE 37
Second PCR Amplifications

| | PCR (product name) |
|---|---|
| | Fab hinge |
| template | Fab hinge a:Fab hinge b |
| | (1:1) |
| 5′ primer (20 μM) | NdeIVH-F |
| | (SEQ ID NO: 244) |
| 3′ primer (20 μM) | XhoIHA26-R |
| | (SEQ ID NO: 245) |
| Fragment size (bp) | 856 |

The purified product then was disgusted and inserted into the pETDuet vector containing 2G12 Fab. For this process, the purified product was digested with the Nde I and Xho I restriction endonucleases (New England Biolabs) and purified using a PCR purification column. The purified digested product then was ligated into the pETDuet vector containing the nucleotide encoding the 2G 12 domain exchanged Fab fragment (SEQ ID NO: 231), that had been digested with Nde I/Xho I, using T4 DNA ligase.

The product of this ligation reaction then was transformed into TOP 10F′ cells (Invitrogen™ Corporation, Carlsbad, Calif.) and the cells titrated for colony formation on LB agar plates supplemented with 100 μg/mL ampicillin and 20 mM glucose. Following overnight growth at 37° C., colonies were picked and grown in 1.2 mL LB medium containing 50 μg/mL ampicillin overnight at 37° C., and culture DNA prepared using Qiagen miniprep DNA kit. Verification of correct insertion of the product and the presence of the hinge region in the construct was carried out by sequencing the prepared DNA.

### Example 14B(viii)

### 2G12 scFab ΔC2 Cys19 Construct

The 2G12 scFab ΔC2 Cys19 construct (illustrated in FIG. 8D) was generated in a pET28 vector (Novagen). As illustrated in FIG. 8D, the 2G12 scFab ΔC2 Cys19 polynucleotide construct was identical to the 2G12 Fab Cys19 fragment, with the exception that the construct was mutated such that other amino acids were substituted for two cysteines in the encoded constant regions (removing the disulfide bridges between heavy and light chain) and a linker was added, linking the V_{H} and C_{L} domains. The nucleotide sequence of the pET 28 vector containing the nucleic acid encoding the 2G12 scFab ΔC2 Cys19 fragment is set forth in SEQ ID NO: 31.

The oligonucleotides listed in Table 38 below were ordered from IDT, for generation of the 2G12 scFab ΔC2 Cys19 construct. The BamHISacI(+) and SacIBamHI(−) oligonucleotides were generated with 5′ phosphate groups.

TABLE 38
Oligonucleotides for Generation of the Domain
Exchanged 2G12 scFab ΔC2 Cys19 Construct

| | | SEQ |
|---|---|---|
| Oligonucleotide | | ID |
| Name | Sequence | NO: |
| XbaIVL-F | GGGGAATTGTGAGCGGATAACAATTC | 251 |
| BamHICK-R | CCGCCACCGGATCCACCACCAGATTCACCA | 252 |
| | CGGTTGAAAGATTTGGTAACC | |
| SacIVH-F | GCGGTGGGAGCTCCGGTGAAGTTCAGCTG | 253 |
| | GTTGAATCTGGTG | |
| HingeCH1 | CTGGCCGGCCTGGCCGCTGCTGCCAGATTT | 254 |
| deltaC-R | CGGTTCAACTTTCTTGTCAAC | |
| NcoIHinge-R | GTATGCGCCATGGTGATGGTGATGGTGCTG | 255 |
| | GCCGGCCTGGCCGCTG | |
| BamHISacI(+) | GATCCGGTGGCGGCAGCGAAGGTGGTGGC | 28 |
| | AGCGAAGGTGGCGGTAGCGAAGGTGGCGG | |
| | CAGCGAAGGCGGCGGTAGCGGTGGGAGCT | |
| SacIBamHI(−) | CCCACCGCTACCGCCGCCTTCGCTGCCGCC | 256 |
| | ACCTTCGCTACCGCCACCTTCGCTGCCACC | |
| | ACCTTCGCTGCCGCCACCG | |

First, a light chain polynucleotide (scFab ΔC2 Cys19 LC) was generated by PCR amplification using the template and primers indicated in Table 39, below. The template was the pET Duet vector containing the 2G12 Fab polynucleotide (SEQ ID NO: 231). For the reaction, 1 μL template (approximately 10 ng) and 1 μL of each primer were mixed with 1 μL it of Advantage HF2 polymerase mix in 1× Advantage HF2 reaction buffer and dNTP in a 50 μL reaction volume. The amplification was performed with 1 minute denaturation at 95° C. and 30 cycles of denaturation at 95° C. for 5 seconds, annealing at 60° C. for 10 seconds, and extension at 68° C. for 30 seconds followed by an incubation at 68° C. for 3 minutes. The reaction then was cooled down to 4° C. The size of the product is indicated in the Table 39, below. The product then was run on a 1% agarose gel and purified using a gel extraction kit.

TABLE 39
PCR Amplification of Light Chain Polynucleotide

| | PCR (product name) |
|---|---|
| | scFab ΔC2 Cys19 LC |
| template | 2G12 Fab in pETDuet vector |
| | (SEQ ID NO: 231) |
| 5′ primer (20 μM) | XbaIVL-F |
| | (SEQ ID NO: 251) |
| 3′ primer (20 μM) | BamHICK-R |
| | (SEQ ID NO: 252) |
| Product size (bp) | 795 |

The light chain product then was digested and inserted into the pET28 vector containing the 2G12 scFv tandem polynucleotide. For this process, the purified product was digested with Xba I and Bam HI restriction endonucleases (New England Biolabs®, Inc.) and purified using a PCR purification column. The digested product then was ligated into the pET28 vector containing the 2G12 domain exchanged scFv tandem polynucleotide (SEQ ID NO: 36), described in Example 14B(i) above, that had been digested with Xba I/Bam HI, using T4 DNA ligase.

The product of this ligation reaction was used to transform TOP 10F′ cells (Invitrogen™ Corporation, Carlsbad, Calif.). The cells were titrated for colony formation on LB agar plates supplemented with 50 kanamycin and 20 mM glucose. Following overnight growth at 37° C., colonies were picked and grown in 1.2 mL LB medium containing 50 μg/mL kanamycin, overnight at 37° C., and DNA from the cultures prepared using Qiagen miniprep DNA kit. Verification that the product had been correctly inserted into the vector was confirmed by DNA sequence analysis.

Next, a heavy chain polynucleotide (scFab μC2 Cys19HCl) was generated by PCR amplification using the template and primers indicated in Table 40, below. The template was the pET Duet vector containing the 2G12 Fab Cys 19 polynucleotide (SEQ ID NO: 30), described in Example 14B(vi), above. For the reaction, 1 μL of the template DNA(approximately 10 ng) was amplified with 1 μL of each primer in the presence of 1 μL of Advantage HF2 polymerase mix in 1× Advantage HF2 reaction buffer and dNTP in a 50 μL reaction volume. The amplified product was run on a 1% agarose gel and purified using a Gel Extraction kit.

TABLE 40
PCR Amplification of Heavy Chain Polynucleotide

| | PCR (product name) |
|---|---|
| | scFab μC2 Cys19 HC1 |
| template | 2G12 Fab Cys 19 in pETDuet vector |
| | (SEQ ID NO: 30) |
| 5′ primer (20 μM) | SacIVH-F |
| | (SEQ ID NO: 253) |
| 3′ primer (20 μM) | HingeCH1ΔC-R |
| | (SEQ ID NO: 254) |
| Product size (bp) | 716 |

Next, a second heavy chain fragment (scFab ΔC2 Cys19 HC2), was generated by PCR amplification, using the first heavy chain product as a template. The primers and template, as well as size of the product, are indicated in Table 41, below. For the reaction, 2 μL of purified scFab μC2 Cys19HCl product from the previous step was amplified with 2 μL of each primer in the presence of 2 μL of Advantage HF2 polymerase mix and dNTP in 1× Advantage HF2 polymerase reaction buffer in a 100 reaction volume. The product was run on a 1% agarose gel and purified by Gel Extraction.

TABLE 41
PCR Amplification of Second Heavy Chain Polynucleotide

| | PCR (product name) |
|---|---|
| | scFab ΔC2 Cys19 HC2 |
| template | scFab ΔC2 Cys19 HC1 |
| 5′ primer (20 μM) | SacIVH-F |
| | (SEQ ID NO: 253) |
| 3′ primer (20 μM) | NcoIHinge-R |
| | (SEQ ID NO: 255) |
| Product size (bp) | 743 |

Next, a linker (GATCCGGTGGCGGCAGCGAAGGTGGTGGCAGCGAAGGTGGCGGTAGCGA AGGTGGCGGCAGCGAAGGCGGCGGTAGCGGTGGGAGCT, SEQ ID NO: 28), for insertion between the V_{H} and C_{L} domains was generated by mixing the BamHISacI(+) (SEQ ID NO: 28) and SacIBamHI(−) (SEQ ID NO: 256) oligonucleotides under conditions whereby they hybridized through complementary regions: in the presence of 50 mM NaCl, by denaturing at 90° C. for 5 min and slowly cooling down to ambient temperature (approximately 25° C.). The linker contained Sac I and BamHI restriction site overhangs for ligation into the vector with the heavy chain.

Next, the heavy chain product (scFab ΔC2 Cys19 HC2) was digested and inserted into the pET28 vector into which the light chain fragment had been inserted as described in this subsection above. For this process, the light chain and the heavy chain product was digested with Sac I and Nco I restriction enzymes (New England Biolabs®, Inc.) and ligated, along with the linker prepared above, using T4 DNA ligase, into the pET28 vector into which the light chain had been introduced (described in this subsection above), that had been digested with Barn HI and Nco I.

The product of this ligation reaction was used to transform TOP10F′ cells (Invitrogen™ Corporation, Carlsbad, Calif.) and the cells titrated for colony formation on LB agar plates supplemented with 50 μg/mL kanamycin and 20 mM glucose. Following overnight growth at 37° C., colonies were picked and grown in 1.2 mL LB medium containing 50 μg/mL kanamycin, overnight at 37° C., and DNA from the culture was prepared using Qiagen miniprep DNA kit. The correct insertion of the fragment was confirmed by DNA sequence analysis.

### Example 14B(ix)

### Generation of Alternate Linker 2 Library for 2G12 scFv Tandem (VL-VH-VH-VL-6His-HA)

In addition to the original linker 2, used in generating the scFv tandem, detailed in Example 14B(i), above, which had 18 amino acids, the following oligonucleotides (listed in Table 42, below) were ordered from Integrated DNA Technologies (IDT) (Coralville, Iowa) to make a library of linkers with 16 to 20 amino acids. Each oligonucleotide contained a 5′ phosphate group.

TABLE 42

Oligonucleotides for Linker Library

| | | |
|---|---|---|
| Oligo | | SEQ ID |
| name | Sequence | NO: |

| | | |
|---|---|---|
| L216F | GATCCGGCAGCAGCAGCAGCGGCGGCGGGAGCT | 257 |
| L216R | CCCGCCGCCGCTGCTGCTGCTGCCG | 258 |
| L217F | GATCCGGCAGCAGCAGCAGCGGCGGCGGCGGGAGCT | 259 |
| L217R | CCCGCCGCCGCCGCTGCTGCTGCTGCCG | 260 |
| L219F | GATCCAGCGGCAGCAGCAGCAGCGGCGGCGGCGGCGGGAGCT | 261 |
| L219R | CCCGCCGCCGCCGCCGCTGCTGCTGCTGCCGCTG | 262 |
| L220F | GATCCAGCGGCGGCAGCAGCAGCAGCGGCGGCGGCGGCGGGAGCT | 263 |
| L220R | CCCGCCGCCGCCGCCGCTGCTGCTGCTGCCGCCGCTG | 264 |

Four linker oligonucleotide duplexes (L216, L217, L219, L220) were made by mixing 5′ oligonucleotides and 3′ oligonucleotides, as indicated in Table 43, below, under conditions whereby they formed duplexes by hybridizing through complementary regions: in the presence of 50 mM NaCl, by denaturing at 90° C. for 5 min and slowly cooling down to ambient temperature (approximately 25° C.).

TABLE 43

Linker Oligonucleotide Duplexes

| | | | | |
|---|---|---|---|---|
| Linker name | L216 | L217 | L219 | L220 |

| | | | | |
|---|---|---|---|---|
| 5′ oligonucleotide | L216F | L217F | L219F | L220F |
| (100 μM) | (SEQ ID | (SEQ ID NO: | (SEQ ID NO: | (SEQ ID NO: |
| | NO: 257) | 259) | 261) | 263) |
| 3′ oligonucleotide | L216R | L217R | L219R | L220R |
| (100 μM) | (SEQ ID | (SEQ ID NO: | (SEQ ID NO: | (SEQ ID NO: |
| | NO: 258) | 260) | 262) | 264) |
| Linker length | 16 | 17 | 19 | 20 |
| (amino acid | | | | |
| residues) | | | | |
| Nucleotide | GGAGGAT | GGAGGATCC | GGAGGATCC | GGAGGATCCA |
| sequence encoding | CCGGCAG | GGCAGCAGC | AGCGGCAGC | GCGGCGGCAG |
| linker | CAGCAGC | AGCAGCGGC | AGCAGCAGC | CAGCAGCAGC |
| | AGCGGCG | GGCGGCGGG | GGCGGCGGC | GGCGGCGGCG |
| | GCGGGAG | AGCTCCGGC | GGCGGGAGC | GCGGGAGCTC |
| | CTCCGGC | GGCGGA | TCCGGCGGC | CGGCGGCGGA |
| | GGCGGA | | GGA | |
| SEQ ID NO of | 20 | 22 | 24 | 26 |
| nucleotide sequence | | | | |
| encoding linker | | | | |
| SEQ ID NO of | 21 | 23 | 25 | 27 |
| amino acid | | | | |
| sequence of | | | | |
| polypeptide linker | | | | |

Each linker oligonucleotide duplex was inserted (via ligation using T4 DNA ligase into the pET28 vector containing the 2G12 scFv tandem polynucleotide (SEQ ID NO: 36), described in Example 14B(i) above, which had been cut with Barn HI and Sac I restriction endonucleases, thus partially replacing the sequence of the original Linker 2 in that construct.

### Example 14C

### Expression and Analysis of 2G12 Antibody Fragment Polypeptides in Bacterial Host Cells

### Example 14C(i)

### Polypeptide Expression

To evaluate expression of the various 2G12 domain exchanged polypeptide antibody fragments described in Example 14A from vectors generated as described in Example 14B, protein expression was induced in host cells transformed with the vectors. First, for protein expression of the 2G12 Fab fragment, 50 μL BL21 chemically competent E. coli cells were transformed with 100 ng of the pETDuet 2G12 domain exchanged Fab vector (SEQ ID NO: 231) and plated onto agar plates supplemented with kanamycin (30 ug/mL). Following overnight growth at 37° C., a single colony was picked and used to inoculate 50 mL of LB medium, supplemented with 30 ug/mL kanamycin. The culture was grown at 37° C., with shaking at 250 rpm, until the O.D. reached 0.6. To induce protein expression, 1 mM IPTG was added to the culture, which then was maintained at 30° C., with shaking at 250 rpm, overnight. The bacteria then were isolated by centrifugation (3000 rpm, 10 minutes) and resuspended in 1 mL PBS. To lyse the cells, the pellet was freeze-thawed three times in a dry ice/ethanol bath. The lysate then was centrifuged at 16,000×g for 20 minutes at 4° C. and the pellet discarded.

1 mL of the cleared supernatant then was separated on a Sephacryl S-200 HiPrep 16×60 size exclusion column (Amersham) by FPLC. Molecular weight standards (1 kb Plus DNA marker, Invitrogen™ Corporation, Carlsbad, Calif.) were used to determine molecular weight of the fraction proteins, by correlation with elution time. Protein from the fractions obtained from the column was tested for the presence 2G12 by ELISA binding against gp120, as described in Example 14D, below. Based on the molecular weight standards, it was determined that the fractions having reactivity in the ELISA binding assay with gp120 contained protein of an apparent size of approximately 92.5 Kda, the appropriate size of the 2G12 Fab fragment.

The same conditions and host cells were used to express other 2G12 fragments described in the above Examples. The results are listed in Table 44, below.

In Table 44, in the column labeled “Expression in E. coli,” a “++” indicates that the fragment was successfully expressed from the construct in bacterial host cells, using the conditions, methods and host cells described in this Example; a “−” indicates that the fragment was not successfully expressed in bacterial host cells using the conditions, methods and host cells described in this Example; and “NA” indicates that expression from this construct was not attempted.

As shown in Table 44, In addition to the 2G12 Fab fragment, the vectors containing nucleotide sequence encoding the domain exchanged 2G12 Fab hinge (SEQ ID NO: 34), 2G12 domain exchanged scFv tandem (SEQ ID NO: 36); 2G12 domain exchanged scFv (SEQ ID NO: 35) and the 2G12 domain exchanged scFv hinge E (SEQ ID NO: 37) fragments all were used to successfully express antibody fragments in bacterial cells, using the approach used to express the 2G12 Fab fragment. Expression of the 2G12 scFab ΔC2 Cys19 fragment in bacterial host cells was not attempted (indicated by ND in Table 44, below).

These data are expressed in Table 44. This table lists each 2G12 domain exchanged fragment (Fab, Fab hinge, Fab Cys19, scFabΔC2 Cys19, scFv tandem, scFv, scFv hinge and scFv Cys19) for which a construct was generated, as described in this and the previous Examples.

These data are exemplary, showing expression from particular constructs in a particular study with exemplary cell culture conditions and host cells and other parameters. Thus, the data are not comprehensive and are not meant to indicate that other constructs, including the constructs for which a “−” is listed in Table 44, cannot be used for expressing domain exchanged fragments in these or any other host cells under these or any other conditions.

TABLE 44
Expression of 2G12 Domain Exchange Fragments in Bacterial Host
Cells and Binding of the Expressed Antibodies to Antigen

| 2G12 Domain | | |
|---|---|---|
| Exchanged | Expression in | Binding to |
| Fragment | E. coli | gp120 |
| Fab | ++ | ++ |
| Fab Hinge | ++ | ++ |
| Fab Cys19 | − | − |
| scFabΔC² | ND | ND |
| Cys19 | | |
| scFv tandem | ++ | + |
| scFv | ++ | − |
| scFv hinge | ++ | + |
| scFv Cys19 | − | − |

### Example 14C(ii)

### Analysis of Antigen Specificity Using ELISA-Based Binding Assay

Polypeptides expressed from the host cells transformed with vectors described in Example 14C(i) were assessed in an ELISA-based antigen binding assay similar to the one described in Example 13D, above. Using this assay, the ability of each fragment to bind the 2G12 cognate antigen, gp120, was evaluated and compared to the ability of the 2G12 Fab fragment to bind the antigen. Polypeptides expressed from the AC8 scFv construct, described in Example 10A above were used as controls.

First, DNA (˜200 ng) from the various constructs was used to transform chemically competent BL21(DE3) cells (Invitrogen™ Corporation, Carlsbad, Calif., Carlsbad, Calif.). Single colonies of the transformants were grown overnight at 37° C. in LB media containing the appropriate antibiotic (Fab constructs: 50 μg/mL ampicillin; ScFv constructs: 25 μg/mL kanamycin), to allow secretion of domain exchanged fragments expressed from the constructs into the culture supernatant. The cultures then were centrifuged at 3,000 rpm for 15 min. The cell pellets were resuspended in 1 mL PBS and subjected to five freeze-thaw cycles. Insoluble material was removed by centrifugation at 14,000 rpm for 20 min.

The resulting PBS solutions contained the domain exchanged antibody fragments that were secreted into the supernatant during overnight growth, as well as antibodies harbored within the cells.

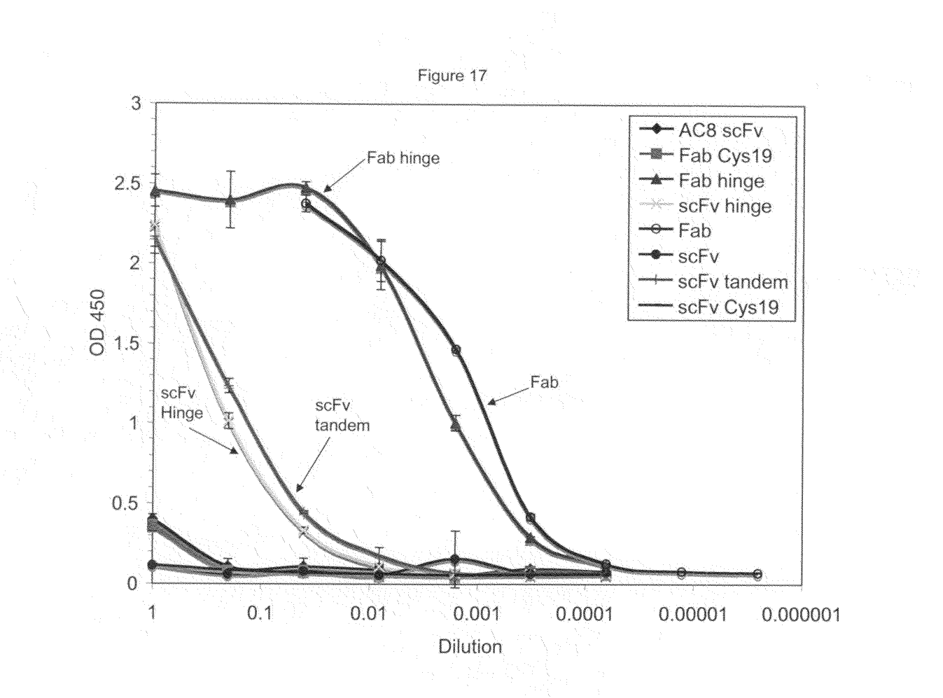

In order to demonstrate that the expressed fragments could bind the 2G12 antigen, gp120, the ELISA-based assay such as described in Example 13D was performed on the PBS solutions containing the fragments. Briefly, gp120-coated plates were incubated with serially diluted solutions of the polypeptide-containing PBS solutions from the previous step (1:5 serial dilutions), using the same binding conditions as described in Example 13D, above. Each sample was added to the plate in triplicate. Following binding, the plates were washed 10× with PBS containing 0.05% Tween to remove unbound proteins. Bound antibody fragments were detected using HRP-conjugated anti-HA, followed by a substrate, which was detected by taking absorbance readings, as described in Example 13D above. The data are summarized in Table 44, above and in FIG. 17.

In Table 44, in the column labeled “Binding to gp120,” “++” indicates that polypeptides from a particular sample bound strongly to the gp120 antigen as assessed using these experimental conditions; “+” indicates that polypeptides from a particular sample bound moderately well to the gp120 antigen as assessed using these experimental conditions; and “−” indicates that the polypeptides from a particular sample exhibited weak binding (no detectable absorbance compared to control level) to the gp120 antigen as assessed using these experimental conditions.

As shown in Table 44, under these experimental conditions, the polypeptides recovered from the cells transformed with the 2G12 domain exchanged Fab and the 2G12 domain exchanged Fab hinge constructs (vectors having the nucleotide sequences set forth in SEQ ID Nos: 231 and 34, respectively) exhibited strong binding to gp120, while the polypeptides recovered from the cells transformed with the domain exchanged 2G12 scFv tandem and 2G12 scFv hinge constructs (vectors having the nucleotide sequences set forth in SEQ ID Nos: 36 and 37, respectively), exhibited moderate binding (absorbance values less than half those for the Fab and Fab hinge proteins at comparable dilutions), and that the polypeptides recovered from the Fab Cys 19, scFv Cys 19 and scFv constructs exhibited weak binding (no detectable absorbance over that observed for polypeptides from the control sample (AC8 scFv)). FIG. 17 shows a graph, where the Y axis represents absorbance at 450 nm and the X axis represents dilution of the solution containing the antibody fragments. The binding curves for the domain exchanged fragments that exhibited moderate or strong binding to gp120 are labeled on the graph, with arrows pointing to the appropriate curve. The lack of detectable binding in the Fab Cys19 and scFv Cys19 samples likely was due to poor protein expression from these constructs under particular conditions as described in Example 14C(i) above.

These data are exemplary, showing binding of polypeptides from particular samples in a particular study with exemplary cell culture conditions, host cells, reagants and other parameters. Thus, the data are not comprehensive and are not meant to indicate that other constructs, including the constructs for which a “−” is listed in Table 44, cannot be used to express domain exchanged fragments that bind cognate antigen in these or any other host cells under these or any other conditions and parameters.

### Example 14E

### Phage Display of the Fragments

Example 10, above, describes the generation of phage display 2G12 pCAL G13 vector for phage display of the 2G12 Fab fragment. Example 11, above, describes the successful expression of the 2G12 domain exchanged fragment, using this vector, as part of a gene III fusion protein on phage surface. Example 11 describes precipitation of phage displaying the 2G12 Fab fragment, and verification of its ability to specifically bind gp120 antigen using the ELISA-based assay on precipitated phage. Further, as described in Example 13, panning was used to selectively enrich for antigen binding (2G12) version of the Fab fragment when spiked in with a non-binding (3-Ala) Fab fragment. These results indicate that the provided compositions and methods can be used to generate domain exchanged antibodies displayed on phage, including phage display libraries of domain exchanged antibodies and fragments thereof, and to select domain exchanged antibodies from the libraries having particular properties, such as ability to bind to a particular antigen.

Since modifications will be apparent to those of skill in this art, it is intended that this invention be limited only by the scope of the appended claims.

1. A method for producing a collection of variant assembled polynucleotide duplexes based on a target polynucleotide, comprising:
(a) generating a pool of reference sequence duplexes, wherein:
each reference sequence duplex in the pool includes at least a portion with sequence identity to a region of a target polynucleotide; and
includes a single stranded overhang of sufficient length to bind a complementary single stranded overhang;
(b) generating a pool of randomized duplexes, wherein each randomized duplex contains a randomized portion, a reference sequence portion containing identity to a region of the target polynucleotide, and an overhang comprising a sequence complementary to the overhang in the pool of duplexes of step (a) and of sufficient length to bind therewith;
(c) generating intermediate duplexes by combining the duplexes generated in step (a) and the randomized duplexes generated in step (b), under conditions whereby duplexes hybridize through complementary regions; and
(d) amplifying the intermediate duplexes to generate assembled polynucleotide duplexes from the intermediate duplexes, thereby generating a collection of variant assembled polynucleotide duplexes, the variant assembled duplexes having reference sequence portions with identity to regions of the target polynucleotide and randomized portions; wherein:
step (a) and step (b) are performed simultaneously or sequentially, in any order.

2. The method of claim 1, wherein step (a) is effected by:
(i) incubating a region of the target polynucleotide with a polymerase and primers, under conditions whereby complementary strands are synthesized, wherein the primers contain a restriction endonuclease cleavage site nucleotide sequence; and
(ii) adding a restriction endonuclease under conditions whereby the overhangs are generated, thereby generating a pool of reference sequence duplexes with overhangs.

3. The method of claim 2, wherein the region of the target polynucleotide is a functional or structural region of the target polynucleotide.

4. The method of claim 2, wherein the overhangs in the duplexes in step (a) are restriction site overhangs that are compatible with restriction site overhangs in the randomized duplexes.

5. The method of claim 1, wherein, step (b) is effected by:
(i) synthesizing a positive strand pool and a negative strand pool of randomized oligonucleotides, wherein each randomized oligonucleotide in each pool contains a reference sequence portion and a randomized portion; and
(ii) incubating the positive and negative strand pools of oligonucleotides under conditions whereby they hybridize through complementary regions.

6. The method of claim 5, wherein the reference sequence contains at least at or about 70% identity to the target polynucleotide.

7. The method of claim 5, wherein randomized portions of the randomized oligonucleotides are synthesized by a doping strategy selected from among any one or more of NNN, NNK, NNB, NNS, NNW, NNM, NNH, NND and NNV; NNM; NNH; NND; and NNV, wherein:
N is any nucleotide;
K is T or G;
B is C, G or T;
S is C or G;
W is A or T;
M is A or C;
H is A, C or T;
D is A, G or T; and
V is A, G or C.

8. The method of claim 5, wherein the overhang in step (b) is produced by adding a restriction endonuclease under conditions whereby the overhangs are generated.

9. The method of claim 1, wherein step (c) is performed by:
combining the duplexes; and
hybridizing polynucleotides of the duplexes and sealing nicks.

10. The method claim 1, wherein step (d) is performed by incubating the intermediate duplexes in the presence of a polymerase and primers, under conditions whereby complementary strands of the polynucleotides of the intermediate duplexes are synthesized.

11. The method of claim 1, wherein synthesis of complementary strands is effected in an amplification reaction.

12. The method of claim 11, wherein the amplification reaction is a polymerase chain reaction (PCR).

13. The method of claim 2, wherein the primers contain less than at or about 100, less than at or about 50 or less than at or about 30 nucleotides in length.

14. The method of claim 1, further comprising purifying one or more of the pools of duplexes.

15. The method of claim 1, wherein the each of the duplexes generated in step (a), the randomized duplexes generated in step (b), or both, contains less than 1000 or about 1000, less than 500 or about 500, less than 250 or about 250, less than 200 or about 200 or less than 150 or about 150, nucleotides in length.

16. The method of claim 1, wherein the collection of variant assembled duplexes contains a diversity of more than about 10⁴, 10⁵, 10⁶, 10⁷, 10⁸, 10⁹, 10¹⁰, 10¹¹, 10¹² or more different variants.

17. The method of claim 1, wherein each variant assembled duplex of the collection contains at least two non-contiguous randomized portions.

18. The method of claim 17, wherein at least two of the non-contiguous randomized portions are separated by at least about 50, about 100, about 150, about 200, about 300, about 400, about 500 nucleotides or more.

19. The method of claim 1, wherein variant assembled polynucleotide duplexes in the collection encode antibodies.

20. The method of claim 19, wherein at least one of the randomized portions in a variant assembled duplex is in an antibody complementarity determining region (CDR) or an antibody framework region.

21. The method of claim 19, wherein the region is at least a CDR1, CDR2 or CDR3 region.

22. The method of claim 19, wherein variant assembled duplexes in the collection contain at least two randomized portions encoding two different antibody CDRs.

23. The method of claim 1, wherein variant assembled duplexes in the collection contain any one or more nucleic acids selected from among nucleic acid encoding an antibody variable region domain or functional region thereof, nucleic acid encoding an antibody constant region domain or functional region thereof and nucleic acid encoding an antibody combining site.

24. The method of claim 1, wherein variant assembled duplexes in the collection contain any one or more nucleic acids selected from among nucleic acid encoding an antibody variable heavy chain (V_{H}) domain, nucleic acid encoding an antibody variable light chain (V_{L}) domain, nucleic acid encoding a heavy chain constant region 1 (C_{H}1) domain, and nucleic acid encoding a light chain constant region (C_{L}) domain.

25. The method of claim 19, wherein the antibodies are domain exchanged antibodies.

26. The method of claim 25, wherein the domain exchanged antibodies are modified 2G12 antibodies.

27. The method of claim 26, wherein the 2G12 antibodies contain a modification in a region contributing to antigen binding.

28. The method of claim 26, wherein a 2G12 antibody does not specifically bind to the gp120 protein the human immunodeficiency virus (HIV).

29. The method of claim 1, wherein variant assembled duplexes in the collection contain nucleic acid encoding a variable region domain, domain and a constant region domain, or functional region thereof, of a domain exchanged antibody.

30. A collection of variant assembled polynucleotide duplexes produced by the method of claim 1.

31. A collection of variant assembled polynucleotide duplexes produced by the method of claim 19.

32. A collection of polypeptides encoded by the collection of claim 30.

33. A collection of antibodies encoded by the collection of claim 31.

34. The collection of claim 32 that comprises a domain exchanged antibody.

35. The method of claim 1, wherein the target polynucleotide encodes an antibody.

36. The method of claim 35, wherein the antibody is selected from among a full length antibody, an scFv fragment, a Fab fragment, a Fab′ fragment, a F(ab′)₂, an Fv fragment, a dsFv fragment, a diabody, an Fd and an Fd′.

37. The method of claim 36, wherein the antibody is a domain exchanged antibody.

38. The method of claim 1, wherein the target polynucleotide contains any one or more of nucleic acid encoding an antibody variable heavy chain (V_{H}) domain, nucleic acid encoding an antibody variable light chain (V_{L}) domain, nucleic acid encoding a heavy chain constant region 1 (C_{H}1) domain, and nucleic acid encoding a light chain constant region (C_{L}) domain.

39. A method for producing a collection of variant assembled polynucleotide duplexes, comprising:
(a) synthesizing at least four pools of oligonucleotides, wherein:
each pool of oligonucleotides contains a reference sequence containing identity to a region of a target polynucleotides;
at least one of the pools is a pool of randomized oligonucleotides, and
each oligonucleotide within each of the pools contains a region of complementarity to a region of at least one oligonucleotide in another of the pools;
(b) forming pools of duplexes by:
combining the pools of oligonucleotides under conditions whereby the oligonucleotides hybridize through complementary regions; and
performing fill-in reactions, wherein:
the pools of duplexes contain overhangs; and
(c) generating assembled duplexes by combining the pools of duplexes under conditions whereby they hybridize through complementary regions in the overhangs, thereby generating a collection of variant assembled duplexes having reference sequence portions with identity to the target polynucleotide and randomized portions.

40. The method of claim 39, wherein variant assembled duplexes cassette contain at least two non-contiguous randomized portions.

41. A collection of variant assembled duplexes produced by the method of claim 39.

42. A collection of polypeptides encoded by the collection of claim 41.

43. The collection of claim 42 that comprises a domain exchanged antibody.

44. A method for producing a collection of variant assembled duplex cassettes comprising:
(a) synthesizing at least three pools of oligonucleotides, wherein:
the pools contain at least one pool of positive strand oligonucleotides and one pool of negative strand oligonucleotides;
each oligonucleotide pool contains a reference sequence containing identity to a region of a target polynucleotide;
at least two of the oligonucleotide pools are pools of randomized oligonucleotides, and
each oligonucleotide within each pool contains at least a region of complementarity to a region of an oligonucleotide in at least another of the pools; and
(b) forming variant assembled cassettes by:
combining the pools of oligonucleotides under conditions whereby positive and negative strand oligonucleotides hybridize through regions of complementarity and the nicks are sealed, thereby generating a collection of variant assembled duplex cassettes; wherein
each of the cassettes comprises the nucleotide sequence of one oligonucleotide from each pool, and at least one randomized portion.

45. The method of claim 44, wherein the variant assembled contain at least two non-contiguous randomized portions.

46. A collection of variant assembled duplex cassettes produced by the method of claim 44.

47. A collection of polypeptides encoded by the collection of claim 46.

48. The collection of claim 47 that comprises a domain exchanged antibody.

49. A displayed collection, comprising a collection polypeptides of claim 32, wherein each polypeptide is displayed on a genetic package.

50. The displayed collection of claim 49, wherein:
the genetic package comprises a phage; and
the polypeptides are linked to the phage directly or indirectly via a phage coat protein.

51. A method for producing a collection of variant assembled duplex cassettes comprising:
contacting a collection of assembled randomized polynucleotide duplexes produced by the method of claim 1 with a restriction endonuclease to generate a collection of variant assembled duplex cassettes.

52. A collection, comprising randomized polynucleotides, wherein:
each randomized polynucleotide member of the collection contains at least two reference sequence portions that are common among the polynucleotides and at least two non-contiguous randomized portions, wherein the randomized portions are separated by at least about 100, 200, 300, 500, 1000 or more nucleotides.

53. The collection of polypeptides encoded by the collection of randomized polynucleotides of claim 52, wherein polypeptide members encode an antibody or portion thereof.

54. The collection of polypeptides of claim 53, wherein the polypeptides are antibodies or portions thereof.

55. The collection of polypeptides of claim 54, wherein the antibodies include domain exchanged antibodies.

56. The collection of claim 55, wherein the domain exchanged antibodies are Fab dimers.
